(19) United States
(12) Patent Application Publication
(10) Pub. No.: US 2026/0161131 A1
(43) Pub. Date: Jun. 11, 2026

(54) IMAGE FORMING APPARATUS AND CARTRIDGE

(71) Applicant: CANON KABUSHIKI KAISHA, Tokyo (JP)

(72) Inventors: TOSHIKI FUJINO, Kanagawa (JP); TACHIO KAWAI, Tokyo (JP); TERUHIKO SASAKI, Shizuoka (JP); NORIYUKI KOMATSU, Shizuoka (JP); AKINOBU HIRAYAMA, Shizuoka (JP)

(21) Appl. No.: 19/537,837

(22) Filed: Feb. 12, 2026

Related U.S. Application Data
(63) Continuation of application No. PCT/JP2024/080143, filed on Aug. 23, 2024.

(30) Foreign Application Priority Data
Aug. 25, 2023 (JP) 2023-137004

(51) Int. Cl. G03G 21/18

(52) U.S. Cl. CPC G03G 21/186; G03G 21/1814; G03G 21/1821; G03G 2221/1654

(57) ABSTRACT

The cartridge includes a frame, a photosensitive drum, and a rack. The photosensitive drum is supported by the frame and is rotatable about its axis. The rack has one or more teeth at least partially exposed so as to face an axis of the photosensitive drum. The rack is provided on a side of the cartridge in a direction of the axis of the photosensitive drum.

### TECHNICAL FIELD

The present invention relates to a cartridge and an image forming apparatus using the cartridge.

Here, the cartridge is a device which can be attached to and detached from the main assembly of an image forming apparatus. One example is a process cartridge. The process cartridge is a cartridge in which a photosensitive member and a process means actable on the photosensitive member are integrated into a unit, and the cartridge is detachably mountable to the main assembly of the electrophotographic image forming apparatus.

For example, a cartridge in which a photosensitive member and at least one of the process means, namely, a developing means, a charging means, and a cleaning means, are integrated into a unit can be cited. In addition, the image forming apparatus in this application is an electrophotographic image forming apparatus for forming an image on a recording medium using an electrophotographic image forming method.

Examples of electrophotographic image forming apparatuses include electrophotographic copying machines, electrophotographic printers (LED printers, laser beam printers, and so on), facsimile machines, and word processors.

### BACKGROUND ART

In an electrophotographic image forming apparatus (hereinafter also simply referred to as an “image forming apparatus”), an electrophotographic photosensitive member, generally a drum type, serving as an image bearing member, i.e., a photosensitive drum (electrophotographic photosensitive drum), is uniformly charged. Next, an electrostatic latent image (electrostatic image) is formed on the photosensitive drum by selectively exposing the charged photosensitive drum. Then, the electrostatic latent image formed on the photosensitive drum is developed into a toner image with toner as a developer. Thereafter, the toner image formed on the photosensitive drum is transferred onto a recording material such as recording paper or a plastic sheet, and the toner image transferred to the recording material is fixed to the recording material by applying heat and/or pressure to the toner image transferred to the recording material, thereby performing image recording.

Such an image forming apparatus generally requires toner replenishment and maintenance of various process means. In order to facilitate this toner replenishment and maintenance, a process cartridge in which the photosensitive drum, the charging means, the developing means, the cleaning means, and so on are assembled in a frame into a form of cartridge which can be mounted to and dismounted from the main assembly of the image forming apparatus has been put into practical use.

This process cartridge system makes it possible for the user to perform part of the maintenance of the apparatus, in effect, without relying on a service person in charge of after-sales service. This significantly improves the operability of the apparatus and provides an image forming apparatus with excellent usability. For this reason, this process cartridge system is widely used in image forming apparatuses.

As described in JP-H8-328449 (see FIG. 16), the image forming apparatus described above is generally known to have a drive transmission member which is urged toward the process cartridge by a spring and which is provided with a coupling at an end for transmitting drive from the main assembly of the image forming apparatus to the process cartridge.

When a door of the image forming apparatus main assembly is closed, the drive transmission member of this image forming apparatus is pressed by the spring and moves toward the process cartridge. This causes the drive transmission member to engage (couple) with the coupling of the process cartridge, thus enabling drive transmission to the process cartridge. When the door of the image forming apparatus main assembly is opened, the drive transmission member is moved away from the process cartridge by a cam against force of the spring. This causes the drive transmission member to disengage from the coupling of the process cartridge, making it possible to dismount the process cartridge from the main assembly of the image forming apparatus.

### SUMMARY OF THE INVENTION

An example of the embodiments of the present invention is

A cartridge comprising:
a frame;
a photosensitive drum supported by the frame and rotatable about an axis; and
a rack having one or more teeth at least partially exposed to face the axis of the photosensitive drum and provided at a side of the cartridge with respect to a direction of the axis of the photosensitive drum.

A further example of the embodiments is

A cartridge comprising:
a frame;
a photosensitive drum supported by the frame and rotatable about an axis; and
an elastic member having a surface at least partially exposed so as to face the axis of the photosensitive drum, the elastic member being provided at a side of the cartridge with respect to a direction of the axis of the photosensitive drum.

Even further example of the embodiments is

A cartridge comprising:
a frame;
a photosensitive drum supported by the frame and rotatable about an axis; and
a frictional force applying portion having a surface at least partially exposed so as to face the axis of the photosensitive drum and provided at a side of the cartridge with respect to a direction of the axis of the photosensitive drum.

Even further example of the embodiments is

A cartridge comprising:
a frame;
a photosensitive drum supported by the frame and rotatable about an axis; and
a tacky member having a surface at least partially exposed so as to face the axis of the photosensitive drum and provided at a side of the cartridge with respect to a direction of the axis of the photosensitive drum.

Even further example of the embodiments is

A cartridge comprising:
a frame;
a photosensitive drum supported by the frame and rotatable about the axis thereof;
one or more movable teeth provided at a side of the cartridge with respect to a direction of the axis of the photosensitive drum and at least partially exposed so as to face the axis of the photosensitive drum; and
a lock for restricting movement of the one or more teeth.

Even further example of the embodiments is

A cartridge comprising:
a frame;
a photosensitive drum supported by the frame and rotatable about an axis; and
a rotatable missing tooth gear provided at the side of the cartridge and having one or more teeth at least partially exposed so as to face the axis of the photosensitive drum.

Even further example of the embodiments is

A cartridge comprising:
a frame;
a photosensitive drum supported by the frame and rotatable about an axis, the photosensitive drum having a first end and a second end opposite the first end; and
one or more movable teeth provided at a side of the cartridge with respect to a direction of the axis of the photosensitive drum and at least partially exposed toward the axis of the photosensitive drum;
a spring urging the one or more teeth;
wherein as viewed along the axis of the photosensitive drum,
a line extending from the axis of the photosensitive drum through a tooth of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

Even further example of the embodiment is

A cartridge comprising:
a frame;
a photosensitive drum supported by the frame and rotatable about an axis;
one or more teeth provided at a side of the cartridge with respect to a direction of the axis of the photosensitive drum and at least partially exposed toward the axis of the photosensitive drum; and
a movable lever provided with the one or more teeth;
wherein as viewed along the axis of the photosensitive drum,
a line extending from the axis of the photosensitive drum through a tooth of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

Even further example of the embodiment is

A cartridge comprising:
a frame;
a photosensitive drum supported by the frame and rotatable about an axis, the photosensitive drum having a first end and a second end opposite the first end; and
a rotatable gear provided at a side of the cartridge with respect to a direction of the axis of the photosensitive drum, the rotatable gear having one or more teeth at least partially exposed toward the axis of the photosensitive drum, the rotatable gear being movable in a direction of the axis of itself.

Even further example of the embodiments is

A cartridge comprising:
a frame;
a photosensitive drum supported by the frame and rotatable about an axis; and
a rotatable gear having one or more teeth at least partially exposed toward the axis of the photosensitive drum, the rotatable gear being provided at a side of the cartridge with respect to a direction of the axis of the photosensitive drum,
wherein one of the frame and the gear has a hole and the other has a shaft portion that fits into the hole, with a gap between the hole and the shaft portion, the gap making the gear movable in a direction perpendicular to an axis of itself.

Even further example of the embodiments is

A cartridge comprising:
a frame;
a photosensitive drum supported by the frame and rotatable about an axis; and
a rotatable belt provided at a side of the cartridge with respect to a direction of the axis of the photosensitive drum, the belt having a surface at least partially exposed to outside so as to face the axis of the photosensitive drum.

According to some preferred embodiments of the present invention, the above-described conventional technology can be further developed.

### BRIEF DESCRIPTION OF THE DRAWINGS

Part (a) of FIG. 1 and part (b) of FIG. 1 are illustrations of a drive transmitting portion of a process cartridge according to Embodiment 1.

FIG. 2 is a cross-sectional view of a main assembly of an image forming apparatus and a process cartridge of the electrophotographic image forming apparatus according to Embodiment 1.

FIG. 3 is a cross-sectional view of the process cartridge according to Embodiment 1.

FIG. 4 is an exploded perspective view of the process cartridge according to Embodiment 1.

FIG. 5 is an exploded perspective view of a process cartridge according to Embodiment 1.

Part (a) of FIG. 6, part (b) of FIG. 6, and part (c) of FIG. 6 are illustrations of a link portion of the electrophotographic image forming apparatus according to Embodiment 1.

Part (a) of FIG. 7 and part (b) of FIG. 7 are illustrations of the link portion of the electrophotographic image forming apparatus according to Embodiment 1.

Part (a) of FIG. 8 and part (b) of FIG. 8 are cross-sectional views of a guide portion of the electrophotographic image forming apparatus according to Embodiment 1.

FIG. 9 is an illustration of a drive train portion of the electrophotographic image forming apparatus according to Embodiment 1.

Part (a) of FIG. 10 and part (b) of FIG. 10 are illustrations of a longitudinal positioning portion of the electrophotographic image forming apparatus according to Embodiment 1.

Part (a) of FIG. 11 and part (b) of FIG. 11 are cross-sectional views of a positioning portion of the electrophotographic image forming apparatus according to Embodiment 1.

Part (a) of FIG. 12 and part (b) of FIG. 12 are illustrations of the link portion of the electrophotographic image forming apparatus according to Embodiment 1.

Part (a) of FIG. 13 and part (b) of FIG. 13 are perspective views of the drive transmitting portion of the electrophotographic image forming apparatus according to Embodiment 1.

FIG. 14 is a perspective view of the drive transmitting portion of the electrophotographic image forming apparatus according to Embodiment 1.

FIG. 15 is a cross-sectional view of the drive transmitting portion of the electrophotographic image forming apparatus according to Embodiment 1.

FIG. 16 is an illustration of the drive train of the process cartridge according to Embodiment 1.

FIG. 17 is a sectional view of the drive transmitting portion of the electrophotographic image forming apparatus according to Embodiment 1.

Part (a) of FIG. 18 and part (b) of FIG. 18 are sectional views of the drive transmitting portion of the electrophotographic image forming apparatus according to Embodiment 1.

Part (a) of FIG. 19 and part (b) of FIG. 19 are cross-sectional views of the drive transmitting portion of the electrophotographic image forming apparatus according to Embodiment 1.

FIG. 20 is a sectional view of the drive transmitting portion of the electrophotographic image forming apparatus according to Embodiment 1.

FIG. 21 is a sectional view of the drive transmitting portion of the electrophotographic image forming apparatus according to Embodiment 1.

FIG. 22 is an illustration of the drive train of the process cartridge according to Embodiment 1.

FIG. 23 is a perspective view of a process cartridge according to Embodiment 2.

Part (a) of FIG. 24 and part (b) of FIG. 24 are illustrations of a drive train of the process cartridge according to Embodiment 2.

Part (a) of FIG. 25 and part (b) of FIG. 25 are illustrations of a rack gear mechanism of the process cartridge according to Embodiment 2.

Part (a) of FIG. 26, part (b) of FIG. 26, and part (c) of FIG. 26 are illustrations of the rack gear mechanism of the process cartridge according to Embodiment 2.

Part (a) of FIG. 27, part (b) of FIG. 27, and part (c) of FIG. 27 are illustrations of the rack gear mechanism of the process cartridge according to Embodiment 2.

Part (a) of FIG. 28 and part (b) of FIG. 28 are illustrations of the rack gear mechanism of the process cartridge according to Embodiment 2.

Part (a) of FIG. 29 and part (b) of FIG. 29 are illustrations of an arrangement of the rack gear mechanism of the process cartridge according to Embodiment 2.

Part (a) of FIG. 30, part (b) of FIG. 30, part (c) of FIG. 30, and part (d) of FIG. 30 are sectional views illustrating operation of the rack gear mechanism of the process cartridge according to Embodiment 2.

Part (a) of FIG. 31 and part (b) of FIG. 31 are illustrations of the drive transmitting portion of the electrophotographic image forming apparatus according to Embodiment 2.

Part (a) of FIG. 32, part (b) of FIG. 32, and part (c) of FIG. 32 are sectional views of the drive transmitting portion of the electrophotographic image forming apparatus according to Embodiment 2.

Part (a) of FIG. 33 and part (b) of FIG. 33 are cross-sectional views of the electrophotographic image forming apparatus showing process of mounting the process cartridge according to Embodiment 2.

Part (a) of FIG. 34 and part (b) of FIG. 34 are cross-sectional views showing the operation of the drive transmitting portion of the electrophotographic image forming apparatus according to Embodiment 2.

Part (a) of FIG. 35, part (b) of FIG. 35, and part (c) of FIG. 35 are sectional views showing the operation of the drive transmitting portion of the electrophotographic image forming apparatus according to Embodiment 2.

Part (a) of FIG. 36 and part (b) of FIG. 36 are cross-sectional views showing the operation of the drive transmitting portion of the electrophotographic image forming apparatus according to Embodiment 2.

Part (a) of FIG. 37, part (b) of FIG. 37, part (c) of FIG. 37, and part (d) of FIG. 37 are cross-sectional views of the electrophotographic image forming apparatus showing the process of dismounting the process cartridge according to Embodiment 2.

FIG. 38 is a cross-sectional view of the electrophotographic image forming apparatus according to Embodiment 2.

Part (a) of FIG. 39 and part (b) of FIG. 39 are illustrations relating to a first modified example of Embodiment 2.

Part (a) of FIG. 40 and part (b) of FIG. 40 are illustrations relating to a second modified example of Embodiment 2.

FIG. 41 is a perspective view of a process cartridge according to Embodiment 3.

Part (a) of FIG. 42 and part (b) of FIG. 42 are illustrations of an arrangement of the frictional force imparting surface of the process cartridge according to Embodiment 3.

Part (a) of FIG. 43 and part (b) of FIG. 43 are illustrations of a drive transmitting portion of the electrophotographic image forming apparatus according to Embodiment 3.

Part (a) of FIG. 44 and part (b) of FIG. 44 are cross-sectional views of the electrophotographic image forming apparatus showing the process of mounting the process cartridge according to Embodiment 3.

Part (a) of FIG. 45 and part (b) of FIG. 45 are cross-sectional views showing the operation of the drive transmitting portion of the electrophotographic image forming apparatus according to Embodiment 3.

Part (a) of FIG. 46 and part (b) of FIG. 46 are sectional views showing operation of the drive transmitting portion of the electrophotographic image forming apparatus according to Embodiment 3.

Part (a) of FIG. 47 and part (b) of FIG. 47 are sectional views showing the operation of the drive transmitting portion of the electrophotographic image forming apparatus according to Embodiment 3.

Part (a) of FIG. 48, part (b) of FIG. 48, and part (c) of FIG. 48 are cross-sectional views showing the operation of the drive transmitting portion of the electrophotographic image forming apparatus according to Embodiment 3.

Part (a) of FIG. 49 and part (b) of FIG. 49 are cross-sectional views showing the operation of the drive transmitting portion of the electrophotographic image forming apparatus according to Embodiment 3.

Part (a) of FIG. 50 and part (b) of FIG. 50 are cross-sectional views showing the operation of the drive transmitting portion of the electrophotographic image forming apparatus according to Embodiment 3.

Part (a) of FIG. 51 is an illustration of a method for measuring a friction coefficient. Part (b) of FIG. 51 is an illustration of a method for measuring a degree of elasticity.

FIG. 52 is a perspective view of a process cartridge according to Embodiment 4.

Part (a) of FIG. 53 and part (b) of FIG. 53 are illustrations of an arrangement of an elastic rotatable member of the process cartridge according to Embodiment 4.

Part (a) of FIG. 54 and part (b) of FIG. 54 are cross-sectional views of operation of a drive transmitting portion of the electrophotographic image forming apparatus according to Embodiment 4.

FIG. 55 is a sectional view showing operation of the drive transmitting portion of the electrophotographic image forming apparatus according to Embodiment 4.

FIG. 56 is a perspective view of a process cartridge according to Embodiment 5.

Part (a) of FIG. 57 and part (b) of FIG. 57 are illustrations of a missing tooth gear mechanism of the process cartridge according to Embodiment 5.

Part (a) of FIG. 58 and part (b) of FIG. 58 are illustrations of the missing tooth gear mechanism of the process cartridge according to Embodiment 5.

Part (a) of FIG. 59, part (b) of FIG. 59, and part (c) of FIG. 59 are illustrations of the missing tooth gear mechanism of the process cartridge according to Embodiment 5.

Part (a) of FIG. 60 and part (b) of FIG. 60 are illustrations of an arrangement of the missing tooth gear mechanism of the process cartridge according to Embodiment 5.

Part (a) of FIG. 61 and part (b) of FIG. 61 are cross-sectional views showing the operation of the missing tooth gear mechanism of the process cartridge according to Embodiment 5.

Part (a) of FIG. 62 and part (b) of FIG. 62 are cross-sectional views of the electrophotographic image forming apparatus showing process of mounting the process cartridge according to Embodiment 5.

Part (a) of FIG. 63 and part (b) of FIG. 63 are cross-sectional views showing operation of the drive transmitting portion of the electrophotographic image forming apparatus according to Embodiment 5.

Part (a) of FIG. 64 and part (b) of FIG. 64 are cross-sectional views showing the operation of the drive transmitting portion of the electrophotographic image forming apparatus according to Embodiment 5.

Part (a) of FIG. 65, part (b) of FIG. 65 and part (c) of FIG. 65 are cross-sectional views of the electrophotographic image forming apparatus showing process of dismounting the process cartridge according to Embodiment 5.

Part (a) of FIG. 66 and part (b) of FIG. 66 are illustrations of a first modified example of Embodiment 5.

FIG. 67 is a perspective view of a process cartridge according to Embodiment 6.

Part (a) of FIG. 68 and part (b) of FIG. 68 are illustrations of a rotatable rack gear mechanism of the process cartridge according to Embodiment 6.

Part (a) of FIG. 69 and part (b) of FIG. 69 are illustrations of the rotatable rack gear mechanism of the process cartridge according to Embodiment 6.

Part (a) of FIG. 70 and part (b) of FIG. 70 are illustrations showing operation of the rotatable rack gear mechanism of the process cartridge according to Embodiment 6.

Part (a) of FIG. 71, part (b) of FIG. 71, part (c) of FIG. 71, and part (d) of FIG. 71 are sectional views showing operation of the drive transmitting portion of the electrophotographic image forming apparatus according to Embodiment 6.

Part (a) of FIG. 72, part (b) of FIG. 72, part (c) of FIG. 72, and part (d) of FIG. 72 are sectional views showing the operation of the drive transmitting portion of the electrophotographic image forming apparatus according to Embodiment 6.

Part (a) of FIG. 73 and part (b) of FIG. 73 are illustrations relating to a first modified example of Embodiment 6.

FIG. 74 are perspective views of a process cartridge according to Embodiment 7.

Part (a) of FIG. 75 and part (b) of FIG. 75 are illustrations of an urging mechanism of the process cartridge according to Embodiment 7.

Part (a) of FIG. 76 and part (b) of FIG. 76 are illustrations of an arrangement of the urging mechanism of the process cartridge according to Embodiment 7.

Part (a) of FIG. 77 and part (b) of FIG. 77 are cross-sectional views showing an operation of the urging mechanism of the process cartridge according to Embodiment 7.

Part (a) of FIG. 78 and part (b) of FIG. 78 are cross-sectional views of the electrophotographic image forming apparatus showing process of mounting the process cartridge according to Embodiment 7.

Part (a) of FIG. 79 and part (b) of FIG. 79 are cross-sectional views showing the operation of the drive transmitting portion of the electrophotographic image forming apparatus according to Embodiment 7.

Part (a) of FIG. 80, part (b) of FIG. 80, and part (c) of FIG. 80 are sectional views showing the operation of the drive transmitting portion of the electrophotographic image forming apparatus according to Embodiment 7.

FIG. 81 is a cross-sectional view showing the operation of the drive transmitting portion of the electrophotographic image forming apparatus according to Embodiment 7.

Part (a) of FIG. 82 and part (b) of FIG. 82 are sectional views showing the operation of the drive transmitting portion of the electrophotographic image forming apparatus according to Embodiment 7.

FIG. 83 is a perspective view of a process cartridge according to a first modified example of Embodiment 7.

FIG. 84 is an illustration of the process cartridge according to the first modified example of Embodiment 7.

FIG. 85 is an illustration of a lock of the process cartridge according to the first modified example of Embodiment 7.

Part (a) of FIG. 86 and part (b) of FIG. 86 are illustrations of the lock of the process cartridge according to the first modified example of Embodiment 7.

Part (a) of FIG. 87 and part (b) of FIG. 87 are illustrations of a projection of the process cartridge according to the first modified example of Embodiment 7.

Part (a) of FIG. 88 and part (b) of FIG. 88 are illustrations of the lock of the process cartridge according to the first modified example of Embodiment 7.

Part (a) of FIG. 89 and part (b) of FIG. 89 are illustrations of the projection of the process cartridge according to the first modified example of Embodiment 7.

Part (a) of FIG. 90, part (b) of FIG. 90, part (c) of FIG. 90, and part (d) of FIG. 90 are illustrations of the lock operation of the process cartridge according to the first modified example of Embodiment 7.

Part (a) of FIG. 91 and part (b) of FIG. 91 are cross-sectional views showing the operation of the opening/closing door of an electrophotographic image forming apparatus according to a first modified example of Embodiment 7.

Parts (a)-(l) of FIG. 92 are illustrations of the operation of the drive transmitting portion of an electrophotographic image forming apparatus according to the first modified example of Embodiment 7.

Part (a) of FIG. 93 and part (b) of FIG. 93 are illustrations of the operation of the drive transmitting portion of the electrophotographic image forming apparatus according to the first modified example of Embodiment 7.

FIG. 94 is a perspective view of a process cartridge according to a second modified example of Embodiment 7.

FIG. 95 is an illustration of an engagement mechanism of a process cartridge according to the second modified example of Embodiment 7.

Part (a) of FIG. 96 and part (b) of FIG. 96 are illustrations of the engagement mechanism of the process cartridge according to the second modified example of Embodiment 7.

Parts (a)-(f) of FIG. 97 are illustrations of an engagement mechanism of the process cartridge according to the second modified example of Embodiment 7.

Part (a) of FIG. 98 and part (b) of FIG. 98 are cross-sectional views showing operation of the drive transmitting portion of the electrophotographic image forming apparatus according to the second modified example of Embodiment 7.

Parts (a)-(f) of FIG. 99 are illustrations of an engagement mechanism of the process cartridge according to the second modified example of Embodiment 7.

Part (a) of FIG. 100 and part (b) of FIG. 100 are illustrations of operation of the drive transmitting portion of the electrophotographic image forming apparatus according to the second modified example of Embodiment 7.

FIG. 101 is an illustration of a drive train of the process cartridge according to the second modified example of Embodiment 7.

FIG. 102 is a perspective view of a process cartridge according to Embodiment 8.

FIG. 103 is an illustration of an engagement mechanism of the process cartridge according to Embodiment 8.

Part (a) of FIG. 104 and part (b) of FIG. 104 are illustrations of an engagement mechanism of the process cartridge according to Embodiment 8.

Part (a) of FIG. 105 and part (b) of FIG. 105 are cross-sectional views showing operation of the drive transmitting portion of the electrophotographic image forming apparatus according to Embodiment 8.

FIG. 106 is an illustration of the engagement mechanism of the process cartridge according to a first modified example of Embodiment 8.

Part (a) of FIG. 107 and part (b) of FIG. 107 are cross-sectional views showing the operation of the drive transmitting portion of the electrophotographic image forming apparatus according to the first modified example of Embodiment 8.

FIG. 108 is an illustration of the engagement mechanism of the process cartridge according to a second modified example of Embodiment 8.

FIG. 109 is a cross-sectional view showing operation of the drive transmitting portion of the electrophotographic image forming apparatus according to the second modified example of Embodiment 8.

FIG. 110 is an illustration of an engagement mechanism of the process cartridge according to a third modified example of Embodiment 8.

FIG. 111 is a perspective view of a process cartridge according to Embodiment 9.

Part (a) of FIG. 112 and part (b) of FIG. 112 are illustrations of a load applying mechanism of the process cartridge according to Embodiment 9.

Part (a) of FIG. 113 and part (b) of FIG. 113 are illustrations of the load applying mechanism of the process cartridge according to Embodiment 9.

Part (a) of FIG. 114 and part (b) of FIG. 114 are cross-sectional views showing operation of the drive transmitting portion of the electrophotographic image forming apparatus according to Embodiment 9.

Part (a) of FIG. 115, part (b) of FIG. 115, and part (c) of FIG. 115 are illustrations of operation of the drive transmitting portion of the electrophotographic image forming apparatus according to Embodiment 9.

Part (a) of FIG. 116, part (b) of FIG. 116, and part (c) of FIG. 116 are illustrations of a first modified example of Embodiment 9.

Part (a) of FIG. 117, part (b) of FIG. 117, and part (c) of FIG. 117 are illustrations of a second modified example of Embodiment 9.

Part (a) of FIG. 118 is a perspective view of the cartridge, and part (b) of FIG. 118 is an exploded perspective view of the cartridge.

Part (a) of FIG. 119 is a side view of the cartridge, and part (b) of FIG. 119 is a sectional view of the cartridge.

FIG. 120 is an illustration of a drive transmission member.

FIG. 121 is an illustration of the cartridge and the drive transmission member.

FIG. 122 is an illustration of a drive transmission member.

Part (a) of FIG. 123 is an illustration of a drive transmission member, and part (b) of FIG. 123 is an illustration of a cartridge and a drive transmission member.

Part (a) of FIG. 124 is an illustration of a drive transmission member, and part (b) of FIG. 124 is an illustration of a cartridge and a drive transmission member.

Part (a) of FIG. 125 is an illustration of a drive transmission member, and part (b) of FIG. 125 is an illustration of a cartridge and a drive transmission member.

Part (a) of FIG. 126 is an illustration of the drive transmission member, and part (b) of FIG. 126 is an illustration of the cartridge and the drive transmission member.

Part (a) of FIG. 127 is an illustration of a drive transmission member, and part (b) of FIG. 127 is an illustration of a cartridge and a drive transmission member.

Part (a) of FIG. 128 is a perspective view of a cartridge, and part (b) of FIG. 128 is a side view of the cartridge.

Part (a) of FIG. 129 is a perspective view of a cartridge, and part (b) of FIG. 129 is a perspective view of the cartridge.

Part (a) of FIG. 130 is an exploded perspective view of a cartridge, and part (b) of FIG. 130 is an exploded perspective view of the cartridge.

Part (a) of FIG. 131 and part (b) of FIG. 131 are views showing a control member.

Part (a) of FIG. 132 and part (b) of FIG. 132 are side views of a cartridge.

Part (a) of FIG. 133 is a sectional view of a cartridge illustrating a positional relationship of a control member, and part (b) of FIG. 133 is a view showing the control member.

Part (a) of FIG. 134 is a side view of the cartridge, and part (b) of FIG. 134 is a view as viewed from the front, showing the cartridge and a drive transmission member.

FIG. 135 is a side view of a cartridge.

FIG. 136 is a side view of the cartridge.

FIG. 137 is a side view of the cartridge.

FIG. 138 is a side view of the cartridge.

FIG. 139 is a side view of the cartridge.

Part (a) of FIG. 140 and part (b) of FIG. 140 are side views of the cartridge.

FIG. 141 is a cross-sectional view of a main assembly of an image forming apparatus and a cartridge.

FIG. 142 is a cross-sectional view of a cartridge.

Part (a) of FIG. 143 and part (b) of FIG. 143 are perspective views of the image forming apparatus with a door open and closed.

FIG. 144 is a sectional view of a drive transmission member with the door closed.

FIG. 145 is a perspective view of vicinity of a cylindrical cam with the door open.

Part (a) of FIG. 146 and part (b) of FIG. 146 are sectional views of the image forming apparatus when the cartridge is mounted.

FIG. 147 is a perspective view of a drive side of the cartridge.

Part (a) of FIG. 148 and part (b) of FIG. 148 are cross-sectional views of an image forming apparatus showing a cartridge pressing portion and a positioning portion.

FIG. 149 is a perspective view of a drive transmission member.

FIG. 150 is a sectional view showing a thrust direction movement of the drive transmission member when a coupling is engaged.

FIG. 151 is a cross-sectional view showing peripheral parts of the drive transmission member when the coupling is engaged.

FIG. 152 is a perspective view showing a support structure of a bearing of the drive transmission member on the drive side.

Part (a) of FIG. 153 and part (b) of FIG. 153 are sectional views showing an attitude of the drive transmission member.

FIG. 154 is a cross-sectional view showing the attitude of the drive transmission member when the opening/closing door is open.

Part (a) of FIG. 155 and part (b) of FIG. 155 are perspective views showing a control member of the cartridge.

FIG. 156 is a cross-sectional view showing a tilting movement of the drive transmission member when the cartridge is mounted.

Part (a) of FIG. 157 and part (b) of FIG. 157 are perspective views showing the drive transmission member and a cover portion.

FIG. 158 is a cross-sectional view showing operation of the control member when the cartridge is mounted and dismounted.

FIG. 159 is a top view of a cartridge.

FIG. 160 is a side view of the cartridge.

FIG. 161 is a sectional view of the cartridge.

FIG. 162 is a top view of the cartridge.

FIG. 163 is a perspective view of the cartridge.

FIG. 164 is a cross-sectional view of the cartridge and a main assembly of the image forming apparatus.

FIG. 165 is a cross-sectional view of the cartridge.

FIG. 166 is a perspective view of the cartridge.

FIG. 167 is a perspective view of the cartridge.

FIG. 168 is a cross-sectional view of some parts as viewed from the non-drive side.

FIG. 169 is an illustration showing disposition of a rack gear.

FIG. 170 is an illustration showing the disposition of a rack gear.

FIG. 171 is a side view of the cartridge from the driving side.

Part (a) of FIG. 172 and part (b) of FIG. 172 are side views of a gear portion and a process cartridge as viewed from a driving side.

FIG. 173 is a side view of the cartridge as viewed from the driving side.

Part (a) of FIG. 174 and part (b) of FIG. 174 are cross-sectional views of the apparatus main assembly and a cartridge ZB.

FIG. 175 is a cross-sectional view of some parts as viewed from the non-driving side.

FIG. 176 is a side view of a drive transmission member.

FIG. 177 is a sectional view of an apparatus main assembly and a cartridge.

FIG. 178 is a cross-sectional view of the apparatus main apparatus and the cartridge.

FIG. 179 is a side view of the cartridge as viewed from a driving side.

Part (a) of FIG. 180 and part (b) of FIG. 180 are cross-sectional views of some parts as viewed from the non-driven side.

FIG. 181 is a sectional view of an apparatus main assembly and a cartridge ZB.

FIG. 182 is an enlarged sectional view of one tooth of the gear portion.

FIG. 183 is a sectional view of an apparatus main assembly and a cartridge.

### EMBODIMENTS

### Embodiment 1

An embodiment of the present invention will be described in detail with reference to the accompanying drawings.

A direction of a rotational axis of an electrophotographic photosensitive drum is a longitudinal direction.

In addition, in the longitudinal direction, a side where the electrophotographic photosensitive drum receives a driving force from a main assembly of an image forming apparatus is referred to as a driven side, and the opposite side therefrom is a non-driven side.

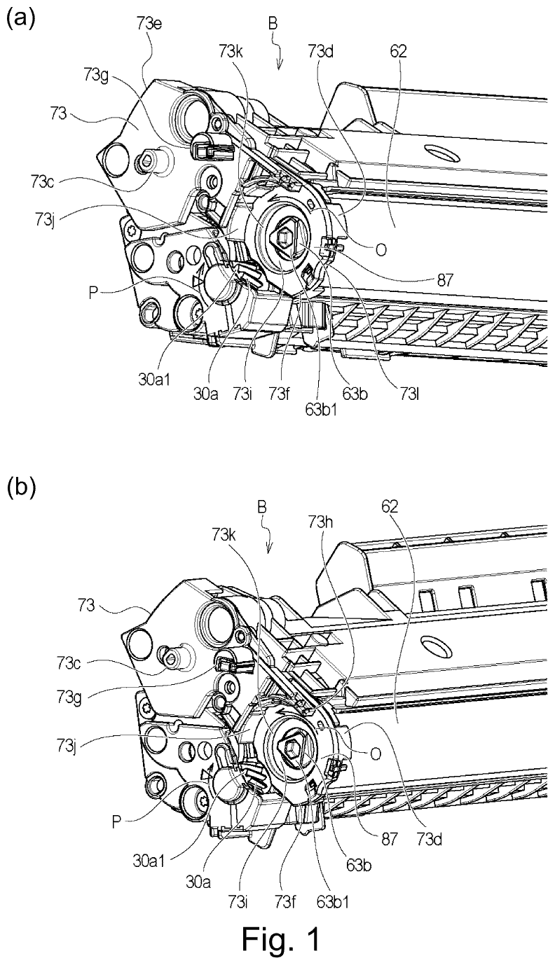

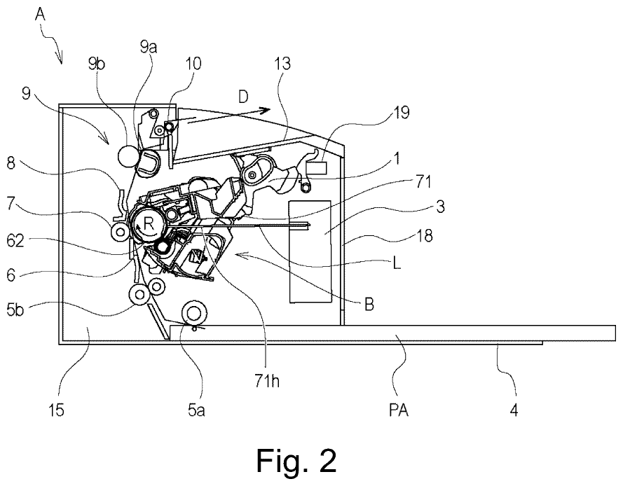

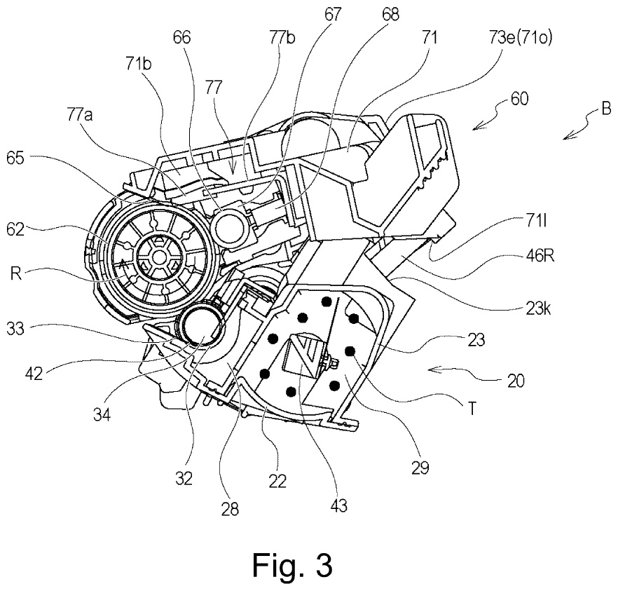

Referring to FIGS. 2 and 3, the overall structure and image forming process will be described.

FIG. 2 is a cross-sectional view of the main assembly (electrophotographic main assembly of the image forming apparatus, main assembly of the image forming apparatus) An of the electrophotographic image forming apparatus, and a process cartridge (hereinafter referred to as cartridge B), according to the embodiment of the present invention.

FIG. 3 is a cross-sectional view of the cartridge B.

Here, the main assembly A of the apparatus is the part of the electrophotographic image forming apparatus excluding the cartridge B.

### <Overall Structure of Electrophotographic Image Forming Apparatus>

The electrophotographic image forming apparatus (image forming apparatus) shown in FIG. 2 is a laser beam printer using electrophotographic process in which cartridge B is detachably attached to the main assembly A of the apparatus. An exposure device 3 (laser scanner unit) is disposed to form a latent image on the electrophotographic photosensitive drum 62 as an image bearing member of cartridge B when cartridge B is attached to the main assembly A of the apparatus. In addition, a sheet tray 4 is disposed below the cartridge B, which stores a recording material (hereinafter referred to as sheet material PA) to be used for image formation. The electrophotographic photosensitive drum 62 is a photosensitive member (electrophotographic photosensitive member) used for electrophotographic image formation.

Furthermore, in the apparatus main assembly A, there are a pick-up roller 5a, a pair of feeding rollers 5b, a pair of conveying rollers 5c, a transfer guide 6, a transfer roller 7, a feeding guide 8, a fixing device 9, a pair of discharge rollers 10, a discharge tray 11, and so on this order along the feeding direction D of the sheet material PA. The fixing device 9 comprises a heating roller 9a and a pressure roller 9b.

### <Image Forming Process>

Next, an outline of the image forming process will be described. Based on a print start signal, the electrophotographic photosensitive drum (hereinafter, photosensitive drum 62 or simply drum 62) is rotated and driven at a predetermined peripheral speed (process speed) in the direction of the arrow R.

The charging roller (charging member) 66 to which a bias voltage is applied contacts an outer peripheral surface of the drum 62 and uniformly charges the outer peripheral surface of the drum 62.

The exposure device 3 outputs a laser beam L corresponding to the image information. The laser beam L passes through a laser opening 71h provided in a cleaning frame 71 of the cartridge B, and scans and exposes the outer peripheral surface of the drum 62. By this, an electrostatic latent image corresponding to the image information is formed on the outer peripheral surface of the drum 62.

On the other hand as shown in FIG. 3, in the developing unit 20 as a developing device, a toner T in a toner chamber 29 is stirred and fed by the rotation of the feeding member (stirring member) 43, and is supplied out to the toner supply chamber 28.

The toner T is carried on a surface of the developing roller 32 by a magnetic force of a magnet roller 34 (fixed magnet). The developing roller 32 is a developer carrying member for carrying the developer (toner T) on the surface thereof in order to develop the latent image formed on the drum 62.

The toner T is frictionally charged, and a layer thickness of the toner on the peripheral surface of the developing roller 32 as a developer carrying member is regulated, by the developing blade 42.

The toner T is supplied to the drum 62 in accordance with the electrostatic latent image, and develops the latent image. As a result, the latent image is visualized into a toner image. The drum 62 is an image carrying member for carrying the latent image and the image (toner image, developer image) formed with the toner on its surface. As shown in FIG. 2, a sheet material PA stored in a lower part of the device main assembly A is supplied out from the sheet tray 4 by the pickup roller 5a, the pair of feeding rollers 5b, and the pair of conveying rollers 5c, in accordance with the output timing of the laser light L. Then, the sheet material PA is conveyed to a transfer position between the drum 62 and the transfer roller 7 by way of a transfer guide 6. At this transfer position, the toner image is sequentially transferred from the drum 62 onto the sheet material PA.

The sheet material PA onto which the toner image has been transferred is separated from the drum 62 and conveyed along the feeding guide 8 to the fixing device 9. Then, the sheet material PA passes through a nip portion between the heating roller 9a and the pressure roller 9b which constitute the fixing device 9. In this nip portion, a pressure and heat fixing process is performed, and the toner image is fixed to the sheet material PA. The sheet material PA on which the toner image has been fixed is fed to the discharge roller pair 10 to be discharged onto the discharge tray 11.

On the other hand, as shown in FIG. 3, residual toner on the outer peripheral surface of the drum 62 after the image transfer is removed by a cleaning member 77, and is reused in the image forming process. The toner removed from the drum 62 is stored in the waste toner chamber 71b of the cleaning unit 60. The cleaning unit 60 is a unit including the drum 62.

In the foregoing, the charging roller 66, the developing roller 32, the transfer roller 7, and the cleaning member 77 are the process means which ate actable on the drum 62.

### <Overall Cartridge Structure>

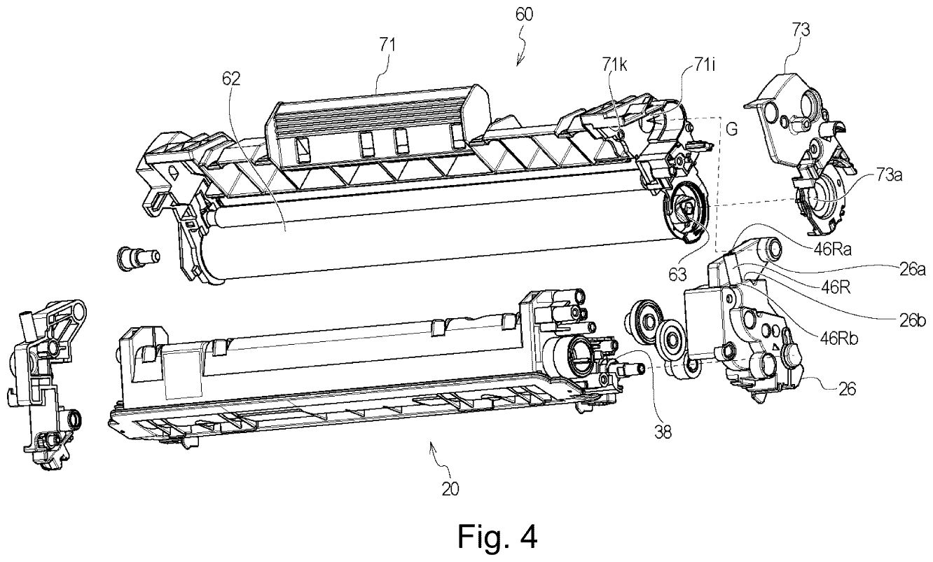

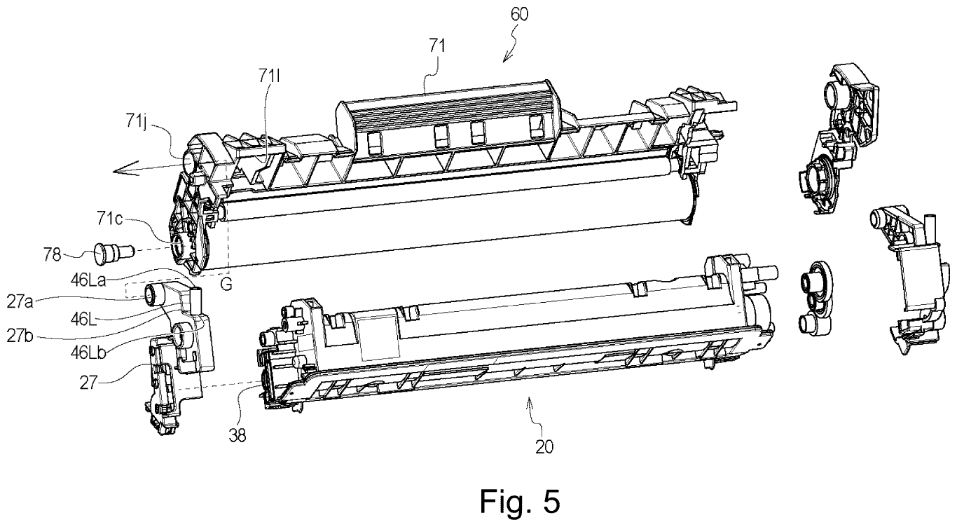

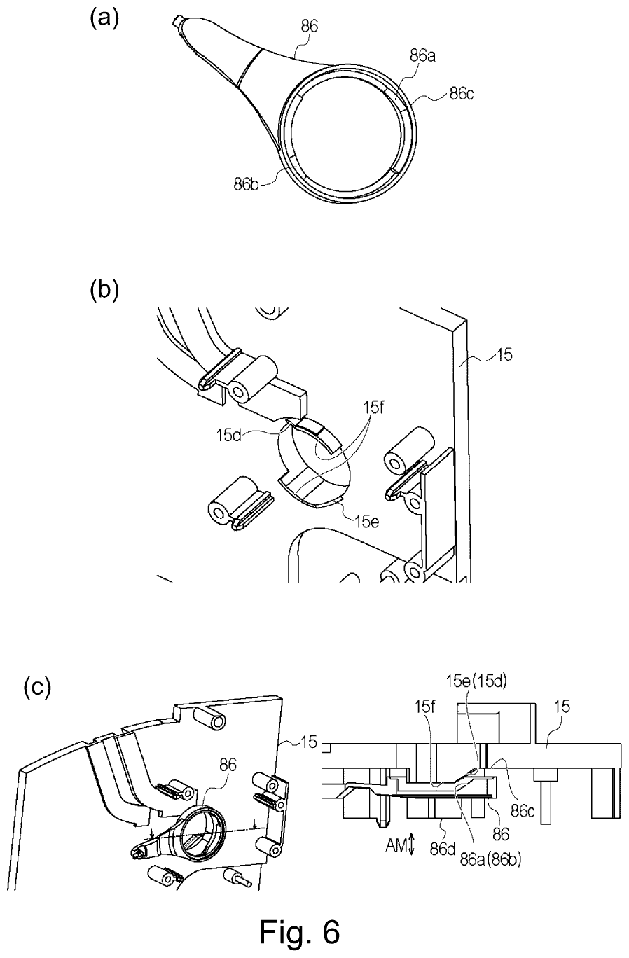

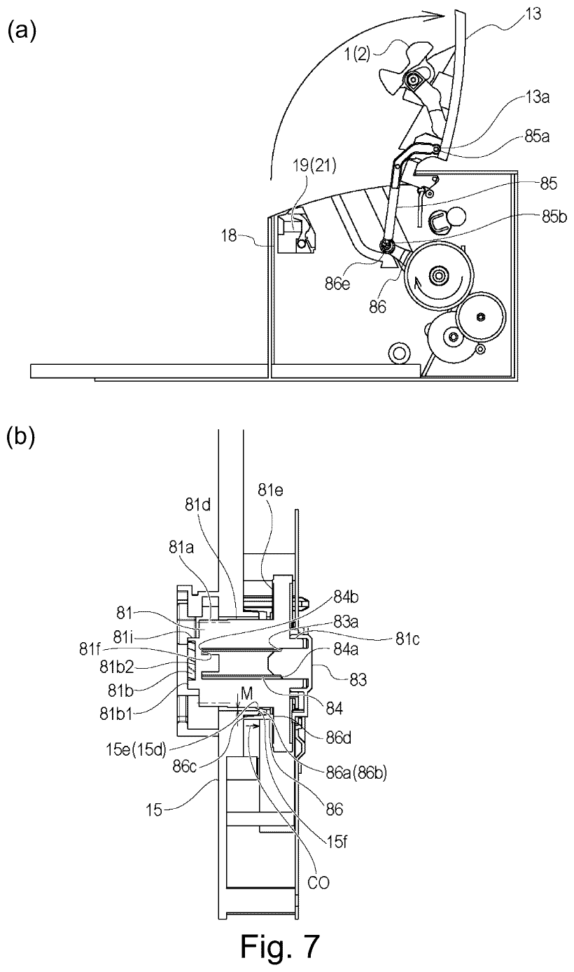

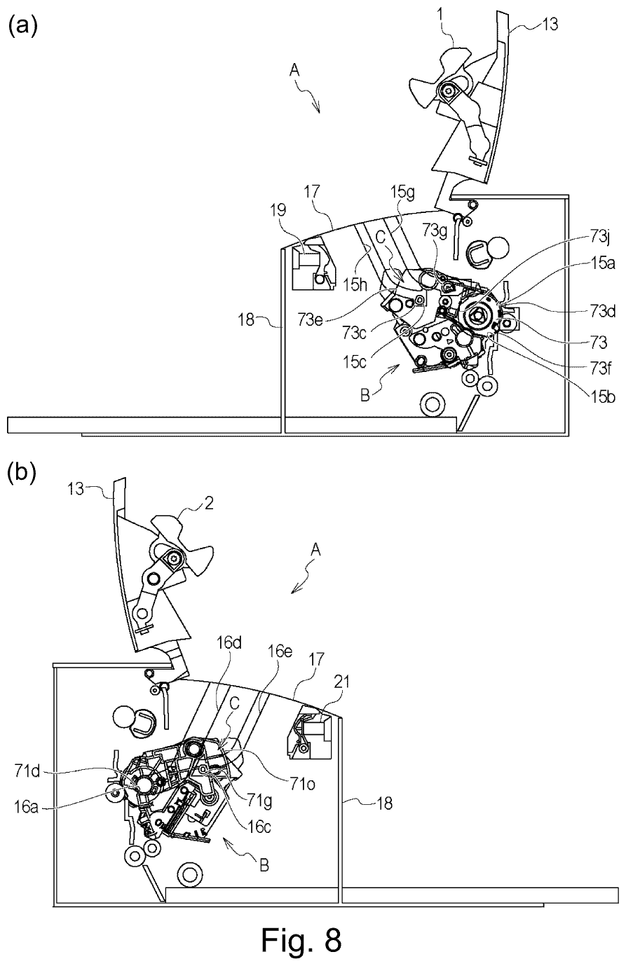

Next, referring to FIG. 3, FIG. 4, and FIG. 5, the overall structure of the cartridge B will be described. FIG. 3 is a cross-sectional view of the cartridge B, and FIG. 4 and FIG. 5 are perspective views illustrating the structure of the cartridge B. In this embodiment, the screws used to connect the various parts will be omitted.

The cartridge B comprises a cleaning unit (photosensitive member holding unit, drum holding unit, image bearing member holding unit) 60 and a developing unit (developer carrier holding unit) 20. One of the cleaning unit 60 and the developing unit 20 may be called a first unit, and the other may be called a second unit.

Generally, a process cartridge is a cartridge in which the electrophotographic photosensitive member and at least one process means actable on the electrophotographic photosensitive member are integrated into one cartridge, and the cartridge is detachable from the main assembly (apparatus main assembly of an electrophotographic image forming apparatus. Examples of the process means include the charging means, the developing means, and the cleaning means. In this embodiment, each electrophotographic photosensitive member and the process means are supported by the cartridge frame.

As shown in FIG. 3, the cleaning unit 60 includes the drum 62 as the electrophotographic photosensitive member, the charging roller 66 as the charging means, cleaning member 77 as the cleaning means, and the cleaning frame 71 which supports these members. On the driving side of the drum 62, a driving side drum flange 63 provided on the driving side is rotatably supported by a hole 73a of a drum bearing 73. In a broad sense, the drum bearing 73 and the cleaning frame 71 can be collectively called the cleaning frame. The drum bearing 73 and the cleaning frame 71 are the frame of the cleaning unit 60. The drum bearing 73 and the cleaning frame 71 are also part of the frame of the cartridge. The drum 62 is rotatably supported by the frame.

As shown in FIG. 5, on the non-driving side, the hole (not shown) of the non-driving side drum flange is rotatably supported by a drum shaft 78 press-fitted into the hole 71c provided in the cleaning frame 71.

Each drum flange is a borne part which is rotatably supported by a bearing portion.

In the cleaning unit 60, the charging roller 66 and the cleaning member 77 are arranged in contact with the outer circumferential surface of the drum 62.

The cleaning member 77 includes a rubber blade 77a, which is a blade-shaped elastic member made of rubber as an elastic material, and a support member 77b which supports the rubber blade. The rubber blade 77a abuts against the drum 62 in a counter direction to the rotational direction of the drum 62. That is, the rubber blade 77a abuts against the drum 62 so that its free end surface faces the upstream side of the rotational direction of the drum 62.

As shown in FIG. 3, the waste toner removed from the surface of the drum 62 by the cleaning member 77 is stored in a waste toner chamber 71b defined by the cleaning frame 71 and the cleaning member 77.

Also, as shown in FIG. 3, a reception sheet 65 for preventing waste toner from leaking from the cleaning frame 71 is provided on an edge of the cleaning frame 71 so as to abut against the drum 62.

The charging roller 66 is rotatably mounted in the cleaning unit 60 by way of charging roller bearings (not shown) at the opposite ends in the longitudinal direction of the cleaning frame 71.

The longitudinal direction of the cleaning frame 71 (the longitudinal direction of the cartridge B) is approximately parallel to the direction in which the rotational axis of the drum 62 extends (axial direction). Therefore, hereinafter, when the “longitudinal direction” or “axial direction” is referred to without any special statement, the axial direction of the drum 62 is intended.

The charging roller 66 is pressed against the drum 62 by a charging roller bearing 67 being pressed toward the drum 62 by an urging member 68. The charging roller 66 is rotated by rotation of the drum 62.

As shown in FIG. 3, the developing unit 20 includes the developing roller 32, a developing container 23 supporting the developing roller 32, the developing blade 42, and so on. The developing roller 32 is rotatably mounted in the developing container 23 by bearing members 27 (FIG. 5) and 37 (FIG. 4) provided at the opposite ends thereof. The developing container 23, the bearing members 27, and the bearing members 37 are the frame of the developing unit 20. The developing container 23, the bearing members 27, and the bearing members 37 are also parts of the frame of the cartridge, as are the drum bearing 73 and the cleaning frame 71.

One of the frames of the cleaning unit 60 and the frame of the developing unit 20 may be called a first frame, and the other may be called a second frame. The frame of the cleaning unit 60 and the frame of the developing unit 20 may be collectively referred to simply as the frame. In this embodiment, the frame of the cartridge is divided into the frame of the cleaning unit 60 and the frame of the developing unit 20, but this is not necessarily limited to such a structure. The frame of the cartridge may comprise two or more frames, or may not be separable into a plurality of frames.

In the developing roller 32, a magnet roller 34 is provided. In the developing unit 20, the developing blade 42 is disposed to restrict a toner layer on the developing roller 32. As shown in FIGS. 4 and 5, the developing roller 32 is provided with a spacing members 38 at the opposite end portions thereof, and the spacing members 38 contact the drum 62, so that the developing roller 32 is held with a small gap between the drum 62 and the developing roller 32. As shown in FIG. 3, a blowout prevention sheet 33 for preventing toner from leaking from the developing unit 20 is provided on the edge of the bottom member 22 so as to be in contact with the developing roller 32. In addition, a feeding member 43 is provided in the toner chamber 29 defined by the developing container 23 and the bottom member 22. The feeding member 43 stirs the toner contained in the toner chamber 29 and transports the toner into the toner supply chamber 28.

As shown in FIGS. 4 and 5, the cartridge B is constituted by combining the cleaning unit 60 and the developing unit 20.

When combining the developing unit and the cleaning unit, the center of the first developer support boss 26a of the developing container 23 is first aligned relative to the first hanging hole 71i on the drive side of the cleaning frame 71, with the center of the second development support boss 23b relative to the second hanging hole 71j on the non-drive side. Specifically, by moving the developing unit 20 in the direction of arrow G, the first developer support boss 26a and the second development support boss 23b fit into the first hanging hole 71i and the second hanging hole 71j. By this, the developing unit 20 is movably connected to the cleaning unit 60. More specifically, the developing unit 20 is rotatably (pivotably) connected to the cleaning unit 60. Thereafter, the drum bearing 73 is attached to the cleaning unit 60 to form the cartridge B.

In addition, a first end 46La of the driving side urging member 46L is fixed to the surface 23c of the developing container 23, and a second end 46Lb abuts against the surface 71k that is a part of the cleaning unit.

Further, a first end 46Ra of a non-driving side urging member 46R is fixed to the surface 23k of the developing container 23, and a second end 46Rb thereof abuts against a surface 71l which is a part of the cleaning unit.

In this embodiment, the driving side urging member 46L (FIG. 5) and the non-driving side urging member 46R (FIG. 4) are in the form of compression spring. The urging forces of these springs allow the driving side urging member 46L and the non-driving side urging member 46R to urge the developing unit 20 against the cleaning unit 60, thereby reliably pressing the developing roller 32 toward the drum 62. And, the developing roller 32 is held at a predetermined distance from the drum 62 by the spacing members 38 attached at opposite end portions of the developing roller 32.

### <Cartridge Mounting>

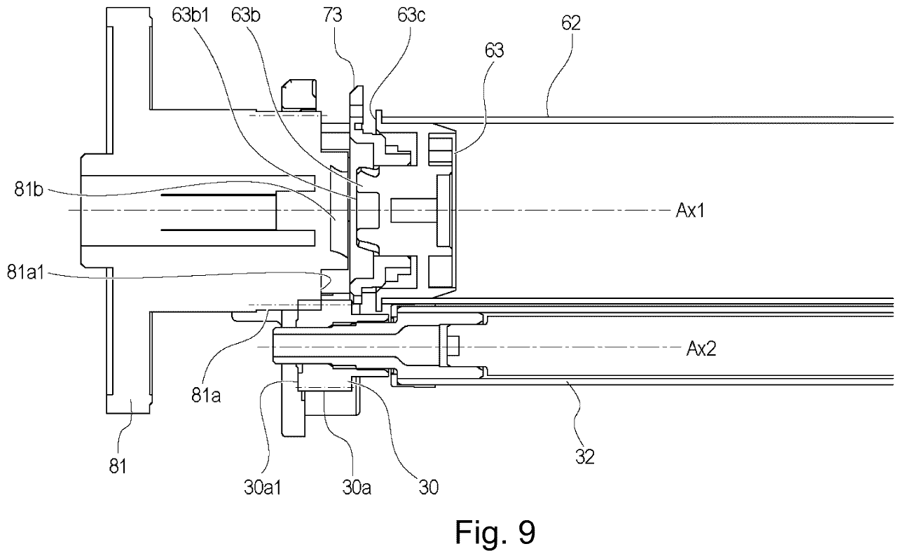

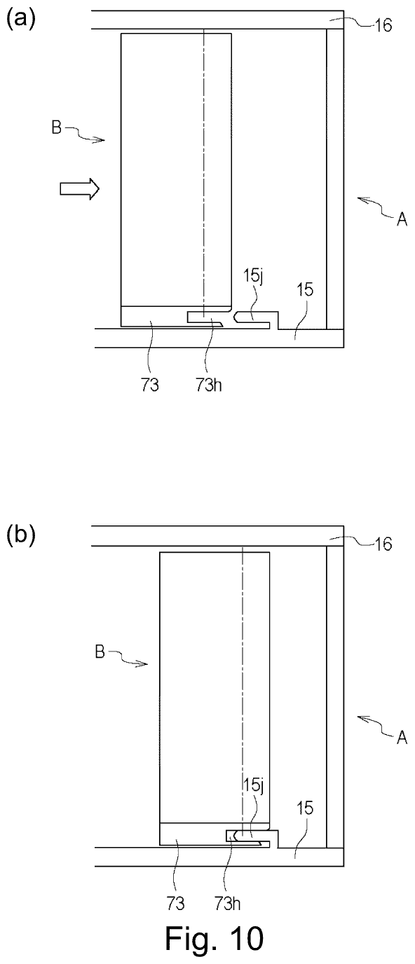

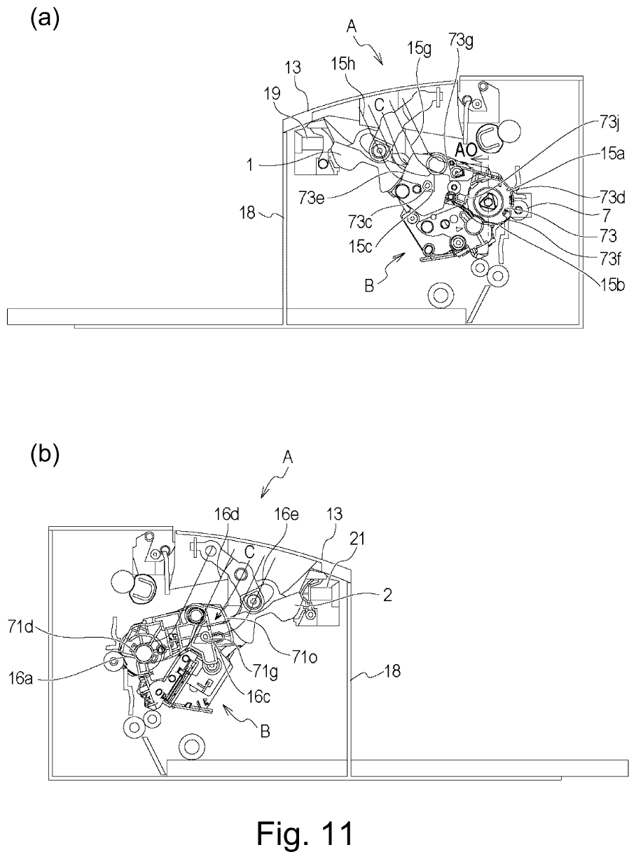

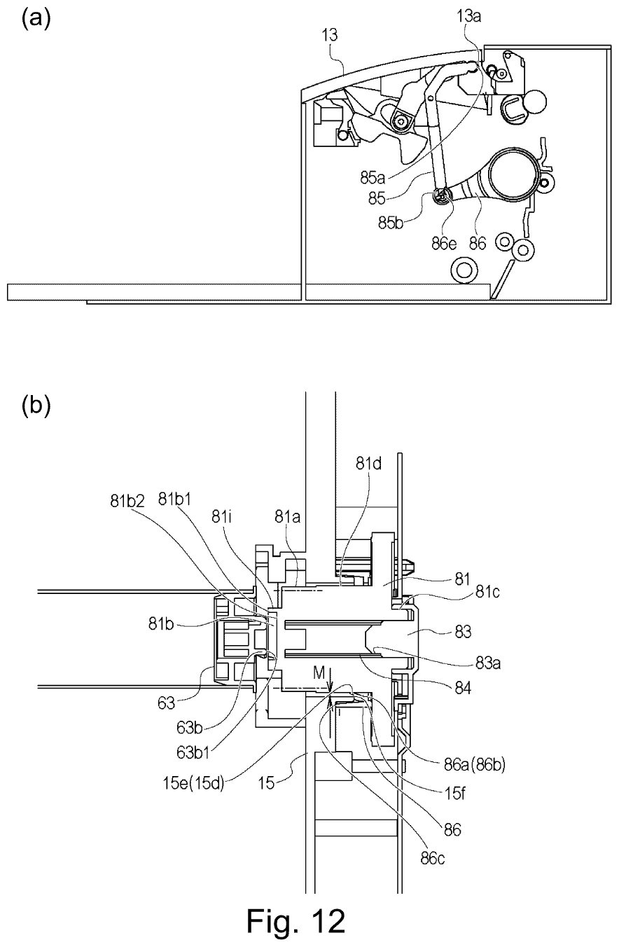

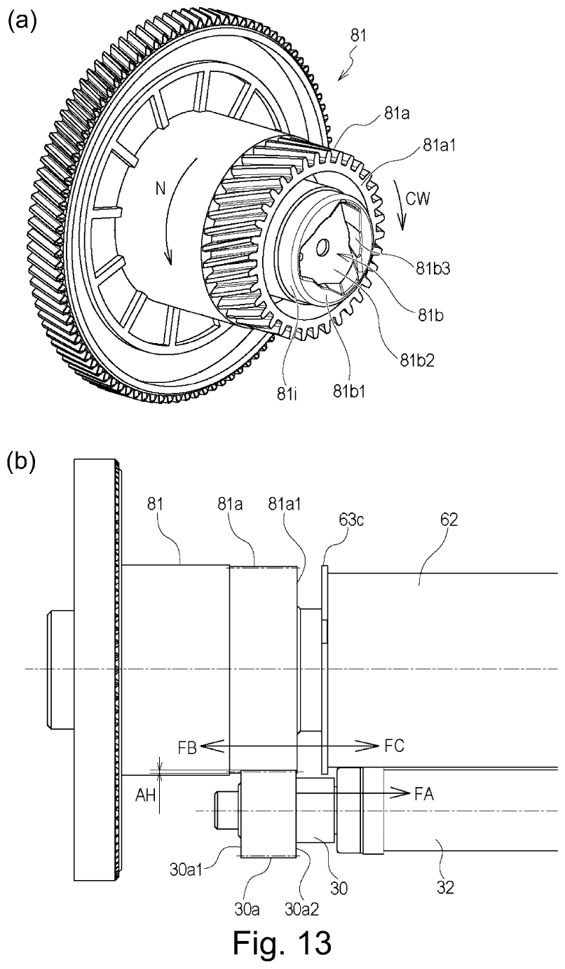

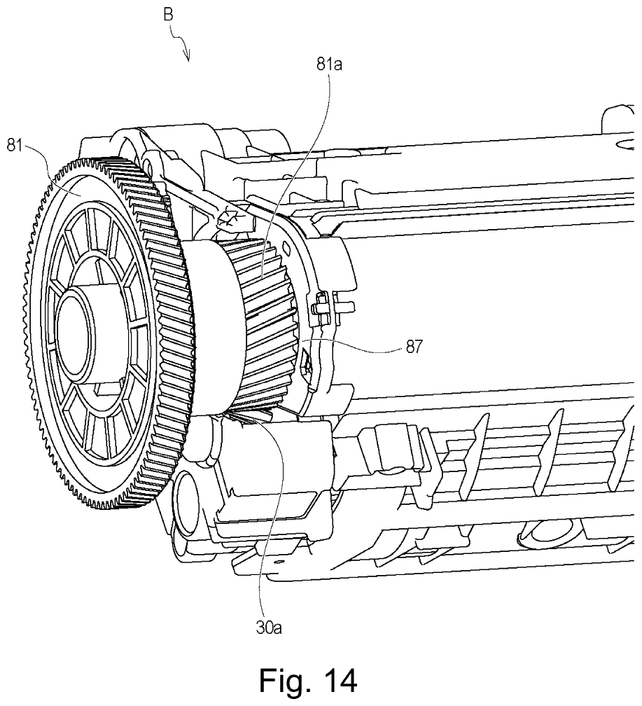

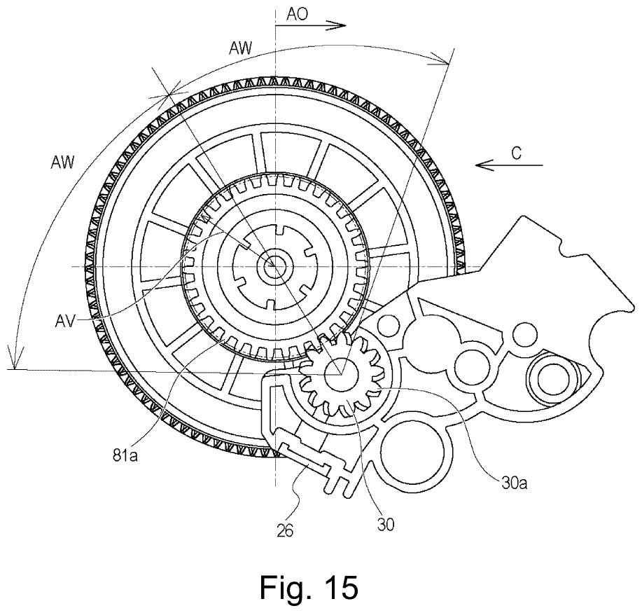

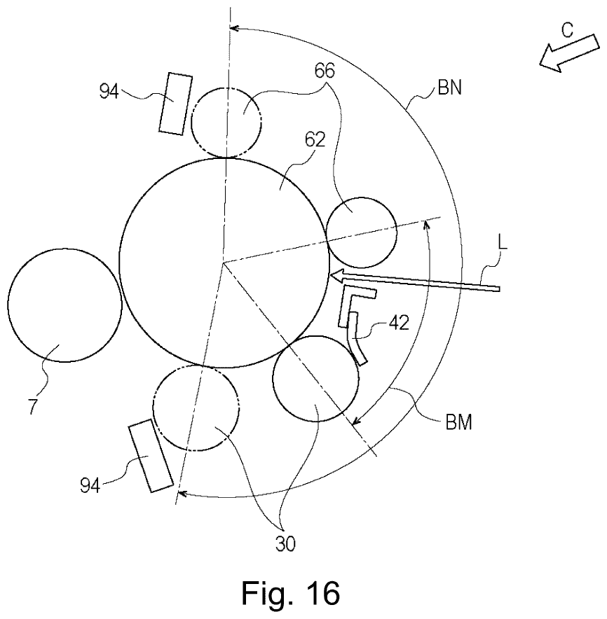

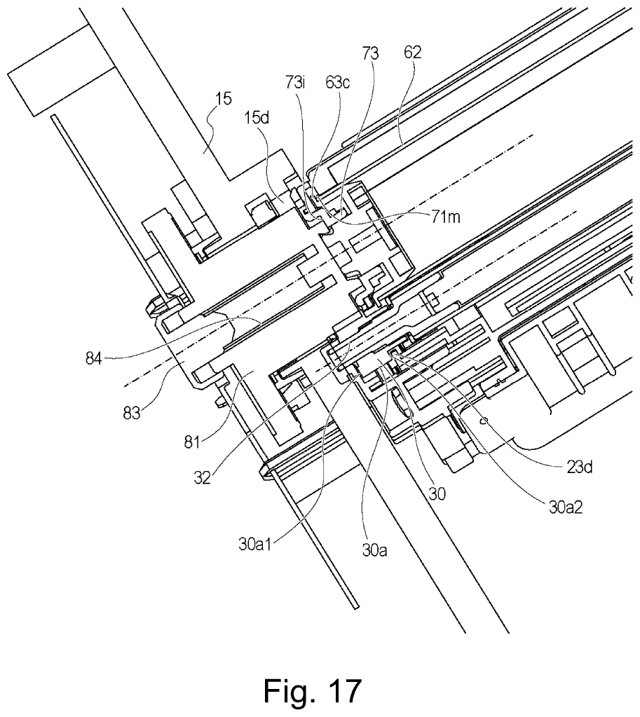

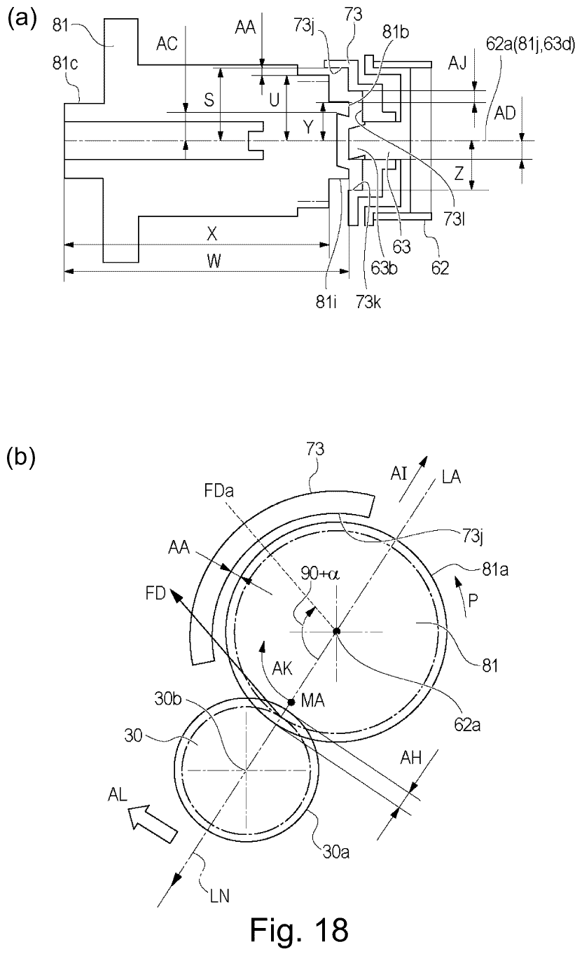

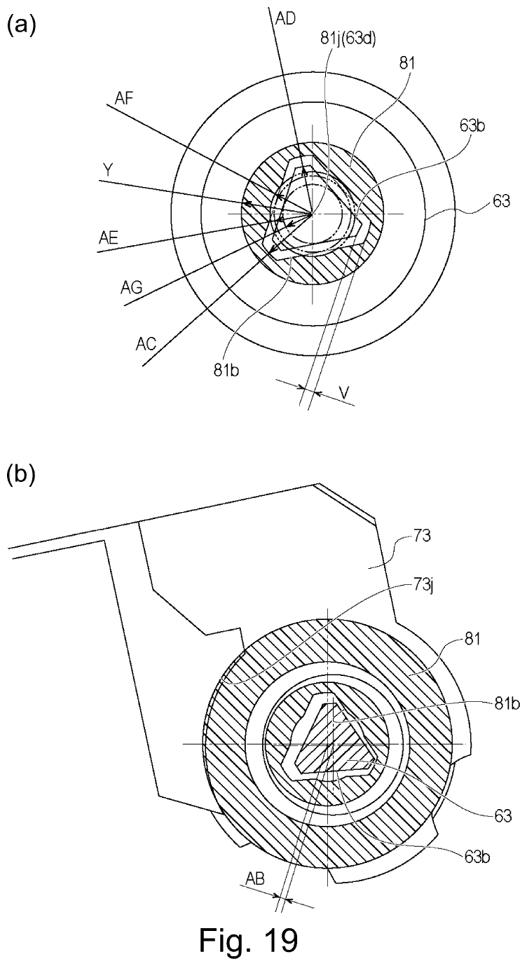

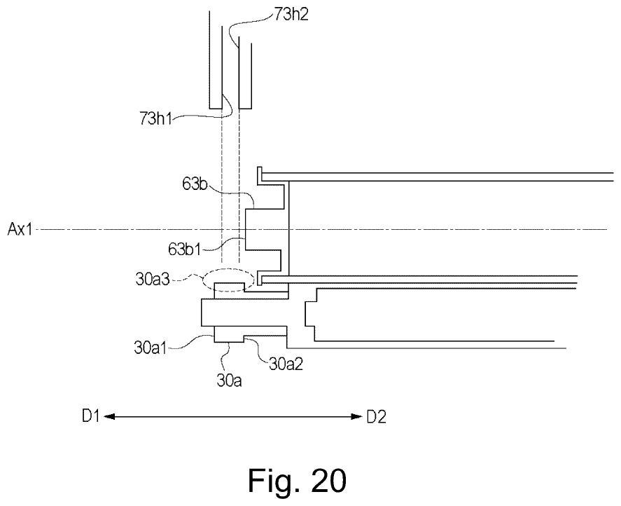

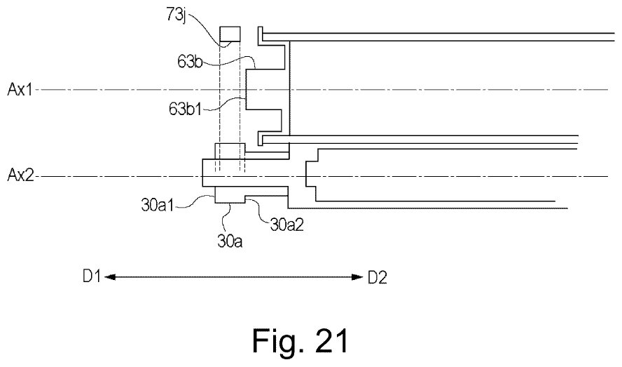

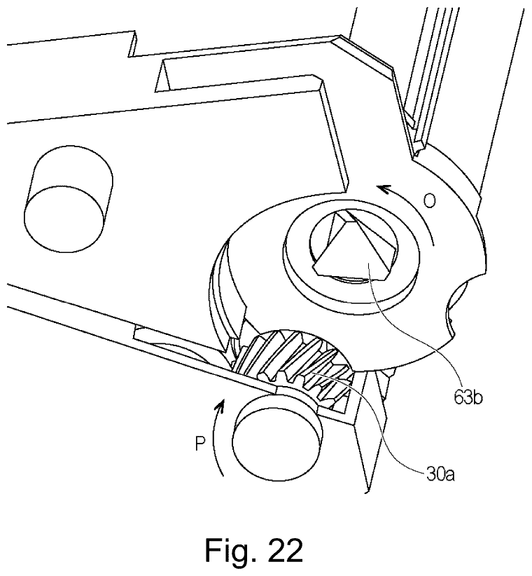

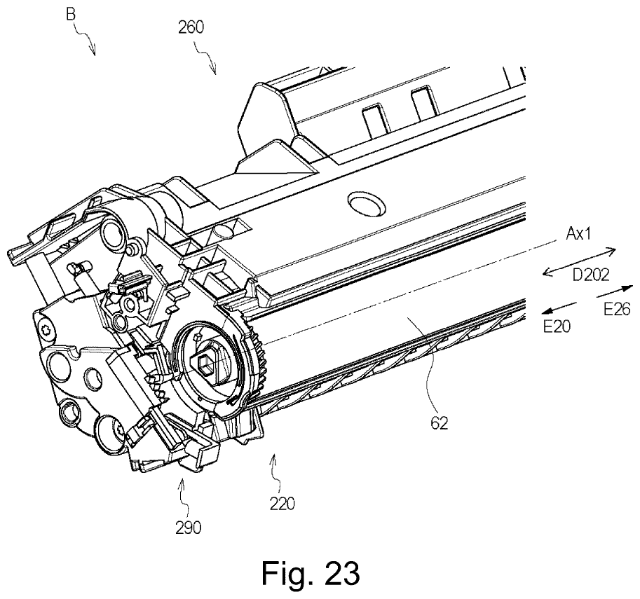

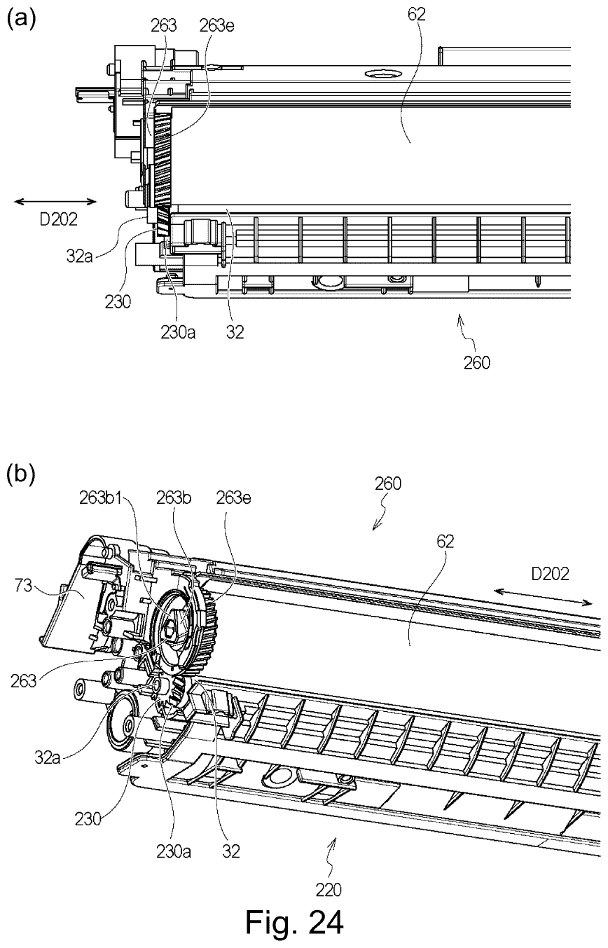

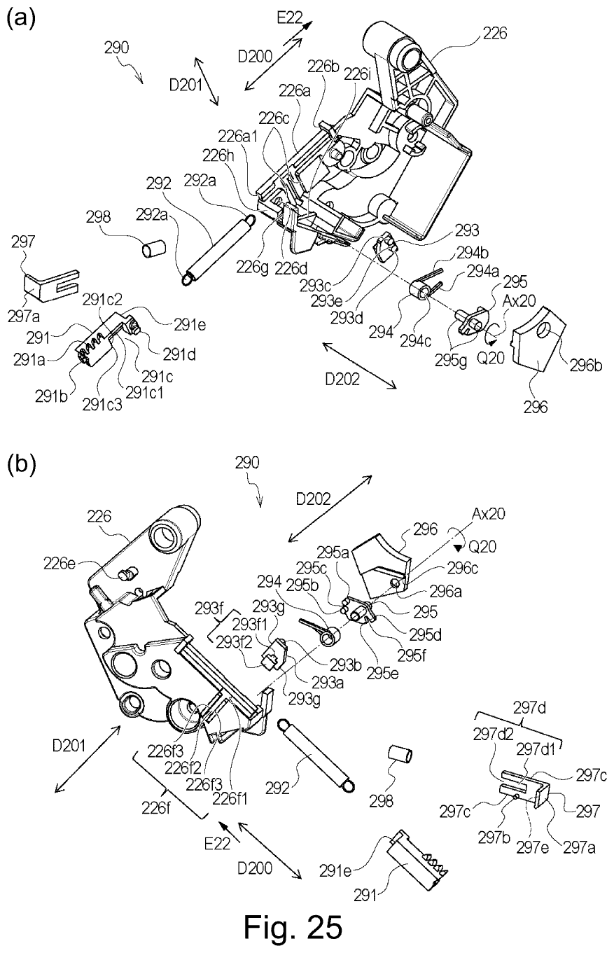

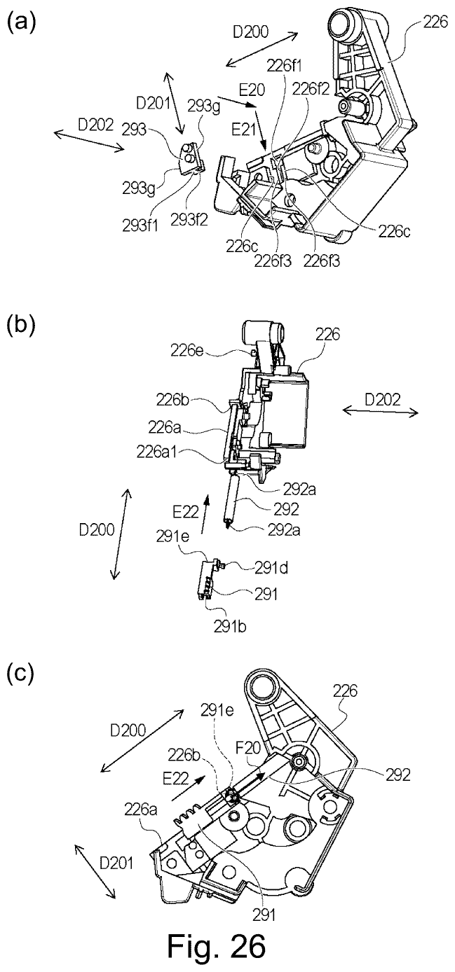

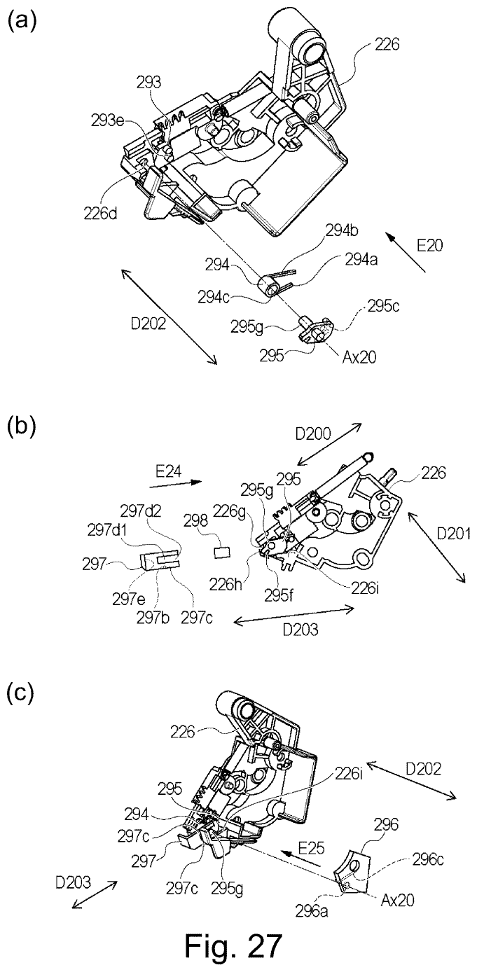

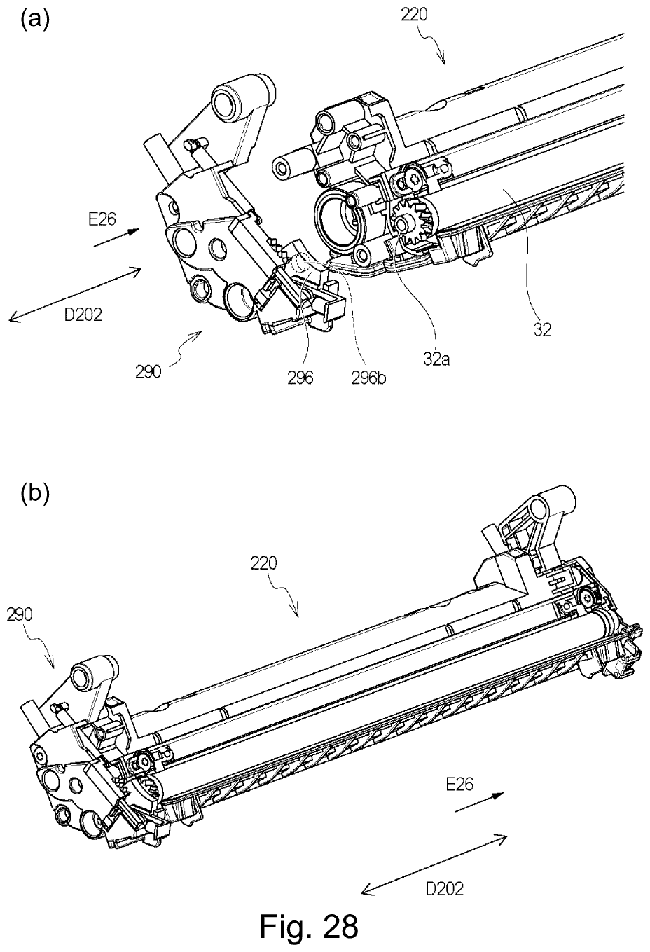

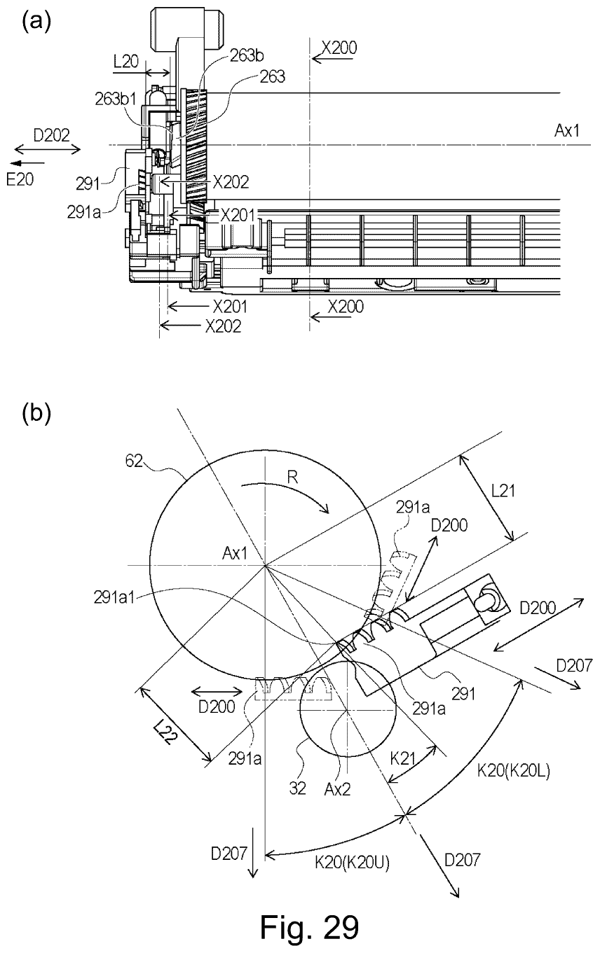

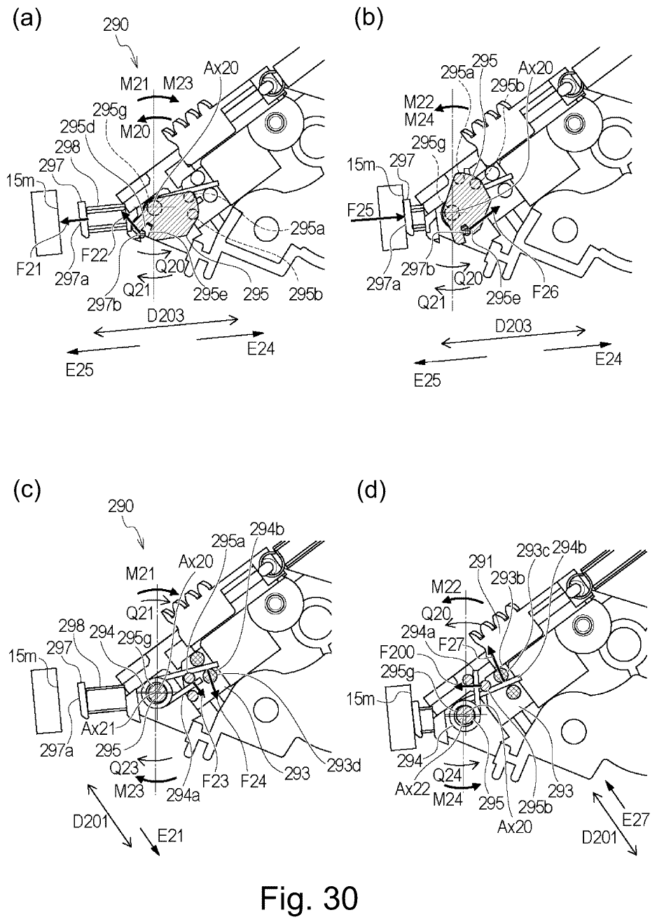

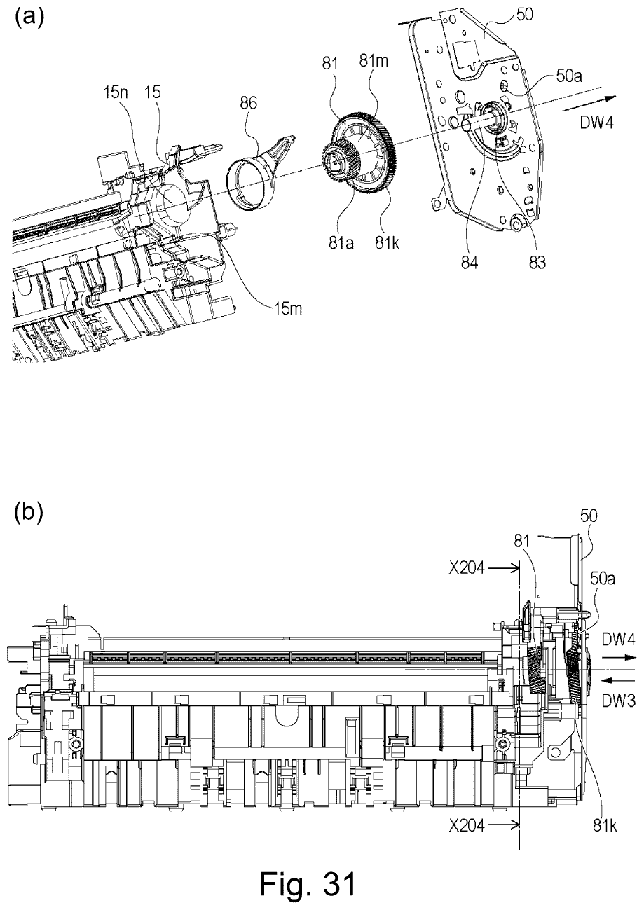

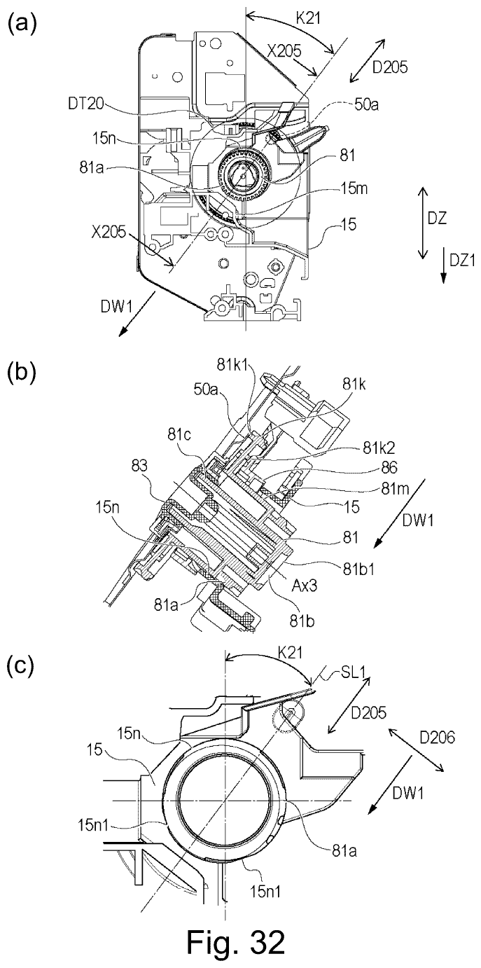

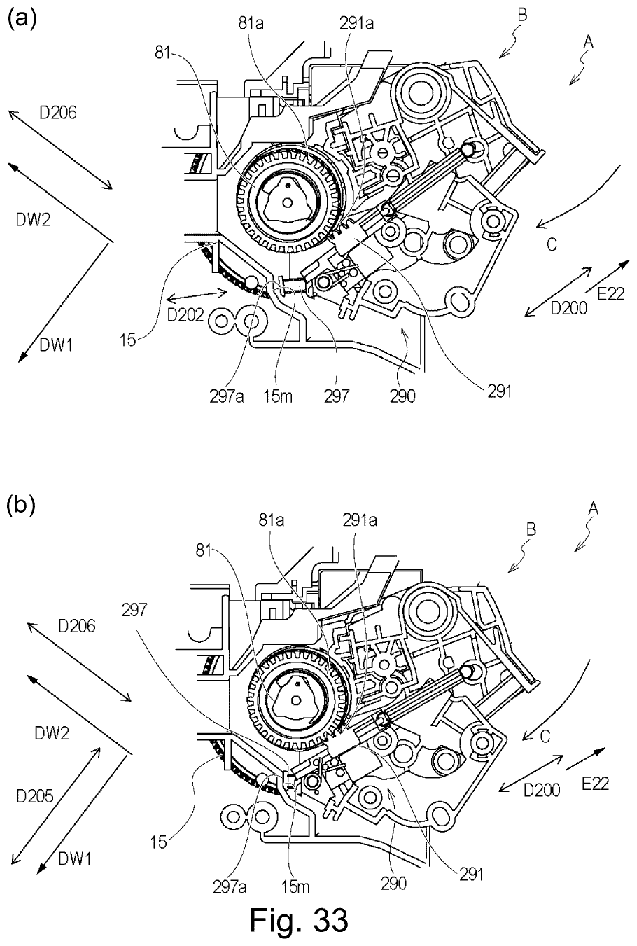

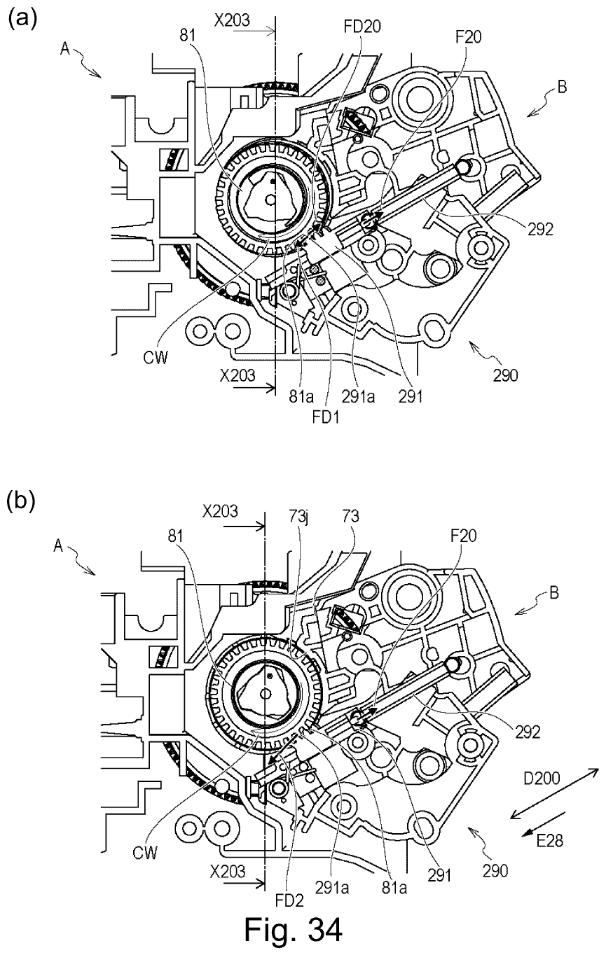

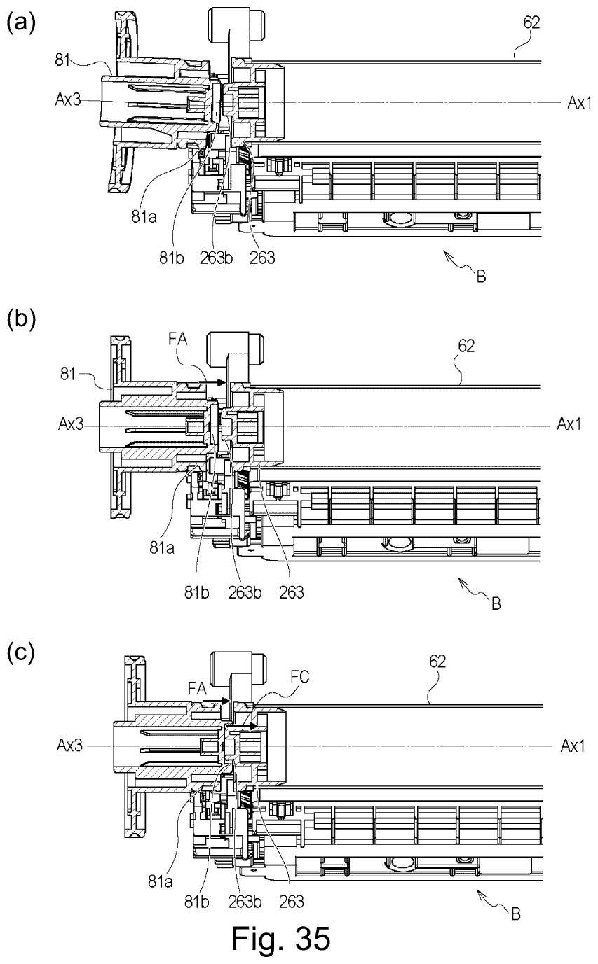

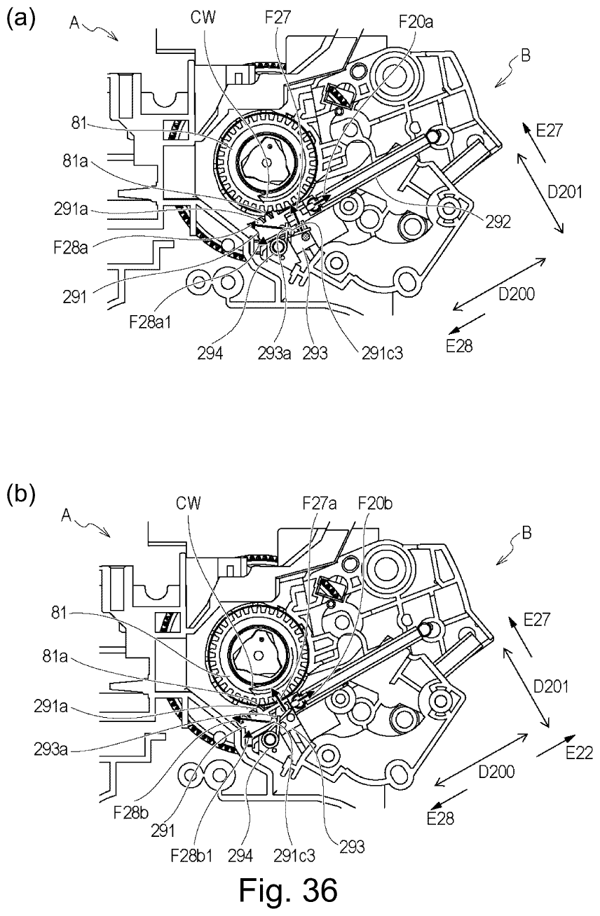

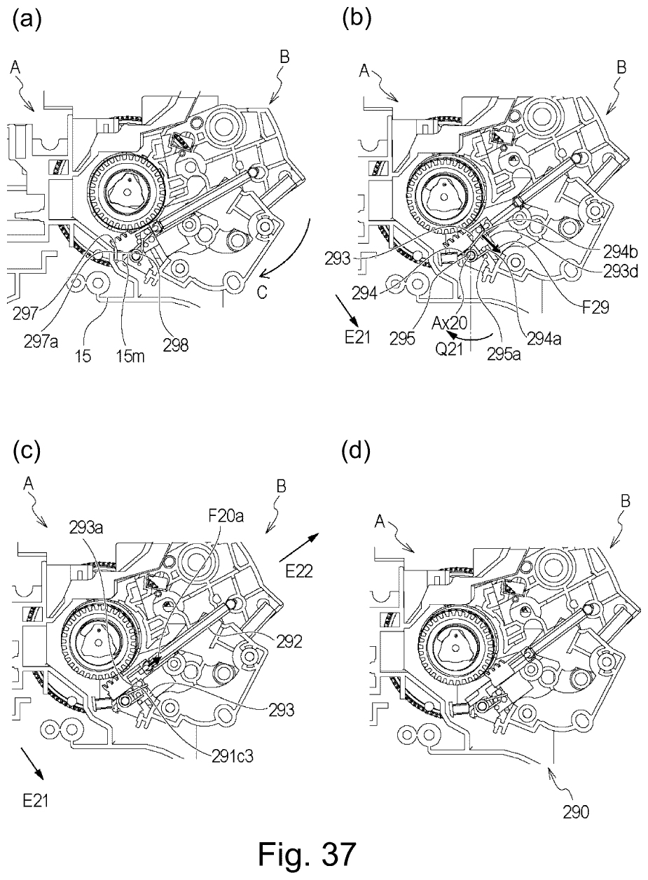

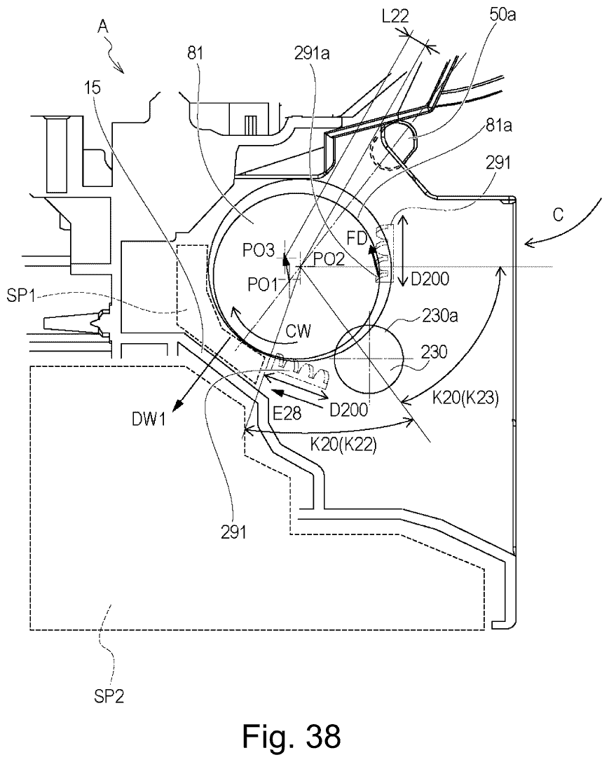

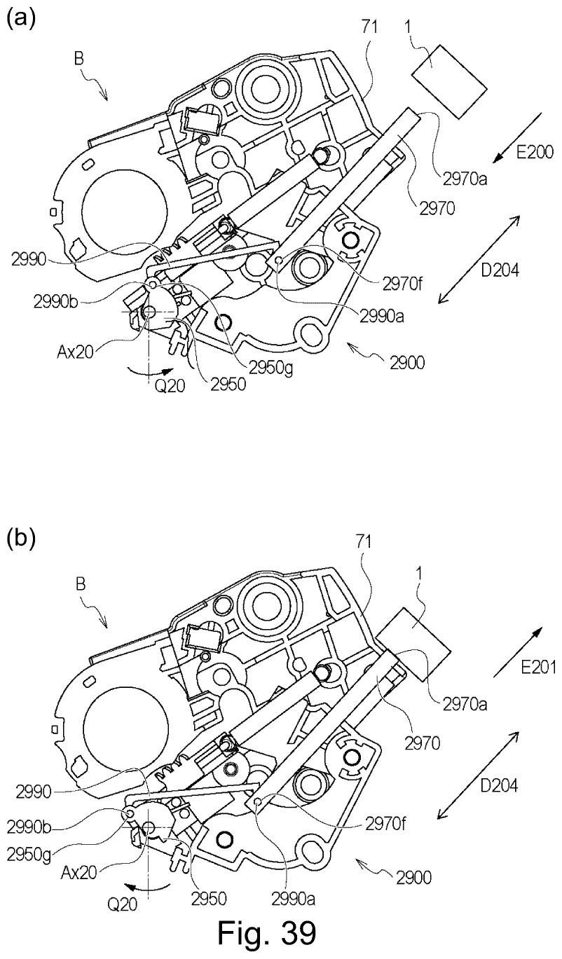

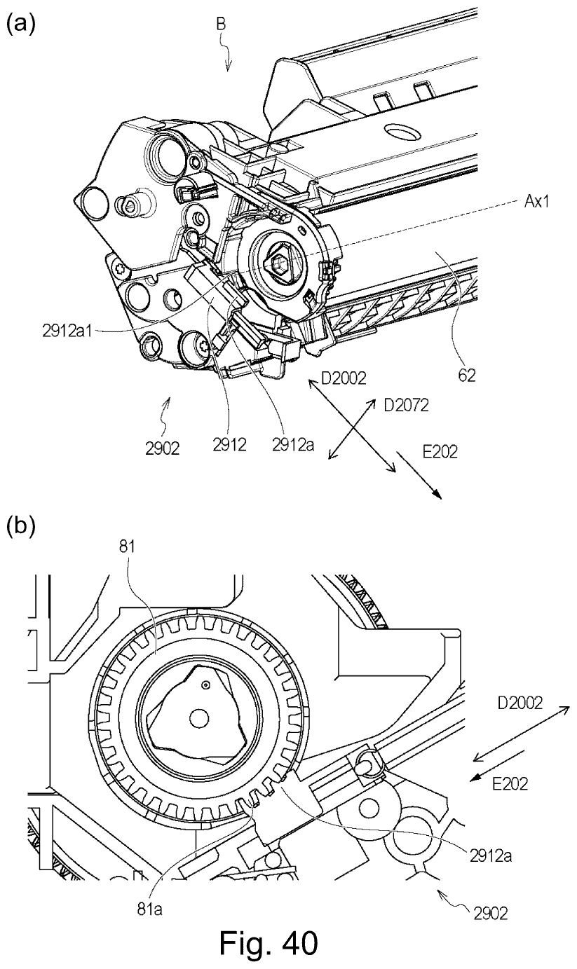

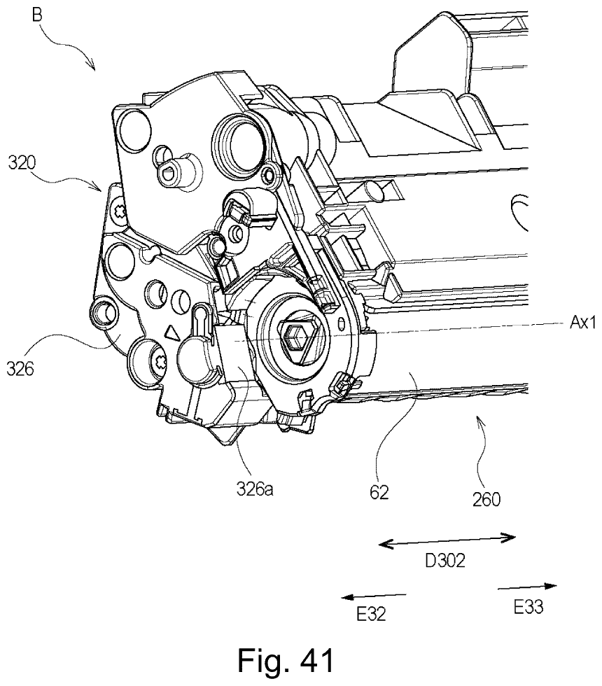

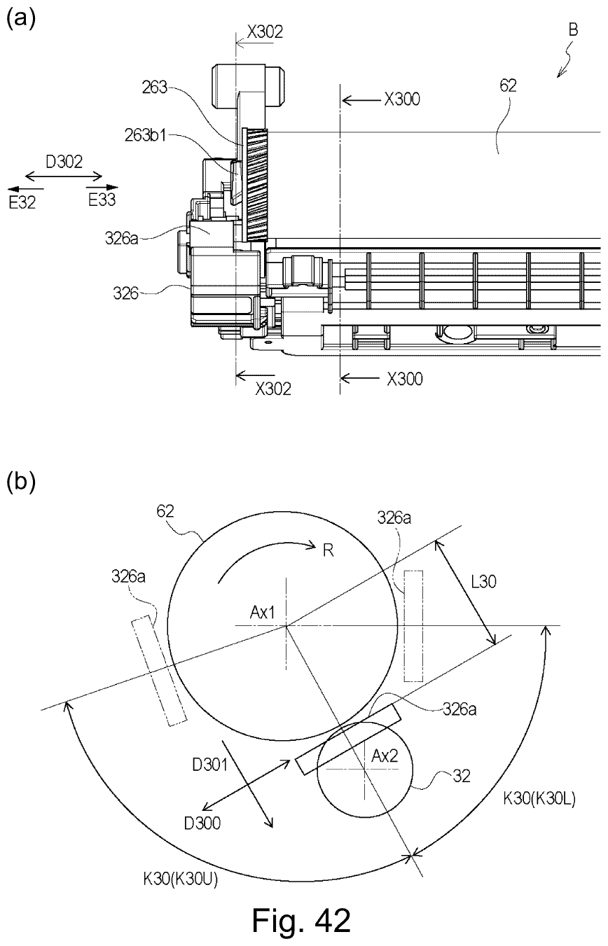

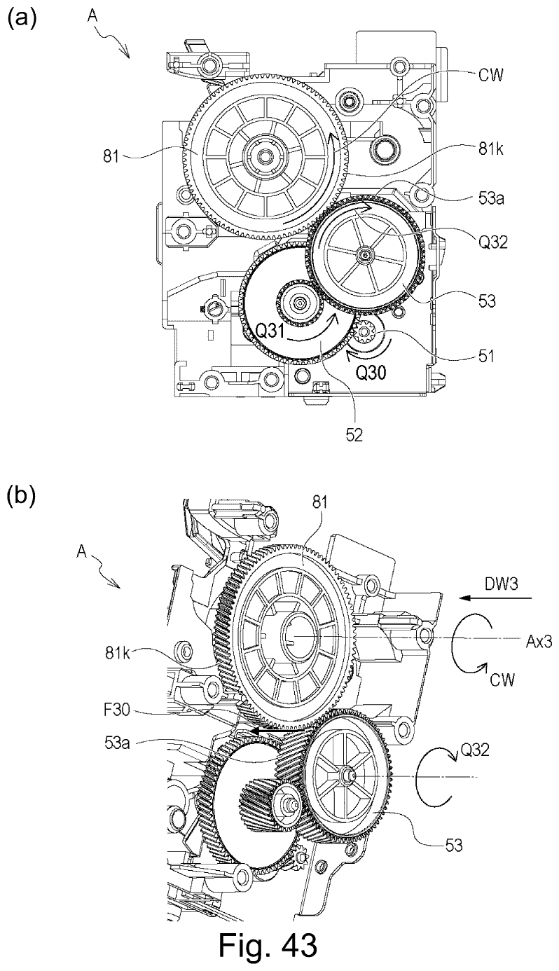

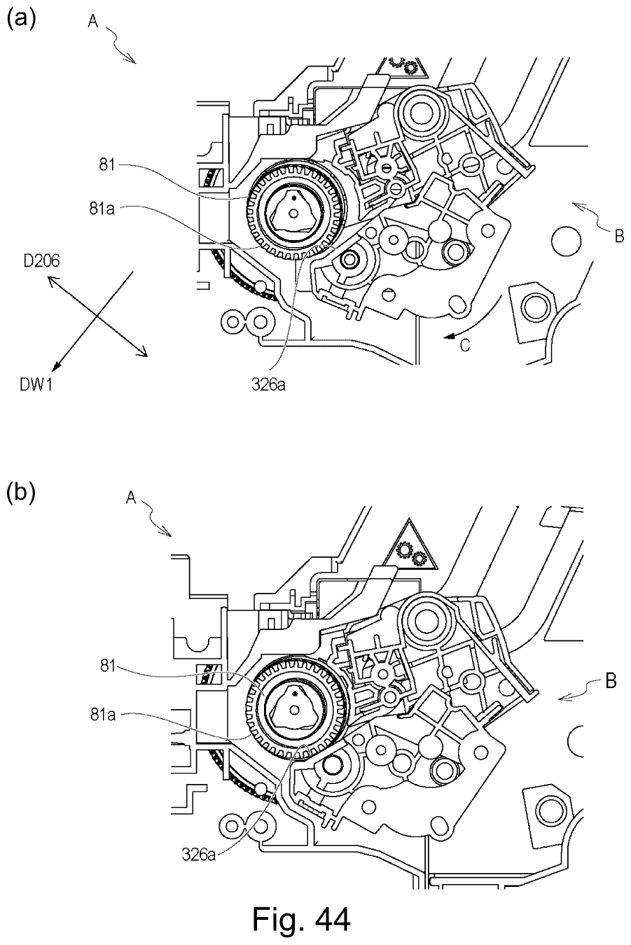

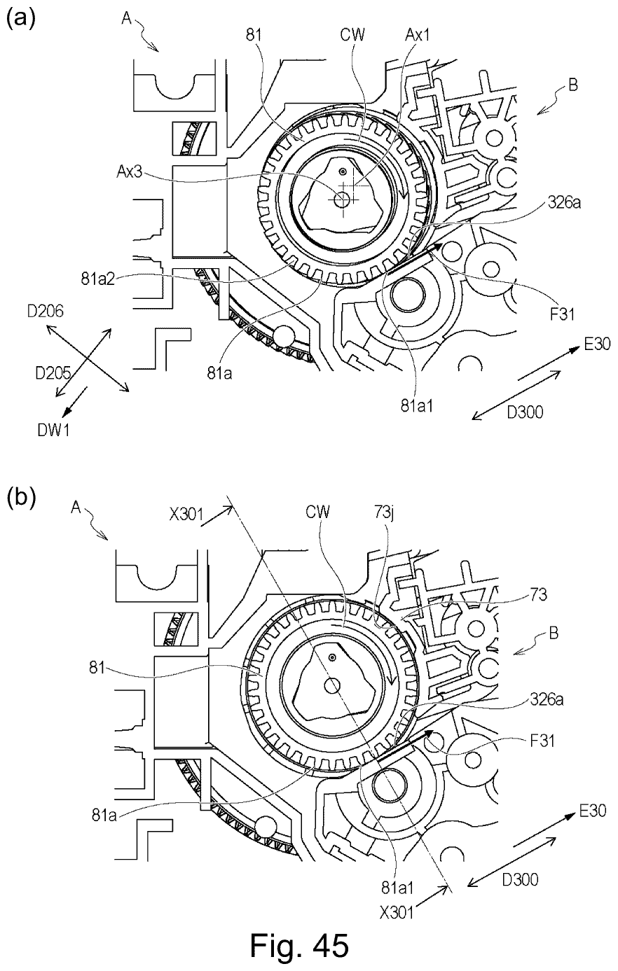

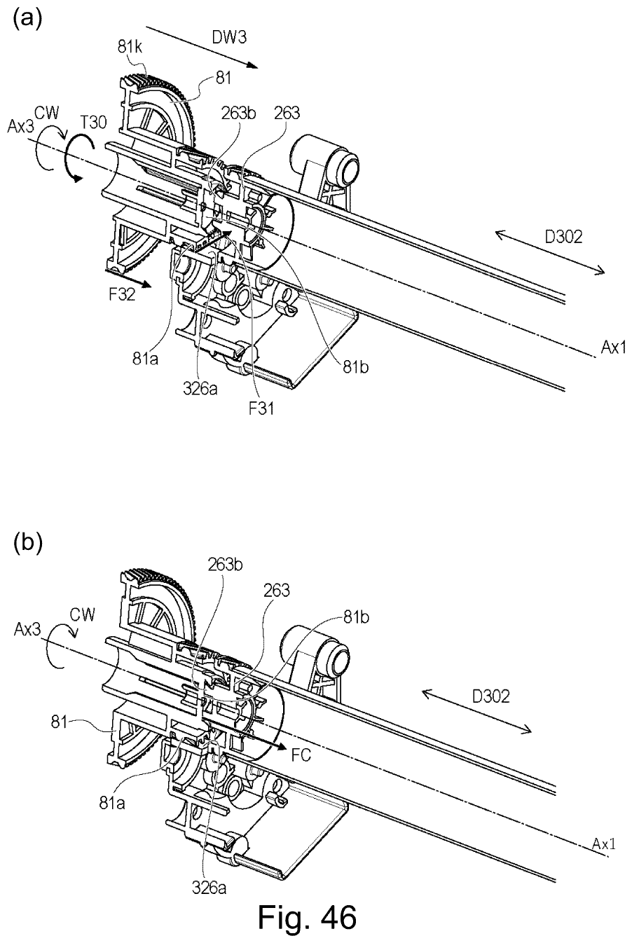

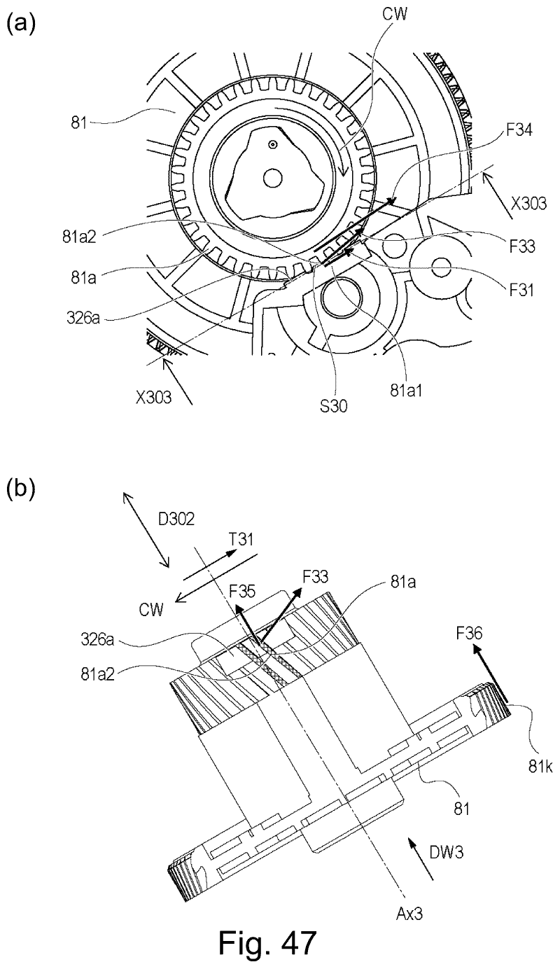

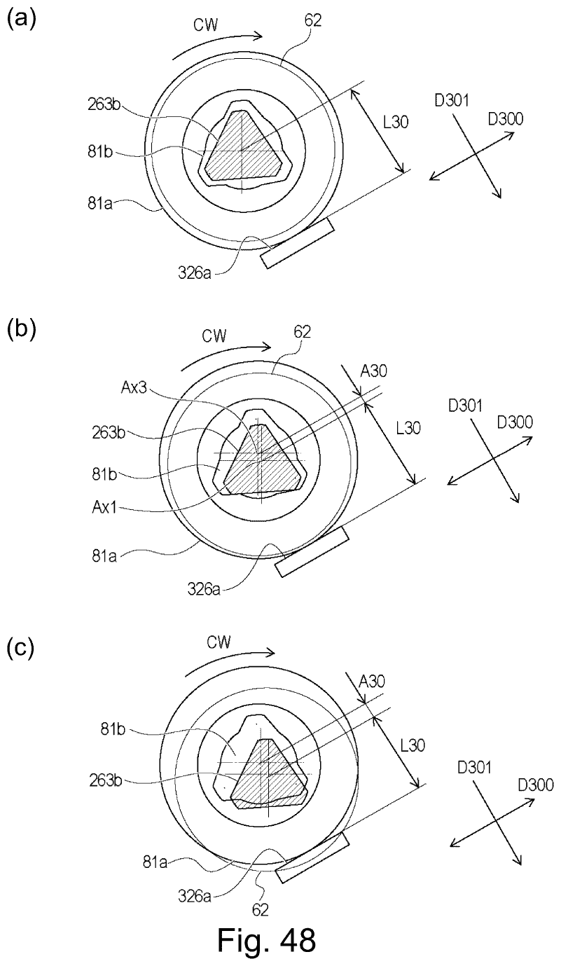

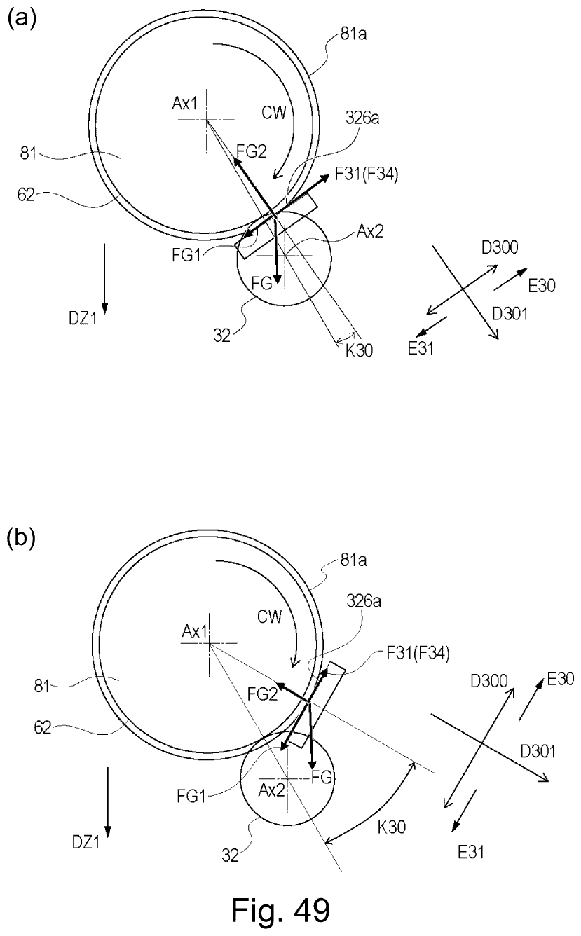

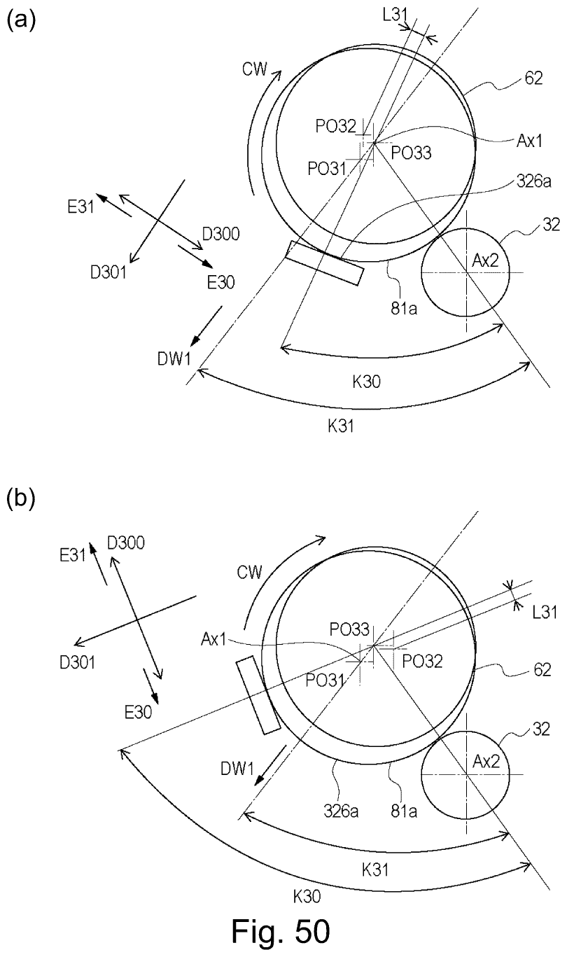

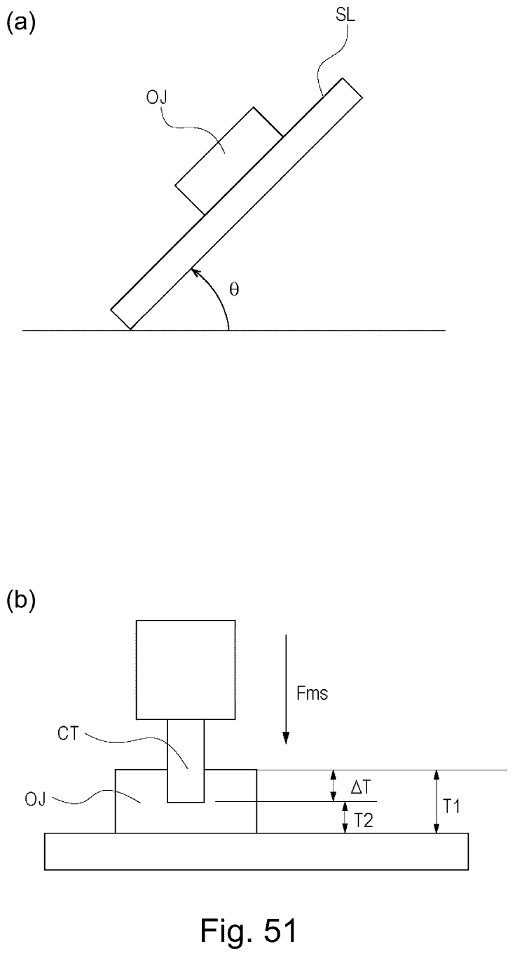

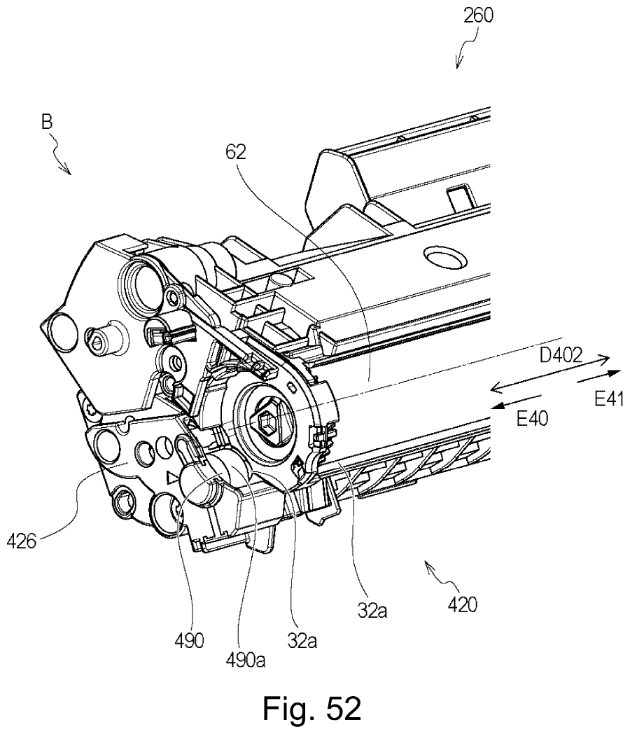

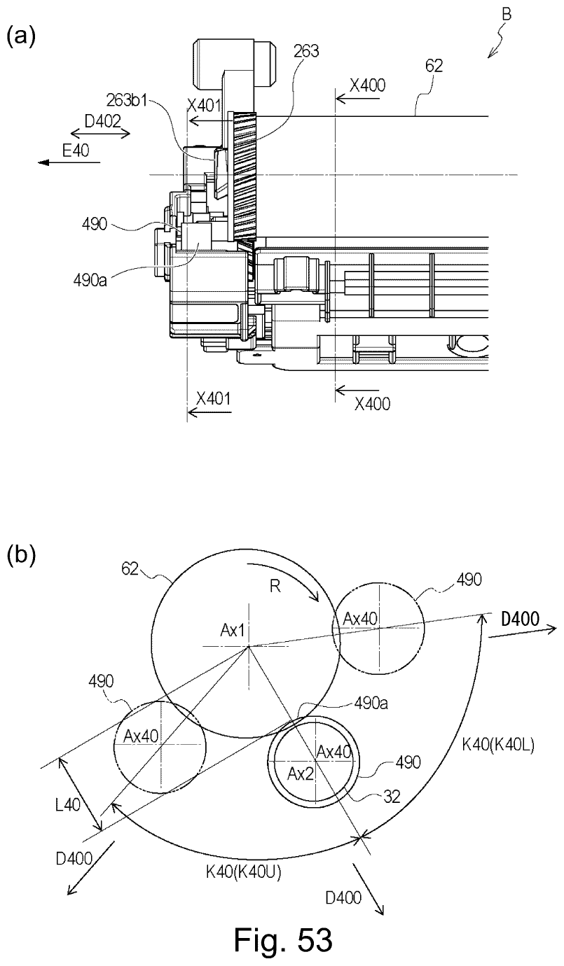

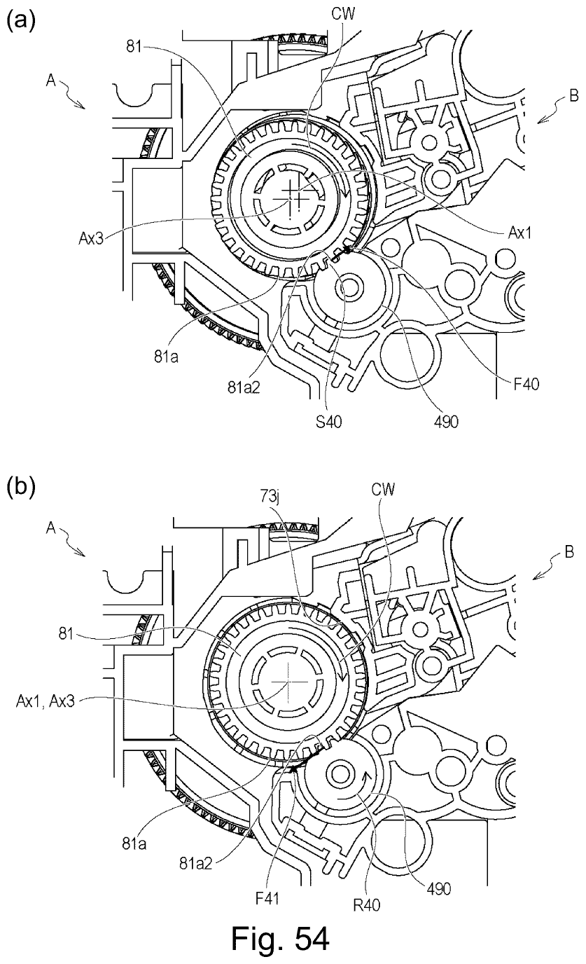

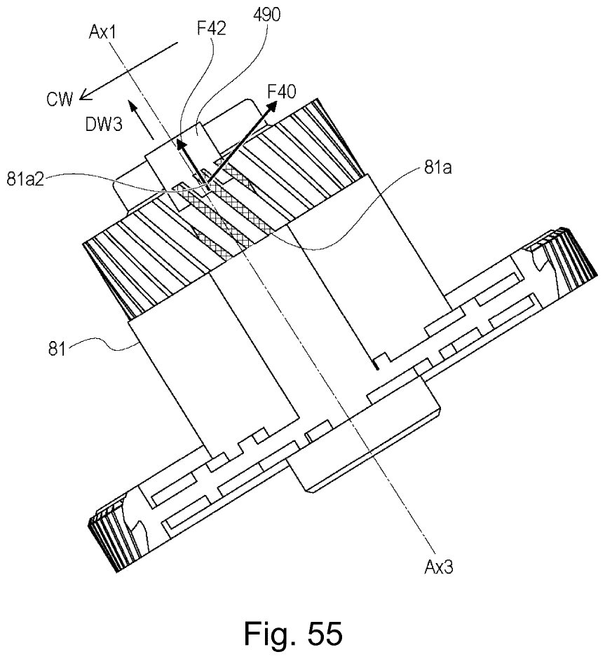

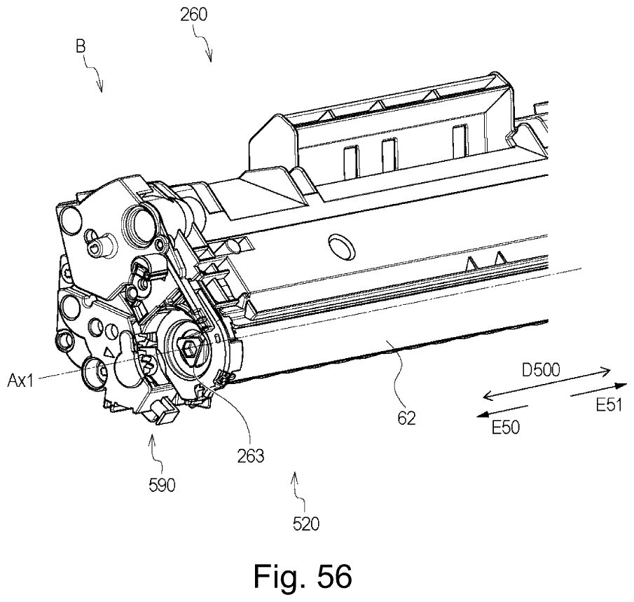

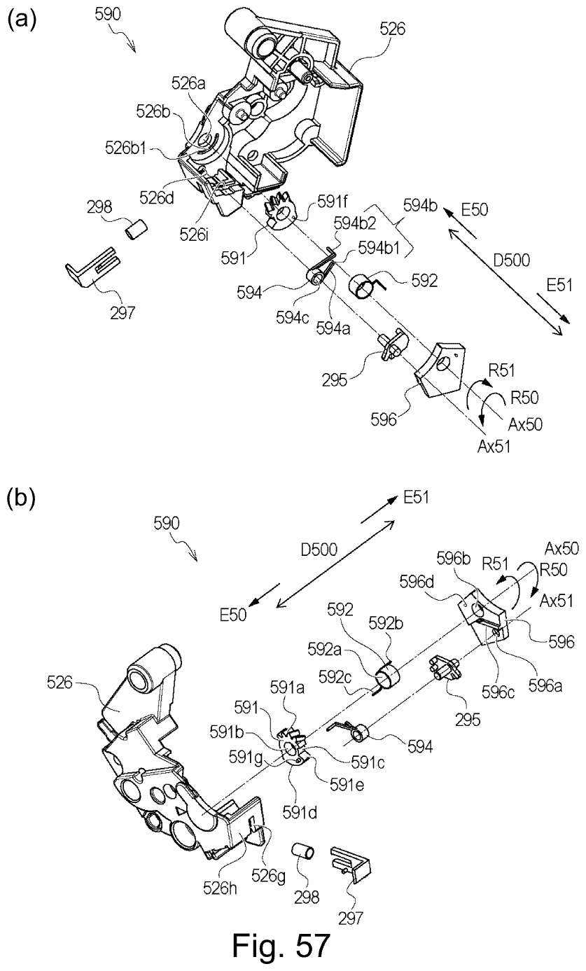

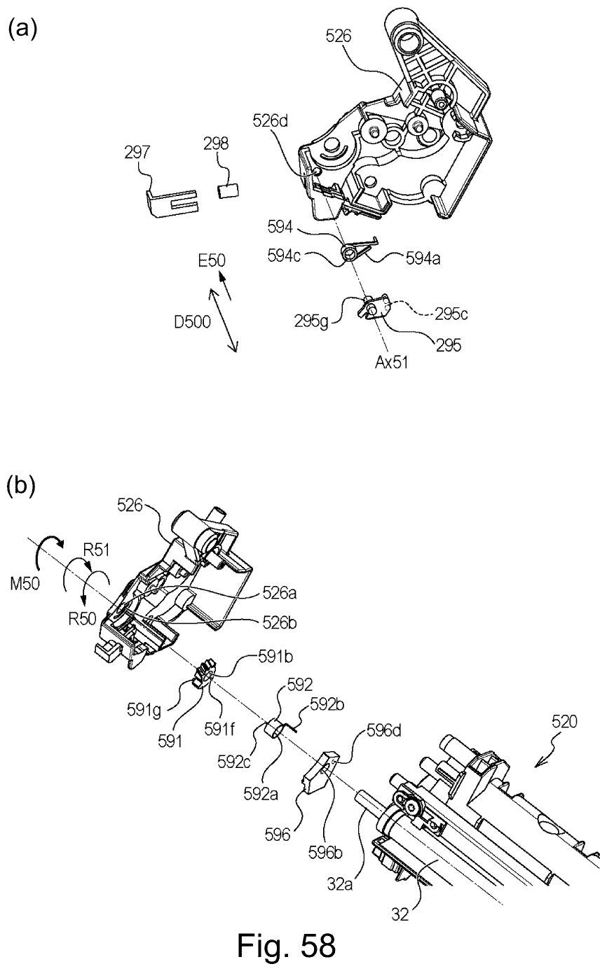

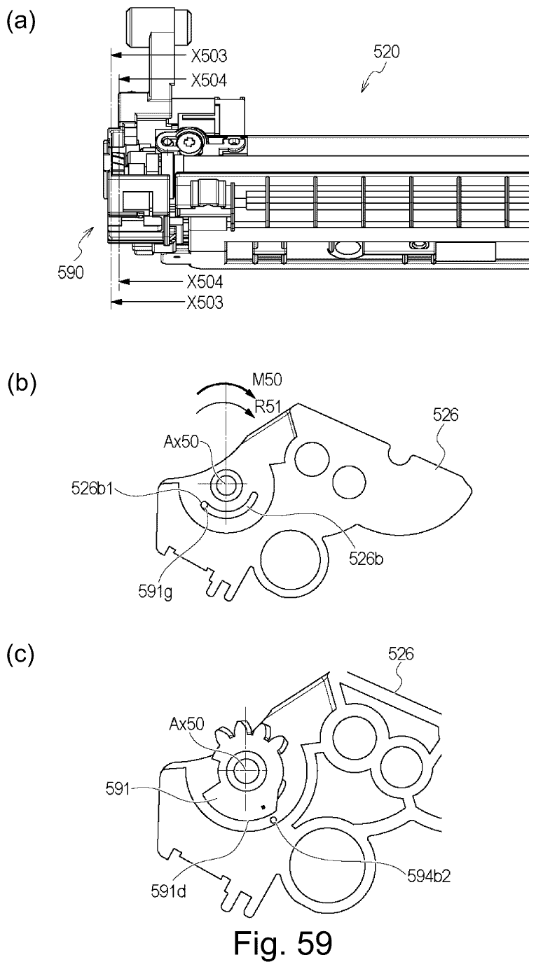

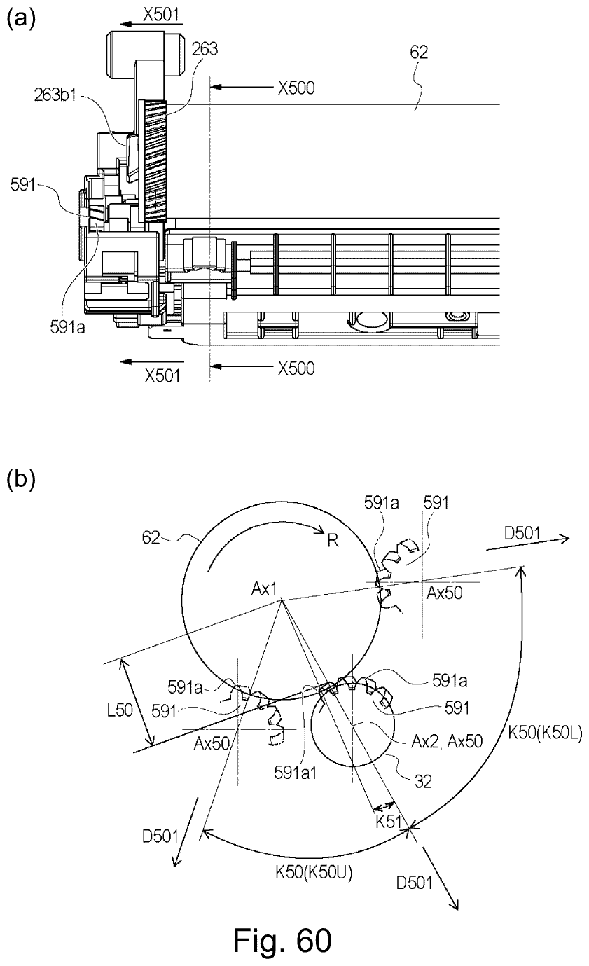

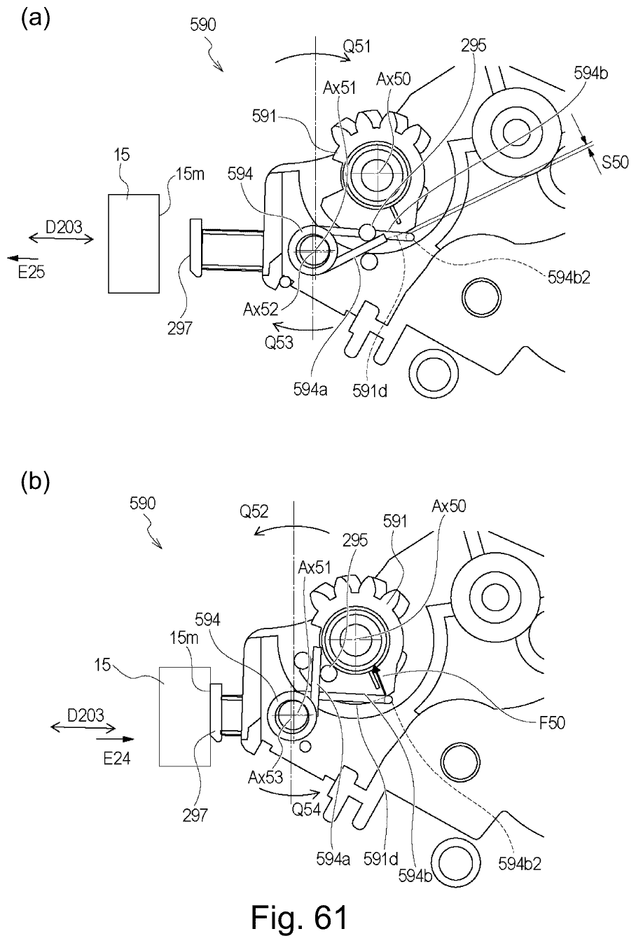

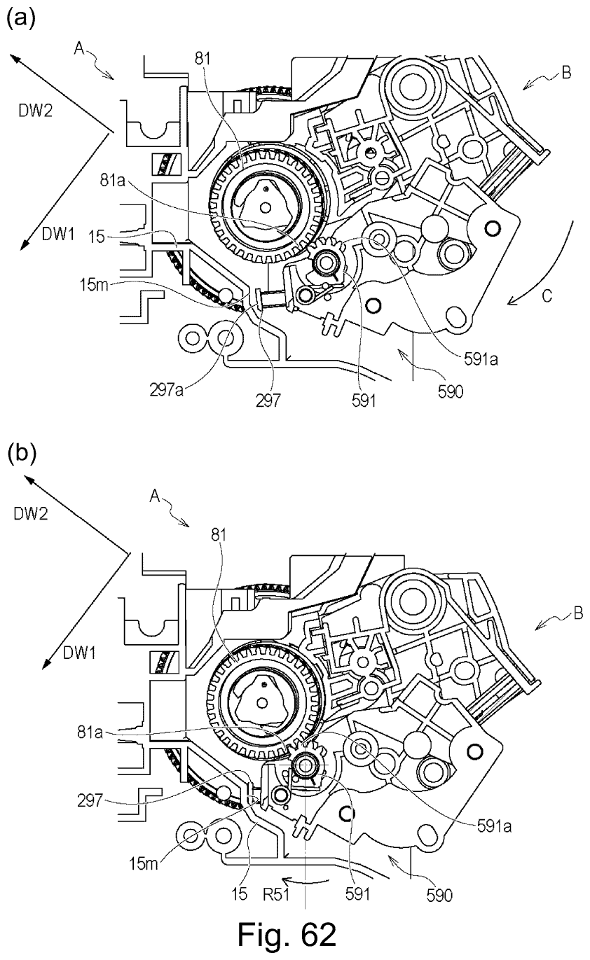

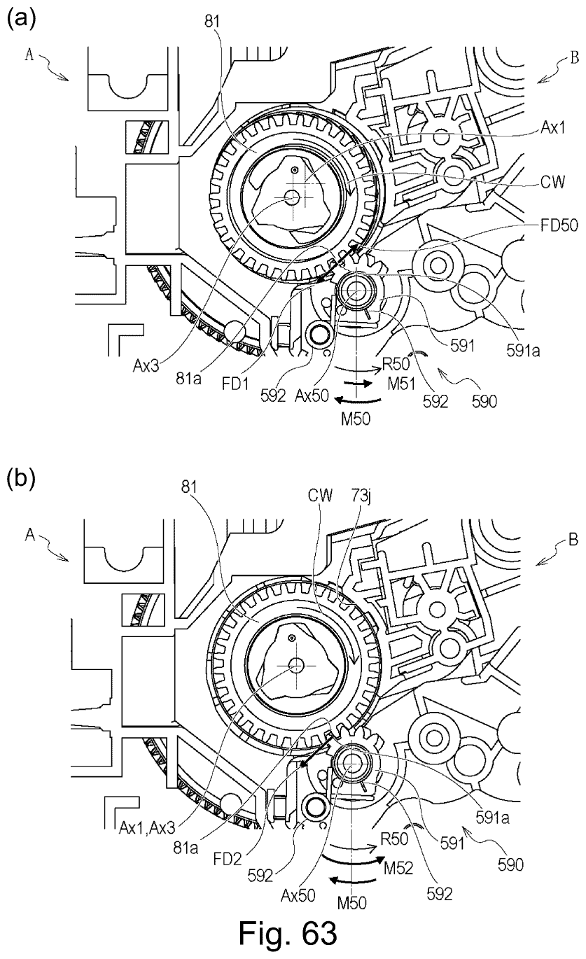

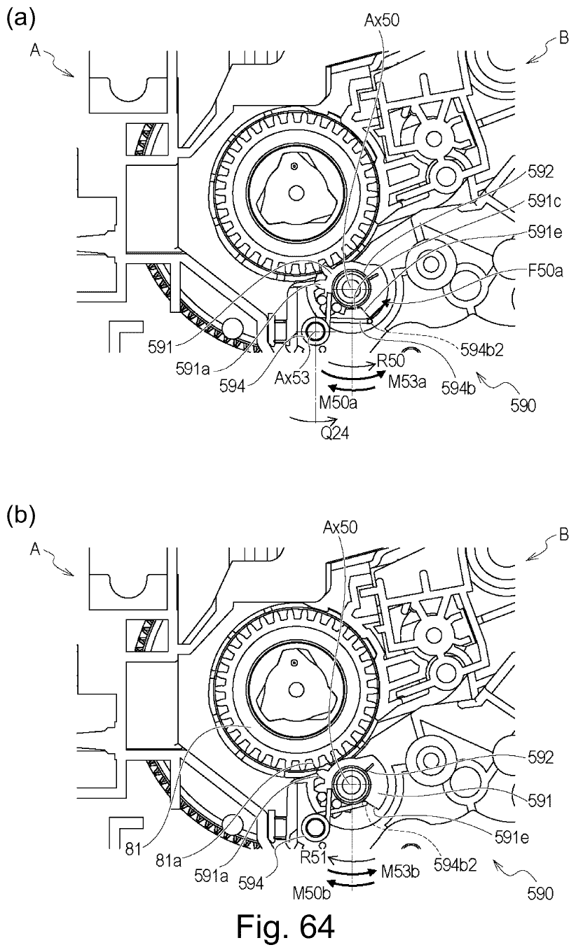

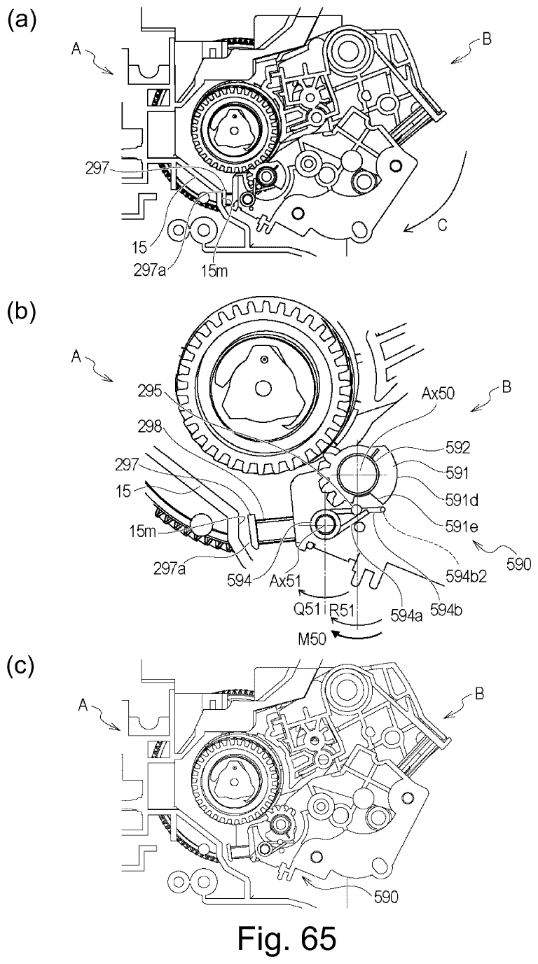

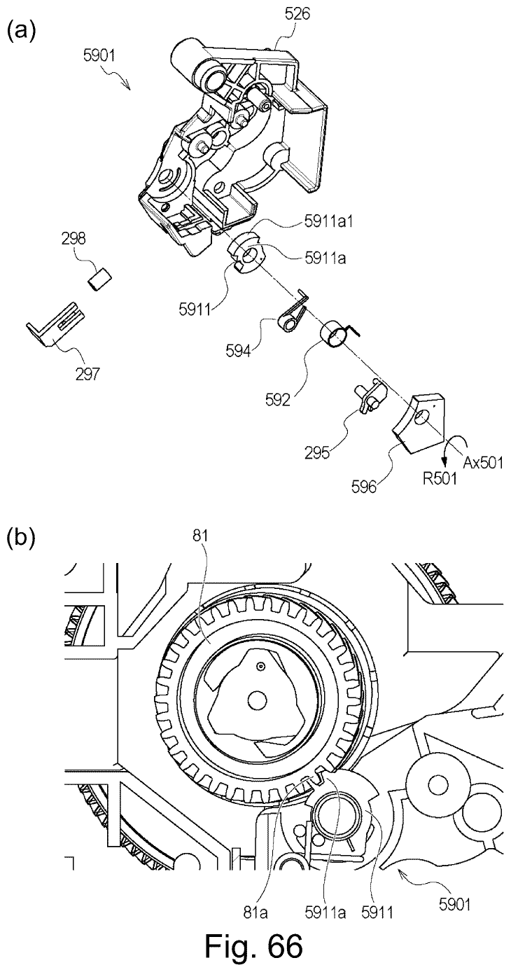

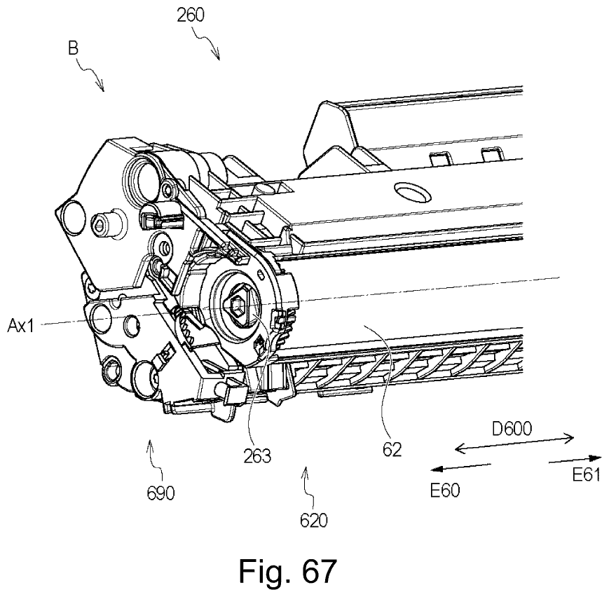

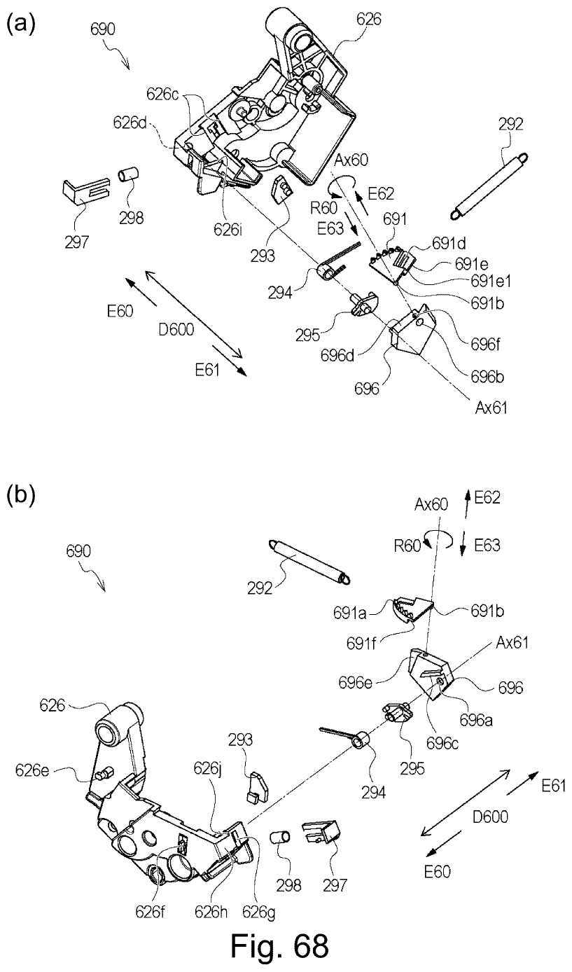

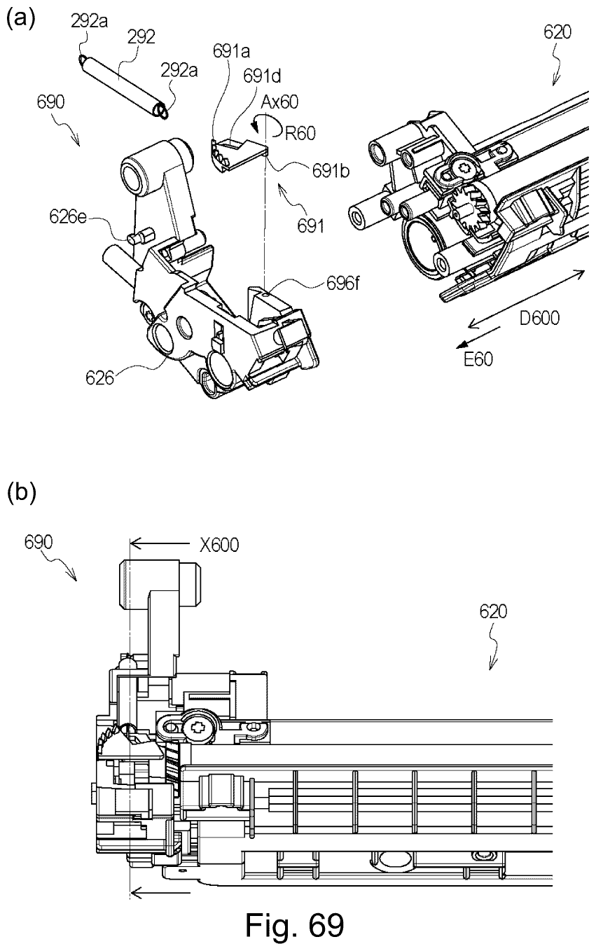

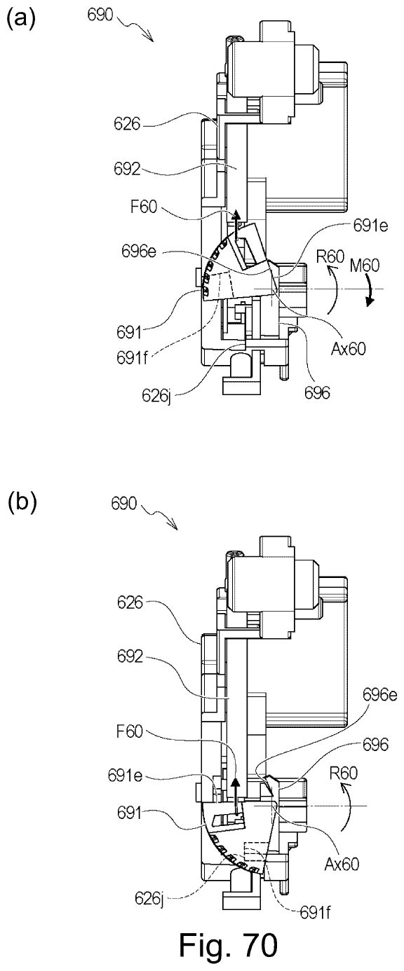

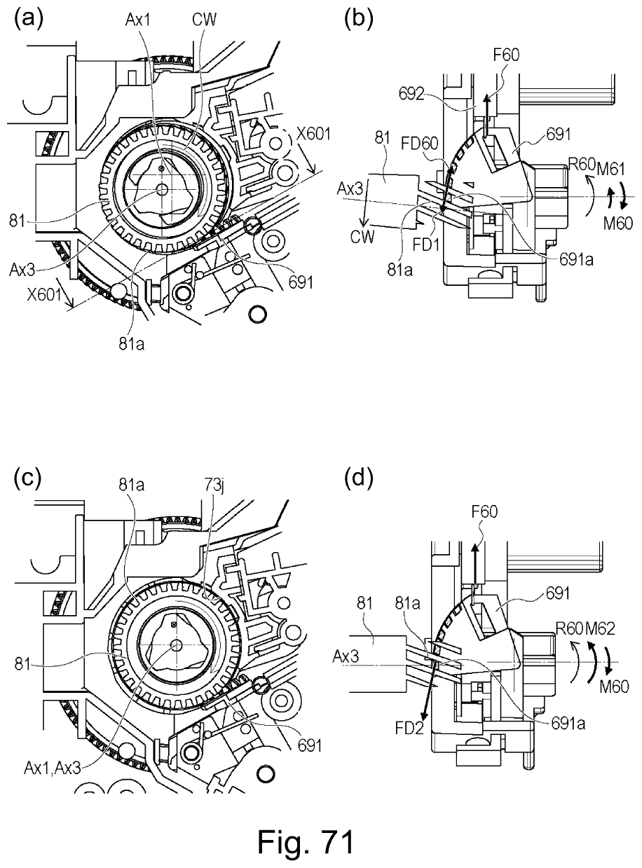

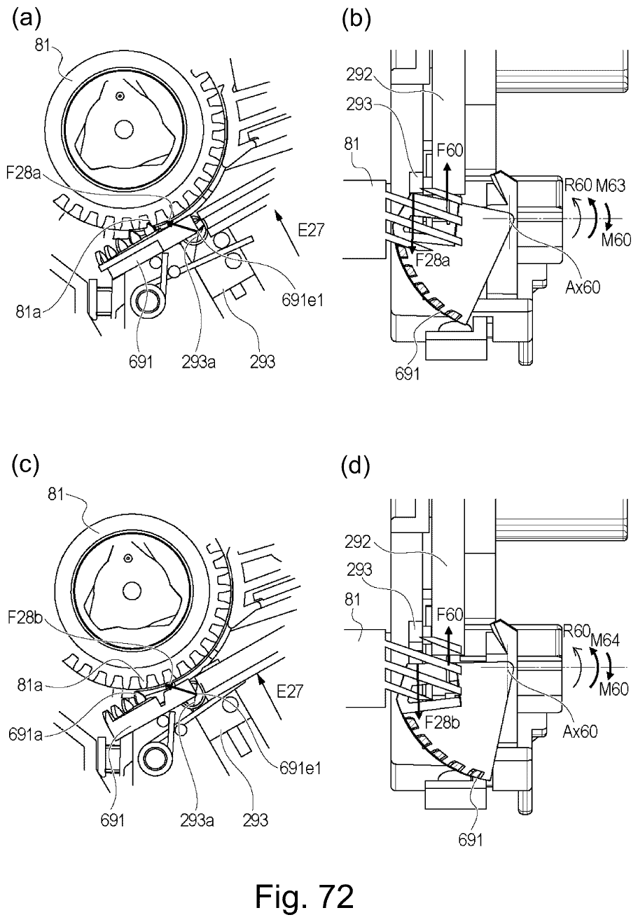

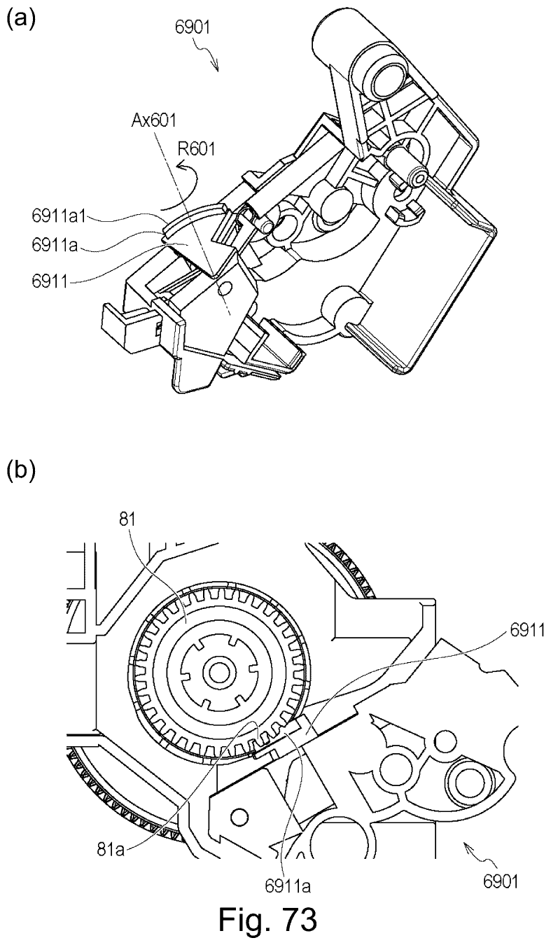

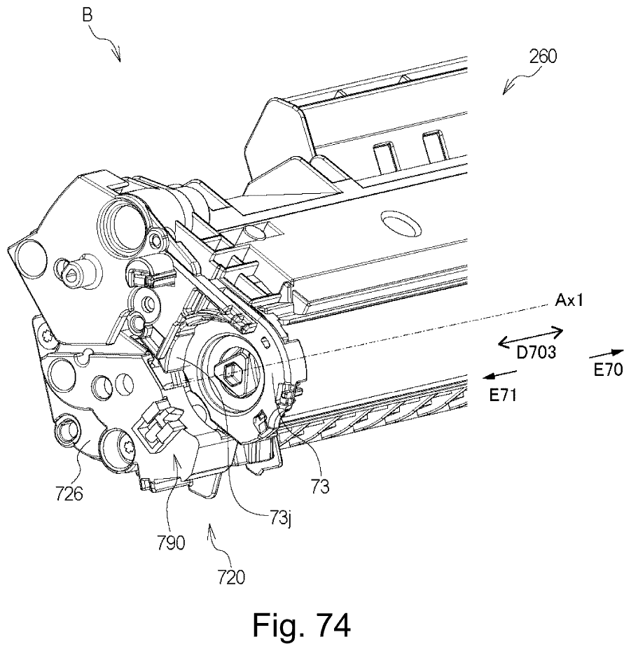

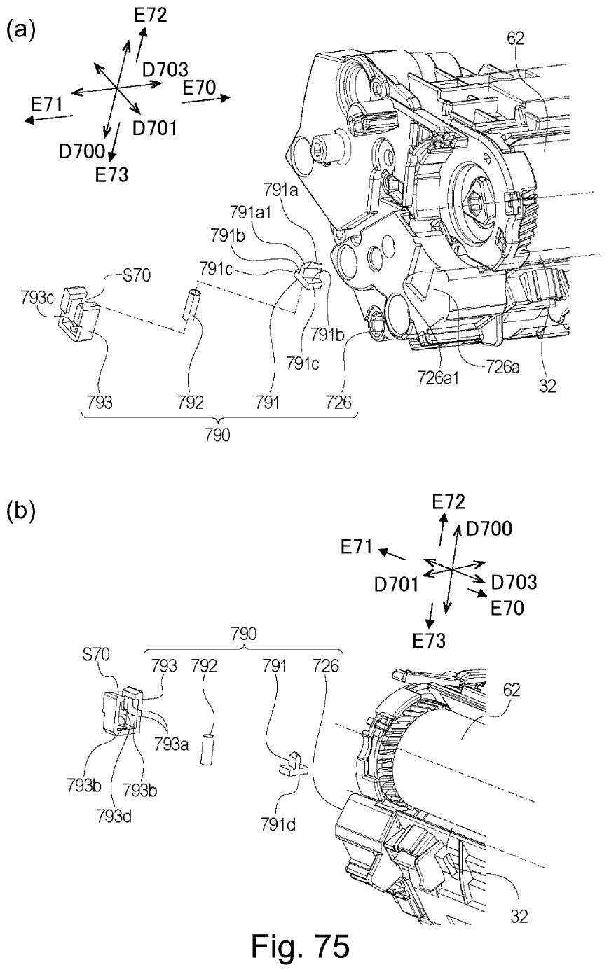

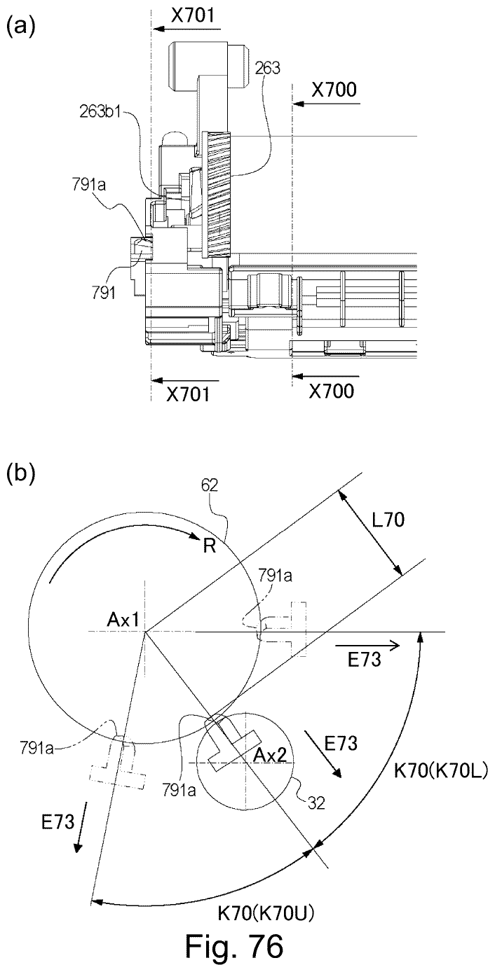

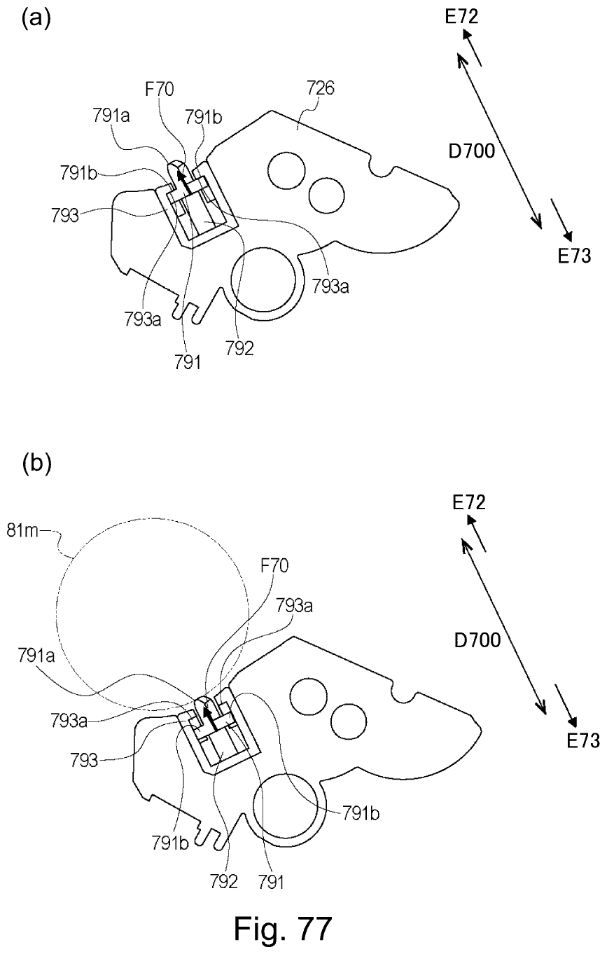

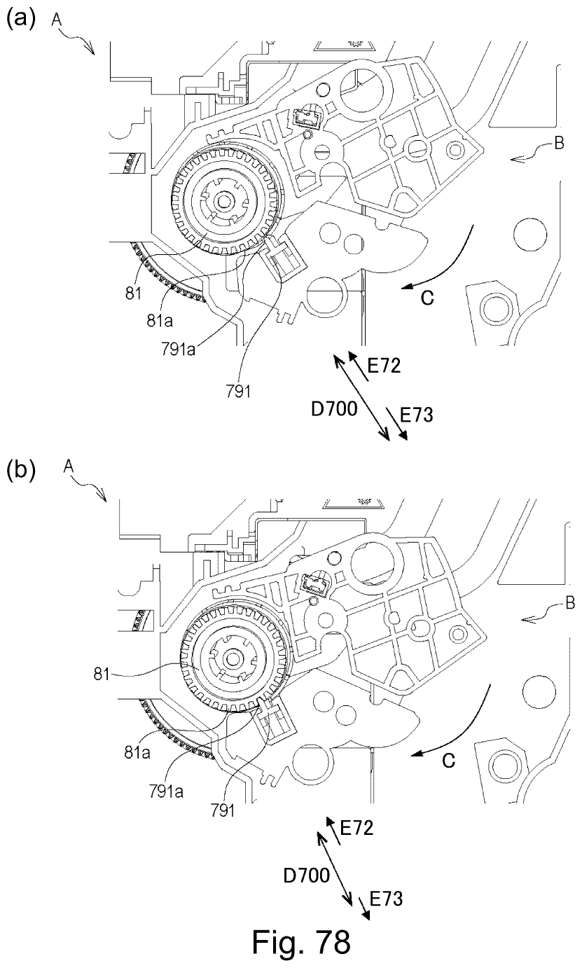

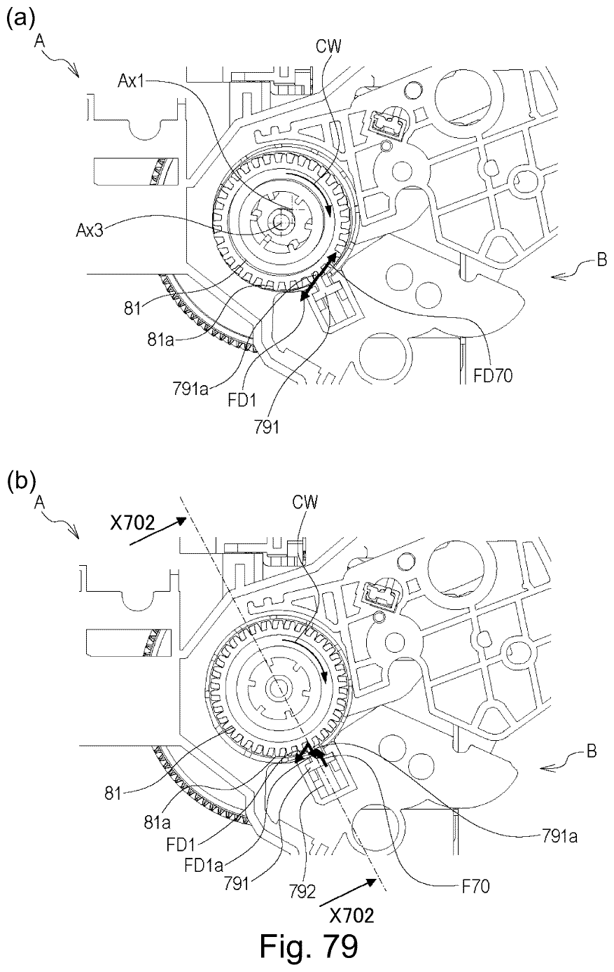

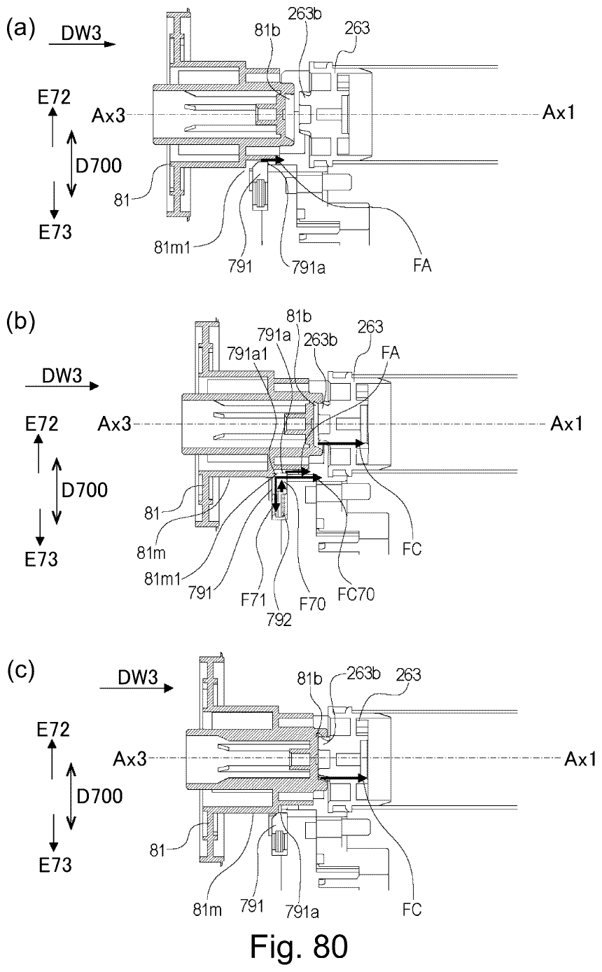

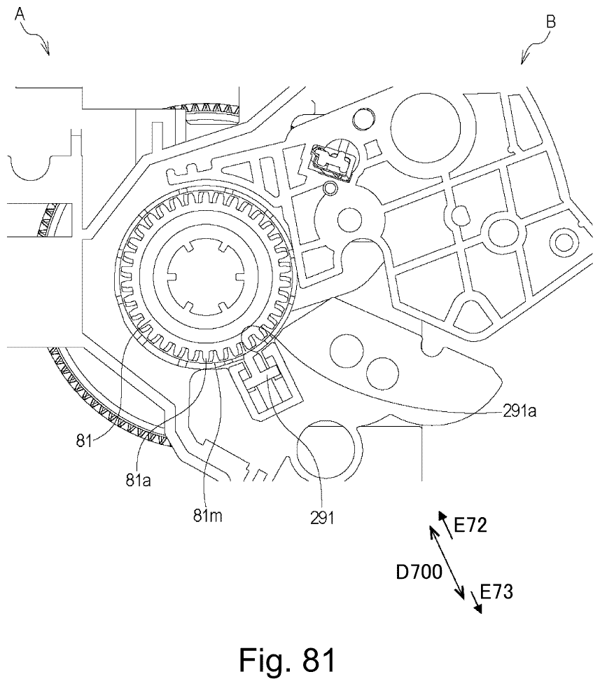

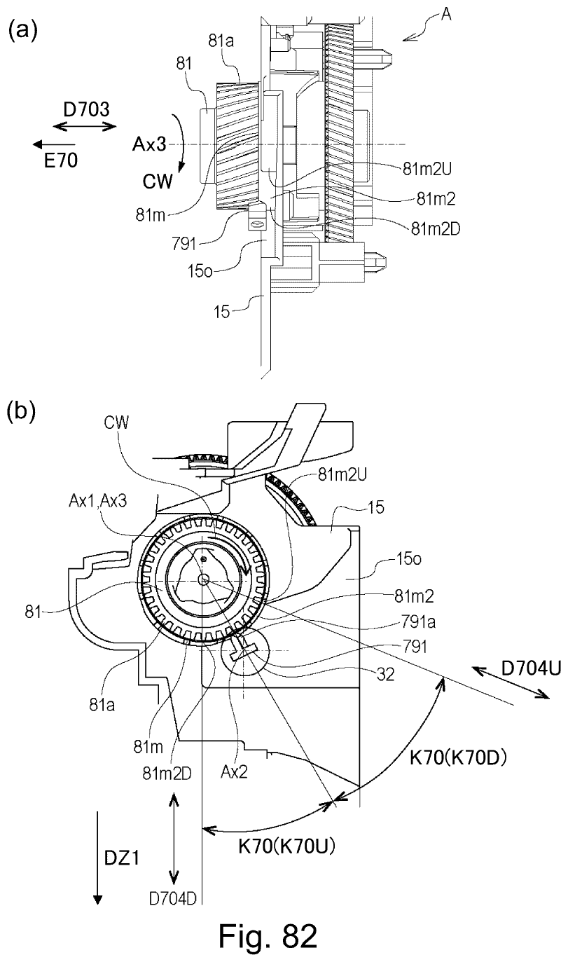

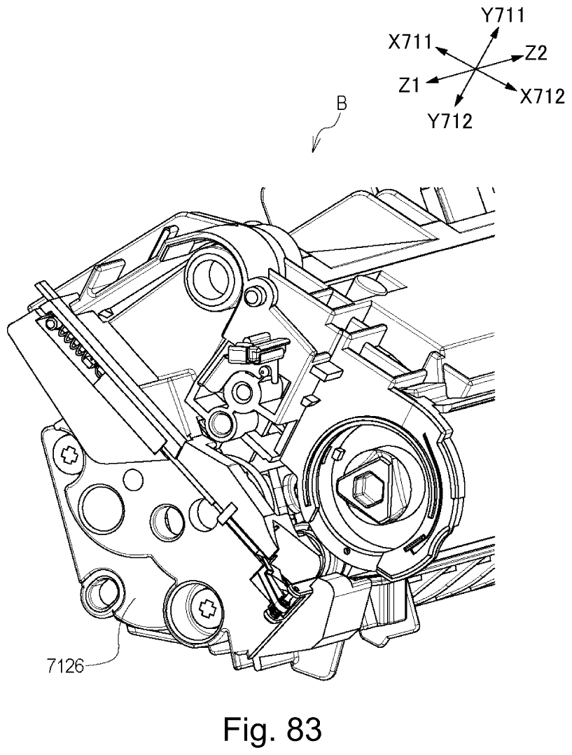

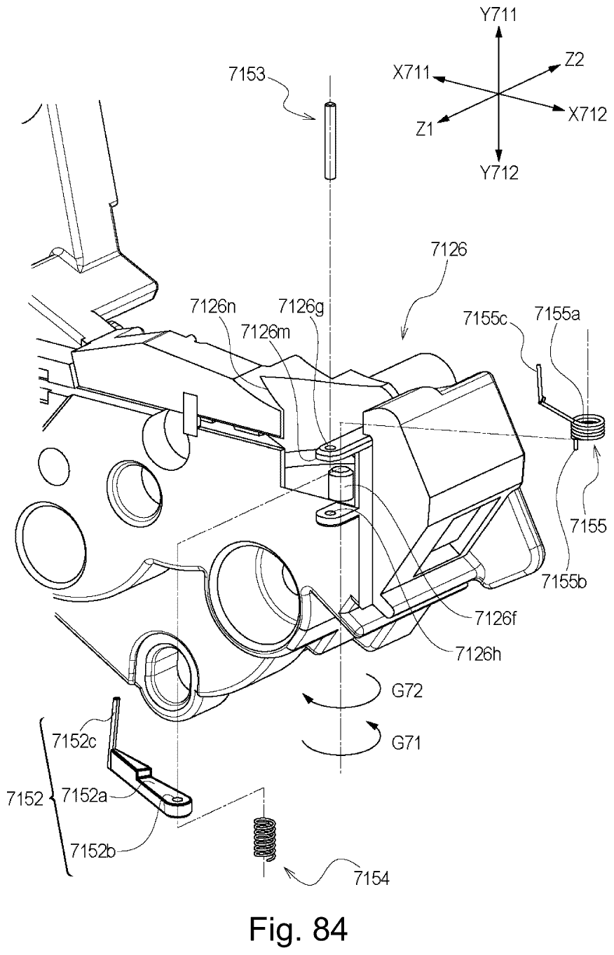

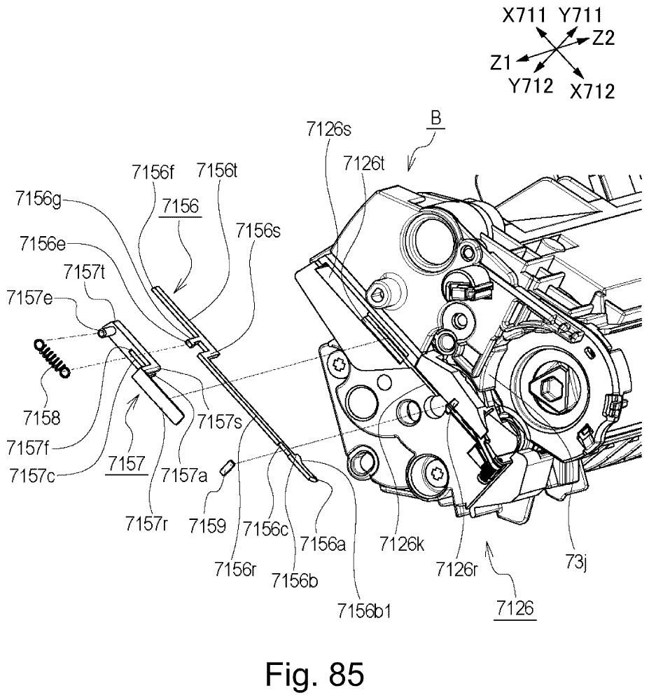

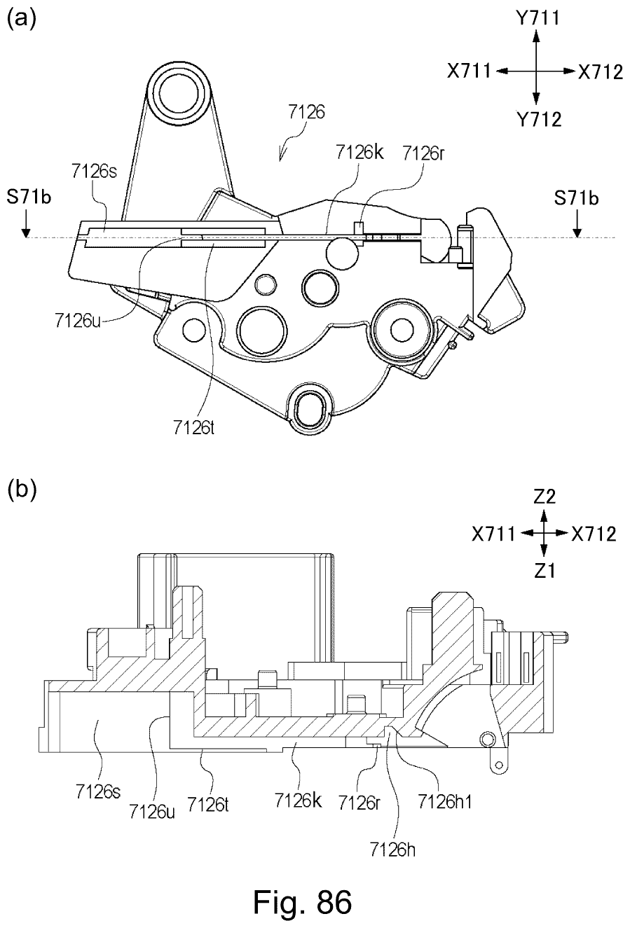

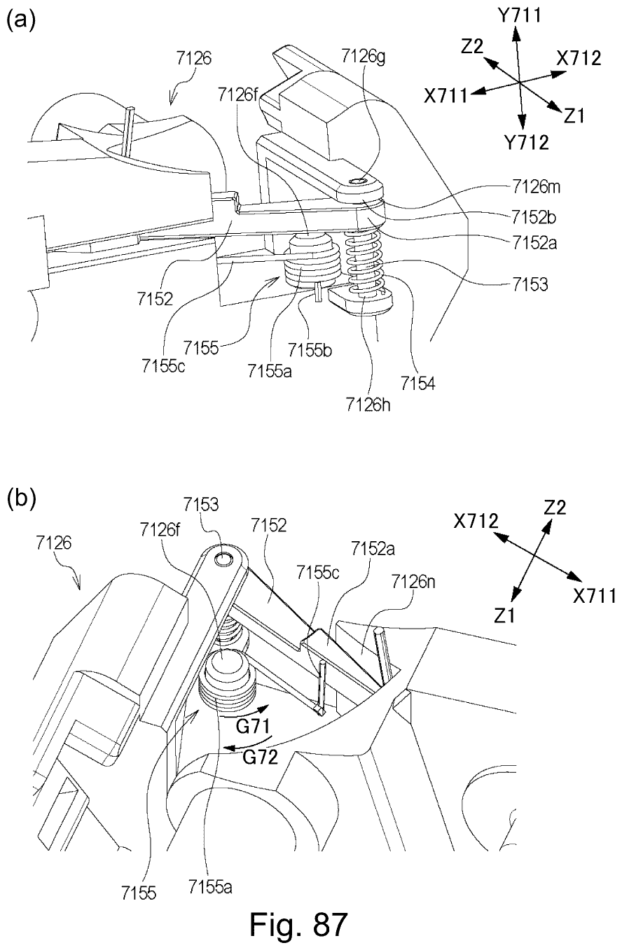

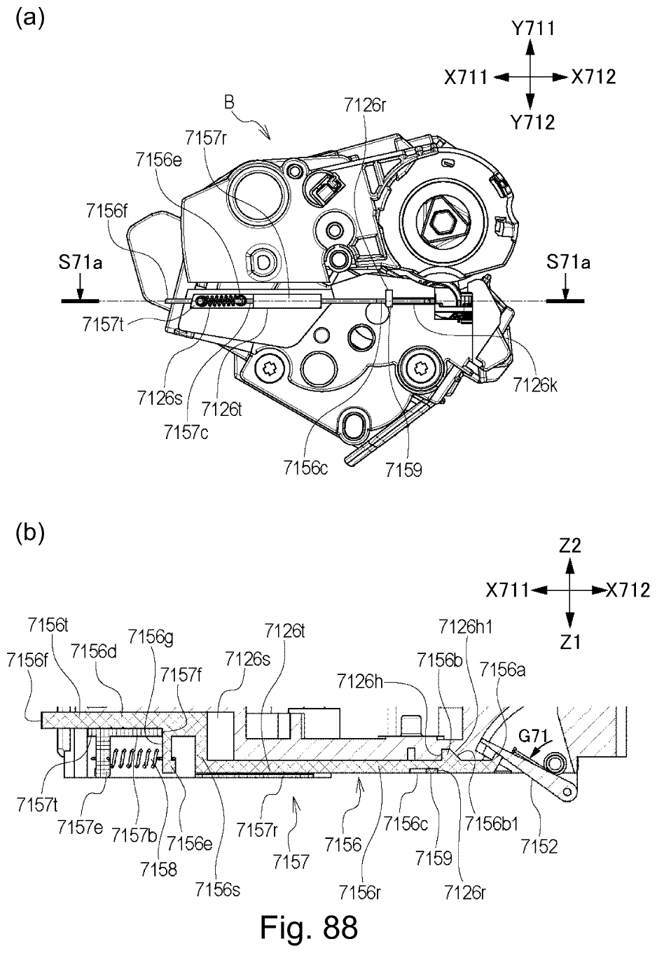

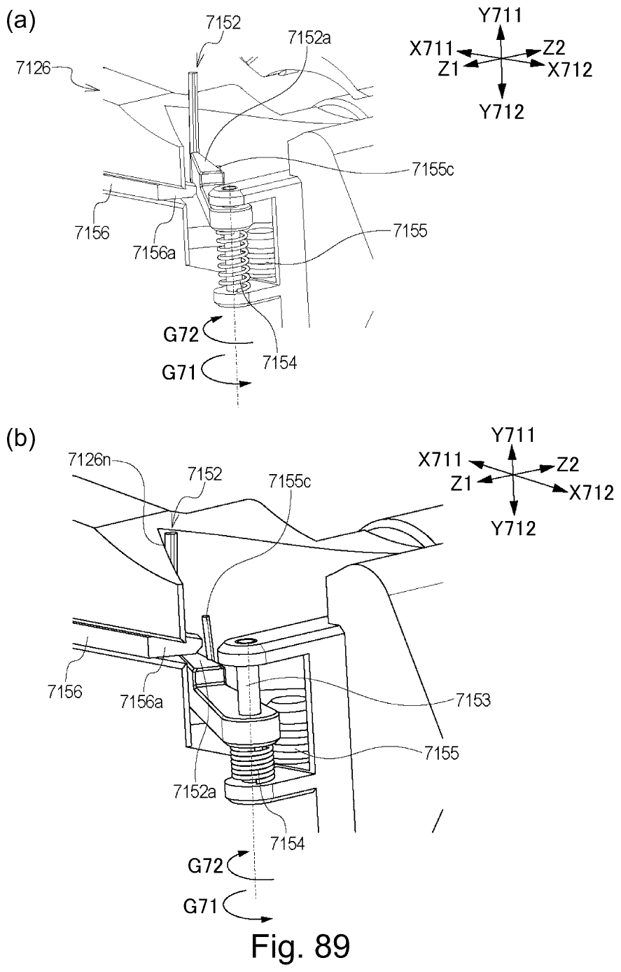

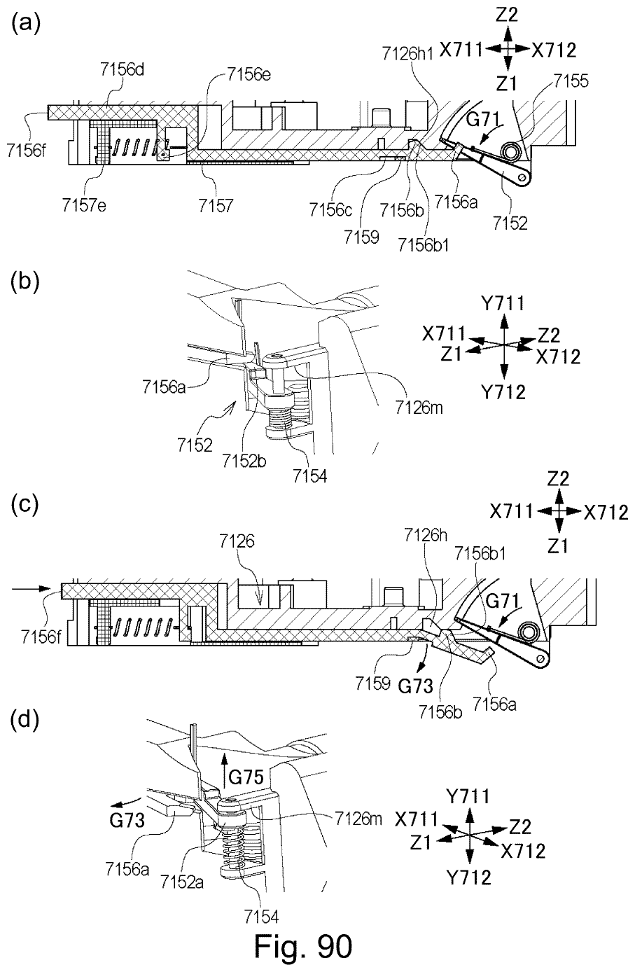

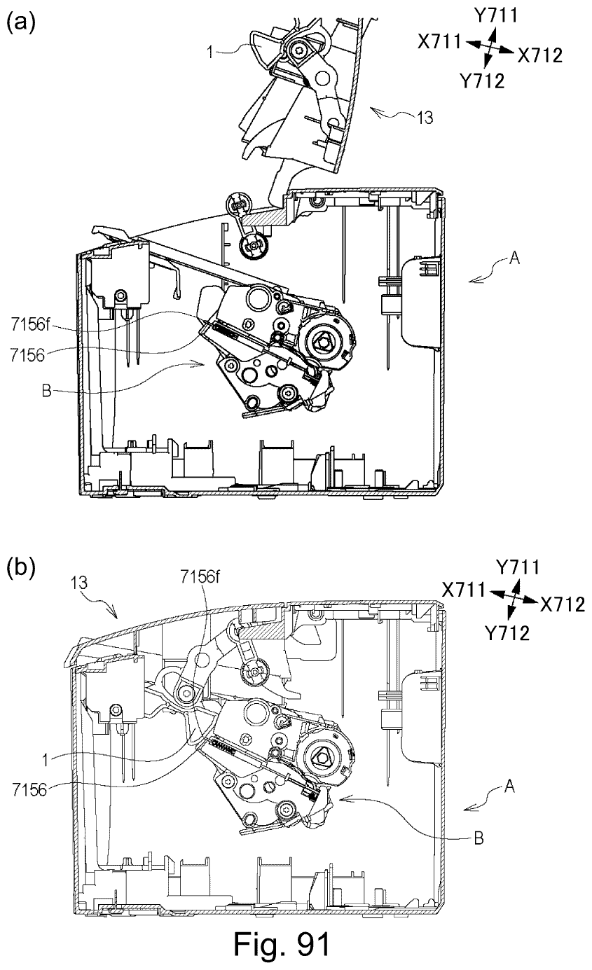

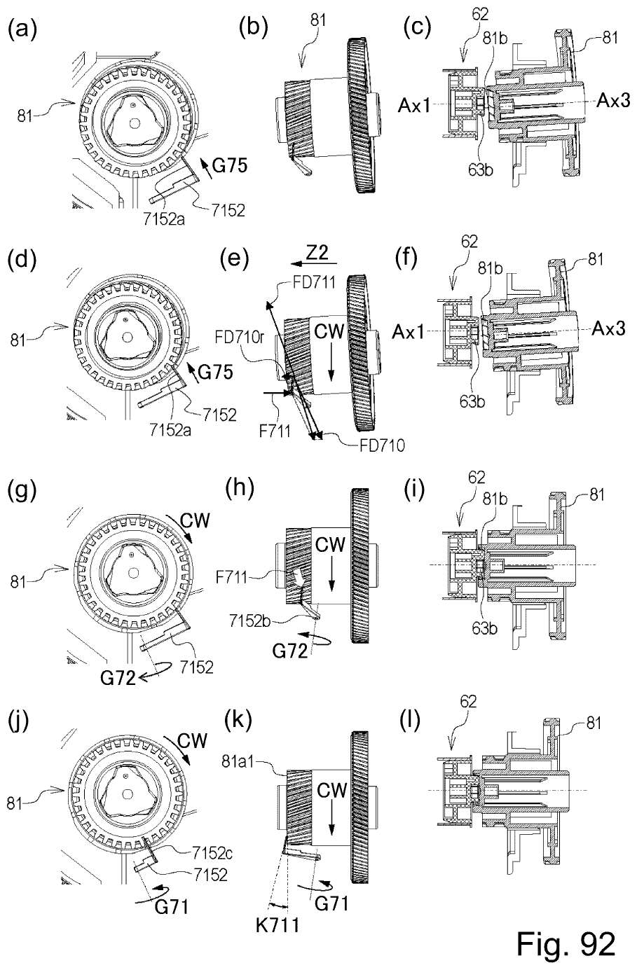

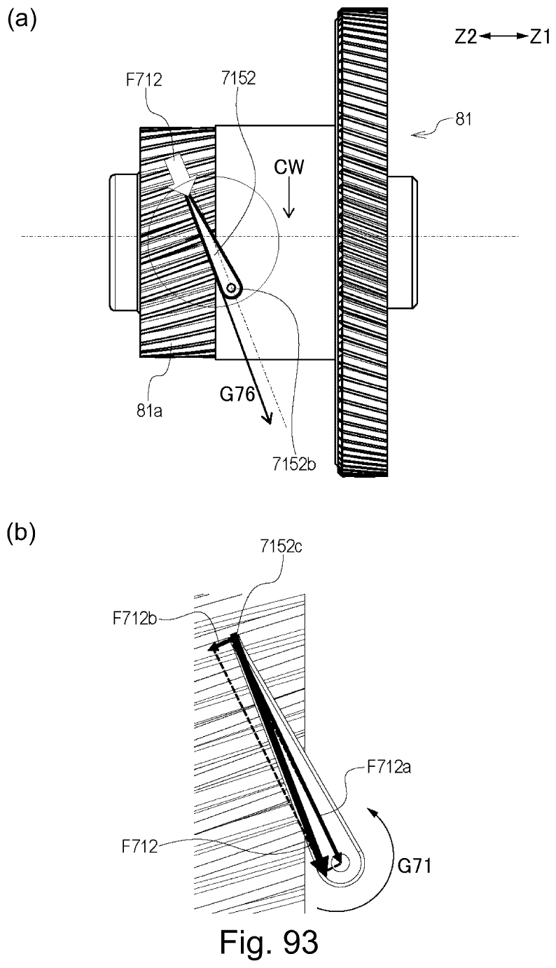

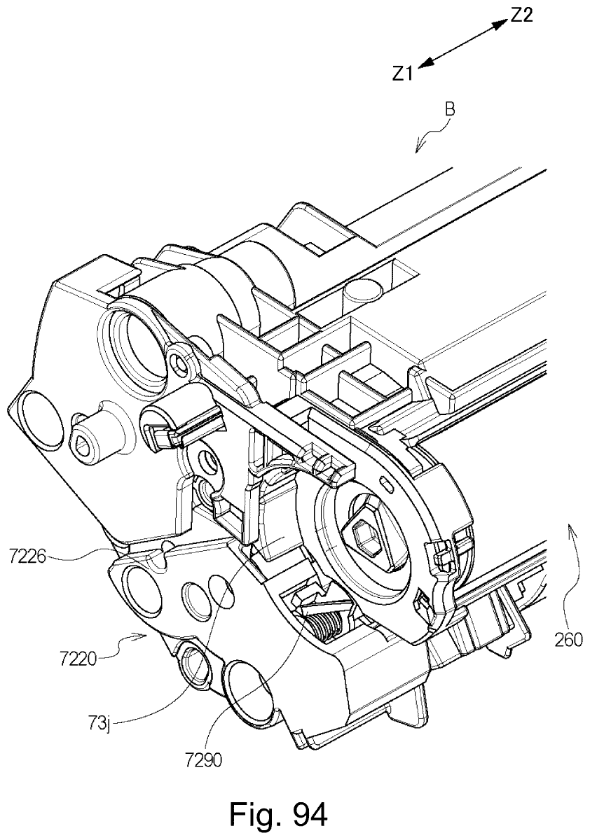

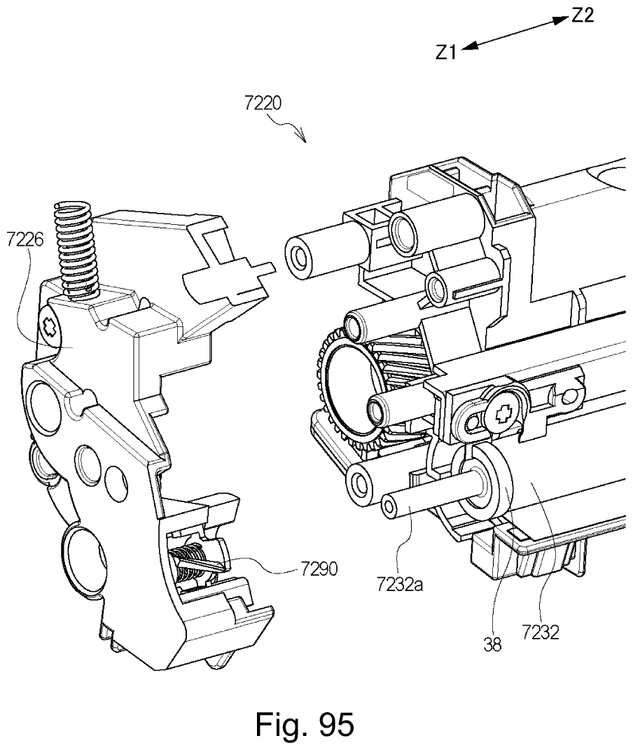

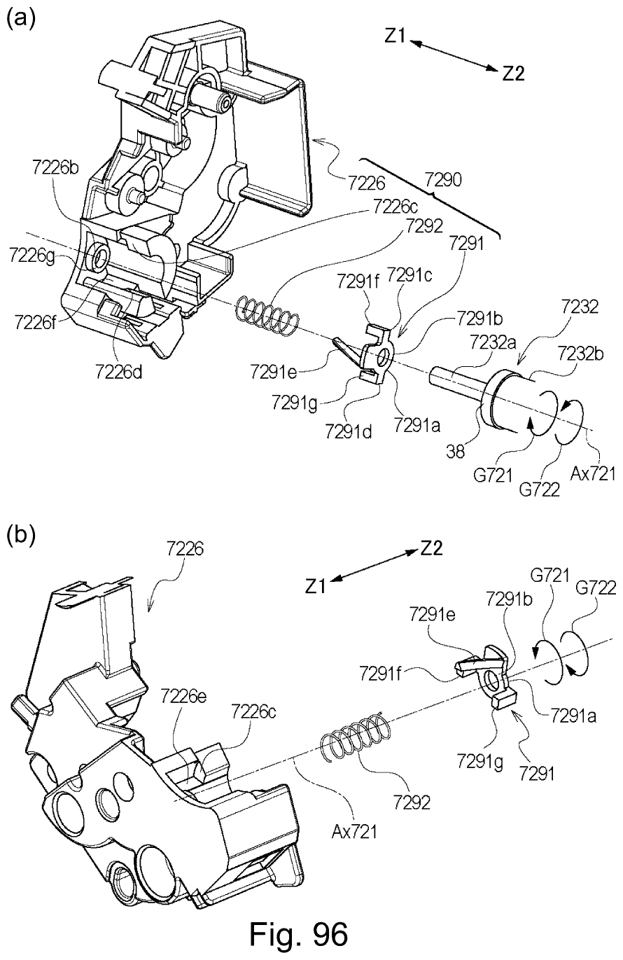

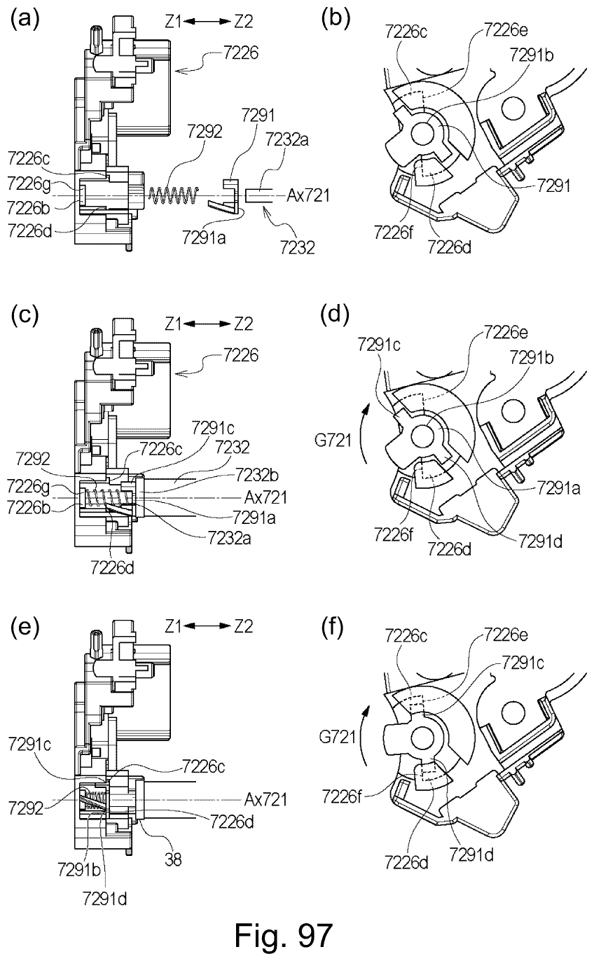

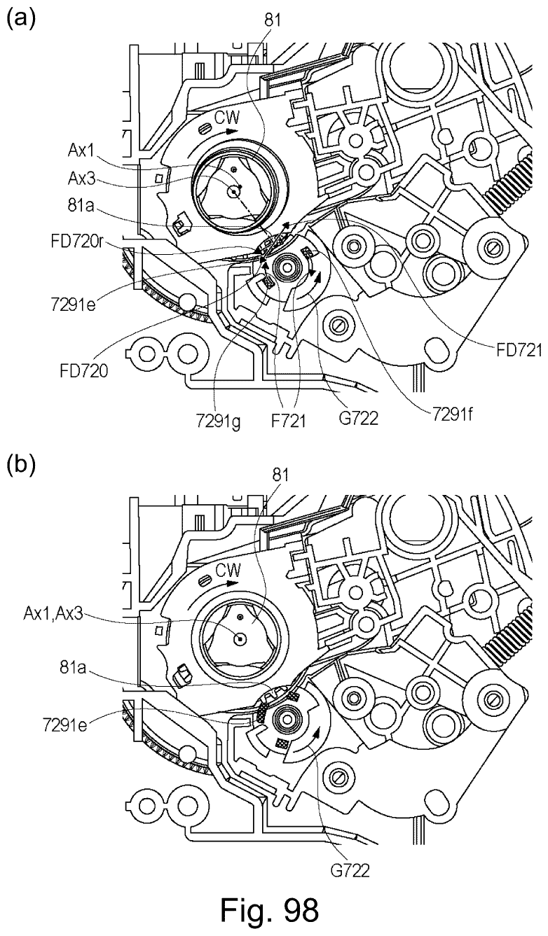

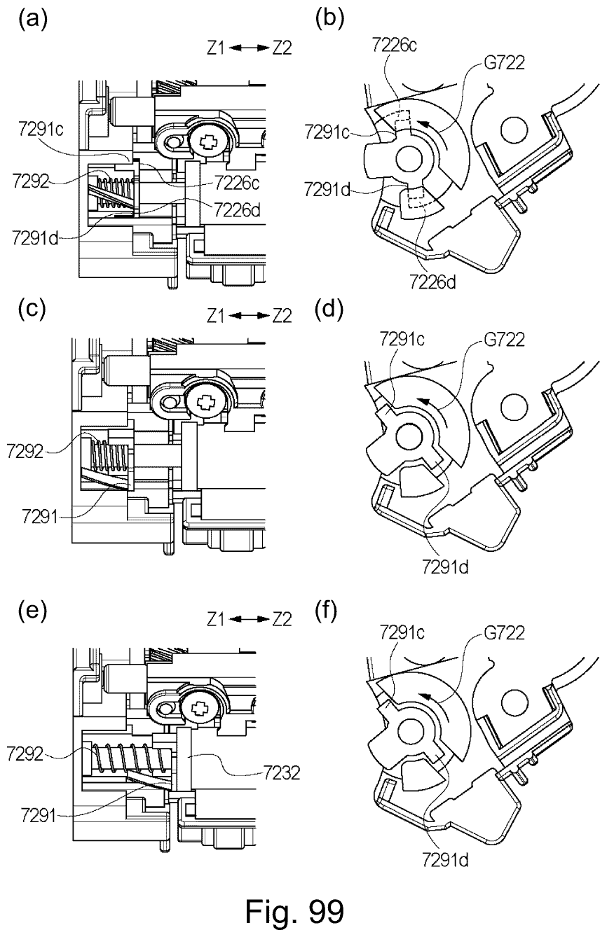

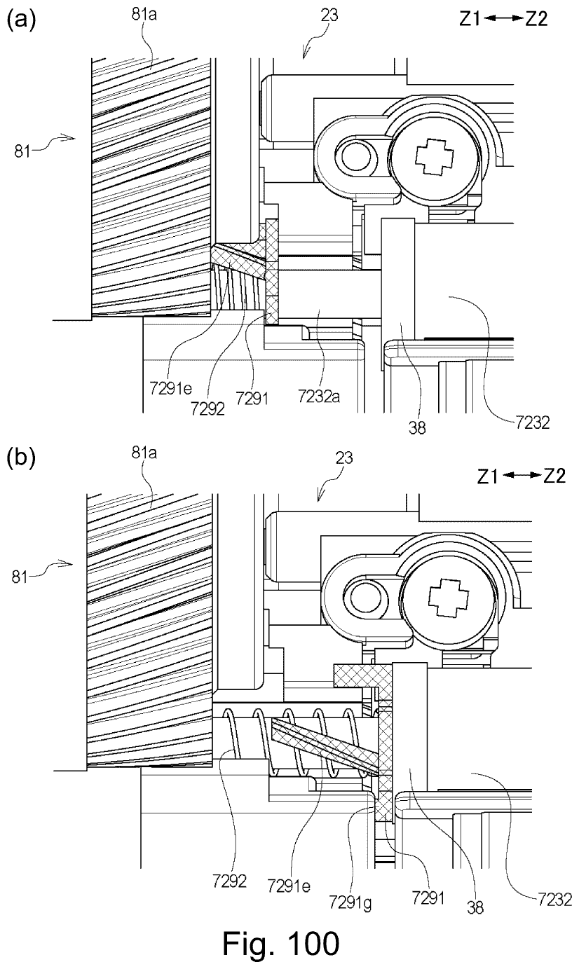

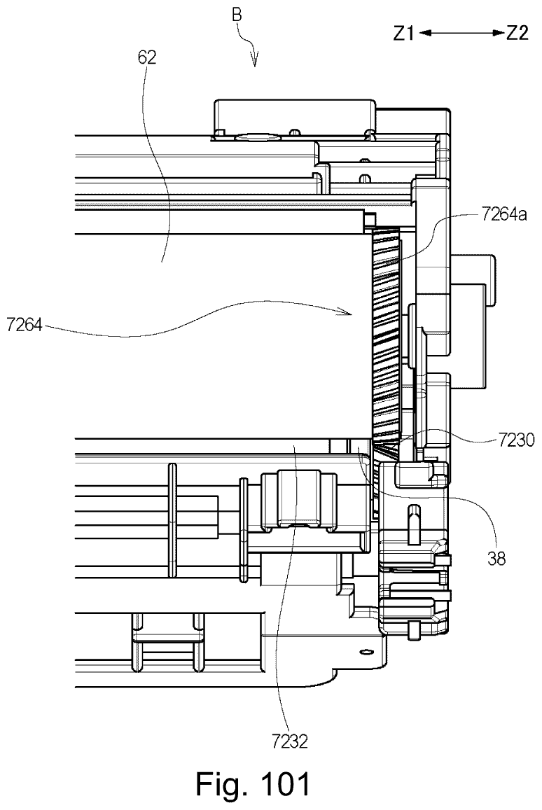

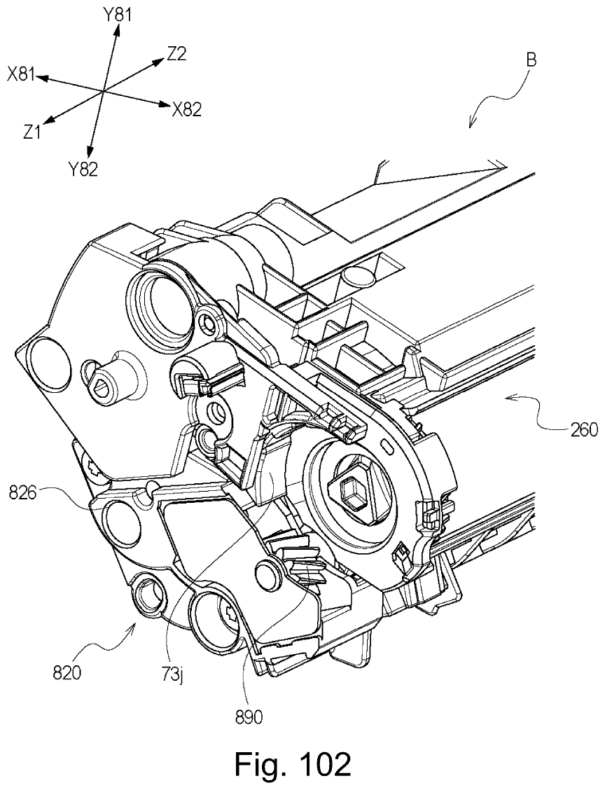

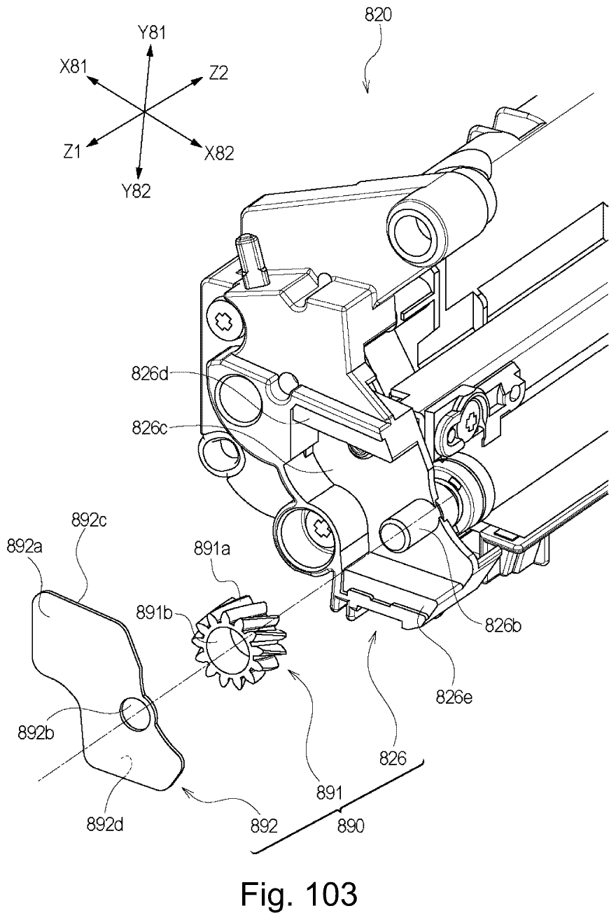

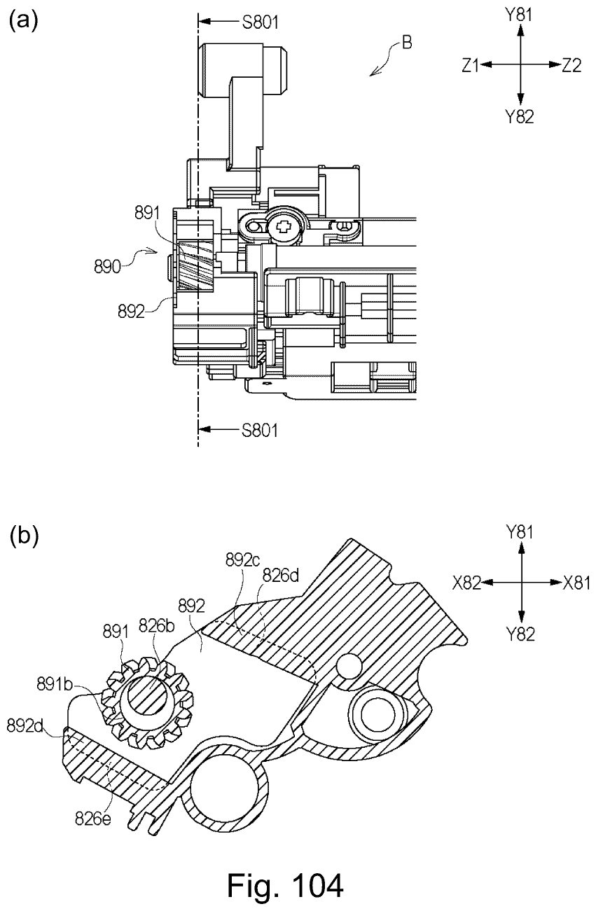

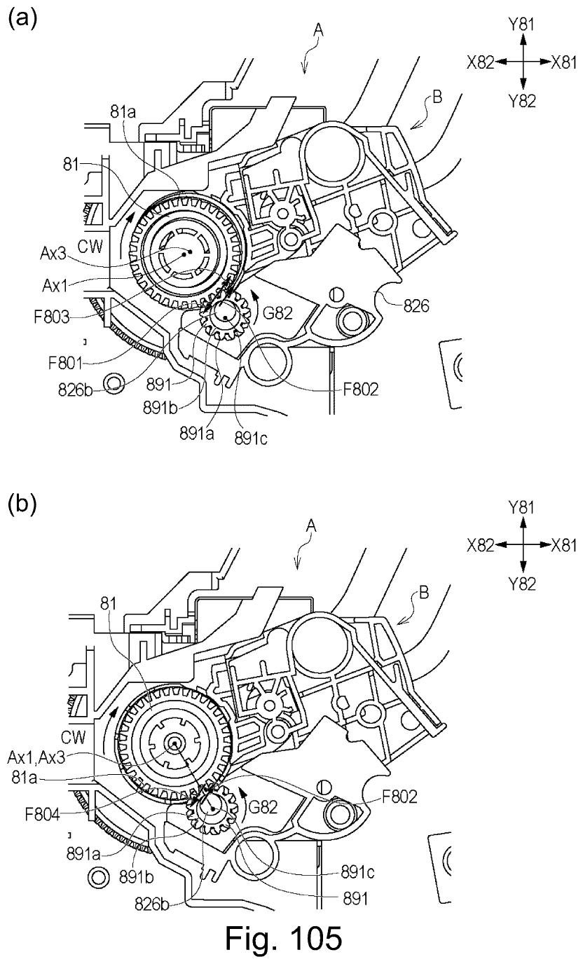

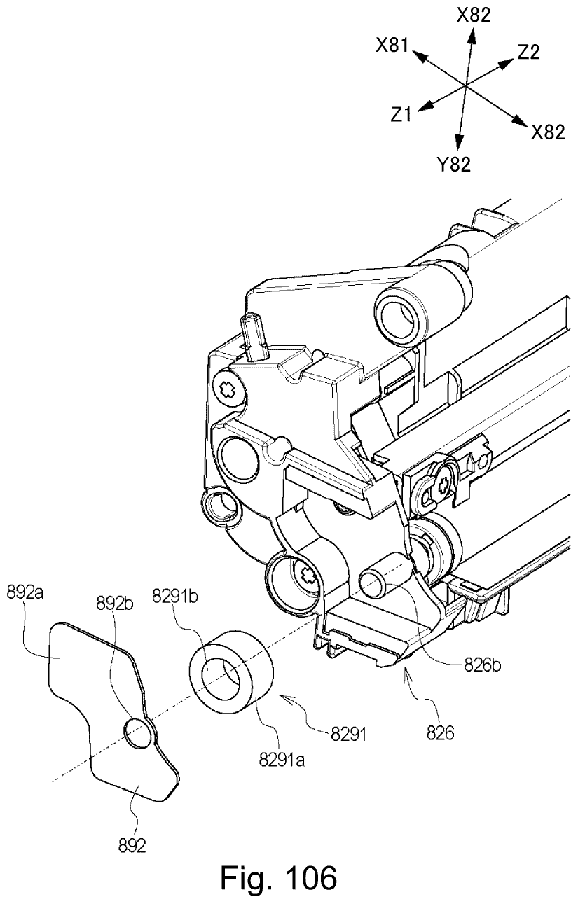

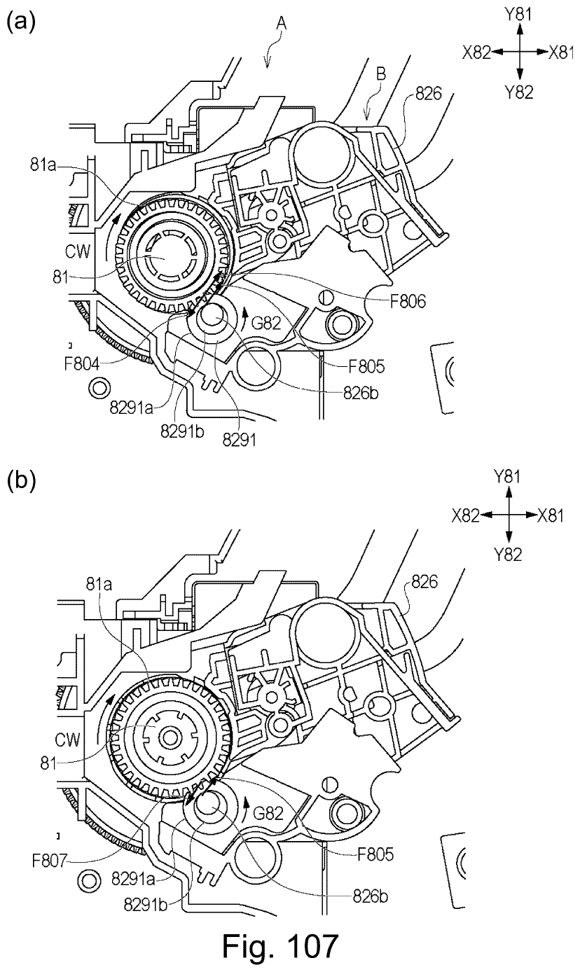

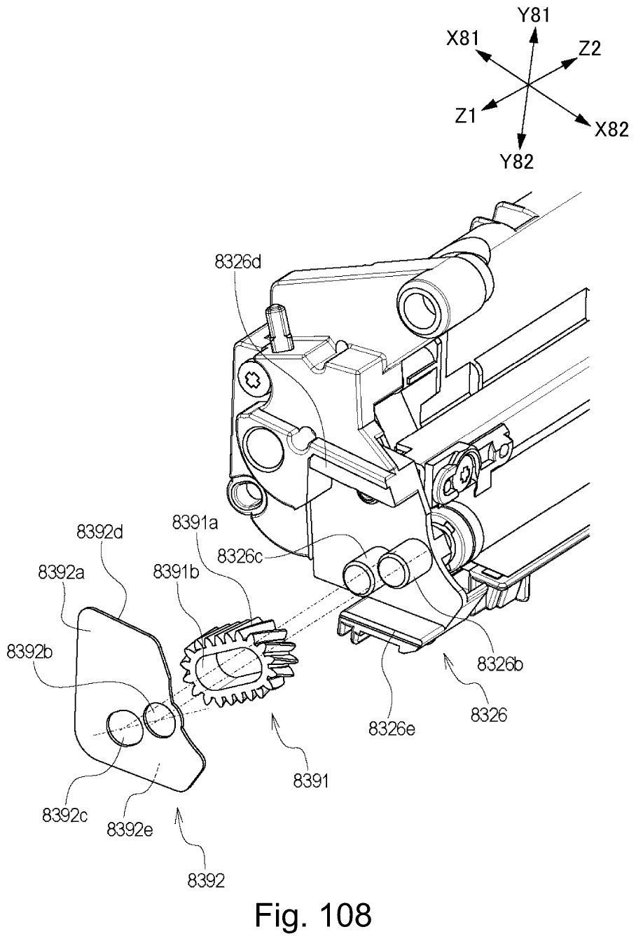

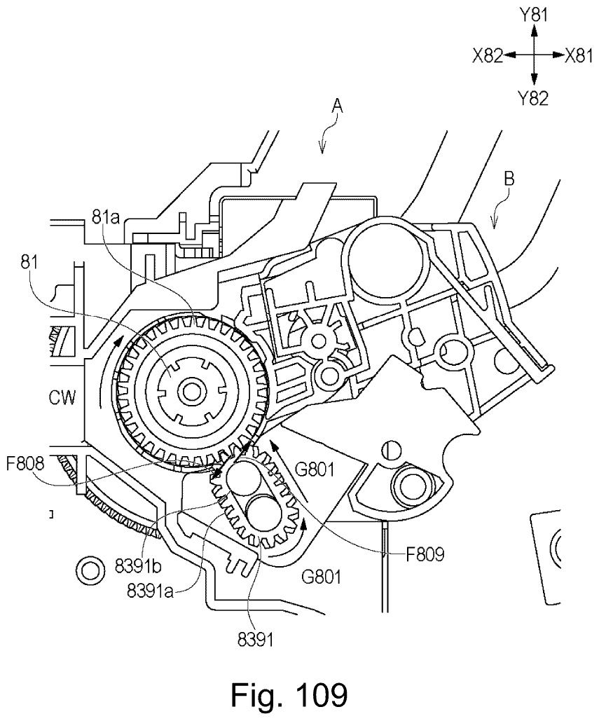

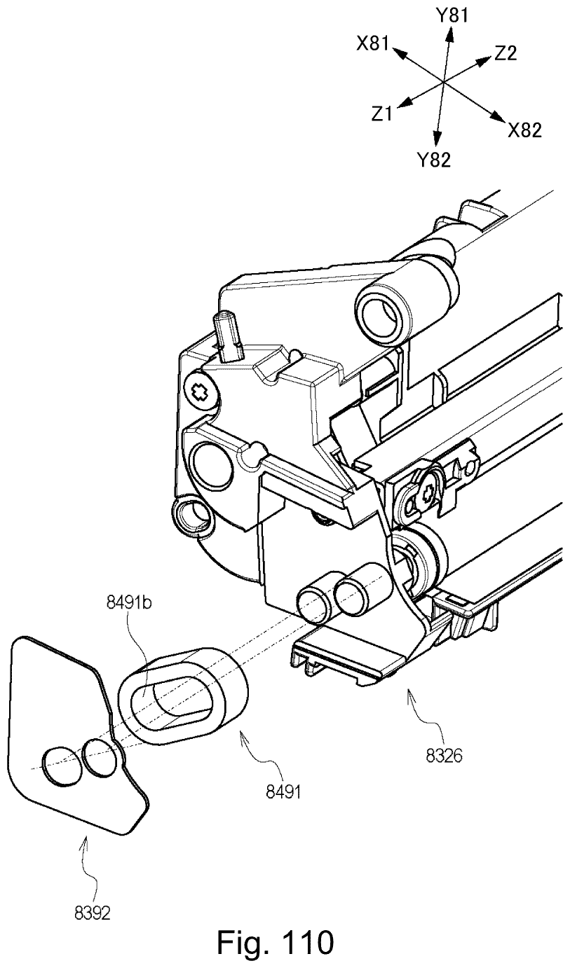

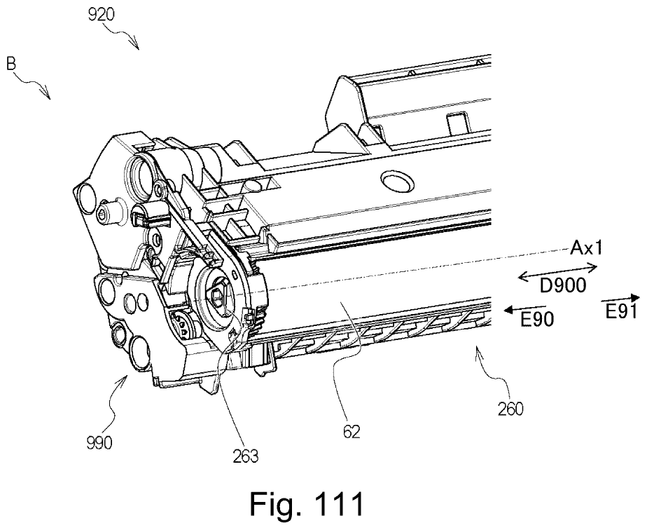

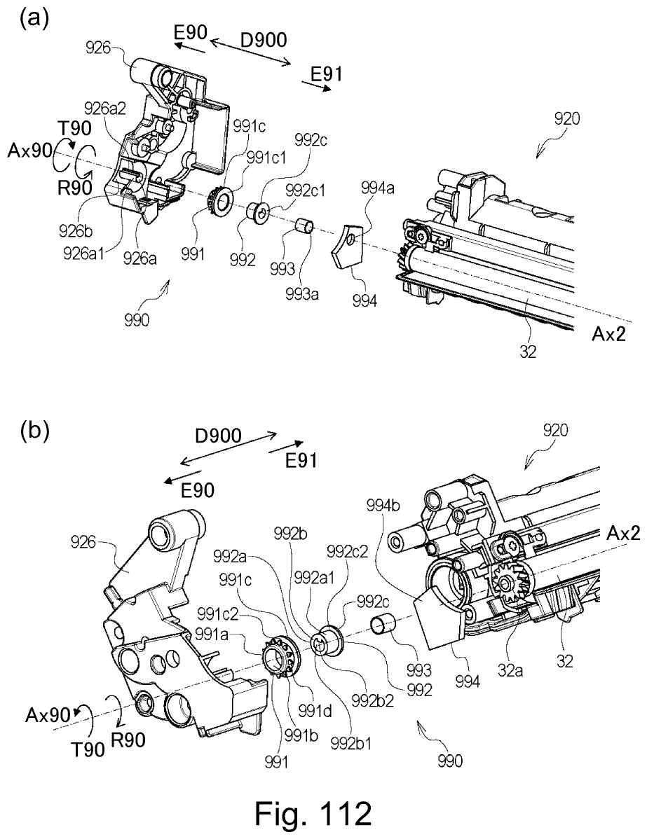

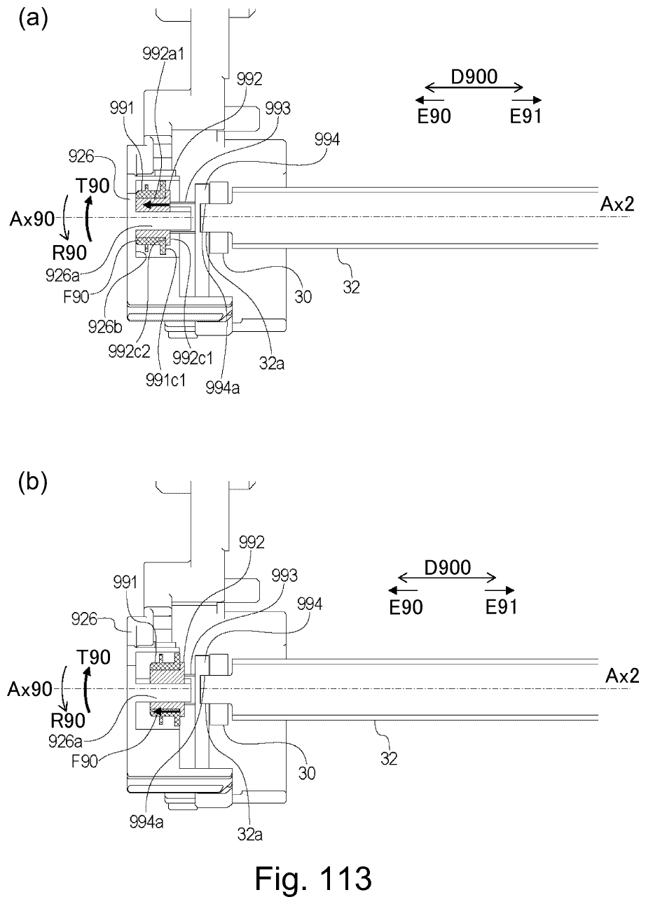

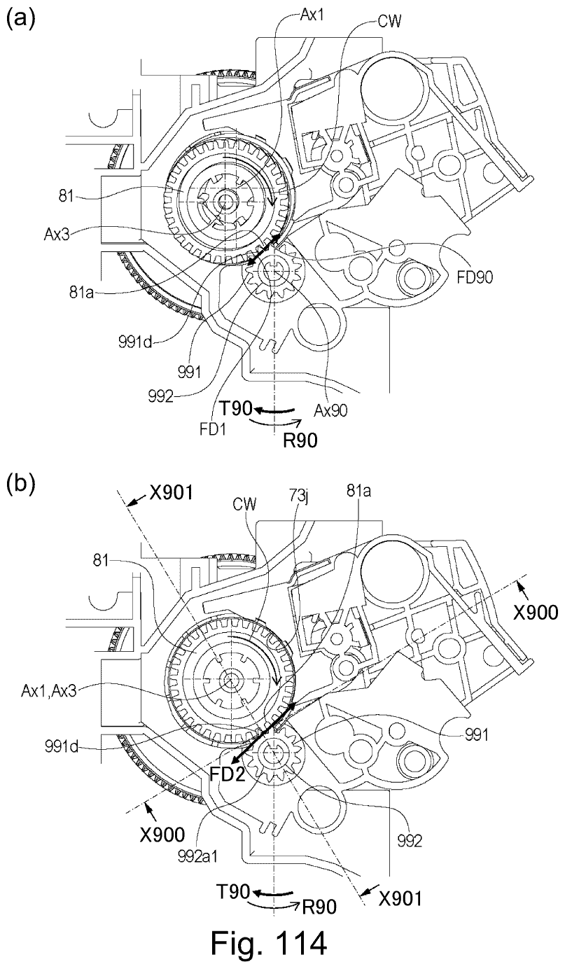

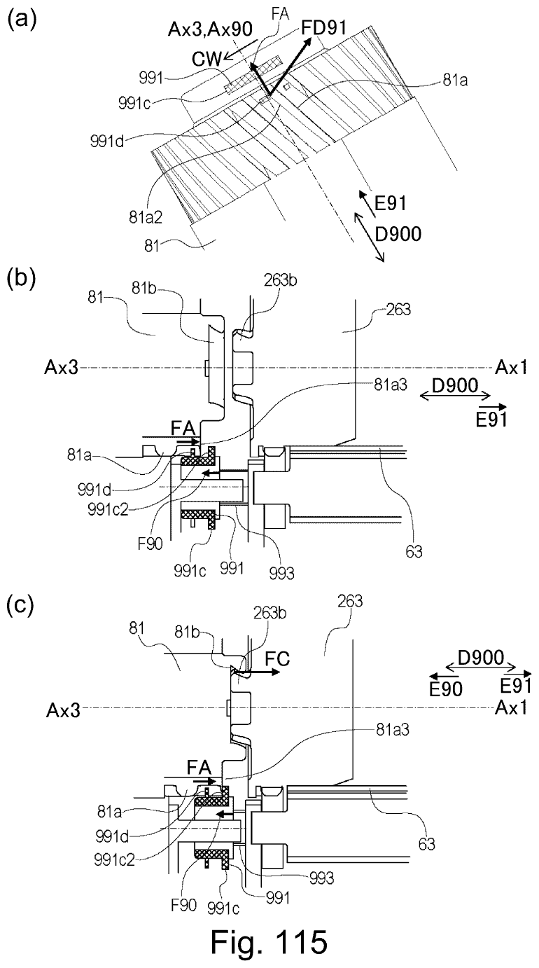

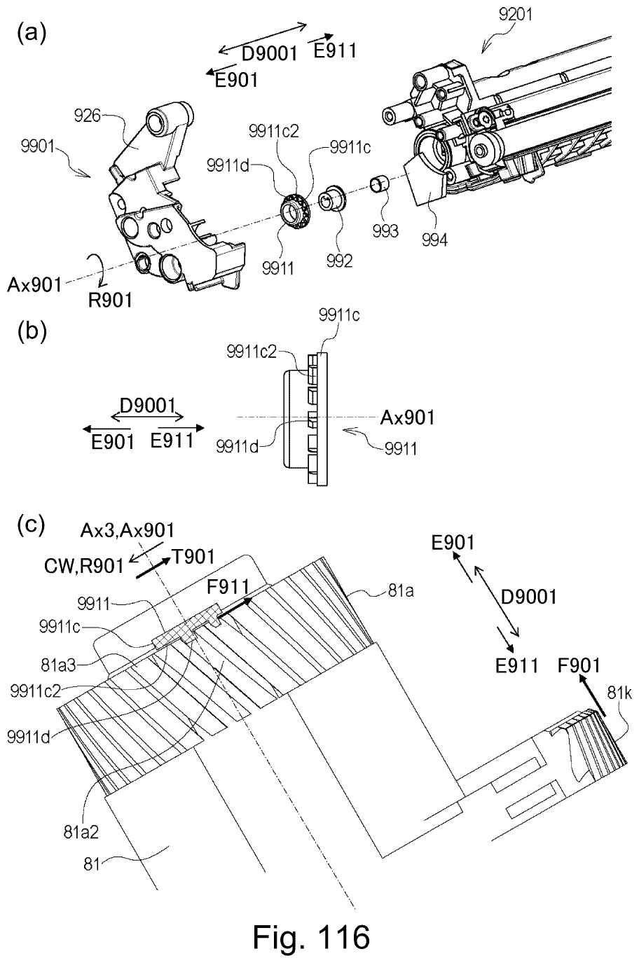

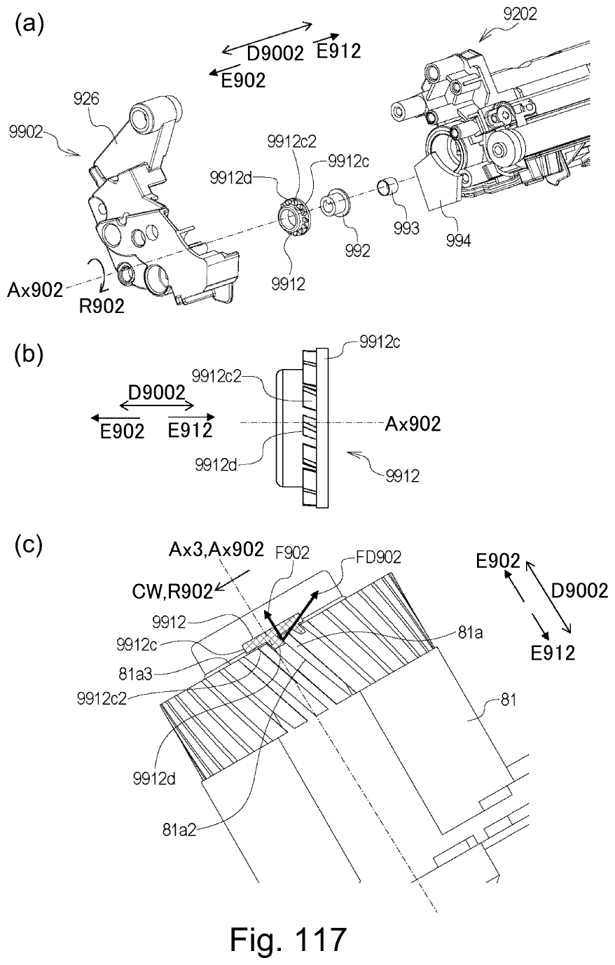

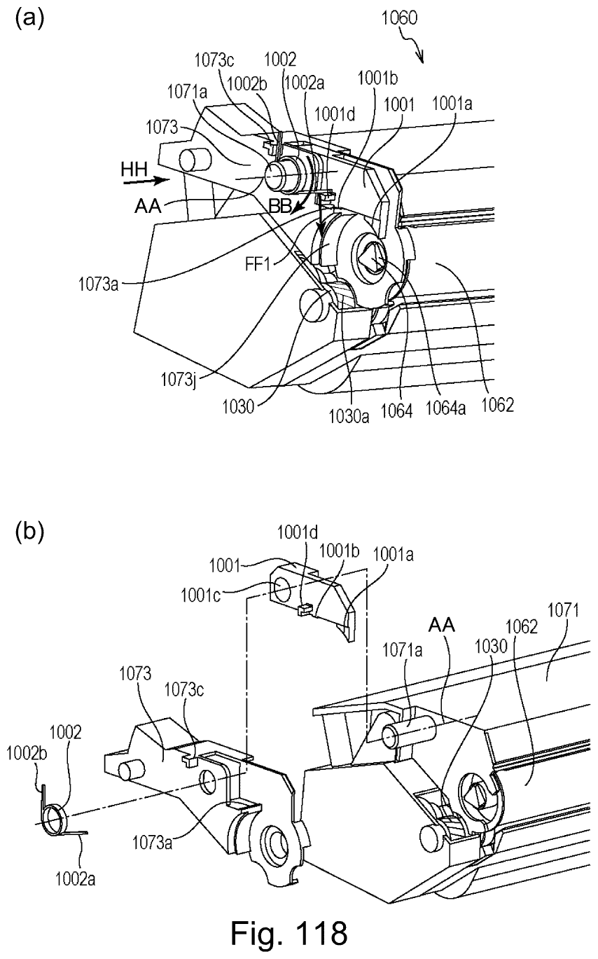

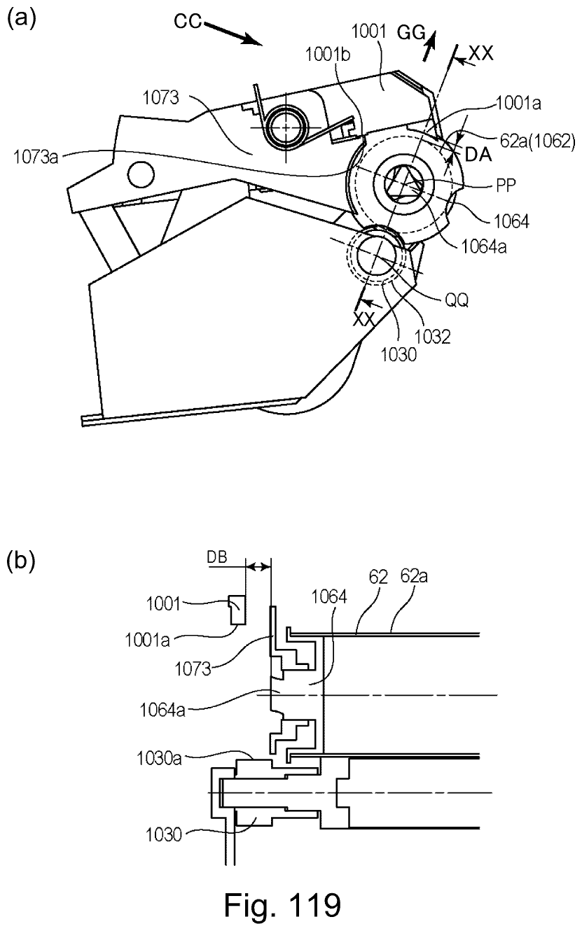

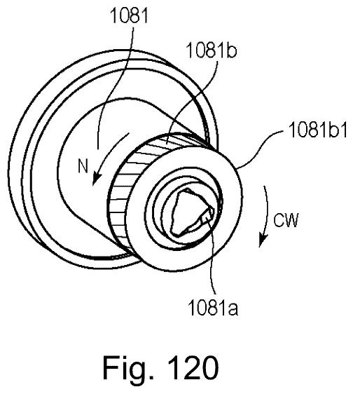

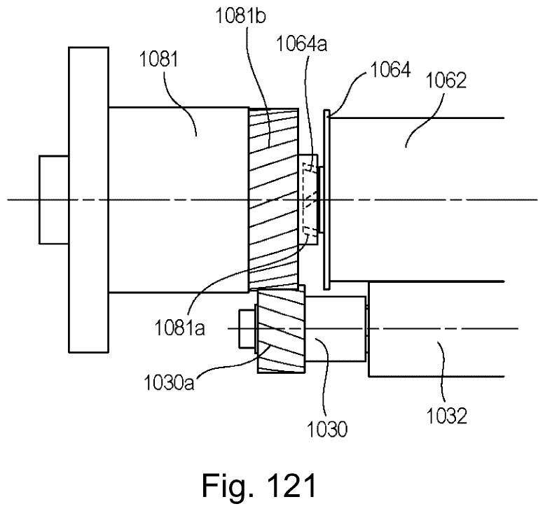

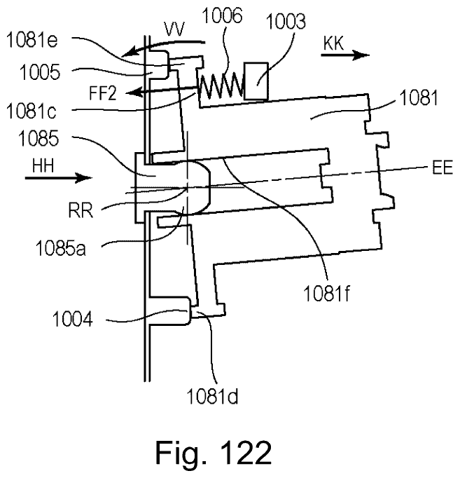

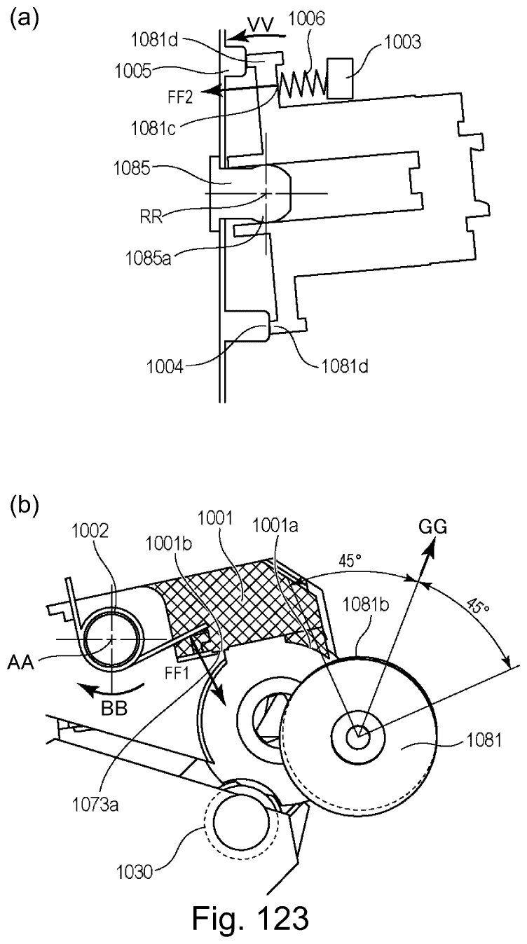

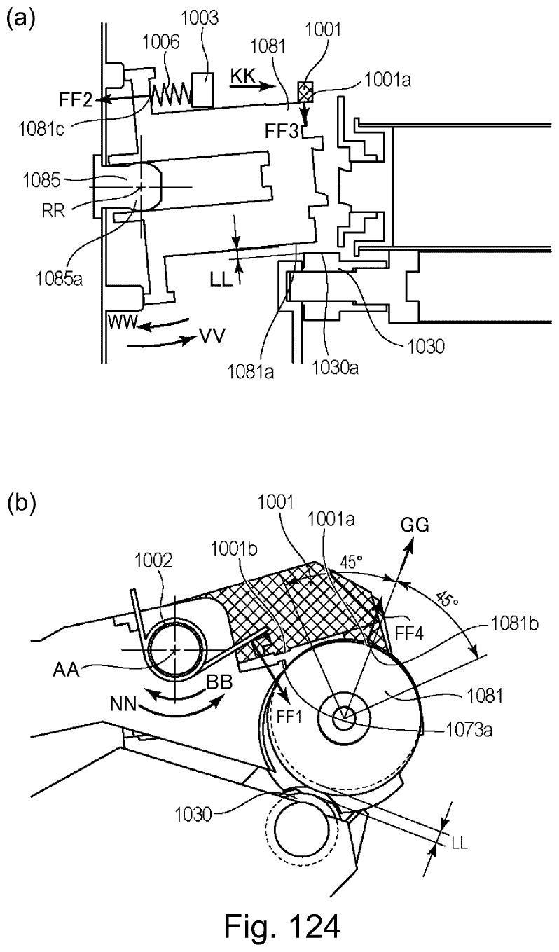

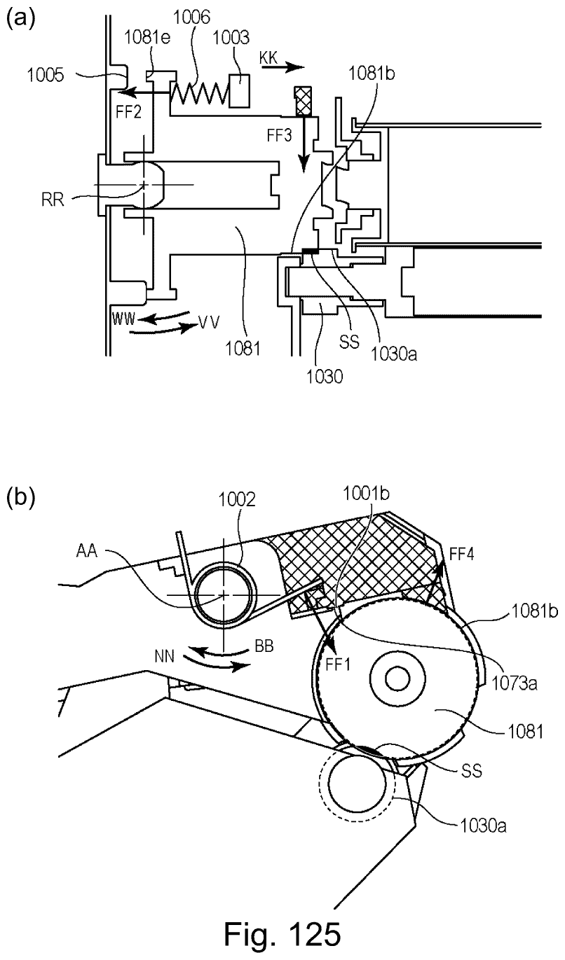

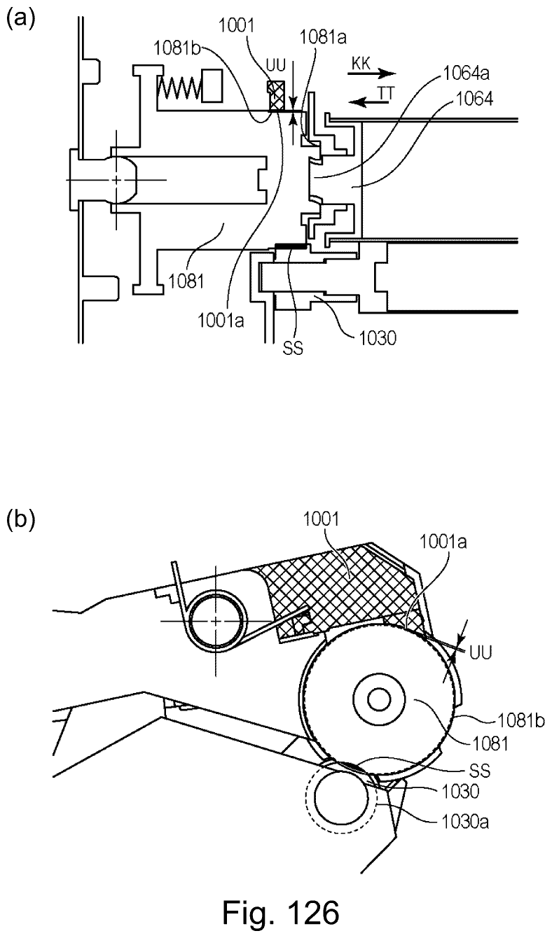

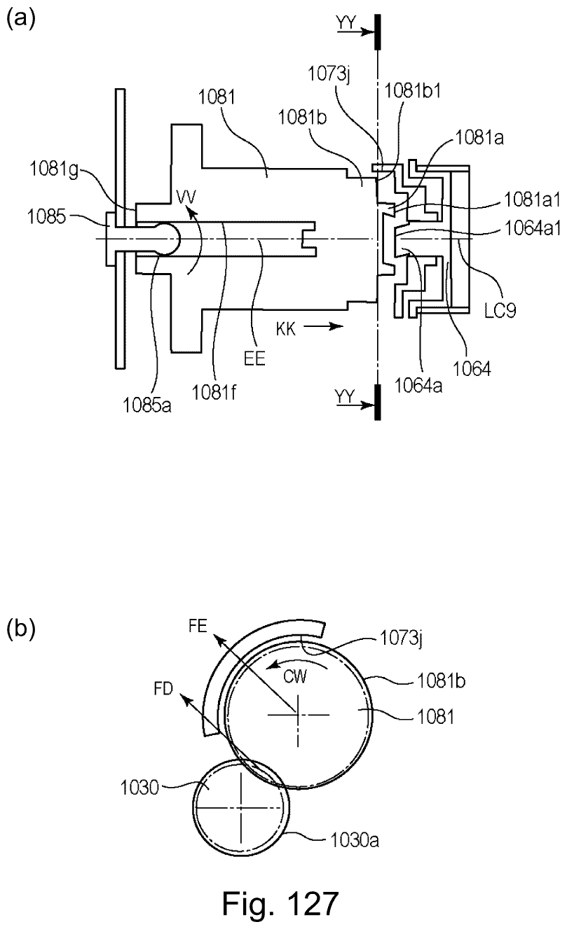

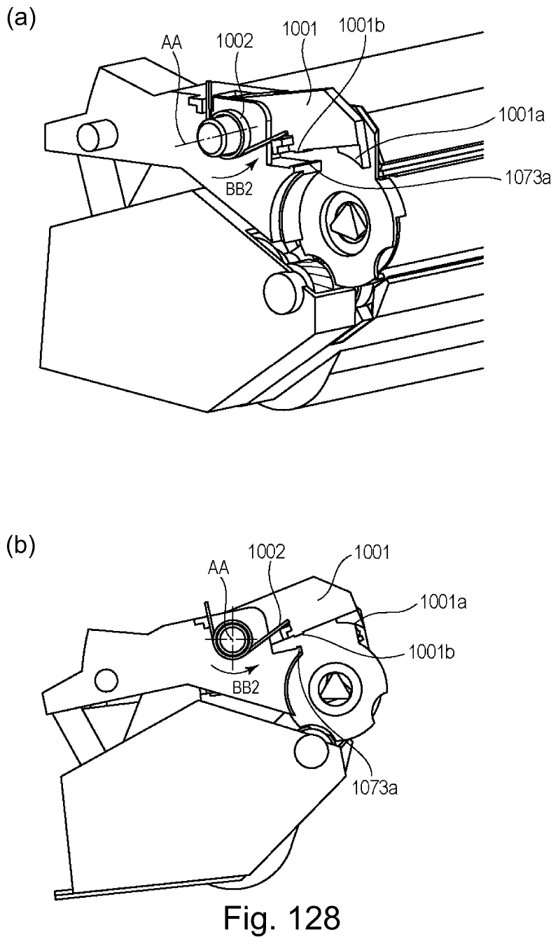

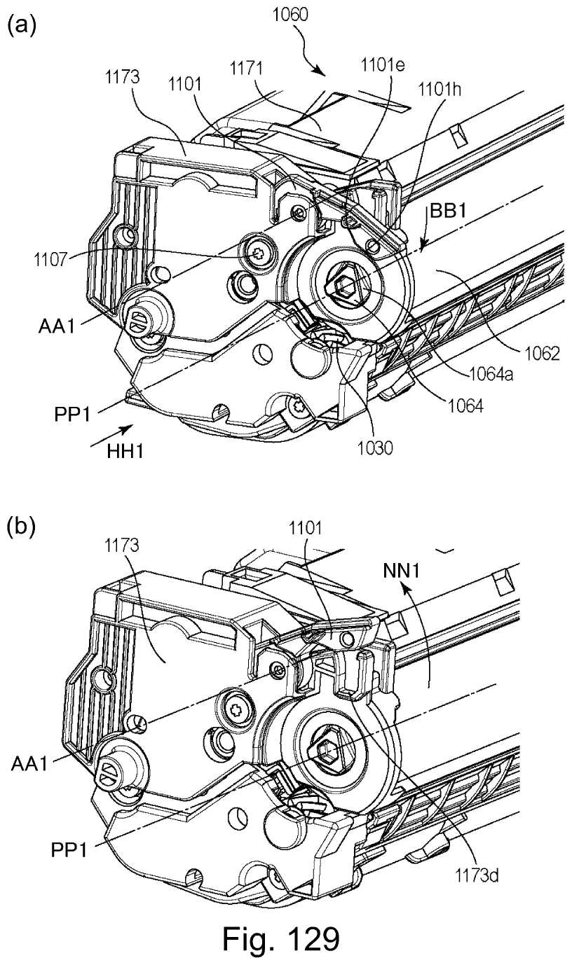

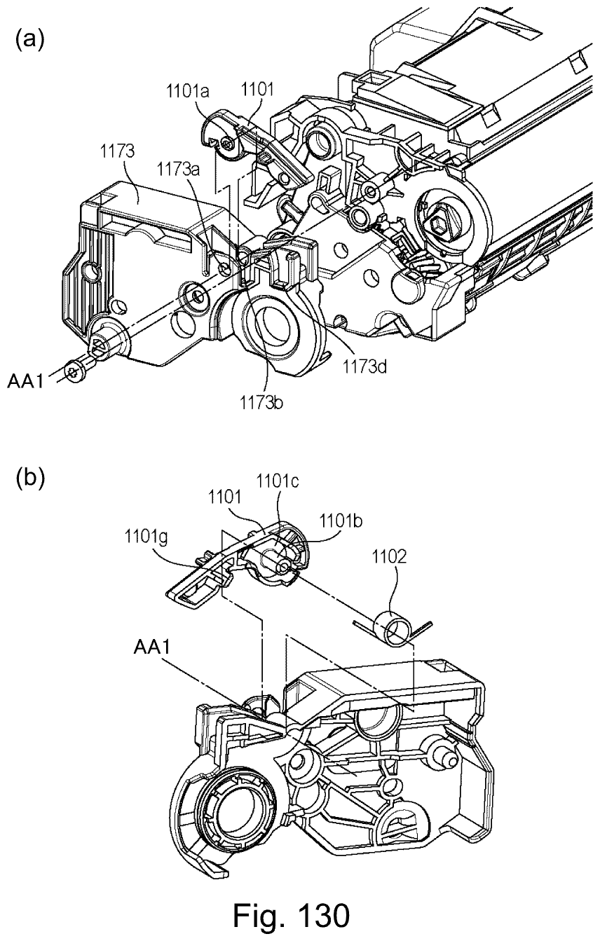

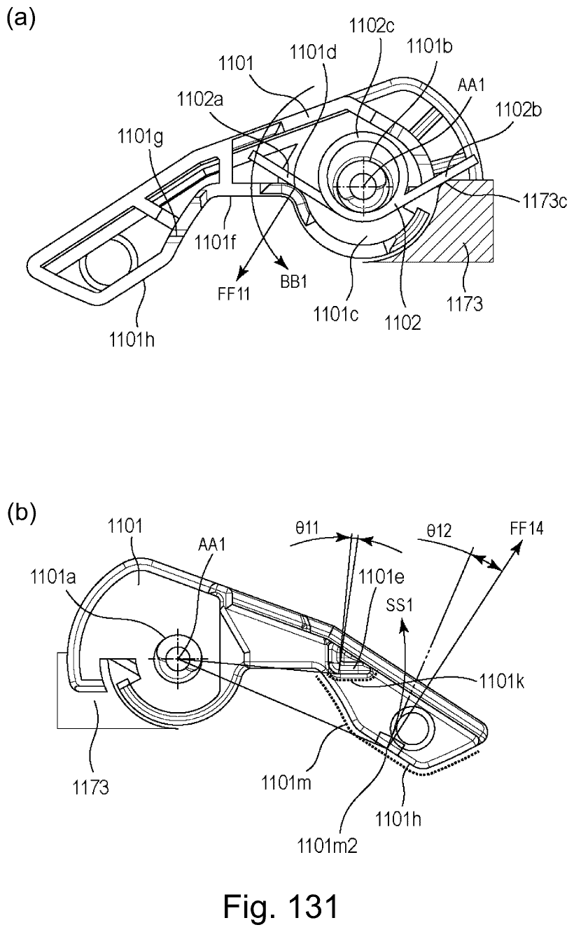

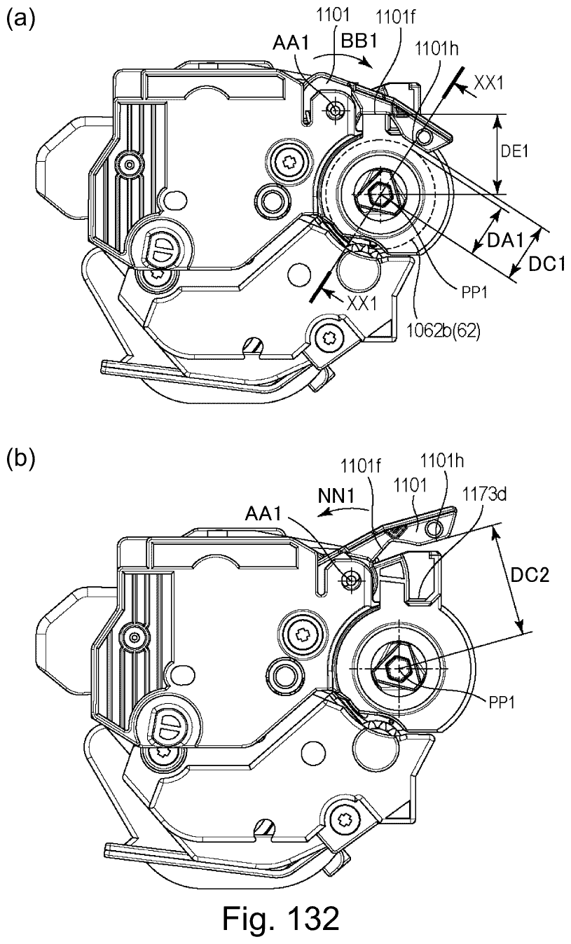

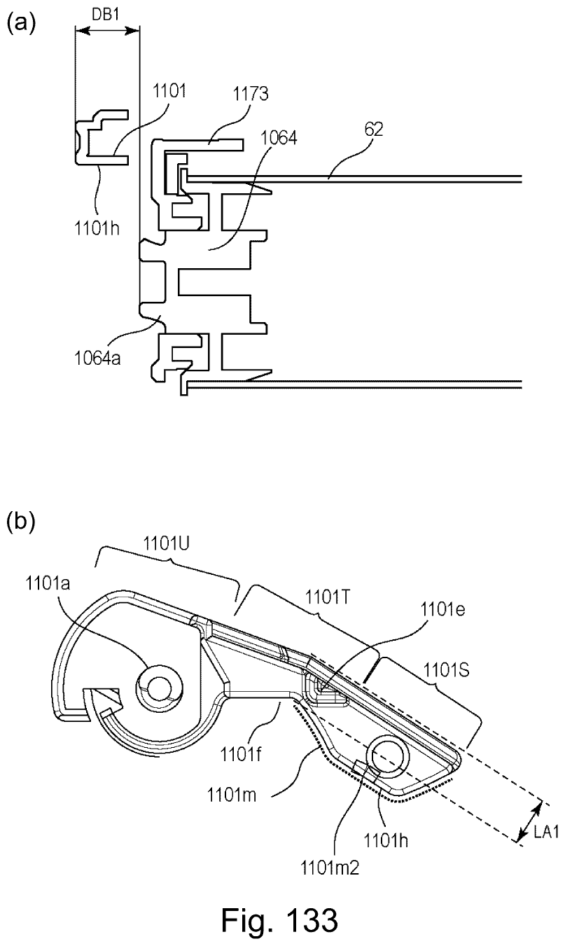

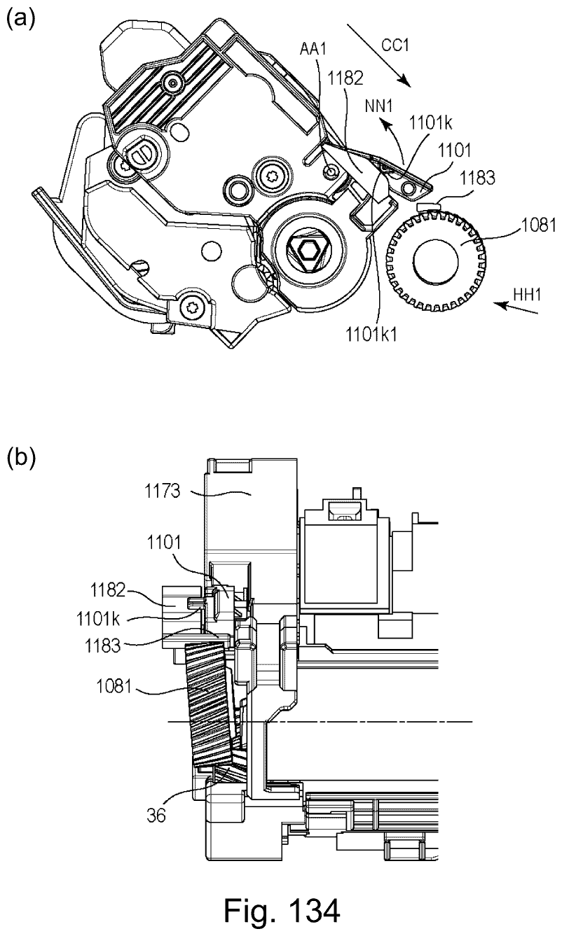

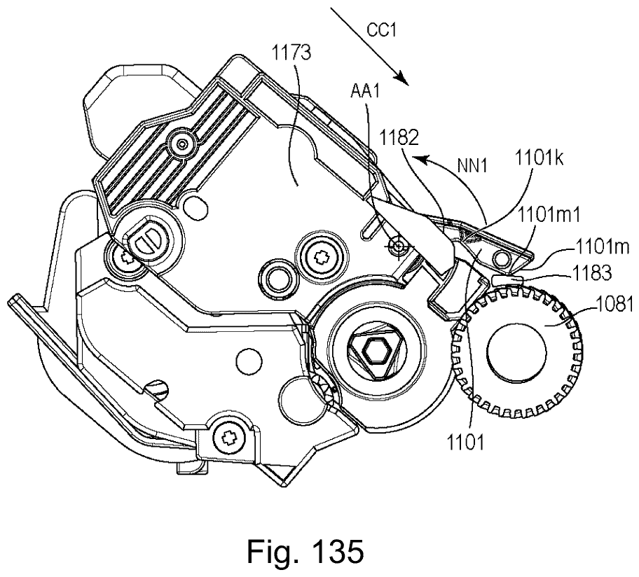

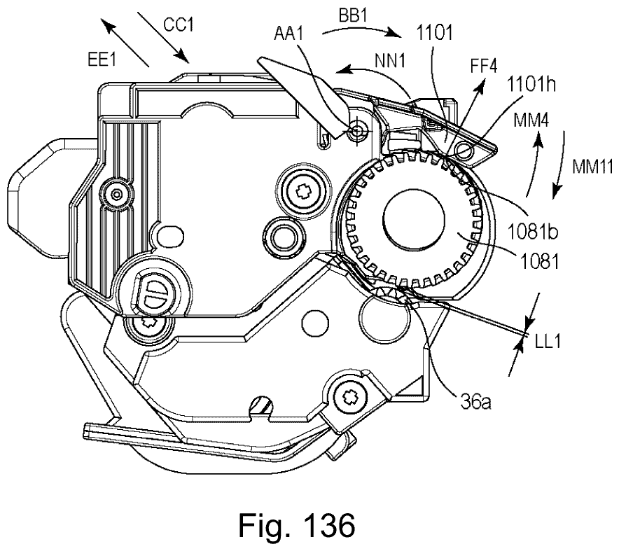

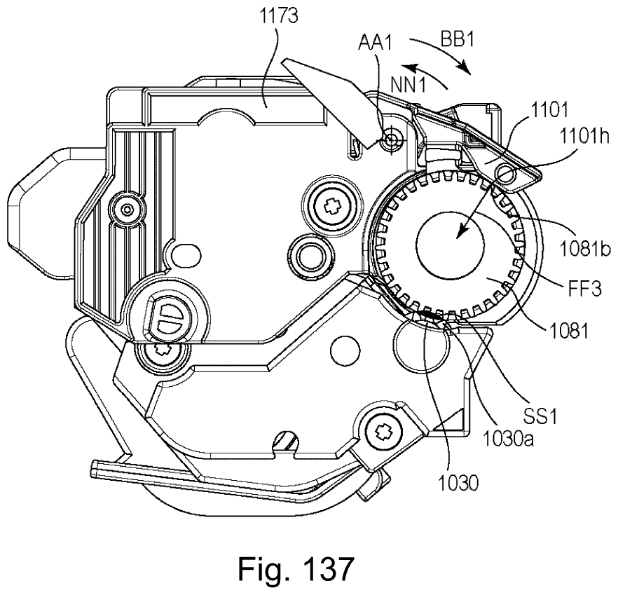

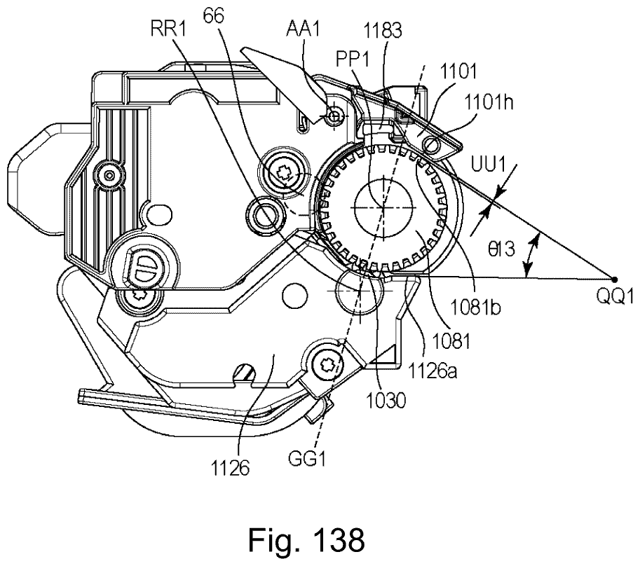

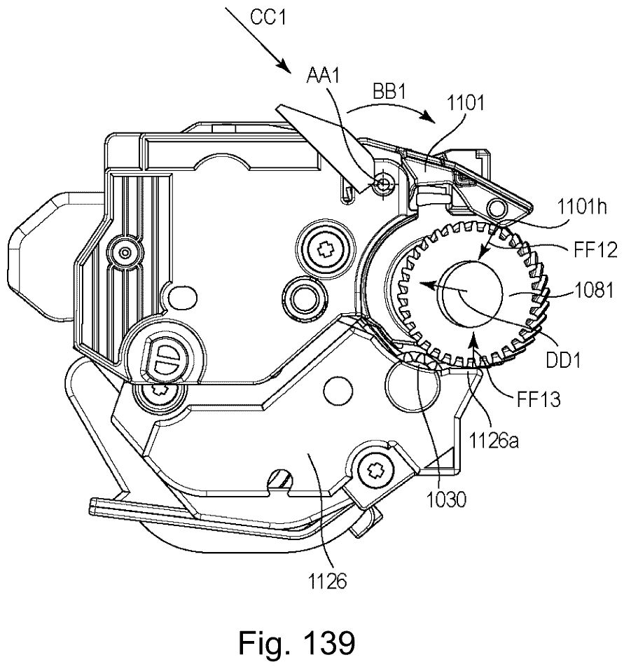

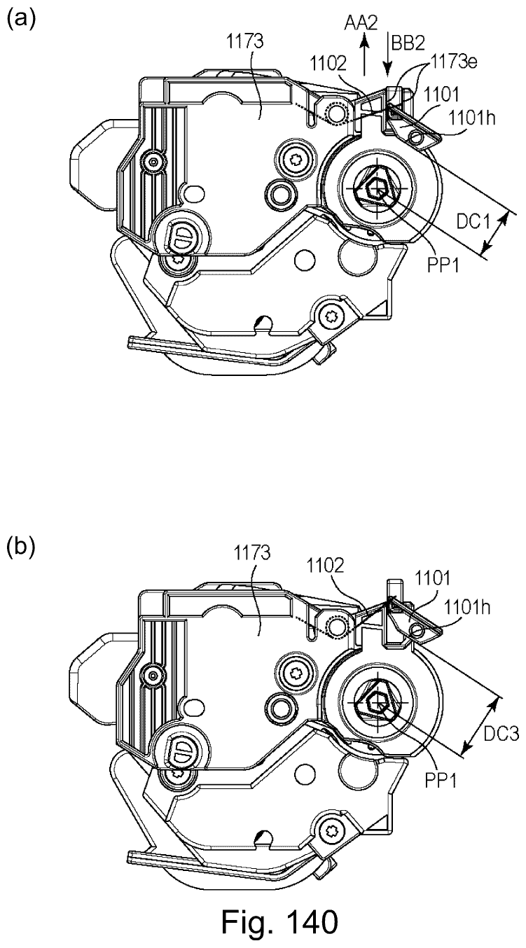

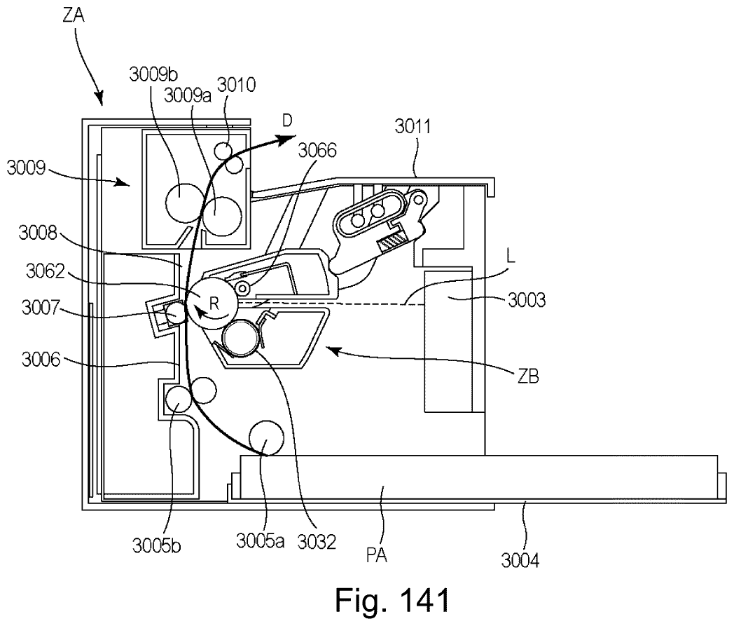

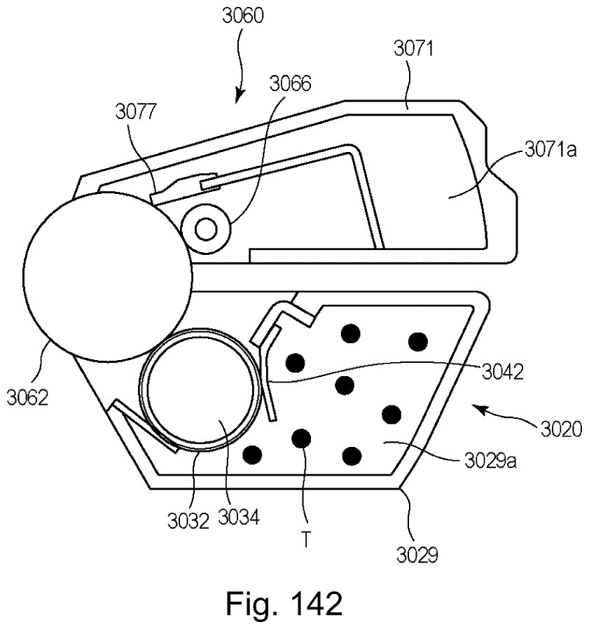

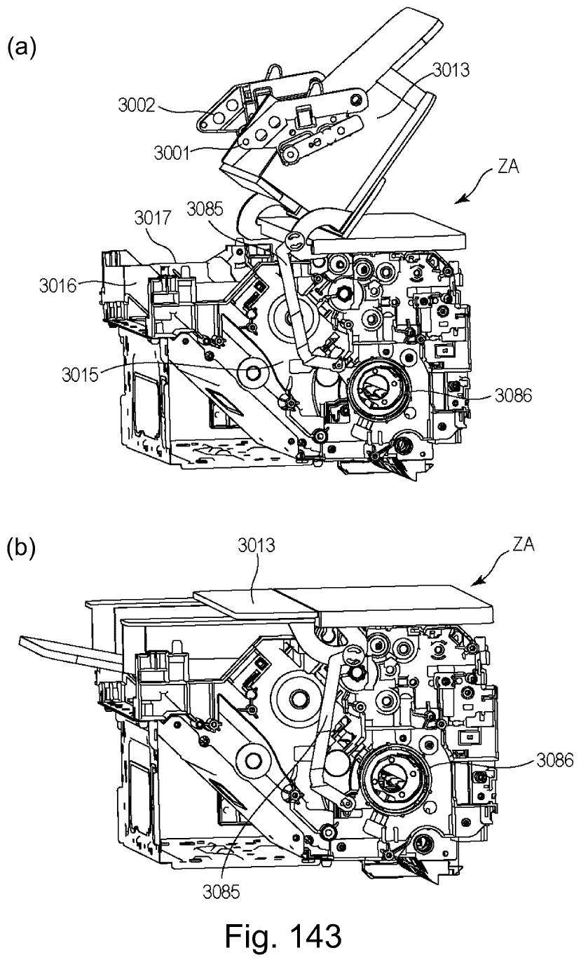

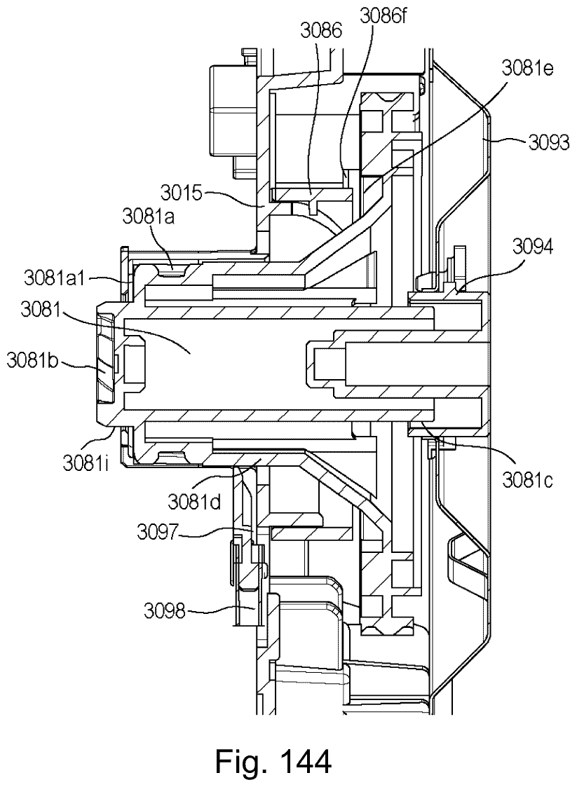

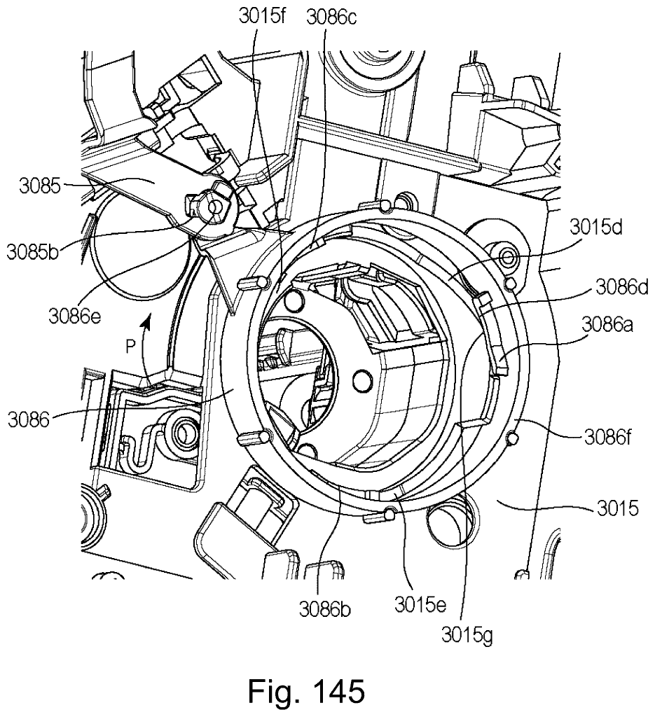

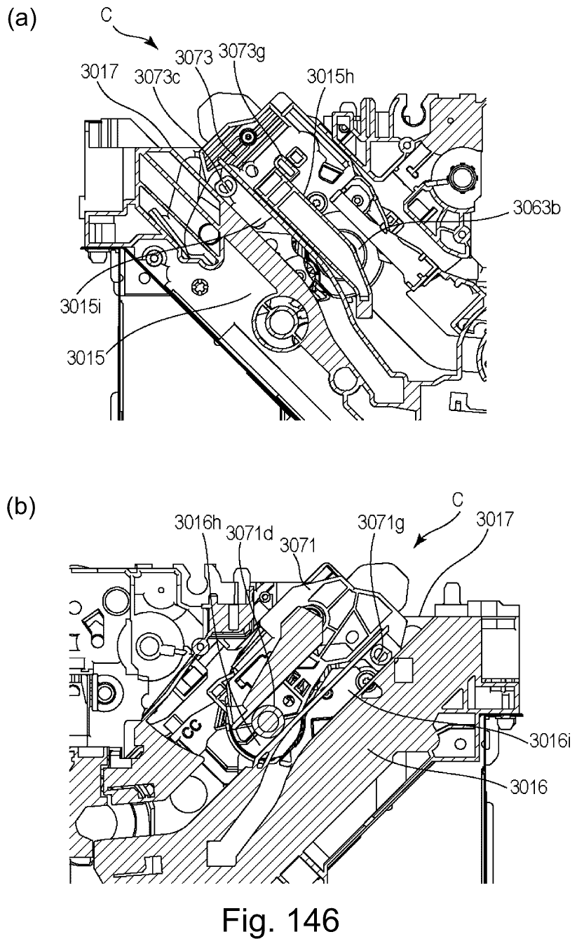

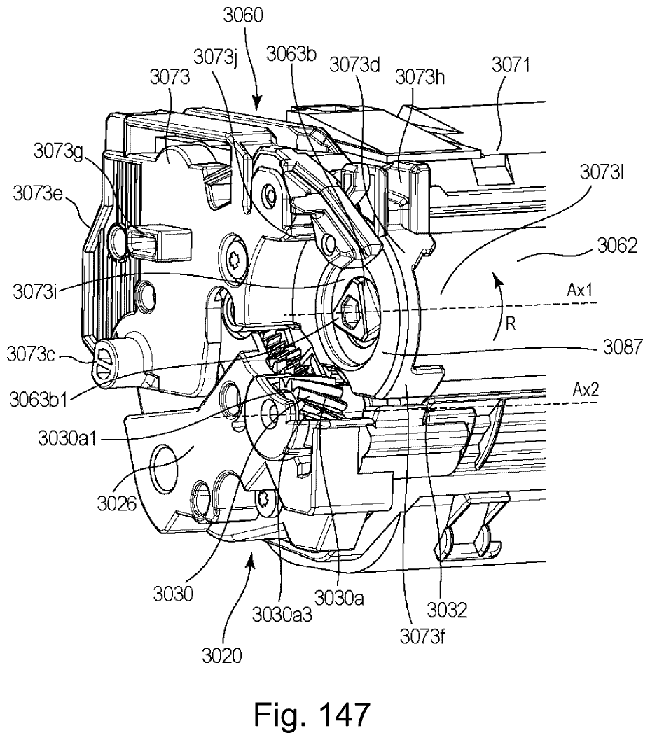

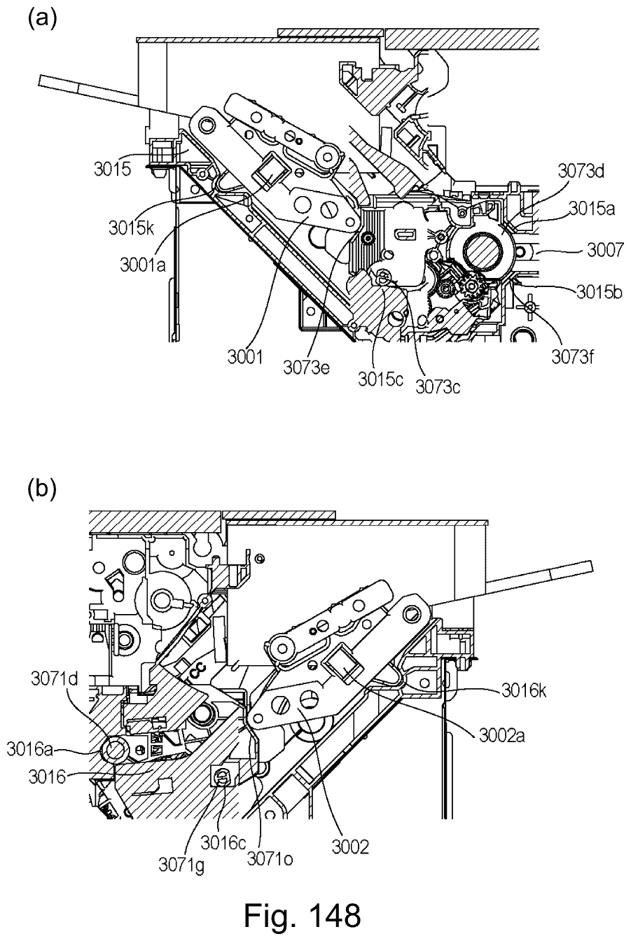

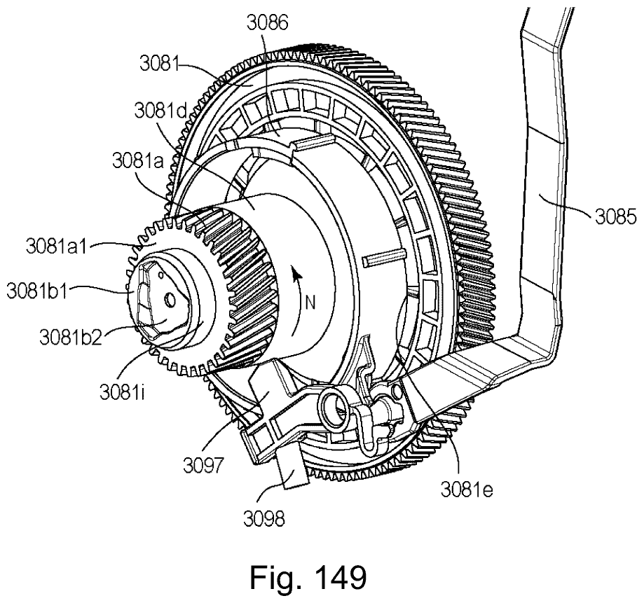

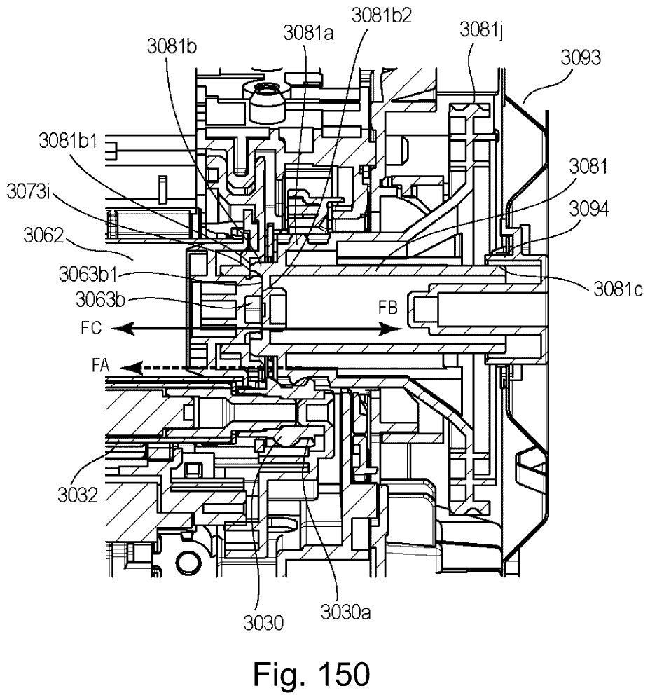

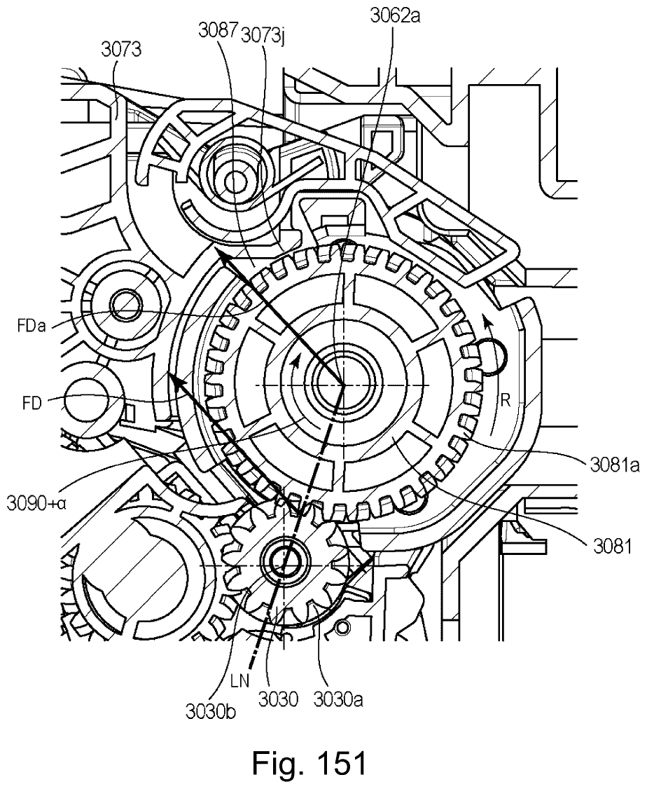

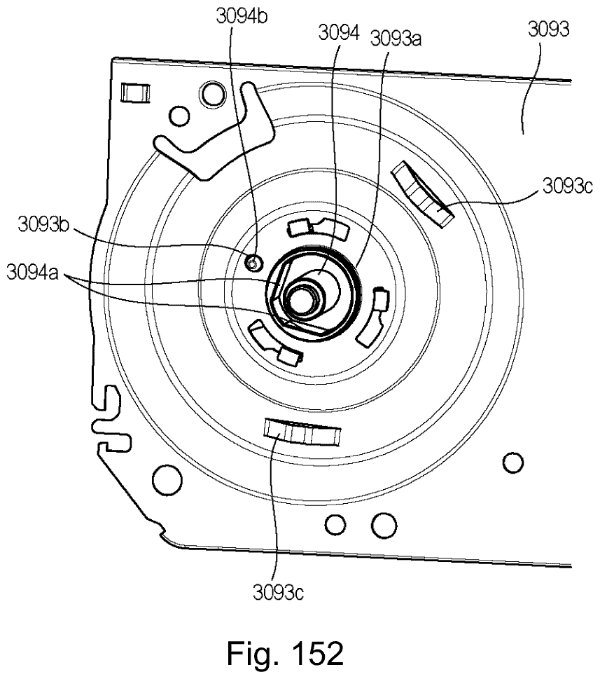

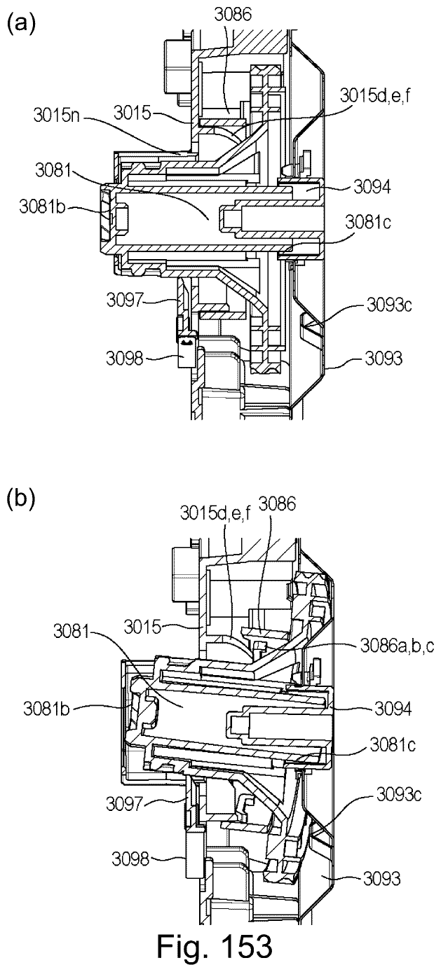

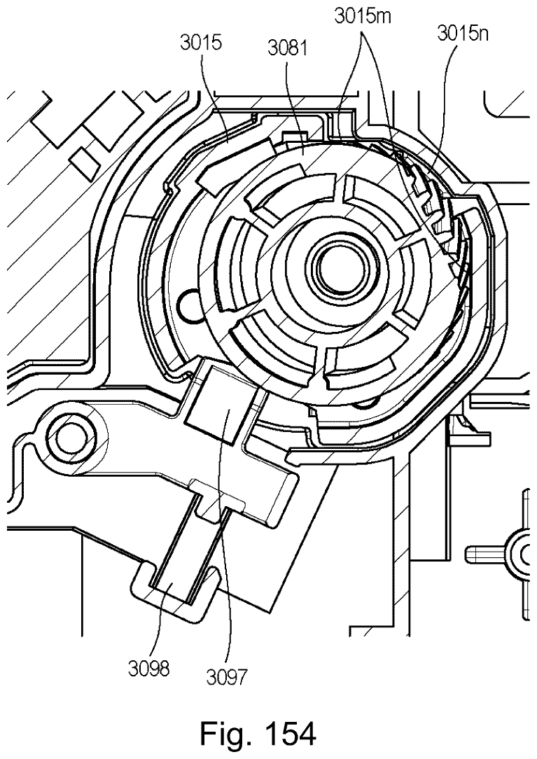

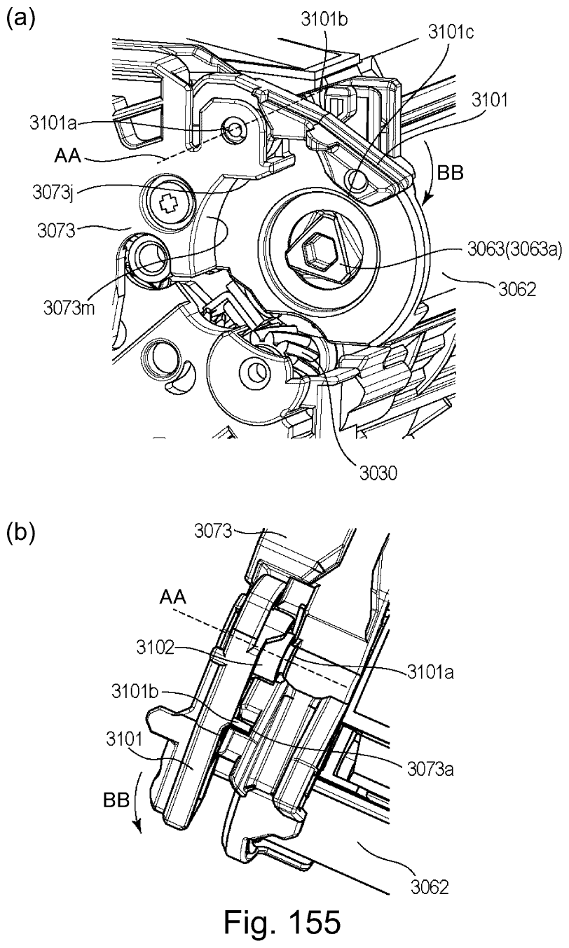

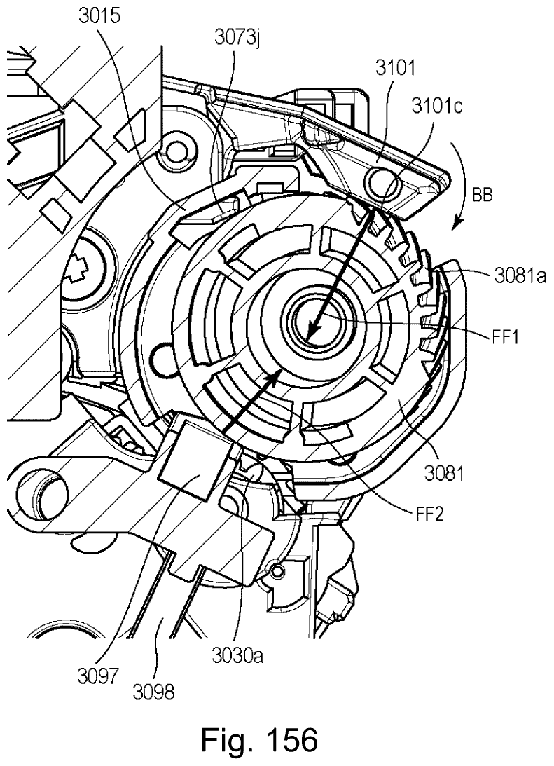

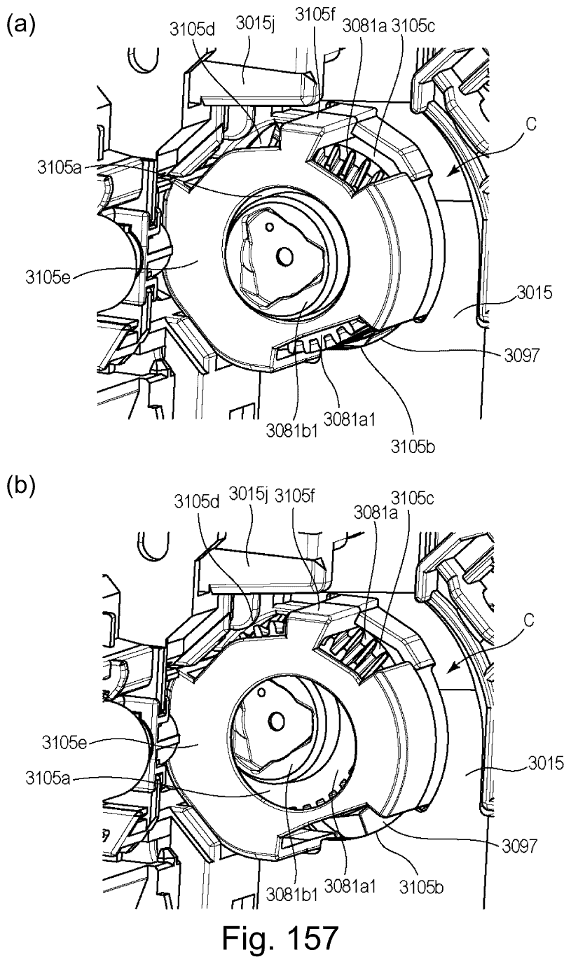

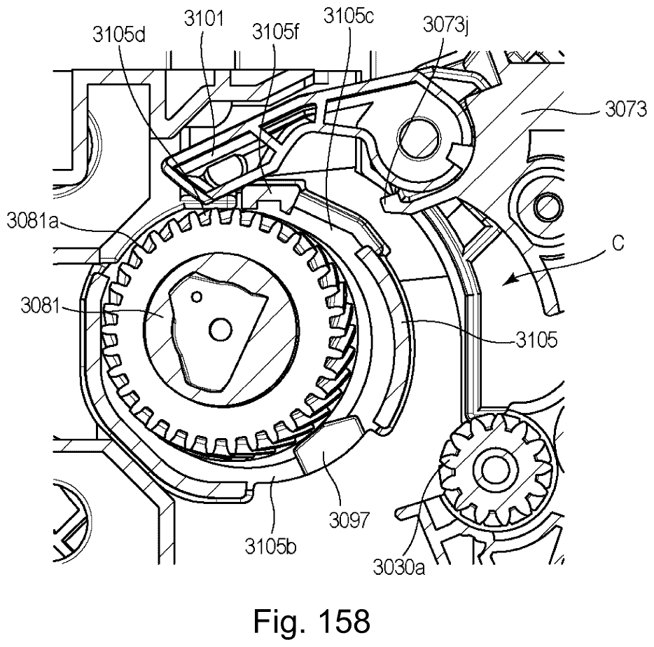

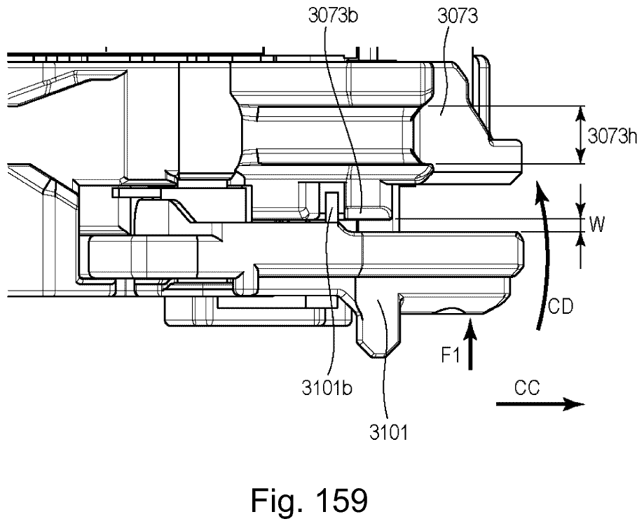

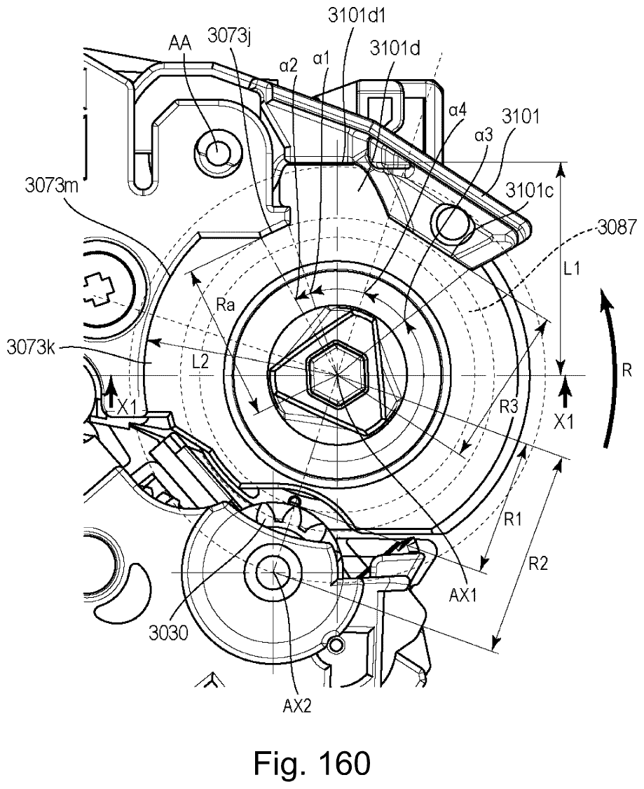

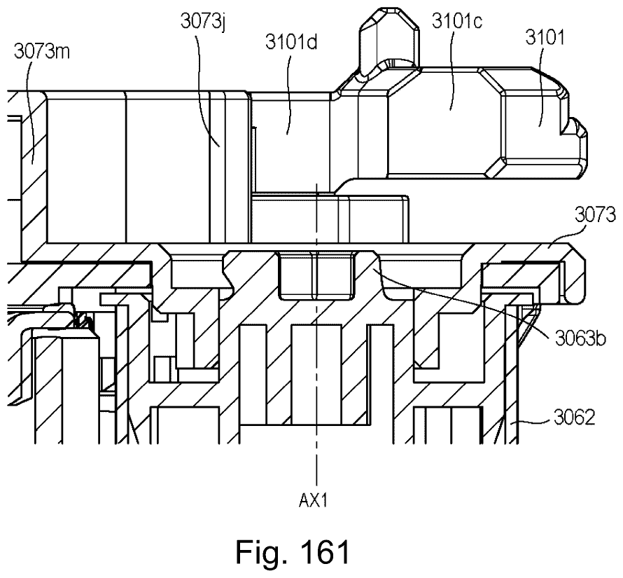

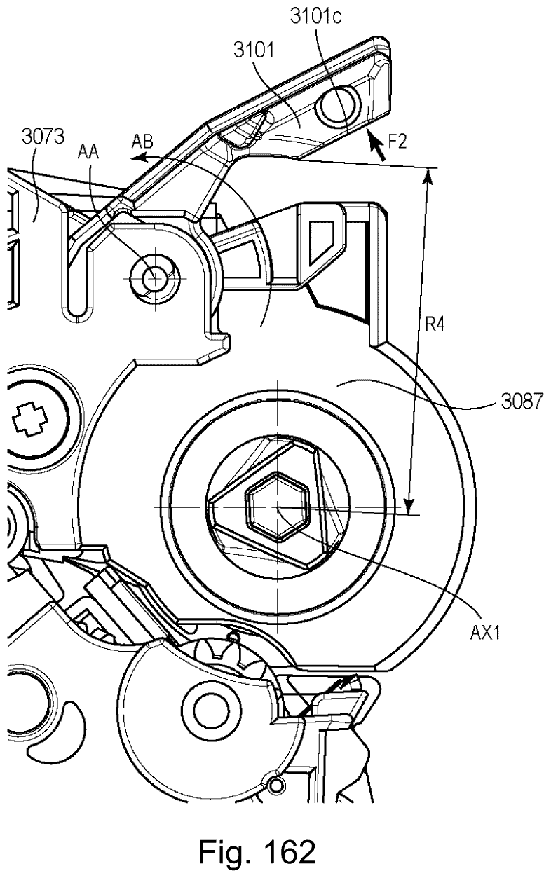

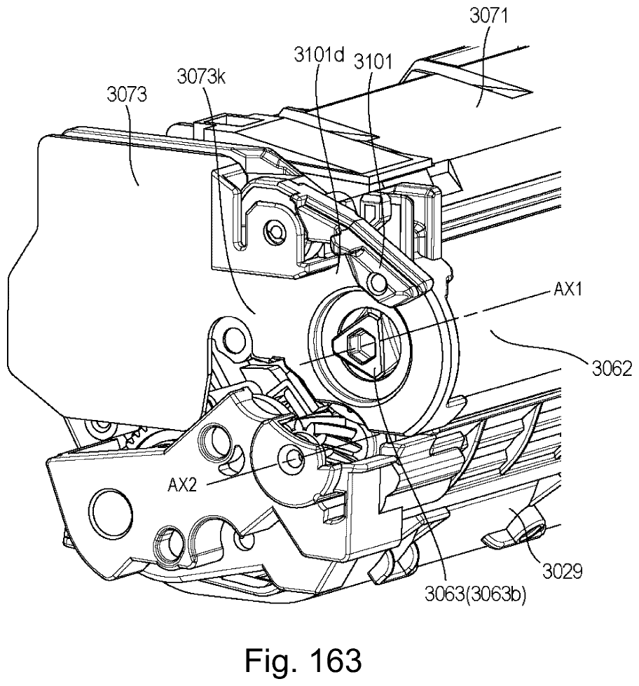

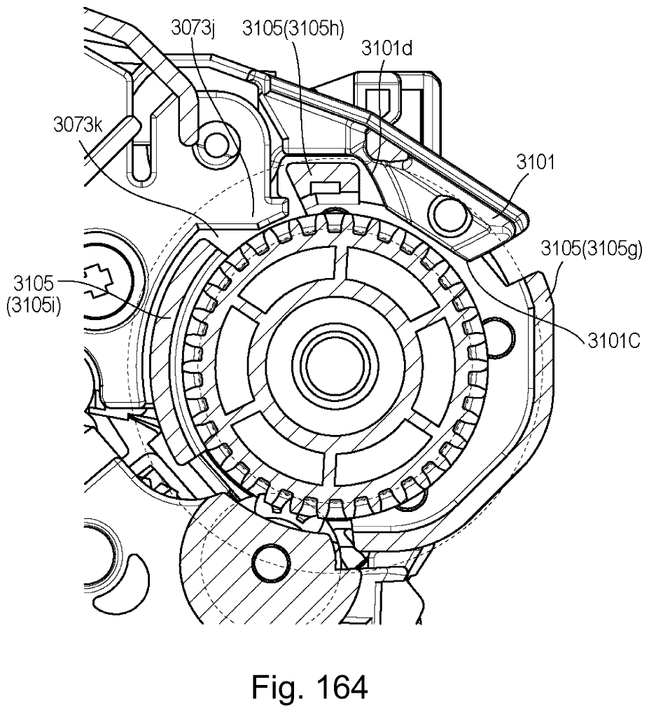

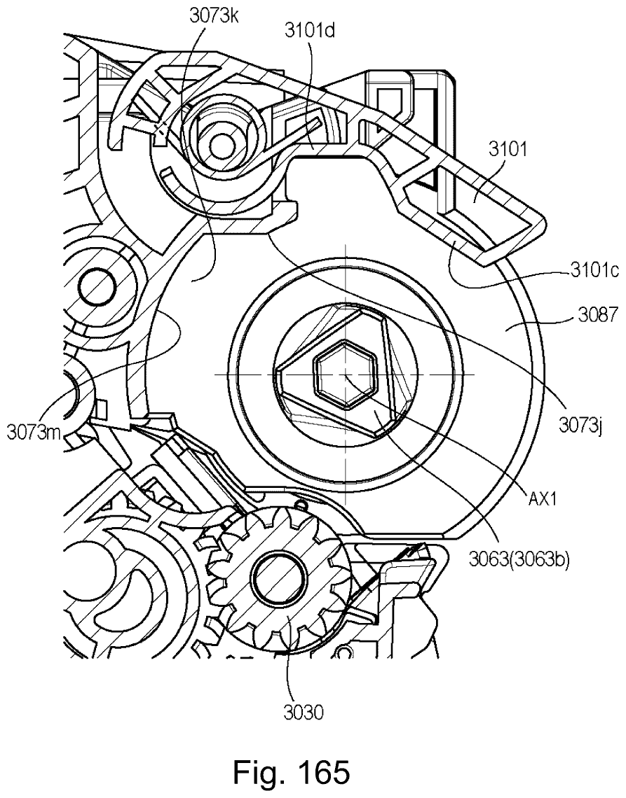

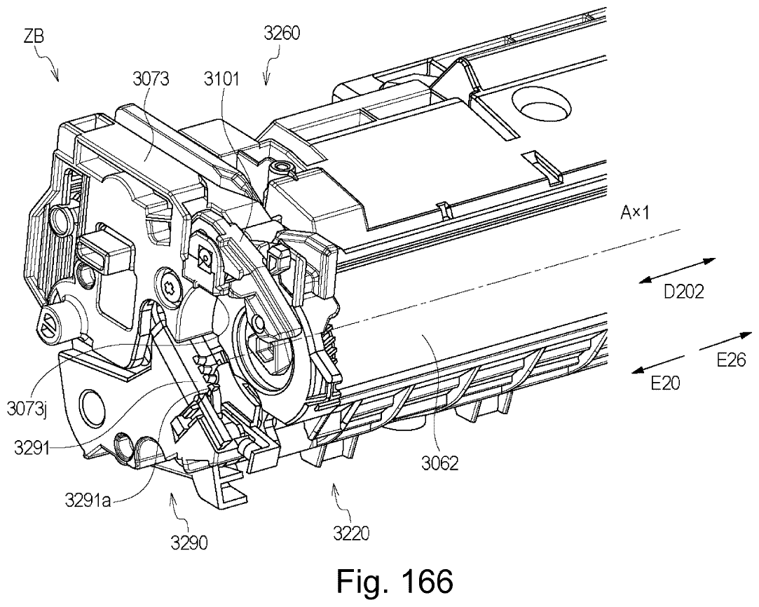

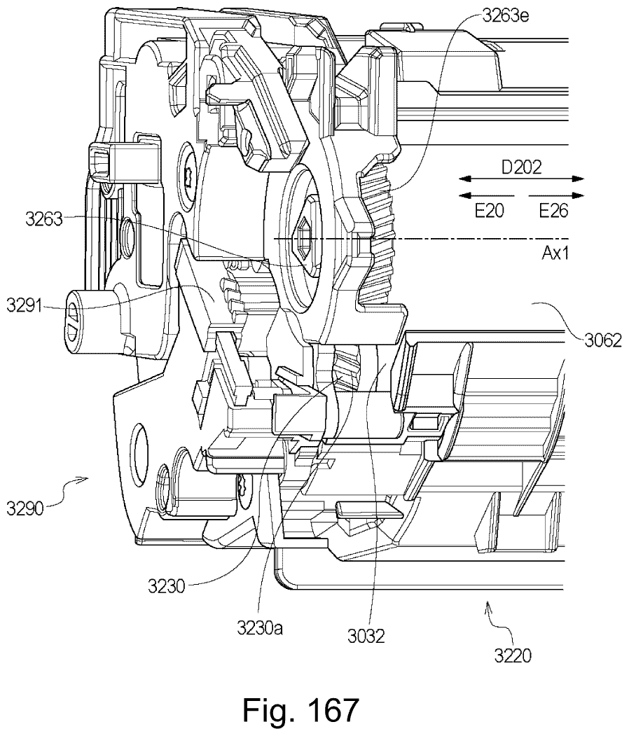

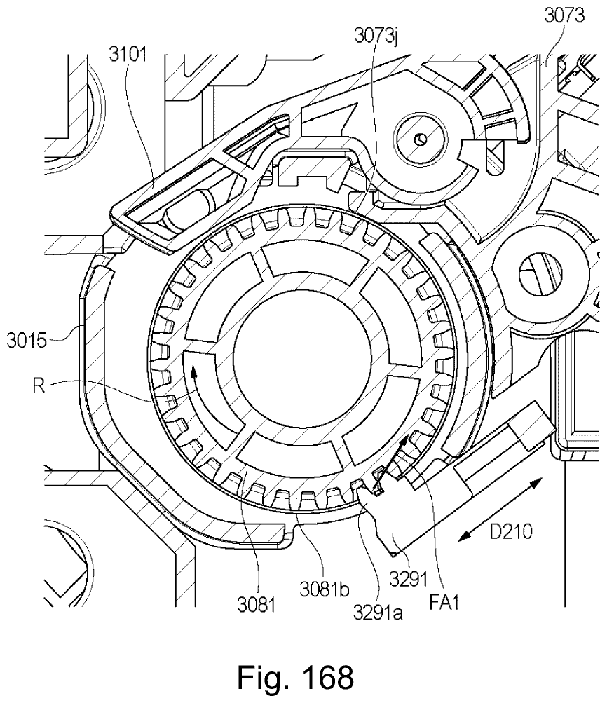

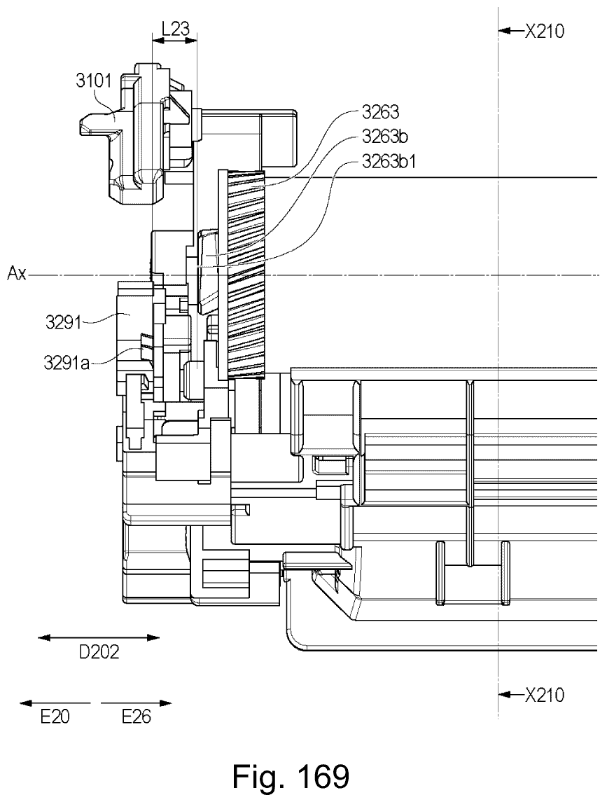

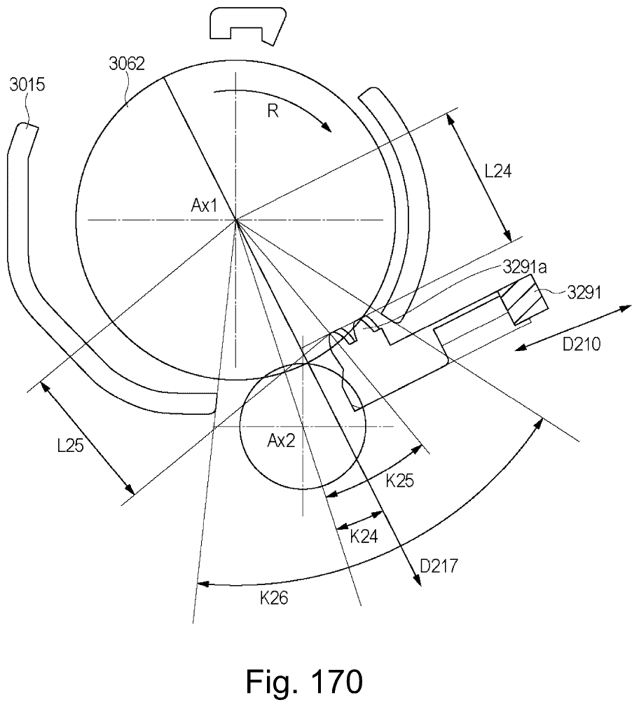

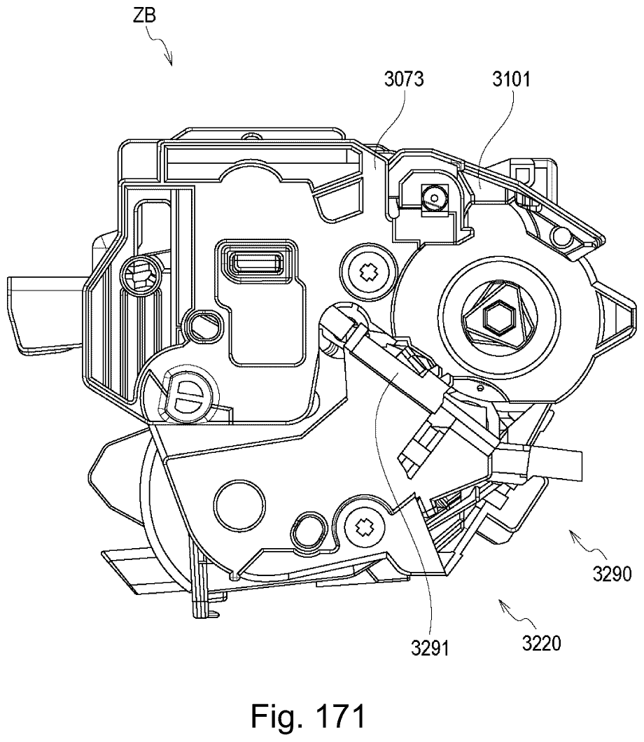

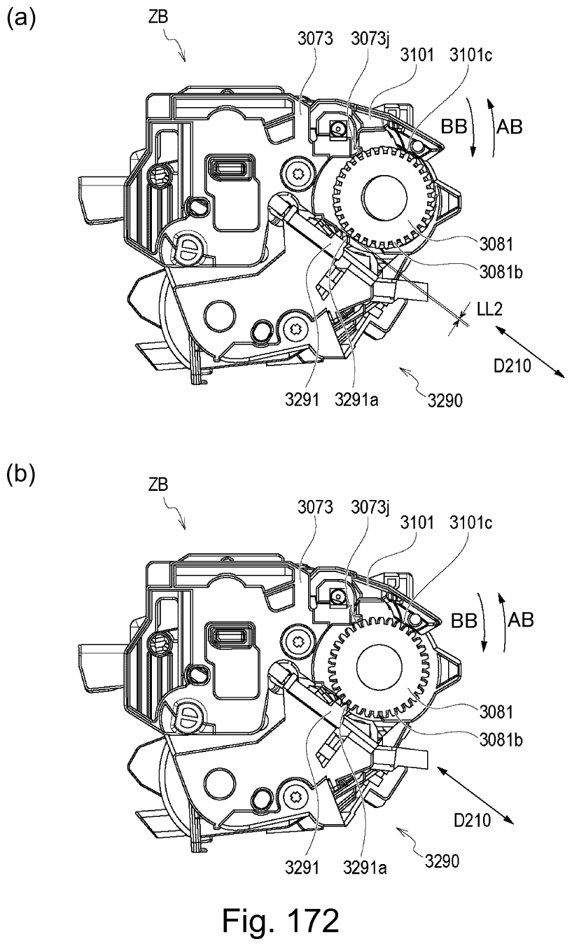

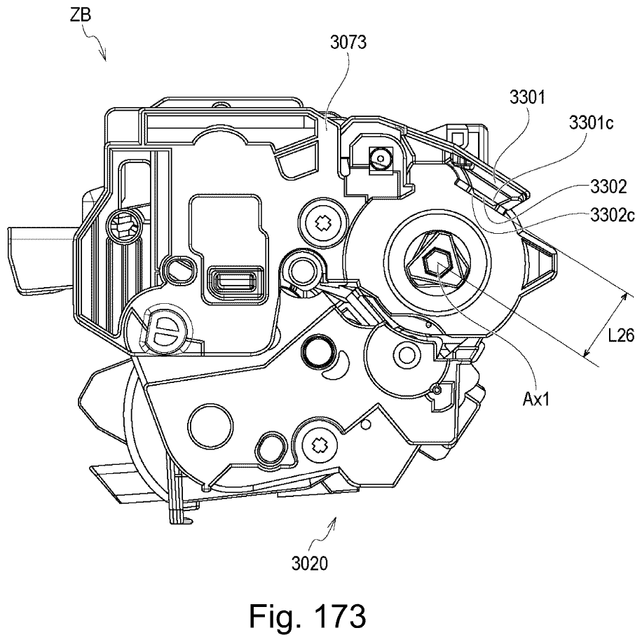

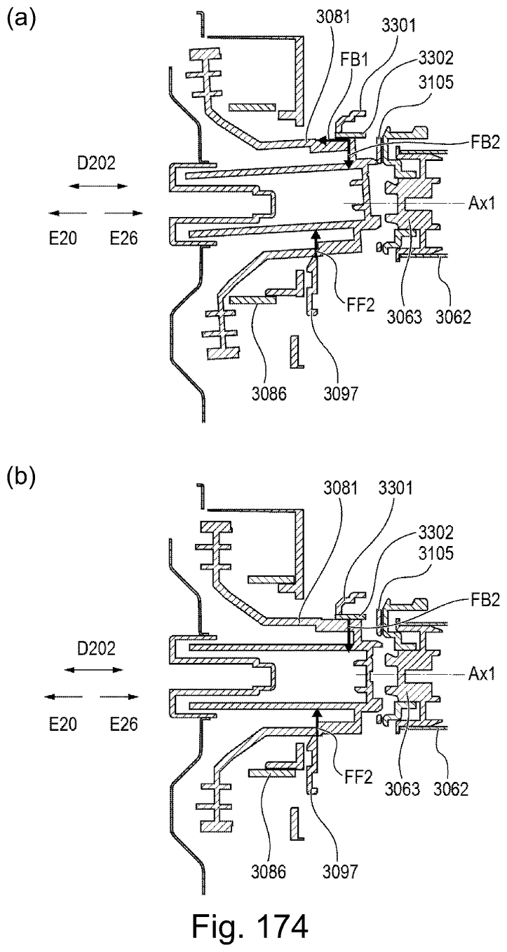

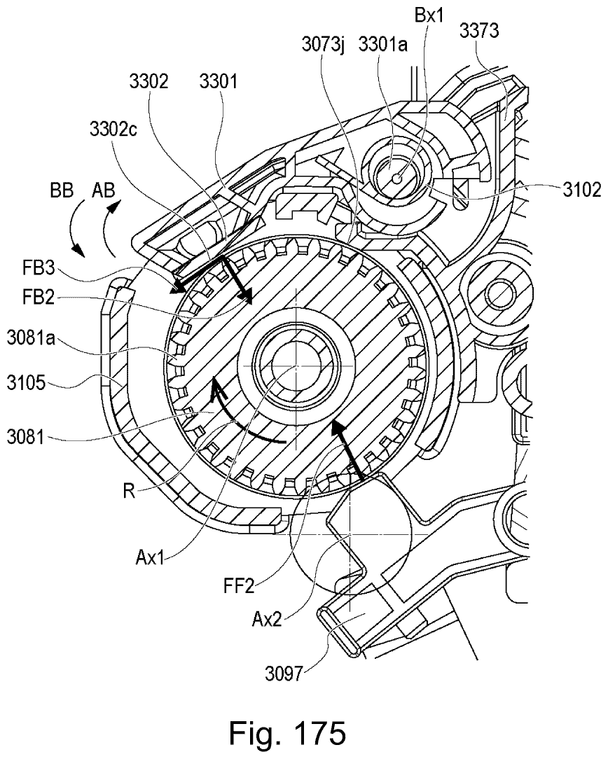

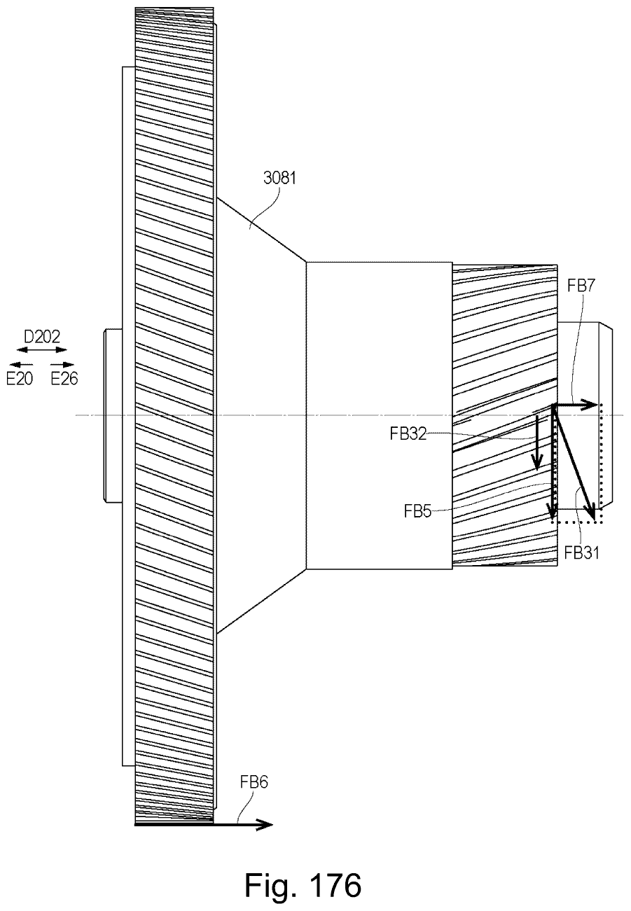

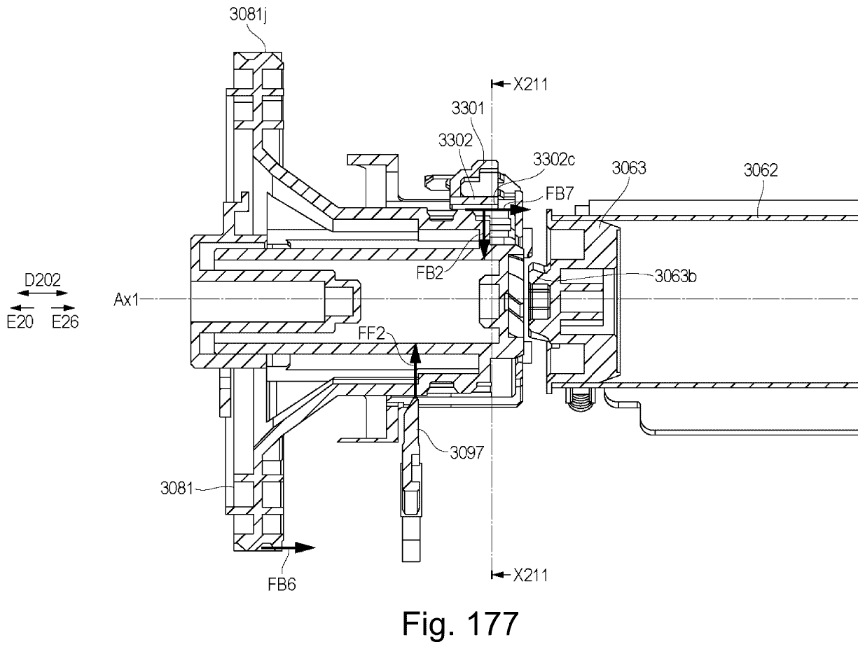

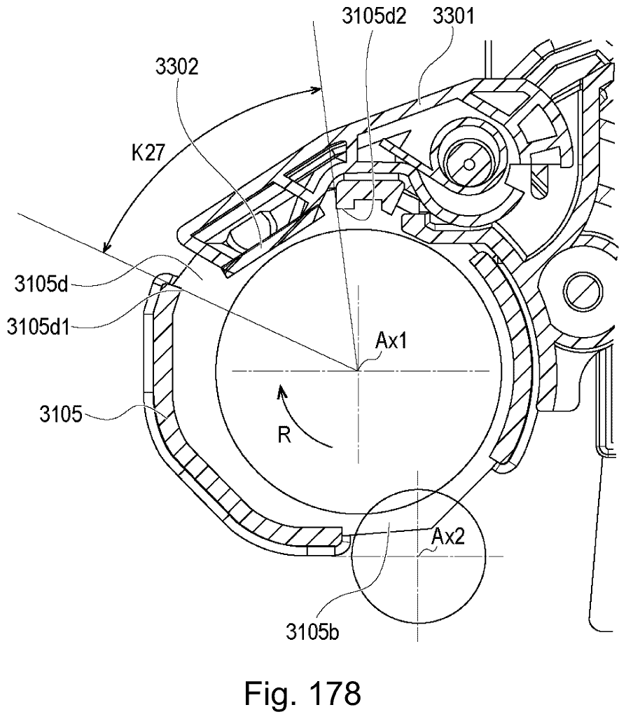

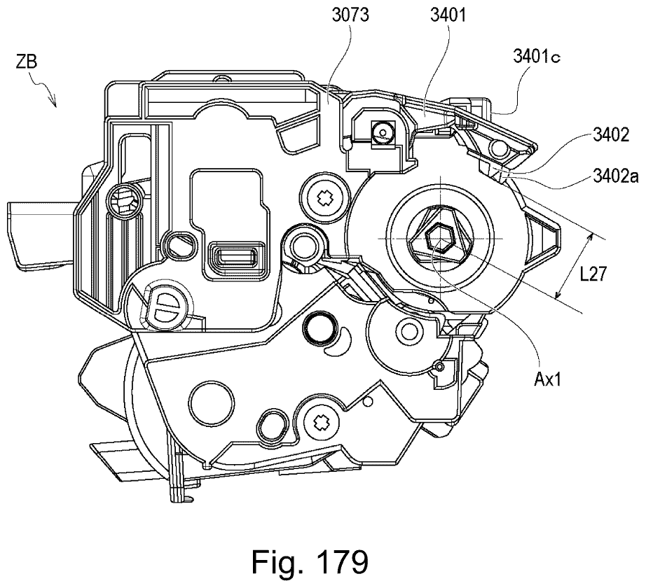

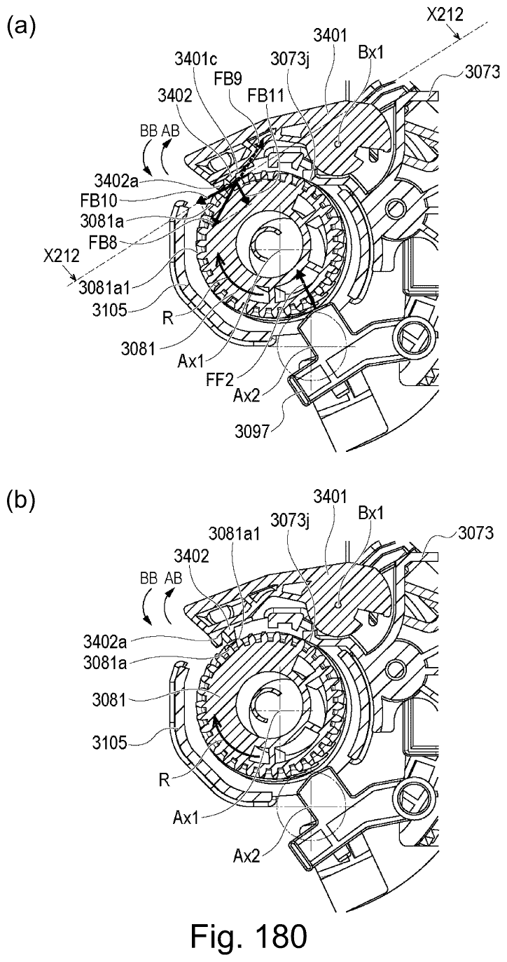

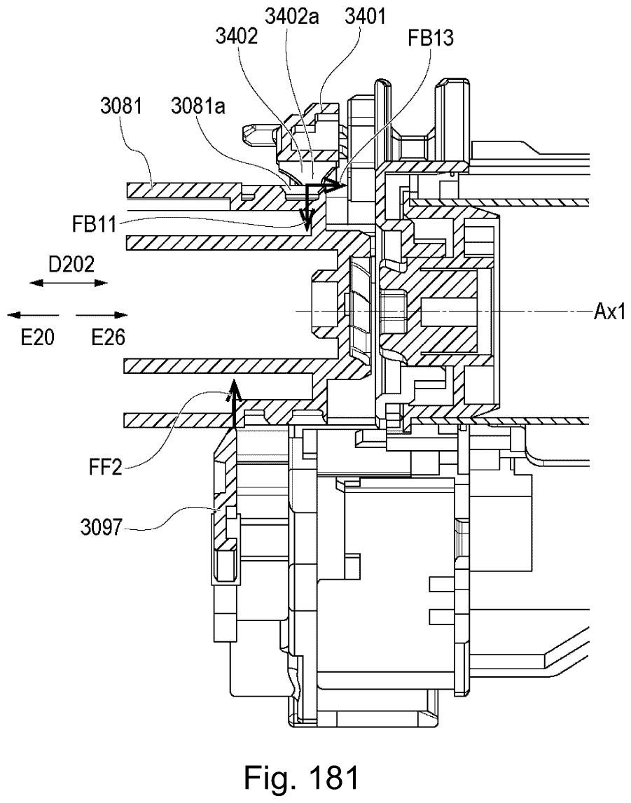

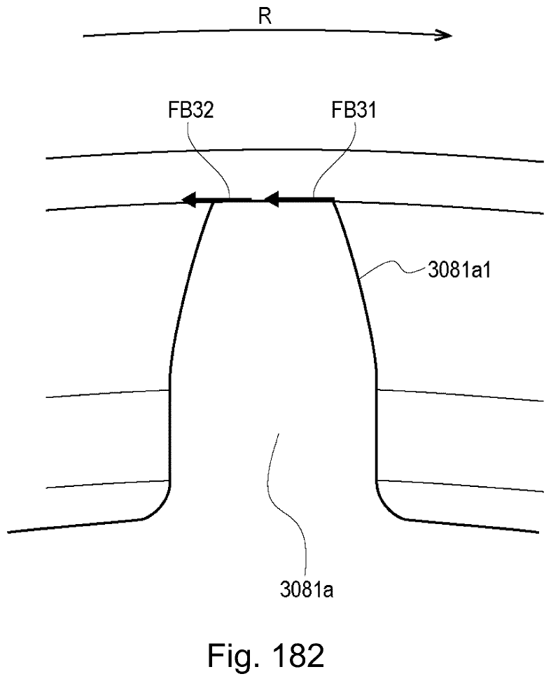

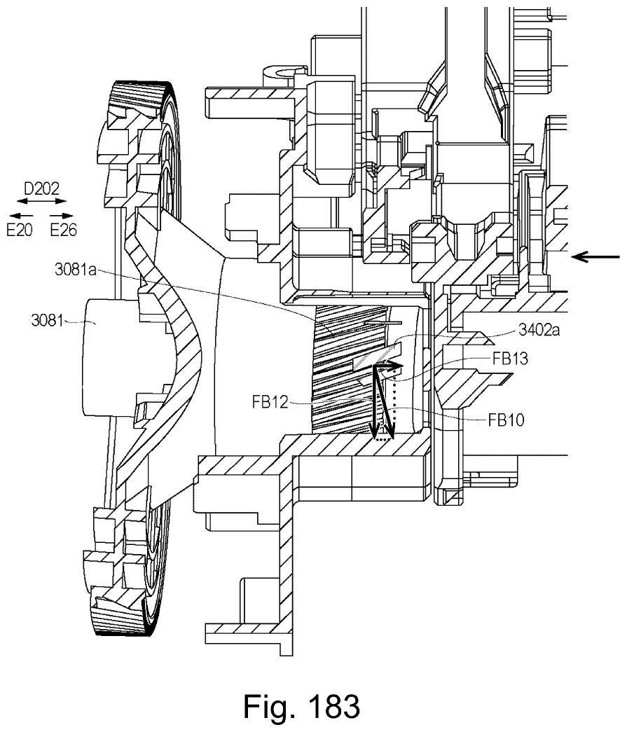

Next, Referring to part (a) of FIG. 1 and part (b) of FIG. 1, part (a) of FIG. 6, part (b) of FIG. 6, part (c) of FIG. 6, part (a) of FIG. 7, part (a) of FIG. 8, part (b) of FIG. 8, FIG. 9, part (a) of FIG. 10, part (b) of FIG. 10, part (a) of FIG. 11, part (b) of FIG. 11, part (a) of FIG. 12, part (b) of FIG. 12, part (a) of FIG. 13, part (b) of FIG. 13, FIG. 14, FIG. 15, and FIG. 16 the mounting of the cartridge will be explained in detail.

Part (a) of FIG. 1 and part (b) of FIG. 1 are perspective views of the cartridge to illustrate the shape of the drive transmitting portion and the surroundings thereof. Part (a) of FIG. 6 is a perspective view of the cylindrical cam, part (b) of FIG. 6 is a perspective view of the drive side plate as viewed from outside the main assembly A of the apparatus, and part (c) of FIG. 6 is a sectional view (direction indicated by the arrow in part (b) of FIG. 6) of the drive side plate to which the cylindrical cam is attached.

Part (a) of FIG. 7 is a cross-sectional view of an image forming apparatus link portion to illustrate a link structure, and part (b) of FIG. 7 is a sectional view of the image forming apparatus drive section to illustrate movement of the drive transmission member.

Part (a) of FIG. 8 is a cross-sectional view of the image forming apparatus drive side guide section to illustrate the mounting of the cartridge, and part (b) of FIG. 8 is a cross-sectional view of the image forming apparatus non-drive side guide portion to illustrate the mounting of the cartridge.

FIG. 9 is an illustration of the image forming apparatus drive train portion to illustrate a positional relationship of the drive train before an opening/closing door is closed.

Part (a) of FIG. 10 is an illustration of an image forming apparatus positioning portion just before engagement to illustrate the longitudinal positioning of the process cartridge B.

Part (b) of FIG. 10 is an illustration of the positioning portion of the image forming apparatus after engagement, for illustrating the positioning of the process cartridge B in the longitudinal direction.

Part (a) of FIG. 11 is a cross-sectional view of the driving side of the image forming apparatus for illustrating the positioning of the cartridge.

Part (b) of FIG. 11 is a cross-sectional view of the non-driving side of the image forming apparatus for illustrating the positioning of the cartridge.

Part (a) of FIG. 12 is a cross-sectional view of the link portion of the image forming apparatus for illustrating the link structure, and part (b) of FIG. 12 is a cross-sectional view of the driving portion of the image forming apparatus for illustrating the movement of the driving transmission member.

Part (a) of FIG. 13 is a perspective view of the driving transmission member for illustrating the shape of the driving transmission member.

Part (b) of FIG. 13 is an illustration of the driving transmission portion of the apparatus main assembly A for illustrating the driving transmission portion.

FIG. 14 is a perspective view of the driving portion of the image forming apparatus for illustrating the engagement space of the driving transmission portion.

FIG. 15 is a cross-sectional view of the drive transmission member for explaining the engagement space of the drive transmission member.

FIG. 16 is a cross-sectional view of the drum 62 and the surroundings thereof, the main assembly A of the apparatus for illustrating the arrangement of the developing roller gear.

FIG. 17 is a sectional view of the drive transmission member for illustrating the engagement of the drive transmission member.

First, the state in which the opening/closing door of the main assembly A of the apparatus is open will be explained. As shown in part (a) of FIG. 7, the main assembly A of the apparatus is provided with the opening/closing door 13, a rotatable cam link 85, a cylindrical cam 86, cartridge pressing members 1 and 2, cartridge pressing springs 19 and 21, and a front plate 18. As shown in part (b) of FIG. 7, the main assembly A of the apparatus is provided with a drive transmission member bearing 83, a drive transmission member 81, a drive transmission member spring 84, a driving side plate 15, and a non-driving side plate 16 (see part (a) of FIG. 10.

The opening/closing door 13 is rotatably mounted to the driving side plate 15 and the non-driving side plate 16. As shown in part (a) of FIG. 6, part (b) of FIG. 6, and part (c) of FIG. 6, the cylindrical cam 86 is attached to the driving side plate 15 so as to be rotatable and movable in a longitudinal direction AM, and has two inclined surfaces 86a and 86b, and has one end 86c on the non-driving side in the longitudinal direction, which is continuous with the inclined surfaces. The driving side plate 15 has two inclined surfaces 15d and 15e facing the two inclined surfaces 86a and 86b, and an end surface 15f facing the one end 86c of the cylindrical cam 86.

As shown in part (a) of FIG. 7, the rotatable cam link 85 has bosses 85a and 85b on both end portions. The bosses 85a and 85b are rotatably mounted to a mounting hole 13a provided in the opening/closing door 13 and a mounting hole 86e provided in the cylindrical cam 86, respectively. When the opening/closing door 13 is rotated to open, the rotatable cam link 85 moves in interrelation with the opening/closing door 13. This movement of the rotatable cam link 85 rotates the cylindrical cam 86, so that the inclined surfaces 86a and 86b first come into contact with the inclined surfaces 15d and 15e provided on the driving side plate 15, respectively. When the cylindrical cam 86 further rotates, the inclined surfaces 86a and 86b slide on and along the inclined surfaces 15d and 15e, so that the cylindrical cam 86 moves toward the driving side in the longitudinal direction. Finally, the cylindrical cam 86 moves until one end 86c of the cylindrical cam 86 abuts against the end surface 15f of the driving side plate 15.

Here, as shown in part (b) of FIG. 7, the drive transmission member 81 is supported rotatably and axially movable by fitting one end (fixed end 81c) of the drive transmission member 81 on the driving side in the axial direction, in the drive transmission member bearing 83. In addition, there is provided a gap M between the longitudinally central portion 81d of the drive transmission member 81 and the driving side plate 15. Further, the drive transmission member 81 has an abutment surface 81e, and the cylindrical cam 86 has the other end 86d facing the abutment surface 81e. The drive transmission member spring 84 is a compression spring, and one end 84a thereof abuts against a spring seat 83a provided on the drive transmission member bearing 83, and the other end 84b abuts against a spring seat 81f provided on the drive transmission member 81. By this, the drive transmission member 81 is urged toward the non-driving side (left side in part (b) of FIG. 7) in the axial direction. By this urging, the abutment surface 81e of the drive transmission member 81 and the other end 86d of the cylindrical cam 86 are abutted against each other.

By the cylindrical cam 86 moving toward the driving side (right side in part (b) of FIG. 7) in the longitudinal direction as described above, the drive transmission member 81 is pushed and is moved toward the driving side. This causes the drive transmission member 81 to take the retracted position. In other words, the drive transmission member 81 is retracted from a moving path of the cartridge B, thereby assuring a space for permitting the mounting of the cartridge B into the main assembly of the image forming apparatus A.

Next, mounting of the cartridge B will be described. As shown in part (a) of FIG. 8 and part (b) of FIG. 8, the driving side plate 15 is provided with an upper guide rail portion 15g and a guide rail 15h as guides, and the non-driving side plate 16 has an upper guide rail portion 16d and a guide rail 16e. The drum bearing 73 provided on the driving side of the cartridge B is provided with a guided portion 73g and a rotation-stopped portion 73c. In the mounting direction of the cartridge B (arrow C), the guided portion 73g and the rotation-stopped portion 73c are disposed upstream (the side of an arrow AO in FIG. 15) of the axis of a coupling projection 63b (see part (a) of FIG. 1, details will be described hereinafter).

The mounting direction of the cartridge B is substantially perpendicular to the axis of the drum 62. In addition, when referring to upstream or downstream in the mounting direction, upstream and downstream are defined in terms of the direction of movement of cartridge B immediately before mounting to the main assembly A of the apparatus is completed.

Further, the cleaning frame 71 has a positioned portion 71d and a rotation-stopped portion 71g on the non-driven side in the longitudinal direction. When cartridge B is mounted through cartridge insertion opening 17 of main assembly A of the apparatus, guided portion 73g and rotation-stopped portion 73c of cartridge B on the upper guide rail portion 15g and guide rail 15h of main assembly A of the apparatus. On the non-driven side, the positioned portion 71d and rotation-stopped portion 71g of cartridge B are guided by guide rail top 16d and guide rail 16e of main assembly A of the apparatus. In this manner, the cartridge B is mounted to main assembly A of the apparatus.

Here, the developing roller gear (developing gear) 30 is provided at the end of the developing roller 32 (see FIG. 9 and part (b) of FIG. 13). That is, the developing roller gear 30 is mounted to the shaft of the developing roller 32.

The developing roller 32 and the developing roller gear 30 are coaxial with each other and rotate about an axis Ax2 shown in FIG. 9. The developing roller 32 is positioned so that the axis Ax2 thereof is substantially parallel to the axis Ax1 of the drum 62. Therefore, the axial direction of the developing roller 32 (the developing roller gear 30) is substantially the same as the axial direction of the drum 62.

The developing roller gear 30 is a drive input gear (cartridge side gear, drive input member) to which a drive force is input from the outside of the cartridge B (i.e., the apparatus main assembly A). The developing roller 32 is structured to rotate by the drive force received by the developing roller gear 30.

As shown in part (a) of FIG. 1 and part (b) of FIG. 1, in the side surface of the driving side of the cartridge B, on the drum 62 side of the developing roller gear 30, there is provided a space 87 which is open so as to uncover the developing roller gear 30 and the coupling projection 63b.

The coupling projection 63b is formed on the driving side drum flange 63 attached to the end of the drum (see FIG. 9). The coupling projection 63b is a coupling part (drum side coupling part, cartridge side coupling part, photosensitive member side coupling part, input coupling part, driving input part) to which the driving force is inputted from the outside of the cartridge B (i.e., the apparatus main assembly A) (see FIG. 9). The coupling projection 63b is positioned coaxially with the drum 62. In other words, the coupling projection 63b rotates about the axis Ax1.

The driving side drum flange 63 provided with the coupling projection 63b is sometimes called a coupling member (drum side coupling member, cartridge side coupling member, photosensitive member side coupling member, drive inputting coupling member, input coupling member). The driving side drum flange 63 is sometimes simply called a coupling.

In addition, in the longitudinal direction of the cartridge B, the side on which the coupling projection 63b is provided is the driving side, and the opposite side is the non-driving side.

As shown in FIG. 9, the developing roller gear 30 includes a gear portion (input gear portion, cartridge side gear portion, developing side gear portion) 30a and an end face 30a1 on the driving side of the gear portion (see part (a) of FIG. 1, part (b) of FIG. 1, and FIG. 9). The teeth (gear teeth) formed on the outer periphery of the gear portion 30a are helical teeth inclined with respect to the axis of the developing roller gear 30. In other words, the developing roller gear 30 is a helical gear (see part (a) of FIG. 1).

The drive transmission member (drive output member, main assembly side drive member) 81 includes a gear portion (main assembly side gear portion, output gear portion) 81a for driving the developing roller gear 30. The gear portion 81a has an end surface 81a1 at the end on the non-driving side (see part (a) of FIG. 13 and part (b) of FIG. 13).

The teeth (gear teeth) of the gear portion 81a are also helical teeth inclined with respect to the axis of the drive transmission member 81. In other words, the drive transmission member 81 also has a portion of helical gear.

The drive transmission member 81 also has a coupling recess 81b. The coupling recess 81b is the coupling portion (main assembly side coupling portion, output coupling portion) provided on the apparatus main assembly side. The coupling recess 81b is a recess which is formed in a projection (cylindrical portion) provided at a free end portion of the drive transmission member 81 and which can be coupled with the coupling projection 63b provided on the drum side.

The space 87 (see FIG. 1), which is structured so that the gear portion 30a and the coupling projection 63b are exposed, is for disposing the gear portion 81a of the drive transmission member 81 when the cartridge B is mounted to the apparatus main assembly A. Therefore, the space 87 is larger than the gear portion 81a of the drive transmission member 81 (see FIG. 15).

More specifically, in a cross section of cartridge B passing through gear portion 30a and perpendicular to the axis of the drum 62 (axis of coupling projection 63b), an imaginary circle is drawn with the axis of the drum 62 (axis of coupling projection 63b) as its center and the same radius as that of the gear portion 81a. Then, the inside of the imaginary circle is a space in which no components of cartridge B are arranged. The space defined by this imaginary circle is included inside the space 87 described above. In other words, the space 87 is larger than the space shown by the imaginary circle.

This will be explained in another way. In the above cross section, an imaginary circle is drawn concentrically (coaxially) with drum 62, with the radius being a distance from the axis of the drum 62 to the tooth tip of the gear portion 30a of developing roller gear 30. Then, the inside of this imaginary circle is also a space in which no components of cartridge B are disposed.

By providing the space 87, the drive transmission member 81 does not interfere with the cartridge B, when the cartridge B is mounted in main assembly A of the apparatus. As shown in FIG. 15, the space 87 allows the cartridge B to be mounted in the apparatus main assembly A by accepting the drive transmission member 81 therein.

When cartridge B is viewed along the axis of the drum 62 (axis of coupling projection 63b), the gear teeth of the gear portion 30a are in a position close to the peripheral surface of the drum 62.

As shown in FIG. 15, gear portion 30a is disposed so that a distance AV (distance measured along a direction perpendicular to the axis) from the axis of the drum 62 to the tip (tooth tip) of the gear teeth of the gear portion 30a is in a range of 90% or more to 120% or less of the radius of the drum 62.

From the viewpoint of stably meshing gear portion 30a with the gear portion 81a to transmit the drive force from the gear portion 81a to the developing roller 32, it is more desirable that the distance AV is 90% or more to 110% or less of the radius of the drum 62. More preferably, the distance AV is 93% or more and 107% or less of the radius of the drum 62.

In particular, in this embodiment, the radius of the drum 62 is 12 mm, and the distance from the axis of the drum 62 to the tip of the gear teeth of the gear portion 30a is set within the range of 11.165 mm or more and 12.74 mm or less. In other words, the distance from the axis of the drum 62 to the tip of the gear teeth of the gear portion 30a is within a range of 93% or more and 107% or less of the drum radius.

In the longitudinal direction, the end face 30a1 of the gear portion 30a of the developing roller gear 30 is disposed so as to be closer to the driving side than the free end portion 63b1 of the coupling projection 63b of the driving side drum flange 63 (see FIGS. 9 and 20). Here, the “driving side” means the side farther from the non-driving side.

In other words, in the longitudinal direction, the end face 30a1 is located farther from the non-driven side of the cartridge B than the free end portion 63b1. In other words, when measured along the longitudinal direction, a distance from the non-driven side of the cartridge B to the end face 30a1 is longer than a distance from the non-driven side of the cartridge B to the free end portion 63b1.

In other words, in the longitudinal direction, the end face 30a1 is located outside the free end portion 63b1. Here, “outside” means the side farther from the center in a certain direction. In other words, the end face 30a1 of the gear part 30a is located farther from the center of the cartridge B in the longitudinal direction than the free end portion 63b1. When measured along the longitudinal direction, the distance from the center of the cartridge B to the end face 30a1 of the gear part 30a is longer than the distance from the center of the cartridge B to the free end portion 63b1.

In other words, in the longitudinal direction, the free end portion 63b1 is “inside” the end face 30a1. Here, the “inside” means the side closer to the center in a certain direction. In other words, the free end portion 63b1 is closer to the center of the cartridge B in the longitudinal direction than the end face 30a1 of the gear portion 30a. When measured along the longitudinal direction, the distance from the center of the cartridge B to the free end portion 63b1 is shorter than the distance from the center of the cartridge B to the end face 30a1 of the gear portion 30a.

As a result, in the axial direction of the developing roller gear 30, the gear teeth of the gear portion 30a are provided with an exposed part which is exposed out of the cartridge B (see FIG. 1). In particular, in this embodiment, as shown in FIG. 15, the gear portion 30a is exposed over a range of 64° or more. That is, as cartridge B is viewed from the drive side, if a line connecting the center of the drum 62 and the center of the developing roller gear 30 is taken as a reference line, both sides of developing roller gear 30 relative to this reference line are exposed over a range of at least 32 degrees.

In FIG. 15, an angle AW is the angle, as the center (axis) of developing roller gear 30 is the origin, from the reference line to the position where the gear portion 30a begins to be covered by driving side developing side member 26, and it satisfies “AW≥32°”.

The total exposure angle of the gear portion 30a can be expressed as 2AW, which satisfies the relationship “2AW≥64°” as described above.

If the gear portion 30a of developing roller gear 30 is exposed from driving side developing side member 26 so as to satisfy the above relationship, the gear portion 81a is allowed to be meshing engagement with the gear portion 30a, thus transmitting the drive, without interfering with driving side developing side member 26.

At least a part of the exposed portion of the gear portion 30a is disposed further outside (on the driving side) of cartridge B than free end portion 63b1 of coupling projection 63b, and faces the axis of the drum (see FIGS. 1, 9, and 20).

FIGS. 9 and 21 show a state in which the gear teeth in the exposed part 30a3 of the gear portion 30a face the rotational axis Ax1 of the drum 62 (rotational axis of coupling convex portion 63b)

In FIG. 20, the axis Ax1 of the drum 62 is above the exposed portion 30a3 of the gear portion 30a.

In FIG. 9, at least a part of the gear portion 30a extends toward the driving side beyond the coupling projecting part 63b in the axial direction, so that the gear portion 30a overlaps the gear portion 81a of the drive transmission member 81 in the axial direction.

Since the part of the gear portion 30a is exposed to face the axis Ax1 of the drum 62, the gear portion 30a and the gear portion 81a of the drive transmission member 81 can be brought into contact with each other during the process of inserting the cartridge B into the main assembly A of the apparatus.

FIG. 20 shows a state in which the outer end surface 30a1 of the gear portion 30a is disposed on the arrow D1 side of the free end portion 63b1 of the coupling projection 63b. The arrow D1 is an arrow orienting outward in the axial direction.

Because of the above-described positional relationship, the gear portion 30a of the developing roller gear 30 and the gear portion 81a of the drive transmission member 81 can make meshing engagement with each other during the process of mounting the cartridge B into the main assembly A of the apparatus.

In addition, in a mounting direction C of the cartridge B, the center (axis) of the gear portion 30a is disposed upstream of the center (axis) of the drum 62 (on the downstream side in the direction of the arrow AO in FIG. 15).

The arrangement of the developing roller gear 30 will be explained in more detail. As shown in FIG. 16, which is a cross-sectional view as viewed from the non-driven side, a line connecting the center of the drum 62 and the center of the charging roller 66 is taken as a reference line (starting line) indicating the angle of reference (0°). At this time, the center (axis) of the developing roller gear 30 is in an angle range of 64° to 190° toward the downstream side of the rotational direction of the drum 62 (clockwise direction in FIG. 16) with respect to the above-described reference line.

More precisely, the center of the drum 62 is taken as the origin, the half line extending from the center of the drum 62 to the center of the charging roller 66 is taken as the starting line, and the rotational direction of the drum is taken as the positive direction of the angle. Then, angular coordinate in a polar coordinate system indicative of the center of the developing roller satisfies the following relationship. Angle 64°≤angular coordinate of the polar coordinate system indicating the center of the developing roller≤angle 190°

There is a certain degree of freedom in the arrangement of the charging roller 66 and the arrangement of the developing roller gear 30. The angle at which the charging roller 66 and the developing roller gear 30 are closest to each other is indicated by an arrow BM, which is 64° in this embodiment as described above. On the other hand, the angle at the time when they are most remote from each other is indicated by an arrow BN, which is 190° in this embodiment.

As described above, the unit in which the developing roller gear 30 is provided (developing unit 20) is movable relative to the unit in which the drum 62 and the coupling projection 63b are provided (cleaning unit 60). More particularly, the developing unit 20 is rotatable relative to the cleaning unit 60 with the first developing support boss 26a and the second development support boss 23b (see FIGS. 4 and 5) as the rotation center (rotational axis). Therefore, the center distance (axis distance) between the developing roller gear 30 and the drum 62 is variable, and the developing roller gear 30 can move within a certain range relative to the axis of the drum 62 (axis of the coupling projection 63b).

As shown in FIG. 9, when the gear portion 30a and the gear portion 81a come into contact with each other during the insertion process of the cartridge B, the gear portion 30a is pushed by the gear portion 81a to move away from the axis of the drum 62 (axis of coupling projection 63b). This reduces the impact resulting from the contact between the gear portion 30a and the gear portion 81a.

As shown in part (a) of FIG. 10 and part (b) of FIG. 10, the drum bearing 73 is provided with a fitted portion 73h as a positioned portion in the longitudinal direction (axial direction) (axially positioned portion).

The driving side plate 15 of apparatus main assembly A is provided with a fitting portion 15j which can fit into fitted portion 73h. During the above-described mounting process, the fitted portion 73h of the cartridge B is fitted with the fitting portion 15j of the apparatus main assembly A, so that the position of the cartridge B in the longitudinal direction (axial direction) is determined (see part (b) of FIG. 10). In this embodiment, the fitted portion 73h is in the form of a slit (groove) (see part (b) of FIG. 1). This slit communicates with the space 87. In other words, the slit (the fitted portion 73h) forms a space which is open to the space 87.

Referring to FIG. 20, the arrangement of the fitted portion 73h will be described in detail. FIG. 20 is an illustration (schematic illustration) showing the arrangement of the fitted portion 73h relative to the gear portion 30a or the coupling projection 63b. As shown in FIG. 20, this slit (the fitted portion 73h) is a space that is generated between two portions (the outer portion 73h1 and the inner portion 73h2 of the fitted portion 73h) which are arranged along the axial direction. In the axial direction, the inner end (inner portion 73h2) of the fitted portion 73h is disposed inside (arrow D2 side) of the end face 30a1 of the gear portion 30a. In the axial direction, the outer end (outer portion 73h1) of the fitted portion 73h is disposed outside (arrow D1 side) of the free end portion 63b1 of the coupling projection 63b.

Next, the state in which the opening/closing door 13 is closed will be described. As shown in part (a) of FIG. 8, part (b) of FIG. 8, part (a) of FIG. 11, and part (b) of FIG. 11, the driving side plate 15 is provided with an upper positioning portion 15a, a lower positioning portion 15b, and a rotation stop portion 15c for positioning, and the non-driving side plate 16 includes a positioning portion 16a and a rotation stop portion 16c.

The drum bearing 73 is provided with an upper positioned portion (first positioned portion, first projection, first protruding portion) 73d and a lower positioned portion (second positioned portion, second projection, second projecting portion) 73f.

The cartridge pressing members 1 and 2 are rotatably mounted to opposite axial ends of the opening/closing door 13, respectively. The cartridge pressing springs 19 and 21 are mounted to opposite ends in the longitudinal direction of the front plate provided in the image forming apparatus A, respectively. The drum bearing 73 has a pressed portion 73e as a force receiving portion, and the cleaning frame 71 has a pressed portion 71o on the non-driven side (see FIG. 3). By closing the opening/closing door 13, the pressed portions 73e and 71o of the cartridge B are pressed by the cartridge pressing members 1 and 2 which are urged by the cartridge pressing springs 19 and 21 of the apparatus main assembly A.

As a result, on the drive side, the upper positioned portion 73d, a lower positioned portion 73f, and a rotation-stopped portion 73c of the cartridge B are brought into contact with the upper positioning portion 15a, the lower positioning portion 15b, and the rotation stop portion 15c of the main assembly A of the apparatus, respectively. As a result, the cartridge B and the drum 62 are positioned on the drive side. Also, on the non-drive side, the positioned portion 71d and the rotation-stopped portion 71g of the cartridge B are brought into contact with the positioning portion 16a and the rotation-stopped portion 16c of the main assembly A of the apparatus, respectively. As a result, the cartridge B and the drum 62 are positioned on the non-drive side.

As shown in part (a) of FIG. 1 and part (b) of FIG. 1, the upper positioned portion 73d and the lower positioned portion 73f are disposed near the drum. Also, the upper positioned portion 73d and the lower positioned portion 73f are aligned along the rotational direction of the drum 62.

In addition, in the drum bearing 73, it is necessary to provide a space (arc-shaped recess) 731 between the upper positioned portion 73d and the lower positioned portion 73f in order to place the transfer roller 7 (see FIG. 11). Therefore, the upper positioned portion 73d and the lower positioned portion 73f are disposed apart from each other.

In addition, the upper positioned portion 73d and the lower positioned portion 73f are projections protruding inward in the axial direction from the drum bearing 73. As described above, it is necessary to secure a space 87 around the coupling projection 63b. Therefore, the upper positioned portion 73d and the lower positioned portion 73f do not project outward in the axial direction, but instead project inward to secure the space 87.

The upper positioned portion 73d and the lower positioned portion 73f are projections disposed so as to cover a part of the drum 62. In other words, the upper positioned portions 73d, 73f are projecting portions which protrude (overhang) inward in the axial direction of the drum 62. When the upper positioned portion 73d and the drum 62 are projected onto the axis of the drum 62, the projected areas of the upper positioned portion 73d and the drum 62 at least partially overlap. In this regard, the lower positioned portion 73f is similar to the upper positioned portion 73d.

The upper positioned portion 73d and the lower positioned portion 73f are arranged so as to partially cover the driving side drum flange 63 provided at the end of the drum 62. When the upper positioned portion 73d and the driving side drum flange 63 are projected onto the axis of the drum 62, the projected areas of the upper positioned portion 73d and the driving side drum flange 63 overlap at least partially. In this regard, the lower positioned portion 73f is similar to the upper positioned portion 73d.

The pressed portions 73e and 71o are projecting portions of the frame of the cleaning unit provided at one end side (driving side) and the other end side (non-driving side) of the cartridge B in the longitudinal direction, respectively. Particularly, the pressed portion 73e is provided on the drum bearing 73. The pressed portions 73e and 71o project in a direction intersecting the axial direction of the drum 62 away from the drum 62.

On the other hand, as shown in part (a) of FIG. 12 and part (b) of FIG. 12, the driving side drum flange 63 has a coupling projection 63b on the driving side and a free end portion 63b1 at the free end of the coupling projection 63b. The drive transmission member 81 has a coupling recess 81b and a free end portion 81b1 of the coupling recess 81b on the non-driving side. By closing the opening/closing door 13, the cylindrical cam 86 moves in the longitudinal direction toward the non-driving side (the side approaching cartridge B) by way of the rotatable cam link 85 while the inclined surfaces 86a, 86b rotate along the inclined surfaces 15d, 15e of the driving side plate 15. This allows the drive transmission member 81 which is in the retracted position to be moved in the longitudinal direction toward the non-driving side (the side approaching cartridge B) by the drive transmission member spring 84. Since the gear teeth of the gear portion 81a and the gear portion 30a are inclined with respect to the moving direction of the drive transmission member 81, the movement of the drive transmission member 81 causes the gear teeth of the gear portion 81a to abut against the gear teeth of the gear portion 30a. At this point, the movement of the drive transmission member 81 toward the non-drive side is stopped.

Even after the drive transmission member 81 stops, the cylindrical cam 86 continues to move toward the non-drive side, so that the drive transmission member 81 and the cylindrical cam 86 are separated from each other.

Next, as shown in FIG. 1, part (a) of FIG. 13 and FIG. 17, the drum bearing 73 has a recessed bottom surface 73i. The drive transmission member 81 has a bottom portion 81b2 functioning as a positioning portion at the bottom of the coupling recess 81b. The coupling recess 81b of the drive transmission member 81 is in the form of a hole having a substantially triangular cross section. As viewed from the non-drive side (cartridge side, the opening side of the recess 81b), the coupling recess 81b has a shape twisted in the counterclockwise direction N toward the drive side (the back side of the recess 81b). The gear portion 81a of the drive transmission member 81 is in the form of a helical gear, and has gear teeth twisted in the counterclockwise direction N toward the drive side as viewed from the non-drive side (cartridge side). In other words, the coupling recess 81b and the gear portion 81a are inclined (twisted) in the opposite direction to the rotational direction CW of the drive transmission member 81 toward the rear end (fixed end 81c) of the drive transmission member 81.

The gear portion 81a and the coupling recess 81b are on the axis of the drive transmission member 81 so that the axis of the gear portion 81a and the axis of the coupling recess 81b overlap. In other words, the gear portion 81a and the coupling recess 81b are arranged coaxially (concentrically).

The coupling projection 63b of the driving side drum flange 63 has a substantially triangular cross section and a projecting shape (protrusion, projection). The coupling projection 63b is twisted in a counterclockwise direction O from the driving side (tip side of the coupling projection 63b) toward the non-driving side (bottom side of the coupling projection 63b) (see FIG. 22). In other words, the coupling projection 63b is inclined (twisted) in a counterclockwise direction (drum rotational direction) as goes from the outside toward the inside of the cartridge in the axial direction.

The coupling projection 63b has portions (ridges) which form corners of a triangular prism (the apex of the triangle) which are driving force receiving portions for actually receiving a driving force from the coupling recess 81b. This driving force receiving portions are inclined toward the drum rotational direction as goes from the outside toward the inside of the cartridge in the axial direction. In addition, the inner surface (inner peripheral surface) of the coupling recess 81b is a driving force applying portion for applying a driving force to the coupling projection 63b.

The gear portion 30a of developing roller gear 30 is a helical gear, and has a shape which is twisted (inclined) in the clockwise direction P from the driven side toward the non-driven side (see FIG. 22). In other words, the gear teeth (helical teeth) of the gear portion 30a are inclined (twisted) in the clockwise direction P (the rotational direction of the developing roller and developing roller gear) from the outside toward the inside of the cartridge in the axial direction of the gear portion 30a. In other words, the gear 30a is inclined (twisted) in the opposite direction to the rotational direction of the drum 62, from the outside to the inside in the axial direction.

As shown in FIG. 13, the drive transmission member 81 is rotated by a motor (not shown) in the clockwise direction CW (the opposite direction of an arrow N in FIG. 13) as viewed from the non-driven side (cartridge side). Then, a thrust force (force produced in the axial direction) is produced by the meshing engagement of the helical teeth between the gear portion 81a of the drive transmission member 81 and the gear portion 30a of the developing roller gear 30. An axial (longitudinal) force FA is applied to the drive transmission member 81, and the drive transmission member 81 tends to move in the longitudinal direction toward the non-driven side (the side approaching the cartridge). In other words, the drive transmission member 81 approaches and comes into contact with the coupling projection 63b.

In particular, in this embodiment, the gear portion 81a of the drive transmission member 81 has the helical teeth which are twisted for movement of 5 to 8.7 mm in the axial direction per tooth (see FIG. 13). This corresponds to a torsion angle of the gear portion 81a being 15° to 30°. The torsion angle of the developing roller gear 30 (gear portion 30a) is also 15° to 30°. In this embodiment, a torsion angle of 20° is adopted for the gear portion 81a and the gear portion 30a.

When the drive transmission member 81 rotates and the triangular phase of the coupling recess 81b and the coupling projection 63b match, the coupling projection 63b is brought into meshing engagement (couples) with the coupling recess 81b.

When the projection 63b engages with the coupling recess 81b, both the coupling recess 81b and the coupling projection 63b are twisted (inclined) with respect to the axis, and a new thrust force FC is produced.

In other words, a force FC acts on the drive transmission member 81 toward the non-driving side (the side approaching the cartridge) in the longitudinal direction. This force FC plus the previously described force FA move the drive transmission member 81 further toward the non-driving side (the side approaching the cartridge) in the longitudinal direction. That is, the coupling projection 63b acts to bring the drive transmission member 81 closer to the coupling projection 63b of the cartridge B.

The drive transmission member 81, which is attracted by the coupling projection 63b, is positioned in the longitudinal direction (axial direction) by the free end portion 81b1 of the drive transmission member 81 abutting against the recessed bottom surface 73i of the drum bearing 73.

In addition, a reaction force FB of the force FC acts on the drum 62, and this reaction force (resistance) FB moves the drum 62 in the longitudinal direction to the driving side (the side approaching the drive transmission member 81, the outside of the cartridge B). In other words, the drum 62 and the coupling projection 63b are attracted to the drive transmission member 81 side. As a result, the free end portion 63b1 of the coupling projection 63b of the drum 62 abuts against the bottom portion 81b2 of the coupling recess 81b. Because of this, the drum 62 is also positioned in the axial direction (longitudinal direction).

In other words, the coupling projection 63b and the coupling recess 81b attract each other, by which the axial positions of the drum 62 and the drive transmission member 81 are determined.

In this state, the drive transmission member 81 is in the drive position. In other words, the drive transmission member 81 is in the position for transmitting the drive force to the coupling projection 63b and the gear portion 30a.

Furthermore, triangular centering action of the coupling recess 81b determines the center of the free end portion of the drive transmission member 81 relative to the driving side drum flange 63. That is, the drive transmission member 81 is centered with respect to the driving side drum flange 63, so that the drive transmission member 81 and the photosensitive member become coaxial. By this, the drive transmission member 81 can transmit drive to the developing roller gear 30 and the driving side drum flange 63 with high precision.

The coupling recess 81b and the coupling projection 63b which engages therewith can also be considered as centering portions. That is, the coupling recess 81b and the coupling projection 63b are engaged with each other, so that the drive transmission member 81 and the drum become coaxial with each other. In particular, the coupling recess 81b is called a main assembly side centering portion (main assembly of the image forming apparatus side centering portion), and the coupling projection 63b is called a cartridge side centering portion.

As explained above, the engagement of the coupling is assisted by the forces FA and FC acting on the drive transmission member 81 toward the non-driven side.

In addition, by positioning the drive transmission member 81 by the drum bearing (bearing member) 73 provided on the cartridge B, the positional accuracy of the drive transmission member 81 relative to the cartridge B can be enhanced.

Thus, the longitudinal positional accuracy of the gear portion 30a of the developing roller gear 30 and the gear portion 81a of the drive transmission member 81 is enhanced, and therefore, the width of the gear portion 30a of the developing roller gear 30 can be suppressed to be small. Then, the cartridge B and the apparatus main assembly A for mounting the cartridge B can be downsized.

To summarize this embodiment, the gear portion 81a of the drive transmission member 81 and the gear portion 30a of the developing roller gear 30 have helical teeth. Helical teeth provide a higher contact ratio between the gears as compared with spur teeth. As a result, the rotational accuracy of the developing roller gear 30 is improved, and the developing roller gear 30 rotates smoothly.

The direction in which the helical teeth of the gear portion 30a and the gear portion 81a are inclined is selected so that the gear portion 30a and the gear portion 81a produce forces (forces FA and FB) by which they are attract each other. That is, when the gear portion 30a and the gear portion 81a rotate in a meshed state, a force is produced which brings the coupling recess 81b provided in the drive transmission member 81 and the coupling projection 63b provided at the end of the drum 62 closer to each other. As a result, the drive transmission member 81 moves toward the cartridge B side, and the coupling recess 81b also approaches the coupling projection 63b. This assists the connection (coupling) of the coupling recess 81b and the coupling projection 63b.

In addition, the direction in which the coupling projection 63b (driving force receiving portion) is inclined relative to the axis of the drum and the direction in which the helical teeth of the gear portion 30a of the developing roller gear 30 are inclined relative to the axis of the gear portion 30a are opposite to each other (see FIG. 38). As a result, the movement of the drive transmission member 81 is assisted not only by the force produced by the engagement (meshing) of the gear portion 30a and the gear portion 81a, but also by the force (force FC) produced by the engagement (coupling) of the coupling projection 63b and the coupling recess 81b. In other words, the coupling projection 63b and the coupling recess 81b are attracted to each other by rotating in a coupled state between the coupling projection 63b and the coupling recess 81b. As a result, the coupling projection 63b and the coupling recess 81b are stably engaged (coupled).

The drive transmission member 81 is urged toward the coupling projection 63b by a resilient member (drive transmission member spring 84) (see part (a) of FIG. 7). In this embodiment, the force of the drive transmission member spring 84 can be weakened by the amount of the forces FA and FC (see part (b) of FIG. 13). This reduces the frictional force between the drive transmission member spring 84 and the drive transmission member 81 which occurs when the drive transmission member 81 rotates, so that the torque required to rotate the drive transmission member 81 is reduced. The load on the motor for rotating the drive transmission member 81 can also be reduced. In addition, the sliding noise between the drive transmission member 81 and the drive transmission member spring 84 can also be reduced.

In this embodiment, the drive transmission member 81 is urged by the resilient member (drive transmission member spring 84), but the resilient member is not necessarily required. In other words, if the gear portion 81a and the gear portion 30a are arranged so as to overlap each other at least partially in the axial direction, and the gear portion 81a and the gear portion 30a mesh with each other when the cartridge is mounted to the apparatus main assembly, then, the elastic member can be eliminated. In this case, when the gear portion 81a rotates, the meshing between the gear portion 81a and the gear portion 30a produces a force which attracts the coupling projection 63b and the coupling recess 81b to each other. That is, even without the resilient member (drive transmission member spring 84), the force produced by the meshing of the gears brings the drive transmission member 81 closer to the cartridge B. By this, the coupling recess 81b can be engaged with the coupling projection 63b.

When there is provided no elastic member, no friction between the elastic member and the drive transmission member 81 is produced, so that the required rotation torque of the drive transmission member 81 is further reduced. In addition, it is possible to eliminate noise caused by the sliding between the drive transmission member 81 and the elastic member. Further, it is possible to reduce the number of parts of the image forming apparatus, so that it is possible to simplify the structure of the image forming apparatus and reduce costs.

Furthermore, the coupling projection 63b of the driving side drum flange 63 is coupled to the recess 81b of the drive transmission member 81 in the state that the drive transmission member 81 is rotating. Here, the coupling projection 63b is inclined (twisted) in the rotational direction of the photosensitive drum as it goes from the outside to the inside of the cartridge in the axial direction of the drum 62. That is, since the coupling projection 63b is inclined (twisted) along the rotational direction of the drive transmission member 81, the coupling projection 63b is easily coupled with the rotating recess 81b.

In this embodiment, as shown in part (a) of FIG. 1 and part (b) of FIG. 1, a structure example has been shown in which the coupling projection 63b (drum 62) rotates counterclockwise O when the cartridge B is viewed from the drive side, and the developing roller gear 30 (developing roller 32) rotates clockwise P.

However, it is also possible to employ a structure in which the coupling projection 63b (drum 62) rotates counterclockwise and the developing roller gear 30 (developing roller 32) rotates clockwise when the cartridge B is viewed from the non-drive side. That is, by changing the layout of the main assembly A of the apparatus or the cartridge B, the rotational directions of the coupling projection 63b (drum 62) and the developing roller gear 30 may be opposite to those in this embodiment. In any case, when the coupling projection 63b and the developing roller gear 30 are viewed from the same direction, the coupling projection 63b and the developing roller gear 30 have opposite rotational directions. One of them rotates clockwise and the other rotates counterclockwise.

In other words, if the cartridge B is viewed so that the rotational direction of the coupling projection 63b is counterclockwise (in this embodiment, if the cartridge B is viewed from the driving side), the rotational direction of the developing roller gear 30 is clockwise.

In this embodiment, the developing roller gear 30 is used as the drive input gear meshing with the drive transmission member 81, but another gear may be used as the drive input gear.

In other words, a structure in which the drive input gear (developing roller gear 30) is not connected to the developing roller 32 can be employed. In such a case, the drive input gear may be structured to transmit the drive force received from the drive transmission member 81 to another member other than the developing roller 32, or may be structured not to transmit the received drive force anywhere. In this embodiment, the cartridge has the developing roller 32, but the cartridge does not necessarily have to have the developing roller 32.

Even in such a case, if the drive input gear of the cartridge meshes with the gear 81a and receives the drive force, a force is produced which pulls the drive transmission member 81 toward the coupling projection 63b.

Even if the drive input gear is structured not to transmit the drive force to the developing roller 32 or the like, it is possible to rotate the developing roller 32 as long as the cartridge has a separate drive transmission path for transmitting the drive force from the coupling projection 63b to the developing roller 32 or the like. For example, if a gear is provided on the photosensitive drum 62 and a gear that meshes with the gear of the photosensitive drum 62 is provided on the developing roller 32, the drive force received by the coupling projection 63b can be transmitted to the developing roller by way of the photosensitive drum and these gears.

However, if the developing roller gear 30 is structured to transmit the driving force to the developing roller 32 as in this embodiment, the path for transmitting the driving force from the drive transmission member 81 to the developing roller 32 is shortened, which provides the advantage of making it easier to simplify the cartridge structure.

### <Coupling Engagement Conditions>

Referring to FIG. 1, part (a) of FIG. 13, FIG. 17, part (a) of FIG. 18, part (b) of FIG. 18, part (a) of FIG. 19, and part (b) of FIG. 19, the conditions for coupling engagement will be specifically explained. Part (a) of FIG. 18 is a sectional view of the image forming apparatus drive unit as seen in the opposite direction to the mounting direction of the cartridge B to explain the distances in the drive transmitting portion. Part (b) of FIG. 18 is a cross-sectional view of the image forming apparatus drive unit as seen from the drive side to explain the distances in the drive transmitting portion. Part (a) of FIG. 19 is a cross-sectional view of the image forming apparatus drive unit as seen from the drive side to explain a gap in the coupling unit. Part (b) of FIG. 19 is a cross-sectional view of the image forming apparatus drive unit as seen from the drive side to explain a gap in the coupling unit.

As shown in FIG. 1, part (a) of FIG. 18 and part (b) of FIG. 18, the drum bearing 73 has a restricting portion 73j as a tilt restricting portion (movement restricting portion, position restricting portion, stopper) for restricting movement of drive transmission member 81 and restricting (suppressing) tilt of drive transmission member 81.

The drive transmission member 81 has a cylindrical portion 81i (see part (a) of FIG. 18) on the non-driving side (side closer to cartridge B). The cylindrical portion 81i is a cylindrical portion (protrusion) in which coupling recess 81b is formed.

As described above, at the stage when the drive transmission member 81 starts to rotate, the gear portion 81a of the drive transmission member 81 and the gear portion 30a of the developing roller gear 30 engage as shown in FIG. 9. On the other hand, the coupling recess 81b and the coupling projection 63b are not coupled or the coupling is insufficient. In this state, when the gear portion 81a transmits the drive force to the gear portion 30a, the meshing engagement of the gears produces an engaging force FD (part (b) of FIG. 18) in the gear portion 81a.

When this engaging force FD is applied to the drive transmission member 81, the drive transmission member 81 tilts. More particularly, since the drive transmission member 81 is supported only at the fixed end 81c (see part (a) of FIG. 18, the end farther from the cartridge B), which is the end on the drive side, as described above, the drive transmission member 81 tilts with the one end 81c (fixed end) on the drive side as the fulcrum. Then, the end (free end, free end portion of the drive transmission member 81 on the side where the coupling recess 81b is provided moves.

If the drive transmission member 81 is tilted significantly, the coupling recess 81b cannot couple with the coupling projection 63b. To avoid this, the cartridge B is provided with the restricting portion 73j to suppress (restrict) the tilt of the drive transmission member 81 within a certain range. In other words, when the drive transmission member 81 is tilted, the restricting portion 73j supports the drive transmission member 81, thereby preventing the tilt from becoming too large.

The restricting portion 73j of the drum bearing 73 is an arc-shaped curved surface portion disposed so as to face the axis of the drum 62 (axis of the coupling projection 63b). The restricting portion 73j can also be regarded as a projecting portion which projects so as to cover the drum axis. A space in which no components of the process cartridge B are disposed is provided between the restricting portion 73j and the drum axis, and the drive transmission member 81 is structured to be disposed in this space. The restricting portion 73j faces the space 87 shown in FIG. 1, and the restricting portion 73j forms an edge (outer edge) of the space 87.

The restricting portion 73j is disposed at a position where it can prevent the drive transmission member 81 from being moved (tilting) by the engaging force FD.

The direction of the engaging force FD is determined by a front pressure angle α of the gear portion 81a (i.e., front pressure angle α of the developing roller gear 30). The direction of the engaging force FD is inclined by 90+a′ degrees toward an upstream AK in the rotational direction of the drum 62 with respect to the arrow (half straight line) LN extending from the center 62a of the drum 62 (i.e., the center of the drive transmission member 81) toward the center 30b of the developing roller gear 30.

Here, in a helical gear with a torsion angle of 20°, the standard front pressure angle α is 21.2°. In this embodiment, the front pressure angle α of the gear portion 81a and the gear portion 30a is also 21.2°. In this case, the inclination of the engaging force FD with respect to the arrow LN is 111.2°. However, a different value can be used as the front pressure angle of the gear portion 81a and the gear portion 30a, and in such case, the direction of the engaging force FD is also different. The front pressure angle α also changes depending on the twist angle of the helical gear, and the front pressure angle α is preferably 20.6 or more and 22.8 or less.

In part (b) of FIG. 18, when a half line FDa is extended starting at the center 62a of the photosensitive drum and extending in the same direction as the engaging force FD, the restricting portion 73j is disposed so as to straddle this half line FDa. The half line FDa is a line inclined (rotated) by 90+a′ degrees from the half line LN to the upstream side in the rotational direction of the drum 62, with the center of the drum 62 as the origin (axis, fulcrum). In this embodiment, the half line FDa is inclined at 111.2 degrees with respect to the half line LN.

The restricting portion 73j does not necessarily need to be disposed on this line FDa, and it is preferable that the restricting portion 73j is disposed near the half line FDa. Specifically, it is preferable that at least a part of the restricting portion 73j is disposed somewhere within a range of plus or minus 15 degrees with respect to the half line FDa.

The half line FDa is a line provided by rotating the half line LN by (90+α) degrees upstream in the rotational direction of the drum 62. Therefore, it is preferable that the restricting portion 73j is disposed in a range of (75+α) degrees to (105+α) degrees upstream in the drum rotational direction with respect to the half line LN, with the center of the drum 62 as the origin. Considering that the preferable value of the front pressure angle α is 20.6 degrees or more and 22.8 degrees or less, the preferable range in which the restricting portion 73j is disposed is a range of 95.6 degrees or more and 127.8 degrees or less with respect to the half line LN. In this embodiment, since the front pressure angle α is 21.2 degrees, the preferred range of the restricting portion 73j is 96.2 degrees or more and 126.2 degrees or less.

As another preferred arrangement of the restricting portion 73j, a plurality of restricting portions 73j may be arranged on opposite sides of the half line FDa, with the half line FDa interposed therebetween (see FIG. 26). In this case, the restricting portion 73j can also be regarded as being arranged straddling the line FDa.

The restricting portion 73j is preferably arranged on the upstream side AO (see FIG. 15) of the cartridge mounting direction C (see part (a) of FIG. 11) with respect to the center (axis) of the coupling projection 63b. This is to prevent the restricting portion 73j from interfering with the mounting of the cartridge B.

The range (area) in which the restricting portion 73j is arranged on the drum bearing 73 can also be described as follows.

In a plane perpendicular to the axis of the drum 62 (see part (b) of FIG. 18), a straight line LA is drawn passing through the center 62a of the drum 62 and the center 30b of the developing roller gear 30. Here, the restricting portion 73j is placed on the side of the straight line LA where the charging roller is provided (i.e., the side indicated by the arrow AL).

Alternatively, the restricting portion 73j is disposed in an area AL on the side opposite, with respect to the line LA passing through the center 62a of the drum 62 and the gear center 30b, from the side where the drum 62 is exposed (the side where the drum 62 faces the transfer roller 7). Before the cartridge B is mounted in the main assembly A of the apparatus, a cover, a shutter or the like which covers the drum 62 may be provided on the cartridge B, and the drum 62 may not be exposed because of such a member. However, the side where the drum 62 is exposed here means the side where the drum 62 is exposed when such a cover, shutter, or the like is omitted.

In addition, in a plane perpendicular to the axis of the drum 62, the range (area AL) in which the restricting portion 73j is disposed can be described as follows, using the circumferential direction (rotational direction) of the drum 62.

A half line (original line) LN is drawn starting from the center 62a of the drum 62 and extending toward the center 30b of the gear portion 30a of the developing roller gear 30. The area AL is a range (area) with an angle greater than 0° and not exceeding 180° toward the upstream side (arrow AK side) of the drum rotational direction with respect to this half line LN.

This will be explained in another way. The area AL is the upstream side (arrow AK side) of the midpoint MA between the center 62a of the drum 62 and the developing roller gear center 30b, in the drum rotational direction O. In addition, the area AL is a range which does not exceed the straight line (extension line) LA which passing through the center 62a of the drum 62 and the center 30b of the gear portion 30a of the developing roller gear 30.

In addition, when the opening/closing door 13 is open and the drive transmission member 81 is moved to the driving side, the restricting portion 73j is placed at a position overlapping with the gear portion 81a of the drive transmission member 81 in the longitudinal direction. That is, the restricting portion 73j also overlaps with the developing roller gear 30 in the longitudinal direction. When the developing roller gear 30 and the restricting portion 73j are projected onto the axis Ax2 of the developing roller gear 30 as shown in FIG. 21, at least a part of the projection areas of them overlap with each other. That is, the restricting portion 73j is close to the gear portion 81a (gear portion 30a) where the meshing force is produced. Therefore, when the meshing force received by the drive transmission member 81 is borne by the restricting portion 73j, the drive transmission member 81 is prevented from bending.

In addition, at least a part of the restricting portion 73j is placed outside the coupling projection 63b in the axial direction (the side of the arrow D1 shown in FIG. 21).

Next, the radial position of the restricting portion 73j will be described with reference to the drum 62 (see part (a) of FIG. 18).

The distances discussed below are distances measured along a direction perpendicular to the axial direction of the drum 62 (radial distances of the drum 62). The distance from the axis (center 62a) of the drum 62 to the restricting portion 73j is S. The radius of the tooth tip of the gear portion 81a of the drive transmission member 81 is U. The distance from the center 81j of the drive transmission member 81 to the radially outermost part of the coupling recess is AC. The distance from the center 63d of the driving side drum flange 63 to the radially outermost part of the coupling projection 63b is AD. The distance between the restricting portion 73j and the tooth tip of the gear portion 81a of the drive transmission member 81 is AA. The amount of misalignment between the coupling projection 63b and the coupling recess 81b at the time when the drive transmission member 81 is tilted corresponding to the amount of the gap from the restricting portion 73j (when the drive transmission member 81 is tilted and the gear portion 81a is in contact with the restricting portion 73j) is AB (see part (b) of FIG. 19).

Then, a gap AA between the gear portion 81a of the drive transmission member 81 and the restricting portion 73j of the drum bearing 73 is as follows:

$$A A = S - U .$$

In the following, the distance is measured along the axial direction of the drive transmission member 81 from the fixed end 81c, which is the fulcrum of the inclination of the drive transmission member 81. The axial distance from one end 81c of the drive transmission member 81 to the gear portion 81a is X. The axial distance from one end 81c of the drive transmission member 81 to the coupling recess 81b is W.

The distances X and W satisfy W>X. Therefore, when the drive transmission member 81 is tilted by the gap AA between the restricting portion 73j and the gear portion 81a, the misalignment amount AB becomes longer than the gap AA and is as follows:

$$A B = A A \times ( W / X ) .$$

In addition, the gap between the coupling projection 63b of the driving side drum flange 63 and the coupling recess 81b of the drive transmission member 81 in a state where there is no misalignment is V. Here, a gap V is the smallest value (minimum distance) among the distances between the surfaces of both coupling parts (the distance measured along the direction perpendicular to the axis of the drum 62, that is, the radial distance).

When the triangular phases of the couplings are aligned, this shortest gap V is as follows:

$$V = A C - A D .$$

Even if the drive transmission member 81 is tilted by the gap AA and misalignment of amount AB occurs between the couplings, it is preferable that the gap V between the couplings satisfies the following, in order for the couplings to engage:

$$V = A C - A D > A B .$$

In other words, if the misalignment amount AB is smaller than the shortest gap V between the coupling projection 63b and the coupling recess 81b, the coupling projection 63b and the coupling recess 81b can tolerate the misalignment amount AB, and they can engage.

If the phase of the coupling recess 81b relative to the coupling projection 63b changes, the shortest gap V between the two coupling parts also changes. In other words, if the phases of the two coupling parts are misaligned, the shortest gap V between the coupling projection 63b and the coupling recess 81b becomes smaller than (AC-AD). There may also be cases where the gap V is smaller than the misalignment amount AB.

However, if there is at least one phase relationship between the two coupling parts which satisfies “V>AB”, the coupling projection 63b and the coupling recess 81b engage with each other. This is because the coupling recess 81b comes into contact with the coupling projection 63b while rotating. The coupling recess 81b can engage (couple) with the coupling projection 63b at the timing when it rotates to an angle satisfying “V>AB”.

When the distance S is measured from the center 62a of the drum 62 to the restricting portion 73j along the radial direction of the drum 62, S=AA+U. Substituting “AB=AA×(W/X)” and “AA=S−U” into “V>AB, “V>(S−U)×(W/X) is obtained. It will suffice if there is at least one phase relationship between the coupling projection 63b and the coupling recess 81b which satisfies this formula.

The above formula can be further modified to show the condition for distance S as follows. S<U+V×(X/W).

In addition, when the drive transmission member 81 rotates, it is desirable that the restricting portion 73j does not contact the gear portion 81a, and therefore it is desirable that the restricting portion 73j is separated from the tooth tip of the gear portion 81a. This is expressed as a formula: S>U.

When this is summarized together with the above relational formula, U<S<U+V×(X/W) is established.

As in this embodiment, if the cross-sectional shape of the coupling projection 63b and the cross-sectional shape of the coupling recess 81b are both substantially equilateral triangles, the gap Vis maximum when the phases of both coupling portions are aligned. The value of V at that time can be substituted into the above formula to find the required range of S.

The operation when the coupling engages will be explained. Before the coupling recess 81b of the drive transmission member 81 and the coupling projection 63b of the driving side drum flange 63 are brought into engagement with each other, an engaging force FD is applied to the drive transmission member 81. As described above, the engaging force FD is a force generated by the meshing between the gear portion 81a of the drive transmission member 81 and the gear portion 30a of the developing roller gear 30.

The engaging force FD causes the drive transmission member 81 to tilt in the direction FD in which the meshing force is applied, with the drive transmission member bearing 83 as the fulcrum, by the amount of the gap AA between the restricting portion 73j of the drum bearing 73 and the gear portion 81a. The amount of misalignment AB between the coupling recess 81b and the coupling projection 63b due to this tilt becomes smaller than the gap V between the coupling recess 81b and the coupling projection 63b, at a predetermined phase. As a result, when the drive transmission member 81 rotates and the triangular phase of the coupling recess 81b and the coupling projection 63b are aligned, the coupling recess 81b fits into and engages with the coupling projection 63b without interference between the end faces of the coupling.

Here, an example of dimensions which satisfy the above conditional formula when the radius of the drum 62 is 12 mm is given below.

In this embodiment, the dimensions of each part of the drive transmission member 81 which can be applied to the drum 62 having a radius of 12 mm are as follows. The distance AC from the center of the coupling recess 81b to the apex of the approximately equilateral triangle of the coupling recess 81b is 6.5 mm, and a radius AE of the inscribed circle of the approximately equilateral triangle of the coupling recess 81b is 4.65 mm. The approximately equilateral triangle of the coupling recess 81b is not a pure equilateral triangle, but the apex (corner) is rounded into an arc shape. A radius AF of the hollowed-out portion 81b3 of the coupling recess is 4.8 mm. A radius U of the tooth tip circle of the gear portion 81a of the coupling recess is 12.715 mm. The distance X from one end 81c to the non-driving side end face 81a1 is 30.25 mm. The distance W from one end 81c to the free end portion 81b1 of the coupling recess is 33.25 mm.

The shortest distance V between the coupling recess 81b and the coupling projection 63b satisfies the following relationship: 0<V<1.7.

The lower limit of V occurs when the size of the triangle of the coupling recess 81b is equal to the size of the triangle of the coupling projection 63b, and the lower limit value of V is “0”. On the other hand, the upper limit of V occurs when the distance AC from the center to the apex of the coupling projection 63b is 4.8 mm, which is the radius AF of the hollowed-out portion of the coupling recess 81b. In this case, the gap V (mm) between the coupling projection 63b and the coupling recess 81b is calculated as “1.7=6.5−4.8”.

Substituting each value and V=1.7 into the formula “U<S<U+V×(X/W)” shown above, the result is “12.715<S<14.262” (unit: mm).

The above formula will be confirmed by using two actual examples.

First, the first example shows the dimensions when the coupling projection 63b is maximized as long as it can engage with the coupling recess 81b. At this time, the gap V between the coupling projection 63b and the coupling recess 81b is minimized, so the allowable tilt of the drive transmission member 81 is small. Therefore, in order to reduce the tilt of the drive transmission member 81, it is necessary to bring the restricting portion 73j as close as possible to the normal position of the gear portion 81a.

On the other hand, the second example shows the dimensions when the coupling projection 63b is minimized as long as it can engage with the coupling recess 81b. At this time, the gap V between the coupling projection 63b and the coupling recess 81b is maximized, so that the coupling projection 63b and the coupling recess 81b can engage with each other even if the drive transmission member 81 is relatively greatly tilted. In other words, the restricting portion 73j can relatively greatly tolerate the inclination of the drive transmission member 81, so that the restricting portion 73j can be made relatively far from the normal position of the gear portion 81a.

The first example is an example in which the size of the coupling projection 63b is made close to the maximum and the radial engagement amount (area where the two members engage with each other) between the coupling projection 63b and the coupling recess 81b is made close to the maximum. At this time, V (the gap between the couplings) approaches the lower limit (minimum), so that S (the distance from the center of the drum 62 to the restricting portion 73j) needs to approach the lower limit (12.715 mm).

A distance AD from the center to the apex of the coupling projection 63b of the driving side drum flange 63 is 6.498 mm. In this way, when the coupling projection 63b has a dimension slightly smaller than the distance 6.5 mm from the center of the coupling recess 81b to the triangular apex, the radial engagement amount between the coupling portions is approximately maximum.

A radius AG of the inscribed circle in the triangle constituting the coupling projection 63b of the driving side drum flange 63 is 4.648 mm. The approximate triangle of the coupling projection 63b is not a pure equilateral triangle, but has its apex (corner) rounded into an arc shape.

In this case, the distance S from the center 62a of the drum 62 to the restricting portion 73j of the drum bearing is set to 12.716 mm, which is slightly larger than the radius U of the tip circle of the gear portion 81a.

As a result, the gap AA between the restricting portion 73j of the drum bearing and the gear portion 81a of the drive transmission member is 0.001 mm (=12.716−12.715). Here, the amount of misalignment AB between the coupling portions when the drive transmission member 81 is tilted by the amount of the gap AA with the restricting portion 73j is amplified by the difference in the longitudinal positions of the restricting portion 73j and the coupling portion. The misalignment amount AB is 0.0011 mm (=0.001×33.25/30.25). In addition, the shortest gap V between the coupling projection 63b and the coupling recess 81b when the coupling parts are in phase is 0.002 mm (the smaller one of “6.5−6.498” and “4.65−4.648”).

Therefore, even if the drive transmission member 81 is tilted by the meshing force, the engagement is possible, because the gap V between the coupling parts is larger than the misalignment amount AB between the coupling parts.

As will be understood from the foregoing, it is preferable that the radial distance from the center of the drum 62 to the outermost part of the coupling parts is greater than 4.8 mm, and the radial distance from the center of the drum 62 to the restricting part 73j is greater than 12.715 mm.

In the second example, the size of the coupling projection 63b is made as small as possible as described above, and the radial overlap amount between the coupling projection 63b and the coupling recess 81b (the area where they engage) is made as small as possible. In this case, V (the gap between the couplings) approaches its maximum (upper limit), and S (the distance from the center of the drum 62 to the restricting portion 73j) can also take a value close to its upper limit.

The distance AD between the center and the apex of the coupling projection 63b of the driving side drum flange 63 is set to 4.801 mm. This is a value slightly larger than the radius 4.8 mm of the hollowed-out portion 81b3 of the coupling recess 81b, and is a radius at which the radial overlap amount between the couplings is almost minimum. If the distance AD of the coupling projection 63b is shorter than the radius of the hollowed-out portion 81b3, the free end portion of the projection 63b will not engage with the coupling recess 81b, and drive transmission will be impossible.

In this case, the radius AG of the triangular inscribed circle of the coupling projection 63b is 2.951 mm.

The distance S from the center 62a of the drum 62 to the restricting portion 73j of the drum bearing is 14.259 mm.

As a result, the gap AA between the restricting portion 73j of the drum bearing 73 and the gear portion 81a of the drive transmission member 81 is 1.544 mm (=14.259−12.715). Here, the amount of misalignment AB between the coupling portions when the drive transmission member 81 is tilted by the amount of gap AA relative to the restricting portion 73j is amplified due to the difference in the longitudinal positions of the restricting portion 73j and the coupling part, and is 1.697 mm (=1.544×33.25/30.25). In addition, when the coupling portions are in phase with each other, the gap V between the coupling projection 63b and the coupling recess 81b is 1.699 mm (the smaller one of “6.5−4.801” and “4.65−2.951”). Therefore, even if the drive transmission member 81 is tilted by the engaging force FD, the gap V between the coupling portions is larger than the amount of misalignment AB between the coupling portions, so that the coupling projection 63b and the coupling recess 81b can engage with each other.

As can be seen from the second example, it is preferable that the radial distance from the center of the drum 62 to the outermost part of the coupling projection 63b is greater than 4.8 mm, and the radial distance from the center of the drum 62 to the restricting part 73j is less than 14.262 mm.

Considering the first and second examples in combination, in this embodiment, it is preferable that the radial distance S from the center 62a of the drum 62 to the restricting part 73j of the drum bearing is greater than 12.715 mm and less than 14.262 mm.

Next, the arrangement of the coupling projection 63b in the longitudinal direction (drum axial direction) will be described. As shown in

FIG. 17, the driving side drum flange 63 has a flange portion 63c. The cleaning frame 71 has a drum restricting rib 71m (drum restricting portion, drum longitudinal position restricting portion, drum axial position restricting portion).

The drum restricting rib 71m is disposed on the non-drive side in the longitudinal direction with respect to the flange portion 63c of the driving side drum flange 63, and faces the flange portion 63c with a gap.

If the drum 62 moves beyond this gap toward the non-drive side, the flange portion 63c comes into contact with the drum restricting rib 71m, by which the movement of the drum 62 is restricted. In other words, the drum 62 is structured not to move in the longitudinal direction (axial direction) beyond a certain range. This improves the longitudinal positional accuracy of the coupling projection 63b of the driving side drum flange 63 before the coupling projection 63b of the driving side drum flange 63 engages with the coupling recess 81b. Therefore, even if the longitudinal movement amount of the drive transmission member 81 is reduced, the coupling projection 63b and the coupling recess 81b can be engaged with each other. By reducing the longitudinal movement amount of the drive transmission member 81, the device main assembly A can be downsized.

Next, the arrangement of the gear portion 30a of the developing roller gear 30 in the longitudinal direction (drum axial direction) will be described. As shown in FIG. 17, the developing roller gear 30 has a non-driven side end surface 30a2 on the non-driven side of the gear portion 30a. The developing container 23 is provided with a developing roller gear restricting rib 23d (gear restricting portion, gear longitudinal position restricting portion, gear axial position restricting portion).

The developing roller gear restricting rib 23d is disposed on the non-driven side in the axial direction with respect to the non-driven side end surface 30a2 of the gear portion 30a, and faces the non-driven side end surface 30a2 with a gap therebetween.

As a result, the developing roller gear restricting rib 23d provided on the drive side of the cartridge B restricts the developing roller gear 30 from moving longitudinally toward the non-driven side. This improves the positional accuracy of the gear portion 30a of the developing roller gear 30 in the axial direction before the gear portion 30a of the developing roller gear 30 meshes with the gear portion 81a of the drive transmission member 81. Therefore, the gear width of the gear portion 30a of the developing roller gear 30 can be reduced.

As a result, the cartridge B and the device main assembly A for mounting the cartridge B can be downsized.

### <Dismounting Cartridge>

Next, referring to FIGS. 7, 18, and 19, the dismounting of the cartridge B from the apparatus main assembly A will be described.

As shown in FIG. 7, when the opening/closing door 13 is rotated to open, the cylindrical cam 86 rotates along the inclined surfaces 86a and 86b by way of the rotatable cam link 85 and moves axially toward the driving side until one end 86c of the cylindrical cam 86 abuts against the end surface 15f of the driving side plate 15. Then, the cylindrical cam 86 moves, so that the drive transmission member 81 become movable axially toward the driving side (the side away from the cartridge B).

Here, as shown in part (a) of FIG. 18, part (b) of FIG. 18 and part (a) of FIG. 19, the amount of engagement of the teeth in the radial direction between the gear portion 81a of the drive transmission member 81 and the gear portion 30a of the developing roller gear 30 is engagement amount AH.

In order for the gear portion 81a to disengage from the gear portion 30a, the gear portion 81a has to move in a direction away from the gear portion 30a by more than the engagement amount AH between the gear portions. Therefore, the restricting portion 73j of the drum bearing 73 is arranged so as not to impede the movement of the drive transmission member 81 when the gear portion 81a moves away from the gear portion 30a. For this purpose, the direction in which the gear portion 81a of the drive transmission member 81 moves away from the gear portion 30a of the developing roller gear 30 is the direction indicated by an arrow AI along the direction of the line connecting the center 81j of the drive transmission member 81 and the center 30b of the developing roller gear 30. It is preferable not to provide the restricting portion 73j in the direction indicated by the arrow AI. That is, it is desired that the restricting portion 73j is not disposed so as to straddle the straight line LA, and that the drive transmission member 81 does not contact the restricting portion 73j when the gear portion 81a disengages from the gear portion 30a.

It is also desirable that the drive transmission member 81 does not contact a recessed peripheral surface 73k of the drum bearing 73 when the gear portion 81a disengages from the gear portion 30a. Therefore, in the state where the opening/closing door 13 is open (parts (a) and (b) of FIG. 7), the drive transmission member 81 retracts to a position where it does not contact the recessed peripheral surface 73k of the drum bearing 73.

That is, as shown in part (a) of FIG. 18, the drive transmission member 81 retracts until it disengages from the coupling projection 63b. In this state, the free end portion of the drive transmission member 81 is at approximately the same position as the free end portion of the recessed peripheral surface 73k in the longitudinal direction, or further to the left of the free end portion of the recessed peripheral surface 73k.

In this state, even if the drive transmission member 81 tilts to release the meshing engagement between the gear portion 81a and the gear portion 30a, the drive transmission member 81 does not contact the recessed peripheral surface 73k.

There may be a main assembly A in which the amount of movement of the drive transmission member 81 when it is retracted is short, and the free end portion of the drive transmission member 81 in the retracted position is placed to the right of the free end portion of the recessed peripheral surface 73k. In such a case, contacting between the drive transmission member 81 and the recessed peripheral surface 73k can be avoided if the following conditions are satisfied.

The radial distance from the center 62a of the drum 62 to the recessed peripheral surface 73k of the drum bearing 73 is Z. The radial distance from the center 81j of the drive transmission member 81 to the outer circumferential surface of the cylindrical portion 81i of the drive transmission member 81 is Y. The radial distance in the gap between the recessed peripheral surface 73k and the cylindrical portion 81i is AJ. In this case, the gap AJ satisfies the following formula. AJ=Z−YAJ>AH.

In other words, a recess is provided around the drum 62. The drive transmission member 81 can move within a range where the inner circumferential surface of the recess (recessed peripheral surface 73k) does not contact the gear portion 81a.

It will suffice if the radial position of the recessed peripheral surface 73k of the drum bearing 73 is such that the distance Z from the center 62a of the drum 62 is as follows: Z>AH+Y.

With the above-described structure, when the cartridge B is dismounted from the main assembly A of the apparatus, the drive transmission member 81 can be tilted in the direction AD away from the developing roller gear 30 by the amount AH of engagement between the gear portion 81a of the drive transmission member 81 and the gear portion 30a of the developing roller gear 30. Then, the meshing engagement between the gear portion 81a of the drive transmission member 81 and the gear portion 30a of the developing roller gear 30 is broken, so that the cartridge B can be smoothly dismounted from the main assembly A of the apparatus.

As described above, the thrust force produced by the meshing engagement of the helical gears causes the drive transmission member 81 to move in a direction toward the coupling portion on the cartridge side.

In addition, the force produced by the meshing engagement of the gears causes the drive transmission member 81 to move (tilt), but the amount of movement (amount of tilt) is restricted by the restricting portion provided on the cartridge side. This ensures reliable engagement (coupling) between the drive transmission member 81 and the coupling portion on the cartridge side to accomplishes reliable drive transmission.

Furthermore, by providing a gap which allows the drive transmission member 81 to move radially beyond the gear meshing height, the gears can be smoothly released from the meshing engagement when the cartridge B is dismounted from the apparatus main assembly. In other words, the cartridge can be easily dismounted.

The functions, materials, shapes, and relative arrangements of the components described in the above-described embodiment and each modified example are not intended to limit the scope of the present invention unless otherwise specified. The same applies to the embodiments described below.

### Embodiment 2

Next, Embodiment 2 will be described below with reference to FIGS. 23 to 38. In particular, among the elements disclosed in this embodiment, those corresponding to the members described in Embodiment 1 will be assigned the same names as the members in Embodiment 1, and only the different points from Embodiment 1 will be described.

In this embodiment, the direction along the rotational axis Ax1 of the drum 62 is the longitudinal direction D202. The longitudinal direction D202 is the rotational axis direction (axial direction) of the drum 62.

As in Embodiment 1, in the axial direction of the drum 62, the side where the driving side drum flange 263 (see part (b) of FIG. 24) is provided is referred to as a driving side of the cartridge or a side of the driving side. The driving side may be regarded as an end of the cartridge in the axial direction of the drum 62.

The side opposite the driving side in the axial direction of the drum 62 is referred to as a non-driving side of the cartridge or a side of the non-driving side. One of the driving side and the non-driving side of the cartridge may be referred to as one side of the cartridge, or the first side or first side of the cartridge. The other of the driving side and the non-driving side of the cartridge may be referred to as the other side, or the second side or second side.

One of the ends of the drum 62 may be referred to as a first end portion or a first end. The other end may be referred to as a second end portion or a second end. For example, when the driving side end of the drum 62 is called the first end portion or first end, the non-driving side end of the drum 62 is referred to as the second end portion or second end. The second end is the end of the drum 62 which is opposite the first end. The drive side end of the drum 62 is the end of the drum 62 where the driving side drum flange 263 (see part (b) of FIG. 24) is provided. In other words, the drum 62 receives a drive force from the drive side end portion.

The direction from the non-drive side to the drive side is the direction of an arrow E20, and the direction from the drive side to the non-drive side is the direction of an arrow E26.

First, referring to FIGS. 23 and 24, the cartridge structure of this embodiment will be explained. FIG. 23 is a perspective view of the cartridge B. FIG. 24 is illustrations showing, for the purpose of explanation, the drive transmission structure of the cartridge B in this embodiment. Part (a) of FIG. 24 is a view as viewed in the direction perpendicular to the rotational axis of the drum 62, and part (b) of FIG. 24 is a perspective view. A rack gear mechanism 290 and the drum bearing 73 are not shown in FIG. 24. As shown in FIG. 23, the cartridge B in this embodiment comprises a cleaning unit 260 and a developing unit 220, similar to Embodiment 1. The developing unit 220 includes the rack gear mechanism 290.

As shown in FIG. 24, the driving side drum flange 263 is provided with a gear portion 263e on the side closer to the drum 62 in the axial direction of the drum 62. A developing roller gear 230 has a gear portion 230a, and rotatable integrally with a support shaft 32a of the developing roller 32. The support shaft 32a of the developing roller 32 extends further toward the driving side beyond the developing roller gear 230 in the longitudinal direction D202.

The gear portion 230a of the developing roller gear 230 is positioned in a state of meshing engagement with the gear portion 263e of the driving side drum flange 263. That is, the driving force of the driving side drum flange 263 is transmitted to the developing roller 32 by way of the developing roller gear 230. In other words, the developing roller 32 is driven by driving the driving side drum flange 263. In this embodiment, the developing unit 220 is rotated by the gear portion 263e of the driving side drum flange 263, but the drive may be transmitted from the non-driving side drum flange to the developing unit 220. This structure will be described in Modified Example 2 of Embodiment 7 with reference to FIG. 101.

### <Rack Gear Mechanism>

Next, referring to FIG. 25, the structure of the rack gear mechanism 290 will be described. FIG. 25 is an exploded perspective view of the rack gear mechanism 290. Part (a) of FIG. 25 is a view as viewed from the non-driving side, and part (b) of FIG. 25 is a view as viewed from the driving side.

In this embodiment, the rack gear mechanism 290 is provided on the driving side of the cartridge as part of the structure of the developing unit 220 (see part (b) of FIG. 28). As shown in FIG. 25, the rack gear mechanism 290 comprises a driving-side development side member 226, a rack gear 291, a tension spring 292, a locking member 293, a torsion coil spring 294, a rotatable member 295, a support member 296, a pressed member 297, and an initialization spring 298. The rack gear 291 is simply called a rack, as the case may be.

Although details will be described hereinafter, the rack gear 291 is a gear structured to engage with a helical gear on the outside of the cartridge, i.e., to mesh with the gear portion 81a of the drive transmission member 81. The rack gear mechanism 290 including the rack gear 291 is disposed on the drive side of the cartridge. That is, in the axial direction of the drum 62, the coupling portion (coupling projection 263a) and the rack gear mechanism 290 are placed on the same side of the cartridge.

Each of the components of the rack gear mechanism 290 will be described.

The driving-side development side member 226 includes a rail portion 226a, a restricting portion 226b, sliding surfaces 226c, a retaining portion 226f, a hole portion 226d, a spring hook portion 226e, a spring seat surface 226h, a cut-away portion 226g, and a guide surface 226i as components related to the rack gear mechanism 290.

The rail portion 226a extends in a first movable direction D200, and one end of the rail portion 226a is defined as an end 226a1.

The restricting portion 226b is provided in the opposite direction to the end 226a1 of the rail portion 226a. The restricting portion 226b is shaped so that a part thereof projects beyond the rail portion 226a in a direction perpendicular to the first movable direction D200.

The sliding surfaces 226c are surfaces perpendicular to the first movable direction D200. When the direction perpendicular to the first movable direction D200 and the longitudinal direction of the cartridge is defined as a second movable direction D201, the slide surface 226c extends in the second movable direction D201. The sliding surfaces 226c constitute a pair of surfaces facing each other in the first movable direction D200, and is placed between the end 226a1 of the rail portion 226a and the restricting portion 226b.

The retaining portion 226f is provided between the slide surfaces 226c. The retaining portion 226f is provided with a first hole portion 226f1 and a second hole portion 226f2 in this order from the side closer to the rail portion 226a in the second movable direction D201. As for widths of the first hole portion 226f1 and the second hole portion 226f2 in the first movable direction D200, the first hole portion 226f1 is larger than the second hole portion 226f2. In addition, the retaining portion 226f has a pair of retaining walls 226f3 adjacent to the second hole portion 226f2 in the first movable direction D200.

The hole portion 226d is provided on the end (226a1) side beyond the slide surface 226c in the first movable direction D200.

The spring hook portion 226e is provided on the downstream side in a direction of an arrow E22, which is the side away from the rail portion 226a with respect to the hole portion 226d, in the first movable direction D200.

The spring seat surface 226h is the surface on the most downstream side, in the cartridge mounting direction (see arrow C in FIG. 8), of the development side member 226 on the driving side.

The cut-away portion 226g is provided on the non-driven side of the spring seat surface 226h in the longitudinal direction D202.

The guide surface 226i is a surface adjacent to the cut-away portion 226g and extending toward the upstream side in the cartridge mounting direction.

The rack gear 291 has a rectangular parallelepiped shape, and comprises a gear portion 291a, a guided groove 291b, a groove portion 291c, a spring hook portion 291d, and abutted surface 291e. The longitudinal direction of the rack gear 291 is the same as the first movable direction D200. The rack gear 291 is a gear movable linearly along the first movable direction D200.

The gear portion 291a is a portion including at least one gear tooth. The gear portion 291a of this embodiment has multiple gear teeth. The gear teeth are arranged in the first movable direction D200 of the rack gear 291. As will be described in detail hereinafter, the gear portion 291a of this embodiment is a part which corresponds to the gear portion 30a (see FIG. 9) of Embodiment 1. In order to mesh with the gear portion 81a of the drive transmission member 81, the gear portion 291a is at least partially exposed toward the outside of the cartridge. More specifically, the exposed portion of the gear portion 291a faces toward the side where the axis Ax1 of the drum 62 is located (see FIG. 23).

The guided groove 291b is a T-shaped groove penetrating in the first movable direction D200, which is parallel to the arrangement direction of the gear portion 291a. The guided groove 291b is shaped so that it can move only in the first movable direction D200 by the rail portion 226a of the driving-side development side member 226.

The groove portion 291c is a groove extending toward the gear portion 291a in the second movable direction D201. Of the surfaces defining the groove portion 291c, the surface parallel to the first movable direction D200 is a restricting surface 291c1, and of the two surfaces perpendicular to the second movable direction D201, the surface closer to the gear portion 291a is the locking surface 291c2. In addition, a corner portion formed on the opposite side of the restricting surface 291c1 in the second movable direction D201 of the locking surface 291c2 is a pressed portion 291c3.

The spring hook portion 291d is provided on the side of the groove portion 291c opposite to the gear portion 291a in the first movable direction D200.

The tension spring 292 is provided with spring hook portions 292a provided at the respective ends in the direction of extension. The spring hook portions 292a are shaped so that they can be connected to the spring hook portion 226e of the driving-side development side member 226 and to the spring hook portion 291d of the rack gear 291.

The locking member 293 has a flat plate shape and comprises a pressing portion 293a, a restricted surface 293b, a first cylindrical portion 293c, a second cylindrical portion 293d, a gap 293e, a retaining projection 293f, and a guided surface 293g. The guided surfaces 293g constitute a pair of opposing surfaces, and the extending direction thereof is the same as the second movable direction D201.

As shown in the Figure, the pressing portion 293a is inclined with respect to one of the guided surfaces 293g.

The restricted surface 293b is a surface extending from the pressing portion 293a toward the guided surface 293g in the first movable direction D200.

The first cylindrical portion 293c and the second cylindrical portion 293d are projections which extend in the longitudinal direction D202 away from the rack gear 291. In addition, the first cylindrical portion 293c and the second cylindrical portion 293d are arranged in this order in the direction away from the restricted surface 293b in the second movable direction D201. Further, there is provided a gap 293e between the first cylindrical portion 293c and the second cylindrical portion 293d.

The retaining projection 293f is a T-shaped projection extending in the direction opposite to the first cylindrical portion 293c and the second cylindrical portion 293d in the longitudinal direction D202. The retaining projection 293f includes an arm portion 293f1 and a retaining portion 293f2, and a width of the arm portion 293f1 in the second movable direction D201 is smaller than that of the retaining portion 293f2. In addition, in the longitudinal direction D202, the retaining portion 293f2 is located farther away from the first cylindrical portion 293c and the second cylindrical portion 293d than the arm portion 293f1.

The torsion coil spring 294 comprises an actuated arm 294a, an actuating arm 294b, and an inner diameter portion 294c. In addition, a state in which no load is imparted to the actuated arm 294a and the actuating arm 294b is defined as a free state. As viewed in the longitudinal direction D202 of the actuated arm 294a and the actuating arm 294b, the direction in which the free ends of the actuated arm 294a and the actuating arm 294b approach each other from the free state thereof is a closing direction, and the direction where they move away from each other is an opening direction. If the actuated arm 294a and the actuating arm 294b are continuously moved in the closing direction, the free ends thereof will meet and thereafter move away from each other, but the case where the free ends move away from each other at this time is also considered to be the closing direction.

The rotatable member 295 comprises a first cylindrical portion 295a, a second cylindrical portion 295b, a gap 295c, a first pressed surface 295d, a second pressed surface 295e, a gap 295f, and a shaft portion 295g.

The shaft portion 295g is a cylinder extending in the longitudinal direction D202, and serves as a rotational axis of the rotatable member 295. The rotational axis of the rotatable member 295 is referred to as a rotational axis Ax20.

The first cylindrical portion 295a and the second cylindrical portion 295b are projections extending in the longitudinal direction D202 toward the rack gear 291. When the clockwise direction about the rotational axis Ax20 as viewed in the direction in which the first cylindrical portion 295a and the second cylindrical portion 295b projects is defined as a rotational direction Q20, the first cylindrical portion 295a is disposed downstream and the second cylindrical portion 295b is disposed upstream in the rotational direction Q20. A gap 295c is provided between the first cylindrical portion 295a and the second cylindrical portion 295b.

The first pressed surface 295d and the second pressed surface 295e are disposed at positions spaced by a certain amount in the radial direction from the rotational axis Ax20. In addition, in the rotational direction Q20, the first pressed surface 295d faces downstream and the second pressed surface 295e faces upstream. A gap 295f is provided between the first pressed surface 295d and the second pressed surface 295e.

The support member 296 comprises a hole 296a, a developing roller support hole 296b, and a guide surface 296c, and is a member which is fixed to the driving-side development side member 226 when the rack gear mechanism 290 is assembled. In the longitudinal direction D202, the hole 296a and the guide surface 296c are provided on one end side, and the developing roller support hole 296b is provided on the other end side. Here, the one end side is the side on which the hole portion 226d of the driving-side development side member 226 is provided.

The hole 296a is provided so as to be coaxial with the hole portion 226d of the driving-side development side member 226 when the rack gear mechanism 290 is assembled. The assembling of the rack gear mechanism 290 will be described hereinafter.

The guide surface 296c is arranged so as to face and be parallel to the guide surface 226i of drive-side developing side member 226 when rack gear mechanism 290 is assembled.

The pressed member 297 is L-shaped and comprises a pressed surface 297a, a spring seat 297e, a guided surface 297c, a cut-away portion 297d, and a cylindrical portion 297b.

The pressed surface 297a is a surface extending in longitudinal direction D202. In addition, the spring seat 297e is provided on the surface opposite the pressed surface 297a.

The guided surfaces 297c constitute a pair of surfaces extending vertically from the spring seat 297e, and when the rack gear mechanism 290 is assembled, they are arranged so as to be parallel to the guide surface 226i of the driving-side development side member 226 and the guide surface 296c of the support member 296.

The cut-away portion 297d is provided in the gap 297d1 between the guided surfaces 297c, and has an entrance portion 297d2 which is open on the side away from the pressed surface 297a.

The cylindrical portion 297b is a protrusion extending in the longitudinal direction D202.

The initialization spring 298 is a compression spring (compression coil spring), but other elastic members may be used instead of such a spring.

### <Assembly of Rack Gear Mechanism>

Next, referring to FIGS. 26 to 29, an assembling method of the rack gear mechanism 290 will be explained. FIGS. 26 and 27 are illustrations showing the assembly method of the rack gear mechanism 290. The mechanism is assembled in the order of part (a) of FIG. 26, part (b) of FIG. 26, and part (c) of FIG. 26, and part (a) of FIG. 27, part (b) of FIG. 27, and part (c) of FIG. 27. FIG. 28 is an illustration showing the assembly method of the rack gear mechanism 290 to the developing unit 220. Part (a) of FIG. 28 shows the state before the assembling, and part (b) of FIG. 28 shows the state after the assembling. FIG. 29 shows an arrangement of the rack gear 291 of the rack gear mechanism 290. Part (a) of FIG. 29 is a view as viewed in the direction perpendicular to the rotational axis of the drum 62, and part (b) of FIG. 29 is a cross-sectional view taken along a line X200-X200.

First, as shown in part (a) of FIG. 26, the locking member 293 is assembled to the driving-side development side member 226. The locking member 293 is assembled in the direction of the arrow E20 along the longitudinal direction D202 in order to pass the retaining portion 293f2 through the first hole portion 226f1 of the driving-side development side member 226. The locking member 293 moves in the direction of an arrow E21 along the second movable direction D201 after the retaining portion 293f2 is completely passed through the first hole portion 226f1. Then, the movement of the locking member 293 in the longitudinal direction D202 is restricted by the retaining wall 226f3 as the arm portion 293f1 passing through the second hole portion 226f2. In addition, the guided surface 293g of the locking member 293 is sandwiched by the sliding surfaces 226c, so that the movement of the locking member 293 in the first movable direction D200 is restricted. As a result, the locking member 293 is supported by the driving-side development side member 226 so as to be movable only in the second movable direction D201.

Next, as shown in part (b) of FIG. 26, the rack gear 291 is assembled to the driving-side development side member 226. The rack gear 291 is assembled to the rail portion 226a in the direction of the arrow E22 along the first movable direction D200 so that the guided groove 291b is fitted from the end 226a1 of the rail portion 226a. The guided groove 291b of the rack gear 291 is supported by the rail portion 226a, so that the movement of the rack gear 291 in the second movable direction D201 and the longitudinal direction D202 is restricted. As a result, the rack gear 291 is supported by the driving-side development side member 226 so as to be movable only in the first movable direction D200.

Next, the spring hook portion 292a of the tension spring 292 is assembled to the spring hook portion 291d of the rack gear 291 and to the spring hook portion 226e of the driving-side development side member 226. As a result, as shown in part (c) of FIG. 26, the rack gear 291 is urged in the direction of the arrow E22 by a force F20 of the tension spring 292. The abutted surface 291e is abutted against the restricting portion 226b of the driving-side development side member 226 by the force F20, so that the movement of the rack gear 291 in the direction of the arrow E22 is restricted.

Next, as shown in part (a) of FIG. 27, the torsion coil spring 294 and the rotatable member 295 are assembled to the driving-side development side member 226. First, the shaft portion 295g of the rotatable member 295 is inserted into the inner diameter portion 294c of the torsion coil spring 294 in a phase in which the actuated arm 294a is positioned in the gap 295c. The rotatable member 295 is assembled in the direction of the arrow E20 along the longitudinal direction D202, and the shaft portion 295g is rotatably supported in the hole portion 226d. At this time, the torsion coil spring 294 is assembled so that the actuating arm 294b is positioned in the gap 293e of the locking member 293.

Next, as shown in part (b) of FIG. 27, the pressed member 297 and the initialization spring 298 are assembled to drive-side development side member 226. The pressed member 297 is inserted into cut-away portion 226g in the direction of an arrow E24 along the guide surface 226i. At this time, the pressed member 297 is assembled so that the cylindrical portion 297b is positioned in the gap 295f of the rotatable member 295. In addition, the pressed member 297 passes through the shaft portion 295g of rotatable member 295 from entrance portion 297d2 to into the gap 297d1. The pressed member 297 is arranged so that guided surface 297c and guide surface 226i face each other. Thereafter, the initialization spring is compressed and provided between the spring seat 297e of the pressed member 297 and the spring seat surface 226h of the driving-side development side member 226.

Next, as shown in part (c) of FIG. 27, the support member 296 is assembled to the driving-side development side member 226. The support member 296 is assembled in the direction of arrow E25 along the longitudinal direction D202, and the shaft portion 295g of the rotatable member 295 is inserted into the hole portion 296a. In addition, the guide surface 296c is fixed to the driving-side development side member 226 by adhesive or the like while supporting the guided surface 297c of the pressed member 297. At this time, the shaft portion 295g of the rotatable member 295 is rotatably supported by the hole portion 226d of the driving-side development side member 226 and the hole portion 296a of the support member 296. The pressed member 297 is supported by the guide surface 226i of the driving-side development side member 226 and the guide surface 296c of the support member 296 so as to be movable in a predetermined direction, and this predetermined direction is referred to as a third movable direction D203. The movement of the rotatable member 295, the torsion coil spring 294, and the pressed member 297 in the longitudinal direction D202 is restricted by the driving-side development side member 226 and the support member 296. With this structure as described above, the rotatable member 295 is supported by the driving-side development side member 226 and the support member 296 so as to be rotatable about the rotational axis Ax20. Similarly, the pressed member 297 is supported by the driving-side development side member 226 and the support member 296 so as to be movable in the third movable direction D203.

Through the above process, the rack gear mechanism 290 is assembled.

Next, the rack gear mechanism 290 is mounted to the developing unit 220. As shown in part (a) of FIG. 28, the rack gear mechanism 290 is mounted in the direction of arrow E26 along the longitudinal direction D202 so that the support shaft 32a of the developing roller 32 is inserted into the support hole 296b of the support member 296. Thereafter, the rack gear mechanism 290 is then fixed to the developing unit 220 with screws or the like (see part (b) of FIG. 28).

Finally, the developing unit 220 to which the rack gear mechanism 290 has been mounted and the cleaning unit 260 are assembled, but as this is similar to Embodiment 1, a description thereof will be omitted.

Here, referring to FIG. 29, the range of the rack gear 291 of the rack gear mechanism 290 will be described. The rack gear 291 is a part corresponding to the developing roller gear 30 (see FIG. 9, and so on) of Embodiment 1, and therefore, the preferred location of the rack gear 291 is similar to the preferred range of the developing roller gear 30. However, there are differences between them, which will be described in detail below.

The rack gear 291 is a movable part, which will be described in detail hereinafter. Unless otherwise specified, the following description is based on the premise that the cartridge is in the initial position before it is mounted in the main assembly of the apparatus, that is, the state in which the rack gear 291 is in the position for meshing with the drive transmission member 81.

In part (a) of FIG. 29, for the purpose of better illustration only the drum 62 and the driving side drum flange 263 are shown as constituting the cleaning unit 260. Similarly, part (b) of FIG. 29 shows only the drum 62, the developing roller 32, and the rack gear 291. In addition to the arrangement in this embodiment, the rack gear 291 in part (b) of FIG. 29 is also illustrated in a state where an angle K20 which will be described hereinafter is in positive and negative directions for the sake of explanation, with the positive angle being an angle K20U and the negative angle being an angle K20L. Part (b) of FIG. 29 corresponds to a view of the cartridge as seen along the axis Ax1 of the photosensitive drum. That is, part (b) of FIG. 29 is a view of the cartridge as seen in the axial direction of the photosensitive drum. In other words, part (b) of FIG. 29 corresponds to a view of some components of the cartridge projected onto a plane perpendicular to the axis Ax1 of the photosensitive drum.

As shown in part (a) of FIG. 29, in the longitudinal direction D202, the gear portion 291a of the rack gear 291 is on an arrow E20 direction side of the free end portion 263b1 of the coupling projection 263b of the driving side drum flange 263. In other words, the gear portion 291a of the rack gear 291 is located on an outer side in the longitudinal direction than the free end portion 263b1 of the coupling projection 263b of the driving side drum flange 263. Further in other words, the gear portion 291a of the rack gear 291 is located on the side farther away from the non-driving side of the cartridge B than the free end portion 263b1 of the coupling projection 263b of the driving side drum flange 263.

Namely, the gear portion 291a is located farther away from the non-driving side of the cartridge B and the end of the non-driving side of the drum 62 than the free end portion 263b1 is. In other words, the distance from the end of the non-driving side of the drum 62 to the gear portion 291a is longer than the distance from the end of the non-driving side of the drum 62 to the free end portion 263b1. Here, these distances are measured along a direction parallel to the axis Ax1 of the photosensitive drum.

The distance between the gear portion 291a and the free end portion 263b1 measured along the longitudinal direction D202 is referred to as a distance L20. The distance L20 is arbitrary position of the gear portion 291a. In this case, the distance L20 is in the range of 0 to 12 mm, and more preferably, in the range of 3 to 9 mm or less. In this embodiment, it is 5.5 mm. The range of the distance L20 may be further increased depending on the tooth width of the gear portion 291a and the structure of the driving side drum flange 263.

In this embodiment, the entire region of the gear portion 291a is located on the arrow E20 direction side with respect to the free end portion 263b1, but the gear portion 291a may be partially located on the arrow E20 direction side of the free end portion 263b1. In other words, at least a part of the gear portion 291a is located on the arrow E20 direction side of the free end portion 263b1.

As shown in part (b) of FIG. 29, a direction perpendicular to the first movable direction D200 is defined as a perpendicular direction D207. The arrow showing the perpendicular direction D207 is a straight line perpendicular to the moving direction (first movable direction D200) of the rack gear 291 and to the straight line passing through each tooth free end portion of the rack gear 291. This arrow also passes through the gear portion 291a of the rack gear 291 and extends in a direction away from the rotational axis Ax1 of the drum 62.

As shown in part (b) of FIG. 29, the distance measured along the perpendicular direction D207 from the rotational axis Ax1 of the drum 62 to a straight line passing through the multiple tooth tips of the gear portion 291a of the rack gear 291 is referred to as a distance L21. This distance L21 is the distance measured along the direction perpendicular to the rotational axis Ax1 from the rotational axis Ax1 of the drum 62 to a straight line passing through the multiple tooth tops of the gear portion 291a.

Here, it is desirable that the distance L21 is in the range of 90% to 120% of the radius of the drum 62, more preferably 90% to 110%. This is because the gear portion 291a meshes reliably with the gear portion 81a of the drive transmission member 81.

In this embodiment, as in Embodiment 1, the radius of the drum 62 is 12 mm, and the distance L21 is in the range of 11.165 mm to 12.84 mm. In other words, the distance L21 from the axis of the drum 62 to the top of the gear teeth of the gear portion 291a is in the range of 93% to 107% of the drum radius.

Furthermore, the distance from the rotational axis Ax1 of the drum 62 to the tooth top of the gear portion 291a closest to the rotational axis Ax1, measured along a direction perpendicular to the rotational axis Ax1, is referred to as L22.

Similarly to the case of L21, a distance L22 is preferably in the range of 90% to 120% of the radius of the drum 62, more preferably 90% to 110%. In this embodiment, it is in the range of 93% to 107%.

In order to mesh with the drive transmission member 81, the gear portion 291a is at least partially exposed so as to face the drum axis Ax1 (see part (a) of FIG. 29 and part (b) of FIG. 29). An open space is provided between the gear portion 291a and the drum axis Ax1 so that the drive transmission member 81 can be disposed between the gear portion 291a and the drum axis Ax1

In addition, a straight line extending from the rotational axis Ax1 of the drum 62 so as to pass through the rotational axis Ax2 of the developing roller 32 is used as a reference line, and the angle between this reference line and the perpendicular direction D207 is referred to as angle K20. The downstream direction of the rotation of the drum 62 is positive direction of the angle K20.

In this embodiment, the angle K20 is 0°, and therefore, the perpendicular direction D207 coincides with the reference line. For this, the angles K20U and K20L are referred to.

The downstream direction of the rotation of the drum 62 is the positive direction of the angle. In other words, for the angle K20, the downstream side of the direction of arrow R, which is the direction of rotation of the drum 62, is positive, and the upstream side of the direction of arrow R is negative. With this definition, it is preferable that the rack gear 291 is disposed so that the angle K20 is in the range of −75° to 50°.

The lower limit of K20 is selected from the viewpoint of more reliably engaging the drive transmission member 81 and the rack gear 291 with each other, and also from the viewpoint of avoiding interference between the rack gear 291 and the cartridge structure around it and the main assembly of the image forming apparatus A. Therefore, it is more preferable that angle K20 be −50° or greater, and even more preferable that angle K20 be −35° or greater.

Furthermore, with regard to the upper limit of K20, it is more preferable that angle K20 is 45° or less, and even more preferable that angle K20 is 30° or less. This is from the viewpoint of ensuring more reliable meshing of the drive transmission member 81 and the rack gear 291, and of preventing interference of the rack gear 291 and the surrounding cartridge structure with the main assembly of the image forming apparatus A.

It is preferable to select an appropriate combination of the upper and lower limits of the above-described angles depending on the structure of the apparatus main assembly A and the cartridge.

In this way, the preferable range of angle K20 is selected to be appropriate depending on the structure of the main assembly of the image forming apparatus A to which this embodiment is applied, and this will be described hereinafter.

As described above, the straight line connecting the rotational axis Ax1 of the drum 62 and the rotational axis Ax2 of the developing roller 32 is used as a reference line. The angle formed by a straight line extending from the rotational axis Ax1 of the drum 62 and passing through the teeth of the gear portion 291a of the rack gear 291 with respect to this reference line is angle K21 (see FIG. 29).

The angle K21 is positive in the downstream direction of the arrow R, which is the rotational direction of the drum 62, and is negative in the upstream direction of the arrow R. At this time, it is preferable that the rack gear 291 is disposed so that the angle K21 is −75° or more and 50° or less. This is a preferable condition for the gear portion 81a of the drive transmission member 81 (see FIG. 13) and the gear portion 291a of the rack gear 291 to mesh with each other.

With respect to the lower limit of K21, from the viewpoint of more secure engagement between the drive transmission member 81 and the rack gear 291, it is further preferable that the angle K21 is not less than −50°, and it is even further preferable that the angle is not less than −35°.

With respect to the upper limit of K21, it is further preferable that the angle K21 is not more than 45°, and it is even further preferable that the angle is not more than 30°. This is from the viewpoint of more secure engagement between the drive transmission member 81 and the rack gear 291, and from the viewpoint of preventing the rack gear 291 and the surrounding cartridge structure from interfering with the apparatus main assembly.

Depending on the structures of the apparatus main assembly A and the cartridge, it is preferable to select an appropriate combination of the upper and lower limits of the above-described angle. In this embodiment, K21 is set to be not less than −35° and not more than 45°.

It is preferable that the angle K21 of at least one tooth of the gear portion 291a of the rack gear 291 is arranged so as to be within the above-described preferable range. However, it is further preferable that the angle K21 between the reference line and a line from the rotational axis Ax1 toward the closest tooth tip of the rack gear is within the above-described preferred range.

In this embodiment, the rack gear mechanism 290 is provided in the developing unit 220, but it may be provided in the cleaning unit 260, depending on the settings of the angle K20, the angle K21, the distance L20, and the distance L21.

### <Operation of Rack Gear Mechanism>

Next, referring to FIG. 30, operation of the rack gear mechanism 290 will be explained.

FIG. 30 is an operation illustration of the rack gear mechanism 290, wherein parts (a) and (c) are cross-sectional views taken along the line X201-X201 in part (a) of FIG. 29, and part (b) of FIG. 29 and part (d) of FIG. 29 are cross-sectional views taken along the line X202-X202. Parts (a) and (c) of FIG. 30 show the rack gear mechanism 290 in a standby state (non-operating state), and parts (b) and (d) show the rack gear mechanism 290 in an operating state. Some of the members are shown with hatching for better understanding.

First, referring to part (a) of FIG. 30 and part (c) of FIG. 30, a standby state (non-operating state) of the rack gear mechanism 290 will be explained. As shown in part (a) of FIG. 30, the pressed member 297 is urged in the direction of an arrow E25 along the third movable direction D203 by an urging force F21 of the initialization spring 298 to be placed in a first position shifted in the direction of arrow E25. In addition, the cylindrical portion 297b abuts against the first pressed surface 295d of the rotatable member 295 to apply the force F22 to the first pressed surface 295d. A moment M21 due to the force F22 is produced in the rotatable member 295 to urge rotatable member 295 in the rotational direction Q21 about the rotational axis Ax20.

As shown in part (c) of FIG. 30, the first cylindrical portion 295a of the rotatable member 295 is urged in a rotational direction Q21 about the rotational axis Ax20. The actuated arm 294a of the torsion coil spring 294 abuts against the first cylindrical portion 295a of the rotatable member 295 and receives a force F23. By receiving this force F23, a moment M23 is produced by the torsion coil spring 294 about the rotational axis Ax1. This moment M23 urges the torsion coil spring 294 in a rotational direction Q23 about the rotational axis Ax21. And, the actuating arm 294b of the torsion coil spring 294 abutting against the second cylindrical portion 293d of the locking member 293 applies a force F24 to the second cylindrical portion 293d. The actuating arm 294b abuts against the second cylindrical portion 293d of the locking member 293.

With this structure, the locking member 293 is urged in the direction of the arrow E21. Here, an angle between the actuated arm 294a and the actuating arm 294b of the torsion coil spring 294 is set at a position slightly shifted in the direction of opening from the free state position. Then, the actuated arm 294a and the actuating arm 294b of the torsion coil spring 294 tend to return to their closed state. The force F24 toward the locking member 293 is maintained. This state is called the standby state of the rack gear mechanism 290. Although the details will be described hereinafter, the standby state is a non-operating state in which the locking member 293 of the rack gear mechanism 290 is not operated.

Next, referring to part (b) of FIG. 30 and part (d) of FIG. 30, the operating state of the rack gear mechanism 290 will be described. When the cartridge B is mounted in the main assembly of the image forming apparatus A, the pressed surface 297a of the pressed member 297 comes into contact with a part of the main assembly of the image forming apparatus A and is pressed in the direction of the arrow E24. In this embodiment, a part of the main assembly of the image forming apparatus A is an abutment portion 15m of the driving side plate 15 (see part (a) of FIG. 31). When the pressed member 297 moves in the direction of the arrow 24, the second pressed surface 295e of the rotatable member 295 is pressed against the cylindrical portion 297b, so that the rotatable member 295 rotates in the rotational direction Q20 about the rotational axis Ax20 (see part (b) of FIG. 30 and part (d) of FIG. 30).

In this state, the pressed member 297 is urged in the direction of the arrow E24 along the third movable direction D203 by an external force F25, and moves in the direction of the arrow E24 to a second position. In addition, the cylindrical portion 297b of the pressed member 297 comes into contact with the second pressed surface 295e of the rotatable member 295 to apply a force F26 to the second pressed surface 295e of the rotatable member 295.

A moment M22 is produced in the rotatable member 295 by the force F26, and the rotatable member 295 rotates in the rotational direction Q20 about the rotational axis Ax20. As shown in part (d) of FIG. 30, by the rotation of the rotatable member 295 in the rotational direction Q20, the second cylindrical portion 295b comes into contact with the actuated arm 294a of the torsion coil spring 294 to apply a force F200. The torsion coil spring 294 is spring-charged by the force F200, and a moment M24 is produced, so that the torsion coil spring 294 is urged in a rotational direction Q24 about a rotational axis Ax22 which is the rotational axis of the torsion coil spring 294 at this time.

The actuating arm 294b of the torsion coil spring 294 comes into contact with the first cylindrical portion 293c of the locking member 293 to apply a force F27 to the first cylindrical portion 293c. The force F27 urges the locking member 293 in the direction of the arrow E27, and the restricted surface 293b abuts against the rack gear 291. At this time, the angle between the actuated arm 294a and the actuating arm 294b of the torsion coil spring 294 is smaller than in the free state. In other words, the actuated arm 294a and the actuating arm 294b of the torsion coil spring 294 tends to restore to their original opening direction.

As a result, the torsion coil spring 294 maintains a state in which the actuating arm 294b urges the locking member 293 by the force F27 in the direction of the arrow E27 along the second movable direction D201. This state is referred to as the operating state of the rack gear mechanism 290.

Although details will be described hereinafter, the operating state is a state in which the locking member 293 is operable. In other words, with the rack gear mechanism 290 taken in the operating state, after the rack gear 291 moves, the rack gear 291 is locked by the locking member 293 and does not return to its original position.

When the cartridge B is dismounted from the main assembly of the image forming apparatus A in this state, the pressed member 297 moves in the direction of the arrow E25 by the urging force F21 of the initialization spring 298, as shown in part (a) of FIG. 30 and part (c) of FIG. 30. The first pressed surface 295d of the rotatable member 295 is pressed by the cylindrical portion 297b, so that the rotatable member 295 rotates in the rotational direction Q21 about the rotational axis Ax20. In other words, the rack gear mechanism 290 returns to the standby state (non-operating state) shown in part (a) of FIG. 30.

The standby state is a state in which the locking member 293 is not operated, as will be described in detail hereinafter. In other words, when the rack gear mechanism 290 returns to the standby state, the rack gear 291 is no longer locked by the locking member 293, and therefore the rack gear 291 can return to the original position thereof.

The locking member 293 may be simply called a lock, and the pressed member 297 may be called an operating part. The pressed member 297 is operated by mounting the cartridge to or dismounting it from the main assembly of the image forming apparatus A.

### <Structure of Main Assembly of Image Forming Apparatus>

Next, referring to FIGS. 31 and 32, the structure of the main assembly of the image forming apparatus A in this embodiment will be described.

FIG. 31 is an illustration of the structure of the main assembly of the image forming apparatus A. Part (a) of this Figure is an exploded perspective view of the drive side, and part (b) thereof is a view seen along a direction perpendicular to the longitudinal direction.

FIG. 32 is an illustration showing the structure of the main assembly of the image forming apparatus A. Part (a) of FIG. 32 is a cross-sectional view taken along a line X204-X204 in part (b) of FIG. 31, part (b) of FIG. 32 is a cross-sectional view taken along a line X205-X205 in part (a) of FIG. 32, and part (c) of FIG. 32 is an enlarged view showing a DT20 area in part (a) of FIG. 32. The Figures of the main assembly of the image forming apparatus A in this embodiment and the following embodiments are shown in more detail than that in Embodiment 1. The members corresponding to those described in Embodiment 1 are assigned the same names as in Embodiment 1.

As shown in part (a) of FIG. 31, the main assembly of the image forming apparatus A in this embodiment includes a cylindrical cam 86, a drive transmission member 81, and a driving side outer frame 50, which are arranged in this order in the direction of the arrow DW4 which indicates the longitudinal drive direction, from the driving side plate 15. In addition, a drive transmission member bearing 83 provided with a drive transmission member spring 84 is attached to the driving side outer frame 50.

The driving side plate 15 is provided with a hole portion 15n through which the gear portion 81a of the drive transmission member 81 passes, and includes an abutment portion 15m for abutting against the pressed member 297 of the rack gear mechanism 290 described in the foregoing.

The drive transmission member 81 includes a second gear portion 81k for receiving a drive force from a drive source of the main assembly of the image forming apparatus A (not shown). A cylindrical portion 81m is connected between the gear portion 81a and the second gear portion 81k. A diameter of the cylindrical portion 81m is slightly larger than an addendum circle of the gear portion 81a, and slides in the hole portion 15n of the driving side plate 15.

The driving side outer frame 50 is provided with a projection 50a that projects inward in the longitudinal direction.

Here, the drive transmission member 81 is structured to be inclinable in a predetermined inclining direction DW1. This will be described below.

As shown in part (a) of FIG. 32, the projection 50a of the driving side outer frame 50 is disposed at a position rotated by an angle K21 clockwise from an upstream side of the gravity direction DZ1 of the vertical direction DZ around the center of the drive transmission member bearing 83 (see part (b) of FIG. 7). A line connecting the projection 50a to the center of the drive transmission member bearing 83 (see part (b) of FIG. 7) is defined as a direction D205, and a direction from the projection 50a toward the center of the drive transmission member bearing 83 is defined as an inclining direction DW1.

As shown in part (b) of FIG. 32, the fixed end 81c of the drive transmission member 81 is supported by the drive transmission member bearing 83 in a cantilever fashion. As described in Embodiment 1, when the opening/closing door 13 is open, the cylindrical cam 86 moves toward the driving side in the longitudinal direction (see FIG. 7). Here, a rib extending toward the non-driving side in the longitudinal direction on the wall surface connecting the second gear portion 81k and the cylindrical portion 81m with each other is an abutment rib 81k2, and an end face of the second gear portion 81k on the driving side in the longitudinal direction is an abutment surface 81k1. The drive transmission member 81 abuts against the cylindrical cam 86 at the abutment rib 81k2 and against the projection 50a at the abutment surface 81kl. At this time, the coupling free end portion 81b1 side of the drive transmission member 81 tilts in the inclining direction DW1 with the fixed end 81c as a fulcrum.

The drive transmission member 81 has a play between the cylindrical cam 86 and the projection 50a, and an amount of tilt of the drive transmission member 81 in the inclining direction DW1 is determined by the abutment of the gear portion 81a against the hole portion 15n of the driving side plate 15. Here, as shown in part (c) of FIG. 32, a straight line that is parallel to the direction D205 and passes through the center of the drive transmission member bearing 83 (see part (b) of FIG. 7) is defined as a straight line SL1. The hole portion 15n of the driving side plate 15 has a pair of gear support surfaces 15n1 on an inclining direction DW1 side, the pair being symmetrical with respect to the straight line SL1. The position of the drive transmission member 81 in the inclining direction DW1 is determined by the abutment of the gear portion 81a against the pair of gear support surfaces 15n1.

In addition, the drive transmission member 81 is supported as a cantilever with the fixed end 81c as a fulcrum, and therefore, the free end of the coupling 81b1 also tilts in the inclining direction DW1 due to the inclination caused by gravity.

In addition, the gear portion 81a of the drive transmission member 81 is not restricted in position in the direction D206 perpendicular to the direction D205, and tilts in the direction D206 when an external force is applied on the gear portion 81a or the like.

### <Mounting of Cartridge to Main Assembly of Image Forming Apparatus>

Next, referring to FIG. 33, the operation of mounting the cartridge B to the main assembly of the image forming apparatus A in this embodiment will be described. FIG. 33 is a cross-sectional view showing the mounting operation of the cartridge B to the main assembly of the image forming apparatus A, taken along a line X202-X202 in part (a) of FIG. 29. Also, part (a) of this Figure shows a state immediately before mounting the cartridge, and part (b) shows a state after mounting the cartridge.

As shown in part (a) of FIG. 33, immediately before the cartridge B is mounted to the main assembly of the image forming apparatus A, the pressed surface 297a of the pressed member 297 faces the abutment portion 15m of the driving side plate 15 which is a part of the main assembly of the image forming apparatus A. At this time, the rack gear mechanism 290 is in the standby state. Also, the gear portion 291a of the rack gear 291 is immediately before brought into meshing engagement with the gear portion 81a of the drive transmission member 81. When the cartridge B moves from this position in the mounting direction C, it reaches the state after the cartridge B is mounted, as shown in part (b) of FIG. 33.

At this time, the position of the rack gear 291 relative to other parts of the cartridge will be called initial position, engagement position, operating position, pre-movement position, and so on. The rack gear 291 is urged to the initial position by the tension spring 292.

Here, the movement of the rack gear 291 in the direction of the arrow E22 along the first movable direction D200 is restricted, and therefore, during the mounting process of the cartridge B, the gear portion 81a of the drive transmission member 81 and the gear portion 291a of the rack gear 291 interfere with each other. However, as described above, the gear portion 81a of the drive transmission member 81 can be tilted in a direction D206 perpendicular to the direction D205 by an external force. Therefore, if the component of the direction D206 toward the downstream side of the mounting direction Cis defined as an escaping direction DW2, when the gear portion 291a of the rack gear 291 comes into contact with the gear portion 81a of the drive transmission member 81, the gear portion 81a tilts in the escaping direction DW2. This makes it possible to prevent interference between the gear portion 291a of the rack gear 291 and the gear portion 81a. Thereafter, the gear portion 291a of the rack gear 291 moves to a meshing position relative to the gear portion 81a of the drive transmission member 81, and the gear portion 81a of the drive transmission member 81 is brought into meshing engagement with the gear portion 291a due to its own weight.

Then, when the cartridge B is mounted in the main assembly of the image forming apparatus A, the pressed member 297 is pressed by the abutment portion 15m of the driving side plate 15 to move to the second position. This causes the rack gear mechanism 290 to change to the operating state.

### <Engagement Operation of Drive Transmission Member 81>

Next, FIGS. 34 to 36, the description will be made as to the operation from when the drive transmission member 81 is driven until the coupling recess 81b is brought into engagement with the coupling projection 263b of the driving side drum flange 263. FIG. 34 is a cross-sectional view showing the operation when the drive transmission member 81 is driven, taken along a line X202-X202 in part (a) of FIG. 29. Part (a) of this Figure shows driving with the drive transmission member 81 inclined, and part (b) shows immediately after the drive transmission member 81 is aligned with the rotational axis Ax1 of the drum 62. FIG. 35 is a sectional view showing the engagement operation of the drive transmission member 81, taken along a line X203-X203 in part (a) of FIG. 34. Part (a) of this Figure shows a state in which the drive transmission member 81 is inclined, part (b) of this Figure is a states in which the drive transmission member 81 is aligned with the rotational axis Ax1 of the drum 62, and part (c), is a state in which the coupling recess 81b is engaged with the coupling projection 263b of the driving side drum flange 263. FIG. 36 is cross-sectional views showing the operation of the rack gear mechanism 290 after the drive transmission member 81 is aligned with the rotational axis Ax1 of the drum 62, taken along a line X202-X202 in part (a) of FIG. 29. Part (a) of FIG. 36 shows the process in which the movement of the rack gear 291 is restricted by the locking member 293, and part (b) of FIG. 36 shows a state in which the movement is restricted.

As shown in part (a) of FIG. 34, when the drive transmission member 81 rotates in the rotational direction CW, an engaging reaction force FD20, which is a reaction force of an engaging force FD1, is produced in the gear portion 81a by the meshing of the gears, as in Embodiment 1. At this stage, the inclined gear portion 81a moves in the direction of the engaging reaction force FD20, and therefore, not much force is transmitted to the gear portion 291a, and the engaging force FD1 is very small. Therefore, the engaging force FD1 is smaller than the force F20 by the tension spring 292 acting on the rack gear 291, and the rack gear 291 does not move by the engaging force FD1. The rack gear 291 remains in the initial position.

In this embodiment, the tension spring 292 is used as the elastic member for urging the rack gear 291 toward its initial position, but this is not inevitable. For example, the rack gear 291 may be urged by a different type of spring.

The rack gear 291 remains in its initial position, but on the other hand, the gear portion 81a of the drive transmission member 81 is moved by the engaging force FD1. If the axis of the drive transmission member 81 is a rotational axis Ax3 (see part (a) of FIG. 35), the movement of the gear portion 81a causes the rotational axis Ax3 to move in a direction coinciding with the rotational axis Ax1 of the drum 62. Then, as shown in part (b) of FIG. 34, the gear portion 81a comes into contact with the restricting portion 73j, and the rotational axis Ax3 of the drive transmission member 81 and the rotational axis Ax1 of the drum 62 become substantially coaxial with each other.

As in Embodiment 1, a thrust force FA is generated by the meshing of the helical teeth of the gear portion 81a and the gear portion 291a. As shown in part (b) of FIG. 35, a thrust force FA in the axial direction (longitudinal direction) is imparted to the drive transmission member 81 to move it in the longitudinal direction to toward the non-driven side (the side approaching the cartridge). That is, the drive transmission member 81 approaches and contacts the coupling projection 63b. When the drive transmission member 81 rotates such that triangular phases of the coupling recess 81b and the coupling projection 63b match, the coupling projection 263b enters the coupling recess 81b as shown in part (c) of FIG. 36. As in Embodiment 1, when the surfaces constituting the coupling projection 263b and the coupling recess 81b are brought into contact with each other and the drive is transmitted, a new thrust force FC is produced because both are twisted (inclined) with respect to the axis.

When the gear portion 81a of the drive transmission member 81 comes into contact with the restricting portion 73j or when the coupling recess 81b is engaged with the coupling projection 63b, the movement of the gear portion 81a in directions other than the rotational direction is restricted. When the movement of the drive transmission member 81 is restricted, the force can be sufficiently transmitted to the gear portion 291a of the rack gear 291 from the gear portion 81a. Therefore, as shown in part (b) of FIG. 34, the engaging force FD2 becomes greater than the force F20 which urges the rack gear 291 by the tension spring 292, where FD2 is a meshing force which the gear portion 291a receives due to the meshing force between the gears at this time. Therefore, the rack gear 291 is moved from the initial position in the direction of the arrow E28 along the first movable direction D200 by the engaging force FD2.

When the rack gear 291 moves by a certain amount in the direction of the arrow E28, the pressed portion 291c3 abuts against the pressing portion 293a of the locking member 293 as shown in part (a) of FIG. 36. Here, the locking member 293 is urged in the direction of the arrow E27 along the second movable direction D201 by the force F27 from the torsion coil spring 294. Therefore, the pressed portion 291c3 of the rack gear 291 receives a force F28a from the pressing portion 293a of the locking member 293. A force F28a1 which is a first movable direction D200 component of the force F28a, is selected to be larger than a force F20a from the tension spring 292. Therefore, the rack gear 291 moves in the direction of the arrow E28, and the locking member 293 further moves in the direction of the arrow E27.

When the rack gear 291 moves in the direction of the arrow E28, as shown in part (b) of FIG. 36, the gear portion 291a is brought out of meshing with the gear portion 81a of the drive transmission member 81. In this state, the locking member 293 is urged in the direction of the arrow E27 along the second movable direction D201 by a force F27a from the torsion coil spring 294. As a result, the pressed portion 291c3 of the rack gear 291 receives a force F28b from the pressing portion 293a of the locking member 293. If the force of the is defined as force F28b1, a force F28b1 which is a first movable direction D200 component of the force F28b is selected to be larger than a force F20b from the tension spring 292. By doing so, the movement of the rack gear 291 in the direction of the arrow E22 is restricted by the locking member 293. Also, the locking member 293 moves from the unlocked position shown in part (a) of FIG. 36 to the locked position shown in part (b) of FIG. 36, and this state is maintained.

As a result, the gear portion 291a is maintained in a state not meshed with the gear portion 81a of the drive transmission member 81. The position of the rack gear 291 in the cartridge at this time is called a retracted position, a non-engaged position, a post-movement position, and so on.

In this manner, the rack gear 291 moves from the initial position to the retracted position by meshing with the gear portion 81a of the drive transmission member 81 and receiving the driving force from the gear portion 81a. When the rack gear 291 is in the retracted position, the movement of the rack gear 291 is prevented and locked by the locking member 293 in the locked position, and the rack gear 291 remains in the retracted position.

One of the initial position (see part (a) of FIG. 36) and the retracted position (see part (b) of FIG. 36) of the rack gear 291 may be referred to as the first position of the rack gear 291, and the other may be referred to as the second position of the rack gear 291. The rack gear 291 is a movable member movable between the first position and the second position. As the rack gear 291 moves, the teeth of the rack gear 291 also move between the first position and the second position.

Similarly, one of the locked position (see part (a) of FIG. 36) and the unlocked position (see part (b) of FIG. 36) of the locking member 293 may be referred to as the first position of the locking member 293, and the other may be referred to as the second position of the locking member 293. The locking member 293 is also a movable member movable between the first position and the second position.

The locking member 293 which keeps the rack gear 291 in the retracted position is not inevitable, but it is preferable. To explain reasons, a hypothetical situation will be explained in which the cartridge does not have the locking member 293 and the movement of the rack gear 291 is not restricted by the locking member 293.

In this case, when the rack gear 291 moves to the retracted position by receiving a driving force from the drive transmission member 81, and the engagement with the drive transmission member is released, then the force F20b of the tension spring 292 moves in the direction of arrow E22 and tends to return to the initial position.

Therefore, the gear portion 291a of the rack gear 291 also moves in the direction of arrow E22 and collides against the gear portion 81a of the drive transmission member 81, and then the gear portion 291a and the gear portion 81a are brought into reengagement with each other. Also, the drive transmission member 81 rotates in the rotational direction CW, and the gear portion 81a moves the gear portion 291a of the rack gear 291 again in the direction of the arrow E28 toward the retracted position. Thereafter, the rack gear 291 reaches the retracted position, and the meshing between the gear portion 291a of the rack gear 291 and the gear portion 81a of the drive transmission member 81 is released. Then, the gear portion 291a moves again in the direction of the arrow E22 toward the initial position, and the gear portion 291a collides against the gear portion 81a of the drive transmission member 81.

The reciprocating motion of the rack gear 291 as described above is repeated at the gear meshing period, resulting in abnormal noise or deterioration in the rotation accuracy of the drive transmission member 81. On the other hand, with the cartridge of this embodiment having the locking member 293, as described above, the locking member 293 maintains the rack gear 291 in a state that the gear portion 291a is kept from meshing of the gear portion 81a of the drive transmission member 81. Thus, the above problem can be avoided.

### <Dismounting Cartridge>

Next, referring to FIG. 37, the dismounting operation of the cartridge B from the main assembly of the image forming apparatus A will be explained. FIG. 37 is cross-sectional views showing the dismounting operation of the cartridge B, taken along a line X202-X202 in part (a) of FIG. 29. Part (a) of FIG. 29 to part (d) of FIG. 29 show the dismounting process.

As shown in part (a) of FIG. 37, in order to dismount the cartridge B, the cartridge B is moved in the direction opposite to the mounting direction C. At this time, the pressed surface 297a of the pressed member 297 separates from the abutment portion 15m of the driving side plate 15, so that the pressed member 297 moves to the first position by the force F22 of the initialization spring 298.

As shown in part (b) of FIG. 37, the first pressed surface 295d of the rotatable member 295 is pressed against the cylindrical portion 297b, so that the rotatable member 295 rotates in the rotational direction Q21 about the rotational axis Ax20 (see FIG. 30). At this time, the angle between the actuated arm 294a and the actuating arm 294b of the torsion coil spring 294 becomes more open (less than) 20° than in the free state, so that the torsion coil spring 294 tries to return to the closing direction. Because the actuated arm 294a of the torsion coil spring 294 is supported by the first cylindrical portion 295a of the rotatable member 295, a restoring force F29 is generated in the actuating arm 294b. The locking member 293 moves in the direction of the arrow E21 by the second cylindrical portion 293d receiving the force F29.

As shown in part (c) of FIG. 37, when locking member 293 moves in the direction of an arrow E21, the pressing portion 293a is brought out of contact with the pressed portion 291c3 of rack gear 291. That is, by the locking member 293 moving from the locked position (see part (a) of FIG. 37) to the unlocked position (see part (c) of FIG. 37), the locking of the rack gear 291 made by the locking member 293 is broken. The rack gear 291 is moved in the direction of arrow E22 from the retracted position (see part (a) of FIG. 37) to the initial position (see part (d) of FIG. 37) by the force F20a imparted by the tension spring 292.

Then, as shown in part (d) of FIG. 37, the rack gear mechanism 290 is rendered to a standby state.

Through the above-described process, the cartridge B is dismounted from main assembly of the image forming apparatus A.

As described above, when the pressed member 297 is pressed with driving side plate 15, the rack gear mechanism 290 is in the operating state, and locking member 293 in the locked position locks the rack gear 291 in a standby position. On the other hand, when pressed member 297 is not pressed by driving side plate 15, rack gear mechanism 290 is in a standby state. In other words, the locking member 293 moves from the locking position to the unlocking position, and therefore, the rack gear 291 is allowed to the initial position thereof.

In other words, the pressed member 297 is an operating portion that is operated to switch between the operating state in which the locking member 293 can lock the rack gear 291 and the standby state in which the locking member 293 does not the lock rack gear 291. The locking member 293 placed in the operating state is maintained in the locked position, and the locking member 293 placed in the standby state is released from the locked position and is therefore in the unlocked position.

As shown in FIG. 29, as mentioned above, the preferred range of the angle K20, which is the angle between the line connecting the axis of the drum 62 and the axis of the developing roller 32 and the line perpendicular to the first movable direction D200, is set by the structure of the main assembly of the image forming apparatus A. This will be explained referring to FIG. 38.

FIG. 38 is a cross-sectional view of the main assembly of the image forming apparatus A for explaining the preferred range of the angle K20, taken along a line X202-X202 in part (a) of FIG. 29. The shape of each member that are not necessary for explanation are shown simplified. Also, as in part (b) of FIG. 29, the rack gear 291 shown in FIG. 38 is illustrated in a state in which the angle K20 is shifted in the positive and negative directions for explanation, in addition to the arrangement in this embodiment.

With the assumption that the positive range of the angle K20 is an angle K22 and the negative range is an angle K23, the preferred range of the angle K22 is determined by the shape of the driving side plate 15, and the preferred range of the angle K23 is determined by the inclining direction DW1 of the drive transmission member 81.

First, the angle K22 will be explained. The angle K22 is the limit angle at which the rack gear 291 does not interfere when it moves in the direction of the arrow E28 in the first movable direction D200. In the main assembly of the image forming apparatus A of this embodiment, a space SP1 in the area downstream of the drive transmission member 81 in the cartridge mounting direction C is narrow. This is because the members constituting the main assembly of the image forming apparatus A are arranged in an area that does not interfere with the mounting trajectory of the cartridge B, and in the main assembly of the image forming apparatus A of this embodiment, the drive source (motor) and the gear train connected thereto are arranged in a space SP2. When the rack gear 291 moves, the angle at which it can enter the space SP1 is K22, and the angle K22 is preferably 50° or less.

Next, the angle K23 will be explained. In FIG. 38, each position is defined as follows.

A position PO1 is a center position of the coupling recess 81b (see FIG. 13, and so on) of the drive transmission member 81 inclined in the inclining direction DW1.

A position PO2 is a center position of the coupling projection 263b (see FIG. 24) of the drum 62.

A position PO3 indicates a center position of the coupling recess 81b after the drive transmission member 81 is moved by the engaging reaction force FD20 (see part (a) of FIG. 34).

At this time, the distance L22 between positions PO2 and PO3 measured in a direction perpendicular to the axis Ax1 of the drum 62 corresponds to the amount of misalignment between the coupling projection 63b and the coupling recess 81b having been described in the section on the coupling engagement conditions in Embodiment 1. That is, the angle K23 is the limit angle at which the distance L22 is the amount of misalignment that allows the coupling projection 63b and the coupling recess 81b to engage with each other, and is preferably −75° or more. The pressure angle of the gear portion 81a of the drive transmission member 81 is set to 20°, and the drive transmission member 81 moves in the same direction as the engaging reaction force FD20.

As described above, the preferred range of the angle K20 is determined by the structure of the main assembly of the image forming apparatus A. Therefore, depending on the main assembly of the image forming apparatus to which this embodiment is applied, the preferred range of the angle K20 is determined appropriately in consideration of the above-described conditions.

As described above, in this embodiment as well, as in the above-described Embodiment 1, the force FA produced by the meshing of the rack gear 291 and the gear portion 81a of the drive transmission member 81 can be used to move the drive transmission member 81 toward the cartridge B, as shown in FIG. 35. The force FA produced by the meshing can be used to connect the drive transmission member 81 to the cartridge B.

By employing such a rack gear 291 in the cartridge B, the mechanism inside the main assembly A of the apparatus required to move the drive transmission member 81 toward the cartridge B can be simplified as in Embodiment 1. For example, it is possible to eliminate a spring or the like inside the main assembly A of the apparatus urging the drive transmission member 81 toward the cartridge B, or to reduce the force of such a spring or the like.

In this embodiment, after the drive transmission member 81 approaches the cartridge B and is connected to the cartridge B, the engagement between the drive transmission member 81 and the rack gear 291 is broken (see part (b) of FIG. 36). This is because the rack gear 291 can move to a position where it does not mesh with the drive transmission member 81. Therefore, also when the user dismounts the cartridge B from the main assembly A of the apparatus, the drive transmission member 81 and the rack gear 291 are not meshed. As a result, the user can dismount the cartridge B with a light force. This is because there is a low possibility that the drive transmission member 81 and the rack gear 291 hits and interfere with the cartridge B being dismounted.

### Modified Example 1 of Embodiment 2

In this embodiment, the transition of the rack gear mechanism from the standby state to the operating state is carried out when the cartridge B is attached to the main assembly of the image forming apparatus A, but it may be carried out when the user closes the opening/closing door 13 (see FIG. 8). In the following, Modified Example 1 will be described, which is a partial modification of the structure of Embodiment 2. For the sake of explanation, the structure having been described in the foregoing may be called a representative example of Embodiment 2, and the structure which will be explained in the following may be called Modified Example 1 of Embodiment 2.

FIG. 39 shows the operation of a rack gear mechanism 2900 in this modification, wherein part (a) shows a standby state of the rack gear mechanism 2900, and part (b) shows an operating state of the rack gear mechanism 2900.

As shown in part (a) of FIG. 39, when the rack gear mechanism 2900 is in the standby state, a pressed surface 2970a of a pressed member 2970 protrudes a predetermined amount beyond the cleaning frame 71. The protruding direction of the pressed member 2970 is referred to as a fourth movable direction D204. A first support shaft 2990a of the link member 2990 is rotatably supported in a support hole 2970f of the pressed member 2970, and a second support shaft 2990b of the link member 2990 is rotatably supported in a support hole 2950g of the rotatable member 2950.

The pressed surface 2970a of the pressed member 2970 is pressed in the direction of an arrow E200 along the fourth movable direction D204 by the cartridge pressing member 1 provided on the opening/closing door 13. This movement is transmitted to the rotatable member 2950 by way of the link member 2990, and the rotatable member 2950 is rotated in the rotational direction Q20 about the rotational axis Ax20. By the rotation of the rotatable member 2950, the rack gear mechanism 2900 is changed to an operating state as shown in part (b) of FIG. 39 by a similar action in this embodiment.

When the rack gear mechanism 2900 is in an operating state, and the opening/closing door 13 is opened so that the cartridge pressing member 1 moves away from the pressed surface 2970a, the pressed member 2970 is moved in the direction of an arrow E201 along the fourth movable direction D204 by a spring (not shown). When the pressed member 2970 is moved in the direction of the arrow E201, the rotatable member 2950 is rotated in the rotational direction Q21 about the rotational axis Ax3 by way of the link member 2990. By the rotation of the rotatable member 2950, the rack gear mechanism 2900 is rendered into the standby state as shown in part (a) of FIG. 39 by the similar action in this embodiment.

The pressed member 2970 is an operating portion which is operated to switch the rack gear mechanism 2900 between the standby state and the operating state. The rack gear mechanism 2900 includes the locking member 293 and the rack gear 291 described in the above-described Embodiment 2. By operating the pressed member 2970, the state is switched between one in which the locking member 293 can lock the rack gear 291 and another in which the locking member 293 does not lock the rack gear 291 and permits the rack gear 291 to move.

In order to accomplish the above-described operation, the movable range of the link member 2990 and the movable direction of the pressed member 2970 are appropriately restricted.

In this modification, the pressed member 2970 is moved by the cartridge pressing member 1 provided on the opening/closing door 13, but the structure may be such that the user operates it directly. In such a case, the user operates the pressed member 2970 after mounting the cartridge B in the main assembly of the image forming apparatus A.

### Modified Example 2 of Embodiment 2

In addition, instead of the rack gear 291 having the gear portion 291a described as Embodiment 2, an elastic member (elastic body) without teeth may be provided on the driving side of the cartridge. Such a structure will be described as Modified Example 2 of Embodiment 2, bellow.

FIG. 40 is an illustration of this modification. Part (a) of FIG. 40 is a perspective view of the cartridge B of this modification, and part (b) of FIG. 40 is a cross-sectional view showing meshing with the drive transmission member 81.

As shown in part (a) of FIG. 40, an elastic movable member 2912a is provided on a slide member 2912 (corresponding to rack gear 291) of a slide mechanism 2902 (corresponding to rack gear mechanism 290).

The elastic movable member 2912a is movable linearly as the rack gear 291 is.

The elastic movable member 2912a is made of an elastically deformable material such as polyurethane foam, rubber, or elastomer. In this modification, polyurethane foam ESH available from Inoac Corporation or Moltoprene available from Inoac Corporation are used. In addition, a distance from the rotational axis Ax1 of the drum 62 to a surface 2912a1 of the elastic movable member 2912a is set to 12.74 mm in a perpendicular direction D2072 perpendicular to a first movable direction D2002.

This distance corresponds to the shortest distance measured from the axis Ax1 to the surface 2912a1 along a direction perpendicular to the axis Ax1. This distance also corresponds to the distance measured from the axis Ax1 to the tangent line of the surface 2912a1 along a direction perpendicular to the axis Ax1. This distance is preferably 75-120% of the drum radius.

The elastic movable member 2912a is an elastic body, and can be compressed and deformed by contact with the gear portion 81a of the drive transmission member 81. Therefore, the distance from the axis Ax1 of the drum 62 to the surface 2912a1 of the elastic movable member 2912a has a wider allowable range than the distances L21 and L22 in Embodiment 2 (see part (b) of FIG. 29). The distances L21 and L22 are the distances from the axis Ax1 of the drum 62 to the gear portion 291a of the rack gear 291, and for details, please refer back to the foregoing description.

In other respects, the preferred arrangement and preferred movement direction of the elastic movable member 2912a are similar to those of the rack gear 291 described in the foregoing as the main component of Embodiment 2.

However, the elastic movable member 2912a, which is an elastic body, has a strong force for holding the drive transmission member 81 when it meshes with the gear portion 81a of the drive transmission member 81. Therefore, the preferred ranges of the angles K20 and K21 described above with reference to FIG. 29 can be wider than those described above.

More particularly, in this modified example, the preferred range of the angle K20 is −70 degrees or more and 100 degrees or less. Similarly, the preferred range of the angle K21 in this modified example is −70 degrees or more and 100 degrees or less.

The above description of the preferred range of angle K20 and the preferred range of angle K21 for the rack gear 291 can be applied to the more preferred range of angle K20 and the more preferred range of angle K21 for the elastic movable member 2912a.

As described above with reference to FIG. 29, as the cartridge is viewed along the axis Ax1 of the photosensitive drum, a line extending from the axis Ax1 of the photosensitive drum 62 to pass through the axis Ax2 of the developing roller 32 is taken as the reference line. In this modified example, the movable direction of the elastic movable member 2912a corresponds to the movable direction D200 shown in FIG. 29. Similarly, the direction perpendicular to the movable direction of the elastic moving member 2912 corresponds to the perpendicular direction D207 shown in FIG. 29. The angle formed between the perpendicular direction D207 and the reference line is K20.

In this modified example, the perpendicular direction D207 is also the direction of the normal line of the elastic movable member 2912a which extends from the elastic movable member 2912a so as to be away from the axis Ax1 of the drum 62.

An angle between the reference line is K21 and a line extending from the axis Ax1 of the drum 62 toward the surface of the elastic movable member 2912a. As with the gear portion 291a of the rack gear 291 described with reference to part (a) of FIG. 29, it is preferable that at least a part of the surface 2912a1 of the elastic movable member 2912a is outside the coupling portion 263b. In other words, as measured along the axis Ax1 of the drum 62 (see part (a) of FIG. 29), at least a part of the surface 2912a1 of the elastic movable member 2912a is farther from the end of the non-driving side of the drum 62 than the coupling portion 263a.

In addition, it is preferable that the surface 2912a1 of the elastic movable member 2912a is at least partially exposed to the outside so as to face the axis Ax1 of the drum 62 (see part (a) of FIG. 40). This is because the surface 2912a1 of the elastic movable member 2912a needs to come into contact with the drive transmission member 81 placed between the surface 2912a1 and the axis Ax1 as shown in part (b) of FIG. 40.

As shown in part (b) of FIG. 40, the elastic movable member 2912a enters the space between the adjacent gear teeth of the gear part 81a of the drive transmission member 81 and deforms so as to match the shape of the gear teeth. The deformed elastic movable member 2912a moves the drive transmission member 81 by the same action as the rack gear 291, and moves the slide member 2912 in the direction of the arrow E202 along the movable direction D2002. By this, the same operation as the rack gear 291 is performed.

As the slide member 2912 moves, the elastic movable member 2912a moves linearly or planarly in a direction along its surface 2912a1.

With such a structure of the elastic movable member 2912a, it is possible to engage the cartridge with the gear portion 81a of the drive transmission member 81. In this modified example, the gear portion 81a bites into the elastic movable member 2912a, which provides the advantage that the meshing state between the elastic movable member 2912a and the gear portion 81a is easily stabilized.

The meshing operation between the elastic movable member 2912a and the gear portion 81a is the same as the meshing operation between the elastic member and the gear portion 81a in Embodiment 4. Details will be explained hereinafter with respect to Embodiment 4.

### Embodiment 3

Next, referring to FIGS. 41 to 51, Embodiment 3 will be explained below. In particular, among the elements disclosed in this embodiment, those corresponding to the members described in Embodiment 2 are assigned like names as of the members in Embodiment 2, and only the different points from Embodiment 2 are described.

First, referring to FIG. 41, the cartridge structure of this embodiment will be described. FIG. 41 is a perspective view of the cartridge B. The cartridge B in this embodiment comprises a cleaning unit 260 and a developing unit 320, as in Embodiment 2. The developing unit 320 has a driving-side development side member 326. The driving-side development side member 326 is on the driving side of the cartridge, and is a part of the frame constituting the developing unit 320. The driving-side development side member 326 is provided with a friction force imparting portion (friction material, friction member) 326a. In this embodiment, the friction force imparting portion 326a is fixed to the driving-side development side member 326.

The direction along the rotational axis Ax1 of the drum 62 is a longitudinal direction D302, the driving side drum flange 263 side is a driving side, and the opposite side from the driving side is the non-driving side. A direction from the non-driven side to the driven side is indicated by a direction of an arrow E32, and a direction from the driven side to the non-driven side is indicated by a direction of arrow E33.

Next, referring to FIG. 42, a range of existence of the friction force imparting portion 326a will be described. Although details will be described hereinafter, the friction force imparting portion 326a is a member structured to contact the gear portion 81a of drive transmission member 81. Therefore, a preferred arrangement of the friction force imparting portion 326a is similar to those in the preferred arrangement of the gear portion 30a (see FIG. 9) of the developing roller gear 30 in Embodiment 1 structured to mesh with the gear portion 81a, and the gear portion 291a of the rack gear 291 in Embodiment 2.

For example, the preferred arrangement of the friction force imparting portion 326a in the axial direction of the photosensitive drum 62 is equivalent to the preferred range of the gear portion 30a and the gear portion 291a. A surface of the friction force imparting portion 326a is at least partially exposed toward the axis Ax1 of the drum 62.

On the other hand, there is a preferred arrangement specific to the friction force imparting portion 326a of this embodiment, which will be described in detail below.

FIG. 42 shows the arrangement of the friction force imparting portion 326a. Part (a) of FIG. 42 is a view taken along a direction perpendicular to the rotational axis of the drum 62, and part (b) of FIG. 42 is a cross-sectional view taken along a line X300-X300 in part (a) of FIG. 42. Part (b) of FIG. 42 shows the drum 62, the developing roller 32, and the friction force imparting portion 326a, only. In addition to the arrangement in this embodiment, part (b) of FIG. 42 also shows a state in which the friction force imparting portion 326a is arranged in the positive and negative directions of angle K30, which will be described hereinafter for the sake of explanation, the positive angle is angle K30U and the negative angle is angle K30L.

As shown in part (a) of FIG. 42, in the longitudinal direction D302, at least a part of the friction force imparting portion 326a is located in the direction of the arrow E32 (longitudinally outward, away from the cartridge B) beyond a free end portion 263b1 of the driving side drum flange 263. Also, at least a part of the friction force imparting portion 326a is disposed so as to be within a range of 4 to 9 mm beyond the free end portion 263b1 to the driving side. Depending on the structure of the driving side drum flange 263 and the structure of the applicable main assembly of the image forming apparatus A, the above range may be set to be larger.

As shown in part (b) of FIG. 42, in the direction perpendicular to the longitudinal direction D302, the direction parallel to the friction force imparting portion 326a is referred to as direction D300. In the direction D301 perpendicular to the direction D300, a distance from the axis of the drum 62 to the friction force imparting portion 326a is referred to as distance L30. At this time, when the friction force imparting portion 326a is a rigid body, the distance L30 is selected to be in the range of 90% to 120% of the radius of the drum 62, and particularly preferably 92% to 120%.

In this embodiment, the radius of the drum 62 is 12 mm. The distance L30 from the axis of the drum 62 to the friction force imparting portion 326a is set to 10.8 mm or more, which is 90% of the radius of the drum 62, and more preferably 11.041 mm or more, which is 92%. Furthermore, L30 is set to 14.439 mm or less, which is 120% of the radius of the drum 62. In this embodiment, the distance L30 is set to 106.2% (12.74 mm) of the radius of the drum 62.

In addition, when the friction force imparting portion 326a is an elastic body (elastic member), the distance L30 is set to be in the range of 75% to 120% of the radius of the drum 62 when no load is applied to the friction force imparting portion 326a. This is because, when the cartridge B is mounted in the main assembly of the image forming apparatus A and the friction force imparting portion 326a is deformed, the distance L30 is in the range of 90% to 120%, and more preferably, 92% to 120%.

In addition, when the surface of the friction force imparting portion 326a is not a flat surface, the direction of the tangent (tangential plane) of at least a part of the friction force imparting portion 326a is the direction D300, and in such a case, the friction force imparting portion 326a may be an arc shape surface having a portion which is convex or concave toward the rotational axis Ax1 of the drum 62, or may be a surface including an uneven portion.

The straight line extending from the axis of the drum 62 through the axis of the developing roller 32 is used as the reference. Angle K30 is the angle formed between this reference line and a direction D301 perpendicular to the friction force imparting portion 326a. The direction D301 is that of the direction of a straight line which passes through a frictional force imparting portion 236a and extends in a direction away from the axis of the drum 62. In other words, D301 is the direction of a normal line of friction force imparting portion 326a that extends away from drum 62.

The positive direction of angle K30 is a downstream direction of the rotation of the drum 62. In other words, the positive direction of angle K30 is the downstream direction of arrow R, which is the rotational direction of the drum 62, and the negative direction of angle K30 is the upstream direction of arrow R. It is preferable that the angle K30 is −70° or more and 100° or less.

More specifically, the preferable range of the angle K30 varies depending on the material used for the friction force imparting portion 326a. The preferred range of the angle K30 (deg) for the material of the friction force imparting portion 326a is shown below.

The preferred range of the angle K30 when a wrapping film is used as the friction force imparting portion 326a is equal to or greater than 0 degrees and equal to or less than 100 degrees.

The preferred range of the angle K30 when a double-sided tape is used as the friction force imparting portion 326a is equal to or more than-50 degrees and equal to or less than 100 degrees.

The preferred range of the angle K30 when polyurethane foam is used as the friction force imparting portion 326a is-70 degrees or more and 100 degrees or less.

The preferred range of the angle K30 for a silicon sheet is-50 degrees or more and 100 degrees or less.

For the wrapping film, LWFS-30-600 (grain size #600) available from Sankyo Rikagaku Co., Ltd, Japan is used.

For the double-sided tape, No. 5000N (C) sold by Nitto Denko Corporation, Japan is used.

For the polyurethane foam, ESH sold by Inoac Corporation, Japan is used.

The angle K30 is set according to FIG. 51, and friction force imparting portion 326a is positioned.

In this embodiment, the lapping film (a plastic film for abrading) is used as a rigid material having a high coefficient of friction. Here, the lapping film is an abrasive material. The angle K30 is 0°.

In order to make the friction force imparting portion 326a act stably on the drive transmission member 81 and to easily secure space for arranging the friction force imparting portion 326a in the main assembly, it is further preferable to narrow the range of the angle K30.

For a more suitable range of K30, the suitable range of the angle K20 described with reference to FIG. 29 can be applied.

In this embodiment, the angle K30 is also the angle between a reference line and a line extending from the axis Ax1 of the drum 62 through the friction force imparting portion 326a. It is desirable that at least a part of the friction force imparting portion 326a is within the suitable range of the angle K30.

The preferred ranges of the angle K30 and distance L30 described above are determined by the relationship relative to the main assembly of the image forming apparatus A to which this embodiment is applied, and details of this will be described hereinafter.

In this embodiment, as shown in FIG. 42, the friction force imparting portion 326a is provided on the driving-side development side member 326, which is a part of the developing unit 320. However, depending on the settings of the angle K30 and distance L30, the friction force imparting portion 326a may be provided on a part of the cleaning unit 260 (see FIG. 41).

### <Drive Transmission Structure of Main Assembly of Image Forming Apparatus>

Next, the drive transmission structure to the drive transmission member 81 of the main assembly of the image forming apparatus A in this embodiment will be explained using FIG. 43. FIG. 43 shows the drive train of the main assembly of the image forming apparatus A, wherein (a) is a side view seen from the drive side, and (b) is a perspective view seen from the drive side.

As shown in part (a) of FIG. 43, the driving force is transmitted to the drive transmission member 81 from a motor gear 51 connected to a motor (not shown) which is a driving source of the main assembly of the image forming apparatus A, by way of a first idler gear 52 and a second idler gear 53. The second gear portion 81k of the drive transmission member 81 meshes with a gear portion 53a of the second idler gear 53. The motor gear 51 rotates in a rotational direction Q30, the first idler gear 52 rotates in a rotational direction Q31, and the second idler gear 53 rotates in a rotational direction Q32, respectively, and the drive transmission member 81 rotates in the rotational direction CW.

As shown in part (b) of FIG. 43, the second gear portion 81k the drive transmission member 81 has right-handed helical teeth, and the gear portion 53a of the second idler gear 53 has left-handed helical teeth, so that a thrust force F30 corresponding to the torque of the drive transmission member 81 is produced by meshing.

Here, the second idler gear 53 is fixed in the longitudinal direction. In addition, the drive transmission member 81 is supported so as to be movable in the longitudinal direction, and therefore, the thrust force F30 causes the drive transmission member 81 to move toward the inside of the main assembly of the image forming apparatus A (in the direction of an arrow DW3 toward the cartridge) due to the relationship in the torsional direction described above. The direction of the thrust force F30 is the same direction as that of the axial (longitudinal) force FA produced in the gear portion 81a of the drive transmission member 81 described in Embodiments 1 and 2 (see FIGS. 13 and 35).

### <Mounting of Cartridge to Main Assembly of Image Forming Apparatus>

Next, referring to FIG. 44, the operation of mounting the cartridge B to the main assembly of the image forming apparatus A in this embodiment will be described. FIG. 44 is cross-sectional views illustrating the mounting operation of the cartridge B to the main assembly of the image forming apparatus A, taken along a line X302-X302 in part (a) of FIG. 42. Part (a) of FIG. 42 shows a state before mounting the cartridge, and (b) shows a state after mounting the cartridge.

As shown in part (a) of FIG. 44, before the cartridge B is mounted in the main assembly of the image forming apparatus A, the friction force imparting portion 326a is in contact with the gear portion 81a of the drive transmission member 81. When the cartridge B is moved from this position in the mounting direction C, the gear portion 81a of the drive transmission member 81 is brought into interference with the friction force imparting portion 326a. However, as described in Embodiment 2, the gear portion 81a of the drive transmission member 81 can tilt in the direction D206 perpendicular to the inclining direction DW1. Therefore, when the gear portion 81a interferes with the friction force imparting portion 326a during mounting of the cartridge B, it can escape in the direction D206. This allows the cartridge B to be mounted without interference of the friction force imparting portion 326a with the gear portion 81a. Then, the cartridge B is brought into the mounted state shown in part (b) of FIG. 44.

At this time, the gear portion 81a of the drive transmission member 81 abuts against the friction force imparting portion 326a and the hole portion 15n of the driving side plate 15 due to its own weight, so that the position is determined (see FIG. 32).

### <Engagement Operation of Drive Transmission Member>

Next, referring to FIG. 45 to FIG. 47, the operation until the drive transmission member 81 is driven by the motor gear 51 and the coupling recess 81b engages with the coupling projection 263b of the driving side drum flange 263 will be described. FIG. 45 is cross-sectional views showing the operation when the drive transmission member 81 is driven, taken along a line X302-X302 in part (a) of FIG. 42. Part (a) of FIG. 45 shows the driving state with the drive transmission member 81 tilted, and part (b) of FIG. 45 shows the state in which the drive transmission member 81 has moved to a position where it is enabled to engage with the driving side drum flange 263. FIG. 46 is sectional perspective views showing the engagement operation of the drive transmission member 81, and is sectional views taken along a line X301-X301 shown in part (b) of FIG. 45. Part (a) of FIG. 46 shows a state in which the drive transmission member 81 is aligned with the rotational axis Ax1 of the drum 62, and part (b) of FIG. 46 shows a state in which the coupling recess 81b is engaged with the coupling projection 263b of the driving side drum flange 263. FIG. 47 is a view showing a state in which the friction force imparting portion 326a is elastically deformed. Part (a) of FIG. 46 is a cross-sectional taken along a line X302-X302 shown in part (a) of FIG. 42, and part (b) of FIG. 46 is a cross-sectional view taken along a line X303-X303 shown in part (a) of FIG. 42. Hereinafter, for the sake of explanation, the tooth tips of each tooth of the gear portion 81a of the drive transmission member 81 are referred to as tooth tips 81a1, and the surfaces of each tooth downstream in the rotational direction CW are referred to as tooth surfaces 81a2 (see FIG. 45).

In the following, two cases will be described, namely, the case in which the friction force imparting portion 326a is deformed by contact with the gear portion 81a of the drive transmission member 81, and the case in which it is not deformed.

First, the case will be described in which the friction force imparting portion 326a is so hard that it does not elastically deform even when it is brought into contact with the gear portion 81a. This corresponds to the case where a wrapping film, among the members exemplified above, is used as the friction force imparting portion 326a.

Even if the friction force imparting portion 326a elastically deforms, such a case is also included in the case where it is not elastically deformed, if the degree of deformation is negligibly small.

As shown in part (a) of FIG. 45, when the drive transmission member 81 rotates in the rotational direction CW, the tooth tip 81a1 of the gear portion 81a rubs against the friction force imparting portion 326a and receives a frictional force F31. As described in Embodiment 2, the gear portion 81a of the inclined drive transmission member 81 is not restricted in position in the direction opposite to the inclining direction DW1 or in the direction D206 perpendicular to the direction D205, and therefore can move in the direction of an arrow E30 along the direction D300 parallel to the friction force imparting portion 326a. Therefore, the gear portion 81a is moved in the direction of the arrow E30 by to the frictional force F31. As the gear portion 81a moves, the rotational axis Ax3 approaches the rotational axis Ax1 of the drum 62. Thereafter, the gear portion 81a abuts against the restricting portion 73j, and as shown in part (b) of FIG. 45, the drive transmission member 81 becomes substantially coaxial with the driving side drum flange 263 and is in an engageable position. In addition, the coupling recess 81b and the coupling projection 263b maintain an engageable position in a direction perpendicular to the longitudinal direction.

As shown in part (a) of FIG. 46, the friction force F31 causes a torque T30 in the gear portion 81a of the drive transmission member 81. The torque T30 causes thrust force F30 in the second gear portion 81k of the drive transmission member 81 due to meshing with the gear portion 53a of the second idler gear 53 (see part (b) of FIG. 43).

The drive transmission member 81 is moved by the thrust force F30 in the direction of arrow DW3, which is toward the non-driving side (approaching the cartridge) in the longitudinal direction D302, and approach and contact the coupling projection 263b. Then, when the triangular phases of the coupling recess 81b and the coupling projection 263b match with each other as a result of the rotation of the drive transmission member 81, the coupling projection 263b enters and engages with the coupling recess 81b, as shown in part (b) of FIG. 46. Then, as in Embodiment 1, when the surfaces constituting the coupling projection 263b and the coupling recess 81b come into contact to each other and the drive is transmitted, a new thrust force FC is produced, because both are twisted (inclined) about the axis.

Next, the description will be made as to the case where the friction force imparting portion 326a is elastically deformed by the gear portion 81a. Of the members exemplified above, this corresponds to a case where a double-sided tape, polyurethane foam, or silicone sheet is used as the friction force imparting portion 326a.

As shown in part (a) of FIG. 47, when the friction force imparting portion 326a is an elastic body with a soft surface layer, the tooth tip 81a1 of the gear portion 81a bites into the friction force imparting portion 326a. In other words, the friction force imparting portion 326a a space S30 between the adjacent gear teeth of the gear portion 81a. In this state, when the drive transmission member 81 rotates in the rotational direction CW, the tooth surface 81a2 receives a component force F33 in the rotational direction CW of the reaction force from the friction force imparting portion 326a. In addition, since the friction force F31 from the friction force imparting portion 326a also acts on the tooth tip 81a1 of the gear portion 81a, the force to move the gear portion 81a is a resultant force F34 of the friction force F31 and the component force F33. Therefore, it is possible to move the gear portion 81a with a larger force than when the friction force imparting portion 326a is not elastically deformed by the gear portion 81a.

In addition, as shown in part (b) of FIG. 47, the gear portion 81a (shown by hatching in the Figure), which is a helical tooth, receives the component force F33 from the friction force imparting portion 326a on the tooth surface 81a2, by which a thrust force F35 in the direction of the arrow DW3 is produced. Furthermore, in the drive transmission member 81, a resultant force F34 (see part (a) of FIG. 47) of the friction force F31 and the component force F33 produces a torque T31 larger than that of the friction force F31 alone, and a thrust force F36 in the direction of the arrow DW3 is produced in the second gear portion 81k. The drive transmission member 81 moves in the direction of the arrow DW3 by the thrust force F35 produced in the gear portion 81a and the thrust force F36 produced in the second gear portion 81k. Therefore, in the case that the helical bar is used, it is possible to move the drive transmission member 81 in the longitudinal direction D302 with a larger force than when the friction force imparting portion 326a is not elastically deformed by the gear portion 81a.

After the engagement between the coupling recess 81b and the coupling projection 263b, the gear portion 81a and the friction force imparting portion 326a may be in contact with each other or may be separated from each other. However, the electric power consumed by the drive source (motor) increases by the torque T30 (or the torque T31 produced by the resultant force F34) produced from the frictional force F31 between the gear portion 81a and the friction force imparting portion 326a. Therefore, it is preferable that the gear portion 81a and the friction force imparting portion 326a are spaced apart from each other.

The engagement operation of the drive transmission member 81 described above is easily achieved by positioning the friction force imparting portion 326a in a suitable range. The suitable range has been described above, but will be explained in detail here. Reference will made to FIGS. 48 to 50 for the explanation.

First, the direction parallel to the surface of the friction force imparting portion 326a is referred to as direction D300. In other words, D300 is a direction along a tangent to the surface of the friction force imparting portion 326a. The direction perpendicular to the tangent direction D300 is direction D301. In other words, D301 is a normal direction to the friction force imparting portion 326a.

Referring to FIG. 48, a preferred range will be described as to the distance L30 from the axis of the drum 62 to the surface of the friction force imparting portion 326a, in this perpendicular direction D301.

Here, L30 corresponds to the distance from the axis Ax1 of the drum 62 to the tangent of the friction force imparting portion 326a, measured along a direction perpendicular to the axis Ax1 of the drum 62. In addition, L30 also corresponds to a shortest distance from the axis Ax1 of the drum 62 to the friction force imparting portion 326a, measured along a direction perpendicular to the axis Ax1 of the drum 62.

FIG. 48 is an illustration showing a relationship between the distance L30 from the axis of the drum 62 to the friction force imparting portion 326a and the gear portion 81a of the drive transmission member 81. Parts (a), (b), and (c) of FIG. 48 are illustrations in which the value of the distance L30 is changed to change the position of the friction force imparting portion 326a. Part (a) of FIG. 48 shows the case where the distance L30 is the applicable value of this embodiment, part (b) of FIG. 48 shows the case where the distance L30 is set within the preferred range in the lower limit direction, and part (c) of FIG. 48 shows the case where the distance L30 is set outside the preferred range in the lower limit direction.

First, the description will be made as to a case where the distance L30 is 106.2% (12.74 mm) of the radius of the drum 62, which is the applicable value of this embodiment. As shown in part (a) of FIG. 48, the central positions of the coupling recess 81b and the coupling projection 263b in the direction D301 perpendicular to the direction D300 are aligned with each other.

Next, the description will be made as to a case where the distance L30 is set in the preferred range in the lower limit direction (the side where the friction force imparting portion 326a approaches the rotational axis Ax of the drum 62). As shown in part (b) of FIG. 48, when the distance L30 is set in the lower limit direction, the distance between the friction force imparting portion 326a and the rotational axis center Ax1 of the drum 62 becomes smaller. Therefore, the distance between the coupling projection 263b fixed to the drum 62 and the friction force imparting portion 326a becomes smaller. When the friction force imparting portion 326a comes into contact with the gear portion 81a in this state, misalignment occurs between the coupling recess 81b and the coupling projection 263b. This misalignment amount is referred to as A30. As described in Embodiment 1, the misalignment amount A30 is required to be 1.699 mm or less as a coupling engagement condition when applied to the main assembly of the image forming apparatus A of this embodiment. When the drum radius of this embodiment is 12 mm and the distance L30 is 92% (11.041 mm) of the radius of the drum 62, which is the lower limit, the misalignment amount A30 is 1.699 mm.

Next, a case where the distance L30 is outside the preferred range in the lower limit direction will be described. As shown in part (c) of FIG. 48, the distance between friction force imparting portion 326a and the center of the drum 62 is further closer, so that the coupling projection 263b is further closer to the friction force imparting portion 326a. When the friction force imparting portion 326a abuts against the gear portion 81a in this state, the misalignment amount A30 is 1.699 mm or more, so that the coupling recess 81b and the coupling projection 263b cannot engage with each other.

As explained above, the distance L30 needs to be set to 92% (11.041 mm) or more of the radius of the drum 62, and this is the preferred range of the lower limit of distance L30.

The same applies to the upper limit of the preferred range of distance L, and therefore the explanation thereof is omitted.

Next, referring to FIG. 50, the description will be made as to a preferred range of the upper limit of the angle K30 that the direction D301 forms with respect to a line extending from the axis of the drum 62 and passing through the axis of the developing roller 32. The direction of the line which passes through the friction force imparting portion 326a and extends perpendicularly to the surface of the friction force imparting portion 326a away from the drum axis Ax1 corresponds to the direction D301.

FIG. 50 is an illustration of the upper limit of the angle K30. An angle K31 is that between the reference line which passes through the rotational axis Ax2 of the developing roller 32 and through the rotational axis Ax1 of the drum 62, and the inclining direction DW1. Part (a) of FIG. 50 shows a case in which the angle K30 is equal to or less than the angle K31, and part (b) of FIG. 50 shows a case in which the angle K30 is equal to or more than the angle K31.

Here, the center position of the gear portion 81a of the drive transmission member 81 inclined to DW1 is position PO31, the position after the friction force imparting portion 326a abuts against the gear portion 81a is a position PO32, and the center position of the drum 62 is a position PO33. In addition, the distance between position PO32 where the friction force imparting portion 326a abuts against the gear portion 81a and moves and position PO33 of the rotational axis Ax1 of the drum 62 is defined as distance L31.

Part (a) of FIG. 50 shows the case where the angle K30 is equal to or less than the angle K31. The position where the friction force imparting portion 326a abuts against the gear portion 81a and moves is PO32. The direction in which the gear portion 81a is moved by the friction force imparting portion 326a is the direction of arrow E30. The position PO32 is upstream of the position PO33 of the rotational axis Ax1 of the drum 62 in the direction of arrow E30. At this time, when the gear portion 81a is moved in the direction of the arrow E30 by the friction force imparting portion 326a, it approaches the rotational axis Ax1 of the drum 62.

On the other hand, part (b) of FIG. 50 shows the case where the angle K30 is equal to or larger than the angle K31. The position where the friction force imparting portion 326a abuts against the gear portion 81a and moves is the position PO32. The direction in which the gear portion 81a is moved by the friction force imparting portion 326a is the direction of the arrow E30. In the direction of the arrow E30, the position PO32 is downstream of the position PO33 of the rotational axis Ax1 of the drum 62. At this time, when the gear portion 81a is moved in the direction of the arrow E30 by the friction force imparting portion 326a, it moves away from the rotational axis Ax1 of the drum 62. In order for the coupling to engage in this state, it is necessary to reduce the distance L31. The distance L31 increases as the angle K30 increases. The angle K30 at which the coupling can be engaged is the upper limit of the preferred range.

Next, referring to FIG. 49, the preferable range of the lower limit of the angle K30 of the direction D301 with respect to the line connecting the axis of the drum 62 and the axis of the developing roller 32 will be described. In FIG. 49, a line extending from the rotational axis Ax1 of the drum 62 so as to pass through the rotational axis Ax2 of the developing roller 32 is shown as a reference line. The angle which the direction D301 perpendicular to the direction D300 parallel to the friction force imparting portion 326a makes with this reference line is defined as angle K30 (see part (b) of FIG. 42). The direction D301 is indicated by an arrow indicating the normal line relative to the friction force imparting portion 326a. More specifically, the arrow indicating the direction D301 is the normal direction to the friction force imparting portion 326a extending away from the axis Ax of the drum 62.

FIG. 49 is an illustration of the lower limit of angle K30, wherein part (a) of FIG. 49 shows a case where the angle K30 is within the preferred range, and part (b) of FIG. 49 shows a case where the angle K30 is outside the preferred range.

As shown in part (a) of FIG. 49, at the contact portion between the gear portion 81a and friction force imparting portion 326a, a force FG1 is produced due to its own weight FG in the direction of an arrow E31 including a component in the direction of gravity DZ1 along direction D300. Also, at the contact portion between the gear portion 81a and the friction force imparting portion 326a, the gear portion 81a receives a reaction force FG2 due to its own weight FG. When the gear portion 81a rotates in the rotational direction CW, a frictional force F31 is produced due to the reaction force FG2. Also, when the friction force imparting portion 326a elastically deforms, a resultant force F34 consisting of not only the frictional force F31 but also the reaction force F33 is produced. When the angle K30 is within the preferred range, the frictional force F31 or the resultant force F34 is greater than the force FG1. Therefore, the gear portion 81a can be moved in the direction of the arrow E30 against the force FG1 by the frictional force F31 or the resultant force F34.

On the other hand, when the angle K30 is smaller than the lower limit of the preferred range, as shown in part (b) of FIG. 49, the force FG1 is greater and the frictional force F31 or the resultant force F34 is smaller. As a result, the frictional force F31 or the resultant force F34 is smaller than the force FG1 in the direction of the arrow E31. Therefore, the gear portion 81a cannot be moved in the direction of the arrow E30. In other words, the inclined drive transmission member 81 cannot be moved to the engagement position, and therefore, the coupling cannot be engaged.

The friction force F31 or the component force F33 (see part (b) of FIG. 47), which is a part of the resultant force 34, varies depending on the material of the friction force imparting portion 326a, and is affected by friction coefficient, surface softness, and tackiness of the material.

Lapping film (plastic film for polishing) is listed as a representative material with a high friction coefficient which does not elastically deform, that is, a non-elastic material.

Double-sided tape is listed as a representative material having high tackiness. Double-sided tape is one of the tacky members having tackiness. Various materials with different softness can be used for a base material of double-sided tape, and therefore, it depends on the selection of the base material whether it is an elastic member or not.

Polyurethane foam is listed as a material with a soft surface, that is, a representative elastic member.

Furthermore, a silicone sheet is listed as a material having both of frictional property and softness. A silicone sheet is also a type of elastic member.

The preferred range on the lower limit side of the angle K30 is wider in the order of the wrapping film, the double-sided tape and the silicone sheet, and the polyurethane foam.

In this embodiment, when the cartridge B is mounted in the main assembly of the image forming apparatus A, the developing roller 32 is disposed at a position approximately 30° counterclockwise away from the direction of gravity DZ1, in the circumferential direction around the rotational axis Ax1 of the drum 62. In other words, as viewed along the axis Ax1 of the drum 62, the straight line extending from the axis Ax1 of the drum 62 and passing through the axis of the developing roller 32 forms an angle of 30° counterclockwise relative to the straight line extending in the direction of gravity DZ1.

If the developing roller 32 of the cartridge B to which this embodiment is applied is not disposed at the angle of 30°, the preferred range of the angle K30 increases or decreases by the difference in the angle. For example, if the developing roller 32 is positioned at 20° counterclockwise from the direction of gravity DZ1 to the rotational axis Ax1 of the drum 62, the preferred range of the angle K30 using a wrapping film for the friction force imparting portion 326a is-10° or more and 90° or less.

As described above, the preferred range of the distance L30 and the angle K30 is the range set for engagement of the coupling. This value depends on the structure of the main assembly of the image forming apparatus A to which this embodiment is applied. Depending on the structure of the main assembly of the image forming apparatus A to which the embodiment is applied, the preferred range of the distance L30 and the angle K30 is not limited to those values.

The friction coefficients of the members exemplified as the material usable for the frictional force applying portion 336a are as follows. The friction coefficient of polyurethane foam is 2.61. The coefficient of friction of the silicone sheet is 0.87. The coefficient of friction of the wrapping film is 0.75.

For comparison, the coefficient of friction of the cartridge frame is as follows.

The coefficient of friction of the POM resin which constitutes the part of the frame supporting the drum 62 is 0.34. Here, in this embodiment, the part of the frame supporting the drum 62 is the drum bearing 73.

The coefficient of friction of the PS resin constituting the parts of the frame exposed to the outside is 0.46. The coefficient of friction of the part of the frame exposed to the outside corresponds to the coefficient of friction of the cleaning frame 71 in this embodiment.

Thus, the coefficient of friction of the friction force imparting portion 336a is higher than that of the frame of the cartridge. As described above, the coefficient of friction of the part of the frame exposed to the outside, for example the cleaning frame 71, is often higher than that of the bearing portion of the frame, i.e. The drum bearing 73. In this embodiment, the coefficient of friction of the friction force imparting portion 336a is selected to be higher than that of the part of the frame exposed to the outside.

The coefficient of friction of the friction force imparting portion 336a is also more than 1.5 times higher than that of the bearing part of the frame.

The coefficient of friction of the friction force imparting portion 336a is also more than 1.5 times higher than that of the portion of the frame exposed to the outside.

Part (a) of FIG. 51 shows a method used in this embodiment as a method for measuring values of the friction coefficient. A small piece of a measurement object OJ is placed on a slope SL prepared of an ABS resin plate. After that, the inclination of the slope SL of the ABS resin is increased, and the angle of the slope when the measurement object OJ started to slide along the slope SL determined as an angle θ. The value of tan 0 is determined as the friction coefficient of the measurement object OJ.

In this embodiment, when an elastic member is used as the friction force imparting portion 336a, the degree of elasticity is examined by the following method.

A measuring probe (contact element) CT having a surface of 2×5 mm is pressed against a measured object having an original thickness T1 of 3 mm with a force Fms=50 gf for 10 seconds. At this time, when a reduction in the thickness of the measurement object OJ is ΔT [mm], a value obtained by dividing ΔT [mm] by the original thickness T1=3 mm is obtained as a degree of deformation.

For example, when a polyurethane foam having an original thickness T1 of 3 mm is pressed by the probe CT, the measured thickness T2 after deformation is 0.78 mm. The amount of reduction in thickness at this time is T1−T2=2.22 mm, and the degree of deformation ΔT/T1 is 2.22/3=0.74. The degree of deformation of the silicon sheet is 0.02.

In this embodiment, a member having a degree of deformation of 0.01 or more is considered as being an elastic member. It is preferable to use an elastic member having a degree of deformation of 0.9 or less. This is because if an elastic member is more easily deformed beyond this, when it comes into contact with the gear portion 81a of the drive transmission member 81, the elastic member may be bitten deeply by the gear portion 81a, with the result of hindering movement of the drive transmission member 81.

As described above, in this embodiment as well, by bringing the drive transmission member 81 into contact with the friction force imparting portion 336a of the cartridge B, it is possible to bring the drive transmission member 81 close to the cartridge B and connect it to the cartridge B. In this embodiment, the friction force imparting portion 336a is used, which has the advantage of simplifying the cartridge structure more than the above-described embodiments.

### Embodiment 4

Next, referring to FIGS. 52 to 55, Embodiment 4 will be described. In particular, among the elements disclosed in this embodiment, those corresponding to the members described in the above-described embodiments will be assigned the same names as the members in the above-described embodiments, and only the different points will be described. In this embodiment, a direction along the rotational axis Ax1 of the drum 62 is a longitudinal direction D402, the side of the driving side drum flange 263 is a driving side, and the opposite side to the driving side is a non-driving side. In addition, a direction from the non-driving side toward the driving side is a direction of arrow E40, and the direction from the driving side toward the non-driving side is a direction of arrow E41.

First, referring to FIGS. 52 and 53, the cartridge structure of this embodiment will be described. FIG. 52 is a perspective view of the cartridge B.

As shown in FIG. 52, the cartridge B in this embodiment comprises the cleaning unit 260 and a developing unit 420, as in Embodiment 1. The developing unit 420 includes an elastic rotatable member 490.

The elastic rotatable member 490 is a cylindrical rotatable member, and is made of an elastic material main assembly (elastic member) which can be elastically deformed, such as polyurethane foam, rubber, or elastomer. In this embodiment, ESH available from Inoac Corporation, Japan or Moltoprene available from Inoac Corporation, Japan is used as the polyurethane foam. In this embodiment, an outer diameter portion 490a of the cylindrical shape has a radius of 5.84 mm in this embodiment. The elastic rotatable member 490 is provided on the support shaft 32a of the developing roller 32, and is rotatable integrally with the developing roller 32. The elastic rotatable member 490 may be structured to be rotatable relative to the support shaft 32a.

Next, referring to FIG. 53, the arrangement of the elastic rotatable member 490 will be described. As will be described in detail hereinafter, the elastic rotatable member 490 is structured to mesh with the gear portion 81a of the drive transmission member 81 by elastic deformation, similarly to the elastic movable member 2912a (see part (b) of FIG. 40) of the modified example 2 of Embodiment 2. Therefore, as to the preferred positioning of the elastic rotatable member 490, the preferred range of the elastic movable member 2912a is applied. In the following, the matters specific to the elastic rotatable member 490 will be particularly described in detail.

FIG. 53 is an illustration showing the structure of the cartridge B. Part (a) of FIG. 53 is a view seen in a direction perpendicular to the rotational axis of the drum 62, and part (b) of FIG. 53 is a cross-sectional view taken along a line X400-X400 in part (a) of FIG. 53. For the sake of better illustration, only the drum 62 and the driving side drum flange 263 are shown in part (a) of FIG. 53 as the components constituting the cleaning unit 260. Similarly, part (b) of FIG. 53 shows only the drum 62, the developing roller 32, and the elastic rotatable member 490. In addition to the arrangement in this embodiment, part (b) of FIG. 53 also shows a state in which the elastic rotatable member 490 is shifted in a positive or negative direction at an angle K40, which will be described hereinafter for the sake of explanation, wherein the positive angle is indicated by angle K40U and the negative angle is indicated by angle K40L.

As shown in part (a) of FIG. 53, in the longitudinal direction D402, as in Embodiment 3, at least a part of the elastic rotatable member 490 is placed shifted in the direction of the arrow E40 from the free end portion 263b1 of the coupling portion 263b of the driving side drum flange 263. In other words, at least a part of the elastic rotatable member 490 is positioned outside the free end portion 263b1 in the longitudinal direction. That is, at least a part of the elastic rotatable member 490 is placed so as to be farther away from the non-driving side of the cartridge B than the free end portion 263b1.

In particular, in this embodiment, at least a portion of the elastic rotatable member 490 is disposed within a range of 4 to 9 mm from free end portion 263b1 toward the drive side. Note that the above range may be selected to be even larger depending on the structure of driving side drum flange 263 and the structure of the applicable main assembly of the image forming apparatus A.

Part (b) of FIG. 53 is a schematic illustration of the cartridge as viewed along the longitudinal direction D402. The direction of a straight line extending from the rotational axis Ax1 of the drum 62 to pass through the rotational axis Ax40 of elastic rotatable member 490 is referred to as direction D400.

The arrow showing the direction D400 is a straight line perpendicular to the rotational axis Ax1 and the longitudinal direction D402. The distance from the axis of the drum 62 to the outer diameter portion 490a of the elastic rotatable member 490 measured along the direction D400 perpendicular to the rotational axis Ax1 is referred to as a distance L40. Here, the distance L40 is selected in a range of 75% to 120% of the radius of the drum 62, similarly to the case in which the friction force imparting portion 326a is an elastic body as with Embodiment 3. In this embodiment, the radius of the drum 62 is 12 mm, and the distance L40 is selected to be 95.67% (11.48 mm) of the radius of the drum 62.

With a straight line connecting the rotational axis Ax1 of the drum 62 and the rotational axis Ax2 of the developing roller 32 being the reference line, the angle between the direction D400 and this reference line is referred to as an angle K40. The angle K40 is positive in the downstream direction of the arrow R direction, which is the rotational direction of the drum 62, and negative in the upstream direction of the arrow R direction. In this case, the preferred range of the angle K40 is set in a range of −70 to 100 degrees, similarly to the case of employing polyurethane foam for the elastic moving member in Modified Example 2 of Embodiment 2. In this embodiment, the angle K40 is set to 0°. As in the Embodiment 3, the preferred range of the angle K40 and the distance L40 described above is determined depending on the relationship with the used main assembly of the image forming apparatus A.

In this embodiment, the elastic rotatable member 490 is provided on the support shaft 32a of the developing roller 32, but this is not inevitable. The elastic rotatable member 490 may be provided on a shaft provided on the development side member 426 or the cleaning unit 260, depending on the setting of the angle K40 and the distance L40.

Next, referring to FIG. 54, the description will be made as to the operation in which the drive transmission member 81 is driven and the coupling recess 81b is brought into engagement with the coupling projection 263b of the driving side drum flange 263. FIG. 54 is cross-sectional views showing the operation when the cartridge B is mounted and the drive transmission member 81 is driven, taken along a line X401-X401 in part (a) of FIG. 53. Part (a) of FIG. 54 shows the state immediately after the drive transmission member 81 is driven after the cartridge B is mounted, and part (b) of FIG. 54 shows the state in which the drive transmission member 81 has moved and is in a position where it can engage with the driving side drum flange 263.

As shown in part (a) of FIG. 54, when the cartridge B is mounted in the main assembly of the image forming apparatus A, the elastic rotatable member 490 enters a space S40 between the adjacent gear teeth of the gear portion 81a, similarly to the case in which the polyurethane foam is used in Embodiment 3. In this state, when the drive transmission member 81 rotates in the rotational direction CW, the tooth surface 81a2 receives a reaction force F40 from the elastic rotation member 490, and the gear portion 81a moves in the direction of the reaction force F40. By the movement of the gear portion, the rotational axis Ax3 approaches the rotational axis Ax1 of the drum 62. Thereafter, the gear portion 81a abuts against the restricting portion 73j, and as shown in part (b) of FIG. 54, the drive transmission member 81 becomes substantially coaxial with the driving side drum flange 263. At this time, the coupling recess 81b and the coupling projection 263b also become substantially coaxial and are in engageable positions.

At this time, the elastic rotation member 490 is rotated in a rotational direction R40 by a force F41 received from the tooth surface 81a2 of the gear portion 81a.

As shown in FIG. 55, a thrust force F42 in the direction of the arrow DW3 is produced onto the tooth surface 81a2 of the helical gear portion 81a (shown by hatching in the figure) by the reaction force F40 received from the rotating elastic rotatable member 490. This thrust force F42 moves the drive transmission member 81 in the direction of the arrow DW3.

The subsequent engagement operation is similar to that of the previously described embodiment, and therefore the description thereof is omitted.

As contrasted to the friction force imparting portion 326a described in Embodiment 3, the elastic rotatable member 490 of this embodiment moves the gear portion 81a of the drive transmission member 81 and also receives a driving force from the gear portion 81a. The driving force received by the elastic rotatable member 490 can be used as a power for driving the developing roller 32 and other members of the cartridge B.

For example, in Embodiment 1 (see FIG. 9), the developing roller gear 30 is connected to the developing roller 32, and therefore the elastic rotatable member 490 may be connected to the developing roller gear 30.

However, the elastic rotatable member 490 does not necessarily need to transmit the driving force received from the drive transmission member 81 to another member.

In this modified example, the gear portion 81a of the drive transmission member 81 bites into the elastic rotatable member 490, which is an elastic body, and therefore has the advantage that the engagement state between the elastic rotatable member 490 and the drive transmission member 81 is easily stabilized.

### Embodiment 5

Next, referring to FIGS. 56 to 66, Embodiment 5 will be described in the following. In particular, among the elements disclosed in this embodiment, those corresponding to the members described in the previous embodiment will be assigned the same names as the members in the previous embodiment, and only the different points from the previous embodiment will be described. In the description of this embodiment, reference will be made in particular to Embodiment 2.

First, referring to FIG. 56, the cartridge structure of this embodiment will be described. FIG. 56 is a perspective view of the cartridge B. As shown in FIG. 56, the cartridge B in this embodiment comprises a cleaning unit 260 and a developing unit 520, as in Embodiment 2. The developing unit 520 also has a missing tooth gear mechanism 590. In this embodiment, the direction along the rotational axis Ax1 of the drum 62 is a longitudinal direction D500, the driving side drum flange 263 side is a driving side, and the direction toward the driving side is indicated by an arrow E50. The side opposite the driving side is a non-driving side, and a direction toward the non-driving side is indicated by an arrow E51.

### <Missing Tooth Gear Mechanism>

Next, referring to FIG. 57, the structure of the missing tooth gear mechanism 590 will be described. FIG. 57 is an exploded perspective view of the missing tooth gear mechanism 590. Part (a) of FIG. 57 is a view as seen from the non-driving side, and part (b) of FIG. 57 is a view as seen from the driving side.

In this embodiment, the missing tooth gear mechanism 590 is provided on the drive side of the cartridge as part of the structure of the developing unit 520 (see part (a) of FIG. 59). As shown in FIG. 57, the missing tooth gear mechanism 590 comprises a driving-side development side member 526, a missing tooth gear 591, an urging spring 592, a torsion coil spring 594, a rotatable member 295, a support member 596, a pressed member 297, and an initialization spring 298. Each of the components of the missing tooth gear mechanism 590 will be described in the following.

The driving-side development side member 526 includes a shaft support portion 526a, a restriction hole 526b, a hole portion 526d, a spring seat surface 526h, a cut-away portion 526g, and a guide surface 526i as components related to the missing tooth gear mechanism 590.

The shaft support portion 526a is a hole recessed in the longitudinal direction D500, and the axis thereof is a rotational axis Ax50. When the missing tooth gear mechanism 590 is assembled, the rotational axis Ax2 of the developing roller 32 is coaxial with the rotational axis Ax50 of the shaft support portion 526a.

The restriction hole 526b is a hole recessed in the longitudinal direction D500, and is an arc-shaped hole coaxial with the rotational axis Ax50. As viewed from the non-driven side parallel to the rotational axis Ax50, a counterclockwise direction about the rotational axis Ax50 is indicated by a rotational direction R50, and a clockwise direction is indicated by a rotational direction R51. A downstream end of the restriction hole 526b in the rotational direction R51 is referred to as a restriction surface 526b1.

The hole portion 526d, the spring seat surface 526h, the cut-away portion 526g, and the guide surface 526i are provided in the same manner as the hole portion 226d, the spring seat surface 226h, the cut-away portion 226g, so that guide surface 226i of Embodiment 2.

The missing tooth gear 591 comprises a gear portion 591a, a shaft hole 591b, a small diameter portion 591c, a large diameter portion 591d, a pressed portion 591e, a spring hook hole 591f, and a locking projection 591g. When the missing tooth gear mechanism 590 is assembled, the shaft hole 591b of the missing tooth gear 591 is coaxial with the rotational axis Ax50, and a plurality of the gear portions 591a are distributed radially outward from the shaft hole 591b. The small diameter portion 591c is provided downstream of the gear portion 591a in the rotational direction R50, and the large diameter portion 591d is provided further downstream. The surface connecting the small diameter portion 591c and the large diameter portion 591d is the pressed portion 591e. The missing tooth gear 591 is provided with the spring hook hole 591f at the end on the downstream side in the direction of the arrow E51 and the locking projection 591g at the end on the downstream side in the direction of the arrow E50.

The missing tooth gear 591 has at least one gear tooth. In this embodiment, the missing tooth gear 591 has multiple gear teeth. The missing tooth gear 591 of this embodiment is a part corresponding to the gear portion 30a (see FIG. 9) of Embodiment 1. The missing tooth gear 591 is at least partially exposed toward the outside of the cartridge in order to mesh with the gear portion 81a of the drive transmission member 81. More specifically, the exposed portion of the gear portion 291a faces toward the side where the axis Ax1 of the drum 62 is provided (see FIG. 56).

The urging spring 592 is a torsion coil spring, and has an inner diameter portion 592a, a fixed arm 592b projecting toward the arrow E51 side, and an actuating arm 592c projecting in the direction of the arrow E50.

The torsion coil spring 594 comprises an actuated arm 594a, an actuating arm 594b, and an inner diameter portion 594c. A state in which no load is applied to the actuated arm 594a and the actuating arm 594b is referred to as a free state. The actuating arm 594b has an arm portion 594b1 extending radially outward and an actuating portion 594b2 extending in the direction of arrow E50 from the free end side of the arm portion 594b1. As viewed in the direction D500, the side in which the actuated arm 294a and the actuating arm 294b approach each other from the free state is referred to as a closing direction, and the side in which they are away is referred to as an opening direction.

The rotatable member 295 is similar to Embodiment 2. In this embodiment, the axis of rotation of the rotatable member 295 is referred to as a rotational Ax51.

The support member 596 comprises a hole portion 596a, a developing roller support hole 596b, a guide surface 596c, and a spring hook hole 596d, and is a member which is fixed to the driving-side development side member 526 at the time when the missing tooth gear mechanism 590 is assembled. The developing roller support hole 596b is a hole penetrating in the longitudinal direction D500. The spring hook hole 596d is a hole penetrating in the longitudinal direction D500. The hole portion 596a and the guide surface 596c have the same structure as the hole 296a and the guide surface 596c of Embodiment 2.

The pressed member 297 and the initialization spring 298 have the same structure as those of Embodiment 2.

### <Assembling of Missing Tooth Gear Mechanism>

Next, referring to FIGS. 58 and 59, the assembly method of the missing tooth gear mechanism 590 per se and the assembly of the missing tooth gear mechanism 590 to the developing unit 520 will be described. FIG. 58 shows the assembling method of the missing tooth gear mechanism 590. It is assembled in the order of part (a) of FIG. 58 and part (b) of FIG. 58. FIG. 59 shows the missing tooth gear mechanism 590 assembled. Part (a) of FIG. 59 is a view as seen in a direction perpendicular to the longitudinal direction, part (b) of FIG. 59 is a sectional view taken along a line X503-X503 shown in part (a) of FIG. 59, and part (c) of FIG. 59 is a sectional view taken along a line X504-X504 in part (a) of FIG. 59.

First, as shown in part (a) of FIG. 58, the torsion coil spring 594 and the rotatable member 295 are assembled to the driving-side development side member 526. For the torsion coil spring 594, the shaft portion 295g of the rotatable member 295 is inserted into the inner diameter portion 594c, in the phase with which the actuated arm 594a positioned in the gap 295c. The rotatable member 295 is assembled in the direction of the arrow E50 along the direction D500, and the shaft portion 295g is rotatably supported in the hole portion 526d.

Next, the pressed member 297 and the initialization spring 298 are assembled, but since this is similar to Embodiment 2, the description thereof will be omitted.

Next, the missing tooth gear 591, the urging spring 592, and the support member 596 are assembled. As shown in part (b) of FIG. 58, the developing unit 520 includes the developing roller 32. The developing roller support hole 596b of the support member 596, the inner diameter portion 592a of the urging spring 592, the shaft hole 591b of the missing tooth gear 591, and the shaft support portion 526a of the driving-side development side member 526 are fitted around the support shaft 32a of the developing roller 32 in this order. As in Embodiment 2, the support member 596 is fixed to the driving-side development side member 526 by adhesive or the like while the shaft portion 295g of the rotatable member 295 is inserted into the hole portion 596a and the guide surface 296c supports the guided surface 297c of the pressed member 297 (see part (c) of FIG. 27).

The fixed arm 592b of the urging spring 592 is inserted into the spring hook hole 596d of the support member 596, and the actuating arm 592c thereof is inserted into the spring hook hole 591f of the missing tooth gear 591.

The missing tooth gear 591 is rotatably supported by the shaft support portion 526a of the driving-side development side member 526, and the locking projection 591g is inserted into the restriction hole 526b of the driving-side development side member 526. At this time, the urging spring 592 is assembled in a state in which the actuating arm 592c is twisted in the rotational direction R50 relative to the fixed arm 592b to urge the missing tooth gear 591 in the rotational direction R51 with a moment M50. By this moment M50, as shown in part (b) of FIG. 59, the locking projection 591g of the missing tooth gear 591 is abutted against the restriction surface 526b1 of the driving-side development side member 526. Also, as shown in part (c) of FIG. 59, the large diameter portion 591d of the missing tooth gear 591 is in an opposite phase to the actuating portion 594b2 of the torsion coil spring 594 in the radial direction of the rotational axis Ax50.

After this, the missing tooth gear mechanism 590 is fixed to the developing unit 520 with screws or the like, as shown in part (a) of FIG. 59.

Through the above process, the missing tooth gear mechanism 590 is assembled to the developing unit 520.

Next, referring to FIG. 60, the range of the missing tooth gear 591 of the missing tooth gear mechanism 590 will be described. The missing tooth gear 591 is structured to mesh with the gear portion 81a of the drive transmission member 81, as with the developing roller gear 30 in Embodiment 1, as will be described in detail hereinafter. Therefore, the preferred position of the missing tooth gear 591 is the same as the preferred position of the developing roller gear 30.

The missing tooth gear 591 is a rotatable member, as will be described in detail hereinafter. The following description is based on the assumption that the missing tooth gear 591 is in the initial position before the cartridge is mounted in the main assembly of the apparatus, that is, the missing tooth gear 591 is in a position where it can mesh with the drive transmission member 81.

FIG. 60 shows the arrangement of the missing tooth gear 591 of the missing tooth gear mechanism 590. Part (a) of FIG. 60 is a view as seen in a direction perpendicular to the rotational axis of the drum 62, and part (b) of FIG. 60 is a sectional view taken along a line X500-X500 in part (a) of FIG. 60. In part (a) of FIG. 60, for the components constituting the cleaning unit 260, only the drum 62 and the driving side drum flange 263 are shown for the sake of better illustration. Similarly, part (b) of FIG. 60 shows only the drum 62, the developing roller 32, and a part of the missing tooth gear 591. In addition to the arrangement in this embodiment, part (b) of FIG. 60 also shows the missing tooth gear 591 in a state in which the angle K50 to be described hereinafter is arranged shifted in the positive and negative directions for the sake of explanation, wherein the positive angle is indicated as angle K50U and the negative angle is indicated as angle K50L.

A preferred arrangement for the missing tooth gear 591 corresponds to the preferred arrangement for the developing roller gear 30 (see FIGS. 1, 9 and 20) described with Embodiment 1 and the suitable arrangement for the rack gear 291 (see part (b) of FIG. 29) described in Embodiment 2.

For example, it is desirable that at least a part of the missing tooth gear 591 is arranged outwardly of the free end portion 263b1 of the driving side drum flange 263 in the longitudinal direction. It is also desirable that the teeth of the missing tooth gear 591 be exposed so as to face the drum axis Ax1.

When the cartridge is viewed along the rotational axis Ax1, a direction of a straight line extending from the rotational axis Ax1 of the drum 62 to pass through the rotational axis Ax50 of the missing tooth gear 591 is referred to as a direction D501. The direction D501 is perpendicular to the rotational axis Ax1. In this direction D501, a distance from the axis of the drum 62 to the free end portion (tooth tip) of the gear tooth of the gear portion 591a is referred to as a distance L50. At this time, the arrangement is such that the distance L50 is in the range of 90% to 120% of the radius of the drum 62, as in Embodiment 2. The distance L50 is further preferably 90% to 110%, and even further preferably 93% to 107%.

Furthermore, the straight line extending from the rotational axis Ax1 of the drum 62 and passing through the rotational axis Ax2 of the developing roller 32 is referred to as the reference line, and an angle between the direction D501 and this reference line is as an angle K50. As before, the downstream direction of the rotation of the drum 62 is taken as a positive direction of the angle. In other words, for the angle K50, the downstream side of the direction of arrow R, which is the rotational direction of the drum 62, with respect to the reference, is the positive side, and the upstream side of the direction of arrow R is the negative side.

In this case, it is preferable that the missing tooth gear 591 is disposed so that the angle K50 is in the range of −75° to 50°. The preferable range of the angle K50 related to the missing tooth gear 591 is the same as the preferable range of the angle K20 (see part (b) of FIG. 29) in Embodiment 2.

In addition, an angle formed between a straight line extending from the rotational axis Ax1 of the drum 62 and extending from the rotational axis Ax1 to pass through the tooth tip 591a1 of the gear portion 591a of the missing tooth gear 591 and the reference line is an angle K51.

The positive direction of the angle K51 is the downstream direction of the rotation of the drum 62. That is, the angle K51 is positive on the downstream side in the direction of the arrow R, which is the rotational direction of the drum 62, and is negative on the upstream side in the direction of the arrow R. The preferred range of the angle K51 is the same as the preferred range of the angle K21 (see part (b) of FIG. 29) described in Embodiment 2.

This is a preferred condition for the gear portion 81a (see FIG. 13) of the drive transmission member 81 to mesh with the gear portion 591a of the missing tooth gear 591. It is also preferred that the angle K51 of at least one tooth of the gear portion 591a of the missing tooth gear 591 is disposed so as to be within the preferred range.

In this embodiment, the missing tooth gear 591 is disposed so that the angle K51 is in the range of −35° or more and 45° or less.

Although the missing tooth gear mechanism 590 is provided in the developing unit 520 in this embodiment, it may be provided in the cleaning unit 260 depending on the settings of the angle K50, the angle K51, and the distance L50.

In this embodiment, the missing tooth gear 591 is provided coaxially with the developing roller 32, but it does not have to be coaxial. In such a case, the missing tooth gear 591 is supported by the driving-side development side member 526 or the like, rather than the support shaft 32a of the developing roller 32.

### <Operation of Missing Tooth Gear Mechanism>

Next, referring to FIG. 61, the operation of the missing tooth gear mechanism 590 will be described.

FIG. 61 is an operation illustration of the missing tooth gear mechanism 590, taken along a line X501-X501 of part (a) of FIG. 60. Also, part (a) of FIG. 61 shows a standby state of the missing tooth gear mechanism 590, and part (b) of FIG. 61 shows an operating state of the missing tooth gear mechanism 590.

First, the standby state (non-operating state) of the missing tooth gear mechanism 590 will be described, referring to part (a) of FIG. 61. In the standby state of the missing tooth gear mechanism 590, as in Embodiment 2, the pressed member 297 is urged in the direction of the arrow E25 along the third movable direction D203, and is in a first position projecting in the direction of the arrow E25. At this time, as in Embodiment 2, the rotatable member 295 is urged in a rotational direction Q51 about the rotational axis Ax51, and the torsion coil spring 594 is urged in a rotational direction Q53 about a rotational axis Ax52. At this time, the actuated arm 594a and the actuating arm 594b of the torsion coil spring 594 are in free state. Then, the actuating portion 594b2 of the torsion coil spring 594 is in a position spaced apart from the large diameter portion 591d of the missing tooth gear 591 by a gap S50 in the radial direction about the rotational axis Ax50. This state is referred to as the standby state of the missing tooth gear mechanism 590.

Next, referring to part (b) of FIG. 61, the operating state of the missing tooth gear mechanism 590 will be described. When the cartridge B is mounted in the main assembly of the image forming apparatus A, the pressed member 297 is pressed by the abutment portion 15m (see part (a) of FIG. 31 of the driving side plate 15 in the same manner as in Embodiment 2, and is moved in the direction of the arrow 24. As a result, the rotatable member 295 rotates in a rotational direction Q52 about the rotational axis Ax51. With the rotation of the shaft portion 295g of the rotatable member 295, the actuated arm 594a of the torsion coil spring 594 is urged in a rotational direction Q54 about a rotational axis Ax53, and is spring-charged. By this, the actuating portion 594b2 of the torsion coil spring 594 abuts against the large diameter portion 591d of the missing tooth gear 591, and imparts a force F50. This state is called the operating state of the missing tooth gear mechanism 590. Details will be described hereinafter, but the operating state is a state in which the torsion coil spring 594 is capable of locking the rotational movement of the missing tooth gear 591.

### <Mounting of Cartridge to Main Assembly of Image Forming Apparatus>

Next, referring to FIG. 62, the operation of mounting the cartridge B to the main assembly of the image forming apparatus A in this embodiment will be described. FIG. 62 is cross-sectional views showing the mounting operation of the cartridge B to the main assembly of the image forming apparatus A, taken along a line X501-X501 of part (a) of FIG. 60. Also, part (a) of FIG. 62 shows the state immediately before the cartridge is mounted, and part (b) of FIG. 62 shows the state after the cartridge is mounted.

As shown in part (a) of FIG. 62, immediately before the cartridge B is mounted to the main assembly of the image forming apparatus A, the pressed surface 297a of the pressed member 297 faces the abutment portion 15m of the driving side plate 15 constituting the main assembly of the image forming apparatus A. At this time, the missing tooth gear mechanism 590 is in the standby state. Also, the gear portion 591a of the missing tooth gear 591 is in a state immediately before meshing with the gear portion 81a of the drive transmission member 81. In this state, the position of the missing tooth gear 591 in the cartridge may be referred to as an initial position, engagement position, action position, pre-movement position, and so on.

When the cartridge B moves in the mounting direction C from here, it reaches the state after the cartridge B is mounted as shown in part (b) of FIG. 62.

Here, the missing tooth gear 591 in the initial position is constrained from rotating in the rotational direction R51 (see part (b) of FIG. 59). Therefore, the gear portion 81a of the drive transmission member 81 and the gear portion 591a of the missing tooth gear 591 contact each other. At this time, similar to Embodiment 2, the gear portion 81a is inclined in the escaping direction DW2. Thereafter, the drive transmission member 81 moves by its own weight to make meshing engagement with the gear portion 591a of the missing tooth gear 591.

On the other hand, when the cartridge B is mounted in the main assembly of the image forming apparatus A, the pressed member 297 is pressed by the abutment portion 15m of the driving side plate 15 to move to the second position. By this, the missing tooth gear mechanism 590 is placed into the operating state.

### <Engagement Operation of Drive Transmission Member 81>

Next, referring to FIGS. 63 and 64, the description will be made as to the operation of the drive transmission member 81 when it is driven and the coupling recess 81b engages with the coupling projection 263b of the driving side drum flange 263. FIG. 63 is cross-sectional views showing the operation when the drive transmission member 81 is driven, taken along a line X501-X501 in part (a) of FIG. 60. Part (a) of FIG. 63 shows the drive in the state that the drive transmission member 81 is tilted, and part (b) of FIG. 63 shows the state immediately after the drive transmission member 81 is aligned with the rotational axis Ax1 of the drum 62. FIG. 64 is cross-sectional views showing the operation of the missing tooth gear mechanism 590 after the drive transmission member 81 is aligned with the rotational axis Ax1 of the drum 62, taken along a line X501-X501 in part (a) of FIG. 60. Part (a) of FIG. 64 shows the process in which the rotation of the missing tooth gear 591 is being restricted by the action arm 594b of the torsion coil spring 594, and part (b) of FIG. 64 shows the state in which the movement has been restricted.

As shown in part (a) of FIG. 63, when the drive transmission member 81 rotates in the rotational direction CW, as in Embodiment 2, the gears mesh with each other, and an engaging reaction force FD50, which is a reaction force of the engaging force FD1, is produced in the gear portion 81a. At this stage, the inclined gear portion 81a can move in the direction of the meshing reaction force FD50, and therefore, not much force is transmitted to the gear portion 591a, so that the engaging force FD1 is very small. Therefore, the moment M51 acting on the missing tooth gear 591 by the engaging force FD1 is sufficiently smaller than the moment M50 by the urging spring 592, so that the missing tooth gear 591 does not rotate in the rotational direction R50. The missing tooth gear 59 maintains its initial position as before it meshes with the drive transmission member 81.

Meanwhile, the gear portion 81a of the drive transmission member 81 is moved by the reaction force FD50 of the engaging force FD1. As the gear portion 81a moves, the rotational axis Ax3 moves in a direction of aligning with the rotational axis Ax1 of the drum 62.

Then, as shown in part (b) of FIG. 63, the gear portion 81a abuts against the restricting portion 73j, and the rotational axis Ax3 of the drive transmission member 81 and the rotational axis Ax1 of the drum 62 become substantially coaxial.

After this, the engagement operation between the coupling projection 263b and the coupling recess 81b is the same as in Embodiment 2, and therefore the description thereof will be omitted.

When the gear portion 81a of the drive transmission member 81 abuts against the restricting portion 73j or when the coupling recess 81b engages with the coupling projection 263b as shown in part (b) of FIG. 63, movement of the gear portion 81a in any direction other than the rotational direction is restricted. When the movement of the drive transmission member 81 is restricted, the force can be sufficiently transmitted from the gear portion 81a to the gear portion 591a of the missing tooth gear 591. Therefore, when the force which the gear portion 591a receives due to the meshing force between the gears at this time is the engaging force FD2, the moment M52 acting on the missing tooth gear 591 by the engaging force FD2 is greater than the moment M50 applied by the urging spring 592. Therefore, the missing tooth gear 591 is rotated in the rotational direction R50 from the initial position (engaged position) by the moment M52.

When the missing tooth gear 591 rotates a predetermined amount in the rotational direction R50, as shown in part (a) of FIG. 64, the actuating portion 594b2 of the torsion coil spring 594 comes into contact with the pressed portion 591e of the missing tooth gear 591, and the pressed portion 591e is subjected to a force F50a from the actuating portion 594b2. Here, the moment M53a acting on the missing tooth gear 591 due to the force F50a is set to be larger than the moment M50a from the urging spring 592. Therefore, the actuating arm 594b of the spring-charged torsion coil spring 594 rotates in the rotational direction Q24 about the rotational axis Ax53. Then, as shown in part (b) of FIG. 64, the actuating portion 594b2 approaches the rotational axis Ax50 of the missing tooth gear 591 and comes into contact with the small diameter portion 591c, thereby stopping the rotation. During this time, the missing tooth gear 591 rotates in the rotational direction R50.

When the missing tooth gear 591 rotates in the rotational direction R50, the gear portion 591a is disengaged from the gear portion 81a of the drive transmission member 81. In this state, the pressed portion 591e of the missing tooth gear 591 receives a moment M53b from the actuating portion 594b2 of the torsion coil spring 594. Here, the moment M53b is set to be equal to or greater than the moment M50b from the urging spring 592. As a result, the rotation of the missing tooth gear 591 in the rotational direction R51 is restricted by an actuating portion 591b2 of the torsion coil spring 594. In other words, the gear portion 591a is maintained in a state in which it is disengaged from the gear portion 81a of the drive transmission member 81. The position of the missing tooth gear 591 in the cartridge at this time will be referred to as a retracted position, non-engaged position, post-movement position, and so on.

When the missing tooth gear 591 moves from the initial position (engaged position) to the retracted position (disengaged position), it is locked by the torsion coil spring 594. The torsion coil spring 594 is a locking member configured to lock the movement of the missing tooth gear 591.

### <Dismounting Cartridge>

Next, referring to FIG. 65, the dismounting operation of the cartridge B from the main assembly A of the image forming apparatus will be described. FIG. 65 is cross-sectional views showing the dismounting operation of the cartridge B, taken along a line X502-X502 in part (a) of FIG. 60. Part (a) of FIG. 65 to part (c) of FIG. 65 show the process. In part (b) of FIG. 65, unnecessary parts are not shown for better illustration, and the missing tooth gear mechanism 590 and the periphery thereof are shown enlarged.

As shown in part (a) of FIG. 65, in order to dismount the cartridge B, the cartridge B is moved in the direction opposite to the mounting direction C. At this time, as shown in part (b) of FIG. 65, similarly to Embodiment 2, the pressed surface 297a of the pressed member 297 spaced away from the abutment portion 15m of the driving side plate 15, and the pressed member 297 moves to the first position by the initialization spring 298.

The rotatable member 295 rotates in the rotational direction Q51 about the rotational axis Ax51. At this time, the torsion coil spring 594 restores to its original state in which the actuated arm 594a and the actuating arm 594b close, and the torsion coil spring 594 becomes in the free state. At this time, the actuating portion 594b2 of the torsion coil spring 594 moves to a position farther away in the radial direction about the rotational axis Ax50 than the large diameter portion 591d of the missing tooth gear 591. In this way, the contact between the actuating portion 594b2 of the torsion coil spring 594 and the pressed portion 591e of the missing tooth gear 591 is released, and the missing tooth gear 591 is rotated in the rotational direction R51 about the rotational axis Ax50 by the moment M50 of the urging spring 592.

Then, as shown in part (c) of FIG. 65, the missing tooth gear mechanism 590 becomes in a standby state. The standby state of the missing tooth gear mechanism 590 is a non-operating state in which the missing tooth gear 591 is not locked by the torsion coil spring 594, that is, an unlocked state.

The pressed member 297 is an operating part which is operated to switch the missing tooth gear mechanism 590 between the standby state and the operating state. When the pressed member 297 is pressed, the torsion coil spring 594 becomes in the operating state in which it can lock the missing tooth gear 591.

Through the above process, the cartridge B is dismounted from the main assembly of the image forming apparatus A.

### Modified Example 1 of Embodiment 5

An elastic member, such as the elastic rotatable member 490 described in Embodiment 4, can be applied to the gear portion 591a of the missing tooth gear 591 of this embodiment. Such a modification will be described. For convenience of explanation, the above-described structure may be called a representative example of Embodiment 5, and the following structure may be called modification 1 of Embodiment 5.

FIG. 66 is an illustration of this modification. Part (a) of FIG. 66 is an exploded perspective view of a rotating mechanism 5901, and part (b) of FIG. 66 is a cross-sectional view showing the meshing with the drive transmission member 81.

As shown in part (a) of FIG. 66, an elastic member 5911a is provided on the rotating member 5911 (corresponding to the missing tooth gear mechanism 590 in original one of this embodiment) of the rotating mechanism 5901 (corresponding to the missing tooth gear mechanism 591 in this embodiment).

In this modification, the elastic member 5911a is made of an elastically deformable material such as polyurethane foam, rubber, or elastomer. In this modification, ESH from Inoac Corporation, Japan and Moltoprene from Inoac Corporation, Japan which are polyurethane foams, are used. When the surface of the elastic member 5911a is a surface 5911a1, the distance from a rotational axis Ax501 of the rotating member 5911 to the surface 5911a1 is selected to be 5.84 mm.

As shown in part (b) of FIG. 66, the elastic member 5911a enters the space between the adjacent gear teeth of the gear portion 81a of the drive transmission member 81 and deforms to match the shape of the gear teeth. The deformed elastic member 6911a moves the drive transmission member 81 by the same action as the missing tooth gear 591, and rotates the rotating member 5911 in a rotational direction R501 about the rotational axis Ax501. This results in the same operation as in this embodiment being carried out. The engagement is also possible with this structure.

The elastic member 5911a can be deformed by contacting the drive transmission member 81. Therefore, the permissible range for the distance from the rotational axis Ax1 of the drum 62 to the elastic member 5911a is wider than the permissible range for the distance from the rotational axis Ax1 of the drum 62 to the free end portion of the teeth of the missing tooth gear 591.

A distance from the rotational axis Ax1 of the drum 62 to the free end portion of the teeth of the missing tooth gear 591 measured in a direction perpendicular to the axis Ax1 is preferably within the range of 90-120% of the radius of the drum 62, and more preferably within the range of 90-110%.

In contrast, the distance from the rotational axis Ax1 of the drum 62 to the elastic member 5911a measured in a direction perpendicular to the axis Ax1 is preferably 75-120% of the radius of the drum 62.

In this embodiment, after the drive transmission member 81 is connected to the cartridge B, the engagement between the missing tooth gear 591 and the gear portion 81a of the drive transmission member 81 can be broken (see part (b) of FIG. 64). In other words, even when the cartridge B is dismounted, the engagement between the missing tooth gear 591 and the drive transmission member 81 can be broken. Therefore, it is unlikely that the missing tooth gear 591 is caught on the drive transmission member 81, preventing the dismounting of the cartridge B. This provides the advantage that the user can easily dismount the cartridge B.

### Embodiment 6

Next, referring to FIGS. 67 to 73, Embodiment 6 will be described in the following. In particular, among the elements disclosed in this embodiment, those corresponding to the members described in the previous embodiments are assigned the same names as the members in the previous embodiment, and only the different points from the previous embodiments are described. In this embodiment, the rack gear in Embodiment 2 is changed from the translational motion to rotational motion.

First, referring to FIG. 67, the cartridge structure of this embodiment will be described. FIG. 67 is a perspective view of the cartridge B. As shown in FIG. 67, the cartridge B in this embodiment comprises a cleaning unit 260 and a developing unit 620, as in Embodiment 2. The developing unit 620 has a rotatable rack gear mechanism 690. In this embodiment, a direction along the rotational axis Ax1 of the drum 62 is a longitudinal direction D600, a side provided with a driving side drum flange 263 is a driving side, and a direction toward the driving side is indicated by an arrow E60. The side opposite the driving side is the non-driving side, and the direction toward the non-driving side is indicated by an arrow E61.

### <Rotatable Rack Gear Mechanism>

Next, referring to FIG. 68, the structure of the rotatable rack gear mechanism 690 will be described. FIG. 68 is an exploded perspective view of the rotatable rack gear mechanism 690. Part (a) of FIG. 69 is a view as seen from the non-driven side, and part (b) of FIG. 69 is a view as seen from the driven side.

In this embodiment, the rotatable rack gear mechanism 690 is provided as a part of the structure of the developing unit 620 (see part (b) of FIG. 69). FIG. 68 shows a detailed structure of the rotatable rack gear mechanism 690. The rotatable rack gear mechanism 690 comprises a driving-side development side member 626, a rotatable rack gear 691, a tension spring 292, a locking member 293, a torsion coil spring 294, a rotatable member 295, a support member 696, a pressed member 297, and an initialization spring 298. Each of these components of the rotatable rack gear mechanism 690 will be described below.

The driving-side development side member 626 is provided with a slide surface 626c, a retaining portion 626f, a hole 626d, a spring hook portion 626e, a spring seat surface 626h, a cut-away portion 626g, a guide surface 626i, and a locking surface 626j as components related to the rack gear mechanism 690.

The slide surface 626c, the retaining portion 626f, the hole 626d, the spring hook portion 626e, the spring seat surface 626h, the cut-away portion 626g, and the guide surface 626i are respectively identical in structure to the slide surface 226c, the retaining portion 226f, the hole portion 226d, the spring hook portion 226e, the spring seat surface 226h, the cut-away portion 226g, and the guide surface 226i of Embodiment 2 (see FIG. 25).

The locking surface 626j is a surface facing in the direction of the arrow E60 of the longitudinal direction D600.

The rotatable rack gear 691 comprises a gear portion 691a, a support shaft 691b, a spring hook portion 691d, an abutted surface 691e, and a locked surface 691f. The rotatable rack gear 691 is a rack equivalent to the rack gear 291 described in Embodiment 2 (see part (a) of FIG. 29 and the like). However, there is a difference in that while the rack gear 291 moves linearly, the rack gear 691 of this embodiment moves so as to rotate at least in a predetermined range of angles around the axis Ax60. Therefore, this embodiment corresponds to a modified example of Embodiment 2 in which the movement direction of the rack gear 291 is changed.

The axis of the support shaft 691b is referred to as a rotational axis Ax60. A direction toward the tooth tip of the gear portion 691a along the rotational axis Ax60 of the rotatable rack gear 691 is referred to as a direction of arrow E62, and a direction opposite to the direction of the arrow E62 is a direction of arrow E63. A counterclockwise direction about the rotational axis Ax60 as viewed from the direction of the arrow E62 is referred to as a rotational direction R60.

The gear portion 691a has at least one gear tooth, and each gear tooth is arranged in the rotational direction R60 at a predetermined interval at positions radially outward from the rotational axis Ax60.

The support shaft 691b is cylindrical and centered on the rotational axis Ax60, and is provided so as to project in the direction of arrow E63.

The spring hook portion 691d is provided upstream of the gear portion 691a in the rotational direction R60.

The abutted surface 691e is provided as a surface facing the upstream side in the rotational direction R60 of the rotatable rack gear 691. A ridge portion of the abutted surface 691e on the arrow E63 side is a pressed portion 691e1.

The locked surface 691f is provided as a surface facing the downstream side in the rotational direction R60 of the rotatable rack gear 691.

The support member 696 comprises a hole portion 696a, a developing roller support hole 696b, a guide surface 696c, a support surface 696d, a restricting surface 696e, and a support hole 696f, and is fixed to the driving-side development side member 626 in the state that the rotatable rack gear mechanism 690 is assembled.

The support surface 696d is provided as an end face of the support member 696 on the downstream side in the arrow E62.

The support hole 696f is recessed in the direction of arrow E63 in the support surface 696d, and supports the support shaft 691b of rotatable rack gear 691 in the state that the rotatable rack gear mechanism 690 is assembled.

The hole portion 696a, the developing roller support hole 696b, and the guide surface 696c have the same structures as the hole portion 296a, the developing roller support hole 296b, and the guide surface 296c in Embodiment 2 (see FIG. 25).

The restricting surface 696e faces downstream in the rotational direction R60 about rotational axis Ax60.

The tension spring 292, the locking member 293, the torsion coil spring 294, the rotatable member 295, the pressed member 297, and the initialization spring 298 have the same structures as in Embodiment 2. The axis of rotation of the rotatable member 295 is a rotational axis Ax61.

### <Assembling of Rotatable Rack Gear Mechanism>

Next, referring to FIGS. 69 and 70, the method of assembling the rotatable rack gear mechanism 690 will be described. FIG. 69 is an illustration of the method of assembling the rotatable rack gear mechanism 690.

Part (a) of FIG. 69 shows the assembly of the rotatable rack gear 691 and the tension spring 292, and part (b) of FIG. 69 shows a state in which the rotatable rack gear mechanism 690 is mounted to the developing unit 620. FIG. 70 is an illustration of operation of the rotatable rack gear 691 of the rotatable rack gear mechanism 690, as viewed along the axis of rotation Ax60. Part (a) of FIG. 70 shows the rotatable rack gear 691 before it rotates in the direction of rotation R60, and part (b) of FIG. 70 shows the same after it has been rotated.

First, through the same process as in Embodiment 2, the locking member 293, the torsion coil spring 294, the rotatable member 295, the pressed member 297, the initialization spring 298, and the support member 696 are assembled to the driving-side development side member 626 in this order (see FIGS. 26 to 28).

Next, as shown in part (a) of FIG. 69, the rotatable rack gear 691 and the tension spring 292 are assembled to the driving-side development side member 626.

The rotatable rack gear 691 is inserted into the support hole 696f of the support member 696 and is supported rotatably about the rotational axis Ax60 with the support shaft 691b. At this time, the gear portion 691a is assembled so as to be positioned on the arrow E60 side beyond the support shaft 691b in the longitudinal direction D600.

Next, the spring hooks 292a at both ends of the tension spring 292 are mounted to the spring hook portions 691d of the rotatable rack gear 691 and the spring hook portion 626e of the driving-side development side member 626.

Through the above process, the rotatable rack gear mechanism 690 is assembled.

Thereafter, the rotatable rack gear mechanism 690 is fixed to the developing unit 620 with screws or the like (see part (b) of FIG. 69).

As shown in part (a) of FIG. 70, the rotatable rack gear 691 is urged upstream in the rotational direction R60 by a force F60 of the tension spring 292. As a result, the abutted surface 691e of the rotatable rack gear 691 is brought into contact with the restricting surface 696e of the support member 696 by the moment M60 produced by the force F60 (see also FIG. 68), and the rotation of the rotatable rack gear 691 is restricted.

When the rotatable rack gear 691 rotates in the rotational direction R60, from this state, as shown in part (b) of FIG. 70, the locked surface 691f comes into contact with the locking surface 626j of the driving-side development side member 626, so that the rotation in the rotational direction R60 is restricted (see also FIG. 68). In other words, the rotatable rack gear 691 becomes rotatable between the restricting surface 696e of the support member 696 and the locking surface 626j of the driving-side development side member 626.

The preferred range of the rotatable rack gear 691 is the same as that of the rack gear 291 in Embodiment 2.

For example, the preferred ranges of angles K20 and K21 for the rack gear 291 described in FIG. 29 also apply to the rotatable rack gear 691. As viewed along the axis Ax1 of the drum 62, the rotatable rack gear 691 moves linearly, and therefore, the direction of movement is considered to correspond to the movable direction D200 shown in part (b) of FIG. 29, and the angle K20 can be determined.

The preferred arrangement of the gear teeth of the rack gear 291 relative to the axis Ax1 of the drum 62 and the driving side drum flange 263 is similar to the preferred arrangement of the gear teeth of the rack gear 291.

### <Operation of Rotatable Rack Gear Mechanism>

The operation of the rotatable rack gear mechanism proceeds from the standby state to the operating state as the pressed member 297 moves, but since the structure and operation are similar to those of Embodiment 2, the description there is omitted.

<Engagement Operation with Drive Transmission Member 81>

Next, referring to FIG. 71 and FIG. 72, the description will be made as to the operation of the drive transmission member 81 after the cartridge B is mounted, until the coupling recess 81b engages with the coupling projection 263b of the driving side drum flange 263. The mounting of the cartridge B into the main assembly of the image forming apparatus A is omitted because it is the same as in Embodiment 2.

FIG. 71 shows the operation of the drive transmission member 81 when it is driven. Part (a) of FIG. 71 and part (b) of FIG. 71 show the drive transmission member 81 in a tilted state, and part (c) of FIG. 71 and part (d) of FIG. 71 show the drive transmission member 81 in a state where it is substantially coaxial with the rotational axis Ax1 of the drum 62. Part (a) of FIG. 71 and part (c) of FIG. 71 are sectional views taken along a line X600-X600 of part (b) of FIG. 69, and part (b) of FIG. 69 and part (d) of FIG. 69 are sectional views taken along a line X601-X601 of part (a) of FIG. 69. Also, part (b) of FIG. 69 and part (d) of FIG. 69 show only the rotatable rack gear mechanism 690 and the drive transmission member 81.

FIG. 72 shows the operation of the chipped gear mechanism 690 after the drive transmission member 81 is aligned with the rotational axis Ax1 of the drum 62. Part (a) of FIG. 72 and part (c) of FIG. 72 show the process in which the movement of the rotatable rack gear 691 becomes restricted by the locking member 293, and part (b) of FIG. 72 and part (d) of FIG. 72 show the state in which the movement is restricted. Part (a) of FIG. 72 and part (c) of FIG. 72 are sectional views taken along a line X600-X600 of part (b) of FIG. 69, and part (b) of FIG. 69 and part (d) of FIG. 69 are sectional views taken along a line X601-X601 (a). Part (b) of FIG. 72 and part (d) of FIG. 72 show only the rotatable rack gear mechanism 690 and the drive transmission member 81.

As shown in part (a) of FIG. 71 and part (b) of FIG. 71, when the drive transmission member 81 rotates in the rotational direction CW, as in Embodiment 2, an engaging reaction force FD60, which is a reaction force caused by the engaging force FD1, is produced in the gear portion 81a. At this stage, the inclined gear portion 81a can move in the direction of the meshing reaction force FD60, so that not much force is transmitted to the gear portion 691a and the engaging force FD1 is very small. Therefore, the moment M61 acting on the rotatable rack gear 691 by the engaging force FD1 is sufficiently smaller than the moment M60 by the tension spring 292, and the rotatable rack gear 691 does not rotate. For this reason, the rotatable rack gear 691 remains in the initial position before meshing with the drive transmission member 81.

On the other hand, the gear portion 81a of the drive transmission member 81 is moved by the reaction force FD60 of the engaging force FD1. As the gear portion 81a moves, the rotational axis Ax3 moves in a direction to align with the rotational axis Ax1 of the drum 62.

Then, as shown in part (c) of FIG. 71, the gear portion 81a abuts against the restricting portion 73j, and the rotational axis Ax3 of the drive transmission member 81 and the rotational axis Ax1 of the drum 62 become substantially coaxial with each other.

The subsequent engagement action between the coupling projection 263b and the coupling recess 81b is the same as in Embodiment 2, and therefore the description thereof is omitted.

After this, as shown in part (d) of FIG. 71, when the gear portion 81a of the drive transmission member 81 comes into contact with the restricting portion 73j or when the coupling recess 81b comes into engagement with the coupling projection 263b, movement of the gear portion 81a in directions other than the rotational direction is restricted. When the movement of the drive transmission member 81 is restricted, the force can be sufficiently transmitted from the gear portion 81a to the gear portion 691a of the rotatable rack gear 691. Therefore, when the force that the gear portion 691a receives due to the meshing force between the gears at this time is an engaging force FD2, the moment M62 acting on the rotatable rack gear 691 by the engaging force FD2 is greater than the moment M60 applied by the tension spring 292. Therefore, the rotatable rack gear 691 rotates in the rotational direction R60.

As shown in part (a) of FIG. 71 and part (c) of FIG. 71, as the cartridge is viewed along the axis of the drum 62, the multiple gear teeth of the rotatable rack gear 691 move linearly along a straight line passing through the tips of these gear teeth. This is similar to the gear teeth of the rack gear 291 in Embodiment 2 (see FIG. 33, and so on).

In other words, the multiple gear teeth of the rotatable rack gear 691 move along a plane that is in contact with the tips of these teeth.

When the rotatable rack gear 691 moves a predetermined amount in the rotational direction R60, the pressed portion 691e1 is brought into contact with the pressing portion 293a of the locking member 293, as shown in part (a) of FIG. 72. As in Embodiment 2, the pressed portion 691e1 of the rotatable rack gear 691 receives a force F28a from the pressing portion 293a of the locking member 293. As shown in part (b) of FIG. 72, the rotatable rack gear 691 further rotates in the rotational direction R60 against the moment M60 of the tension spring 292 by a moment M63 produced by the force F28a.

Then, as shown in part (d) of FIG. 72, as the rotatable rack gear 691 rotates partway in the rotational direction R60, the gear portion 691a separates from the meshing of the gear portion 81a of the drive transmission member 81.

Then, the locked surface 691f of the rotatable rack gear 691 abuts against the locking surface 626j of the driving-side development side member 626, so that the rotation is restricted (see FIG. 70). Also, as shown in part (c) of FIG. 72, the locking member 293 is moved in the direction of the arrow E27 by the rotation of the rotatable rack gear 691, but when the rotation of the rotatable rack gear 691 is restricted, as described above, the movement in the direction of the arrow E27 is restricted. At this time, the gear portion 691a is out of engagement with the gear portion 81a of the drive transmission member 81. The position of the rotatable rack gear 691 at this time is called a retracted position, non-engaged position, post-movement position, and so on.

In this state, as in Embodiment 2, the pressed portion 691e1 of the rotatable rack gear 691 receives a force F28b from the pressing portion 293a of the locking member 293 (see part (d) of FIG. 72). The moment M64 by the force F28b is selected to be larger than the moment M60 by the tension spring 292, and upstream rotation in the rotational direction R60 is restricted. In other words, the rotatable rack gear 691 is held in the retracted position, and the gear portion 691a is maintained in a state where it is not meshed with the gear portion 81a of the drive transmission member 81.

### Modified Example 1 of Embodiment 6

An elastic member, such as the elastic rotatable member 490 described in Embodiment 4, can be applied to the gear portion 691a of the rotatable rack gear 691 of this embodiment. Such a structure is shown in the following.

For sake of explanation, the above-described structure may be called a representative example of Embodiment 6, and the structure described below may be called Modified Example 1 of Embodiment 6.

FIG. 73 is an illustration of this modification. Part (a) of FIG. 73 is a perspective view of the rotating mechanism 6901, and part (b) of FIG. 73 is a cross-sectional view showing the meshing with the drive transmission member 81.

As shown in part (a) of FIG. 73, an elastic member 6911a is provided on the rotating member 6911 (corresponding to the rotatable rack gear 691 of this embodiment) of the rotating mechanism 6901 (corresponding to the rotatable rack gear mechanism 690 of this Embodiment. As shown in the Figure, the elastic member 6911a is provided in a position similar to that of the gear portion 691a of the rotatable rack gear 691 of this Embodiment.

However, since the elastic member 6911a is capable of elastic deformation, the suitable arrangement range is wider than the suitable arrangement range of the gear portion 691a of the rotatable rack gear 691.

The distance from the axis Ax1 to the tip of the teeth of the gear portion 691a, measured along a direction perpendicular to the rotational axis Ax1 of the drum 62, is preferably in the range of 90-120%, more preferably 90-110%, of the radius of the drum 62. On the other hand, the distance from the axis Ax1 to the surface of the elastic member 6911a, measured along a direction perpendicular to the rotational axis Ax1 of the drum 62, is preferably in the range of 75-120% of the radius of the drum 62.

In this modification, an elastically deformable material such as polyurethane foam, rubber, or elastomer is used for the elastic member 6911a. In this modification, polyurethane foams ESH available from Inoac Corporation, Japan and Moltoprene available from Inoac Corporation, Japan are used. When the surface of the elastic member 6911a is surface 6911a1, the distance from the rotational axis Ax1 (not shown) of the drum 62 to the surface 6911a1 measured in the direction along a rotational axis Ax601 is set to 12.74 mm.

As shown in part (b) of FIG. 73, the elastic member 6911a enters the space between the adjacent gear teeth of the gear portion 81a of the drive transmission member 81 and deforms to match the shape of the gear teeth. The deformed elastic member 6911a moves the drive transmission member 81 by the same action as the rotatable rack gear 691, and rotates the rotating member 6911 in a rotational direction R601 about the rotational axis Ax601. By this, the same operation as in this embodiment is carried out.

### Embodiment 7

Next, referring to FIGS. 74 to 82, Embodiment 7 will be described. In particular, among the elements disclosed in this Embodiment those that correspond to the members described in the previous examples will be assigned the same names as the members in the previous Embodiments and only the different points will be described.

In this Embodiment and Modified Examples thereof, several examples of structures in which the cartridge has only one gear (projection, engagement portion) that can mesh with the gear portion 81a of the drive transmission member 81 will be introduced.

First, referring to FIG. 74, the cartridge structure of this embodiment will be described. FIG. 74 is a perspective view of a cartridge B. As shown in FIG. 74, the cartridge B in this embodiment comprises a cleaning unit 260 and a developing unit 720. The developing unit 720 has a driving-side development side member 726. The driving-side development side member 726 is provided with an urging mechanism 790. In this embodiment, a direction along a rotational axis Ax1 of a drum 62 is the longitudinal direction D703, a driving side drum flange 263 side is a driving side, and a direction toward the driving side is indicated by an arrow E71. A side opposite the driving side is the non-driving side, and a direction toward the non-driving side is indicated by an arrow E70.

### <Urging Mechanism>

Next, referring to FIG. 75, the structure of the urging mechanism 790 will be described. FIG. 75 is an exploded perspective view of the urging mechanism 790. Part (a) of FIG. 75 is a view as seen from the driving side, and part (b) of FIG. 75 is a view as seen from the non-driving side.

As shown in FIG. 75, the urging mechanism 790 comprises a driving-side development side member 726, a projecting member 791, an elastic member 792, and a restricting member 793. Each of the components of the urging mechanism 790 will be described in the following.

The driving-side development side member 726 is provided with a positioning portion 726a which is recessed in the direction of the arrow E70, which is the non-driving side direction, in the longitudinal direction D703. A downstream surface of the positioning portion 726a in the longitudinal direction D703 in the direction of the arrow E70 is referred to as a restricting surface 726a1.

The projecting member 791 is a movable member which can move in a movable direction D700 perpendicular to the longitudinal direction D703. In this embodiment, the direction of a straight line connecting the center of the drum 62 and the center of the developing roller 32 coincides with the movable direction D700.

This movable direction D700 collectively refers to an E72 direction and an E73 direction.

The direction in which the projecting member 791 moves toward the center of the drum 62 is called the E72 direction, and the direction in which the projecting member 791 moves away from the drum 62 is called the E73 direction.

The projecting member 791 is provided with a projecting portion 791a which protrudes toward the E72 direction. The projecting portion 791a is provided with an inclined surface 791a1 at a downstream end in the arrow E71 direction, which is the driving side direction in the longitudinal direction. In addition, a pair of restricted surfaces 791b which protrude in the direction D701 perpendicular to the longitudinal direction and perpendicular to the movable direction D700 and face the arrow E72 direction are provided at the end of the projecting portion 791a in the arrow E73 direction opposite to the arrow E72 direction. A pair of surfaces extending from the end, in the direction D701 of the restricted surface 791b in the direction of arrow E73 are referred to as sliding surfaces 791c. An end surface of the projecting member 791 facing the direction of arrow E73 is referred to as spring seat 791d.

The elastic member 792 is in the form of a compression spring or the like.

The restricting member 793 is provided with a predetermined gap S70 in the direction D701 and is provided with a pair of restricting surfaces 793a facing the direction of arrow E73. The restricting member 793 is provided with a pair of sliding surfaces 793b facing each other in direction D701 and extending from the restricting surface 793a in the direction of arrow E73. The restricting member 793 is provided with spring seat 793c facing the direction of arrow E72 so as to connect the ends of the pair of sliding surfaces 793b on the arrow E73 direction side. The restricting member 793 is provided with a pair of longitudinally restricting surfaces 793d extending from a pair of sliding surfaces 793b in the direction D701 so as to approach each other and facing the direction of the arrow E70.

Next, the assembling of the urging mechanism 790 will be described.

First, the projecting member 791 is assembled to the restricting member 793. The projecting member 791 is arranged so that the restricted surface 791b faces the restricting surface 793a of the restricting member 793. At this time, the projecting member 791 is in a state that the slide surface 791c is supported by the sliding surface 793b so as to be movable in the movable direction D700.

Next, the elastic member 792 is provided in a compressed state between the spring seat 791d of the projecting member 791 and the spring seat 793c of the restricting member 793. As a result, the projecting member 791 is urged against the restricting member 793 in the direction of the arrow E72. Due to this urging force, the restricted surface 791b of the projecting member 791 abuts against the restricting surface 793a of the restricting member 793, and the projecting portion 791a protrudes beyond the gap S70 in the direction of arrow E72.

Next, the restricting member 793 to which the projecting member 791 and the elastic member 792 are assembled is assembled to the driving-side development side member 726. The restricting member 793 is fixed to the driving-side development side member 726 by adhesion or the like in a state that it abuts against the restricting surface 726a1 of the positioning portion 726a of the driving-side development side member 726. As a result, the movement of the projecting member 791 in the longitudinal direction is restricted by the restricting surface 726a1 of the driving-side development side member 726 and by the longitudinally restricting surface 793d of the restricting member 793.

With this structure, the projecting member 791 is supported so as to be movable in the movable direction D700 while being urged in the direction of the arrow E72 relative to the developing unit 720.

Next, referring to FIG. 76, the positioning of the projecting portion 791a of the projecting member 791 relative to the cartridge B will be described.

Although details will be described hereinafter, the projecting portion 791a is an engagement portion, i.e., a tooth (gear tooth), which is capable of meshing engagement with the gear portion 81a of the drive transmission member 81, similarly to the gear portion 30a of the developing roller gear 30 in Embodiment 1. In other words, the preferred arrangement of the projecting portion 791a corresponds to the preferred arrangement of the teeth of the gear 30a. For example, the projecting portion 791a is arranged on the drive side of the cartridge, and at least the part of the projecting portion 791a capable of meshing with the gear portion 81a of the drive transmission member 81 is exposed toward the outside of the cartridge. More specifically, the exposed portion of the projecting portion 791a faces the axis Ax1 of the drum 62 (see part (a) of FIG. 75 and part (b) of FIG. 76).

The projecting member 791 is a movable member, but when considering a suitable arrangement of the projecting portion 791a, it is easy to understand to consider the position at which the projecting portion 791a meshes with the gear portion 81a of the drive transmission member 81 as a reference. In this embodiment, it is easy to understand to assume that the projecting member 791 is in its initial position before the cartridge is mounted in the apparatus main assembly.

In the following, the matters specific to the projecting member 791 will be particularly described in detail. FIG. 76 is an illustration showing the arrangement of the projecting portion 791a relative to the cartridge B. Part (a) of FIG. 76 is an illustration of the cartridge B as viewed in a direction perpendicular to the longitudinal direction, and part (b) of FIG. 76 is a cross-sectional view taken along a line X700-X700 of part (a) of FIG. 76. In FIG. 76, members not necessary for the explanation are not shown. In addition to the arrangement in this embodiment, the projecting member 791 in part (b) of FIG. 76 is also illustrated in a state in which an angle K70 described hereinafter is arranged in a positive and negative direction for the sake of explanation, with the positive angle indicated as angle K70U and the negative angle indicated as an angle K70L.

As shown in part (a) of FIG. 76, in the longitudinal direction D703, at least a part of the projecting portion 791a is placed in a downstream side, in the direction of arrow E71, of the free end portion 263b1 of the driving side drum flange 263, and is disposed so as to be 4 to 12 mm from the free end portion 263b1 to the driving side. The above range may be selected to be larger depending on the structure of the driving side drum flange 263 and on the structure of the main assembly of the image forming apparatus A to which it is applied.

At least a part of the projecting portion 791a is placed on the longitudinally outside of the free end portion 263b1. At least a part of the projecting portion 791a is placed so as to be farther away from the non-driving side of the cartridge B than the free end portion 263b1.

As shown in part (b) of FIG. 76, a distance measured from the rotational axis Ax1 of the drum 62 to the free end portion of the projecting portion 791a along a movable direction E73 is referred to as a distance L70. The movable direction E73 is also the direction of a line extending from the axis Ax1 to the projecting portion 791a in a direction perpendicular to the axis Ax1. Therefore, the distance L70 corresponds to the distance measured from the axis Ax1 to the projecting portion 791a in a direction perpendicular to the axis Ax1.

At this time, the distance L70 is determined so as to be in the range of 90% to 120% of the radius of the drum 62, more preferably 90% to 110%, as in Embodiment 1. More preferably, it is 93% to 107%. In this embodiment, the distance L70 is 95.8% (11.5 mm).

Also, a straight line extending from the rotational axis Ax1 of the drum 62 and passing through the rotational axis Ax2 of the developing roller 32 is used as a reference line, and the angle between the movable direction E73 and this reference line is referred to as angle K70.

In this embodiment, the angle between the line extending from the drum Ax1 to the tip of the engaging portion 791a, i.e., passing through the teeth of the engaging portion 791a, and the reference line may be deemed as being K70.

The positive direction of the angle is the downstream direction of the rotation of the drum 62. In other words, the angle K70 is positive on the downstream side in the direction of arrow R, which is the rotational direction of the drum 62, and is negative on the upstream side in the direction of arrow R. In this case, it is preferable that the projecting portion 791a is disposed such that the angle K70 is in the range of −75° to 50°, similarly to the angles K20 and K21 (see part (b) of FIG. 29) in Embodiment 2.

The more preferable ranges for the upper and lower limits of the angle K70 in this embodiment are the same as those having been described for the angle K20 and the angle K21.

In particular, in this embodiment, when applied to the main assembly of the image forming apparatus A, the angle K70 is set in the range of −50° or more and 30° or less due to the structural constraints of the driving side plate 15. The preferable ranges of the angle K70 and the distance L70 described above are determined by the relationship with the main assembly of the image forming apparatus A to which this embodiment is applied, as in Embodiment 2. The structural constraints of the driving side plate 15 will be described hereinafter.

In this embodiment, the projecting portion 791a is provided on the driving-side development side member 726, which is a part of the developing unit 320, but may be provided on a part of the cleaning unit 260 depending on the settings of the angle K70 and the distance L70.

### <Operation of Urging Mechanism>

Next, referring to FIG. 77, operation of the urging mechanism 790 will be described.

FIG. 77 is an operation illustration of the urging mechanism 790 and is a cross-sectional view taken along a line X701-X701 of part (a) of FIG. 76. Part (a) of FIG. 77 shows the projecting position of the projecting member 791, and part (b) of FIG. 77 shows the retracted position of the projecting member 791.

As shown in part (a) of FIG. 77, in the projecting position, the projecting member 791 projects in the direction of the arrow E72 along the movable direction D700. The projecting position of the projecting member 791 may be called an initial position, an engaged position, a pre-movement position, an action position, or the like.

When the projecting member 791 is pushed, from this state, in the direction of the arrow E73 along the movable direction D700 against a force F70, it is moved to the retracted position of the projecting member 791 shown in part (b) of FIG. 77. The retracted position of the projecting member 791 may be called a non-engaged position, a non-projecting position, a post-movement position, or the like. In this embodiment, the member for pushing the projecting member is the cylindrical portion 81m of the drive transmission member 81 (see part (a) of FIG. 31).

When the pushing of the projecting member 791 is dismounted from this state, the projecting member 791 moves to the protruding position shown in part (a) of FIG. 77 by the force F70 from the elastic member 792. In the initial state where no external force is applied to the projecting member 791 from outside the cartridge, the projecting member 791 is in the projecting position. As will be described hereinafter in detail, the projecting member 791 is a projecting engagement portion structured to engage with a gear outside the cartridge, that is, to mesh with the gear portion 81a of the drive transmission member 81.

The projecting member 791 is placed on the driving side of the cartridge. That is, in the axial direction of the drum 62, the coupling (coupling projection 263a) and the projecting member 791 are placed on the same side of the cartridge.

### <Mounting of Cartridge to Main Assembly of Image Forming Apparatus>

Next, referring to FIG. 78, the operation of mounting the cartridge B to the main assembly of the image forming apparatus A in this embodiment will be described. FIG. 78 is cross-sectional views showing the mounting operation of the cartridge B to the main assembly of the image forming apparatus A, taken along a line X701-X701 of part (a) of FIG. 76. Also, part (a) of FIG. 78 shows the state before the cartridge is mounted, and part (b) of FIG. 78 shows the state after the cartridge is mounted. Regarding the operation of the cartridge B when it is mounted in the main assembly of the image forming apparatus A, the description will be omitted for the matters which are the same as those of Embodiment 2 will be omitted.

As shown in part (a) of FIG. 78, when the cartridge B is in a state immediately before being mounted in the main assembly of the image forming apparatus A, the projecting member 791 is in the projecting position. Also, the projecting portion 791a of the projecting member 791 is immediately before abutting against the gear portion 81a of the drive transmission member 81.

When cartridge B moves from here in the mounting direction C, it goes through a mounting process similar to that of Embodiment 2 to reach the state after the cartridge B is mounted as shown in part (b) of FIG. 78.

When cartridge B is in the mounted state, the projecting portion 791a is placed between the gear teeth of the gear portion 81a of the drive transmission member 81. That is, the projecting portion 791a acts as a gear tooth and meshes with the gear portion 81a.

<Engagement with Drive Transmission Member>

Referring to FIGS. 79 to 81, the engagement between the drive transmission member 81 and the projecting member 791 will be described.

FIG. 79 is cross-sectional views showing the movement of the gear portion 81a when the drive transmission member 81 is driven, taken along a line X701-X701 of part (a) of FIG. 76. Also, part (a) of FIG. 79 shows the state immediately after driving, and part (b) of FIG. 79 shows the state immediately after driving and the gear part 81a has moved. FIG. 80 is sectional views showing the longitudinal movement of the gear portion 81a when the drive transmission member 81 is driven, and the Figure is taken along a line X702-X702 of in part (b) of FIG. 79. Part (a) of FIG. 80 shows the state in which the drive transmission member 81 is aligned with the rotational axis Ax1 of the drum 62, part (b) of FIG. 80 shows the state in which the coupling projection 263b of the driving side drum flange 263 has entered the coupling recess 81b, and part (c) of FIG. 80 shows the state in which the coupling engagement is completed. For the sake of better illustration, FIG. 80 does not show the gear portion 81a of the drive transmission member 81. FIG. 81 is a cross-sectional view showing the state in which the coupling engagement is completed, taken along a line X701-X701 in part (a) of FIG. 76. Regarding the engagement operation with the drive transmission member 81, the description will be omitted for the matters which are the same as with Embodiment 2.

As shown in part (a) of FIG. 79, when the drive transmission member 81 rotates in the rotational direction CW, as in Embodiment 2, the engagement between the projecting portion 791a and the gear portion 81a causes a reaction force FD70 corresponding to the engaging force FD1, in the gear portion 81a. In the drive transmission member 81, the gear portion 81a is moved by the FD70, and the rotational axis Ax3 moves in a direction of aligning with the rotational axis Ax1 of the drum 62. Then, as shown in part (b) of FIG. 79, the gear portion 81a abuts against the restricting portion 73j (see FIG. 74), and in the direction perpendicular to the longitudinal direction, the coupling recess 81b and the coupling projection 63b are substantially in coaxial positions where they can be engaged with each other. Here, the force F70 by the elastic member 792 that urges the projecting member 791 is sufficiently large, as compared to a force FD1a of the movable direction (D700) component of the engaging force FD1. Therefore, the projecting member 791 maintains its projecting position.

The gear portion 81a of the drive transmission member 81 has helical teeth, and therefore, as shown in part (a) of FIG. 80, by engaging with the stationary protruding portion 791a, a force FA (thrust force) in the axial direction (longitudinal direction) is produced. The force FA causes the drive transmission member 81 to move in the direction of the arrow DW3, which is the non-driving side in the longitudinal direction, thereby bringing it into contact to the coupling projection 263b.

The drive transmission member 81 rotates further, and as shown in part (b) of FIG. 80, the coupling projection 63b begins to engage with the coupling recess 81b. At this time, the inclined surface 791a1 of the projecting portion 791a abuts against the corner 81m1, which is an end, in the direction of the arrow DW3, of the cylindrical portion 81m of the drive transmission member 81.

Similarly to Embodiment 1, a thrust force FC is produced in the drive transmission member 81 by the engagement between the coupling projection 263b and the coupling recess 81b. This thrust force FC causes the inclined surface 791a1 to receive a force FC70 from the corner 81m1. The projecting member 791 receives a force F71, which is a component force in the direction of the arrow E73 along the movable direction D700 of the force FC70, on the inclined surface 791a1. The force F71 causes the projecting member 791 to move in the direction of the arrow E73 against the force F70 of the elastic member 792. That is, the projecting member 791 begin moving from the projecting position toward the retracted position. This movement of the projecting member 791 increases the distance from the axis Ax1 of the drum to the projecting portion 791a.

Then, as shown in part (c) of FIG. 80, when the drive transmission member 81 moves in the longitudinal direction to a position where the coupling recess 81b and the coupling projection 263b abut, the free end portion of the projecting portion 791a abuts against the cylindrical portion 81m. That is, as shown in FIG. 81, the projecting member 791 abuts against the cylindrical portion 81m of the drive transmission member 81 in the movable direction D700, and maintains the retracted position where the engagement between the projecting portion 791a and the gear portion 81a is released. This avoids interference between the projecting member 791 and the gear portion 81a.

The above-described coupling engagement operation enables the urging mechanism 790 to engage the coupling recess 81b of the drive transmission member 81 with the coupling projection 263b of the driving side drum flange 263.

As measured along a direction perpendicular to the axis Ax1 of the drum 62, the distance from the axis Ax1 to the projecting member 791 is shorter when the projecting member 791 is in the projecting position than when the projecting member 791 is in the retracted position. In other words, the projecting member 791 moves away from the axis Ax1 by moving from the projecting position to the retracted position. The projecting member 791 is movable at least in the radial direction of the drum 62. In other words, the projecting member 791 is a movable member which can move so as to change the distance from the axis Ax1 to the projecting portion 791a.

As described above, the projecting member 791 needs to fit into between the teeth of the gear portion 81a. Therefore, the thickness of such a part of the projecting member 791 that engages with the gear portion 81a is preferably 0.1 mm or more and 2 mm or less. Although it depends on the size of the gear portion 81a, if the thickness of the projecting member 791 exceeds 2 mm, it may exceed the size of the gap between the teeth of the gear portion 81a, with the result that the projecting member 791 may not be able to enter the gap between the teeth of the gear portion 81a. In order to assure the strength of the projecting member 791, it is preferable that the thickness thereof is 0.1 mm or more.

Here, the thickness of the projecting member 791 is the length measured in the circumferential direction of the gear portion 81a. In this embodiment, the length of the projecting member 791 measured in the direction perpendicular to the movable direction D700 in FIG. 81 which is a view of the cartridge as seen along the axis Ax1 of the drum, is the thickness of the projecting member 791. The thickness of the projecting member 791 corresponds to the tooth thickness when the projecting member 791 is deemed as a gear tooth.

Next, referring to FIG. 82, for the preferable range of angle K70, the description will be made as to the constraints imposed by the structure of the driving side plate 15 of the main assembly of the image forming apparatus A to which the present embodiment is applied.

FIG. 82 illustrates the structural constraints of the driving side plate 15 for angle K70. Part (a) of FIG. 82 is a view as seen in the mounting direction C along the direction perpendicular to the longitudinal direction, and part (b) of FIG. 82 is a sectional view taken along a line X700-X700 of part (a) of FIG. 76. FIG. 82 also illustrates the position where the drive transmission member 81 is engaged. Here, for the sake of better illustration, some members and shapes are not shown in FIG. 82.

As shown in part (a) of FIG. 82, the driving side plate 15 of the main assembly of the image forming apparatus A in this embodiment is provided with a recess 150 which is partially recessed toward the drive side direction in the longitudinal direction. The recess 150 is provided in each embodiment so that a member acting on the gear portion 81a (such as the developing roller gear 30 in Embodiment 1 and the rack gear 291 in Embodiment 2) can access the gear portion 81a.

When the coupling is completely engaged, the cylindrical portion 81m of the drive transmission member 81 protrudes toward the cartridge side (the arrow E70 side) beyond the driving side plate 15 within the range of the recess 150 and is exposed outward radially with respect to the rotational axis Ax3. As described above, when the coupling is engaged, the projecting member 791 has to abut against the cylindrical portion 81m. In other words, the projecting member 791 has to be positioned within the recess 150 so that it can abut against the cylindrical portion 81m exposed on the cartridge side.

As shown in part (b) of FIG. 82, in the rotational direction CW, the cylindrical portion 81m exposed on the cartridge side is an exposed portion 81m2, a downstream end of the exposed portion 81m2 is a downstream end 81m2D, and an upstream end is an upstream end 81m2U, and the downstream side in the rotational direction CW is a positive direction based on the gravity direction DZ1. In this case, the recess 150 in this embodiment is structured such that an angle of a direction D704D connecting the rotational axis Ax3 and the downstream end 81m2D is 0°, and an angle of a direction D704U connecting the rotational axis Ax3 and the upstream end 81m2U is 80°.

Therefore, in this embodiment, in order for the projecting portion 791a to abut against the exposed portion 81m2 in the above-described range, the angle K70 is selected to be −50° to 30° based on the direction connecting the rotational axis Ax1 of the drum 62 and the rotational axis Ax2 of the developing roller 32.

In this embodiment, the number of the teeth on the cartridge side for engagement with the drive transmission member 81 is reduced, which provides the advantage of making it easier to simplify the structure of the cartridge B.

### Modified Example 1 of Embodiment 7

Next, referring to FIGS. 83 to 93, a first modification in which the structure disclosed in this embodiment is partially modified will be described in the following. In particular, among the elements disclosed in this modification, those that correspond to the members described in the above-described embodiments will be assigned the same names as the members in the above-described embodiment, and only the different points will be described.

For the sake of description, the above-described structure will be referred to as a representative example of Embodiment 7, and the structure shown in the following will be referred to as the first modification of Embodiment 7.

Referring to FIGS. 83 and 84, the structure of a driving-side developing side member 7126 (hereinafter referred to as the side member 7126) of this modification will be described. FIG. 83 is a perspective view of a cartridge B. FIG. 84 is an exploded perspective view of the side member 7126.

As shown in FIG. 83, the side member 7126 is mounted to the cartridge B.

### <Description of Directions>

As shown in FIG. 84, the side member 7126 is attached with a projecting member 7152, a parallel pin 7153, a compression spring 7154, and a torsion coil spring 7155. The components will be described. The projecting member 7152 is a lever-shaped or arm-shaped movable member (lever member, arm member) and is provided on the side of the drive side of the cartridge B.

The side member 7126 is provided with a cylindrical portion 7126f.

For the sake of explanation, the axis of the cylindrical portion 7126f is referred to as a Y axis. With respect to the Y axis, the side where the photosensitive drum 62 exists as viewed from the cylindrical portion 7126f is referred to as a Y711 direction as shown in FIG. 84. The opposite direction to the Y711 direction described above is a Y712 direction shown in FIG. 84. An axis parallel to the rotational axis of the photosensitive drum 62 is the Z axis, and a direction toward the drive input side of the photosensitive drum 62 is a Z1 direction as shown in FIG. 84. The opposite direction to the Z1 direction described above is a Z2 direction as shown in FIG. 84. A direction perpendicular to the Y axis and the Z axis is referred to as a X axis. With respect to the X axis, the side where the developing roller 32 exists as viewed from the cylindrical portion 7126f is an X711 direction as shown in FIG. 84. The opposite direction to the X711 direction described above is a X712 direction as shown in FIG. 84.

A clockwise direction around the axis of the cylindrical portion 7126f as viewed in the Y712 direction is referred to as a rotational direction G72, and the opposite direction is referred to as a rotational direction G71.

### <Explanation of Components of Projection Member>

As shown in FIG. 84, through holes 7126g and 7126h are provided coaxially on the Z1 side of the cylindrical portion 7126f of the side member 7126, which are parallel to the axial direction of the cylindrical portion 7126f. A surface on which the through hole 7126g is provided and faces in the Y712 direction is an abutment surface 7126m. The X711 side of the cylindrical portion 7126f is provided with a surface 7126n facing the Z2 direction.

The projection member 7152 is provided with a base plate portion 7152a extending in the X-axis direction. An end, in the X712 direction, of the base plate portion 7152a is provided with a through hole 7152b in the Y-axis direction, and the opposite end is provided with a projecting portion 7152c extending from the base plate portion 7152a in the Y711 direction.

The parallel pin 7153 has a cylindrical shape extending in the Y-axis direction, and the diameter thereof is slightly larger than the diameter of the through holes 7126g, 7126h of side member 7126, and slightly smaller than the diameter of the through hole 7152b of projection member 7152.

The torsion coil spring 7155, as an example of an elastic member or spring, has a torsion spring portion 7155a closely contacted in a cylindrical shape having an axis parallel to the Y-axis. An inner diameter of torsion spring portion 7155a is sufficiently larger than the diameter of the cylindrical portion 7126f of side member 7126. A first hook portion 7155b extends in the Y712 direction from the Y712 direction end surface of torsion spring portion 7155a.

Also, a second hook portion 7155c is provided on the Y711 end surface of the torsion spring portion 7155a, extending in the axially outward direction. After extending in the axially outward direction, the second hook portion 7155c is bent in the Y711 direction, which is a direction perpendicular to the axially outward direction, and then further extends.

The compression spring 7154, which is an example of an elastic member or spring, extends in the Y-axis direction, and has an inner diameter sufficiently larger than the diameter of the parallel pin 7153.

Although the details will be described hereinafter, the projecting portion 7152c placed at a free end portion of the projection member 7152 is a projecting engagement portion configured to engage with a helical gear existing outside of the cartridge, i.e., to make meshing with the gear portion 81a of the drive transmission member 81. The projecting portion 7152c can also be considered as one tooth (gear tooth) configured to mesh with an external gear (i.e., the gear portion 81a of the drive transmission member 81).

The projecting member 7152 is disposed on the driving side of the cartridge in the axial direction of the drum 62. That is, in the axial direction of the drum 62, the coupling portion (coupling projection 263b) and the projecting member 7152 are disposed on the same side of the cartridge.

### <Lock Structure>

Next, a lock structure will be explained using FIGS. 85 and 86.

FIG. 85 is an exploded perspective view of the lock.

Part (a) of FIG. 86 is a side view of the side member 7126, and part (b) of FIG. 86 is a sectional view taken along a line S71b-S71b of part (a) of FIG. 86.

As shown in FIG. 85, to the side member 7126, mounted is a locking member (lock) 7156 on the Z2 direction side, a lock retainer 7157, a tension spring 7158 as an example of an elastic member or spring, and a lever pressing member 7159.

As shown in FIG. 85 and part (b) of FIG. 86, the side member 7126 is provided with a groove portion 7126k extending in the X-axis direction and recessed in the Z2 direction. A second groove portion 7126s wider than the groove portion 7126k is provided on a portion of the X711 direction side of the groove portion 7126k. A groove recess 7126t and a recess 7126r having the same width as the second groove portion 7126s but shallower (smaller recession in the Z2 direction) than the groove portion 7126k are provided on the X712 direction end of the second groove portion 7126s and on a part of the groove portion 7126k.

As shown in part (b) of FIG. 86, a second recess 7126h recessed in the Z1 direction is further provided on the groove portion 7126k on the X712 direction side of the recess 7126r. An inclined surface 7126h1 is provided at a X712 direction end of the second recess 7126h.

As shown in FIG. 85, the locking member 7156 has a rod shape extending in the X-axis direction. The locking member 7156 has, in the order from the X712 end, a first rod portion 7156r parallel to the X-axis, a second rod portion 7156s extending in the Z2 direction from the X711 end of the first rod portion 7156r, and a third rod portion 7156t extending in the X711 direction from a Z2 direction end of the second rod portion 7156s.

The width measured in the Y-axis direction of the locking member 7156 is slightly smaller than the width measured in the Y-axis direction of the groove portion 7126k of the side member 7126.

The first rod portion 7156r is further provided, in order from the X712 end, with a locking portion 7156a projecting in the Z2 direction, an inclined projection 7156b protruding in the Z2 direction, and a groove portion 7156c recessed in the Z2 direction. The X712 side of the inclined projection 7156b is provided with an inclined surface 7156b1 which advances in the Z1 direction as it advances in the X712 direction.

The third rod 7156t is provided with a spring hook portion 7156e projecting in the Z1 direction. A surface of the spring hook portion 7156e on the X711 side is an abutment surface 7156g. The X711 direction end of the third rod 7156t is provided with an end surface 7156f.

Although the details will be described hereinafter, the locking member 7156 is configured to lock the movement of the projecting member 7152.

The lock retainer 7157 has a flat plate shape extending in the X-axis direction. The lock retainer 7157 is provided, in the order from the X712-direction end, with a first flat plate portion 7157r parallel to the X-axis, a second flat plate portion 7157s extending in the Z2 direction from the X711-direction end of the first flat plate portion 7157r, and a third flat plate portion 7157t extending in the X711 direction from the Z2-direction end of the second flat plate portion 7157s.

The second flat plate portion 7157s is provided with a through hole 7157a extending in the Z2 direction from the first flat plate portion 7157r and penetrating in the X-axis direction.

The third flat plate portion 7157t is provided with a through hole 7157c extending in the X-axis direction and penetrating in the Z direction. The through hole 7157c is connected to the through hole 7157a at its X712 end. The X711 direction end of the through hole 7157c is an abutment surface 7157f.

A cylindrical spring hook 7157e having a hook shape protruding in the Z1 direction is provided at the X711 direction end of the third flat plate portion 7157t.

### <Method of Assembling Projection Member>

Next, referring to FIGS. 84 and 87, the assembly of the projection member 7152 will be explained.

Part (a) of FIG. 87 and part (b) of FIG. 87 are partial perspective views of the side member 7126 and the projection member 7152 as viewed in different directions.

As shown in FIG. 84 and part (a) of FIG. 87, the parallel pin 7153 is held in a press-fitted state in the through holes 7126g and 7126h of the side member 7126 while penetrating the compression spring 7154 and the through hole 7152b of the projecting member 7152. At this time, as shown in part (a) of FIG. 87, the compression spring 7154 is attached in a state in which one end on the Y712 direction side is abutted against the side member 7126 and the other end is compressed in the Y712 direction by the base plate part 7152a of the projecting member 7152. Therefore, the projecting member 7152 receives an urging force in the Y711 direction from the compression spring 7154 and is supported in a state in which it abuts against the abutment surface 7126m of the side member 7126 in the Y711 direction. Furthermore, the projecting member 7152 is supported by the parallel pin 7153 so as to be rotatable about the through hole 7152b.

Next, the torsion spring portion 7155a of the torsion coil spring 7155 is fitted, in the Y712 direction, abound the cylindrical portion 7126f of the side the member 7126. As shown in part (a) of FIG. 87, the first hook portion 7155b, which is one end of the torsion coil spring 7155, is mounted to the side member 7126. As shown in part (b) of FIG. 87, the hook portion 7155c at the end opposite the first hook portion 7155b is abutted against the base plate portion 7152a of the projecting member 7152, and is mounted while deforming the hook portion 7155c in a G72 direction. Therefore, the projecting member 7152 receives an urging force from the torsion coil spring 7155 in the rotational direction G71 about the cylindrical portion 7126f, and is held in a state in which the base plate portion 7152a abuts against the surface 7126n of the side member 7126.

### <Assembling of Locking Member>

Next, referring to FIGS. 85 and 88, the assembling of the locking member 7156 will be explained.

Part (a) of FIG. 88 is a side view of the cartridge B with the locking member 7156 mounted, and part (b) of FIG. 88 is a sectional view taken along a line S71a-S71a in part (a) of FIG. 88.

The locking member 7156 is fitted in the groove portion 7126k of the side member 7126 in the Z2 direction. At this time, as shown in FIG. 85 and part (b) of FIG. 88, the inclined projection 7156b of the locking member 7156 is fitted into the second recess 7126h provided on the groove portion 7126k.

Furthermore, the lock retainer 7157 is attached in the Z2 direction so that the locking member 7156 penetrates the through hole 7157c. As shown in part (a) of FIG. 88, the first flat plate portion 7157r of the lock retainer 7157 is attached by adhesive or the like to the groove recess 7126t of the side member 7126, and the third flat plate portion 7157t is attached by adhesive or the like to the second groove portion 7126s.

Also, as shown in part (a) of FIG. 88, the groove portion 7156c overlaps with the recess 7126r in the X-axis direction, and a lever pressing member 7159 is attached by adhesive or the like to the recess 7126r of the side member 7126.

Thus, as shown in part (b) of FIG. 88, the movement of the locking member 7156 in the Z-axis direction is restricted by the first flat plate portion 7157r and the lever pressing member 7159 of the lock retainer 7157, and the locking member 7156 is supported so as to be movable in the X711 and X712 directions.

As shown in part (b) of FIG. 88, the opposite end portions of the tension spring 7158 are attached to the spring hook portion 7156e of the locking member 7156 passing through the through hole 7157c, and to the spring hook portion 7157e of the lock retainer 7157, respectively. The locking member 7156 is urged in the direction of the arrow X711 by the urging force of the tension spring 7158, and is held in a state in which the abutment surface 7156g abuts the abutment surface 7157f of the lock retainer 7157.

Here, as shown in part (b) of FIG. 88, the end surface 7156f, which is the end surface in the X711 direction of the locking member 7156, projects in the X711 direction beyond the outer shape of the cartridge B.

### <Mounting of Projecting Member to Locking Member>

Next, referring to FIG. 89, the mounting of the projecting member 7152 to the locking member 7156 will be described.

Part (a) of FIG. 89 is a perspective view of the projection member 7152 before the locking member 7156 is mounted, and part (b) of FIG. 89 is a perspective view after mounting.

As described above, the projection member 7152 is urged in the direction of an arrow G71 by the urging force of the torsion coil spring 7155.

As shown in part (a) of FIG. 89, the locking member 7156 is mounted to the side member 7126, with the projection member 7152 mounted to the side member 7126. Then, the locking portion 7156a of the locking member 7156 abuts against the base portion 7152a of the projection member 7152 in the Z-axis direction, and pushes the projection member 7152 against the urging force of the torsion coil spring 7155, which is an example of an elastic member or spring, thereby rotating the projection member 7152 in the direction of arrow G72.

Next, as shown in part (b) of FIG. 89, the projecting member 7152 is pushed in the Y712 direction against the urging force of the compression spring 7154. The projecting member 7152 slips into the Y712 direction side of the locking portion 7156a of the locking member 7156, and is abutted against the surface 7126n of the side member 7126 by the urging force of the torsion coil spring 7155 in the G71 direction.

Thereafter, as shown in part (b) of FIG. 89, the base portion 7152a of the projecting member 7152 abuts against the locking portion 7156a of the locking member 7156 in the Y-axis direction. In this way, the projecting member 7152 is attached to the locking member 7156.

### <Mechanism of Locking Member>

Next, referring to FIG. 90, the operation of the locking member 7156 will be described. Part (a) of FIG. 90 and part (b) of FIG. 90 are sectional views and perspective views at the same position as part (b) of FIG. 88 showing the state of the locking member 7156 before it moves, and part (c) of FIG. 90 and part (d) of FIG. 90 are a sectional view and a perspective view showing the state of locking member 7156 while it is moving.

Part (a) of FIG. 90 and part (b) of FIG. 90 show the state in which the locking member 7156 is in the locked position. From this state, the end surface 7156f of locking member 7156 is pushed in the X712 direction. Then, as shown in part (c) of FIG. 90, the inclined surface 7156b1 of inclined projection 7156b abuts against inclined surface 7126h1 of side member 7126 and moves in a direction of arrow X712 while riding on it in the Z1 direction. At this time, as shown in part (c) of FIG. 90, the locking member 7156 deforms with the contact point with the lever pressing member 7159 as a fulcrum, and as the inclined projection 7156b moves in the Z1 direction, the locking portion 7156a moves in the Z1 direction. This shows that the locking member 7156 has moved to the unlocked position.

When the locking portion 7156a moves in the Z1 direction and reaches the unlocked position, as shown in part (d) of FIG. 90, the contact with the base plate portion 7152a of the projection member 7152 is broken. Then, the locking member 7156 is moved by the urging force of the compression spring 7154 in the Y711 direction, and the base plate portion 7152a abuts against the abutment surface 7126m of the side member 7126.

### <Operation of Locking Member>

The operation of the locking member 7156 will be explained using FIG. 91.

FIG. 91 is cross-sectional views of the image forming apparatus A taken along an XY plane, showing the operation of the locking member 7156, wherein part (a) of FIG. 91 shows the state before the opening/closing door 13 is closed, and part (b) of FIG. 91 shows the state after the opening/closing door 13 is closed.

As shown in part (a) of FIG. 91, the opening/closing door 13 is provided with a cartridge pressing member 1. The cartridge pressing member 1 is disposed in a position opposing and in contact with an end surface 7156f of the locking member 7156, in the state that the opening/closing door 13 is closed.

As shown in part (a) of FIG. 91 and part (b) of FIG. 91, the end surface 7156f of the locking member 7156 abuts against the cartridge pressing member 1 by the operation of closing the opening/closing door 13, and is pushed in the X712 direction from a projecting state projecting beyond the outer shape of the cartridge B. In this way, the locking member 7156 moves from the locked position to the unlocked position. Then, the state shown in part (a) of FIG. 90 and part (b) of FIG. 90 changes to a state in which the engagement between the locking member 7156 and the projecting member 7152 is broken as shown in part (c) of FIG. 90 and part (d) of FIG. 90.

In other words, by the opening/closing door 13 being moved to the closed position, the locking member 7156 is moved from a locked position, in which the movement of the projecting member 7152 is prevented, to an unlocked position, in which the movement of the projecting member 7152 is not prevented. The end surface 7156f of the locking member 7156 is an operating part which is operated by the opening and closing operation of the opening/closing door 13. By operating the end surface 7156f, the locking member is switched between the locked state (operated state) and the unlocked state (non-operated state, standby state)

### <Large Gear Operation>

Referring to FIGS. 92 and 93, the engagement operation of the projecting member 7152 with the drive transmission member 81 will be explained.

Part (a) of FIG. 92, part (d) of FIG. 92, part (g) of FIG. 92, and part (j) of FIG. 92 are side views of the projecting member 7152 and the drive transmission member 81 as viewed in the Z2 direction. Part (b) of FIGS. 92, part (e) of FIG. 92, part (h) of FIG. 92, and part (k) of FIG. 92 are side views as viewed in the X712 direction. Part (c) of FIGS. 92, part (f) of FIG. 92, part (i) of FIG. 92, and part (1) of FIG. 92 are sectional views taken along YZ plane through the axis of the photosensitive drum 62.

Furthermore, part (a) of FIG. 92, part (b) of FIG. 92, and part (c) of FIG. 92 show the state when the opening/closing door 13 is open. Part (d) of FIG. 92, part (e) of FIG. 92, and part (f) of FIG. 92 show the state when the opening/closing door 13 is closed. Part (g) of FIG. 92, part (h) of FIG. 92, and part (i) of FIG. 92 show the state when the drive transmission member 81 starts to operate. Part (j) of FIG. 92, part (k) of FIG. 92, and part (1) of FIG. 92 show the state when the projecting member 7152 has completed its movement.

Part (a) of FIG. 93 is a side view of the state of part (h) of FIG. 92 as seen in the Y711 direction, and part (b) of FIG. 93 is an enlarged view of the circled portion of part (a) of FIG. 93.

The engaging operation with the drive transmission member 81 is similar to that of Embodiment 7, and therefore the description of the common matters will be omitted.

As shown in part (a) of FIG. 92, part (b) of FIG. 92, and part (c) of FIG. 92, when the opening/closing door 13 is open, the projecting member 7152 of the cartridge B is in a position where it does not contact the drive transmission member 81. This is because, as described above, the movement of the projecting member 7152 is locked by the locking member 7156 (see part (a) of FIG. 90 and part (b) of FIG. 90). The position of the projecting member 7152 at this time will be referred to as a first retracted position, a first non-engaged position, and so on.

As shown in part (d) of FIG. 92, part (e) of FIG. 92, and part (f) of FIG. 92, when the opening/closing door 13 is closed, the projection member 7152 moves in the G75 direction, so that the projecting portion 7152c abuts against the drive transmission member 81. This is because, as described above, the movement of the locking member 7156 to the unlocked position (see part (c) of FIG. 90 and part (d) of FIG. 90) allows the projection member 7152 to move. The projection member 7152 is moved by the elastic force of the compression spring 7154, which is an example of an elastic member or spring. The position of the projection member 7152 after it moves in the G75 direction will be referred to as the projecting position or the engaged position. The projection member 7152 is urged toward the projecting position (engaged position) by the compression spring 7154.

When projection member 7152 moves to the projecting position, the engagement portion of projecting member 7152, i.e., projecting portion 7152c which is a tooth, is capable of meshing engagement with gear portion 81a of drive transmission member 81.

Next, the drive transmission member 81 rotates in the direction of an arrow CW, causing the drive transmission member 81 to move in the same manner as in Embodiment 7, and the gear portion 81a comes into contact with the restricting portion 73j (see FIG. 85).

In other words, when the drive transmission member 81 rotates in the rotational direction CW, as shown in part (e) of FIG. 92, the meshing engagement of the projecting portion 7252c of the projection member 7152 with the gear portion 81a produces a reaction force FD711 of the engaging force FD710 in gear portion 81a, as in Embodiment 2. The gear portion 81a of the drive transmission member 81 is moved by the FD711, and the rotational axis Ax3 moves in a direction of coinciding with the rotational axis Ax1 of the drum 62. Then, the gear portion 81a abuts against the restricting portion 73j (see FIG. 85), and in a direction perpendicular to the Z-axis direction, the coupling recess 81b and the coupling projection 63b are in place where they are substantially coaxial and with each other can be engaged with each other. Here, an urging force F711 from the torsion coil spring 7155 which urges the projection member 7152 is sufficiently large as compared with a force FD710r of the Z-axis component of the engaging force FD710. Therefore, the projecting member 7152 is maintained at the protruding position by the elastic force of the torsion coil spring 7155.

The drive transmission member 81 is moved in the Z2 direction by the force produced by the helical teeth of the gear portion 81a, as in Embodiment 1, so that the coupling recess 81b of the drive transmission member 81 is brought into engagement with the coupling projection 63b of the driving side drum flange 63, as shown in part (i) of FIG. 92.

By the coupling engagement operation described above, as shown in part (g) of FIG. 92, part (h) of FIG. 92, and part (i) of FIG. 92, the projection member 7152 can engage the coupling recess 81b of the drive transmission member 81 with the coupling projection 63b of the driving side drum flange 63.

In this way, the drive transmission from the drive transmission member 81 to the driving side drum flange 63 is enabled.

### <Preferred Range>

Here, as described above, in order to move the drive transmission member 81, the preferred position of the projecting portion 7152c of the projection member 7152 is the same as the preferred position of the projecting portion 791a described as the main structure of Embodiment 7.

In other words, it is desirable to position the projecting portion 7152c so that the angle K70 (see part (b) of FIG. 76) falls within the preferred range described above. The projecting portion 791a in part (b) of FIG. 76 can be considered as corresponding to the projecting portion 7152c in this modified example. As described above, angle K70 is desirably between −75° and 50°. As described above, the more preferred values for the upper and lower limits of angle K70 are similar to those in the more preferred values for the upper and lower limits of angle K21 (see part (b) of FIG. 29).

In particular, in this modified example, the projecting portion 7152c is positioned so that K70 is between −50° and 30°.

As shown in part (a) of FIG. 93, the axis of the through hole 7152b of projection member 7152 is disposed on the Z1 direction side of an arrow G76, which has a line perpendicular to the torsion angle of the gear portion 81a, starting from the contact point between the gear portion 81a of drive transmission member 81 and projecting portion 7152c.

When drive transmission member 81 rotates in the direction of the arrow CW, the projecting portion 7152c of projection member 7152 receives a force F712, which is a force in the same direction as arrow G76, from gear portion 81a of drive transmission member 81. Here, as shown in part (b) of FIG. 93, force F712 is divided into component forces of a force F712a, which is a component force in the direction of a line connecting the contact point with the projecting portion 7152c to the center of the through hole 7152b, which is the center of rotation, and a force F712b, which is a component force in a direction perpendicular to the direction of the force F712a. The through hole 7152b is on the Z1 direction side with respect to force F711, the force F712b is a force in the Z2 direction, and therefore, the projection member 7152 receives a rotational force in the G72 direction, which is the rotational direction about the through hole 7152b.

In this way, the projection member 7152 rotates in the direction of arrow G72 about the through hole 7152b, and moves to a position where it does not interfere with gear portion 81a in the Z direction, as shown in part (j) of FIG. 92, part (k) of FIG. 92, and part (1) of FIG. 92.

In this state, the projection member 7152 is urged in the direction of the arrow G71 by the urging force of the torsion coil spring 7155. However, the projecting portion 7152c of projection member 7152 abuts against the end surface 81a1, which is the Z2 direction side end surface of drive transmission member 81. Therefore, the projection member 7152 cannot move any further in the G71 direction, and the projection member 7152 remains disengaged with the drive transmission member 81. The position of projection member 7152 at this time will be referred to as a second retracted position.

In addition, as shown in part (k) of FIG. 92, the projecting portion 7152c and end face 81a1 form an angle K711, so that only the free end portion of projecting portion 7152c is in contact with the end surface 81a1.

Furthermore, an amount of the projecting portion 7152c projecting from base plate portion 7152a is at least longer than the distance from the tooth bottom to the tooth free end portion position of the gear portion 81a of drive transmission member 81. Therefore, it is possible to stop the movement in the Y711 direction at a position where the base plate portion 7152a does not interfere with the gear portion 81a of the drive transmission member 81 (to configure such that the base plate portion 7152a abuts against the abutment surface 7126m of the side member 7126).

Furthermore, an amount of the movement of the projection member 7152 in the Y711 direction when moving from the position of part (b) of FIG. 90 to the position of part (d) of FIG. 90 is longer than at least the distance from the tooth bottom to the tooth tip position of the gear portion 81a of the drive transmission member 81. Therefore, in the state that the projection member 7152 has moved to a position in the Z direction where it does not interfere with the gear portion 81a, the free end portion of the projecting portion 7152c can be positioned inside the tooth bottom circle of the gear portion 81a of the drive transmission member 81, as shown in part (j) of FIG. 92. The projecting portion 7152c does not engage with the gear portion 81a in the rotational direction.

With the above-described structure, when the projection member 7152 moves to the second retracted position where it does not interfere with the gear portion 81a of the drive transmission member 81 in the Z direction, it does not engage again.

In this manner, in this embodiment, the projection member 7152 is movable to three positions, namely the first retracted position (see part (a) of FIG. 92 and part (b) of FIG. 92), the engaged position (see part (d) of FIG. 92 and part (e) of FIG. 92), and the second retracted position (see part (j) of FIG. 92 and part (k) of FIG. 92). These three positions may be referred to in any order as the first position, the second position, the third position, and so on. As will be described hereinafter, it is not necessary for the projection member 7152 to be able to take all of the three positions.

The projection member 7152 is locked by the locking member 7156 in the first retracted position (see part (a) of FIG. 92 and part (b) of FIG. 92). As a result, in the process of mounting the cartridge B to the main assembly A of the apparatus, the projection member 7152 is retracted to a position where it does not interfere with the mounting, which is preferable. However, it is not necessarily required to retract the projection member 7152 to the first retracted position in the process of mounting the cartridge B to the main assembly A of the apparatus. For example, if the projecting portion 7152c of the projection member 7152 is elastically deformable, even if the projecting portion 7152c hits the drive transmission member 81 in the process of mounting the cartridge B to the main assembly A of the apparatus, it is possible to deform the projecting portion 7152c, thereby permitting the cartridge B to be mounted.

When the opening/closing door 13 is closed and the locking by the locking member is released, the projection member 7152 moves from the first retracted position (see part (a) of FIG. 92 and part (b) of FIG. 92) to the engagement position (see part (d) of FIG. 92 and part (e) of FIG. 92), thus causing the free end portion thereof to project further beyond the frame of the cartridge. In addition, the projection member 7152 moves the free end portion closer to the axis Ax1 of the drum 62 by moving from the first retracted position (see part (a) of FIG. 92 and part (b) of FIG. 92) to the engagement position (see part (d) of FIG. 92 and part (e) of FIG. 92).

In other words, when the projection member 7152 is in the engagement position (see part (d) of FIG. 92 and part (e) of FIG. 92), the distance from the axis Ax1 to the projecting portion 7152c (see FIG. 84) at the free end portion of the projection member 7152, as measured along a direction perpendicular to the axis Ax1, is shorter than when the projection member 7152 is in the first retracted position (see part (a) of FIG. 92 and part (b) of FIG. 92). When the projection member 7152 moves between the engagement position (see part (d) of FIG. 92 and part (e) of FIG. 92) and the first retracted position (see part (a) of FIG. 92 and part (b) of FIG. 92), the projection member 7152 is displaced at least in the radial direction of the drum 62. In other words, the projection member 7152 is movable so as to change the distance from the axis Ax1 to the projecting portion 7152c.

When the projection member 7152 is in the engaged position, the projecting portion 7152c (see FIG. 84) is able to mesh with the gear portion 81a of the drive transmission member 81. At this time, the projecting portion 7152c acts as a gear tooth.

The projection member 7152 moves inward in the direction of the axis Ax1 of the drum 62 by moving from the engaged position (see part (d) of FIG. 92 and part (e) of FIG. 92) to the second retracted position (see part (j) of FIG. 92 and part (k) of FIG. 92). In other words, the distance from the non-driven side of the cartridge or the non-driven side end of the photosensitive drum to the projecting member 7152 measured along the direction parallel to the axis A1 is shorter when the projecting member 7152 is in the second retracted position (see part (j) of FIG. 92 and part (k) of FIG. 92) than when the projecting member 7152 is in the engagement position (see part (d) of FIG. 92 and part (e) of FIG. 92). When the projecting member 7152 moves between the engagement position (see part (d) of FIG. 92 and part (e) of FIG. 92) and the second retracted position (see part (j) of FIG. 92 and part (k) of FIG. 92), the projecting member 7152 is displaced at least in the axial direction of the drum 62.

### <Description of Dismounting>

When the cartridge B is dismounted from the image forming apparatus A, the projecting member 7152 is rotated in the direction of the arrow G71 by the urging force of the torsion coil spring 7155. As shown in part (a) of FIG. 89, the projection member 7152 is dismounted while it is in abutment to the locking member 7156 in the Z direction.

When the operator mounts the cartridge B again in the image forming apparatus A, the operator can push the projection member 7152 again in the Y711 direction to move it to the locking position as shown in part (b) of FIG. 89, part (c) of FIG. 90, and part (d) of FIG. 90, and then return the projection member 7152 to the state where it engages with the locking member 7156, thereby permitting the operation again.

### <Effects>

With the above-described structure, when the cartridge B is mounted in the image forming apparatus A, the projection member 7152 and the drive transmission member 81 do not come into contact with each other during the mounting operation, so that damage to the drive transmission member 81 which may otherwise be caused by the mounting operation can be reduced.

In this modified example, the locking member 7156 is structured to operate in conjunction with the closing operation of the opening/closing door 13, but it is also possible to adopt a structure in which the locking member 7156 is operated by, for example, the operator.

This modified example is an example of a shape with which the projecting member 7152 does not re-engage with the gear portion 81a of the drive transmission member 81 once it has moved in the Z-axis direction to a position where it does not interfere with the gear portion 81a. However, the shape of the projecting member 7152 is not limited to the above-described shape. For example, any shape that can achieve a similar effect, such as providing a surface which abuts to another location, may be used.

In this modification, the engaging projection 7291e at the free end portion of the engaging member 7291 is used as a tooth engaging with the gear portion 81a of the drive transmission member 81. Since the engaging member 7291 has an arm or lever shape, the engaging projection 7291c can move widely when the engaging member 7291 moves. Therefore, as shown in FIG. 92, there is an advantage that the engaging projection 7291c can be easily moved to a suitable position depending on the situation.

That is, when the cartridge B is mounted or after the drive transmission member 81 has completed connecting to the cartridge B, the engaging projection 7291c can be retracted to a position at which it does not cause a hindrance. On the other hand, it is also easy to move the engaging projection 7291c to a position where it engages with the drive transmission member 81 when necessary.

### Modified Example 2 of Embodiment 7

Next, referring to FIG. 94 to FIG. 101, a second modification in which the structure disclosed in this embodiment is partially modified will be described in the following. In particular, among the elements disclosed in this modification, those which correspond to the members described in the above-described embodiment are assigned the same names as the members in the above-described embodiment, and only the different points will be described.

First, referring to FIGS. 94 and 95, the cartridge structure of this modification will be described. FIG. 94 is a perspective view of the cartridge B. FIG. 95 is an exploded perspective view of a side member 7226. As shown in FIG. 94, the cartridge B in this embodiment comprises a cleaning unit 260 and a developing unit 7220. The developing unit 7220 includes a driving-side development side member 7226 (hereinafter referred to as side member 7226). Also, as shown in FIG. 95, an engaging mechanism 7290 is provided on the side member 7226.

### <Engagement Mechanism>

Next, referring to FIG. 96, the structure of the engaging mechanism 7290 will be described. Part (a) of FIG. 96 and part (b) of FIG. 96 are exploded perspective views of the engaging mechanism 7290 as viewed from different directions.

As shown in FIG. 96, the engaging mechanism 7290 comprises a side member 7226, an elastic member 7292, and an engaging member 7291. The development roller 7232 is mounted to the engaging mechanism 7290 in a Z1 direction. The components of the development roller 7232 and the engaging mechanism 7290 are described in the following.

The development roller 7232 has substantially the same shape as the developing roller 32 of Embodiment 1, and is provided at the Z1 direction end with a cylindrical core metal portion 7232a which projects in the Z1 direction coaxially with the development roller 7232. The development roller 7232 further includes spacing members 38 mounted to opposite ends, as in Embodiment 1.

The side member 7226 is provided with a cylindrical portion 7226b which projects in the Z2 direction. Here, as viewed in the Z1 direction, the clockwise direction about the axis of the cylindrical portion 7226b is referred to as direction G721, and the counterclockwise direction is referred to as direction G722.

An inner diameter of the cylindrical portion 7226b is slightly larger than the diameter of the core metal portion 7232a of the developing roller 7232.

On the Z2 direction side of the cylindrical portion 7226b, abutment surfaces 7226c and 7226d facing in the Z1 direction are provided at two positions symmetrically with respect to an axis Ax721 of the cylindrical portion 7226b. In addition, on the downstream side of the abutment surfaces 7226c and 7226d in the rotational direction G721, abutment surfaces 7226e and 7226f extending from the abutment surfaces 7226c and 7226d in the Z1 direction are provided at two positions symmetrically with respect to the axis Ax721. An end surface of the cylindrical portion 7226b in the Z2 direction is designated as 7226g.

The elastic member 7292 is a compression spring, which is a type of spring, and has a diameter larger than the inner diameter of the cylindrical portion 7226b of the side member 7226 and smaller than the outer diameter of the cylindrical portion 7226b. The inner diameter of the elastic member 7292 is sufficiently larger than the diameter of the core metal portion 7232a of the developing roller 7232.

The engaging member 7291 has a disk-shaped base plate portion 7291a, and the base plate portion 7291a has a through hole 7291b having the same diameter as the inner diameter of the cylindrical portion 7226b. The diameter of the through hole 7291b is slightly larger than the diameter of the core metal portion 7232a of the developing roller 7232.

Two projections 7291c and 7291d are provided from the base plate portion 7291a, projecting in a direction perpendicular to the axis of the through hole 7291b, and are provided symmetrically with respect to the axis of the through hole 7291b. In addition, the projections 7291f and 7291g are provided from the projections 7291c and 7291d, projecting in the Z1 direction.

Furthermore, an engaging projection 7291e is provided from the base plate portion 7291a, projecting in the Z1 direction. The engaging projection 7291e of the engaging member 7291 is similar to the shape of the teeth of the gear portion 30a of the gear 30 of Embodiment 1. In other words, the engaging projection 7291e has a helical shape twisted clockwise as it goes from the base plate portion 7291a in the Z1 direction around the axis of the through hole 7291b. Although the details will be described hereinafter, the engaging projection 7291e is a projecting engagement portion structured to engage with a helical gear outside the cartridge, i.e., to engage with the gear portion 81a of the drive transmission member 81. The engaging projection 7291e can be considered to be a tooth (gear tooth) structured to engage with an external gear.

In Embodiment 5, the missing tooth gear 591 (see FIG. 57, and so on) has been described, but the structure in which the number of the missing tooth gear 591 is reduced down to one is similar to the engaging member 7291. Therefore, the preferred arrangement of the engaging member 7291 and the engaging projection 7291e may be considered to be similar to the preferred arrangement of the missing tooth gear 591 and teeth thereof having been described with reference to FIG. 60. The preferred ranges of the distance K50, angle K50, and angle K51 for the missing tooth gear 591 also apply to the engaging member 7291.

The engaging member 7291 has at least one tooth and is a type of gear which are rotatable about its own axis, particularly a type of missing tooth gear. The engaging member 7291 can engage with the gear portion 81a of the drive transmission member 81.

### <Assembling of Engaging Mechanism>

Part (a) of FIG. 97 and part (b) of FIG. 97 are an exploded view and a side view, as seen in the Z1 direction, of the engaging mechanism 7290 before assembly. Part (c) of FIG. 97 and part (d) of FIG. 97 are an exploded view and a side view, as seen in the Z1 direction, of the engaging mechanism 7290 during assembly. Part (e) of FIG. 97 and part (f) of FIG. 97 are an exploded view and a side view, as seen in the Z1 direction, of the engaging mechanism 7290 after the assembling is complete. Here, some parts are not shown for the sake of better illustration.

As shown in part (a) of FIG. 97 and part (c) of FIG. 97, the core metal portion 7232a of the developing roller 7232 passes through the through hole 7291b (see part (b) of FIG. 97) of the elastic member 7292 and the engaging member 7291, and is rotatably supported by the inner diameter portion of the cylindrical portion 7226b of the side member 7226.

At this time, one end of the elastic member 7292 abuts against the end surface 7226g of the side member 7226, and the other end is mounted compressed in the Z1 direction by the base plate portion 7291a of the engaging member 7291. In this manner, the engaging member 7291 receives an urging force in the Z2 direction from the elastic member 7292 and abuts against the spacing member 38 of the developing roller 7232 in the Z axis direction.

The diameter of the through hole 7291b of the engaging member 7291 is slightly larger than the diameter of the core metal portion 7232a of the developing roller 7232, and the engaging member 7291 is supported rotatably on the core metal portion 7232a of the developing roller 7232 centered on the through hole 7291b.

Thereafter, as shown in part (e) of FIG. 97, the engaging member 7291 is pushed in the Z1 direction against the urging force of the elastic member 7292 in the Z2 direction. And, the engaging member 7291 is rotated in the direction of an arrow G721 about the through hole 7291b from the state shown in part (d) of FIG. 97 to the state shown in part (f) of FIG. 97. Then, the projections 7291c and 7291d abut against the abutment surfaces 7226e and 7226f of the side member 7226 in the direction of the arrow G721.

Furthermore, as shown in part (e) of FIG. 97 and part (f) of FIG. 97, projections 7291c, 7291d of engaging member 7291 are abutted against abutment surfaces 7226c, 7226d in the Z2 direction.

The engaging member 7291 receives an urging force in the Z2 direction from the elastic member 7292. This urging force produces a frictional force between the projections 7291c, 7291d of engaging member 7291 and the abutment surfaces 7226c, 7226d of side member 7226, so that the orientation in the rotational direction about the axis Ax721 is maintained.

The position of the engaging member 7291 in this state is called an initial position or an engaging position.

<Engagement with Image Forming Apparatus>

Referring to FIG. 98, the engagement with the drive transmission member 81 of the image forming apparatus A will be described.

Part (a) of FIG. 98 is a cross-sectional view taken along a plane perpendicular to the Z axis and as viewed in the Z1 direction when the cartridge B is mounted in the image forming apparatus A. Part (b) of FIG. 98 is a cross-sectional view taken along a plane perpendicular to the Z axis and as viewed in the Z1 direction after the drive transmission member 81 has been operated. Here, some parts are not shown for the sake of better illustration.

As shown in part (a) of FIG. 98, when the cartridge B is mounted in the image forming apparatus A, the engaging projection 7291e of the engaging member 7291 in the initial position engages with the gear portion 81a of the drive transmission member 81.

As shown in part (a) of FIG. 98, when the drive transmission member 81 rotates in the rotational direction CW, as in Embodiment 2, the engaging projection 7291e of the engaging member 7291 and the gear portion 81a engage with each other, producing a reaction force FD721 of the engagement force FD720 in the gear portion 81a. In the drive transmission member 81, the gear portion 81a is moved by the force FD721, so that the rotational axis Ax3 moves in a direction of coinciding with the rotational axis Ax1 of the drum 62. Then, as shown in part (b) of FIG. 98, the gear portion 81a abuts against the restricting portion 73j (see FIG. 94), and in the direction perpendicular to the longitudinal direction, the coupling recess 81b and the coupling projection 63b are positioned so that the couplings are substantially coaxial with each other and therefore engageable with each other.

The maximum value of a static friction force F721 produced by the force from the elastic member 792 urging the engaging member 7291 is sufficiently large as compared with the force FD720r, which is the rotational component of the engagement force FD720 of the engaging member 7291. Therefore, the engaging member 7291 does not move and maintains its initial position.

As in the first modification of Embodiment 7, the drive transmission member 81 is moved in the Z2 direction by the force produced by the helical teeth of the gear portion 81a, and the coupling recess 81b of the drive transmission member 81 and the coupling projection 63b of the driving side drum flange 63 engage with each other (see part (i) of FIG. 92).

By the above-described coupling engagement operation, the engaging mechanism 7290 can engage the coupling recess 81b of the drive transmission member 81 and the coupling projection 63b of the driving side drum flange 63, with each other.

As the drive transmission member 81 further rotates in the direction of the arrow CW, as shown in part (b) of FIG. 98, the engaging projection 7291e of the engaging member 7291 rotates in the direction of an arrow G722 by the engaging force of the gear portion 81a. That is, the engaging member 7291 is displaced from the initial position in the direction of the arrow G722.

Next, referring to FIG. 99 and FIG. 100, the description will be made as to how the engaging member 7291 moves in the axial direction, that is, in the Z2 direction, by rotating about own axis thereof.

Part (a) of FIG. 99, part (c) of FIG. 99, and part (e) of FIG. 99 are side views, and part (b) of FIG. 99, part (d) of FIG. 99, and part (f) of FIG. 99 are cross-sectional views taken along a plane perpendicular to the Z-axis direction and as viewed in the Z1 direction.

Part (a) of FIG. 99 and part (b) of FIG. 99 show the state in which the cartridge B is mounted in the image forming apparatus A. Part (c) of FIG. 99 and part (d) of FIG. 99 show the state in which the engaging member 7291 has rotated in the G722 direction. Part (e) of FIG. 99 and part (f) of FIG. 99 are views of the engaging member 7291 after it has rotated in the G722 direction and moved in the Z2 direction.

FIG. 100 is a side view showing the engaged state of the drive transmission member 81 and the engaging member 7291. Part (a) of FIG. 100 is a side view of the initial position, and part (b) of FIG. 100 is a side view of the engaging member 7291 after it has rotated in the G722 direction.

The engaging member 7291 rotates in the direction of the arrow G722 from the state in part (b) of FIG. 99 (part (a) of FIG. 98) as shown in part (d) of FIG. 99 (part (b) of FIG. 98), and the abutment state between the projections 7291c, 7291d and the abutment surfaces 7226c, 7226d of the side member 7226 is broken. Then, from the state shown in part (c) of FIG. 99, the engaging member 7291 is moved, as shown in part (e) of FIG. 99, in the Z2 direction by the urging force of the elastic member 7292 and abuts against the spacing member 38 mounted to the developing roller 7232.

As shown in part (a) of FIG. 100 and part (b) of FIG. 100, the engaging member 7291 moves in the Z2 direction, thereby causing the engaging projection 7291e of the engaging member 7291 to disengage from the gear portion 81a of the drive transmission member 81. The position of the engaging member 7291 at this time is referred to as a retracted position, non-engaged position, and so on.

The engaging member 7291 moves from the initial position (see part (a) of FIG. 99) to the retracted position (see part (e) of FIG. 99), thereby moving inward in the axial direction of the drum 62. In other words, when the engaging member 7291 is placed at the retracted position (see part (e) of FIG. 99), the distance from the non-driven side of the cartridge to the engaging member 7291, measured along the axial direction of the drum 62, is shorter than when the engaging member 7291 is placed at the initial position (see part (a) of FIG. 99). The engaging member 7291 is a movable member which can move in the axial direction of the drum 62.

Furthermore, the movement of the engaging member 7291 from the initial position (see part (a) of FIG. 99) to the retracted position (see part (e) of FIG. 99) is accompanied by rotation about the axis of the engaging member 7291. As the engaging member 7291 rotates, the distance between the engaging projection 7291e placed at its end and the axis of the drum 62 becomes longer. The engaging member 7291 is also a movable member which can move to change the distance thereof from the axis of the drum 62.

The projections 7291c and 7291d of the engaging member 7291 and the abutment surfaces 7226c and 7226d of the side member 7226 can be considered as a lock locking the engaging member 7291 at the retracted position (FIG. 99).

The engaging member 7291 rotates to release the locked state caused by them and enter the unlocked state, and moves to the retracted position by the elastic force of the elastic member 7292. It can be said that the engaging member 7292 is urged toward the retracted position.

One of the initial position (see part (a) of FIG. 99) and the retracted position (see part (e) of FIG. 99) of the engaging member 7291 may be called a first position, and the other a second position. By movement of the engaging member 7291 between the first position and the second position, the engaging projection 7291e, which is one of its teeth, also moves between the first position and the second position.

### <Drive Transmission>

Next, referring to FIG. 101, the drive of the developing roller 7232 will be described. FIG. 101 is a side view of the cartridge B, and as shown in FIG. 101, a non-driven side drum flange 7264 is provided at the Z2 direction end of the photosensitive drum 62. A gear portion 7264a is provided on the non-driven drum flange 7264. The non-driven drum flange 7264 is mounted so as to rotate integrally with the photosensitive drum 62.

In addition, a non-driven side developing roller gear 7230 (hereinafter referred to as the developing roller gear 7230) is provided coaxially with the developing roller 7232 at the Z2 end of the developing roller 7232. The developing roller gear 7230 is mounted to the Z2 direction end of the developing roller 7232 so as to rotate integrally with the developing roller 7232.

The gear portion 7264a of the non-driven drum flange 7264 and the developing roller gear 7230 of the developing roller 7232 are placed at positions where they engaged at a cross sectional plane perpendicular to the Z axis to transmit the rotational drive.

When the driving side drum flange 63 receives the driving force from the drive transmission member 81, the photosensitive drum 62 rotates in the direction of the arrow CW (see FIG. 98). Then, the driving force is transmitted from the gear portion 7264a of the non-driven drum flange 7264 to the developing roller gear 7230, so that the developing roller 7232 rotates.

### <Initialization>

When re-mounting the cartridge B in the image forming apparatus A, the operator has to move the engaging member 7291 in the Z1 direction, and then rotate it in the direction of the arrow G721 to return it to the initial position. In the initial position, the engaging member 7291 is locked by the projections 7291c and 7291d of the engaging member 7291 and the abutment surfaces 7226c and 7226d of the side member 7226.

### <Effects>

The above-described structure makes it possible to protect the developing roller gear 7230 by disposing it inside the cartridge B. In other words, it is not necessary to expose the developing roller gear 7230 significantly to the outside of the cartridge in order to engage it with the drive transmission member 81. This reduces the possibility that an operator may touch the developing roller gear 7230 and damage the developing roller gear, which may affect image forming operation. In addition, after the drive transmission member 81 is connected to the cartridge B, the engaging member 7291 can be moved to a position where it does not engage with the drive transmission member 81 (see part (e) of FIG. 99). Therefore, when dismounting the cartridge B, the engaging member 7291 is less likely to be caught on the drive transmission member 81, which is advantageous in that the user can easily dismount the cartridge B.

### <Preferred Range>

The engaging projection 7291e of the engaging member 7291 is similar to the shape of the teeth of the gear portion 30a of the gear 30 in Embodiment 1, and the preferred range of the arrangement of the engaging projection 7291e in the initial position is the same as the preferred range of the arrangement of the teeth of the gear portion 30a in Embodiment 1.

The position of the Z1-direction end of the engaging projection 7291e of the engaging member 7291 must be within a range which allows engagement between the initial position and the operating position of the drive transmission member 81.

### Embodiment 8

Next, referring to FIGS. 102 to 109, Embodiment 8 will be described in the following. In particular, among the elements disclosed in this Embodiment, those that correspond to the members described in the previous Embodiments will be given the same names as the members in the previous Embodiments, and only the different points will be described.

First, referring to FIG. 102, the cartridge structure of this Embodiment will be described.

FIG. 102 is a perspective view of the cartridge B. As shown in FIG. 102, the cartridge B in this embodiment comprises a cleaning unit 260 and a developing unit 820. The developing unit 820 includes a driving-side development side member 826 (hereinafter referred to as side member 826).

Also, as shown in FIG. 102, an engaging mechanism 890 is provided on the side member 826.

For the sake of better illustration, the vertical direction of image forming apparatus A (see FIG. 2) is referred to as a Y axis, and an upward direction is Y81 direction shown in FIG. 102. The opposite direction to the aforementioned Y81 direction is Y82 direction. The front-rear direction in the image forming apparatus A, which is perpendicular to the Y81 direction, is referred to the X axis, and the forward (front) direction is the X81 direction shown in FIG. 102. The opposite direction to the X81 direction described above is the X82 direction. Similarly to Embodiment 7-1, the axis parallel to the rotational axis of the photosensitive drum 11 is a Z axis, and when orientation in the Z axis is intended, a Z1 direction and a Z2 direction are used. The Z1 direction is toward the drive input side of the photosensitive drum 11.

### <Structure of Engagement Mechanism>

Next, referring to FIGS. 103 and 104, the structure of the engaging mechanism 890 will be described.

FIG. 103 is an exploded perspective view of the engaging mechanism 890.

FIG. 104 shows the engaging mechanism 890 after assembling, wherein part (a) of FIG. 104 is a side view and part (b) of FIG. 104 is a cross-sectional view taken along a line S801-S801 shown in part (a) of FIG. 104.

As shown in FIG. 103, the engaging mechanism 890 is disposed on the drive side of the cartridge B, and comprises a side member 826, a gear member 891, and a pressing plate 892. The components of the engaging mechanism 890 are described in the following.

The side member 826 is provided with a cylindrical portion 826b projecting in the Z1 direction. In addition, two bonding surfaces 826d and 826e which are perpendicular to the Z axis are provided so as to sandwich the cylindrical portion 826b in the Y axis direction.

The gear member 891 is made of a material having a low elastic modulus, has a substantially cylindrical shape, and is provided with a gear portion 891a on the outer periphery thereof and provided with a through hole 891b on the inner periphery. A diameter of the through hole 891b is sufficiently larger than the diameter of the cylindrical portion 826b of the side member 826. In addition, the surface defining the through hole 891b is made of a material having a shape exhibiting a high friction coefficient.

The gear member 891 of this embodiment is a gear corresponding to the gear portion 30a of Embodiment 1 (see FIG. 9). For meshing engagement with the gear portion 81a of the drive transmission member 81, the gear member 891 is at least partially exposed toward the outside of the cartridge. More specifically, the exposed portion of the gear member 8911 faces toward the side where the axis Ax1 of the drum 62 is located (see FIG. 105).

In this manner, the preferred arrangement of the gear member 891 applies to the preferred arrangement of the gear portion 30a of Embodiment 1 (see FIG. 9).

The pressing plate 892 has a flat plate shape perpendicular to the Z axis, and comprises a base portion 892a and a through hole 892b. The diameter of the through hole 892b is slightly larger than the diameter of the cylindrical portion 826b of the side member 826. The pressing plate 892 has bonding surfaces 892c and 892d facing in the Z2 direction at opposite end portions in the Y axis direction.

### <Assembling of Engagement Mechanism>

As shown in FIG. 103, the gear member 891 is mounted to the side member 826 in the Z2 direction, and the cylindrical portion 826b is penetrated through the through hole 891b.

Thereafter, the pressing plate 892 is mounted to the side member 826 in the Z2 direction, and the cylindrical portion 826b is penetrated through the through hole 892b. In addition, the bonding surfaces 892c and 892d of the pressing plate 892 are attached to the bonding surfaces 826d and 826e of the side member in the Z direction by adhesive or the like. In this manner, the movement of the gear member 891 in the Z direction is restricted by the side member 826 and the pressing plate 892.

Also, as shown in part (b) of FIG. 104, the through hole 891b of the gear member 891 is sufficiently large as compared to the cylindrical portion 826b of the side member 826, so that the gear member 891 abuts against the cylindrical portion 826b in the Y82 direction, which is the direction of gravity, and hangs down. Therefore, the gear member 891 can move on the side member 826 on a plane perpendicular to the Z axis within the range of play between the through hole 891b and the cylindrical portion 826b.

<Engagement with Main Assembly>

Referring to FIG. 105, engagement with the drive transmission member 81 of the image forming apparatus A will be described.

FIG. 105 is cross-sectional views taken along a plane perpendicular to the Z axis, and illustrates a state in which the cartridge B receives the drive from the image forming apparatus A. Part (a) of FIG. 105 shows the state immediately after the cartridge B is mounted in the image forming apparatus A, and part (b) of FIG. 105 is a cross-sectional view when the cartridge B receives the drive from the image forming apparatus A.

As shown in part (a) of FIG. 105, when the cartridge B is mounted in image forming apparatus A, the gear member 891 is sandwiched between the drive transmission member 81 and the cylindrical portion 826b of the side member 826, and the gear portion 81a of drive transmission member 81 engages with the gear portion 891a of the gear member 891.

As shown in part (a) of FIG. 105, when the drive transmission member 81 rotates in the rotational direction CW, the gear portion 891a of the gear member 891 receives an engaging force F801 from the gear portion 81a. As described above, the through hole 891b of the gear member 891 has a high friction coefficient. Therefore, when the gear member 891 receives the force F801, it receives a friction force F802 in the direction opposite to that of the force F801 from a contact surface with the cylindrical portion 826b of side member 826. The gear member 891 is restricted from moving by this force F802, and as a result, the gear portion 81a receives a reaction force F803 from the gear portion 891a that is equal to the force F801 but is in the opposite direction.

The drive transmission member 81 moves as the gear portion 81a receives F803, and the rotational axis Ax3 moves in a direction of coinciding with the rotational axis Ax1 of the drum 62. Then, the gear portion 81a abuts against the restricting portion 73j (see FIG. 102), and as shown in part (b) of FIG. 105, in the direction perpendicular to the longitudinal direction, the coupling recess 81b and the coupling projection 63b are positioned so that they are substantially coaxial with each other and can be engaged with each other. Here, a maximum value of the friction force F802 acting on the gear member 891 is sufficiently large as compared with the engaging force F801.

As in Modified Example 1 of Embodiment 7, the drive transmission member 81 is moved in the Z2 direction by the helical teeth of the gear portion 81a, so that the coupling recess 81b of the drive transmission member 81 engages with the coupling projection 63b of the driving side drum flange 63 (see part (i) of FIG. 93).

By the above-described coupling engagement operation, the engaging mechanism 7290 can bring the coupling recess 81b of the drive transmission member 81 into engage with the coupling projection 63b of the driving side drum flange 63.

As the drive transmission member 81 moves, as shown in part (b) of FIG. 105, the gear member 891 moves to a position where the axis 891c is on an extension line connecting the axial center of the cylindrical portion 826b of the side member 826 and the axial center of the drive transmission member 81.

Furthermore, the drive transmission member 81 rotates in the direction of the arrow CW, and the gear member 891 receives an engagement force F804 from the gear portion 81a. Then, the gear member 891 overcomes the friction force F802 with the cylindrical portion 826b of the side member 826, and rotates in the direction of the arrow G82, which is the rotational direction about the axis of the gear member 891.

In this embodiment, the drive is transmitted from the non-driving side drum flange to the developing unit (see FIG. 101) as in Modified Example 2 of Embodiment 7.

In this manner, the drive force is transmitted from the image forming apparatus A to the cartridge B.

Here, the inner diameter of the gear member 891 in this embodiment, i.e., the diameter of the through hole 891B, is larger than the diameter of the cylindrical portion 826b supporting the gear member 891. Therefore, the gear member 891 can be easily mounted to the cylindrical portion 826b. In other words, the assembling of the cartridge can be improved. Since a gap is provided between the through hole 891b and the cylindrical portion 826b, the gear member 891 can move in a direction perpendicular to and intersecting with own axis thereof. Even if the gear member 891 moves in this perpendicular direction, the upper limit of the size of the gap can be selected to be capable of reliably meshing with the drive transmission member 81.

In this embodiment, the gear member 891 has a hole, i.e., the through hole 891b, whereas the support portion supporting the gear member 891 is the cylindrical portion 826b in the shape of a shaft. However, this relationship may be reversed. In other words, the gear member 891 may have a shaft, and the support portion supporting the gear member 891 may have a hole supporting the shaft of the gear member 891. In this case, too, if there is a gap between the shaft and the hole, it becomes easy to mount the gear member 891 to the support portion. In addition, the gear member 891 can move in a direction that intersects with the rotational axis thereof.

The above structure may be referred to as Structure 8-1 or a representative example of Embodiment 8.

### Modified Example 1 of Embodiment 8

In the representative example of Embodiment 8 (structure 8-1) described above, the gear member 891 has a gear portion having a low elasticity, but the same effect can be obtained by using an elastic member not having a gear portion. A structure in which an elastic member is provided instead of the gear member 891 is described in the following as Modified Embodiment 1.

FIG. 106 is an exploded perspective view of a structure having an elastic ring 8291.

In this structure, as shown in FIG. 106, the gear member 891 is replaced with an elastic ring 8291, as compared with structure 8-1, and the other structures are the same as those of structure 8-1.

The elastic ring 8291 is a cylindrical elastic member and has an outer peripheral surface 8291a and a through hole 8291b. The diameter of the through hole 8291b of the elastic ring 8291 is sufficiently larger than the diameter of the cylindrical portion 826b of the side member 826, as is the through hole 891b of the gear member 891. In addition, the surface defining the through hole 8291b is made of a material and has a shape with a high friction coefficient.

The assembling method of this structure is the same as that of structure 8-1, and therefore, the description thereof is omitted.

<Engagement with Main Assembly>

Next, the engagement with the drive transmission member 81 of the image forming apparatus A will be described.

FIG. 107 is a cross-sectional view perpendicular to the Z axis, illustrating the state in which the cartridge B of this structure receives the drive from the image forming apparatus A. Part (a) of FIG. 107 shows the state immediately after the cartridge B is mounted on the image forming apparatus A, and part (b) of FIG. 107 is a cross-sectional view when the cartridge B is receiving the drive from the image forming apparatus A.

As shown in part (a) of FIG. 107, when the cartridge B is mounted to the image forming apparatus A, the elastic ring 8291 enters the space between the adjacent gear teeth of the gear portion 81a of the drive transmission member 81 and deforms to match the shape of the gear teeth.

When the drive transmission member 81 rotates in the rotational direction CW, the outer peripheral surface 8291a of the elastic ring 8291 receives an engaging force F804 from the gear portion 81a. As described above, the through hole 8291b of the elastic ring 8291 has a high coefficient of friction. Therefore, when the elastic ring 8291 receives the force F804, the elastic ring 8291 receives a friction force F805 in the opposite direction to the force F804 from the contact surface with the cylindrical portion 826b of the side member 826. This force F805 restricts the movement of the elastic ring 8291, and as a result, the gear portion 81a receives a reaction force F806 from the outer peripheral surface 8291a of the elastic ring 8291 which is the same force as the force F804 but in the opposite direction.

The drive transmission member 81 is moved by receiving force F806 by the gear portion 81a, and the rotational axis Ax3 moves in a direction coinciding with the rotational axis Ax1 of the drum 62. Then, the gear portion 81a abuts against the restricting portion 73j (see FIG. 102), and as shown in part (b) of FIG. 107, in the direction perpendicular to the longitudinal direction, the coupling recess 81b and the coupling projection 63b are in a position where they are substantially coaxial and can be engaged. Here, the maximum value of the friction force F805 acting on the gear member 891 is sufficiently large as compared with the engaging force F804.

The drive transmission member 81 is moved in the Z2 direction by the helical teeth of the gear portion 81a, as in Modified Example 1 of Embodiment 7, and the coupling recess 81b of the drive transmission member 81 and the coupling projection 63b of the driving side drum flange 63 engage with each other (see part (i) of FIG. 92).

By the above-described coupling engagement operation, the elastic ring 8291 can accomplish the engagement between the coupling recess 81b of the drive transmission member 81 and the coupling projection 63b of the driving side drum flange 63.

When the drive transmission member 81 engages with the driving side drum flange 63, the state shown in part (b) of FIG. 107 is reached. As in Embodiment 8 (structure 8-1), the elastic ring 8291 receives a force F807 from the gear portion 81a of the drive transmission member 81, and overcomes the friction force F805 produced between the through hole 8291b and the cylindrical portion 826b of the side member 826, thereby to rotates in the direction of the arrow G82.

Furthermore, in this embodiment, as in the second modification of Embodiment 7, the drive is transmitted from the non-drive side drum flange to the developing unit (see FIG. 101).

In this way, the drive force is transmitted from the image forming apparatus A to the cartridge B.

The elastic ring 8291 has a larger tolerance for placement and dimensions due to the elastic deformation thereof. For example, in a representative example of Embodiment 8 (Structure 8-1), the distance from the axis Ax1 of the photosensitive drum 62 to the tooth tip of the gear member 891, measured in a direction perpendicular to the axis Ax1, is preferably in the range of 90-120% of the radius of the drum 62. This distance is more preferably in the range of 90-110%.

In contrast, the distance from the axis Ax1 to the surface of the elastic ring 8291, measured in a direction perpendicular to the axis Ax1 of the drum 62, is preferably in the range of 75-120% of the radius of the drum 62.

The above-described structure is referred to as Structure 8-2.

### Modified Example 2 of Embodiment 8

In the representative example of Embodiment 8 (Structure 8-1), the gear member 891 is supported by the cylindrical portion 826b of the side member 826, but it is also possible to configure the elastic belt gear by bridging it between two shafts provided on the side member. The structure in which the gear member 891 is replaced with an elastic belt gear is described below as Modified Example 2.

FIG. 108 is an exploded perspective view of this structure.

A side member 8326 of this structure is provided with two cylindrical portions protruding in the Z1 direction, and the cylinder located on the X82 side is a first cylindrical portion 8326b, and the other is a second cylindrical portion 8326c. The side member 8326 is further provided with two bonding surfaces 8326d and 8326e which are perpendicular to the Z axis and sandwich the first cylindrical portion 8326b and the second cylindrical portion 8326c in the Y axis direction.

The elastic belt gear 8391 is in the form of an endless belt, and has a protruding gear portion 8391a along in the outer circumferential direction on the outer periphery thereof. The inner peripheral surface 8391b is made of a material and has a shape having a high friction coefficient. The elastic belt gear 8391 is a belt having at least one tooth. In this embodiment, the elastic belt gear 8391 has multiple teeth. The elastic belt gear 8391 is in the form of a loop. The elastic belt gear 8391 is substantially in the form of an oval.

A pressing plate 8392 is in the form of a flat plate which is perpendicular to the Z axis, and includes a base plate portion 8392a, a through hole 8392b, and an oblong hole 8392c. The through hole 8392b is formed as a round hole, and the center of the through hole 8392b is located on an extension of the center line of the lengthwise direction of the oblong hole 8392c.

The diameter of the through hole 8392b is slightly larger than the diameter of the first cylindrical portion 8326b of the side member 8326. The width, measured in the shortwise direction, of the oblong hole 8392c is slightly larger than the diameter of the second cylindrical portion 8326c. Bonding surfaces 8392d and 8392e facing the Z2 direction are provided on the opposite ends, in the Y-axis direction, of the pressing plate 8392.

### Assembling of Modified Example 2

As shown in FIG. 108, the elastic belt gear 8391 is mounted to the side member 8326 in the Z2 direction. The elastic belt gear 8391 is mounted with its inner circumferential surface 8391b bridging over both the first cylindrical portion 8326b and the second cylindrical portion 8326c of the side member 8326 while maintaining tension therebetween.

Then, the pressing plate 8392 is mounted to the side member 8326 in the Z2 direction. The first cylindrical portion 8326b and the second cylindrical portion 8326c pass through the through hole 8392b and the oblong hole 8392c, respectively. Then, the bonding surfaces 8392d and 8392e of the pressing plate 8392 are attached to the bonding surfaces 8326d and 8326e of the side member by Z-axis direction by adhesive or the like. In this manner, the movement of the elastic belt gear 8391 in the Z-axis direction is restricted by the side member 8326 and the pressing plate 8392.

<Engagement with Main Assembly>

FIG. 109 is a cross-sectional view taken along a plane perpendicular to the Z axis which extends at the time when the cartridge B of this structure is driven by the image forming apparatus A.

The gear portion 8391a of the elastic belt gear 8391 engages with the gear portion 81a of the drive transmission member 81 in the same manner as in Embodiment 8 (Structure 8-1). Then, the coupling recess 81b of the drive transmission member 81 and the coupling projection 63b of the driving side drum flange 63 are engaged in the same manner as in Embodiment 8 (Structure 8-1).

Thereafter, the elastic belt gear 8391 receives a force F808 from the gear portion 81a by rotation of the drive transmission member 81 in the direction of the arrow CW. The elastic belt gear 8391 overcomes a friction force F809 between the first cylindrical portion 8326b and the second cylindrical portion 8326c of the side member 8326, so that it moves in the direction of arrow G801, sliding along the outer periphery of the first cylindrical portion 8326b and the second cylindrical portion 8326c.

Furthermore, in this embodiment, as in Modified Example 2 of Embodiment 7, the drive is transmitted from the non-driven side drum flange to the developing unit (see FIG. 101).

In this manner, the driving force from the image forming apparatus A is transmitted to the cartridge B.

The elastic belt gear 8391 has a larger tolerance for the dimensions and the location where it can be arranged, since it is elastically deformable. For example, in Embodiment 8 (structure 8-1), the distance from the axis Ax1 of the photosensitive drum 62 to the tooth tip of the gear member 891, measured in a direction perpendicular to the axis Ax1, is preferably in the range of 90-120% of the radius of the drum 62, and more preferably in the range of 90-110%. In contrast, the distance from the axis Ax1 to the tooth tip of the elastic belt gear 8391, measured in a direction perpendicular to the axis Ax1 of the drum 62, is preferably in the range of 75-120% of the radius of the drum 62.

Furthermore, since the elastic belt gear 8391 is elastically deformed, the possibility of damaging the drive transmission member 81 when it meshes with the drive transmission member 81 is reduced. The durability of the drive transmission member 81 can be improved.

The above-described structure is called structure 8-3.

### Modified Example 3 of Embodiment 8

In the above-described structure, the elastic belt gear 8391 has a gear portion, but the same effect can be provided by using an elastic member without a gear portion, as in Modified Example 1 of Embodiment 8 (Structure 8-2). A cartridge using an elastic member without a gear portion is described in the following as Modified Example 3.

FIG. 110 is an exploded perspective view of this structure.

In this structure, the elastic belt gear 8391 of Modified Example 2 (Structure 8-3) is replaced with an elastic belt 8491, and other parts are the same.

The elastic belt 8491 is an endless belt, and the inner peripheral surface 8491b is made of a shape and material with a high friction coefficient. The elastic belt 8491 is a belt without a tooth.

The engagement with the drive transmission member 81 is the same as in Modified Example 1 (Structure 8-2), and the movement (slip) of the elastic belt 8491 is the same as in Modified Example 2 (Structure 8-3), so the description thereof is omitted.

In this embodiment, the drive is transmitted from the non-driving drum flange to the developing unit (see FIG. 101) as in Modified Example 2 of Embodiment 7.

In this manner, the drive force is transmitted from the image forming apparatus A to the cartridge B. The suitable arrangement of the elastic belt 8491 is the same as in Modified Example 2.

The above-described structure is called Structure 8-4.

### <Effects>

By employing the above-described structure, it is possible to arrange the developing roller gear inside the cartridge B as in Modified Example 2 of Embodiment 7, and it is possible to reduce the possibility of an operator touching and damaging the developing roller gear, which may affect image forming operation.

In this embodiment, the drive transmission structure from the non-driving drum flange to the developing unit is described as being the same as in Modified Example 2 of Embodiment 7, but it is also possible to employ a structure in which the drive is transmitted directly to the developing unit from a part which engages with the drive transmission member 81. In such a case, the above-described effect cannot be provided.

### <Preferred Range>

In the representative example of Embodiment 8 and the Modified Example 1 to 3 (i.e., structures 8-1 to 8-4) thereof described above, the preferred range of the arrangement of the cartridge side parts that engage with the drive transmission member 81 is the same as that of the developing roller gear 30 of Embodiment 1 (see FIG. 9, and so on). However, this is so except for the range which is particularly described as the preferred range specific to this embodiment.

The preferred arrangements of the gear member 891, the elastic ring 8291, and the elastic belt gear 8391 are the same as those described in the previous embodiment. For example, reference is made to the preferred arrangements of the developing roller gear 30 (see FIGS. 1, 9, and 20) described in Embodiment 1, the rack gear 291 (see part (b) of FIG. 29) described in Embodiment 2, and the missing tooth gear 591 (see part (b) of FIG. 60) described in Embodiment 5.

Here, the gear portion 891a and the gear portion 8391a in Embodiment 8 (structure 8-1) and Modified Example 2 (8-3) are described as having a helical gear shape in this embodiment, but they may have any shape which engages with the gear portion 81a of the drive transmission member 81. For example, the same effect can be obtained with a shape having multiple protrusions extending outward in the axial direction or a narrow spur tooth shape.

Here, in this embodiment, the parts described as having a shape and material having a high friction coefficient are, for example, elastomer, rubber, sponge, and so on.

Furthermore, in this embodiment, the surface forming the through hole 891b, the surface forming the through hole 8291b, and the inner circumferential surface 8391b and the inner peripheral surface 8491b, which are the sliding parts, are described as having shapes and materials with high friction coefficients. However, the entire parts constituting these may be made of a material with a high friction coefficient, or only the periphery of the sliding parts may be made of a material with a high friction coefficient as a separate part. In addition, in this embodiment, the sliding parts of the gear member 891, the elastic ring 8291, the elastic belt gear 8391, and the elastic belt 8491 are described as having materials and shapes with high friction coefficients. However, it is also possible to configure the cylindrical portions 826b, 8326b, and 8326e with materials and shapes with high friction coefficients.

### Embodiment 9

Next, referring to FIGS. 111 to 117, Embodiment 9 will be described in the following. In particular, among the elements disclosed in this embodiment, those corresponding to the members described in the previous embodiment are assigned the same names as the members in the previous embodiment, and only the different points will be described.

First, referring to FIG. 111, the cartridge structure of this embodiment will be described. FIG. 111 is a perspective view of the cartridge B. As shown in FIG. 111, the cartridge B in this embodiment comprises a cleaning unit 260 and a developing unit 920. The developing unit 920 has a load applying mechanism 990. In this embodiment, a direction along the rotational axis Ax1 of the drum 62 is a longitudinal direction D900, the driving side drum flange 263 side is the driving side, and the direction toward the driving side is indicated by an arrow E90. The opposite side to the driving side is the non-driving side, and a direction toward the non-driving side is indicated by an arrow E91.

### <Structure of Load Applying Mechanism>

Next, referring to FIG. 112, the structure of the load applying mechanism 990 will be described. FIG. 112 is an exploded perspective view of the load applying mechanism 990 and the developing unit 920, where part (a) of FIG. 112 is a view as seen from the non-driven side and part (b) of FIG. 112 is a view as seen from the driven side.

In this embodiment, the load applying mechanism 990 is provided as a part of the structure of the developing unit 920 (see FIG. 111). As shown in FIG. 112, the load applying mechanism 990 comprises a driving-side development side member 926, a rotating member 991, a load applying member 992, an urging member 993, and a support member 994. Each of the components of the load applying mechanism 990 will be described in the following.

The driving-side development side member 926 has a shaft portion 926a and a wall surface 926b as a structure related to the load applying mechanism 990.

The wall surface 926b is a surface facing in a direction of the arrow E91 in the longitudinal direction D900. The shaft portion 926a is a cylindrical shaft extending from the wall surface 926b in the direction of the arrow E91. If the axis of the shaft portion 926a is referred to as a rotational axis Ax90, the shaft portion 926a is provided with an arc portion 926a1 and a groove portion 926a2 along the rotational axis Ax90.

The rotating member (gear member) 991 is cylindrical with the rotational axis Ax90 as the center thereof, and has a cylindrical portion 991a, a support hole 991b, a wall portion 991c, and a projecting portion 991d. As will be described in detail hereinafter, the rotating member 991 is a type of gear structured to mesh with the gear portion 81a of the drive transmission member 81. Each of the projecting portions 991d is a tooth which is capable of meshing engagement with an external gear.

However, the rotating member 991 of this embodiment is structured not to transmit the driving force received from the drive transmission member 81 to other members of the cartridge.

The cylindrical portion 991a is provided with a support hole 991b centered on the rotational axis Ax90, and a wall portion 991c with a larger diameter than the cylindrical portion 991a is provided at the end in the direction of an arrow E91. The surface of the wall portion 991c on the arrow E91 side is an abutment surface 991c1, and a surface on an arrow E90 side is a pressed surface 991c2.

The cylindrical portion 991a is provided with a plurality of projecting portions 991d extending radially outward from the rotational axis Ax90 at a position away in the arrow E90 direction from the wall portion 991c. Here, as viewed from the non-driven side parallel to the rotational axis Ax90, the counterclockwise direction about the rotational axis Ax90 is a rotational direction R90. The plurality of projecting portions 991d are arranged at regular intervals in the rotational direction R90.

The load applying member 992 has a cylindrical shape centered on the rotational axis Ax90, and includes a cylindrical portion 992a, a support hole 992b, and a wall portion 992c.

The cylindrical portion 992a is provided with a support hole 992b centered on the rotational axis Ax90, and a wall portion 992c having a larger diameter than the cylindrical portion 992a at the end in the direction of the arrow E91. The outer peripheral surface of the cylindrical portion 992a is a friction force imparting surface 992a1, and the friction force imparting surface 992a1 is made of a material with a high friction coefficient, such as rubber.

The support hole 992b is provided with a locking portion 992b2 which protrudes radially inward from the arc portion 992b1 along the rotational axis Ax90.

The surface of the wall portion 992c on the arrow E91 side is a spring seat 992c1, and the surface on an arrow E92 side is an abutted surface 992c2.

The urging member 993 is formed of a compression spring, and the inner diameter portion is indicated by 993a.

The support member 994 is formed with a developing roller support hole 994a and a spring seat 994b. The developing roller support hole 994a is provided on the arrow E91 side, and the spring seat 994b is the surface on the arrow E90 side.

### <Assembling of Load Applying Mechanism>

Next, referring to FIGS. 112 and 113, the method of assembling the load applying mechanism 990 per se and assembling the load applying mechanism 990 to the developing unit 520 will be described. FIG. 113 is sectional views taken along the rotational axis Ax90 after the load applying mechanism 990 is assembled. Part (a) of FIG. 113 shows a position where the rotating member 991 is urged by the urging member 993, and part (b) of FIG. 113 shows a position where the rotating member 991 is retracted in the direction of the arrow E91. For the sake of better illustration, FIG. 113 shows only the load applying mechanism 990, the developing roller 32, and the developing roller gear 30, and unnecessary shapes are not shown.

First, the rotating member 991 is assembled to the load applying member 992. As shown in FIG. 112, the friction force imparting surface 992a1 of the load applying member 992 is inserted into the support hole 991b of the rotating member 991 to rotatably support the rotating member 991. Then, the support hole 991b and the friction force imparting surface 992a1 are lightly press-fitted. Alternatively, the friction force imparting surface 992a1 is made of a material with high frictional force such as rubber. With this structure, when the rotating member 991 and the load applying member 992 rotate relative to each other, a load torque T90 is produced.

Next, the load applying member 992 is assembled to the driving side developing side member 926. The locking portion 992b2 of the load applying member 992 and the groove portion 926a2 of the driving side developing side member 926 are aligned, and the support hole 992b is fitted around the shaft portion 926a. As a result, the load applying member 992 is supported by the driving side developing side member 926 in a state in which it can move in the direction of the rotational axis Ax90 but its rotation about the rotational axis 90 is restricted.

Next, the urging member 993 and the support member 994 are assembled to the driving side developing side member 926. The inner diameter portion 993a of the urging member 993 is inserted into the arc portion 926a1 of the driving-side development side member 926, and the developing roller support hole 994a of the support member 994 is fixed to the driving-side development side member 926 by adhesive or the like so as to be coaxial with the developing roller 32. At this time, the urging member 993 is compressed between the spring seat 994b of the support member 994 and the spring seat 992cl of the load applying member 992.

Then, the load applying mechanism 990 is fixed to the developing unit 920 by screws or the like with the developing roller support hole 994a of the support member 994 having been fitted around the support shaft 32a of the developing roller 32.

Next, in the load applying mechanism 990, as shown in part (a) of FIG. 113, the support member 994 is fixed to the driving-side development side member 926, and the rotating member 991 is movable along the rotational axis Ax90 by way of the load applying member 992. Therefore, the urging member 993 presses the spring seat 992cl of the load applying member 992, and the abutted surface 992c2 of the load applying member 992 contacts and presses the abutment surface 991cl of the rotating member 991. As a result, the rotating member 991 is urged by a force F90 in the direction of the arrow E90 and abuts against the wall surface 926b of the driving-side development side member 926. By this, the position of the rotating member 991 is restricted in the longitudinal direction D900.

When the rotating member 991 is pressed in the direction of the arrow E91 by an external force from this state, it can retract in the direction of the arrow 91 against the force F90 as shown in part (b) of FIG. 113. The external force in this embodiment is from the drive transmission member 81 of the main assembly of the image forming apparatus A, and the operation thereof will be described hereinafter.

Here, the preferred arrangement of the rotating member 991 of the load applying mechanism 990 is similar to that of the missing tooth gear 591 in Embodiment 5, and therefore the explanation thereof will be omitted.

<Engaging Operation with Drive Transmission Member>

Referring to FIG. 114 and FIG. 115, the operation in which the drive transmission member 81 is driven and the coupling engages will be described. Here, the mounting of the cartridge B into the main assembly of the image forming apparatus A is similar to that in Embodiment 2, and therefore the description thereof will be omitted.

FIG. 114 is cross-sectional views showing the operation in which the drive transmission member 81 is driven and the gear portion 81a is moving, and the Figure is a view taken along a line which passes through the position of the projecting portion 991d of the rotating member 991 and is perpendicular to the longitudinal direction D900. Part (a) of FIG. 114 shows an initial stage of the driving of the drive transmission member 81, and part (b) of FIG. 114 shows the state immediately after the drive transmission member 81 is driven and the gear portion 81a moves. FIG. 115 is sectional views showing the state in which the drive transmission member 81 is driven and the gear portion 81a moves in the longitudinal direction. Part (a) of FIG. 115 is a sectional view taken along a line X900-X900 of part (a) of FIG. 114, and part (b) of FIG. 114 is a sectional view taken along a line X901-X901 of part (b) of FIG. 114. Part (a) of FIG. 115 and part (b) of FIG. 115 show the state before the coupling is engaged, and part (c) of FIG. 115 shows the state after the coupling is engaged.

Before the cartridge is mounted and immediately after it is mounted in the main assembly, the rotating member 991 is in the initial position (engagement position, pre-movement position).

As shown in part (a) of FIG. 114, when the drive transmission member 81 rotates in the rotational direction CW, a reaction force FD90 is produced by the engaging force FD1 between the gear portion 81a and the projecting portion 991d of the rotating member 991, as in Embodiment 2. At this stage, the inclined gear portion 81a moves in the direction of the engaging reaction force FD90, and therefore not much force is transmitted to the projecting portion 991d and the engaging force FD1 is very small. Therefore, the rotation torque on the rotating member 991 by the engaging force FD1 is smaller than the load torque T90 from the friction force imparting surface 992a1 of the rotating member 991, and therefore the rotating member 991 does not rotate. Therefore, the gear portion 81a is moved by the reaction force FD90. As a result, the rotational axis Ax3 of the drive transmission member 81 moves in a direction which coincides with the rotational axis Ax1 of the drum 62.

Then, as in Embodiment 2, as shown in part (b) of FIG. 114, the gear portion 81a abuts against the restricting portion 73j, and the rotational axis Ax3 of the drive transmission member 81 and the rotational axis Ax1 of the drum 62 become substantially coaxial. The drive transmission member 81, the movement of which is restricted by the gear portion 81a abutting against the restricting portion 73j, can sufficiently transmit force from the gear portion 81a to the projecting portion 991d. Therefore, the engaging force FD2 between the gear portion 81a and the projecting portion 991d which rotates the rotating member 991 increases. The rotating member 991 rotated in the rotational direction R90 by the engaging force FD2 rotates relative to the load applying member 992, and the load torque T90 acts on the friction force imparting surface 992a1.

As shown in part (a) of FIG. 115, a load torque T90 of the rotating member 991 produces a thrust force FA in the gear portion 81a from a reaction force FD91 of an engaging force FD2 (see part (b) of FIG. 114) with the projecting portion 991d. This thrust force FA moves the drive transmission member 81 in the longitudinal direction D900 in the direction of the arrow E91 (the side approaching the cartridge).

As shown in part (b) of FIG. 115, an end portion 81a3 on the end surface on the arrow E91 side of the gear portion 81a abuts against and presses the pressed surface 991c2 of the rotating member 991. This causes the rotating member 991 to move in the direction of the arrow E91 against the force F90 of the urging member 993. In other words, the rotating member 991 is displaced from the initial position in the direction of the arrow E91 and moves to the retracted position (position after movement). The force F90 from the urging member 993 is sufficiently small as compared to the thrust force FA.

The retracted position of the rotating member 991 (see part (c) of FIG. 115) is located inside the initial position (see part (b) of FIG. 115) in the axial direction of the drum 62. In other words, when the rotating member 991 is in the retracted position (see part (c) of FIG. 115), the distance from the non-driven side of the cartridge to the rotating member 991, measured along the axial direction of the drum 62, is shorter than when the rotating member 991 is in the initial position (see part (b) of FIG. 115).

After this, as shown in part (c) of FIG. 115, when the rotating member 991 moves to the retracted position in the direction of arrow E91, the coupling engagement is established as in Embodiment 2. In this state, in addition to the thrust force FA, the thrust force FC produced when the coupling engages also acts on the rotating member 991.

After that, when the image forming operation is completed and the drive transmission member 81 stops driving, the thrust force FA disappears. At this time, the force F90 of the urging member 993 acts in a direction to disengage the coupling, but since the surface where the coupling projection 263b and the coupling recess 81b engage is twisted (inclined), the movement of the gear portion 81a in the direction of the arrow E90 is restricted. Therefore, the coupling engagement is maintained. Here, if the torque for driving the drum 62 is low and the drum rotates due to vibration or the like, with the result of the coupling disengagement, and when the drive transmission member 81 is driven again, the coupling re-engages through the same process as described above. Therefore, the image forming operation can be performed without any problems.

In this embodiment, as the drive transmission member 81 approaches the cartridge, the rotating member 991 also moves from the initial position (see part (b) of FIG. 115) to the retracted position (see part (c) of FIG. 115). In addition, the rotating member 991 maintains an engaged state with the drive transmission member 81 during the movement from the initial position (see part (b) of FIG. 115) to the retracted position (see part (c) of FIG. 115).

Therefore, the drive transmission member 81 can move smoothly toward the cartridge.

In this embodiment, the rotating member 991 is engaged with the drive transmission member 81 to receive the driving force, but it is not structured to transmit the driving force to other components. However, it is possible to change the structure so that the driving force is transmitted from the rotating member 991 to other components of the cartridge, such as the developing roller 32, in the same way as the developing roller gear 30 in Embodiment 1 (see FIG. 9).

### Modified Example 1 of Embodiment 9

The projecting portion 991d of the rotating member 991 described in the representative example of this embodiment is provided at a position away from the wall portion 991c in the direction of the arrow E90, but it may be provided on the wall portion 991c. Such a modification is shown in the following. For the sake of explanation, the above-described structure may be referred to as a representative example of Embodiment 9, and the structure described in the following may be referred to as Modified Example 1 of Embodiment 9. FIG. 116 is an illustration of this Modified Example. Part (a) of FIG. 116 is an exploded perspective view of the cartridge B of this Modified Example, part (b) of FIG. 116 is a side view of a rotating member 9911, and part (c) of FIG. 116 is a cross-sectional view showing the meshing engagement between the drive transmission member 81 and the projecting portion 9911d. The cross-sectional view of part (c) of FIG. 116 is taken along a line X900-X900 of part (a) of FIG. 114.

As shown in part (a) of FIG. 116, a load applying mechanism 9901 of this Modified Example has a rotating member 9911. Here, the structure other than the rotating member 9911 is the same as this embodiment.

As shown in part (b) of FIG. 116, the projecting portion 9911d of the rotating member 9911 protrudes from the pressed surface 9911c2 of a wall portion 9911c in the direction of an arrow E901 parallel to a rotational axis Ax901.

In this Modified Example, the rotating member 9911 also corresponds to the gear, and the multiple projecting portions 9911d provided thereon correspond to gear teeth.

As shown in part (c) of FIG. 116, when the drive transmission member 81 meshes with the projecting portion 9911d of the rotating member 9911 and rotates in the rotational direction CW, a meshing reaction force F911 is produced in the gear portion 81a. The end portion 81a3 of the gear portion 81a abuts against the projecting portion 9911d perpendicular to the rotational direction CW (parallel to the rotational axis Ax3), and therefore, the meshing reaction force F911 does not include a component force in the longitudinal direction D9001. Therefore, in the gear portion 81a of the drive transmission member 81, no thrust force for moving the drive transmission member 81 is produced in the direction of the arrow E901. On the other hand, a load torque T901 for rotating the rotating member 9911 is produced in the drive transmission member 81, and therefore, a thrust force F901 is produced in the second gear portion 81k as in Embodiment 3 (see part (b) of FIG. 47). This thrust force F901 causes the drive transmission member 81 to move in the direction of the arrow E901 in the longitudinal direction D9001, so that the end portion 81a3 of the gear portion 81a presses and moves the pressed surface 9911c2 of the rotating member 9911, thus establishing engagement off the coupling.

In addition, as the drive transmission member 81 moves, the rotating member 9911 also moves from the initial position to the retracted position.

### Modified Example 2 of Embodiment 9

In Modified Example 1 of this embodiment, the projecting portion 9911d is provided parallel to the rotational axis Ax901, but it may be twisted with respect to the rotational axis Ax901. FIG. 117 is an illustration of this modification. Part (a) of FIG. 117 is an exploded perspective view of the cartridge B of this Modified Example, part (b) of FIG. 117 is a side view of the rotating member 9912, and part (c) of FIG. 117 is a sectional view showing the meshing between the drive transmission member 81 and the projecting portion 9912d. The sectional view in part (b) of FIG. 117 is taken along a line X900-X900 in part (a) of FIG. 114.

As shown in part (a) of FIG. 117, a load applying mechanism 9902 of this Modified Example has a rotating member 9912. The structure other than the rotating member 9912 is the same as that of the representative example of this embodiment.

As shown in part (b) of FIG. 117, the projecting portion 9912d of the rotating member 9912 protrudes from a pressed surface 9912c2 of a wall portion 9912c in the direction of the arrow E902. The projecting portion 9912d is twisted in the direction opposite to a rotational direction R902 about a rotational axis Ax902.

In this Modified Example, the rotating member 9912 corresponds to the gear, and the multiple projecting portions 9912d correspond to the gear teeth.

As shown in part (c) of FIG. 117, when the drive transmission member 81 meshes with the projecting portion 9912d of the rotating member 9912 and rotates in the rotational direction CW, the gear portion 81a receives a reaction force FD902 caused by the meshing. The gear portion 81a of the drive transmission member 81 receives a thrust force F902, which is a component force of the reaction force FD902 in the longitudinal direction D9002. As a result, the drive transmission member 81 moves in the longitudinal direction D9002 in the direction of arrow E912, thus pressing and moving the pressed surface 9912c2 of the rotating member 9912 with the end portion 81a3 of the gear portion 81a, so that the coupling engages.

In this Modified Example, the projecting portion 9912d is twisted with respect to the rotational axis Ax902. Therefore, the meshing rate when the projecting portion 9912d of the rotating member 9912 meshes with the gear portion 81a of the drive transmission member 81 is higher than those of the representative example of this embodiment and the modified example 1 of this embodiment. By using the structure of this modified example, the drive transmission accuracy between the gear portion 81a and the projecting portion 9912d can be improved.

The preferred arrangements of the rotating member 991, the rotating member 9911, and the rotating member 9912 described in the representative example of this embodiment, the modified example 1, and the modified example 2 are similar to those described in the previous embodiments. For example, reference is made to the preferred arrangements of the developing roller gear 30 described in Embodiment 1 (see FIGS. 1, 9, and 20), the rack gear 291 described in Embodiment 2 (see part (b) of FIG. 29), and the missing tooth gear 591 described in Embodiment 5 (see part (b) of FIG. 60).

### Embodiment 10

Next, Embodiment 10 will be described. Here, the description of the same points as those in the previous embodiments may be omitted. In particular, among the elements disclosed in this embodiment, those corresponding to the members described in Embodiments 1 to 9 will be assigned the same names as those in Embodiments 1 to 9, and only the different points from Embodiment 1 to 9 will be described.

In the following embodiment, the drive transmission member 1081 is structured to be tiltable (inclinable) as in Embodiment 1 to 9 (see FIG. 122). Furthermore, in this embodiment, a structure in which a control member (alignment assistant member, movable member, urging member, alignment member, pressing member, lever, arm) 1001 (FIG. 118) is provided on the cartridge will be described.

Furthermore, in Embodiment 1 to Embodiment 9, the drive transmission member 81 is inclined by its own weight, but this is not necessarily required. It is possible that the drive transmission member is inclined by a force other than gravity, and it is also possible that the drive transmission member is inclined in a direction different from the direction of gravity. Therefore, in this embodiment, as shown in FIG. 122, the drive transmission member 1081 is inclined in the direction of an arrow VV by an elastic force F22. By this, the drive transmission member 1081 is moved to a position where it is less likely to interfere with the mounting and dismounting of the process cartridge B, thereby reducing the resistance force when the process cartridge B is mounted and dismounted from the main assembly A of the apparatus (details will be described hereinafter).

### (Structures of Coupling Member and Control Member)

First, referring to FIGS. 118 to 121 and 128, structure of a coupling member 1064 and the control member 1001 will be described.

Part (a) of FIG. 118 is a perspective view of the cartridge B according to this embodiment. Part (b) of FIG. 118 is an exploded perspective view of the cartridge B according to this embodiment. Part (a) of FIG. 119 is a side view of the cartridge B according to this embodiment. Part (b) of FIG. 119 is a sectional view of the drive side end of the cartridge B taken along a line XX-XX in part (a) of FIG. 119.

As shown in part (a) of FIG. 118 and part (b) of FIG. 118, the control member 1001, which is a member for controlling the attitude of the drive transmission member 1081 (FIG. 122), is disposed on the drive side of the frame of the cartridge. The control member 1001 is a movable member which can move relative to a photosensitive drum 1062, and is provided on the side of the cartridge on the driving side. The control member 1001 has a lever shape or an arm shape.

The control member 1001 is provided with a hole 1001c. The hole 1001c is supported by a support boss 1071a provided on a cleaning frame 1071. The drum bearing 1073 is fixed integrally to the cleaning frame 1071. The drum bearing 1073 and the cleaning frame 1071 form a part of the frame of the cartridge. In particular, the drum bearing 1073 and the cleaning frame 1071 are frames that form the cleaning unit 1060. The control member 1001 is mounted to the drum bearing 1073 so as to be rotatable about the axis AA of the support boss 1071a.

In addition, an urging spring 1002, which is a torsion coil spring, is mounted to the support boss 1071a, and one end 1002a of the urging spring 1002 abuts against a pressed portion 1001d of the control member 1001.

Furthermore, the other end 1002b of the urging spring 1002 abuts against abutted portion 1073c of the drum bearing 1073. Therefore, the control member 1001 is urged in the direction of arrow BB by the urging force FF1 of the urging spring 1002.

On the other hand, the drum bearing 1073 is provided with a control member abutment portion (stop portion) 1073a which determines the rotation range of the control member 1001. Since the control member 1001 is urged in the direction of the arrow BB by the urging spring 1002, the contacted portion 1001b of the control member 1001 is in a position abutting the control member abutment portion 1073a. In other words, the movement of the control member 1001 is stopped by the control member abutment portion 1073a abutting against the control member 1001.

Also, as shown in part (a) of FIG. 119, as viewed in the direction of the arrow HH (see part (a) of FIG. 118) parallel to the axis of the drum 1062, the restricting portion (urging portion, actuating portion) 1001a of the control member 1001 is placed at a distance DA near the surface (outer peripheral surface) 1062b of the drum 1062. The position of the control member 1001 in this state is referred to as an acting position of the control member. In this embodiment, the distance DA measured from the surface of the photosensitive drum 1062 to the restricting portion 1001a in a direction perpendicular to the axis of the drum 1062 is selected to be smaller than 0.2 times the radius of the drum 1062.

The restricting portion (urging portion, actuating portion) 1001a is a surface of the control member 1001. As will be described in detail hereinafter, the control member 1001 is a movable member which can move to change the distance from the axis of the photosensitive drum 1062 to its own surface (i.e., the restricting portion 1001a in this embodiment).

In addition, as shown in part (b) of FIG. 119, the restricting portion 1001a of the control member 1001 is disposed at a distance DB on the longitudinally outside of the driven portion 1064a of the coupling member 1064.

Furthermore, as shown in part (a) of FIG. 128 and part (b) of FIG. 128, when an external force is applied to the restricting portion 1001a of the control member 1001, the control member 1001 can rotate in the BB2 direction around the axis AA. At that time, the control member 1001 is rotated in the BB2 direction against the urging force of the urging spring 1002. In this state, the contacted portion 1001b of the control member 1001 does not abut against the control member abutment portion 1073a. The control member 1001 can rotate by a predetermined angle in the direction of the arrow BB2.

In this embodiment, the tooth surface 1036a of the developing roller gear 1036 is located longitudinally outward from the coupling member 1064, and as shown in FIG. 118, the tooth surface 1036a is exposed through the outer surface of the cartridge B.

On the other hand, as shown in FIG. 120, the drive transmission member 1081 of the apparatus main assembly A includes a drive transmitting portion (output coupling portion) 1081a and a gear portion (output gear portion) 1081b. FIG. 121 shows a state in which the coupling member 1064 of this embodiment is engaged with the drive transmission member 1081. During image forming operation, as shown in FIG. 121, the drive transmission member 1081 is positioned coaxially with the drum 1062. The drive transmitting portion 1081a meshes with the driven portion 1064a of the coupling member 1064, and at the same time, the gear portion 1081b meshes with the tooth surface (drive input portion) 1030a of the developing roller gear 1030. As a result, the drive transmission member 1081 is enabled to transmit the driving force to the coupling member 1064 and the developing roller gear 1030 simultaneously.

Like the coupling member 1064, the developing roller gear 1030 is a drive input member (gear member) to which driving force is inputted from outside the cartridge B (i.e., the drive transmission member 1081 of the main assembly of the apparatus). The developing roller gear 1030 is sometimes referred to as the drive input gear member. As in the foregoing embodiments, the coupling member 1064 and the developing roller gear 1030 are provided on the drive side of the cartridge.

### (Structure of Drive Transmission Member)

Next, referring to FIGS. 119 and 122, the structure of the drive transmission member 1081 of the main assembly of the apparatus A will be described.

As in Embodiments 1 to 9, the cartridge B is inserted into the mounting portion of the main assembly of the apparatus A along the guide rails 15h and 15g (see FIGS. 10 and 11). At this time, as shown in part (a) of FIG. 119, a direction CC in which the cartridge B is finally mounted to the main assembly of the apparatus A is approximately perpendicular to a section line XX connecting the center PP of the drum 1062 and the center QQ of the developing roller 1032.

On the other hand, FIG. 122 is a cross-sectional view showing a support structure of the drive transmission member 1081 according to this embodiment. FIG. 122 shows a state in which cartridge B is not mounted in the apparatus main assembly A and the opening/closing door 13 is open. As shown in FIG. 122, a supported portion 1081f of the cylindrical drive transmission member 1081 is supported by a support portion 1085a of the spherical drive transmission member support member 1085. Therefore, the drive transmission member 1081 can tilt about a center RR of the support portion 1085a as a fulcrum, and at the same time, the drive transmission member 1081 can move along a rotational axis EE of the supported portion 1081f.

In addition, an advancing/retracting member 1003 is mounted to the drive transmission member 1081 by means not shown, and is movable in directions of arrows KK and TT (part (a) of FIG. 126) in response to the opening and closing operation of the opening/closing door 13. The advancing/retracting member 1003 is provided with an inclined spring 1006, which is a compression spring, and urges the drive transmission member 1081 at a pressed portion 1081c with an urging force FF2. The urging force FF2 from this inclined spring 1006 causes an abutted portion 1081d of the drive transmission member 1081 to abut against the protrusion 1004 provided on the apparatus main assembly A, and at the same time, the abutted portion 1081e to abut against a protrusion 1005. As a result, the drive transmission member 1081 is inclined in the direction of arrow VV.

At this time, the inclination direction of the drive transmission member 1081 as viewed in the direction of arrow HH, which is parallel to the axis of the drum 1062, is a direction having a component in the direction of an arrow GG that is parallel to the section line XX in part (a) of FIG. 119. It is preferable that protrusions 1004 and 1005 be positioned so that the inclination direction of the drive transmission member 1081 is within a range of +45° with respect to arrow GG (see part (b) of FIG. 123 and part (b) of FIG. 124).

### (Process of Mounting and Dismounting of Cartridge Relative to Apparatus Main Assembly)

Next, referring to FIGS. 123 to 126, the process for mounting cartridge B in the apparatus main assembly A and the operation of the control member 1001 will be described. Here, the control member 1001 is depicted shaded in FIGS. 123 to 126.

Part (a) of FIG. 123 and part (b) of FIG. 123 show the state immediately before the restricting portion 1001a of the control member 1001 contacts the gear portion 1081b of the drive transmission member 1081 during the process of opening the door 13 and mounting cartridge B in the apparatus main assembly A.

Part (a) of FIG. 124 and part (b) of FIG. 124 show the state after the cartridge B is inserted up to the mounting portion of the apparatus main assembly A from the state shown in part (a) of FIG. 123 and part (b) of FIG. 123.

Part (a) of FIG. 125 and part (b) of FIG. 125 show the state after the opening/closing door 13 is closed from the state shown in part (a) of FIG. 124 and part (b) of FIG. 124.

Part (a) of FIG. 126 and part (b) of FIG. 126 show the state after drive is applied from the state shown in part (a) of FIG. 125 and part (b) of FIG. 125.

Before the restricting portion 1001a of the control member 1001 comes into contact with the gear portion 1081b of the drive transmission member 1081, as shown in part (a) of FIG. 123, the drive transmission member 1081 is inclined in the direction of arrow VV, just as in the state when the cartridge B is not mounted in the apparatus main assembly A. As shown in part (b) of FIG. 123, the control member 1001 is urged in the direction of arrow BB by the urging force FF1 of the urging spring 1002, and the contacted portion 1001b of the control member 1001 abuts against the control member abutment portion (stop portion) 1073a of the drum bearing 1073 (active position). In other words, the control member 1001 abuts against the abutment portion 1073a, thereby restricting movement in the direction of arrow BB.

When the cartridge B is further inserted from this point, the restricting portion 1001a of the control member 1001 abuts against the gear portion 1081b of the drive transmission member 1081, as shown in part (a) of FIG. 124 and part (b) of FIG. 124. As shown in part (a) of FIG. 124, the drive transmission member 1081 is subjected to an urging force from the restricting portion 1001a. Part (a) of FIG. 123 to part (b) of FIG. 124, the moment MM2 (not shown) about RR in the direction of arrow VV due to the urging force FF2 and the moment MM3 (not shown) about RR in the direction of an arrow WW due to the urging force FF3 satisfy MM2>MM3. Therefore, the drive transmission member 1081 maintains a tilted state in the direction of arrow VV. Then, the gear portion 1081b of the drive transmission member 1081 is spaced from the tooth surface 1030a of the developing roller gear 1030 by a gap LL. For this reason, throughout the process of mounting cartridge B to the mounting portion of the apparatus main assembly A, the gear portion 1081b of the drive transmission member 1081 does not come into contact with the tooth surface 1030a of the developing roller gear 1030.

On the other hand, as shown in part (b) of FIG. 124, the restricting portion 1001a receives a reaction force FF4 of FF3 from the gear portion 1081b. Part (a) of FIG. 123 through part (b) of FIG. 124, the moment MM1 about AA in the direction of arrow BB due to the urging force FF1 and the moment MM4 about AA in the direction of arrow NN due to the reaction force FF4 satisfy MM1<MM4. Therefore, the control member 1001 rotates in the direction of arrow NN against the urging force FF1 of the urging spring 1002, and the contacted portion 1001b moves away from the control member abutment portion 1073a. At this time, the control member 1001 is in the non-acting position (retracted position). As shown in part (a) of FIG. 124, the restricting portion 1001a of the control member 1001 is retracted away from the axis of the photosensitive drum, thereby allowing the drive transmission member 1081 to tilt.

When the opening/closing door 13 is closed at this point, the advancing/retracting member 1003 moves in the direction of an arrow KK in interrelation with the movement of the opening/closing door 13, as shown in part (a) of FIG. 125. Therefore, the compression amount of the inclined spring 1006 decreases, and the urging force FF2 decreases. As a result, the relationship between the moment MM2 about RR in the direction of the arrow VV due to the urging force FF2 and the moment MM3 about RR in the direction of the arrow WW due to the urging force FF3 of the control member 1001 becomes satisfying MM2<MM3. As a result, the drive transmission member 1081 rotates in the direction of the arrow WW, and the abutment portion 1081e and the protrusion 1005 are separated. Then, the gear portion 1081b of the drive transmission member 1081 and the tooth surface 1030a of the developing roller gear 1030 mesh in the area SS. On the other hand, as shown in part (b) of FIG. 125, the relationship between moment MM1 about AA in the direction of arrow BB due to urging force FF1 of urging spring 1002 and moment MM4 about AA in the direction of arrow NN due to reaction force FF4 of urging force FF3 satisfy MM1>MM4. Therefore, the control member 1001 rotates in the direction of arrow BB from the state shown in part (b) of FIG. 124 and moves until contacted portion 1001b contacts the control member abutment portion 1073a of drum bearing 1073.

The control member 1001 shown in part (a) of FIG. 125 and part (b) of FIG. 125 is located in the operative position, and restricting portion 1001a of control member 1001 applies force FF3 to drive transmission member 1081, thereby reducing the tilt angle of drive transmission member 1081 relative to the photosensitive drum.

When drive is applied to the drive transmission member 1081, as shown in part (a) of FIG. 126, the drive transmission member 1081 moves in the direction of arrow KK, so that the drive transmitting portion 1081a of the drive transmission member 1081 engages with the driven portion 1064a of the coupling member 1064. In this state, the restricting portion 1001a of the control member 1001 does not contact the gear portion 1081b of the drive transmission member 1081, leaving a gap UU. Details of the operation from part (a) of FIG. 125 and part (b) of FIG. 125 to part (a) of FIG. 126 and part (b) of FIG. 126 will be described hereinafter.

Next, the process of dismounting the cartridge B from the apparatus main assembly A will be described. This process is the reverse of the process of mounting the cartridge B in the apparatus main assembly A. When the image forming operation is completed, the drive transmission member 1081 is in the state shown in part (a) of FIG. 126 and part (b) of FIG. 126. When the door 13 is opened, the advancing/retracting member 1003 moves in a direction of arrow TT in interrelation with the movement of the door 13, with the result of the state shown in parts (a) and (b) of FIG. 124, the compression amount of the inclined spring 1006 increases, thereby to increase the urging force FF2. This causes the drive transmission member 1081 to move to the left in the Figures, thus disengaging the drive transmitting portion 1081a of the drive transmission member 1081 (see FIG. 120) from the coupling member 1064. At this time, as described above, the moment MM2 in the direction of arrow VV due to the urging force FF2 and the moment MM3 in the direction of arrow WW due to the urging force FF3 satisfy MM2>MM3. Therefore, the drive transmission member 1081 is inclined in the direction of arrow VV. Accordingly, the gear portion 1081b of the drive transmission member 1081 is separated from the tooth surface 1036a of the developing roller gear 1036 with a gap LL therebetween.

In this state, when the cartridge B is dismounted from the main assembly A of the apparatus, it can be completely dismounted from the main assembly A of the apparatus through the states shown in part (a) of FIG. 123 and part (b) of FIG. 123 while maintaining the state in which the drive transmission member 1081 and the developing roller gear 1030 are not in contact with each other. In other words, before the cartridge B is dismounted, the gear part of the drive transmission member 1081 and the developing roller gear 1030 are out of disengagement from each other, so that the cartridge B can be dismounted with a small force.

### (Engagement of Coupling Member and Drive Transmission Member by Drive of Main Assembly)

Next, the description will be made, in detail, as to the operation from the state in which the drive transmission member 1081 and the coupling member 1064 are not engaged as shown in part (a) of FIG. 125 and part (b) of FIG. 125 to the state in which the drive transmission member 1081 and the coupling member 1064 are engaged as shown in part (a) of FIG. 126 and part (b) of FIG. 126.

First, the structure in which the drive transmission member 1081 moves in the longitudinal direction will be described. In a region SS in part (a) of FIG. 125, a gear portion 1081b of the drive transmission member 1081 meshes with a tooth surface 1030a of the developing roller gear 1030. In such a state, the drive transmission member 1081 rotates in the direction of the arrow CW shown in FIG. 120 (the opposite direction of the arrow N) by a motor (not shown) provided in the main assembly A of the apparatus. The gear portion 1081b of the drive transmission member 1081 and the tooth surface 1030a of the developing roller gear 1030 form helical gears. When the drive transmission member 1081 rotates, the drive transmission member 1081 receives a reaction force of the meshing force caused by the rotation load of the developing roller 1032 from the developing roller gear 1030. As described above, since the gear portion 1081b and the tooth surface 1030a form helical gears, this reaction force has a component in the direction of the arrow KK (a component along the axial direction of the photosensitive drum). As a result, the drive transmission member 1081 is moved in the direction of the arrow KK from the position shown in part (a) of FIG. 125.

Next, referring to parts (a) and (b) of FIG. 127, the support structure for the drive transmission member 1081 will be described. Part (a) of FIG. 127 is a sectional view taken along the rotational axis of the coupling member 1064. Part (b) of FIG. 127 is a schematic sectional view taken along a line YY-YY in part (a) of FIG. 127.

In part (a) of FIG. 127, the drive transmission member 1081 moves in the direction of the arrow KK. The supported portion 1081f of the drive transmission member 1081 is supported by a substantially spherical support portion 1085a of the drive transmission member support member 1085. Therefore, a rotational axis EE of the drive transmission member 1081 can be tilted in the direction of the arrow VV with the fixed end 1081g side of the drive transmission member 1081 as the center of rotation. As a result, an end portion 1081a1 (free end, free end portion of the drive transmission member 1081 on a drive transmitting portion 1081a side receives a force in the direction of an arrow FD (part (b) of FIG. 127), which is the meshing force direction between the gear portion 1081b of the drive transmission member 1081 and the tooth surface 1030a of the developing roller gear 1030. And, the drive transmission member 1081 moves in the direction of arrow FE. At this time, a free end portion 1081b1 (part (a) of FIG. 127 and FIG. 120) of the gear portion 1081b of the drive transmission member 1081 abuts against the restricting portion 1073j (part (a) of FIG. 127 and FIG. 118). As a result, the inclination of the drive transmission member 1081 is maintained within a predetermined range.

Next, referring to FIGS. 123 to 127, the process through which the drive transmission member 1081 is brought into engagement with the coupling member 1064 will be described. In the state shown in part (a) of FIG. 125, the drive transmission member 1081 further rotates about the rotational axis EE, so that the drive transmission member 1081 moves further in the direction of the arrow KK while maintaining the inclination. By maintaining the inclination of the drive transmission member 1081 within a certain range, the driven transmission part 1064a of the coupling member 1064 can enter the inside of the hole of the drive transmitting portion 1081a of the drive transmission member 1081 as shown in part (a) of FIG. 126.

The drive transmitting portion 1081a of the drive transmission member 1081 is a recess having a substantially triangular recess shape as shown in part (a) of FIG. 118. On the other hand, the driven transmission part 1064a of the coupling member 1064 is a convex part having a substantially triangular convex shape as shown in FIG. 120. Therefore, when the phase of the drive transmitting portion 1081a of the drive transmission member 1081 does not match the phase of the driven transmission part 1064a of the coupling member 1064, the driven transmission part 1064a cannot enter inside the drive transmitting portion 1081a. Therefore, the end part 1081a1 (free end, free end portion of the drive transmitting portion 1081a of the drive transmission member 1081 abuts against an end part 1064a1 (free end, free end portion of the driven transmission part 1064a. In this state, the drive transmission member 1081 further rotates about the rotational axis EE. Then, when the phase of the drive transmitting portion 1081a of the drive transmission member 1081 matches the phase of the driven transmission part 1064a of the coupling member 1064, the driven transmission part 1064a of the coupling member 1064 enters inside the drive transmitting portion 1081a of the drive transmission member 1081.

As a result, the drive transmitting portion (recess) 1081a of the drive transmission member 1081 and the driven transmission portion 1064a of the coupling member 1064 engage with each other. By doing so, the drive transmission member 1081 can transmit a driving force to the coupling member 1064.

During the process of the engagement between a recess 1081a of the drive transmission member 1081 and the driven transmission portion 1064a of the coupling member 1064, the rotational axis EE of the drive transmission member 1081 substantially aligns with a rotational axis LC9 of the coupling member 1064.

Through the above-described operations, the drive transmission member 1081 reaches the state to be taken during image forming operation shown in part (a) of FIG. 126 and part (b) of FIG. 126.

In this embodiment, the control member 1001 urges the drive transmission member 1081, thereby not only assisting in the alignment of the drive transmission member 1081 with respect to the coupling member 1064, but also urging the drive transmission member 1081 toward the developing roller gear 1030.

In other words, as the opening/closing door 13 closes, the control member 1001 moves from the non-operative position (retracted position: part (a) of FIG. 124 and part (b) of FIG. 124) to the operative position (part (a) of FIG. 125 and part (b) of FIG. 125). At this time, the control member 1001 urges the drive transmission member 1081, thereby reducing the inclination angle of the drive transmission member 1081 with respect to the photosensitive drum 1062. By doing so, the control member 1001 engages the gear portion (output gear portion) 1081b (see FIG. 120) of the drive transmission member 1081 with the tooth surface (input gear portion) 1030a of the developing roller gear 1030 (see part (a) of FIG. 125 and part (b) of FIG. 125).

With the drive transmission member 1081 urged by the control member 1001, the gear portion 1081b of the drive transmission member 1081 engages with a gear portion 1030a of the developing roller gear 1030 and begins to transmit rotational force (the state shown in part (a) of FIG. 125). At this time, an axial force is produced by the meshing of the gears, so that the drive transmission member 1081 is pulled toward the coupling member 1064. As a result, the recess portion (output coupling portion) 1081a of the drive transmission member 1081 and the driven portion (input coupling portion, convex portion) 1064a of the coupling member 1064 engage with each other (the state shown in part (b) of FIG. 126).

On the other hand, as the opening/closing door 13 opens, the drive transmission member 1081 retracts from the coupling member 1064 and disengages from the coupling member 1064. At the same time, the control member 1001 moves from the operating position (part (a) of FIG. 125 and part (b) of FIG. 125) to the non-operating position (retracted position, part (a) of FIG. 124 and part (b) of FIG. 124). This allows the control member 1001 to tilt the drive transmission member 1081. Since the tilt angle of the drive transmission member 1081 with respect to the photosensitive drum 1062 becomes large, the meshing between the gear portion of the drive transmission member 1081 and the developing roller gear can be released. In this state, the cartridge can be easily dismounted.

The control member 1001 is arranged so as not to interfere with the image forming process performed on the surface of the photosensitive drum 1062. That is, a part of the surface of the photosensitive drum 1062 is exposed from the frame of the cartridge, and the toner image formed on the surface of the photosensitive drum 1062 is transferred onto the main assembly side of the image forming apparatus at this exposed part. Therefore, the control member 1001 is arranged so as not to cover or contact the exposed part of the photosensitive drum 1062 at least when the control member 1001 is placed at the operating position (see part (a) of FIG. 118). In particular, the control member 1001 is arranged so as not to cover or contact the image forming area of the photosensitive drum (area where a toner image can be formed).

The coupling member 1064 of this embodiment is not structured to move between an advanced position and a retracted position, unlike the coupling member 64 of Embodiment 1 (see parts (a)-(d) of FIG. 15). However, when the drive transmission member 1081 starts to drive as described above, the drive transmission member 1081 moves closer to the coupling member 1064, so that the drive transmission member 1081 and the coupling member 1064 can be coupled together. This is because the gear portion (output gear portion) 1081a of the drive transmission member 1081 and the gear member (developing roller gear) 1030 on the cartridge side are helical gears. In other words, when the drive transmission member 1081 is driven, the gears mesh with each other, by which a force pulling the drive transmission member 1081 toward the cartridge side is produced.

This structure of the present embodiment may be employed in other embodiments described in the foregoing or in the following.

For example, in each of the embodiments described above, the developing roller gear 30 is structured to receive the drive force by meshing with a gear portion of a flange member (75) mounted to the end of the photosensitive drum (see FIG. 24). This structure may be modified to expose the gear (gear member, helical gear) 1030 of the developing roller to the outside of the cartridge as in this embodiment, so that it can be directly engaged with the gear portion of the drive transmission member of the main assembly of the image forming apparatus.

If the cartridge has a gear which can directly mesh with the gear portion of the drive transmission member, the force produced by the meshing of the gears, when the drive transmission member is driven, moves the drive transmission member so as to approach to the coupling member on the cartridge side (see FIG. 126). This can assist the connection between the drive transmission member and the coupling member.

In this embodiment, the gear on the cartridge side which engages with the drive transmission member 1081 is the developing roller gear 1030 mounted to the shaft of the developing roller 1032. However, other structures are also possible. In other words, the gear 1030 on the cartridge side shown in part (a) of FIG. 118 does not have to be a gear mounted to the developing roller 1032, and does not have to be a gear for transmitting drive force to the developing roller 1032. In other words, as long as the cartridge has a gear which can mesh with the drive transmitting portion 1081b of the drive transmission member 1081, it does not have to be a developing roller gear.

For example, a structure in which the gear 1030 on the cartridge side is not connected to the developing roller 1032, and the driving force is transmitted only from the gear 1030 to the feeding member 34 (see FIG. 4) by way of an idler gear or a transport member gear, is conceivable. Thus, if a structure is employed in which the driving force received by the gear 1030 is not transmitted to the developing roller 1032, the driving force received by the coupling member 1064 can be transmitted not only to the photosensitive drum but also to the developing roller 1032.

Another example of a modification of this embodiment will be described. It is also possible to employ a structure in which the gear 1030 is not directly mounted to the developing roller 1032 or its shaft, and the driving force is transmitted from the gear 1030 to the developing roller 1032 by way of another drive transmission means (for example, an idler gear).

On the other hand, it is also possible to employ a structure in which the coupling member moves between an advanced position and a retracted position.

### Embodiment 11

Next, Embodiment 11 will be described. In this embodiment, a structure similar to Embodiment 10 is described in more detail. Here, the description of the same points as in the previous embodiment will be omitted.

In particular, among the elements disclosed in this embodiment, those corresponding to the members described in Embodiment 10 will be given the same names as in Embodiment 10, and only the points different from those in Embodiment 10 will be described.

### (Structure of Coupling Member and Control Member)

First, referring to FIGS. 129 to 133, the structure of the control member 1101 will be described.

FIG. 129 is a perspective view showing the appearance of the cartridge according to this embodiment.

Part (a) of FIG. 130 and part (b) of FIG. 130 are exploded perspective views of the cartridge according to this embodiment.

FIG. 131 is a side view illustrating the support structure of the control member 1101 and the urging spring 1102 in the cartridge according to this embodiment.

FIG. 132 is a side view of the cartridge according to this embodiment.

Part (a) of FIG. 133 is a sectional view of the cartridge according to this embodiment, taken along a line XX1 in part (a) of FIG. 132.

As shown in part (a) of FIG. 129, a drum bearing 1173 is fixed integrally to a cleaning frame 1171 by a screw 1107. The drum bearing 1173 and the cleaning frame 1171 constitute a part of the cartridge frame. In particular, the drum bearing 1173 and the cleaning frame 1171 are frames that constitute the cleaning unit 1060. The control member 1101 for controlling an attitude of the drive transmission member 1081 (see FIG. 122), is mounted to the drum bearing 1173 so as to be rotatable about the axis AA1 by the structure described below, and is further urged in the direction of an arrow BB1. Part (b) of FIG. 129 shows a state in which the control member 1101 is rotated from the state shown in part (a) of FIG. 129 in the direction of the arrow NN1, which is the opposite direction to the arrow BB1.

As shown in part (a) of FIG. 130 and part (b) of FIG. 130, in this embodiment, as in Embodiment 10, the control member (movable member) 1101 is disposed on the drive side (the side on which the coupling member is disposed) of the cartridge. The control member 1101 is provided with a shaft portion 1101a and a shaft portion 1101b. The shaft portion 1101a and the shaft portion 1101b are disposed coaxially. On the other hand, the drum bearing 1173 is provided with holes 1173a and 1173b coaxially, and the hole 1173a supports the shaft portion 1101a and the hole 1173b supports the shaft portion 1101b so that they can rotate about the axis AA1. An urging spring (urging member, elastic member) 1102, which is a torsion coil spring, is mounted to an inside 1101c of the control member 1101.

As shown in part (a) of FIG. 131, a coil portion 1102c of the urging member 1102 is inserted into the shaft portion 1101b of the control member 1101, and one end 1102a of the urging spring 1102 abuts against a pressed portion 1101d of the control member 1101. The other end 1102b of the urging spring abuts against the abutted portion 1173c of the drum bearing 1173. As a result, the control member 1101 receives an urging force FF11 from the urging spring 1102 at the pressed portion 1101d, and is urged in the direction of arrow BB1 to the drum bearing 1173. In addition, as shown in part (b) of FIG. 131, the control member 1101 is provided with a guided rib 1101e (protrusion). The guided rib 1101e is a protrusion which protrudes outward in the axial direction of the photosensitive drum, and is a part which constitutes the guide portion (control member side guide portion).

On the other hand, as shown in FIG. 129, the drum bearing 1173 is provided with a control member contact portion 1173d which defines the rotation range of the control member 1101. Since the control member 1101 is urged in the direction of the arrow BB1 by the urging spring 1102, the contacted portion 1101g (see part (b) of FIG. 130) of the control member 1101 is in a position in which it is in contact with the control member contact portion (stop portion) 1173d. The position of the control member 1101 at this time is referred to as a normal position with respect to the drum bearing 1173. Part (a) of FIG. 132 shows the cartridge as viewed in the arrow HH1 direction parallel to an axis PP1 of the drum 1062 (see part (a) of FIG. 129).

In the normal position in which the contacted portion 1101g is in contact with the control member contact portion 1173d, the cartridge is viewed along the axis PP1 of the drum 1062. Then, as described above, the restricting portion (acting portion, urging portion) 1101h of the control member 1101 is disposed in the neighborhood of the surface 1062b of the drum 1062, as shown in part (a) of FIG. 132. This is the state in which the control member 1101 is placed at the operating position.

At this time, the restricting portion 1101h is set to be located at a distance DC1 from the axis PP1 of the drum 1062. In this embodiment, the distance DC1 is set to satisfy the relationship of “DC1<DA1×1.2” with respect to a drum radius DA1. DC1 is smaller than 1.2 times the drum radius (i.e., 120%). As in Embodiment 8, the operating position of the control member 1101 is the position in which the control member 1101 acts on the drive transmission member (details will be described hereinafter).

In other words, the control member 1101 can be placed so that the distance from the restricting portion 1101h, which is the surface of the control member 1101, to the axis of the drum is smaller than 1.2 times the drum radius (i.e., 120%).

As described above, when the control member 1101 is in the operating position shown in part (a) of FIG. 132 and the restricting portion 1101h is in the neighborhood of the circumferential surface of the drum 1062, the movement of the control member 1101 is stopped by the stop portion 1173d. However, this is not an inevitable structure. In other words, a structure in which the control member 1101 does not stop at the operating position and the restricting portion 1101h can move so as to be closer to the axis of the drum 1062 than the state shown in part (a) of FIG. 132 is also possible. It will suffice if the operating position and the non-operating position (retracted position) which will be described hereinafter are in the movement range of the control member 1101, and a structure in which the control member 1101 does not stop at the operating position is also possible. In other words, there is no theoretical lower limit to the distance DC1 from the restricting portion 1101h of the control member 1101 to the axis of the drum, and the control member 1101 may be positioned so that this distance is 0.

As shown in part (a) of FIG. 133, the restricting portion 1101h of the control member 1101 is disposed at a distance DB1 from the driven portion 1064a of the coupling member 1064, on the outside in the longitudinal direction (on the left side in the figure). In this embodiment, the entire control member 1101 is disposed at a position outside the free end portion of the coupling member 1064 in the longitudinal direction.

When the control member 1101 is disposed at the operating position, the control member 1101 is disposed so as not to interfere with the image forming process operation performed on the surface of the photosensitive drum 1062. The control member 1101 does not cover or touch the image forming area of the photosensitive drum 1062.

In addition, as shown in FIG. 132, the control member 1101 has a retracting portion (recess) 1101f at a distance DE1 from the axis PP1. Here, the relationship between the distance DE1 and the distance DC1 is DE1>DC1. The retracting portion 1101f is a recess (narrow width portion) recessed to reduce the width of the control member 1101, and is recessed so as to be remote from the axis PP1 of the photosensitive drum when the control member 1101 is placed at the operating position.

In addition, as shown in part (b) of FIG. 132, when an external force is applied to the control member 1101, the control member 1101 can rotate in the direction of the arrow NN1 about the axis AA1 against the urging force FF11 of the urging spring 1102. In this state, the contacted portion 1101g of the control member 1101 is separated from the control member contact portion 1173d. That is, the control member 1101 can rotate in the direction of the arrow NN1 by a predetermined angle. At this time, a distance DC2 between the restricting portion 1101h of the control member 1101 and the rotational axis PP1 of the drum 1062 satisfies DC1<DC2. As in Embodiment 10, the position to which the control member 1101 has moved so that the restricting portion 1101h is away from the axis PP1 of the drum 1062 is called a non-operative position (retracted position) as in Embodiment 10.

The structure is such that by movement of the control member 1101 from the operative position to the non-operative position, the surface portion in the neighborhood of the tip of the control member 1101, i.e., the restricting portion 1101h moves away from the axis PP1 of the drum 1062.

The control member 1101 can rotate smoothly about an axis AA1 even if an external force is applied to any portion of a first guided portion 1101k or a second guided portion 1101m shown in part (b) of FIG. 131 (the area indicated by the dotted line in the Figure). This is because a pressure angle θ11 at a position of the first guided portion 1101k about the axis AA1, and a pressure angle θ12 at any position of the second guided portion 1101m are formed so that they satisfy 011<60° and 012<60°, respectively.

The first guided portion 1101k is a part of a guided rib 1101e, and the second guided portion 1101m is a part including the restricting portion 1101h. These are guide portions (control member side guide portions) provided on the control member.

Here, the pressure angle is one of design parameters of the cam. The pressure angle θ12 of the control member 1101 will be taken as an example for explanation. It is assumed that the cam (control member 1101) operates by receiving an external force FF14 at a certain point 1101m2. At this time, the pressure angle is defined as an angle between the tangent line of a locus SS1 (which is a rotation locus about the axis AA1 in this embodiment) along which the point 1101m2 moves and a direction of the external force FF14 (i.e., the normal direction of the surface on which the point exists). In general, the smaller the pressure angle, the smoother the cam can operate. In this embodiment, the pressure angle is set to 60 degrees or less at any point of the first guided portion 1101k and the second guided portion 1101m including the restricting portion 1101h.

As shown in part (b) of FIG. 133, the control member 1101 has a fixed end portion (first end) 1101U having the shaft portion 1101a and the shaft portion 1101b, a free end portion (free end, second end) 1101S having the restricting portion 1101h, and an intermediate portion 1101T connecting the free end portion and the fixed end.

The guided rib 1101e is disposed on the intermediate portion of the control member 1101. The intermediate portion 1101T includes the above-described retracting portion 1101f, and the width of the intermediate portion 1101T is narrowed at the retracting portion 1101f. In other words, the retracting portion 1101f is a narrow portion having a smaller width than the surrounding area. In part (b) of FIG. 133, the width of the retracting portion 1101f is LA1, and the width of the control member 1101 becomes larger than LA1 as is away from the retracting portion 1101f. A maximum width of the fixed end portion 1101U and a maximum width of the free end portion 1101S are larger than a minimum width LA1 of the intermediate portion 1101T.

As in Embodiment 10, the coupling member 1064 is fixed integrally to the drum 1062 in this embodiment as well. In addition, as shown in FIG. 129, the tooth surface 1030a of the developing roller gear 1030 is located on the outer side in the longitudinal direction relative to the coupling member 1064, and the tooth surface 1030a is exposed through the outer surface of the cartridge B.

In this embodiment, the structure of the drive transmission member 1081 is the same as that of Embodiment 10 (see FIG. 120 to FIG. 122), and therefore, the description is omitted in this embodiment.

(Operation when Inserting Cartridge)

Next, referring to FIGS. 134 to 137, the description will be made as to the process of mounting the cartridge B to the main assembly A of the apparatus and the operation of the control member 1101 at that time. FIGS. 134 to 137 show the process of opening the door 13 and mounting the cartridge B to the main assembly A of the apparatus.

Part (a) of FIG. 134 is a side view of the cartridge B at a predetermined timing before it is mounted to the final mounting position during the process of mounting the cartridge B to the main assembly A of the apparatus. Part (b) of FIG. 134 is a view of the drive transmission member and the cartridge as viewed in the direction of the arrow HH1 shown in part (a) of FIG. 134. As shown in parts (a) and (b) of FIG. 134, when the cartridge B is mounted in the main assembly A of the apparatus in the direction of an arrow CC1, the first guided portion 1101k of the control member 1101 is in contact with a first guide portion 1182 provided in the main assembly A of the apparatus at a contact point 1101k1. Therefore, the control member 1101 takes an attitude provided by rotation in the direction of the arrow NN1 about the axis AA1 from the normal position relative to the drum bearing 1173. In FIG. 134, the first guide portion 1182 is in contact only with the contact point 1101kl of the first guided portion 1101k, but this is not limited to a specific point. During the mounting process, the contact point 1101k1 moves within the range of the first guided portion 1101k shown by the dotted line in part (b) of FIG. 131.

The cartridge B is further inserted in the direction of the arrow CC1 from here. Then, as shown in FIG. 135, a point 1101m1 in the second guided portion 1101m of the control member 1101 comes into contact with the second guide portion 1183 provided in the neighborhood of the upper portion of the drive transmission member 1081 of the main assembly A of the apparatus. Therefore, as in FIG. 134, the control member 1101 takes an attitude provided by rotation in the direction of the arrow NN1 from the normal position. As in the description with respect to FIG. 134, the contact point 1101m1 is not limited to a specific point, but moves in the second guided portion 1101m shown by the dotted line in part (b) of FIG. 131 during the mounting process. At this time, the first guided portion 1101k is separated from the first guide portion 1182.

The cartridge B is further inserted in the direction of the arrow CC1, and the cartridge B is mounted to the final mounting position, which is the position for the printing operation. At this time, as shown in FIG. 136, the restricting portion 1101h of the control member 1101 is in contact with the gear portion 1081b of the drive transmission member 1081. Here, as described in the previous embodiment with reference to FIG. 124, the drive transmission member 1081 maintains a state of being inclined in the direction of the arrow

VV. The control member 1101 receives a reaction force FF4 from the gear portion 1081b of the drive transmission member 1081, and a moment MM4 about an arrow NN1 due to the reaction force FF4. At this time, the moment MM11 about an arrow BB1 due to the urging force FF11 (see part (a) of FIG. 131) which the control member 1101 receives from the urging spring 1102 and the moment MM4 due to the reaction force FF4 satisfy MM11<MM4. Therefore, the control member 1101 is takes a position provided by rotation from the normal position in the direction of the arrow NN1 about the axis AA1 against the urging force FF11 of the urging spring 1102. As a result, the gear portion 1081b of the drive transmission member 1081 is separated from the tooth surface 1030a of the developing roller gear 1030 with a gap LL1.

When the opening/closing door 13 is closed, the reaction force FF4 is reduced by the structure described in the previous embodiment with reference to FIG. 125. As a result, the moment MM11 about the arrow BB1 caused by the urging force FF11 received by the control member 1101 and the moment MM4 caused by the reaction force FF4 become satisfying MM11>MM4. As a result, the control member 1101 rotates in the direction of the arrow BB1 about the axis AA1 as shown in FIG. 137. Thereafter, the contacted portion 1101g of the control member 1101 contacts the control member contact portion 1173d of the drum bearing 1173, and the control member 1101 is in the normal position with respect to the drum bearing 1173. In other words, the control member 1101 is in the operating position. At the same time, the drive transmission member 1081 is rotated in the direction of the arrow WW shown in FIG. 125 by the contact force FF3 received from the restricting portion 1101h of the control member 1101, so that the inclination angle of the drive transmission member 1081 becomes smaller. As a result, the gear portion (output gear portion) 1081b of the drive transmission member 1081 and the tooth surface 1030a of the developing roller gear (gear member) 1030 mesh with each other in the region SS1. Alternatively, they become capable of meshing. In this manner, the operating position of the control member 1101 is a position where the control member 1101 reduces the inclination angle of the drive transmission member 1081 so that the drive transmission member 1081 can be connected to the cartridge.

When drive is applied to the drive transmission member 1081 while the gear portion 1081b of the drive transmission member 1081 and the developing roller gear 1030 can mesh, a force is applied to the drive transmission member 1081 in the direction of the arrow KK (see part (a) of FIG. 126), as in the previous embodiment. This force is produced by the meshing of the helical gears (gear portion 1081b and gear portion 1030a). This force causes the drive transmission member 1081 to move in the direction of the arrow KK, so that the drive transmitting portion 1081a of the drive transmission member 1081 engages with the driven portion (drive force receiving portion) 1064a of the coupling member 1064.

At this time, the control member 1101 is in the regular position relative to the drum bearing 1173. As a result, as shown in FIG. 138, in this state, the restricting portion 1101h of the control member 1101 does not contact the gear portion 1081b of the drive transmission member 1081, and a gap UU1 is formed. This is preferable because the restricting portion 1101h does not affect the drive (rotation) of the drive transmission member 1081.

This structure can be employed because, as described above, when the control member 1101 is placed in the operative position (when the control member 1101 is in the normal position), the contacted portion 1101g (see part (b) of FIG. 130) of the control member 1101 abuts against the stop portion 1173d (see part (a) of FIG. 130). In other words, the stop portion 1173d stops the movement of the control member 1101 by abutting against the contacted portion 1101g, so that the restricting portion 1101h does not contact the drive transmission member 1081.

However, this structure does not necessarily have to be employed. If there is no stop portion 1173d or if the position of the stop portion 1173d is different, the movement of the control member 1101 may not be stopped at the operating position. In other words, it is possible for the restricting portion 1101h to approach the axis of the photosensitive drum even closer than the position shown in FIG. 138. With this structure, the drive transmission member 1081 performs driving in the state that the restricting portion 1101h is in contact with the drive transmission member 1081.

In other words, in this embodiment, when the restricting portion 1101h of the control member 1101 approaches closest to the axis of the photosensitive drum, it is close to the surface 1062b of the photosensitive drum 1062 (see part (a) of FIG. 132). However, it is possible to employ a structure in which the restricting portion 1101h can approach the axis of the drum 1062 even closer than this.

In any case, if the control member 1101 can move at least until the restricting portion 1101h approaches the peripheral surface of the photosensitive drum 1062, the control member 1101 can urge the drive transmission member 1081 tilted by the restricting portion 1101h (see FIG. 137). This allows the gear portion 1081b of the drive transmission member 1081 to mesh with the developing roller gear 1030 on the cartridge side. In this embodiment, when the restricting portion 1101h approaches the axis of the photosensitive drum 1062 to the closest position, the distance DC1 from the restricting portion 1101h to the axis of the photosensitive drum satisfies “DC1<DA1×1.25” with respect to the radius DA1 of the drum 1062. In particular, in this embodiment, the distance DC1 is selected to satisfy “DC1<DA1×1.2”.

The distance from the restricting portion 1101h to the axis of the photosensitive drum 1062 is the shortest distance between them. In other words, it is the distance measured from the restricting portion 1101h to the axis of the photosensitive drum 1062 along a direction perpendicular to the axis of the photosensitive drum.

When the control member 1101 is in the operative position and viewed along the axis of the photosensitive drum, the restricting portion 1101h is the part of the control member 1101 that is closest to the outer circumferential surface of the drum 1062.

The restricting portion 1101h is an actuating portion which acts on the drive transmission member 1081. More specifically, the restricting portion 1101h is an urging portion which urges the drive transmission member 1081. When the control member 1101 is in the operative position, the restricting portion 1101h faces the side on which the axis of the photosensitive drum 1062 is located (see FIG. 133).

Depending on the method of supporting the drive transmission member 1081 in the main assembly A of the apparatus, immediately after the opening/closing door 13 is closed, the drive transmission member 108 may be inclined downstream of the arrow CC1, which is the mounting direction, as shown in FIG. 139. In such a case, it is predicted that the drive transmission member 1081 does not mesh with the developing roller gear 1030 and is sandwiched between the restricting portion 1101h of the control member 1101 and the contact portion 1126a provided on the side cover 1126.

The contact portion 1126a is an opposing portion (opposing surface) that faces the restricting portion 1101h when the control member 1101 is placed at the operating position.

Here, as shown in FIG. 138, the intersection of the tangent line of the contact portion 1126a and the tangent line of the restricting portion 1101h of the control member 1101 is referred to as QQ1. This intersection point QQ1 is set to be on the opposite side of a charging roller 1066 with respect to a straight line GG1 which connects the axis PP1 of the drum 1062 and an axis RRI of the developing roller gear 1030. That is, by extending the tangent line to the contact portion 1126a and the tangent line to the restricting portion 1101h away from the charging member (charging roller 1066), these two tangents intersect each other.

Furthermore, an angle θ13 between the tangent lines of the contact portion 1126a and the restricting portion 1101h is set to be “θ13>25°”. That is, 013 is greater than 25 degrees.

At this time, as shown in FIG. 139, the control member 1101 is urged in the direction of the arrow BB1 by the urging spring 1102, so that the drive transmission member 1081 receives a contact force FF12 from the control member 1101. At the same time, the drive transmission member 1081 receives a contact force FF13 from the contact portion 1126a of the side cover 1126. By these two contact forces, the drive transmission member 1081 is pulled in the direction of the arrow DD1, and the gear portion 1081b meshes with the tooth surface 1030a of the developing roller gear 1030, resulting in the state shown in FIG. 137. In other words, by sandwiching the drive transmission member 1081 between the control member 1101 and the contact portion 1126a, the inclination angle of the drive transmission member 1081 is reduced, and the drive transmission member 1081 is brought closer to the developing roller gear and to the coupling member 1064. The contact portion 1126a is a sandwiching portion for sandwiching the drive transmission member 1081 between itself and the control member 1101.

In this way, as a mechanism for reducing the inclination of the drive transmission member 1081, in addition to the movable control member 1101, the cartridge may also be provided with a fixed contact portion 1126a.

### (Dismounting Cartridge)

Next, the process of dismounting cartridge B from main assembly A of the apparatus will be described. As in the previous embodiment, this process is the reverse of the process of mounting cartridge B to main assembly A of the apparatus. When image formation is completed, drive transmission member 1081 is in the state shown in part (a) of FIG. 126 and FIG. 139. When opening/closing door 13, the drive transmission member 1081 is tilted in the direction of arrow VV (see part (a) of FIG. 124) by the same structure as in the previous embodiment, and is in the state shown in part (a) of FIG. 124 and FIG. 136. That is, drive transmission member 1081 is tilted. As a result, gear portion 1081b of drive transmission member 1081 and tooth surface 1030a of developing roller gear 1030 are separated with gap LL1. Since meshing between gear portion 1081b and developing roller gear 1030 is released, the cartridge can be dismounted from the main assembly of the image forming apparatus with a light load.

From this state, when the cartridge B is omitted in the direction of arrow EE1, which is the opposite direction to arrow CC1, cartridge B can be completely omitted from apparatus main assembly A while maintaining a state in which gear portion 1081b and tooth surface 1030a are not in contact with each other, by way of the states of FIG. 135 and then FIG. 134.

In FIG. 136, the control member 1101 is retracted from the operative position toward the inoperative position to allow inclination of drive transmission member 1081. That is, the control member 1101 is moved so as to move the restricting portion 1101h of the control member 1101 away from the axis of the photosensitive drum 1062. In this embodiment, the distance DC2 (see part (b) of FIG. 132) from the restricting portion 1101h to the axis of the drum 1062 when the control member 1101 is moved to the inoperative position satisfies “DC2>1.25×DA1”. When the control member 1101 moves to the non-operating position, the distance DC2 becomes greater than 1.25 times the radius of the drum 1062. This is to allow the drive transmission member 1081 to tilt.

That is, the restricting member 1101 can be positioned such that the distance DC2 from the restricting portion 1101h, which is the surface of the control member 1101, to the drum axis is greater than 1.25 times the radius of the drum (i.e., 125%).

However, the control member 1101 of this embodiment is structured so that the movable range of the restricting portion 1101h is even greater than this condition. That is, when the control member 1101 is positioned in the non-operating position (retracted position), it is possible to move the restricting portion 1101h even further away from the axis of the photosensitive drum. This is because, as shown in part (a) of FIG. 134 and FIG. 135, the control member 1101 is guided by the main assembly side guides (first guide portion 1182, second guide portion 1183) when the cartridge is mounted or dismounted. In other words, this is because a structure is employed which allows the control member 1101 to move through a large amount.

By moving the surface portion (restricting portion 1101h) in the neighborhood of the free end portion of the control member 1101 significantly away from the axis of the photosensitive drum, the control member 1101 can pass above the drive transmission member 1081 when the cartridge is mounted or dismounted.

In order to allow the guide portions (first guided portion 1101k, second guided portion 1101m) of the control member 1101 to be smoothly guided by the main assembly side guides (1182, 1183) in this manner, this embodiment is further structured to satisfy the following condition. The control member 1101 can move so that the distance DC2 from the restricting portion 1101h of the control member 1101 to the axis of the drum 1062 satisfies “DC2>1.5×DA1” with respect to the radius DA1 of the drum 1062. The control member 1101 can move to a non-acting position (retracted position) where DC2 is greater than 1.5 times the radius of the drum 1062. In particular, in this embodiment, “DC2>2×DA1” is satisfied.

That is, the restricting member 1101 can be positioned such that the distance DC2 from the restricting portion 1101h, which is the surface of the control member 1101, to the drum axis is more than twice the radius of the drum (i.e., more than 200%).

There is no theoretical upper limit to the maximum value of this distance DC2. However, in order to keep the cartridge size small, DC2 is set to be less than 5 times the radius of the drum.

In this embodiment, the drive transmission member 1081 moves in the direction of the arrow KK shown in FIG. 124 by meshing with the developing roller gear 1030 provided on the developing roller 1032. However, as described above, the gear member on the cartridge side for meshing with the drive transmission member 1081 does not necessarily have to be provided on the developing roller 1032 (see FIG. 121).

In this embodiment, the control member 1101 rotates about the axis AA1, but this structure is not necessarily required. For example, as shown in FIG. 140, the control member 1101, which is urged in the direction of the arrow BB2 by the urging spring 1102 supported by the drum bearing 1173, may slide in the direction of an arrow AA2 along a guide rail 1173e. In this structure, the distance DC1 between the restricting portion 1101h in the normal position shown in part (a) of FIG. 140 and the axis PP1 of the drum 1062, and a distance DC3 between the restricting portion 1101h and the axis PP1 in the position in which the control member 1101 slides in the direction of the arrow AA2 shown in part (b) of FIG. 140 satisfy DC1<DC3. Therefore, it is possible to provide the same effect as with the structure in which the control member 1101 is rotatable about the axis AA1 as described above.

### Embodiment 12

Hereinafter, one embodiment of the present invention will be described in detail with reference to the drawings.

A direction of a rotational axis of an electrophotographic photosensitive drum is a longitudinal direction.

In addition, in the longitudinal direction, a side where the electrophotographic photosensitive drum receives the driving force from the main assembly of the image forming apparatus is a driving side, and the opposite side is a non-driving side.

Referring to FIG. 141 and FIG. 142, the overall structure and the image forming process will be described.

FIG. 141 is a cross-sectional view of the main assembly (electrophotographic main assembly of the image forming apparatus, main assembly of the image forming apparatus) ZA of the electrophotographic image forming apparatus according to the Embodiment 12 and the process cartridge (hereinafter, referred to as cartridge ZB).

FIG. 142 is a cross-sectional view of the cartridge ZB.

Here, the main assembly ZA of the apparatus is the part of the electrophotographic image forming apparatus excluding the cartridge ZB.

### <Overall Structure of Image Forming Apparatus>

The electrophotographic image forming apparatus (image forming apparatus) shown in FIG. 141 is a laser beam printer using electrophotographic technology in which cartridge ZB is detachably mounted to the main assembly ZA of the apparatus. An exposure device 3003 (laser scanner unit) is disposed so as to form a latent image on an electrophotographic photosensitive drum 3062 as an image bearing member of the cartridge ZB when the cartridge ZB is mounted to the main assembly ZA of the apparatus. In addition, a sheet tray 3004 for storing recording materials (hereinafter referred to as sheet material PA) on which an image is to be formed is disposed below the cartridge ZB. The electrophotographic photosensitive drum 3062 is a photosensitive member (electrophotographic photosensitive member) used for electrophotographic image formation.

In addition, in the apparatus main assembly ZA, a pickup roller 3005a, a pair of feed rollers 3005b, a transfer guide 3006, a transfer roller 3007, a conveyance guide 3008, a fixing device 3009, a pair of discharge rollers 3010, a discharge tray 3011, and so on like are provided in this order along a feeding direction D of the sheet material PA. The fixing device 3009 comprises a heating roller 3009a and a pressure roller 3009b.

### <Image Formation Process>

Next, an outline of the image forming process will be described. In response to a print start signal, an electrophotographic photosensitive drum (hereinafter referred to as a photosensitive drum 3062 or simply as a drum 3062) is rotated in the direction of an arrow R at a predetermined peripheral speed (process speed).

A charging roller (charging member) 3066 to which a bias voltage is applied contacts the outer peripheral surface of the drum 3062, uniformly charges the outer peripheral surface of the drum 3062.

As shown in FIG. 142, the drum 3062 is rotatably supported by a cleaning frame 3071. The cleaning frame 3071 also supports the charging roller 3066 and a cleaning blade 3077.

The exposure device 3003 outputs a laser beam L corresponding to the image information. The laser beam L passes through a laser aperture provided in the cartridge ZB, and scans and exposes the outer peripheral surface of the drum 3062. As a result, an electrostatic latent image corresponding to the image information is formed on the outer peripheral surface of the drum 3062.

On the other hand, as shown in FIG. 142, in the developing unit 3020 as a developing device, toner T accommodated in the toner chamber 3029a provided inside the developing frame 3029 is carried on a surface of a developing roller 3032 by a magnetic force of a magnet roller 3034 (fixed magnet). The developing roller 3032 is a developer carrier for carrying the developer (toner T) on its surface to develop the latent image formed on the drum 3062.

The developing roller 3032 is rotatably supported by the developing frame, and rotates in the direction of an arrow R2 in FIG. 142 during image forming operation. With this rotation, the toner T carried on the surface of the developing roller 3032 is triboelectrically charged by a developing blade 3042, and a layer thickness of the toner on the circumferential surface of the developing roller 3032 is restricted to a constant thickness.

The toner T is supplied to the drum 3062 in accordance with the electrostatic latent image to develops the latent image. As a result, the latent image is visualized into a toner image. The drum 3062 is an image bearing member for carrying a latent image and image (toner image, developer image) formed with toner on its surface. As shown in FIG. 141, the sheet material PA stored in a lower part of the device main assembly ZA is fed out of the sheet tray 3004 by the pickup roller 3005a and the pair of feed rollers 3005b in synchronization with the output timing of the laser light L. Then, the sheet material PA is transported to the transfer position between the drum 3062 and the transfer roller 3007 by way of the transfer guide 3006. At this transfer position, the toner image is transferred from the drum 3062 onto the sheet material PA in sequence.

The sheet material PA onto which the toner image has been transferred is separated from the drum 3062 and is transported to the fixing device 3009 along the conveyance guide 3008. The sheet material PA passes through the nip portion between the heating roller 3009a and the pressure roller 3009b which constitute the fixing device 3009. In this nip portion, a pressure and heat fixing process is performed, and the toner image is fixed on the sheet material PA. The sheet material PA on which the toner image has been fixed is transported to a pair of discharge rollers 3010 and is discharged to a discharge tray 3011.

On the other hand, as shown in FIG. 142, the drum 3062 after being subjected to the transfer operation has residual toner dismounted from its outer circumferential surface by a cleaning blade 3077, and is used again for the image forming process. The toner dismounted from the drum 3062 is stored in a waste toner chamber 3071 formed inside the cleaning frame 3071.

In the foregoing, the charging roller 3066, the developing roller 3032, the transfer roller 3007, and the cleaning blade 3077 are process means that act on the drum 3062.

Of these, the charging roller and cleaning blade 3077 are supported by the cleaning frame 3071 together with the photosensitive drum 3062. The developing roller 3032 is supported by the developing frame 3029. The cleaning frame 3071 and the photosensitive drum 3062 and other members supported by it are collectively called a cleaning unit 3060. The developing frame 3029 and the developing roller 3032, developing blade 3042 and other members supported by it are collectively called a developing unit 3020. The cartridge ZB of this embodiment comprises the cleaning unit 3060 and the developing unit 3020 connected thereto.

One of the cleaning frame 3071 and the developing frame 3029 may be called a first frame (first casing) and the other a second frame (casing). The cleaning frame 3071 and the developing frame 3029 are sometimes collectively referred to as a cartridge frame (casing).

<State in which Door of Apparatus Main Assembly is Open>

Next, mounting of the cartridge will be specifically described.

First, the structure and operation of the apparatus main assembly ZA from the open state to the closed state of the opening/closing door 3013 will be described. Part (a) of FIG. 143 is a perspective view of the apparatus main assembly with the door open, and part (b) of FIG. 143 is a perspective view of the apparatus main assembly with the door closed. FIG. 144 is a sectional view of the drive transmission member with the door closed.

As shown in FIG. 143, the apparatus main assembly ZA is provided with the door 3013, a cylindrical cam link 3085, a cylindrical cam 3086, and cartridge pressing members 3001 and 3002 including pressing springs on the driving side and non-driving side. Further, the apparatus main assembly ZA is provided with a first side plate 3015 on the driving side and a side plate 3016 on the non-driving side. Also, as shown in FIG. 144, the apparatus main assembly ZA is provided with a drive transmission member 3081 and a bearing 3094 for the drive transmission member. A second side plate 3093 is provided on the driving side of the apparatus main assembly ZA, and the bearing 3094 is attached to the second side plate 3093.

The opening/closing door 3013 is an opening and closing member for opening and closing the mounting portion (space for accommodating the cartridge) for mounting the cartridge ZB. The opening/closing door 3013 is rotatably mounted to the first side plate 3015 and the side plate 3016. In addition, when the opening/closing door 3013 of the apparatus main assembly ZA is in an open state, the cartridge ZB is inserted through the cartridge insertion port 3017.

FIG. 145 is a perspective view of the neighborhood of the cylindrical cam in the state that the opening/closing door is open. The cylindrical cam 3086 is mounted to the first side plate 3015 so as to be rotatable and movable in the longitudinal direction, and has three inclined surfaces 3086a, 3086b, and 3086c, and has one end 3086d on the non-driving side in the longitudinal direction, which is continuous with the inclined surfaces. The first side plate 3015 has three inclined surfaces 3015d, 3015e, and 3015f facing the three inclined surfaces 3086a, 3086b, and 3086c, and an end surface 3015g facing the one end 3086d of the cylindrical cam 3086. As shown in FIG. 145, a boss 3086e provided on the cylindrical cam 3086 and a mounting hole 3085b provided in the cylindrical cam link 3085 are rotatably mounted. In addition, a boss 3085a provided at the other end of the cylindrical cam link 3085 and a mounting hole 3013a provided in the opening/closing door 3013 are rotatably mounted.

When the opening/closing door 3013 is rotated to open, the cylindrical cam link 3085 moves in interrelation with the opening/closing door 3013. The movement of the cylindrical cam link 3085 rotates the cylindrical cam 3086 in the clockwise direction P. When the cylindrical cam 3086 rotates, the inclined surfaces 3086a, 3086b, and 3086c slide along the inclined surfaces 3015d, 3015e, and 3015f, so that the cylindrical cam 3086 moves to the driving side in the longitudinal direction. Finally, the cylindrical cam 3086 moves until one end 3086d of the cylindrical cam 3086 abuts against the end surface 3015g of the first side plate 3015 as shown in FIG. 145.

As shown in FIG. 144, the drive transmission member 3081 is supported rotatably and movably in the axial direction by engaging one end (fixed end 3081c) of the drive side in the axial direction with the bearing 3094. The drive transmission member 3081 has an abutment surface 3081e, and the cylindrical cam 3086 has an abutment portion 3086f facing the abutment surface 3081e. The drive transmission member 3081 has a central portion 3081d in the longitudinal direction, and a gap is provided between the first side plate 3015 and itself. In this gap, an inclining member 3097 including an inclination urging spring 3098 for tilting the drive transmission member 3081 is provided on the first side plate 3015. Detailed description of the inclining member 3097 will be made hereinafter.

As described above, the cylindrical cam 3086 moves in the longitudinal direction toward a side away from the cartridge (the drive side). By doing so, the abutment surface 3081e of the drive transmission member 3081 is pressed by the abutment portion 3086f of the cylindrical cam 3086, and the drive transmission member 3081 moves away from the cartridge. By this, the drive transmission member 3081 takes the retracted position. That is, the drive transmission member 3081 retracts from the movement path when the cartridge ZB is mounted in interrelation with the movement of the opening/closing door 3013 toward the open position. This ensures provision of a space for mounting the cartridge ZB in the apparatus main assembly ZA.

The cylindrical cam 3086 is a retracting member (retraction mechanism) for moving the drive transmission member 3081 to the retracted position in interrelation with the movement of the opening/closing door 3013 to the open position.

### <Mounting of Cartridge>

Next, referring to FIG. 146, the mounting of the cartridge ZB will be described. Part (a) of FIG. 146 is cross-sectional views of the apparatus main assembly as viewed from the drive side when the cartridge is mounted.

Part (b) of FIG. 146 is a cross-sectional view of the apparatus main assembly as seen from the non-driven side when the cartridge is mounted.

As shown in FIG. 146, the first side plate 3015 is provided with an upper guide rail 3015h and a lower guide rail 3015i as guides, and the side plate 3016 is provided with an upper guide rail 3016h and a lower guide rail 3016i. In addition, a drum bearing 3073 provided on the driven side of the cartridge ZB is provided with a guided portion 3073g and a rotation-stopped portion 3073c. In the mounting direction (arrow C) of the cartridge ZB, the guided portion 3073g and the rotation-stopped portion 3073c are disposed upstream of the axis of the coupling projection 3063b. In addition, the cleaning frame 3071 is provided with a positioned portion 3071d and a rotation-stopped portion 3071g on the non-driven side in the longitudinal direction.

The mounting direction C of the cartridge ZB is substantially perpendicular to the axis of the drum 3062. When referring to the mounting direction upstream or downstream, the upstream and downstream are defined in terms of the movement direction of the cartridge ZB immediately before the mounting to the apparatus main assembly ZA is completed.

The cartridge ZB is mounted through the cartridge insertion port 3017 of the apparatus main assembly ZA. Then, the driven side of the cartridge ZB is guided by the guided portion 3073g and the rotation-stopped portion 3073c of the cartridge ZB on the upper guide rail 3015h and the lower guide rail 3015i of the apparatus main assembly ZA. The non-driven side of the cartridge ZB is guided by the positioned portion 3071d and the rotation-stopped portion 3071g of the cartridge ZB on the upper guide rail 3016h and the lower guide rail 3016i of the apparatus main assembly ZA. In this way, the cartridge ZB is mounted to the apparatus main assembly ZA.

FIG. 147 is a perspective view of the drive side of the cartridge. As shown in FIG. 147, a developing roller gear 3030 is provided at the end of the developing roller 3032. That is, the developing roller gear 3030 is connected to the shaft of the developing roller 3032.

The developing roller 3032 and the developing roller gear 3030 are coaxial and rotate about the axis Ax2 shown in FIG. 147. The axis Ax2 of the developing roller 3032 is disposed so as to be approximately parallel to the axis Ax1 of the drum 3062. Therefore, the axial direction of the developing roller gear 3030 is approximately parallel to the axial direction of the drum 3062.

The developing roller gear 3030 is a drive input gear (cartridge side gear, drive input member) to which a drive force (rotational force) is inputted from the outside of the cartridge ZB (i.e., the apparatus main assembly ZA). The developing roller 3032 is structured to be rotated by the driving force received by the developing roller gear 3030.

As shown in FIG. 147, on the drum 3062 side of the developing roller gear 3030 on the drive side of the cartridge ZB, there is provided a space 3087 which is open so as to expose the developing roller gear 3030 and the coupling projection 3063b toward outside.

The coupling projection 3063b is formed on the driving side drum flange (coupling member, drum coupling) 3063 mounted to the end of the drum. The coupling projection 3063b is a coupling portion (drum side coupling portion, cartridge side coupling portion, photosensitive member side coupling portion, input coupling portion, driving input portion) to which a driving force (rotational force) is inputted from the outside of the cartridge ZB (i.e., the apparatus main assembly ZA). The coupling projection 3063b is disposed coaxially with the drum 3062. In other words, the coupling projection 3063b rotates about the axis Ax1.

In addition, in the longitudinal direction of the cartridge ZB, the side on which the coupling projection 3063b is provided corresponds to the driving side, and the opposite side corresponds to the non-driving side.

As shown in FIG. 147, the developing roller gear 3030 has a gear portion (input gear portion, cartridge side gear portion, developing side gear portion) 3030a and an end surface 3030a1 provided on the driving side of the gear portion. The teeth (gear teeth) formed on the outer periphery of the gear portion 3030a are helical teeth inclined with respect to the axis of the developing roller gear 3030. In other words, the developing roller gear 3030 is a helical tooth gear.

Here, the term “helical teeth” also includes a shape in which a plurality of protrusions are arranged along a line inclined with respect to the axis of the gear to substantially form a helical tooth portion.

As shown in FIG. 144, the drive transmission member (drive output member, main assembly side drive member) 3081 has a gear portion (main assembly side gear portion, output gear portion) 3081a for driving the developing roller gear 3030. The gear portion 3081a has an end surface 3081a1 at the end on the non-drive side. The teeth (gear teeth) formed on the gear portion 3081a also has helical teeth inclined with respect to the axis of the drive transmission member 3081. In other words, the drive transmission member 3081 also has a portion of a helical gear.

The drive transmission member 3081 also has a coupling recess 3081b. The coupling recess 3081b is a coupling portion (main assembly side coupling portion, output coupling portion) provided on the apparatus main assembly side. The coupling recess 3081b is a recess formed in the coupling cylindrical portion 3081i provided at the free end portion of the drive transmission member 3081 which can be coupled with the coupling projection 3063b provided on the drum side.

The space 3087, to which the gear portion 3030a and the coupling projection 3063b are exposed, is for placing the gear portion 3081a of the drive transmission member 3081 when the cartridge ZB is mounted to the apparatus main assembly ZA. Therefore, the space 3087 is larger than the gear portion 3081a of the drive transmission member 3081. Because of the provision of the space 3087, the drive transmission member 3081 does not interfere with the cartridge ZB when the cartridge ZB is mounted into the apparatus main assembly ZA. The space 3087 allows the drive transmission member 3081 to be disposed therein, thereby allowing the cartridge ZB to be mounted to the apparatus main assembly ZA.

In addition, as shown in FIG. 147, as the cartridge ZB is viewed along the axis of the drum 3062 (the axis of the coupling projection 3063b), the gear teeth formed on the gear portion 3030a are disposed at a position close to the peripheral surface of the drum 3062.

In the axial direction of the developing roller gear 3030, the gear teeth of the gear portion 3030a have an exposed portion 3030a3 exposed out of the cartridge ZB. If the gear portion 3030a of the developing roller gear 3030 is exposed out of the driving side developing member 3026, the gear portion 3081a meshes with the gear portion 3030a without interfering with the driving side developing member 3026, so that the driving force can be transmitted.

And, at least a part of the exposed part of the gear portion 3030a is placed further outside (on the driving side) of the cartridge ZB than the free end portion 3063b1 of the coupling projection 3063b, and faces the axis of the drum. FIG. 147 shows a state in which the gear teeth placed on the exposed portion 3030a3 of the gear portion 3030a face the rotational axis Ax1 of the drum 3062 (the rotational axis of the coupling projection 3063b). The axis Ax1 of the drum 3062 is placed above the exposed portion 3030a3 of the gear portion 3030a.

In FIG. 147, at least a part of the gear portion 3030a projects toward the driving side beyond the coupling projection 3063b in the axial direction, so that the gear portion 3030a overlaps with the gear portion 3081a of the drive transmission member 3081 in the axial direction. And, because a part of the gear portion 3030a is exposed so as to face the axis Ax1 of the drum 3062, the gear portion 3030a and the gear portion 3081a of the drive transmission member 3081 can contact each other during the process of inserting the cartridge ZB into the apparatus main assembly ZA.

Due to the above-described positional relationship, the gear portion 3030a of the developing roller gear 3030 and the gear portion 3081a of the drive transmission member 3081 can mesh with each other during the process of mounting the above-described cartridge ZB into the apparatus main assembly ZA.

In addition, in the mounting direction C of the cartridge ZB, the center (axis) of the gear portion 3030a is positioned upstream of the center (axis) of the drum 3062.

The drum bearing 3073 is provided with an engaging portion 3073h as a portion to be positioned in the longitudinal direction (axial direction). The first side plate 3015 of the apparatus main assembly ZA is provided with an engaging portion 3015j (see FIG. 157) which can be engaged with the engaging portion 3073h. The engaging portion 3073h of the cartridge ZB mates with the engaging portion 3015j of the apparatus main assembly ZA during the above-described mounting process, thereby determining the position of the cartridge ZB in the longitudinal direction (axial direction). In this embodiment, the engaging portion 3073h is a slit (groove).

<Operation to Close Door after Cartridge Mounting>

Next, the state of closing the door 3013 will be described. Part (a) of FIG. 148 is cross-sectional views showing the cartridge pressing part and positioning part on the driving side, and part (b) of FIG. 148 is a cross-sectional view showing the cartridge pressing part and positioning part on the non-driving side.

As shown in FIG. 148, the first side plate 3015 is provided with an upper positioning part 3015a, a lower positioning part 3015b, and a rotation stop portion 3015c for positioning, and the side plate 3016 is provided with a positioning part 3016a and a rotation stop part 3016c. The drum bearing 3073 has an upper positioned part (first positioned part, first protrusion, first protrusion) 3073d and a lower positioned part (second positioned part, second protrusion, second protrusion) 3073f.

In addition, the cartridge pressing members 3001 and 3002 are slidably mounted to respective axial ends of the opening/closing door 3013. Cartridge pressing springs 3001a and 3002a are mounted to the cartridge pressing members 3001 and 3002. As an urging force receiving portion on the cartridge side, the drum bearing 3073 is provided with a pressed portion 3073e on the driving side, and the cleaning frame 3071 includes a pressed portion 3071o on the non-driving side. As an urging force receiving portion on the apparatus main assembly side, the first side plate 3015 includes a pressed portion 3015k, and the side plate 3016 includes a pressed portion 3016k.

By closing the opening/closing door 3013, the pressed portions 3073e, 3071o of the cartridge ZB and the pressed portions 3015k, 3016k of the apparatus main assembly ZA are pressed by the cartridge pressing members 3001, 3002 of the apparatus main assembly ZA. The cartridge pressing members 3001, 3002 are urged by the cartridge pressing springs 3001a, 3002a of the apparatus main assembly ZA.

As a result, on the drive side, the upper positioned portion 3073d, the lower positioned portion 3073f, and the rotation stop portion 3073c of the cartridge ZB contact the upper positioning part 3015a, the lower positioning part 3015b, and the rotation stop portion 3015c of the apparatus main assembly ZA, respectively. As a result, the cartridge ZB and the drum 3062 are positioned in place on the drive side. Also, on the non-driven side, the positioned portion 3071d and the rotation-stopped portion 3071g of the cartridge ZB contact the positioning portion 3016a and the rotation stop part 3016c of the apparatus main assembly ZA, respectively. This positions the cartridge ZB and the drum 3062 in place on the non-driven side.

The pressed portions 3073e and 3071o are disposed at one end (driven side) and the other end (non-driven side) of the cartridge ZB in the longitudinal direction, respectively. In particular, the pressed portion 3073e is provided on the drum bearing 3073. The pressed portions 3073e and 3071o are recessed (V-shaped) so that the positions of the cartridge pressing members 3001 and 3002 are determined, and the cartridge pressing members 3001 and 3002 are positioned by the pressed portions 3073e and 3071o.

As shown in FIG. 147, the upper positioned portion 3073d and the lower positioned portion 3073f are disposed in the neighborhood of the drum 3062. The upper positioned portion 3073d and the lower positioned portion 3073f are arranged along the rotational direction of the drum 3062. In addition, in the drum bearing 3073, between the upper positioned portion 3073d and the lower positioned portion 3073f, a space (arc-shaped recess) 30731 for disposing the transfer roller 3007 needs to be ensured. Therefore, the upper positioned portion 3073d and the lower positioned portion 3073f are disposed apart from each other. The upper positioned portion 3073d and the lower positioned portion 3073f are protrusions protruding from the drum bearing 3073 toward the inside in the axial direction. As described above, it is necessary to provide a space 3087 around the coupling projection 3063b. Therefore, the upper positioned portion 3073d and the lower positioned portion 3073f do not protrude outward in the axial direction, but instead protrude inward to ensure a space 3087.

Furthermore, in FIG. 147, the upper positioned portion 3073d and the lower positioned portion 3073f are arranged so as to partially cover the driving side drum flange 3063 provided at the end of the photosensitive drum 3062. When the upper positioned portion 3073d and the driving side drum flange 3063 are projected onto the axis of the drum 3062, the projected areas of the upper positioned portion 3073d and the driving side drum flange 3063 at least partially overlap. In this regard, the lower positioned portion 3073f is similar to the upper positioned portion 3073d.

Furthermore, as shown in FIGS. 144 and 145, the opening/closing door 3013 is closed. As a result, the cylindrical cam 3086 rotates by way of the cylindrical cam link 3085, with the inclined surfaces 3086a, 3086b, and 3086c rotating along the inclined surfaces 3015d, 3015e, and 3015f of the first side plate 3015. The cylindrical cam 3086 further rotates and becomes movable toward the non-drive side (the side approaching the cartridge ZB) in the longitudinal direction. As a result, the drive transmission member 3081, which is in the retracted position, becomes movable toward the non-drive side (the side approaching the cartridge ZB) in the longitudinal direction.

### <Drive Start Operation of Drive Transmission Member>

Next, the drive start operation of the drive transmission member after the opening/closing door is closed will be explained.

FIG. 149 is a perspective view of the drive transmission member. As shown in FIG. 149, the drive transmission member 3081 includes a coupling recess 3081b and a free end portion 3081b1 of the coupling recess 3081b on the non-drive side, and a bottom portion 3081b2 for positioning at the bottom of the coupling recess 3081b. The coupling recess 3081b of the drive transmission member 3081 is a hole having a substantially triangular cross section. As viewed from the non-drive side (cartridge side, the opening side of the recess 3081b), the coupling recess 3081b has a shape twisting in the counterclockwise direction N toward the drive side (the back side of the recess 3081b) The gear portion 3081a of the drive transmission member 3081 has a helical gear, and has gear teeth twisting in the counterclockwise direction N toward the drive side as viewed from the non-drive side (cartridge side).

The gear portion 3081a and coupling recess 3081b are arranged so that the axis of the gear portion 3081a and the axis of the coupling recess 3081b overlap with the axis of the drive transmission member 3081. In other words, the gear portion 3081a and the coupling recess 3081b are arranged coaxially (concentrically).

As shown in FIG. 147, the drum bearing 3073 has a recessed bottom surface 3073i, and driving side drum flange 3063 has coupling projection 3063b on the drive side and free end 3063b1 at the free end portion of the coupling projection 3063b. The coupling projection 3063b of driving side drum flange 3063 has a substantially triangular cross section and is a projecting shape (projection, protrusion). The coupling projection 3063b is twisted counterclockwise from the driving side (the free end portion side of the coupling projection 3063b) toward the non-driving side (the bottom side of the coupling projection 3063b). In other words, the coupling projection 3063b is inclined (twisted) in the rotational direction R of the drum as goes from the outside of the cartridge toward the inside in the axial direction.

In addition, the coupling projection 3063b has a portion (ridge) which forms the corner of a triangular prism (the apex of the triangle) serving as a driving force receiving portion which actually receives a driving force (rotational force) from the coupling recess 3081b. This driving force receiving portion is inclined toward the rotational direction of the drum as it as goes from the outside of the cartridge toward the inside in the axial direction. In addition, the inner surface (inner peripheral surface) of the coupling recess 3081b serves as a driving force applying portion for applying a driving force to the coupling projection 3063b.

The cross-sectional shapes of the coupling projection 3063b and the coupling recess 3081b may not be strictly triangular (polygonal), and the corners may be rounded, which are called substantial triangles (polygons). In other words, the coupling projection 3063b is substantially a twisted triangular prism (prism) protrusion. However, the shape of the coupling projection 3063b is not limited to this. If it can be coupled with the coupling recess 3081b, that is, as long as it can be engaged and can be driven, the shape of the coupling projection 3063b may be changed. For example, three bosses are arranged at the vertices of a triangle, and each boss is twisted about the axis of the drum 3062.

As shown in FIG. 147, the gear portion 3030a of the developing roller gear 3030 is a helical gear, and is twisted (inclined) clockwise toward the non-driving side from the driving side. In other words, the gear teeth (helical teeth) of the gear portion 3030a are inclined (twisted) in the clockwise direction (the direction of rotation of the developing roller and the developing roller gear) as goes toward the inside of the cartridge from the outside in the axial direction of the gear portion 3030a. That is, the gear portion 3030a is inclined (twisted) in the opposite direction to the direction of rotation R of the drum 3062 as goes toward the inside of the cartridge from the outside in the axial direction.

FIG. 150 is a sectional view showing the operation in the thrust direction of the drive transmission member when the coupling is engaged. As shown in FIG. 150, the drive transmission member 3081 is rotated in the clockwise direction (the direction of rotation of the drum 3062) as viewed from the non-driven side (cartridge side), by a motor (not shown). Then, a thrust force (a force produced in the axial direction) is produced by the meshing between the helical teeth of the gear portion 3081a of the drive transmission member 3081 and the gear portion 3030a of the developing roller gear 3030. An axial (longitudinal) force FA is applied to the drive transmission member 3081, and the drive transmission member 3081 tends to move longitudinally toward the non-driven side (the side approaching the cartridge). In other words, the drive transmission member 3081 approaches and comes into contact with the coupling projection 3063b.

Then, when the drive transmission member 3081 rotates and the triangular phases of the coupling recess 3081b and the coupling projection 3063b matches, the coupling projection 3063b and the coupling recess 3081b engage (couple).

Then, when the coupling projection 3063b and the coupling recess 3081b engage, a new thrust force FC is produced because both the coupling recess 3081b and the coupling projection 3063b are twisted (inclined) with respect to the axis.

In other words, a force FC acts on the drive transmission member 3081 in the longitudinal direction toward the non-driven side (the side approaching the cartridge). This force FC and the above-described force FA combine to move the drive transmission member 3081 further toward the non-driven side (the side approaching the cartridge) in the longitudinal direction. In other words, the coupling acts to move the drive transmission member 3081 closer to the coupling projection 3063b of the cartridge ZB.

The drive transmission member 3081 pulled by the coupling projection 3063b is positioned in the longitudinal direction (axial direction) when the free end portion 3081b1 of the drive transmission member 3081 abuts against the recessed bottom surface 3073i of the drum bearing 3073.

In addition, a reaction force FB of the force FC acts on the drum 3062, and this reaction force (resistance) FB moves the drum 3062 toward the driving side (the side approaching the drive transmission member 3081, the outside of the cartridge ZB) in the longitudinal direction. In other words, the drum 3062 and the coupling projection 3063b are attracted toward the drive transmission member 3081. As a result, the free end portion 3063b1 of the coupling projection 3063b of the drum 3062 abuts against the bottom portion 3081b2 of the coupling recess 3081b. This also positions the drum 3062 in the axial direction (longitudinal direction).

That is, the coupling projection 3063b and the coupling recess 3081b attract each other, and the axial positions of the drum 3062 and the drive transmission member 3081 are determined.

In this state, the drive transmission member 3081 is in the driving position (advanced position). In other words, the drive transmission member 3081 is in a position for transmitting drive force to the coupling projection 3063b and the gear portion 3030a, and is in a position advanced toward the cartridge.

A centering action of the triangular shape of the coupling recess 3081b determines the center of the free end portion of the drive transmission member 3081 with respect to the driving side drum flange 3063. In other words, the drive transmission member 3081 is centered with respect to the drum flange 3063, and the drive transmission member 3081 and the photosensitive body become coaxial. This allows the drive to be transmitted from the drive transmission member 3081 to the developing roller gear 3030 and the driving side drum flange 3063 with high precision.

The coupling recess 3081b and the coupling projection 3063b which engages therewith can also be considered as centering parts. That is, the engagement of the coupling recess 3081b with coupling projection 3063b makes drive transmission member 3081 and the drum coaxial with each other. In particular, the coupling recess 3081b will be called a main assembly side centering portion (main assembly of the image forming apparatus side centering portion), and the coupling projection 3063b will be called a cartridge side centering portion.

As described above, the engagement of the coupling is assisted by a forces FA and FC acting on drive transmission member 3081 toward the non-drive side.

In addition, by positioning the drive transmission member 3081 by the drum bearing (bearing member) 3073 provided on the cartridge ZB, the positional accuracy of the drive transmission member 3081 relative to the cartridge ZB can be improved.

Since the longitudinal positional accuracy between the gear portion 3030a of the developing roller gear 3030 and the gear portion 3081a of the drive transmission member 3081 is improved, the width of the gear portion 3030a of the developing roller gear 3030 can be made small. The cartridge ZB and the apparatus main assembly ZA for mounting the cartridge ZB can be downsized.

To summarize the above embodiment, the gear portion 3081a of the drive transmission member 3081 and the gear portion 3030a of the developing roller gear 3030 have helical teeth. The helical teeth have a higher meshing rate between the gears than spur teeth. As a result, the rotational accuracy of the developing roller 3032 is improved, and the developing roller 3032 rotates smoothly.

The direction of inclination of the helical teeth of the gear portion 3030a and the gear portion 3081a is selected so that the gear portion 3030a and the gear portion 3081a produce forces (forces FA and FB) effective to attract each other. In other words, when the gear portion 3030a and the gear portion 3081a rotate in a meshed state, a force is produced which brings the coupling recess 3081b provided on the drive transmission member 3081 and the coupling projection 3063b provided on the end of the photosensitive drum 3062 closer to each other. As a result, the drive transmission member 3081 moves toward the cartridge ZB side, and the coupling recess 3081b also approaches the coupling projection 3063b. This assists the connection (coupling) of the coupling recess 3081b and the coupling projection 3063b.

### <Coupling Engagement Conditions>

Next, referring to FIG. 151, the conditions for coupling engagement will be specifically described. FIG. 151 is a cross-sectional view of the periphery of the drive transmission member when the coupling is engaged, as viewed from the drive side.

As shown in FIGS. 147 and 151, the drum bearing 3073 has a restricting portion 3073j which serves as a tilt restricting portion (movement restricting portion, position restricting portion, stopper) for restricting the movement of the drive transmission member 3081 and restricting (suppressing) the tilting of the drive transmission member 3081.

As described above, at the stage when the drive transmission member 3081 starts to rotate in the rotational direction R of the drum 3062, the gear portion 3081a of the drive transmission member 3081 and the gear portion 3030a of the developing roller gear 3030 mesh with each other. On the other hand, the coupling recess 3081b and the coupling projection 3063b are not coupled, or the coupling is insufficient. In this state, when the gear portion 3081a transmits a driving force to the gear portion 3030a, an engaging force FD is produced in the gear portion 3081a due to the meshing of the gears.

When this engaging force FD has been applied to the drive transmission member 3081, the drive transmission member 3081 tilts. In other words, since the drive transmission member 3081 is supported only on the fixed end 3081c (the end farther from the cartridge ZB), which is the end on the driving side, as described above, the drive transmission member 3081 tilts with the end 3081c (fixed end) on the driving side as the fulcrum. Then, the end (free end, free end portion of the drive transmission member 3081 on the side where the coupling recess 3081b is provided moves.

If the drive transmission member 3081 tilts significantly, the coupling recess 3081b cannot couple with the coupling projection 3063b. In order to avoid this, the cartridge ZB is provided with a restricting portion 3073j, which restricts (restricts) the inclination of the drive transmission member 3081 within a certain range. In other words, when the drive transmission member 3081 is inclined, the restricting portion 3073j supports the drive transmission member 3081, thereby preventing the inclination from becoming too large.

The restricting portion 3073j of the drum bearing 3073 is an arc-shaped curved surface portion disposed so as to face the axis of the drum 3062 (the axis of the coupling projection 3063b). The restricting portion 3073j can also be considered as a protruding portion which protrudes to cover the drum axis. Between the restricting portion 3073j and the drum axis is a space 3087 in which no components of the process cartridge ZB are disposed, and the drive transmission member 3081 is structured to be disposed in this space 3087. The restricting portion 3073j faces the space 3087, and the restricting portion 3073j forms the edge (outer edge) of the space 3087.

The restricting portion 3073j is disposed at a position where it can prevent the drive transmission member 3081 from being moved (tilted) by the engaging force FD.

As shown in FIG. 151, the direction in which the engaging force FD is produced is determined by the front pressure angle α of the gear portion 3081a (i.e., the front pressure angle α of the developing roller gear 3030). The direction in which the engaging force FD is produced is inclined (90+α) degrees upstream in the rotational direction R of the drum 3062 with respect to the arrow (half line) LN extending from the center 3062a of the drum (i.e., the center of the drive transmission member 3081) toward the center 3030b of the developing roller gear 3030. Here, the restricting portion 3073j does not necessarily have to be located on this line FDa, and may be located near the half line FDa.

The restricting portion 3073j is preferably located upstream of the center (axis) of the coupling projection 3063b in the cartridge mounting direction C. This is to prevent the restricting portion 3073j from interfering with the mounting of the cartridge ZB.

### <Inclined Structure of Drive Transmission Member>

Next, the inclined structure of the drive transmission member will be described.

As described above, the drive transmission member 3081 has a gear portion 3081a and a coupling recess 3081b on its free end portion side. The drive transmission member 3081 can move forward and backward and can be tilted (tilted). When the drive transmission member 3081 advances toward the cartridge while rotating to engage the coupling recess 3081b with the coupling projection 3063b, it is desirable to reduce the inclination angle of the drive transmission member 3081 with respect to the drum 3062. For this reason, as described above, the cartridge is provided with a restricting portion 3073j to suppress the inclination angle of the drive transmission member 3081 when the drive transmission member 3081 is driven.

On the other hand, in order to dismount the cartridge from the main assembly of the apparatus, it is necessary for the gear portion 3081a of the drive transmission member 3081 to disengage from the gear portion 3030a of the developing roller gear 3030. To smoothly disengage it, it is desirable for the drive transmission member 3081 to be inclined so that the gear portion 3081a can be disengaged from the gear portion 3030a. Therefore, if the drive transmission member 3081 itself is supported so as to be smoothly inclined, the cartridge can be more smoothly dismounted.

In order to tilt the drive transmission member 3081 to disengage the gear portion 3081a from the gear portion 3030a, it is desirable to tilt the drive transmission member 3081 so as not to come into contact with the drum bearing 3073j when dismounting the cartridge.

Also, while the drive transmission member 3081 is made to be easily tilted to disengage the gears, it is necessary for the gear portion 3081a of the drive transmission member 3081 to reliably mesh with the gear portion 3030a of the developing roller gear 3030 when mounting the cartridge. In other words, it is required to hold the drive transmission member 3081 at a predetermined tilt angle so that the gears reliably mesh when mounting the cartridge.

In consideration of this, the drive transmission member 3081 is supported so that it can be tilted more easily, while the drive transmission member 3081 is tilted to a suitable position and angle when mounting and dismounting the cartridge, respectively.

First, the fixed end 3081c side (rear end side, driving side) of the support structure of the drive transmission member 3081 will be described. FIG. 152 is a perspective view showing the support structure of the bearing of the drive transmission member on the driving side.

A second side plate (second driving-side side plate) 3093 is provided on the driving side of the main assembly ZA. As shown in FIG. 152, the second side plate 3093 is a metal plate (plate-shaped metal), and a hole 3093a is provided by drawing in this metal. A bearing 3094 is fitted in the hole 3093a of the second side plate 3093. The drive transmission member 3081 is rotatably supported by the bearing 3094. That is, the fixed end 3081c of the drive transmission member 3081 is supported by the bearing 3094.

There is provided a play (gap) between the bearing 3094 and the fixed end 3081c of the drive transmission member 3081. In this embodiment, the play is about 0.9 mm. This play allows the drive transmission member 3081 to tilt.

As shown in FIG. 152, a V-shaped portion 3094a is provided on the inner circumference of the bearing 3094. The V-shaped portion 3094a comprises two protruding portions (projections) protruding from the inner circumference of the first bearing 3094. The two protruding portions form a V-shape, and are collectively referred to as the V-shaped portion 3094a.

As described above, there is a gap between the bearing 3094 and the fixed end 3081c of the drive transmission member 3081, thereby allowing the drive transmission member 3081 to tilt. However, when the drive transmission member 3081 transmits the drive to the cartridge, it is necessary to align the axis of the drive transmission member 3081 with the axis of the photosensitive drum 3062. That is, when the drive transmission member 3081 carries out the driving operation, it needs to be supported with precision without tilting relative to the bearing 3094. Therefore, during the driving operation of the drive transmission member 3081, the rear end side of the drive transmission member 3081 is in contact with the V-shaped portion 3094a constituted by the two protruding portions (projections), so that the drive transmission member 3081 is supported with precision in a substantially horizontal state. The V-shaped portion 3094a is a position determination portion (position retaining portion) for maintaining the position of the drive transmission member 3081.

In order to determine the phase of the bearing 3094 (i.e., to prevent the bearing 3094 from rotating inside the main assembly), the bearing 3094 is provided with a projection 3094b as a rotation stopper. On the other hand, the second side plate 3093 is provided with a hole portion 3093b. The projection 3094b fits into the hole portion 3093b, thereby fixing the phase of the bearing 3094. That is, the bearing 3094 is fixed so as not to rotate with respect to the second side plate 3093. The phase of the V-shaped portion 3094a provided on the bearing 3094 is also fixed.

The second side plate 3093 is provided with a drive idler gear (not shown) for transmitting the drive from the motor, and the drive idler gear transmits the drive to the second gear portion 3081j of the drive transmission member 3081. As shown in FIG. 150, the V-shaped portion 3094a is provided in the neighborhood of the second gear portion 3081j of the drive transmission member 3081 in the axial direction. The drive transmission member 3081 tilts with the fixed end 3081c of the drive transmission member 3081 as a fulcrum. Therefore, the tilt fulcrum of the drive transmission member 3081 and the axial position of the second gear portion 3081j of the drive transmission member 3081 are close to each other. Therefore, it is possible to reduce the changes in the axial distance between the driving idler gear (not shown) and the second gear portion 3081j of the drive transmission member 3081 and in the misalignment of the tooth trace when the drive transmission member 3081 is tilted. As a result, it is possible to stabilize the meshing of the gears at the beginning of driving.

The phase of the V-shaped portion 3094a is placed at a position where the drive transmission member 3081 can be stably held by the meshing of the driving idler gear and the second gear portion 3081j of the drive transmission member 3081. In other words, by arranging the V-shaped portion 3094a on the downstream side of the meshing force direction, the fixed end 3081c of the drive transmission member 3081 is abutted against the V-shaped portion 3094a of the bearing 3094. This is set so that the drive transmission member 3081 is stably held. In addition, the radial position of the V-shaped portion 3094a is a position where the axial distance between the drive idler gear and the second gear portion 3081j of the drive transmission member 3081 is appropriate when the rear end side of the drive transmission member 3081 abuts against the V-shaped portion 3094a. In other words, the drive transmission member 3081 is held in a position where the idler gear and the drive transmission member 3081 can mesh with each other.

As a result, when no drive is applied, the drive transmission member 3081 can tilt within the play with the rear end side of the drive transmission member 3081 as a fulcrum. In addition, when drive is applied, the rear end side of the drive transmission member 3081 is urged against the V-shaped portion 3094a by the meshing force, and the drive transmission member 3081 takes the first posture in which the axial distance between the second gear portion 3081j of the drive transmission member 3081 and the drive idler gear is determined with high precision. As a result, the rotational power can be transmitted with high precision.

Next, the coupling recess 3081b side (tip side, free end side, non-driving side) of the support structure of the drive transmission member 3081 will be described. Part (a) of FIG. 153 is sectional views showing the posture of the drive transmission member when the coupling is engaged, part (b) of FIG. 153 is a sectional view showing the posture of the drive transmission member when the opening/closing door is open, and FIG. 154 is a cross-sectional view showing the posture of the drive transmission member when the opening/closing door is open.

As shown in part (a) of FIG. 153, the drive transmission member 3081 when the coupling is engaged is supported by the space 3015n provided in the first side plate (first driving-side side plate) 3015 with some play. The space 3015n of the first side plate 3015 is disposed at a position facing the gear portion 3030a of the developing roller gear 3030. In addition, the first side plate 3015 is provided with an inclining member 3097 including an inclination urging spring 3098 to tilt the drive transmission member 3081. The urging direction of the inclining member 3097 is arranged so that the gear portion 3081a of the drive transmission member 3081 moves away from the developing roller gear 3030.

Next, as shown in part (b) of FIG. 153, when the opening/closing door is opened, the drive transmission member 3081 can take a second posture in which the axis of the drive transmission member 3081 is tilted by the inclining member 3097. In the second posture, the drive transmission member 3081 is tilted by the inclining member 3097 so as to fill the space 3015n of the first side plate 3015. Therefore, the gear portion 3081a of the drive transmission member 3081 is tilted so as to move away from the gear portion 3030a of the developing roller gear 3030. Therefore, a gap is generated in the radial direction between the gear portion 3081a of the drive transmission member 3081 and the gear portion 3030a of the developing roller gear 3030.

Here, the drive transmission member 3081 receives an urging force from the inclining member 3097 when the coupling is engaged. However, the position of the coupling recess 3081b of the drive transmission member 3081 is fixed by the centering action of the coupling recess 3081b and the coupling projection 3063b described in the foregoing.

As shown in FIG. 154, the space 3015n of the first side plate 3015 is provided with a V-shaped portion 3015m as a bearing (holding portion) of the drive transmission member 3081 when the cartridge ZB is not mounted. The V-shaped portion 3015m is positioned to permit the inclination of the space 3015n of the first side plate 3015 in order to support the drive transmission member 3081 inclined by the inclining member 3097. That is, the drive transmission member 3081 is held in the V-shaped portion 3015m of this space 3015n. The drive transmission member 3081 creates a gap between the gear portion 3081a of the drive transmission member 3081 and the gear portion 3030a of the developing roller gear 3030 in the radial direction, so that the gears can be disengaged when the cartridge ZB is mounted or dismounted.

### <Structure of Control Member of Cartridge>

Next, the description will be made as to the structure in which the control member (centering auxiliary member, movable member, urging member, centering member, lever member) 3101 is provided on the cartridge when the drive transmission member 3081 is structured to be tiltable (inclinable). FIG. 155 is a perspective view showing the control member of the cartridge.

As shown in part (a) of FIG. 155, the control member 3101, which is a member controlling the posture of the drive transmission member 3081, is provided on the drive side of the cartridge. The control member 3101 is a movable member that can move relative to the photosensitive drum 3062. The control member 3101 is mounted to the drum bearing 3073 so as to be rotatable around the axis AA of the support boss 3101a.

The drum bearing 3073 is a part of the cartridge frame and rotatably supports the photosensitive drum 3062. The drum bearing 3073 is a part forming the side surface of the cartridge on the driving side and is mounted to the end of the cleaning frame 3071 on the driving side. Therefore, the drum bearing 3073 can also be considered as a part of the cleaning frame 3071.

As shown in part (b) of FIG. 155, an urging spring 3102, which is a torsion coil spring, is mounted to the support boss 3101a. The control member 3101 is urged in the direction of the arrow BB by the urging force of the urging spring 3102. On the other hand, the drum bearing 3073 is provided with the control member abutment portion (stop portion) 3073a that defines the rotation range of the control member 3101. Since the control member 3101 is urged in the direction of the arrow BB by the urging spring 3102, the contacted portion 3101b of the control member 3101 is in a position wherein it is in contact with the control member abutment portion 3073a. In other words, the movement of the control member 3101 is stopped by the control member contact portion 3073a being in contact with the control member 3101.

As viewed along the axial direction of the drum 3062, the control portion (restricting portion, urging portion, actuating portion) 3101c of the control member 3101 is disposed in the neighborhood of the surface (outer peripheral surface) 3062b of the drum 3062. The position of the control member 3101 in this state is called the acting position (normal position) of the control member.

On the other hand, when the control member 3101 receives a force from the outside, it can also move to the retracted position (non-acting position) retracted from the acting position so as to move away from the drum 3062. Such an example is shown in FIG. 162. FIG. 162 is a side view of the cartridge ZB. The control member 3101 moves a certain distance from the operative position to the retracted position as the cartridge ZB is mounted in the apparatus main assembly ZA. This will be described hereinafter.

The control portion 3101c of the control member 3101 is disposed at a position at the longitudinally outside position of the coupling projection 3063b.

A top view of part (a) of FIG. 155 is shown in FIG. 159. In FIG. 159, the free end side of the contacted portion 3101b of the control member 3101 in the direction of arrow CC is provided with a clearance W with respect to the adjacent portion 3073b of the drum bearing 3073. Therefore, when the force F1 is applied to the tip of the control member 3101, the control member 3101 can bend in the direction of arrow CD.

Next, the operation of the control member when the cartridge is mounted will be described. FIG. 156 is a cross-sectional view showing the tilting operation of the drive transmission member when the cartridge is mounted.

As described above, when the cartridge ZB is not mounted in the apparatus main assembly ZA, the drive transmission member 3081 is held with inclination by the inclining member 3097. The drive transmission member 3081 receives an urging force FF2 from the inclining member 3097. When the cartridge ZB is inserted from this state and the opening/closing door 3013 is closed, as shown in FIG. 156, the control portion 3101c of the control member 3101 abuts against the gear portion 3081a of the drive transmission member 3081. Therefore, the drive transmission member 3081 receives the urging force FF1 from the control portion 3101c.

Therefore, the drive transmission member 3081 receives an urging force FF1 from the control portion 3101c in the direction of the arrow BB from the control portion 3101c and an urging force FF2 from the inclining member 3097. As a result, FF1>FF2 acting on the drive transmission member 3081, so that the inclination of the drive transmission member 3081 becomes smaller. Therefore, the drive transmission member 3081 moves, so that the gear portion 3081a of the drive transmission member 3081 and the gear portion 3030a of the developing roller gear 3030 come into mesh with each other.

From the foregoing description, the process from the tilted state of the drive transmission member to the engagement of the coupling when the cartridge is mounted in this embodiment is summarized as follows. First, the gear portion 3081a of the drive transmission member 3081 and the gear portion 3030a of the developing roller gear 3030 mesh with each other by the control member 3101 of the cartridge ZB. When the drive transmission member 3081 is driven, the drive transmission member 3081 moves toward the drum 3062 by the meshing force in the thrust direction of the gear portion 3030a of the developing roller gear 3030. In addition, the tilt angle of the drive transmission member 3081 is restricted by the restricting portion 3073j of the cartridge ZB. This reduces the misalignment between the couplings and allows both couplings to be engaged, despite the fact that the drive transmission member 3081 is tilted in the apparatus main assembly ZA.

### <Dismounting Cartridge>

The operation from the closed state of the opening/closing door 3013 of the apparatus main assembly ZA to the open state will be explained. Part (a) of FIG. 153 shows the door in a closed state, and part (b) of FIG. 153 shows the door in an open state.

First, the process up to the disengagement of the coupling will be described. When the door 3013 is rotated to open, the cylindrical cam 3086 rotates by way of the cylindrical cam link 3085. When the cylindrical cam 3086 rotates, the inclined surfaces 3086a, 3086b, and 3086c of the cylindrical cam 3086 slide along the inclined surfaces 3015d, 3015e, and 3015f, so that the cylindrical cam 3086 moves to the driving side (FIG. 145). This movement disengages the couplings 3063b and 3081b from each other. When the door 3013 is further opened, the coupling projection 3063b and the coupling recess 3081b are disengaged.

Next, the process from disengagement of the coupling to drawing-out of the cartridge ZB will be described. As shown in part (b) of FIG. 153, when the opening/closing door 3013 is opened, the drive transmission member 3081 abuts against a protruding portion 3093c of the second side plate 3093 and tilts. A gap is created between the gear portion 3081a of the drive transmission member 3081 and the gear portion 3030a of the developing roller gear 3030 in the radial direction. As a result, when the cartridge ZB is pulled out of the main assembly ZA of the apparatus, the gear portions 3081a and 3030a are smoothly disengaged from each other. In other words, the cartridge ZB can be easily pulled out of the main assembly ZA of the apparatus.

### <Structure of Cover Portion of Drive Transmission Member>

The cover portion 3105 protecting the drive transmission member 3081 of the main assembly ZA of the apparatus will be described. Part (a) of FIG. 157 is a perspective view of the drive transmission member and the cover portion when the coupling is engaged, and part (b) of FIG. 157 is a perspective view showing the drive transmission member and the cover portion with the opening/closing door open. FIG. 158 is a cross-sectional view of the operation of the control member when the cartridge is mounted and dismounted.

As shown in FIG. 157, the cover portion 3105 for protecting the drive transmission member 3081 is provided on the first side plate 3015 so as to cover the drive transmission member 3081. The cover portion 3105 has four openings.

First, a first opening 3105a is located at a position from which the coupling cylindrical portion 3081i of the drive transmission member 3081 projects in the driving state, that is, at the non-driving side end surface 3105e of the cover portion 3105. In addition, the longitudinal position of the non-driving side end surface 3105e of the cover portion 3105 is located between the gear portion end surface 3081a1 of the drive transmission member 3081 and the drum bearing 3073 in the driving state. Furthermore, the longitudinal position of the non-driving side end surface 3105e of the cover portion 3105 is such that the free end portion 3081b1 of the coupling recess protrudes in the driving state. Moreover, when the opening/closing door 3013 is open, the drive transmission member 3081 is in a retracted position, so that the free end portion 3081b1 of the coupling recess does not protrude beyond the non-driving side end surface 3105e of the cover portion 3105. Therefore, the cover portion 3105 is disposed such that it does not interfere with the cartridge ZB when the cartridge ZB is mounted in the axial direction of the drum 3062.

Next, a second opening 3105b is disposed at a position where the gear portion 3081a of the drive transmission member 3081 and the gear portion 3030a of the developing roller gear 3030 mesh in the driving state, and downstream of the side surface of the cover portion 3105 on the upstream side in the mounting direction C. In addition, the gear portion 3081a of the inclined drive transmission member 3081 when the opening/closing door 3013 is open is inclined by the inclining member 3097 in a direction away from the gear portion 3030a of the developing roller gear 3030, and is therefore located away from the second opening 3105b.

A third opening 3105c is located at the position of the restricting portion 3073j of the cartridge ZB which restricts the inclination angle of the drive transmission member 3081 during coupling engagement, on the upstream side of the mounting direction C of the cartridge ZB on the side of the cover portion 3105. In addition, the gear portion 3081a of the inclined drive transmission member 3081 when the opening/closing door 3013 is in the open state is inclined by the inclining member 3097 toward the downstream side in the mounting direction of the cartridge, and therefore, it is at a position away from the third opening 3105c.

Furthermore, a fourth opening 3105d is located at a position where the control member 3101 of the cartridge ZB and the gear portion 3081a of the drive transmission member 3081 are close to each other in the driving state, at the upper downstream side in the mounting direction C of the cartridge ZB on the side of the cover portion 3105 (opposite the second opening).

Furthermore, as shown in FIG. 158, the cover portion 3105 between the third opening 3105c and the fourth opening 3105d has a guide portion 3105f which serves as a guide for operating the control member 3101 when mounting and dismounting the cartridge ZB. The cover portion 3105f guides the free end portion of the control member 3101 to lead the control member 3101 to the fourth opening 3105d.

As described above, the space 3087 of the cartridge ZB is for placing the gear portion 3081a and the cover portion 3105 of the drive transmission member 3081 therein, when the cartridge ZB is mounted in the apparatus main assembly ZA. Because of the provision of this space 3087, when the cartridge ZB is mounted in the apparatus main assembly ZA, the cartridge ZB can be mounted in the apparatus main assembly ZA without interfere of the drive transmission member 3081 with the cartridge ZB.

As described above, in this embodiment, the cover portion 3105 is provided to protect the drive transmission member 3081 of the apparatus main assembly ZA. Therefore, even when the process cartridge which is detachable from the apparatus main assembly is dismounted from the apparatus main assembly, the user is less likely to touch lubricant applied to the output coupling and output gear of the drive transmission member of the image forming apparatus, thereby enabling improvement in usability.

### <Relationship Between Cartridge and Cover>

As described above, the cartridge ZB is provided with a space 3087 (see FIG. 147) so that the cartridge ZB does not interfere with the cover 3105a and the drive transmission member 3081 of the apparatus main assembly ZA when the cartridge is attached to the apparatus main assembly ZA. This space 3087 is designed to fit the shape of the cover part 3105a and the drive transmission member 3081, and this point will be described below.

FIG. 160 shows a side view of the cartridge. FIG. 160 shows the drive side of the cartridge, which is a surface perpendicular to the axis of the drum 3062. FIG. 160 also shows a state in which the control member 3101 is in the operating position.

The drum bearing 3073 forming the side of the cleaning frame 3071 includes a restricting portion (protruding portion) 3073j which protrudes outward in the axial direction. The drum bearing 3073 also includes a protruding portion 3073m which protrudes outward in the axial direction. Here, the restricting portion 3073j may be called a first protruding portion, and the protruding portion 3073m may be called a second protruding portion.

As described above, a restricting member 3101 is provided adjacent to the drum bearing 3073.

Meanwhile, the developing roller 3032 supported by the developing frame 3029 supports the developing roller gear 3030.

The protruding portions (3073j, 3073m), the restricting member 3101, and the developing roller gear 3030 are arranged axially outward of the coupling projection 3063b mounted to the drum 3062 (see FIG. 147). The protruding portions (3073j, 3073m), the restricting member 3101, and the developing roller gear 3030 are arranged so as to surround the periphery of the axis AX1. A space surrounded by the protruding portions (3073j, 3073m), the restricting member 3101, and the developing roller gear 3030 is the space 3087 (see FIG. 147 and FIG. 165).

The shapes and arrangement of the protruding portions (3073j, 3073m), the restricting member 3101, and the developing roller gear 3030 are set to satisfy predetermined conditions, such that the space 3087 matches the shapes of the cover portion 3105a and the drive transmission member 3081. A detailed description will be made in the following.

In the following description, polar coordinates (circular coordinates) on a plane parallel to the axis AX1 of the drum 3062 are used. In this polar coordinate system, the center (axis AX1) of the drum 3062 is set as an origin (pole), and a line extending from the center (axis AX1) of the drum 3062 to the center (axis AX2) of the developing roller gear 3030 is set as the starting line (polar line). The starting line can also be taken as a line extending from the center of the drum 3062 toward the center of the developing roller.

The downstream of the rotational direction R of the photosensitive drum is set as a positive direction of the angular coordinate (declination angle) O. Unless otherwise specified, hereinafter, when the distance from the center (axis AX1) of the photosensitive drum is mentioned, it refers to the distance in this polar coordinate system. In other words, it is the distance measured from the axis AX1 of the drum along a direction perpendicular to the axis AX1. In the polar coordinate system, the distance from the origin (axis AX1 of the drum) is sometimes called a radial coordinate r.

In FIG. 160, the angular coordinate of the upstream end of the surface of the restricting portion (first protruding portion) 3073j in the direction of rotation R is indicated by α1, and the angular coordinate of the downstream end is indicated by α2. The surface of the drum bearing 3073 faces toward the center (AX2) of the drum 3062.

Here, the preferred range for the angular coordinate of the restricting portion 3073j is “190°<α1<α2<280°”. In more detail, the preferred conditions are “190°<α1<250°” and “220°<α2<280°”. In this embodiment, there are approximately α1=216° α2=227°.

Here, in the above polar coordinate system (FIG. 160), the distance from the center (axis AX1) of the drum 3062 to the surface of the restricting portion 3073j of the drum bearing 3073 is Ra, and the distance from the center (axis AX1) of the drum 3062 to the tooth tip circle of the developing roller gear 3030 is R1. The distance from the center (axis AX1) of the drum 3062 to the center (axis AX2) of the developing roller gear 3030 is R2. At this time, the relationship “R1<Ra<R2” is satisfied.

In summary, it is preferable that the surface portion of the restricting portion 3073j is disposed within a region satisfying “R1<r<R2, 190°<Θ<280°” with respect to the radial coordinate r and the angular coordinate Θ in the polar coordinate system.

In addition, the control portion 3101c of the control member 3101 is disposed upstream of the restricting portion 3073j and downstream of the developing roller gear 3030 in the rotational direction R of the drum 3062. The control portion 3101c is a part of the surface of the control member 3101, and faces toward the axis AX1 of the drum 3062.

In the polar coordinate system, in this embodiment, the angular coordinate of the downstream end of the control portion 3101c is α4, and the angular coordinate of the upstream end is α3. The preferable range of α3 and α4 is “110°<α3<α4<225”. In other words, it is desirable that the control portion 3101c is located within the range where the angular coordinate O satisfies “110°<Θ<225°”. However, as described above, the control portion 3101c is located upstream of the restricting portion 3073j in the rotational direction R.

More detailed preferable conditions for α3 and α4 are as follows: 110°<α3<170°. 170°<α4<225°. In this embodiment, approximately. α3=147°. α4=180°.

The angular coordinates α1 and α2 at both ends of the restricting portion 3073j and the angular coordinates α3 and α4 at both ends of the control portion 3101c are made to satisfy “α3<α4<α1<α2”.

In addition, in the polar coordinate system (FIG. 160), the shortest distance R3 from the center of the drum 3062 (axis AX1) to the control portion 3101c is smaller than the distance R2 from the center of the drum 3062 (axis AX1) to the center of the developing roller gear 3030 (axis AX2). R3 is larger than the distance R1 from the center of the drum 3062 (axis AX1) to the tip of the teeth of the developing roller gear 3030. In other words, the relationship “R1<R3<R2” are satisfied.

In addition, it is preferable that the distance R3 from the center of the drum 3062 (axis AX1) to the control portion 3101c is slightly larger than a distance Ra from the center of the drum 3062 (axis AX1) to the restricting portion 3073j. In other words, it is preferable to satisfy “Ra<R3”.

In the range from angle coordinate α4 to angle coordinate α1, the control member 3101 is provided with a recess (retraction portion) 3101d. The recess 3101d is a recess that is recessed away from the center of the drum. The distance from the center (axis line AX1) of the drum 3062 to a surface 3101d1 forming the recess 3101d is L1. The distance L1 satisfies the relationship of “Ra<L1, and R3<L1” with respect to the distance Ra from the drum center (axis line AX1) to the protruding portion 3073j and the distance R3 from the drum center (axis line AX1) to the control portion 3101c.

Furthermore, in the rotational direction R, a second protruding portion 3073m and a retracting portion 3073k are provided downstream of the restricting portion 3073j and upstream of the developing roller gear 3030. The surface of the second protruding portion 3073m is located remoter from the drum center (axis line AX1) than the surface of the restricting portion 3073j. Here, the restricting portion 3073j may be called the first protruding portion to distinguish it from the second protruding portion 3073m.

In other words, the second protruding portion 3073m is recessed toward the outside in the radial direction relative to the restricting portion (first protruding portion) 3073j. The retracting portion 3073k is a space provided by the step between the restricting portion 3073j and the second protruding portion 3073m. The retracting portion 3073k is a part of the side surface of the cartridge frame where the protruding portions (3073j, 3073m) are not formed.

Here, in FIG. 160, the distance L2 from the axis AX1 of the drum 3062 to the second protruding portion 3073m is greater than the distance Ra from the axis AX1 to the protruding portion 3073j. In other words, the relationship “Ra<L2” is satisfied.

In summary, the retracting portion 3073k is disposed in at least a part of the region in the polar coordinate system where the angular coordinate Θ satisfies “α2<Θ<360°” and the radial coordinate r satisfies “Ra<r<R2”.

In particular, as for the angular coordinate Θ, it is preferable that the retracting portion 3073k is provided in the entire range where “282°<Θ<297°” is satisfied. The retracting portion 3073k may be provided beyond this range.

In this embodiment, the second protruding portion 3073m is provided so as to contact the retracting portion 3073k, but this is not necessarily required. For example, if the retracting portion 3073k is formed as shown in FIG. 163, the second protruding portion 3073m may not be required. FIG. 163 is a perspective view of a modified example of the cartridge ZB in which the structure of Embodiment 1 is partially modified.

As shown in FIG. 161, which is a sectional view taken along a line X1-X1 in FIG. 160, the restricting portion 3101c and the protruding portions (3073j, 3073m) of the control member 3101 are located at positions on the outer side in the longitudinal direction with respect to the coupling projection 3063b.

As described above, the space 3087 (FIG. 147) is defined around the axis A1 of the drum 3062 by being surrounded by the control member 3101, the protruding portions (3073j, 3073m), and the developing roller gear 3030. When cartridge ZB is mounted in the apparatus main assembly ZA, the drive transmission member 3081 and the cover portion 3105 (see FIG. 157) which protects the drive transmission member 3081 can enter this space 3087.

FIG. 164 is a cross-sectional view of the cartridge and the apparatus main assembly when the cartridge ZB is mounted in the apparatus main assembly ZA. FIG. 165 is a cross-sectional view of the cartridge when the cartridge ZB is not mounted in the apparatus main assembly ZA. FIG. 165 is taken along a plane perpendicular to a line passing through the developing roller gear 3030 and perpendicular to the axis of the photosensitive drum.

As will be understood from FIG. 164, by providing a clearance portion 3073k and retraction portion 3101d on the side of the cartridge, interference between the cover portion 3105 and the cartridge is avoided. As can be seen from FIG. 165, the space 3087 is defined around the axis AX1 of the photosensitive drum, surrounded by the developing roller gear 3030, the protruding portions (3073j, 3073m), and the control member 3101. In particular, the retracting portion 3073k and the retracting portion 3101d expand this space 3087, so that the space 3087 can be made larger than the cover portion 3105. The cover portion 3105 can be placed in the space 3087, and the drive transmission member 3081 and the cartridge ZB can be connected.

As shown in FIG. 160, the space 3087 is larger than a circle of radius R1 centered on the axis AX1 of the drum 3062. The radius R1 is the distance from the axis A1 of the drum 3062 to the tooth tip of the developing roller gear 3030. In other words, the inside of the circle of radius R1 is a necessary area required to accommodate the drive transmission member 3081.

Furthermore, the space 3087 includes a space expanded by the clearance portion 3073k and the recessed portion 3101d. The cover portion 3105 is disposed in this region. As shown in FIG. 164, a portion 3105i of the cover portion 3105 is provided in the region corresponding to the retracting portion 3073k. The portion 3105h of the cover portion 3105 is placed in the recessed portion 3101d.

In addition, the space 3087 includes a region downstream of the developing roller gear 3030 and upstream of the control portion 3101c in the rotational direction R of the drum 3062. As shown in FIG. 164, a portion 3105g of the cover portion 3105 is disposed in this region. It is desirable that the space 3087 for disposing the portion 3105g is formed at least in the entire region of the declination coordinate Θ of “63°<θ<109°”. In this embodiment, in the area downstream of the developing roller gear 3030 and upstream of the control portion 3101c, the space 3087 is open and not closed. In other words, the drum bearing 3073 does not have a component element which closes the space 3087 between the developing roller gear 3030 and the control portion 3101c.

In the area downstream of the developing roller gear 3030 and upstream of the control portion 3101c, the space 3087 has an area having distance from the drum axis AX1 exceeding Ra (see FIG. 160).

According to this embodiment, the cover portion 3105 can be disposed in the space 3087, and the drive transmission member 3081 protected by the cover portion 3105 can be reliably connected to the cartridge ZB.

As has been described hereinbefore with reference to FIG. 162, when a force F2 is applied to the control member 3101, the control member 3101 can rotate in the direction of the arrow AB about the axis AA against the urging force of the urging spring 3102 so that it moves to a non-operating position (retracted position). At this time, the distance R4 (FIG. 162) between the control portion 3101c of the control member 3101 and the axis AX1 is greater than the distance R3 (FIG. 160) between the control portion 3101c and the axis AX1 at the operating position. In other words, the relationship “R3<R4” is satisfied.

As the control member 3101 moves in this manner, the distance between the control portion 3101c and the drum axis AX1 changes. As the control member 3101 moves, the size of the space 3087 also changes.

Therefore, the space 3087 does not necessarily need to be large enough to accommodate the drive transmission member 3081 and the cover section 3105. That is, there may be a case where a sufficient space 3087 is not formed before the cartridge ZB is mounted in the apparatus main assembly ZA.

In such a case, the control member 3101 is moved to a predetermined position by the apparatus main assembly ZA as the cartridge ZB is mounted in the apparatus main assembly ZA. As a result, it will suffice if the control member 3101 forms a space 3087 sufficient to accommodate the cover portion 3105. The predetermined position of the control member 3101 is a position as shown in FIGS. 160, 164, and 165. In this embodiment, when the cartridge ZB is not mounted in the apparatus main assembly ZA, that is, when the control member 3101 is not receive an external force, the control member 3101 is located in a predetermined position (operating position) as shown in FIGS. 160, 164, and 165.

In this embodiment, the cover portion has four openings. However, the number, shape, and arrangement of these openings are not limited. For example, these openings may be connected, the number of openings may be increased, the shape of the openings may be changed, or the arrangement of the openings may be shifted.

### Embodiment 13

Next, Embodiment 13 will be described. Here, the description of the same points as in the previous examples may be omitted. In particular, among the elements disclosed in this example, those corresponding to the members described in Embodiment 12 will be assigned the same names as in Embodiment 12, and only the points different from those in Embodiment 12 will be described.

In Embodiment 2, the structure in which the developing unit 220 of the cartridge B has a rack gear mechanism 290 has been described, but a similar structure can also be used in the cartridge ZB described in Embodiment 12. An example of applying the rack gear mechanism described in Embodiment 2 to the cartridge described in Embodiment 12 will be described in the following.

Referring to FIGS. 171, 166, and 167, a structure in which a rack gear mechanism 3290 is used in the cartridge ZB will be described. FIG. 171 is a side view of a drive side of the cartridge ZB. FIG. 166 is a perspective view of the cartridge ZB. FIG. 167 is a perspective view of the cartridge ZB as viewed in another angle.

As shown in FIGS. 171 and 166, the cartridge ZB is provided with a rack gear mechanism 3290, as in Embodiment 2. In this embodiment, the rack gear mechanism 3290 is provided on the drive side of the cartridge as a part of the structure of the developing unit 3220. Each part constituting the rack gear mechanism 3290 has the same structure as the rack gear mechanism 290 in Embodiment 2, and therefore the description thereof will be omitted.

As shown in FIG. 167, as in Embodiment 2, the driving side drum flange 3263 has a gear portion 3263e on the side closer to the drum 3062 in the axial direction of the drum 3062. The developing roller gear 3230 has a gear portion 3230a and is supported so as to rotate integrally with the developing roller 3032.

The gear portion 3230a of the developing roller gear 3230 is provided in mesh with the gear portion 3263e of the driving side drum flange 3263. That is, the driving force of the driving side drum flange 3263 is transmitted to the developing roller 3032 by way of the developing roller gear 3230. That is, the developing roller 3032 is driven by driving the driving side drum flange 3263. Here, in this embodiment, the driving force is transmitted to the developing unit 3220 by the gear portion 3263e of the driving side drum flange 3263, but as in the Modified Example 2 of the above-described Embodiment 7, the driving force may be transmitted from the non-driving side drum flange to the developing unit 3220.

### (Rack Gear Mechanism 3290)

FIG. 172 is a side view of the gear portion 3081b of the drive transmission member 3081 and the process cartridge ZB as viewed from the drive side. Part (a) of FIG. 172 shows a state before the process cartridge ZB is mounted in the image forming apparatus ZA and the door 3013 is closed. Part (b) of FIG. 172 shows a state after the process cartridge ZB is mounted in the image forming apparatus ZA and the door 3013 is closed.

As shown in part (a) of FIG. 172, a rack gear 3291 of the rack gear mechanism 3290 has at least one gear tooth 3291a, and the gear portion 3291a is at least partially exposed to the outside of the cartridge (see FIG. 166). This is similar to the rack gear 291 of Embodiment 2 (see part (b) of FIG. 29). More specifically, as in the previously described embodiments, the gear portion 3291a has its teeth exposed toward the axis Ax1 of the drum 3062.

As to the preferred positional relationship of the rack gear 3291 relative to the control member 3101, applicable is the preferred positional relationship of the developing roller gear 1030 relative to the control member 1001 (see part (b) of FIG. 124, FIG. 132, and so on) and the preferred positional relationship of the developing roller gear 3030 relative to the control member 3101 (see FIG. 155, and so on), both of which are described in the previously described embodiments.

For example, as shown in FIG. 166, the gear portion 3291a of the rack gear 3291 faces toward the control member 3101. As shown in FIG. 171, the cartridge is viewed along the axis Ax1 of the drum. Then, the coupling portion 3263b (see FIG. 169) of the driving side drum flange 3263 is at least partially located between the gear portion 3291a of the rack gear 3291 and the control member 3101. This coupling portion 3263b is arranged coaxially with the photosensitive drum 3062. Therefore, as the cartridge is viewed along the drum axis Ax1, the photosensitive drum 3062 is at least partially located between the gear portion 3291a of the rack gear 3291 and the control member 3101. In addition, the gear portion 3291a is structured to mesh with the gear portion 3081b of the drive transmission member 3081, as in Embodiment 2. Furthermore, the rack gear 3291 has a movable direction, as in Embodiment 2. The movable direction of this rack gear 3291 is referred to as a first movable direction D210 (see FIG. 168).

In this embodiment, the first movable direction D210 is a direction parallel to a straight line passing through the tips of the gear teeth 3291a of the gear portion 3291a (i.e., a straight line tangent to the tips of the gear teeth 3291a).

As shown in part (a) of FIG. 180, before the opening/closing door 3013 is closed, the gear portion 3081b of the drive transmission member 3081 is separated from a tooth surface 3291a of the rack gear 3291 by a gap LL2.

When the opening/closing door 3013 is closed, the cylindrical cam 3086 moves to the non-driving side in the longitudinal direction, as in Embodiment 12, and the drive transmission member 3081 becomes movable (see FIG. 153 of Embodiment 12).

Then, as in Embodiment 12, as shown in part (b) of FIG. 180, the control portion 3101c of the control member 3101 rotates in the direction of the arrow BB and abuts against the gear portion 3081b of the drive transmission member 3081. Then, as in Embodiment 12, the drive transmission member 3081 moves, and the gear portion 3081b of the drive transmission member 3081 and the gear portion 3291a of the rack gear 3291 mesh with each other.

FIG. 168 is a cross-sectional view of some parts as viewed from the non-driving side in a state in which the process cartridge ZB is mounted in the image forming apparatus ZA and the opening/closing door 3013 is closed. As in Embodiment 12, as shown in FIG. 168, the drum bearing 3073 of the process cartridge ZB is provided with a restricting portion 3073j and a control member 3101. In addition, the apparatus main assembly ZA is provided with a cover portion 3105 (see part (a) of FIG. 157 of Embodiment 12).

As shown in FIG. 168, when the process cartridge ZB is mounted to the apparatus main assembly ZA and the opening/closing door 3013 is closed, the gear portion 3291a of the rack gear 3291 and the gear portion 3081b of the drive transmission member 3081 are brought into engagement with each other with each other. In addition, when the drive transmission member 3081 rotates in the direction of the arrow R, the gear portion 3081b of the drive transmission member 3081 receives a force in the direction of the arrow FA1 from the gear portion 3291a of the rack gear 3291, as in Embodiment 2. Also, as in Embodiment 2, the drive transmission member 3081 receives a force FA2 in the axial direction, which is the same as the force FA (see FIG. 35 of Embodiment 2), from the gear portion 3291a of the rack gear 3291, and moves in the direction of the arrow E26 (see FIG. 169). At this time, the drive transmission member 3081 engages with the drum coupling 3063 by being restricted in the posture thereof by the restricting portion 3073j and the control member 3101, as in the case of Embodiment 12. Thereafter, the drive transmission member 3081 and the drum coupling 3063 rotate integrally.

Next, the arrangement of the rack gear 3291 will be described.

FIGS. 169 and 170 are illustrations showing the arrangement of the rack gear 3291 of the rack gear mechanism 3290. FIG. 169 is a view as viewed in a direction perpendicular to the rotational axis of the drum 3062, and FIG. 170 is a sectional view taken along a line X210-X210 in FIG. 169.

As shown in FIG. 169, in the longitudinal direction D202, the gear portion 3291a of the rack gear 3291 is placed on the side indicated by the arrow E20 direction from the free end portion 3263b1 of the coupling projection 3263b of the driving side drum flange 3263. In other words, the gear portion 3291a of the rack gear 3291 is placed on the outer side in the longitudinal direction than the free end portion 3263b1 of the coupling projection 3263b of the driving side drum flange 3263. The gear portion 3291a of the rack gear 3291 is placed on the side away from the non-drive side of the cartridge ZB than the free end portion 3263b1 of the coupling projection 3263b of the driving side drum flange 3263.

In other words, the gear portion 3291a is placed remoter from the non-drive side of the cartridge ZB and the end of the non-drive side of the drum 3062 than the free end portion 3263b1. That is, the distance from the end of the non-drive side of the drum 3062 to the gear portion 3291a is longer than the distance from the end of the non-drive side of the drum 3062 to the free end portion 3263b1. However, these distances are measured in a direction parallel to the axis Ax1 of the photosensitive drum (i.e., the longitudinal direction D202).

In this embodiment, the entire area of the gear portion 3291a is on the arrow E20 direction side beyond the free end portion 3263b1, but the gear portion 3291a may be partially on the arrow E20 direction side beyond the free end portion 3263b1.

The distance between the gear portion 3291a and the free end portion 3263b1 measured in the longitudinal direction D202 is set to a distance L23. The distance L23 is set to any position of the gear portion 3291a. In this case, the distance L23 is set in the range of 0 to 13 mm, but more preferably, it is set to a range of 4 to 10 mm or less. In this embodiment, it is 5.5 mm. Here, the range of distance L23 may be increased depending on the tooth width of the gear portion 3291a and the structure of the driving side drum flange 3263.

FIG. 170 shows the first movable direction D210 and the perpendicular direction D217 thereto. As described above, the first movable direction D210 is the direction in which the rack gear 3291 can move. In this embodiment, the first movable direction D210 is also the direction of a straight line extending to touch each tooth tip of the rack gear 3291.

On the other hand, the perpendicular direction D217 refers to a direction perpendicular to the first movable direction D210. Alternatively, the perpendicular direction D217 refers to a direction perpendicular to a straight line which touches the multiple tooth tips of the rack gear 3291. In FIG. 170, the straight line (arrow) indicating the perpendicular direction D217 passes through the gear portion 3291a of the rack gear 3291 and extends away from the rotational axis Ax1 of the drum 3062.

As shown in FIG. 170, a distance L24 is the distance measured along a direction perpendicular to the rotational axis Ax1 from the rotational axis Ax1 of the drum 3062 to a straight line passing through the tips of the teeth of the gear portion 3291a of the rack gear 3291. In this embodiment, the distance L24 is also the distance measured along the perpendicular direction D217 from the rotational axis Ax1 of the drum 3062 to a straight line passing through the tips of the teeth of the gear portion 3291a. In this case, it is desirable that the distance L24 is in a range of 90% to 120%, more preferably 90% to 110%, of the radius of the drum 3062. This is because the gear portion 3291a is to mesh with the gear portion 3081b of the drive transmission member 3081 reliably.

In this embodiment, the radius of the drum 3062 is 12 mm as in Embodiment 1, and the distance L24 is in the range of 11.165 mm to 12.84 mm. In other words, the distance L24 from the axis of the drum 3062 to the tip of the gear teeth of the gear portion 3291a is within a range of 93% to 107% of the radius of the drum.

Furthermore, the distance from the rotational axis Ax1 of the drum 3062 to the tooth tip of the gear portion 3291a closest to the rotational axis Ax1, measured along a direction perpendicular to the rotational axis Ax1, is defined as L25.

Like the distance L24, a distance L25 is preferably in the range of 90% to 120% of the radius of the drum 3062, and more preferably 90% to 110%. In this embodiment, it has been found that a range of 93% to 107% is preferable to achieve more stable meshing.

An open space is provided between the gear portion 3291a and the drum axis Ax1 so that the drive transmission member 3081 can be disposed between the gear portion 3291a and the drum axis Ax1.

A straight line extending from the rotational axis Ax1 of the drum 3062 so as to pass through the rotational axis Ax2 of the developing roller 3032 is used as a reference line, and an angle between this reference line and a straight line indicating the perpendicular direction D217 is defined as an angle K24. As described above, the straight line indicating the perpendicular direction D217 passes through the gear portion 3291a of the rack gear 3291, extends in a direction away from the rotational axis Ax1 of the drum 3062, and is perpendicular to the first movable direction D210 of the rack gear 3291. The preferred range of this angle K24 will be described hereinafter.

### (Preferable Range of Rack Gear 3291)

The rack gear mechanism 3290 is a part corresponding to the developing roller gear 3030 of Embodiment 12. Therefore, the suitable arrangement of the rack gear 3291 is similar to the suitable range of the developing roller gear 3030 shown in Embodiment 12. However, as described in Embodiment 2, the suitable range of the rack gear 3291 is set by the structure of the main assembly of the image forming apparatus. Therefore, the suitable range for the main assembly of the image forming apparatus ZA in this embodiment will be described below.

Since the drive transmission member 3081 of the apparatus main assembly ZA is covered by the cover portion 3105, the suitable range for the rack gear 3291 to engage with the drive transmission member 3081 is limited. That is, as shown in FIG. 170, the angle range K26 formed by the lines connecting the axis Ax1 of the drum 3062 and a line connecting respective opening ends of the second opening 3015b of the cover portion 3105 is the suitable range of the angle K24. In this embodiment, when the downstream side of the direction of arrow R, which is the rotational direction of the drum 3062, is taken as positive, the preferred range of angle K24 is −40° or more and 25° or less.

A line extending from the rotational axis Ax1 of the drum 3062 to pass through the rotational axis Ax2 of the developing roller 3032 is taken as a reference line. An angle K25 is an angle formed between this reference line and the straight line extending from the rotational axis Ax1 of the drum 3062 and passing through the tip of the teeth of the gear portion 3291a of the rack gear 3291. In this case, it is preferred that the rack gear 3291 is positioned so that the angle K25 is also in the range of −40° or more and 25° or less.

It will suffice if the angle K25 of at least one tooth of the gear portion 3291a of the rack gear 3291 is positioned so that the preferred range is satisfied.

It is particularly preferable that the angle K25 formed by the straight line passing through the tooth tip of the gear portion 3291a of the rack gear 3291 from the rotational axis Ax1 is in the above range.

In this embodiment, the rack gear mechanism 3290 is provided in the developing unit 3220, but it may be provided in the cleaning unit 3260 depending on the settings of the angle K24, the distance L24, and the distance L25.

As described above, the apparatus main assembly ZA and the cartridge ZB may also have a structure having a rack gear mechanism as in Embodiment 2.

It is also possible to combine part of the structures disclosed in Embodiment 3 to 9 with the cartridge ZB that is detachably mountable to the apparatus main assembly ZA.

In the cartridge ZB disclosed in this embodiment, instead of the rack gear 3291 or the rack gear mechanism 3290 having the rack gear 3291, the following members or mechanisms having those members described in Embodiments 3-9 can be attached:

Frictional force applying portion 326a (FIG. 42), elastic rotatable member 490 (FIG. 54), missing tooth gear 591 (FIG. 56, FIG. 60), elastic member 5911a (FIG. 66), rotatable rack gear 691 (FIG. 70), projecting member 791 (FIG. 76), projecting member 7152 (FIGS. 83 to 90), engaging member 7291 (FIGS. 91 to 98), gear member 891 (FIGS. 102 to 105), elastic ring 8291 (FIG. 106, 107), elastic belt gear 8391 (FIG. 108), elastic belt 8491 (FIG. 110), rotating member 991 (FIGS. 111 to 113), load applying member 992 (FIG. 114), rotating member 9912 (FIG. 117).

For example, the friction force imparting portion 326a (FIG. 42) disclosed in Embodiment 3 or the driving-side development side member 326 having the friction force imparting portion 326a can be mounted to the cartridge ZB instead of the rack gear 3291 or the rack gear mechanism 3290. In this case, the cartridge ZB is provided with the control member 3101 and the friction force imparting portion 326a.

At this time, inside the apparatus main assembly ZA, the drive transmission member 3081 is covered by the cover portion 3105. Therefore, even if any of the above members is mounted to the cartridge instead of the rack gear 3291, the preferable arrangement range of the member is the same as the preferable arrangement range of the rack gear 3291 described referring to FIG. 170.

In other words, the preferable arrangement range is an angle K26 of −40° or more and 25° or less with respect to the straight line connecting the axis Ax1 of the drum 3062 and the axis Ax2 of the developing roller 3032.

It will suffice if at least a part of the surface of the friction force imparting portion 326a (FIG. 42), the projecting member 7152 (FIGS. 83 to 90), or at least one tooth of the rotatable rack gear 691 (FIG. 70) is located in the range K26.

### Embodiment 14

Next, Embodiment 14 will be described. Here, the description of the same points as in the previous examples may be omitted. In particular, of the elements disclosed in this example, those corresponding to the members described in Embodiment 12 will be assigned the same names as in Embodiment 12, and only the points different from those in Embodiment 12 will be described.

In Embodiment 13, it has been stated that the structures disclosed in Embodiments 3 to 9, such as the friction force imparting portion 326a (FIG. 42), can be applied to the cartridge ZB shown in Embodiment 12.

On the other hand, the structures disclosed in Embodiments 3 to 9 may be placed at a position different from the preferred range described in Embodiment 13. Specifically, the same effect can be provided by providing these on the control member 3101. For example, a structure in which a frictional force imparting portion (friction material, friction member) is provided on the control member 3101 will be described in the following.

The above structure will be described in the following.

FIG. 173 is a side view of the cartridge ZB used in this embodiment as viewed from the drive side.

As shown in FIG. 173, a control member 3301 is attached to the drum bearing 3073 of the cartridge ZB of this embodiment, as in Embodiment 12. The control member 3301 has approximately the same shape as the control member 3101 of Embodiment 12, but a friction force imparting portion 3302 is mounted on the restricting portion 3301c. The friction force imparting portion 3302 has a flat plate shape and is arranged so that the restricting surface 3302c faces the axis Ax1 of the drum 3062.

Here, a shortest distance L26 from the central axis Ax1 of the drum 3062 to the restricting surface 3302c of the friction force imparting portion 3302 is the same as the shortest distance R3 from the central axis Ax1 of the drum 3062 to the restricting surface 3101c of the control member 3101 in Embodiment 12 (see FIG. 160 in Embodiment 12).

### (Frictional Force Imparting Portion 3302)

Next, referring to FIG. 174, the movement of the friction force imparting portion 3302 when the cartridge ZB is mounted will be described. FIG. 174 is a sectional view of the apparatus main assembly ZA and the cartridge ZB taken along a plane passing through the central axis Ax1 of the drum 3062, in which part (a) of FIG. 174 shows a state before the opening/closing door 3013 is closed, and part (b) of FIG. 174 shows a state after the opening/closing door 3013 is closed. The movement of each part other than the friction force imparting portion 3302 is the same as in Embodiment 12, and therefore the description thereof will be omitted.

When cartridge ZB is mounted to apparatus main assembly ZA (part (a) of FIG. 174) and opening/closing door 3013 of apparatus main assembly ZA is closed, the cylindrical cam 3086 moves toward E26 side, Similarly to Embodiment 12, and restriction of the drive transmission member 3081 is ceased. The drive transmission member 3081 is urged by urging force FF2 from inclining member 3097, as described in Embodiment 12.

Moreover, the drive transmission member 3081 receives a force FB2 from the friction force imparting portion 3302 provided on the control member 3301 of the cartridge ZB.

As in Embodiment 12, since FB2>FF2, the drive transmission member 3081 moves in the direction in which the inclination becomes smaller. In the process of the drive transmission member 3081 moving in the direction of decreasing the inclination, as shown in part (a) of FIG. 174, the drive transmission member 3081 receives a friction force FB1 from the friction force imparting portion 3302 in the direction of the arrow E20, which is the opposite direction to the moving direction (see part (a) of FIG. 174). However, if the force FB2 is sufficiently large compared to the friction force FB1, the force FB2 overcomes the friction force FB1, and the drive transmission member 3081 moves in the direction of decreasing the inclination. Here, the strength of the friction force FB1 differs depending on the friction coefficient of the restricting surface 3302c of the friction force imparting portion 3302. If the force FB1 becomes large due to the friction coefficient of the restricting surface 3302c, the force FB2 cannot overcome the friction force FB1, with the result that the drive transmission member 3081 cannot move in the direction of decreasing the inclination. The preferable range of the friction coefficient of the restricting surface 3302c will be described hereinafter.

Next, referring to FIG. 175, the movement of the drive transmission member 3081 of the apparatus main assembly ZA when it is driven to rotate will be described.

FIG. 175 is a cross-sectional view of some parts as viewed from the non-driven side when the process cartridge ZB is mounted to the image forming apparatus ZA and the opening/closing door 3013 is closed.

As shown in FIG. 175, the drum bearing 3073 of the process cartridge ZB is provided with the restricting portion 3073j and a control member 3301, as in Embodiment 12.

The apparatus main assembly ZA is also provided with a cover portion 3105 and the inclining member 3097. The inclining member 3097 urges the drive transmission member 3081 with an urging force FF2 in a direction away from the axis Ax2 of the developing roller 3032.

The gear portion 3081a of the drive transmission member 3081 abuts against the restricting surface 3302c of the friction force imparting portion 3302 provided on the control member 3301. As described in Embodiment 12, the control member 3301 is urged in the direction of the arrow BB, which is the rotational direction about the support boss 3301a of the control member 3301, by the urging spring 3102, which is a torsion coil spring. This urging force is sufficiently larger than the urging force FF2.

When the drive transmission member 3081 rotates in the direction of the arrow R, the drive transmission member 3081 receives a force FB3, which is a frictional force in a tangential direction of a gear tooth tip circle of the gear portion 3081a, in the opposite direction to the rotational direction, from the restricting surface 3302c of the friction force imparting portion 3302.

Referring to FIG. 182, the frictional force received by the gear portion 3081a of the drive transmission member 3081 will be described in detail. FIG. 182 is an enlarged cross-sectional view perpendicular to the axial direction of one tooth of the gear portion 3081a.

As shown in FIG. 182, a friction force FB3 acting on gear portion 3081a has a friction force FB31 at a tip edge of the tooth and a friction force FB32 at the tooth tip circle portion.

Next, referring to FIG. 176, a direction of action of the friction force FB3 as viewed in a direction perpendicular to axis Ax1 of drum 3062 will be described.

FIG. 176 is a side view of the drive transmission member 3081 as viewed in a direction perpendicular to the friction force FB3 shown in FIG. 175.

As shown in FIG. 176, the gear portion 3081a of the drive transmission member 3081 receives the force FB31 as a frictional force perpendicular to the tooth tip edge. The friction force FB31 has a component forces FB7 in the E26 direction and FB5 in the tangential direction of the gear portion 3081a. As drive transmission member 3081 continues to rotate, torque is produced due to forces FB32 and FB5 in the tangential direction of the gear portion 3081a. In other words, the torque required to rotate the drive transmission member 3081 increases due to the frictional force from the restricting surface 3302c.

Next, the movement of the drive transmission member 3081 as viewed in a direction perpendicular to the axis Ax1 of the drum 3062 will be described. FIG. 177 is a sectional view of the apparatus main assembly ZA and cartridge ZB taken along a plane including the axis Ax1 of the drum 3062.

As shown in FIG. 177, the drive transmission member 3081 is subjected to an urging force FF2 from the inclining member 3097 and a force FB2 from the friction force imparting portion 3302 in a direction perpendicular to the axis Ax1.

As described in Embodiment 12, the drive transmission member 3081 engages with a drive idler gear (not shown) at the second gear portion 3081j and receives a force in the rotational direction. The second gear portion 3081j has a helical tooth shape inclined with respect to the axis of the drive transmission member 3081, and as viewed from the non-driven side, the shape is twisted in a clockwise direction as it goes in the direction of arrow E20.

For this reason, when the second gear portion 3081j receives a driving force, in addition to the force in the rotational direction, it receives a force FB6 in the axial direction, that is, the direction of arrow E26.

As described above, the torque increases when the drive transmission member 3081 rotates against forces FB32 and FB5. And as the torque required to rotate the drive transmission member 3081 increases, force FB6 also increases proportionally (see Figure B4).

In this manner, the drive transmission member 3081 receives a force FB6 from the drive idler gear (not shown) to the second gear portion 3081j and the force FB7 from the friction force imparting portion 3302 to the gear portion 3081a, so that it moves in the direction of arrow E26.

At this time, the drive transmission member 3081 engages with the engaging portion 3063b of the driving side drum flange 3063 of the drum 3062 and rotates together with the drive transmission member 3081, by which the posture thereof is maintained by the restricting portion 3073j and the cover portion 3105 shown in FIG. 175.

With the above-described structure, the drive transmission member 3081 can engage with the driving side drum flange 3063 and transmit the drive to the drum 3062, even if no structure for engaging with the drive transmission member 3081 is provided on the developing unit 3020 side. This makes it possible to reduce the number of parts and to achieve a space-saving structure.

### (Preferred Range of Friction Force Imparting Portion 3302)

FIG. 178 is a cross-sectional view of the apparatus main assembly ZA and cartridge ZB, taken along a line X211-X211 in FIG. 177.

As shown in FIGS. 157 and 178 of Embodiment 12, the apparatus main assembly ZA is provided with a cover portion 3105 as in Embodiment 12, and the friction force imparting portion 3302 is disposed at a position corresponding to the fourth opening 3105d. For the structure in which the friction force imparting portion 3302 is disposed at the second opening 3105b, reference is made to the description of Embodiments 8 and 13.

Since the drive transmission member 3081 of the apparatus main assembly ZA is covered with the cover portion 3105, the range in which the friction force imparting portion 3302 can engage with the drive transmission member 3081 is limited. In other words, an angle K27, which is the preferred range of the friction force imparting portion 3302, is the angle formed by the axis Ax1 of the drum 3062 and a line connecting the opening ends 3105d1, 3105d2 of the fourth opening 3105d of the cover portion 3105.

That is, as shown in FIG. 178, when a straight line connecting the axis Ax1 of the drum 3062 and the axis Ax2 of the developing roller 3032 is used as the reference and the downstream side in the direction of arrow R, which is the rotational direction of the drum 3062, is taken as positive, the preferred range of angle K27 is 130° or more and 190° or less.

As mentioned above, if the friction coefficient of the friction force imparting portion 3302 is too high, the drive transmission member 3081 will not be able to move in a direction reducing the inclination when the front door 3013 is closed. Conversely, if the friction coefficient is too low, the forces FB6 and FB7 resulting from the frictional forces shown in FIG. 176 so small that the drive transmission member 3081 cannot move in the E26 direction.

In this embodiment, the friction coefficient of the friction force imparting portion 3302 with respect to the drive transmission member 3081 is set in the range of about 0.3 to 0.5, and 0.4 is particularly preferable. For example, a wrapping film (a film member made of polyvinyl chloride with a thickness of about 0.1 to 0.2) is preferable with a grain size of about 5 μm. A wrapping film is one of the abrasive materials.

In addition, the materials suitable for use as the friction force imparting portion 326a in Embodiment 3 are also suitable for use as the friction force imparting portion 3302, and therefore, the reference is made to the explanation of Embodiment 3. For example, an elastic body such as polyurethane foam can be used as the frictional force imparting portion.

In addition, a tacky material such as double-sided tape can also be used as the frictional force imparting portion. It is desirable that the friction coefficient of them falls within the preferable range.

As described above, the preferred range of the friction coefficient varies depending on the structure of the apparatus main assembly ZA, the shape of the control member 3301, the urging force of the urging spring 3102, and so on.

In addition, in this embodiment, as shown in FIG. 173, the shortest distance L26 from the central axis Ax1 of the drum 3062 to the restricting surface 3302c of the friction force imparting portion 3302 is the same as the shortest distance R3 from the central axis Ax1 of the drum 3062 to the restricting surface 3101c of the control member 3101 in Embodiment 12 (see FIG. 160 in Embodiment 12). The preferred range of the shortest distance L26 is the same as the preferred range of the shortest distance R3 described in Embodiment 12 with respect to FIG. 168.

In addition, when the control member 3301 moves, the distance L25 from the friction force imparting portion 3302 to the drum axis AxIm changes, but the suitable range of L26 at that time is the same as that described using the distances DC1 and DC2 in FIG. 132. That is, the suitable distance from the central axis Ax1 of the drum to the restricting portion 1101h of the control member 1101 described using FIG. 132 corresponds to the suitable distance from the friction force imparting portion 3302 located on the surface of the control member 3301 to the axis Ax1 of the drum 3062 in this embodiment.

### Modified Example 1 of Embodiment 14

In the above-described structure, the structure in which the friction force imparting portion 3302 is provided on the control member 3301 has been described. For convenience of explanation, this may be called a representative example of Embodiment 14.

In contrast to this, a modified example will be described in the following in which a gear member 3402 having a protruding shape which abuts against the gear portion 3081a of the drive transmission member 3081 is provided on the control member 3301 instead of the friction force imparting portion 3302. This modified example may be referred to as Modified Example 1 of Embodiment 14 for convenience. With this Modified Example, it is possible to provide the same effect as the representative example of Embodiment 14 described above.

FIG. 179 is a side view of the cartridge ZB used in this embodiment as seen from the drive side.

As shown in FIG. 179, a control member 3401 is mounted to the drum bearing 3073 of the cartridge ZB of this modified example, as in Embodiment 12. The control member 3401 has approximately the same shape as the control member 3101 of Embodiment 12, but a gear member 3402 is mounted to the restricting portion 3401c. The gear member 3402 has a gear portion 3402a which is engageable with the gear portion 3081a of the drive transmission member 3081, and is structured with a gear shape having at least one tooth. In this embodiment, as an example, a gear member 3402 having multiple teeth, i.e., two teeth, is described. The gear portion 3402a is arranged to face the axis Ax1 of the drum 3062.

Here, a tangent line is taken which touches the tips of the multiple teeth of the gear portion 3402a provided on the control member 3401 of this embodiment. A distance L27 between this tangent line and the central axis Ax1 of the drum 3062 is the same as the shortest distance R3 from the central axis Ax1 of the drum 3062 of Embodiment 12 to the restricting surface 3101c of the control member 3101 (see FIG. 160 of Embodiment 12).

When the control member 3401 moves, the distance L27 changes, but the preferred size of the distance L27 at that time is the same as that explained using the distances DC1 and DC2 in FIG. 132. That is, the preferred distance from the central axis Ax1 of the drum to the restricting portion 1101h of the control member 1101 explained using FIG. 132 corresponds to the preferred distance from the gear portion 3402a of the control member 3401 to the axis Ax1 of the drum 3062 in this embodiment.

Here, the distance L27 can also be regarded as the distance from the drum axis Ax1 to any of the teeth of the gear portion 3042a measured along a direction perpendicular to the axis Ax1 of the drum 3062.

In addition, the preferred range of the angle K27 for the friction force imparting portion 3302 explained using FIG. 178 also applies to the gear portion 3402a.

Next, referring to FIG. 180, the movement of the gear member 3402 will be described.

FIG. 180 is cross-sectional views of some parts as viewed from the non-drive side with the process cartridge ZB mounted to the image forming apparatus ZA and the door 3013 closed.

Part (a) of FIG. 180 shows a state in which the gear member 3402 and the drive transmission member 3081 are engaged with each other, and part (b) of FIG. 180 shows the state in which the gear member 3402 and the drive transmission member 3081 are disengaged from each other.

As shown in part (a) of FIG. 180, the drum bearing 3073 of the process cartridge ZB is provided with a restricting portion 3073j and a control member 3401, as in Embodiment 12. In addition, the apparatus main assembly ZA is provided with a cover portion 3105.

An inclining member 3097 is provided in the apparatus main assembly ZA, and urges the drive transmission member 3081 with an urging force FF2 in a direction away from the axis Ax2 of the developing roller 3032.

The gear portion 3081a of the drive transmission member 3081 engages with a gear portion 3402a of a gear member 3402 provided on the control member 3401. As described in Embodiment 12, the control member 3401 is urged in the direction of arrow BB, which is the rotational direction about a support boss 3401a (not shown) of the control member 3401, by an urging spring 3102 (not shown), which is a torsion coil spring. This urging force is sufficiently larger than the urging force FF2.

When the drive transmission member 3081 rotates in the direction of the arrow R, a tooth surface 3081a1 of the drive transmission member 3081 receives a force FB8 from the gear portion 3402a of the gear member 3402 in a direction perpendicular to the gear tooth surface, that is, in the direction of the front pressure angle of the gear portion 3402a. Here, the force FB8 has a component force FB10 in the direction of the rotational direction R, and a component force FB11 in a direction perpendicular to the force FB10.

In addition, the gear member 3402 receives a reaction force FB9 in the opposite direction to the force FB8.

The gear portion 3402a has a helical tooth shape so that it can engage with the gear portion 3081a of the drive transmission member 3081, and the front pressure angle thereof is approximately the same as the front pressure angle of the gear portion 3081a.

The force FB9 applied to the gear member 3402 is in a direction which does not intersect with Bx1, which is the central axis of the support boss of the control member 3401, so that the force FB9 causes the control member 3401 to rotate in a rotational direction AB against the urging force of the urging spring 3102 (not shown).

When the control member 3401 rotates in the direction of arrow AB, the gear portion 3402a and the gear portion 3081a of the drive transmission member 3081 are disengaged as shown in part (b) of FIG. 180. Thereafter, the control member 3401 is rotated again in the direction of arrow BB by the urging force of the urging spring 3102. The gear portion 3081a of the drive transmission member 3081 abuts against the tooth surface 3081a1 of the drive transmission member 3081 again, and the force FB9 renders the state as shown in part (b) of FIG. 180. The control member 3401 repeats the above operation.

Next, referring to FIGS. 181 and 183, the movement of the drum 3062 in the direction of the axis Ax1 will be explained.

FIG. 181 is a sectional view of the apparatus main assembly ZA and cartridge ZB taken along a plane including the central axis Ax1 of the drum 3062, and shows a state in which the opening/closing door 3013 is closed after the cartridge ZB is mounted.

FIG. 183 is a sectional view of the apparatus main assembly ZA and cartridge ZB taken along a line X212-X212 of part (a) of FIG. 180.

As shown in FIG. 183, the gear portion 3081a of the drive transmission member 3081 is a helical gear. As a result, the force FB10 (see part (a) of FIG. 180), which is a component of the force generated by the engagement of the gear member 3402 with the gear portion 3402a, further has, as its components, a force FB12 in the rotational direction and a force FB13 in the direction E26.

As described above, the drive transmission member 3081 moves in the direction of arrow E26 by the force FB13 in the direction of arrow E26 received from the gear portion 3081a while its posture is maintained by the cover portion 3105 and the restricting portion 3073j, by intermittently abutting the gear member 3402. Then, as in the previously described embodiment, the drive transmission member 3081 engages with the engaging portion 3063b of the driving side drum flange 3063 of the drum 3062 of the cartridge ZB and rotates together.

In addition, the distance L27 between the tooth tip of the gear portion 3402a provided on the control member 3401 of this embodiment and the central axis Ax1 of the drum 3062 is the same as the shortest distance R3 from the central axis Ax1 of the drum 3062 to the restricting surface 3101c of the control member 3101 of Embodiment 12 (see FIG. 160 of Embodiment 12). The preferred range of the shortest distance L27 is the same as the preferred range of the shortest distance R3 of Embodiment 12.

Furthermore, in this Modified Example, the gear portion 3402a is described as having a helical gear shape, but it may have any shape that abuts against the gear portion 3081a of the drive transmission member 3081. For example, a shape having at least one or more protrusions extending outward in the axial direction or a narrow spur tooth shape can provide the same effect.

In this Modified Example, the preferred range in the direction perpendicular to the central axis Ax1 of the drum 3062 is the same as that of Embodiment 14. That is, as shown in FIG. 178, the straight line connecting the axis Ax1 of the drum 3062 and the axis Ax2 of the developing roller 3032 is taken as a reference line, and the downstream side in the arrow R direction, which is the rotational direction of the drum 3062, is taken as the positive direction of the angle. In this case, the preferable range of angle K27 is 130° or more and 190° or less with respect to the reference line.

By employing the above-described structure, by forming the control member 3401 and the gear member 3402 integrally, for example, the same effect as in Embodiment 14 can be provided without mounting a separate friction force imparting part or the like. That is, the drive transmission member 3081 engages with the driving side drum flange 3063, and it is possible to transmit the drive to the drum 3062, and it is possible to reduce the parts and achieve a space-saving structure.

### <Examples of Structures>

Finally, the following are some examples of the cartridge structures described in the above embodiments.

### (Structure 1)

A cartridge comprising:
a frame;
a photosensitive drum supported by the frame and rotatable about an axis; and
a rack having one or more teeth at least partially exposed to face the axis of the photosensitive drum and provided at a side of the cartridge with respect to a direction of the axis of the photosensitive drum.

### (Structure 2)

The cartridge according to Structure 1, further comprising a coupling configured to be capable of transmitting a driving force to the photosensitive drum, the coupling being provided at an end of the photosensitive drum and at the side of the cartridge.

### (Structure 3)

The cartridge according to Structure 2, wherein the end of the photosensitive drum is a first end, the photosensitive drum having a second end opposite the first end, and the one or more teeth are at least partially positioned more remote from the second end of the photosensitive drum than a free end of the coupling as measured along the axis of the photosensitive drum.

### (Structure 4)

The cartridge according to any one of Structures 1 to 3, wherein the rack is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

### (Structure 5)

The cartridge according to any one of Structures 1 to 4, further comprising a movable member provided at the side of the cartridge, wherein the movable member is movable so that a distance from a surface of the movable member to the axis of the photosensitive drum changes.

### (Structure 6)

The cartridge according to Structure 5, wherein as viewed along the axis of the photosensitive drum, the movable member is capable of taking a position such that at least a part of the photosensitive drum is between the surface of the movable member and the rack.

### (Structure 7)

The cartridge according to Structure 5 or 6, wherein the photosensitive drum has a first end and a second end opposite the first end,
the cartridge further comprising a coupling configured to be capable of transmitting a driving force to the photosensitive drum, the coupling being positioned at the first end of the photosensitive drum and at the side of the cartridge,
wherein the movable member is capable of taking a positioned such that at least a part of the surface of the movable member is more remote from the second end of the photosensitive drum than a free end portion of the coupling as measured along the axis of the photosensitive drum.

### (Structure 8)

The cartridge according to any one of Structures 5 to 7, wherein the movable member is capable of taking a position such that the surface of the movable member is adjacent to a peripheral surface of the photosensitive drum as viewed in the axial direction of the photosensitive drum.

### (Structure 9)

The cartridge according to any one of Structures 5 to 8, wherein the movable member is capable of taking a position such that a distance from the surface of the movable member to the axis of the photosensitive drum is less than 1.2 times the radius of the photosensitive drum.

### (Structure 10)

The cartridge according to any one of Structures 5 to 9, wherein the movable member is capable of taking a position such that a distance from the surface of the movable member to the axis of the photosensitive drum is greater than 1.25 times the radius of the photosensitive drum.

### (Structure 11)

The cartridge according to any one of Structures 1 to 10, wherein the rack has a plurality of the teeth, and wherein the rack is configured to move along a straight line or a flat plane contacting to tips of the teeth.

### (Structure 12)

The cartridge according to any one of Structures 1 to 11, wherein the rack has a plurality of the teeth, and wherein a distance, measured along a direction perpendicular to the axis of the photosensitive drum, from the axis of the photosensitive drum to a line passing through tips of the teeth is 90% or more and 120% or less of a radius of the photosensitive drum.

### (Structure 13)

The cartridge according to any one of Structures 1 to 12, wherein the rack is capable of taking a position such that as viewed along the axis of the photosensitive drum, a line extending in a direction perpendicular to a direction of movement of the rack away from the photosensitive drum forms an angle of −75° or more and 50° or less, or 130° or more and 190° or less, with respect to a line extending from the axis of the photosensitive drum to pass through an axis of a developing roller, with a downstream direction of rotation of the photosensitive drum being positive direction of the angle.

### (Structure 14)

The cartridge according to any one of Structures 1 to 13, wherein the rack is capable of taking a position such that as viewed along the axis of the photosensitive drum,
a line extending from the axis of the photosensitive drum through one of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

### (Structure 15)

The cartridge according to any one of Structures 1 to 14, wherein the rack is movable between a first position and a second position, and the cartridge further comprises a lock configured to restrict movement of the rack between the first position and the second position.

### (Structure 16)

The cartridge according to Structure 15, wherein the rack is urged toward the first position.

### (Structure 17)

The cartridge according to Structure 15, wherein the lock is configured to restrict movement of the rack when the rack is in the second position.

### (Structure 18)

The cartridge according to any one of Structures 15 to 17, wherein the lock is configured to be switchable between an operating state in which the lock is capable of restricting movement of the lock and an inoperative state in which the lock does not restrict movement of the rack.

### (Structure 19)

The cartridge according to Structure 18, further comprising an operating portion configured to switch the lock between the operating state and the inoperative state.

### (Structure 20)

The cartridge according to any one of Structures 1 to 18, further comprising a movable member positioned at the side of the cartridge, wherein the movable member is capable of moving so that a distance from a surface of the movable member to the axis of the photosensitive drum changes.

### (Structure 21)

The cartridge according to Structure 20, wherein the movable member is capable of taking a position such that at least a part of the photosensitive drum is between a surface of the movable member and a surface of the rack as viewed along the axis of the photosensitive drum.

### (Structure 22)

The cartridge according to Structure 20 or 21, wherein the photosensitive drum has a first end and a second end opposite the first end,
the cartridge further comprising a coupling configured to be capable of transmitting a driving force to the photosensitive drum, the coupling being positioned at the first end of the photosensitive drum and at the side of the cartridge,
wherein the movable member is capable of taking a positioned such that at least a part of the surface of the movable member is more remote from the second end of the photosensitive drum than a free end portion of the coupling as measured along the axis of the photosensitive drum.

### (Structure 23)

The cartridge according to any one of Structures 20 to 22, wherein the movable member is capable of taking a position such that the surface of the movable member is adjacent to a peripheral surface of the photosensitive drum as viewed along the axis of the photosensitive drum.

### (Structure 24)

The cartridge according to any one of Structures 20 to 23, wherein the movable member is capable of taking a position such that a distance from the surface of the movable member to the axis of the photosensitive drum is less than 1.2 times a radius of the photosensitive drum.

### (Structure 25)

The cartridge according to any one of Structures 20 to 24, wherein the movable member is capable of taking a position such that a distance from the surface of the movable member to the axis of the photosensitive drum is greater than 1.25 times a radius of the photosensitive drum.

### (Structure 26)

A cartridge comprising:
a frame;
a photosensitive drum supported by the frame and rotatable about an axis; and
an elastic member having a surface at least partially exposed so as to face the axis of the photosensitive drum, the elastic member being provided at a side of the cartridge with respect to a direction of the axis of the photosensitive drum.

### (Structure 27)

The cartridge according to Structure 26, wherein the elastic member is movable.

### (Structure 28)

The cartridge according to Structure 26 or 27, wherein the elastic member is movable along the surface.

### (Structure 29)

The cartridge according to any one of Structures 26 to 28, wherein the elastic member is rotatable about an axis thereof.

### (Structure 30)

The cartridge according to any one of Structures 26 to 29, wherein the elastic member is movable so as to change a distance from the axis of the photosensitive drum to the surface of the elastic member.

### (Structure 31)

The cartridge according to Structure 26, further comprising a movable lever on which the elastic member is provided.

### (Structure 32)

The cartridge according to any one of Structures 26 to 31, further comprising a lock configured to restrict movement of the elastic member.

### (Structure 33)

The cartridge according to Structure 32, wherein the lock is switchable between an operating state in which the lock is capable of restricting the movement of the elastic member and an inoperative state in which the lock does not restrict the movement of the elastic member.

### (Structure 34)

The cartridge according to Structure 33, further comprising an operating portion configured to switch the lock between the operating state and the inoperative state.

### (Structure 35)

The cartridge according to any one of Structures 32 to 34, further comprising a spring urging the elastic member.

### (Structure 36)

The cartridge according to Structure 35, wherein the elastic member is movable between a first position and a second position, and the elastic member is urged toward the first position.

### (Structure 37)

The cartridge according to any one of Structures 32 to 36, wherein the lock is configured to restrict movement of the elastic member when the elastic member is in the second position.

### (Structure 38)

The cartridge according to any one of Structures 26 to 37, further comprising a coupling configured to transmit a driving force to the photosensitive drum, the coupling being positioned at an end of the photosensitive drum and at the side of the cartridge.

### (Structure 39)

The cartridge according to any one of Structures 26 to 38, wherein the end of the photosensitive drum is a first end, the photosensitive drum having a second end opposite the first end, and at least a part of the surface of the elastic member is more remote from the second end of the photosensitive drum than a free end portion of the coupling, as measured along the axis of the photosensitive drum.

### (Structure 40)

The cartridge according to any one of Structures 26 to 39, wherein the elastic member is capable of taking a position such that a distance from the axis of the photosensitive drum to the surface of the elastic member is 75% or more and 120% or less of a radius of the photosensitive drum, as measured along a direction perpendicular to the axis of the photosensitive drum.

### (Structure 41)

The cartridge according to any one of Structures 26 to 40, further comprising a movable member provided at the side of the cartridge, the movable member being movable so that a distance from a surface of the movable member to the axis of the photosensitive drum changes.

### (Structure 42)

The cartridge according to Structure 41, wherein the movable member is capable of taking a position such that at least a part of the photosensitive drum is between the surface of the movable member and the surface of the elastic member, as viewed along the axis of the photosensitive drum.

### (Structure 43)

The cartridge according to any one of Structures 41 to 42, wherein the photosensitive drum has a first end and a second end opposite the first end,
the cartridge further comprising a coupling configured to be capable of transmitting a driving force to the photosensitive drum, the coupling being provided at the first end of the photosensitive drum and at the side of the cartridge, and
wherein the movable member is capable of taking a position such that at least a part of the surface of the movable member is more remote from the second end of the photosensitive drum than a free end portion of the coupling, as measured along the axis of the photosensitive drum.

### (Structure 44)

The cartridge described in any one of Structures 41 to 43, wherein the movable member is capable of taking a position such that the surface of the movable member is adjacent to a peripheral surface of the photosensitive drum, as viewed along the axis of the photosensitive drum.

### (Structure 45)

The cartridge according to any one of Structures 41 to 44, wherein the movable member is capable of taking a position such that a distance from the surface of the movable member to the axis of the photosensitive drum is less than 1.2 times a radius of the photosensitive drum.

### (Structure 46)

The cartridge according to any one of Structures 41 to 45, wherein the movable member is capable of taking a position such that a distance from the surface of the movable member to the axis of the photosensitive drum is greater than 1.25 times a radius of the photosensitive drum.

### (Structure 47)

The cartridge according to any one of Structures 26 to 46, wherein as viewed along the axis of the photosensitive drum, a line extending from the axis of the photosensitive drum through the surface of the elastic member forms an angle of −70° or more and 100° or less, or 130° or more and 190° or less, with respect to a line extending from the axis of the photosensitive drum through an axis of a developing roller, with a downstream direction of rotation of the photosensitive drum being positive direction of the angle.

### (Structure 48)

A cartridge comprising:
a frame;
a photosensitive drum supported by the frame and rotatable about an axis; and
a frictional force applying portion having a surface at least partially exposed so as to face the axis of the photosensitive drum and provided at a side of the cartridge with respect to a direction of the axis of the photosensitive drum.

### (Structure 49)

The cartridge according to Structure 48, wherein the frictional force applying portion is movable.

### (Structure 50)

The cartridge according to Structure 48 or 49, wherein the frictional force applying portion is movable so as to change a distance from the axis of the photosensitive drum to the surface of the frictional force applying portion.

### (Structure 51)

The cartridge according to any one of Structures 48 to 50, further comprising a movable lever on which the frictional force applying portion is provided.

### (Structure 52)

The cartridge according to any one of Structure 48 to 51, further comprising a coupling configured to transmit a driving force to the photosensitive drum and provided at an end of the photosensitive drum and at the side of the cartridge.

### (Structure 53)

The cartridge according to Structure 52, wherein the end of the photosensitive drum is a first end, the photosensitive drum having a second end opposite the first end, and at least a part of the surface of the frictional force applying portion is more remote from the second end of the photosensitive drum than a free end portion of the coupling, as measured along the axis of the photosensitive drum.

### (Structure 54)

The cartridge according to any one of Structures 48 to 53, wherein the frictional force applying portion is capable of taking a position such that a distance from the axis of the photosensitive drum to the surface of the frictional force applying portion is 75% or more and 120% or less of a radius of the photosensitive drum, as measured along a direction perpendicular to the axis of the photosensitive drum.

### (Structure 55)

The cartridge according to any one of Structures 48 to 54, wherein a coefficient of friction of the frictional force applying portion is higher than a coefficient of friction of a part exposed to outside of the frame.

### (Structure 56)

The cartridge according to any one of Structures 48 to 55, further comprising a movable member provided at the side of the cartridge, the movable member being movable such that a distance from a surface of the movable member to the axis of the photosensitive drum changes.

### (Structure 57)

The cartridge according to Structure 56, wherein the movable member is capable of taking a position such that at least a part of the photosensitive drum is between the surface of the movable member and the surface of the frictional force applying portion, as viewed along the axis of the photosensitive drum.

### (Structure 58)

The cartridge described in Structure 56 or 57, wherein the photosensitive drum has a first end and a second end opposite the first end, the cartridge further comprising a coupling configured to be capable of transmitting a driving force to the photosensitive drum, the coupling being provided at the first end of the photosensitive drum and at the side of the cartridge, wherein the movable member is capable of taking a position such that at least a part of the surface of the movable member is more remote from the second end of the photosensitive drum than the free end portion of the coupling, as measured along the axis of the photosensitive drum.

### (Structure 59)

The cartridge described in any one of Structures 56 to 58, wherein the movable member is capable of taking a position such that the surface of the movable member is adjacent to a peripheral surface of the photosensitive drum, as viewed along the axis of the photosensitive drum.

### (Structure 60)

The cartridge according to any one of Structures 56 to 59, wherein the movable member is capable of taking a position such that a distance from the surface of the movable member to the axis of the photosensitive drum is less than 1.2 times a radius of the photosensitive drum.

### (Structure 61)

The cartridge according to any one of Structures 56 to 60, wherein the movable member is capable of taking a position such that a distance from the surface of the movable member to the axis of the photosensitive drum is greater than 1.25 times a radius of the photosensitive drum.

### (Structure 62)

The cartridge according to any one of Structures 48 to 61, wherein as viewed along the axis of the photosensitive drum, a line extending from the axis of the photosensitive drum through the surface of the frictional force applying portion forms an angle of −70° or more and 100° or less, or 130° or more and 190° or less, with respect to a line extending from the axis of the photosensitive drum through an axis of a developing roller, where a downstream direction of rotation of the photosensitive drum is positive direction of the angle.

### (Structure 63)

The cartridge according to any one of Structures 48 to 62, wherein as viewed along the axis of the photosensitive drum, a normal line to the surface of the frictional force applying portion extending away from the axis of the photosensitive drum forms an angle of −70° or more and 100° or less, or 130° or more and 190° or less, with a line extending from the axis of the photosensitive drum to pass through an axis of a developing roller, where a downstream direction of rotation of the photosensitive drum is positive direction of the angle.

### (Structure 64)

The cartridge according to any one of Structures 48 to 63, wherein the frictional force applying portion is an elastic member.

### (Structure 65)

The cartridge according to any one of Structures 48 to 63, wherein the frictional force applying portion is an abrasive material.

### (Structure 66)

The cartridge according to any one of Structures 48 to 63, wherein the frictional force applying portion is a tacky member having tackiness.

### (Structure 67)

A cartridge comprising:

a frame;

a photosensitive drum supported by the frame and rotatable about an axis; and

a tacky member having a surface at least partially exposed so as to face the axis of the photosensitive drum and provided at a side of the cartridge with respect to a direction of the axis of the photosensitive drum.

### (Structure 68)

The cartridge according to Structure 67, wherein the tacky member is movable.

### (Structure 69)

The cartridge according to Structure 67 or 68, wherein the tacky member is movable so as to change a distance from the axis of the photosensitive drum to the surface of the tacky member.

### (Structure 70)

The cartridge according to any one of Structures 67 to 69, further comprising a movable lever on which the tacky member is provided.

### (Structure 71)

The cartridge according to any one of Structures 67 to 70, further comprising a coupling configured to transmit a driving force to the photosensitive drum, the coupling being provided at an end of the photosensitive drum and at the side of the cartridge.

### (Structure 72)

The cartridge according to Structure 71, wherein the end of the photosensitive drum is a first end, the photosensitive drum having a second end opposite the first end, and at least a part of the surface of the tacky member is more remote from the second end of the photosensitive drum than the free end portion of the coupling, as measured along the axis of the photosensitive drum.

### (Structure 73)

The cartridge according to any one of Structures 67 to 72, wherein the tacky member is capable of taking a position such that a distance from the axis of the photosensitive drum to the surface of the tacky member is 75% or more and 120% or more of a radius of the photosensitive drum, as measured along a direction perpendicular to the axis of the photosensitive drum.

### (Structure 74)

The cartridge according to any one of Structures 67 to 73, further comprising a movable member provided at the side of the cartridge, the movable member being movable so that a distance from the surface of the movable member to the axis of the photosensitive drum changes.

### (Structure 75)

The cartridge according to Structure 74, wherein the movable member is capable of taking a position such that at least a part of the photosensitive drum is between a surface of the movable member and the surface of the tacky member, as viewed along the axis of the photosensitive drum.

### (Structure 76)

The cartridge described in Structure 74 or 75, wherein the photosensitive drum has a first end and a second end opposite the first end,
the cartridge further including a coupling configured to capable of transmitting a driving force to the photosensitive drum, the coupling being provided at the first end of the photosensitive drum and at the side of the cartridge,
wherein the movable member is capable of taking a position such that at least a part of the surface of the movable member is more remote from the second end of the photosensitive drum than a free end portion of the coupling, as measured along the axis of the photosensitive drum.

### (Structure 77)

The cartridge according to any one of Structures 74 to 76, wherein the movable member is capable of taking a position such that the surface of the movable member is adjacent to a peripheral surface of the photosensitive drum, as viewed along the axis of the photosensitive drum.

### (Structure 78)

The cartridge according to any one of Structures 74 to 77, wherein the movable member is capable of taking a position such that a distance from the surface of the movable member to the axis of the photosensitive drum is less than 1.2 times a radius of the photosensitive drum.

### (Structure 79)

The cartridge according to any one of Structures 74 to 78, wherein the movable member is capable of taking a position such that a distance from the surface of the movable member to the axis of the photosensitive drum is greater than 1.25 times a radius of the photosensitive drum.

### (Structure 80)

The cartridge according to any one of Structures 67 to 79, wherein as viewed along the axis of the photosensitive drum, a line extending from the axis of the photosensitive drum through the surface of the tacky member forms an angle of −70° or more and 100° or less, or 130° or more and 190° or less, with respect to a line extending from the axis of the photosensitive drum through an axis of a developing roller, where a downstream direction of rotation of the photosensitive drum is positive direction of the angle.

### (Structure 81)

The cartridge according to any one of Structures 67 to 80, wherein, as viewed along the axis of the photosensitive drum, the normal to the surface of the tacky member extending away from the axis of the photosensitive drum forms an angle of −70° to 100°, or 130° to 190°, with a line extending from the axis of the photosensitive drum through an axis of the developing roller, where a downstream direction of rotation of the photosensitive drum is positive direction of the angle.

### (Structure 82)

A cartridge comprising:
a frame;
a photosensitive drum supported by the frame and rotatable about the axis thereof;
one or more movable teeth provided at a side of the cartridge with respect to a direction of the axis of the photosensitive drum and at least partially exposed so as to face the axis of the photosensitive drum; and
a lock for restricting movement of the one or more teeth.

### (Structure 83)

The cartridge of Structure 82, wherein the lock is switchable between an operating state capable of restricting movement of the one or more teeth and an inoperative state not restricting movement of the one or more teeth.

### (Structure 84)

The cartridge of Structure 83, further comprising an operating portion configured to switch the lock between the operating state and the inoperative state.

### (Structure 85)

The cartridge of Structure 82 or 83, further comprising a spring urging the one or more teeth.

### (Structure 86)

The cartridge of any one of Structures 82 to 85, wherein the one or more teeth are movable between a first position and a second position and urged toward the first position.

### (Structure 87)

The cartridge of Structure 86, wherein the lock is configured to restrict movement of the one or more teeth when the one or more teeth are in the second position.

### (Structure 88)

The cartridge of Structure 86, wherein the lock is configured to restrict movement of the one or more teeth when the one or more teeth are in the first position.

### (Structure 89)

The cartridge of any one of Structures 82 to 88, further comprising a gear having the one or more teeth.

### (Structure 90)

The cartridge of Structure 89, wherein the gear is a rack gear.

### (Structure 91)

The cartridge of Structure 89, wherein the gear is rotatable about an axis thereof.

### (Structure 92)

The cartridge of Structure 89, wherein the gear is a missing tooth gear.

### (Structure 93)

The cartridge of any one of Structures 82 to 92, further comprising a coupling configured to transmit a driving force to the photosensitive drum, the coupling being provided at an end of the photosensitive drum and at the side of the cartridge.

cartridge.

### (Structure 94)

The cartridge according to Structure 93, wherein the end of the photosensitive drum is a first end, the photosensitive drum having a second end opposite the first end, and at least a part of the one or more teeth is more remote from the second end of the photosensitive drum than the free end portion of the coupling, as measured along the axis of the photosensitive drum.

### (Structure 95)

The cartridge according to any one of Structures 82 to 94, wherein the one or more teeth is capable of taking a position such that a distance from the axis of the photosensitive drum to the free end portion of the one or more teeth is 90% or more and 120% or less of a radius of the photosensitive drum, as measured along a direction perpendicular to the axis of the photosensitive drum.

### (Structure 96)

The cartridge according to any one of Structures 82 to 95, further comprising a movable member provided at the side of the cartridge, the movable member being movable so that a distance from a surface of the movable member to the axis of the photosensitive drum changes.

### (Structure 97)

The cartridge according to Structure 96, wherein the movable member is capable of taking a position such that at least a part of the photosensitive drum is between the surface of the movable member and the gear, as viewed along the axis of the photosensitive drum.

### (Structure 98)

The cartridge according to Structure 96 or 97, wherein the movable member is capable of taking a position such that at least a part of the photosensitive drum is between the surface of the movable member and the surface of the elastic member, as viewed along the axis of the photosensitive drum.

### (Structure 99)

The cartridge described in any one of Structures 96 to 98, wherein the photosensitive drum has a first end and a second end opposite the first end,
the cartridge further comprising a coupling configured to be capable of transmitting a driving force to the photosensitive drum, the coupling being provided at the first end of the photosensitive drum and at the side of the cartridge,
wherein the movable member is capable of taking a position such that at least a part of the surface of the movable member is more remote from the second end of the photosensitive drum than the free end portion of the coupling, as measured along the axis of the photosensitive drum.

### (Structure 100)

The cartridge described in any one of Structures 96 to 99, wherein the movable member is capable of taking a position such that the surface of the movable member is adjacent to a peripheral surface of the photosensitive drum, as viewed along the axis of the photosensitive drum.

### (Structure 101)

The cartridge according to any one of Structures 96 to 100, wherein the movable member is capable of taking a position such that a distance from the surface of the movable member to the axis of the photosensitive drum is less than 1.2 times a radius of the photosensitive drum.

### (Structure 102)

The cartridge according to any one of Structures 96 to 101, wherein the movable member is capable of taking a position such that the distance from the surface of the movable member to the axis of the photosensitive drum is greater than 1.25 times a radius of the photosensitive drum.

### (Structure 103)

The cartridge according to any one of Structures 82 to 102, wherein as viewed along the axis of the photosensitive drum, a line extending from the axis of the photosensitive drum through a tooth of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

### (Structure 104)

A cartridge comprising:
a frame;
a photosensitive drum supported by the frame and rotatable about an axis;
a rotatable missing tooth gear provided at the side of the cartridge and having one or more teeth at least partially exposed so as to face the axis of the photosensitive drum.

### (Structure 105)

The cartridge according to Structure 104, further comprising a coupling configured to be capable of transmitting a driving force to the photosensitive drum, the coupling being provided at an end of the photosensitive drum and at the side of the cartridge.

### (Structure 106)

The cartridge according to Structure 105, wherein the end of the photosensitive drum is a first end, the photosensitive drum having a second end opposite the first end, wherein at least a part of the one or more teeth is more remote from the second end of the photosensitive drum than the free end portion of the coupling, as measured along the axis of the photosensitive drum.

### (Structure 107)

The cartridge according to any one of Structures 104 to 106, wherein the missing tooth gear is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

### (Structure 108)

The cartridge according to any one of Structures 104 to 107, further comprising a movable member provided at the side of the cartridge,
wherein the movable member is movable so that a distance from a surface of the movable member to an axis of the photosensitive drum changes.

### (Structure 109)

The cartridge according to Structure 108, wherein the movable member is capable of taking a position such that at least a part of the photosensitive drum is between the surface of the movable member and the missing tooth gear, as viewed along the axis of the photosensitive drum.

### (Structure 110)

The cartridge described in Structure 108 or 109, wherein the photosensitive drum has a first end and a second end opposite the first end,
the cartridge further comprising a coupling configured to be capable of transmitting a driving force to the photosensitive drum, the coupling being provided at the first end of the photosensitive drum and the side of the cartridge,
wherein the movable member is capable of taking a position such that at least a part of the surface of the movable member is more remote from the second end of the photosensitive drum than the free end portion of the coupling, as measured along the axis of the photosensitive drum.

### (Structure 111)

The cartridge described in Structure 110, wherein the movable member is capable of taking a position such that the surface of the movable member is adjacent to a peripheral surface of the photosensitive drum, as viewed along the axis of the photosensitive drum.

### (Structure 112)

The cartridge according to any one of Structures 108 to 111, wherein the movable member is capable of taking a position such that a distance from the surface of the movable member to the axis of the photosensitive drum is less than 1.2 times a radius of the photosensitive drum.

### (Structure 113)

The cartridge according to any one of Structures 108 to 112, wherein the movable member is capable of taking a position such that a distance from the surface of the movable member to the axis of the photosensitive drum is greater than 1.25 times a radius of the photosensitive drum.

### (Structure 114)

The cartridge according to any one of Structures 104 to 113, wherein as viewed along the axis of the photosensitive drum, a line extending from the axis of the photosensitive drum through the axis of the missing tooth gear forms an angle of −75° or more and +50° or less, or 130° or more and 190° or less, with respect to a line extending from the axis of the photosensitive drum through an axis of a developing roller, where a downstream direction of rotation of the photosensitive drum is positive direction of the angle.

### (Structure 115)

The cartridge according to any one of Structures 104 to 114, wherein the missing tooth gear is rotatable between a first position and a second position, the cartridge further comprising a lock configured to restrict movement of the missing tooth gear between the first position and the second position.

### (Structure 116)

The cartridge according to Structure 115, wherein the missing tooth gear is urged toward the first position.

### (Structure 117)

The cartridge described in Structure 115, wherein the lock is configured to restrict movement of the missing tooth gear when the missing tooth gear is in the second position.

### (Structure 118)

The cartridge described in Structure 115, wherein the lock is configured to restrict movement of the missing tooth gear when the missing tooth gear is in the first position.

### (Structure 119)

The cartridge described in any one of Structures 115 to 118, wherein the lock is capable of being switched between an operating state in which movement of the missing tooth gear is capable of being restricted and an inoperative state in which movement of the missing tooth gear is not restricted.

### (Structure 120)

The cartridge described in any one of Structures 115 to 119, further comprising an operating portion for switching the lock between the operating state and the inoperative state.

### (Structure 121)

A cartridge according to any one of Structures 115 to 120, wherein a locking state of the lock is released by rotation of the missing teeth.

### (Structure 122)

The cartridge according to any one of Structures 104 to 121, wherein the missing teeth gear is movable in a direction of an axis of itself.

### (Structure 123)

A cartridge comprising:
a frame;
a photosensitive drum supported by the frame and rotatable about an axis, the photosensitive drum having a first end and a second end opposite the first end; and
one or more movable teeth provided at a side of the cartridge with respect to a direction of the axis of the photosensitive drum and at least partially exposed toward the axis of the photosensitive drum;
a spring urging the one or more teeth,
wherein as viewed along the axis of the photosensitive drum,
a line extending from the axis of the photosensitive drum through a tooth of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

### (Structure 124)

The cartridge according to Structure 123, further comprising a gear having the one or more teeth.

### (Structure 125)

The cartridge according to Structure 124, wherein the spring urges the one or more teeth by way of the gear.

### (Structure 126)

The cartridge according to any one of Structures 123 to 125, further comprising a movable lever provided with the one or more teeth.

### (Structure 127)

The cartridge according to Structure 126, wherein the spring urges the one or more teeth by way of the lever.

### (Structure 128)

The cartridge according to any one of Structures 123 to 127, further comprising a coupling provided at an end of the photosensitive drum and configured to be capable of transmitting a driving force to the photosensitive drum.

### (Structure 129)

The cartridge according to Structure 128, wherein the end of the photosensitive drum is a first end, and the photosensitive drum has a second end opposite the first end, and wherein the one or more teeth is capable of being at least partially more remote from the second end of the photosensitive drum than the free end portion of the coupling, as measured along the axis of the photosensitive drum.

### (Structure 130)

The cartridge according to any one of Structures 123 to 129, wherein the one or more teeth is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

### (Structure 131)

A cartridge comprising:
a frame;
a photosensitive drum supported by the frame and rotatable about an axis;
one or more teeth provided at a side of the cartridge with respect to a direction of the axis of the photosensitive drum and at least partially exposed toward the axis of the photosensitive drum; and
a movable lever provided with the one or more teeth,
wherein as viewed along the axis of the photosensitive drum,
a line extending from the axis of the photosensitive drum through a tooth of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

### (Structure 132)

The cartridge according to Structure 131, further comprising a coupling configured to be capable of transmitting a driving force to the photosensitive drum and provided at an end of the photosensitive drum and at a side of the cartridge.

### (Structure 133)

The cartridge according to Structure 132, wherein the end of the photosensitive drum is a first end, the photosensitive drum having a second end opposite the first end, and the one or more teeth is capable of being positioned at least partially more remote from the second end of the photosensitive drum than a free end portion of the coupling, as measured along the axis of the photosensitive drum.

### (Structure 134)

The cartridge according to any one of Structures 131 to 133, wherein the one or more teeth are movable between a first position and a second position, the cartridge further comprising a lock for restricting movement of the one or more teeth between the first position and the second position.

### (Structure 135)

The cartridge according to Structure 134, wherein the one or more teeth are urged toward the first position.

### (Structure 136)

The cartridge of Structure 134 or 135, wherein the lock is configured to restrict movement of the rack in a state in which the one or more teeth are in the second position.

### (Structure 137)

The cartridge of Structure 134 or 135, wherein the lock is configured to restrict movement of the rack when the one or more teeth are in the first position.

### (Structure 138)

The cartridge of any one of Structures 131 to 137, further comprising an operating portion for switching between an operating state in which the lock is capable of restricting movement of the one or more teeth and an inoperative state in which the lock does not restrict movement of the one or more teeth.

### (Structure 139)

The cartridge according to any one of Structures 131 to 138, wherein the one or more teeth is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

### (Structure 140)

The cartridge according to any one of Structures 131 to 139, wherein the one or more teeth are fixed to the lever.

### (Structure 141)

The cartridge according to any one of Structures 131 to 140, wherein the free end portion of the lever is the one tooth.

### (Structure 142)

The cartridge according to any one of Structures 131 to 141, wherein the one or more teeth are movable in the direction of the axis of the photosensitive drum.

### (Structure 143)

The cartridge according to any one of Structures 131 to 142, wherein the one or more teeth are movable so that a distance from the axis of the photosensitive drum to the one or more teeth changes.

### (Structure 144)

A cartridge comprising:
a frame;
a photosensitive drum supported by the frame and rotatable about an axis, the photosensitive drum having a first end and a second end opposite the first end; and
a rotatable gear provided at a side of the cartridge with respect to a direction of the axis of the photosensitive drum, the rotatable gear having one or more teeth at least partially exposed toward the axis of the photosensitive drum, the rotatable gear being movable in a direction of the axis of itself.

### (Structure 145)

The cartridge according to Structure 144, wherein as viewed along the axis of the photosensitive drum, a line extending from the axis of the photosensitive drum through a tooth of the one or more teeth forms an angle of −75° or more and 50° or less, or 130° or more and 190° or less, with respect to a line extending from the axis of the photosensitive drum through the axis of a developing roller, where a downstream direction of rotation of the photosensitive drum is positive direction of the angle.

### (Structure 146)

The cartridge according to Structure 144 or 145, further comprising a spring urging the gear.

### (Structure 147)

The cartridge according to Structure 146, wherein the spring urges the one or more teeth by way of the gear.

### (Structure 148)

The cartridge according to any one of Structures 144 to 147, further comprising a lock for restricting movement of the gear.

### (Structure 149)

The cartridge according to Structure 148, wherein a locking state of the gear by the lock is released by rotation of the gear.

### (Structure 150)

The cartridge according to any one of Structures 144 to 149, further comprising a coupling provided at an end of the photosensitive drum and configured to be capable of transmitting a driving force to the photosensitive drum.

### (Structure 151)

The cartridge according to Structure 150, wherein the end of the photosensitive drum is a first end, the photosensitive drum having a second end opposite the first end, and the gear is capable of taking a position such that the one or more teeth are at least partially more remote from the second end of the photosensitive drum than the free end portion of the coupling, as measured along the axis of the photosensitive drum.

### (Structure 152)

The cartridge according to any one of Structures 144 to 151, wherein the one or more teeth is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

### (Structure 153)

A cartridge comprising:
a frame;
a photosensitive drum supported by the frame and rotatable about an axis; and
a rotatable gear having one or more teeth at least partially exposed toward the axis of the photosensitive drum, the rotatable gear being provided at a side of the cartridge with respect to a direction of the axis of the photosensitive drum,
wherein one of the frame and the gear has a hole and the other has a shaft portion that fits into the hole, with a gap between the hole and the shaft portion, the gap making the gear movable in a direction perpendicular to an axis of itself.

### (Structure 154)

The cartridge according to Structure 153, further comprising a coupling configured to be capable of transmitting a driving force to the photosensitive drum and provided at an end of the photosensitive drum.

### (Structure 155)

The cartridge according to Structure 154, wherein the end of the photosensitive drum is a first end, the photosensitive drum having a second end opposite the first end, and the one or more teeth is capable of being at least partially more remote from the second end of the photosensitive drum than the free end portion of the coupling, as measured along the axis of the photosensitive drum.

### (Structure 156)

The cartridge according to any one of Structures 153 to 155, wherein the gear is capable of taking a position such that as viewed along the axis of the photosensitive drum, a line extending from the axis of the photosensitive drum through a tooth of the one or more teeth forms an angle of −75° or more and 50° or less, or 130° or more and 190° or less, with respect to a line extending from the axis of the photosensitive drum through the axis of a developing roller, where a downstream direction of rotation of the photosensitive drum is positive direction of the angle.

### (Structure 157)

The cartridge according to any one of Structures 153 to 156, wherein the gear is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

### (Structure 158)

A cartridge comprising:
a frame;
a photosensitive drum supported by the frame and rotatable about an axis; and
a rotatable belt provided at a side of the cartridge with respect to a direction of the axis of the photosensitive drum, the belt having a surface at least partially exposed to outside so as to face the axis of the photosensitive drum.

### (Structure 159)

The cartridge according to Structure 158, further comprising a coupling configured to be capable of transmitting a driving force to the photosensitive drum and provided at an end of the photosensitive drum and at the side of the cartridge.

### (Structure 160)

The cartridge according to Structure 159, wherein the end of the photosensitive drum is a first end, the photosensitive drum having a second end opposite the first end, and at least a part of the surface of the belt is more remote from the second end of the photosensitive drum than the free end portion of the coupling, as measured along the axis of the photosensitive drum.

### (Structure 161)

The cartridge according to any one of Structures 158 to 160, wherein the belt is an elastic member.

### (Structure 162)

The cartridge according to any one of Structures 158 to 161, wherein the belt has one or more teeth on a surface thereof.

### (Structure 163)

The cartridge according to any one of Structures 158 to 162, wherein the belt is capable of taking a position such that a distance from the axis of the photosensitive drum to a surface of the belt is 75% or more and 120% or less of a radius of the photosensitive drum, as measured along a direction perpendicular to the axis of the photosensitive drum.

### (Structure 164)

The cartridge according to any one of Structures 158 to 163, wherein the belt is capable of taking a position such that a distance from the axis of the photosensitive drum to a surface of the belt is 90% or more and 120% or less of a radius of the photosensitive drum, as measured along a direction perpendicular to the axis of the photosensitive drum.

### (Structure 165)

The cartridge according to any one of Structures 158 to 164, further comprising a movable member provided on the side, wherein the movable member is movable so that a distance from the surface of the movable member to the axis of the photosensitive drum changes.

### (Structure 166)

The cartridge according to Structure 165, wherein the movable member is capable of taking a position such that at least a part of the photosensitive drum is between the surface of the movable member and the belt, as viewed along the axis of the photosensitive drum.

### (Structure 167)

The cartridge according to Structure 165 or 166, wherein the photosensitive drum has a first end and a second end opposite to the first end,
the cartridge further comprising a coupling configured to be capable of transmitting a driving force to the photosensitive drum, the coupling being provided at the first end of the photosensitive drum and at the side of the cartridge with respect to a direction of the axis of the photosensitive drum,
wherein the movable member is capable of taking a position such that at least a part of the surface of the movable member is more remote from the second end of the photosensitive drum than a free end portion of the coupling, as measured along the axis of the photosensitive drum.

### (Structure 168)

The cartridge described in any one of Structures 165 to 167, wherein the movable member is capable of taking a position such that the surface of the movable member is adjacent to the peripheral surface of the photosensitive drum, as viewed along the axis of the photosensitive drum.

### (Structure 169)

The cartridge according to any one of Structures 165 to 168, wherein the movable member is capable of taking a position such that a distance from the surface of the movable member to the axis of the photosensitive drum is less than 1.2 times a radius of the photosensitive drum.

### (Structure 170)

The cartridge according to any one of Structures 165 to 169, wherein the movable member is capable of taking a position such that a distance from the surface of the movable member to the axis of the photosensitive drum is greater than 1.25 times a radius of the photosensitive drum.

### (Structure 171)

The cartridge according to any one of Structures 158 to 170, wherein the belt is capable of taking a position such that as viewed along the axis of the photosensitive drum, a line extending from the axis of the photosensitive drum through the surface of the belt forms an angle of −70° or more and 100° or less, or 130° or more and 190° or less, with a line extending from the axis of the photosensitive drum through the axis of a developing roller, where a downstream direction of rotation of the photosensitive drum is positive direction of the angle.

### INDUSTRIAL APPLICABILITY

According to the present invention, a cartridge that can be mounted in an image forming apparatus is provided.

The present invention is not limited to the above embodiment, and various changes and modifications are possible without departing from the spirit and scope of the present invention. Therefore, the following claims are attached to clarify the scope of the present invention.

This application claims priority based on Japanese Patent Application No. 2023-137004, filed on Aug. 25, 2023, the entire contents of which are incorporated herein by reference.

1. A cartridge comprising:
a frame;
a photosensitive drum supported by the frame and rotatable about an axis; and
a rack having one or more teeth at least partially exposed to face the axis of the photosensitive drum and provided at a side of the cartridge with respect to a direction of the axis of the photosensitive drum.

2. The cartridge according to claim 1, further comprising a coupling configured to be capable of transmitting a driving force to the photosensitive drum, the coupling being provided at an end of the photosensitive drum and at the side of the cartridge.

3. The cartridge according to claim 2, wherein the end of the photosensitive drum is a first end, the photosensitive drum having a second end opposite the first end, and the one or more teeth are at least partially positioned more remote from the second end of the photosensitive drum than a free end of the coupling as measured along the axis of the photosensitive drum.

4. The cartridge according to claim 1, wherein the rack is capable of taking a position such that a distance from the axis of the photosensitive drum to a tip of a tooth of the one or more teeth is 90% or more and 120% or less of a radius of the photosensitive drum, as measured along a direction perpendicular to the axis of the photosensitive drum.

5. The cartridge according to claim 1, further comprising a movable member provided at the side of the cartridge, wherein the movable member is movable so that a distance from a surface of the movable member to the axis of the photosensitive drum changes.

6. The cartridge according to claim 5, wherein as viewed along the axis of the photosensitive drum, the movable member is capable of taking a position such that at least a part of the photosensitive drum is between the surface of the movable member and the rack.

7. The cartridge according to claim 5, wherein the photosensitive drum has a first end and a second end opposite the first end,
the cartridge further comprising a coupling configured to be capable of transmitting a driving force to the photosensitive drum, the coupling being positioned at the first end of the photosensitive drum and at the side of the cartridge,
wherein the movable member is capable of taking a positioned such that at least a part of the surface of the movable member is more remote from the second end of the photosensitive drum than a free end portion of the coupling as measured along the axis of the photosensitive drum.

8. The cartridge according to claim 5, wherein the movable member is capable of taking a position such that the surface of the movable member is adjacent to a peripheral surface of the photosensitive drum as viewed in the axial direction of the photosensitive drum.

9. The cartridge according to claim 5, wherein the movable member is capable of taking a position such that a distance from the surface of the movable member to the axis of the photosensitive drum is less than 1.2 times the radius of the photosensitive drum.

10. The cartridge according to claim 5, wherein the movable member is capable of taking a position such that a distance from the surface of the movable member to the axis of the photosensitive drum is greater than 1.25 times the radius of the photosensitive drum.

11. The cartridge according to claim 1, wherein the rack has a plurality of the teeth, and wherein the rack is configured to move along a straight line or a flat plane contacting to tips of the teeth.

12. The cartridge according to claim 1, wherein the rack has a plurality of the teeth, and wherein a distance, measured along a direction perpendicular to the axis of the photosensitive drum, from the axis of the photosensitive drum to a line passing through tips of the teeth is 90% or more and 120% or less of a radius of the photosensitive drum.

13. The cartridge according to claim 1, wherein the rack is capable of taking a position such that as viewed along the axis of the photosensitive drum, a line extending in a direction perpendicular to a direction of movement of the rack away from the photosensitive drum forms an angle of −75° or more and 50° or less, or 130° or more and 190° or less, with respect to a line extending from the axis of the photosensitive drum to pass through an axis of a developing roller, with a downstream direction of rotation of the photosensitive drum being positive direction of the angle.

14. The cartridge according to claim 1, wherein the rack is capable of taking a position such that as viewed along the axis of the photosensitive drum,
a line extending from the axis of the photosensitive drum through one of the one or more teeth forms an angle of −75° or more and 50° or less, or 130° or more and 190° or less, with respect to a line extending from the axis of the photosensitive drum through an axis of a developing roller, where a downstream direction of rotation of the photosensitive drum is positive direction of the angle.

15. The cartridge according to claim 1, wherein the rack is movable between a first position and a second position, and the cartridge further comprises a lock configured to restrict movement of the rack between the first position and the second position.

16. The cartridge according to claim 15, wherein the rack is urged toward the first position.

17. The cartridge according to claim 15, wherein the lock is configured to restrict movement of the rack when the rack is in the second position.

18. The cartridge according to claim 15, wherein the lock is configured to be switchable between an operating state in which the lock is capable of restricting movement of the lock and an inoperative state in which the lock does not restrict movement of the rack.

19. The cartridge according to claim 18, further comprising an operating portion configured to switch the lock between the operating state and the inoperative state.

20. The cartridge according to claim 1, further comprising a movable member positioned at the side of the cartridge, wherein the movable member is capable of moving so that a distance from a surface of the movable member to the axis of the photosensitive drum changes.

21. The cartridge according to claim 20, wherein the movable member is capable of taking a position such that at least a part of the photosensitive drum is between a surface of the movable member and a surface of the rack as viewed along the axis of the photosensitive drum.

22. The cartridge according to claim 21, wherein the photosensitive drum has a first end and a second end opposite the first end,
the cartridge further comprising a coupling configured to be capable of transmitting a driving force to the photosensitive drum, the coupling being positioned at the first end of the photosensitive drum and at the side of the cartridge,
wherein the movable member is capable of taking a positioned such that at least a part of the surface of the movable member is more remote from the second end of the photosensitive drum than a free end portion of the coupling as measured along the axis of the photosensitive drum.

23. The cartridge according to claim 20, wherein the movable member is capable of taking a position such that the surface of the movable member is adjacent to a peripheral surface of the photosensitive drum as viewed along the axis of the photosensitive drum.

24. The cartridge according to claim 20, wherein the movable member is capable of taking a position such that a distance from the surface of the movable member to the axis of the photosensitive drum is less than 1.2 times a radius of the photosensitive drum.

25. The cartridge according to claim 20, wherein the movable member is capable of taking a position such that a distance from the surface of the movable member to the axis of the photosensitive drum is greater than 1.25 times a radius of the photosensitive drum.

26.-171. (canceled)
